(19) United States
(12) Patent Application Publication
(10) Pub. No.: US 2025/0377760 A1
(43) Pub. Date: Dec. 11, 2025

(54) DEVICES, METHODS, AND GRAPHICAL USER INTERFACES FOR CONTROLLER INPUT

(71) Applicant: Apple Inc., Cupertino, CA (US)

(72) Inventors: Christopher D. MCKENZIE, Burlingame, CA (US); Jonathan RAVSAZ, Sunnyvale, CA (US); Evgenii KRIVORUCHKO, San Francisco, CA (US); Miquel ESTANY RODRIGUEZ, San Francisco, CA (US); Justin A. MEINERS, Boulder, CO (US); Gregory D. CHU, Sunnyvale, CA (US); Alexander L. WANG, Santa Clara, CA (US)

(21) Appl. No.: 19/229,935

(22) Filed: Jun. 5, 2025

Related U.S. Application Data
(60) Provisional application No. 63/657,970, filed on Jun. 9, 2024.
(60) Provisional application No. 63/658,404, filed on Jun. 10, 2024.
(60) Provisional application No. 63/808,215, filed on May 19, 2025.

(51) Int. Cl. G06F 3/04815; G06F 3/04845

(52) U.S. Cl. CPC G06F 3/04815; G06F 3/04845

(57) ABSTRACT

In some embodiments, a computer system controls a user interface element based on directional control input. In some embodiments, a computer system performs an operation in connection with a virtual content item based on input focus. In some embodiments, a computer system reduces the visual prominence of virtual content that is obscuring visibility of one or more objects. In some embodiments, a computer system reduces the visual prominence of virtual content that is obscuring visibility of one or more objects. In some embodiments, a computer system scrolls through paginated content based on directional control input. In some embodiments, a computer system reduces visibility of a first portion of a hand without reducing visibility of a second portion. In some embodiments, a computer system reduces a visual prominence of a portion of virtual content to increase a visibility of one or more hands.

### CROSS REFERENCE TO RELATED APPLICATIONS

This application claims the benefit of U.S. Provisional Application No. 63/808,215, filed May 19, 2025, U.S. Provisional Application No. 63/658,404, filed Jun. 10, 2024, and U.S. Provisional Application No. 63/657,970, filed Jun. 9, 2024, the contents of which are herein incorporated by reference in their entireties for all purposes.

### TECHNICAL FIELD

The present disclosure relates generally to computer systems that provide computer-generated experiences, including, but not limited to, electronic devices that provide virtual reality and mixed reality experiences via a display.

### BACKGROUND

The development of computer systems for augmented reality has increased significantly in recent years. Example augmented reality environments include at least some virtual elements that replace or augment the physical world. Input devices, such as cameras, controllers, joysticks, touch-sensitive surfaces, and touch-screen displays for computer systems and other electronic computing devices are used to interact with virtual/augmented reality environments. Example virtual elements include virtual objects, such as digital images, video, text, icons, and control elements such as buttons and other graphics.

### SUMMARY

Some methods and interfaces for interacting with environments that include at least some virtual elements (e.g., applications, augmented reality environments, mixed reality environments, and virtual reality environments) are cumbersome, inefficient, and limited. For example, systems that provide insufficient feedback for performing actions associated with virtual objects, systems that require a series of inputs to achieve a desired outcome in an augmented reality environment, and systems in which manipulation of virtual objects are complex, tedious, and error-prone, create a significant cognitive burden on a user, and detract from the experience with the virtual/augmented reality environment. In addition, these methods take longer than necessary, thereby wasting energy of the computer system. This latter consideration is particularly important in battery-operated devices.

Accordingly, there is a need for computer systems with improved methods and interfaces for providing computer-generated experiences to users that make interaction with the computer systems more efficient and intuitive for a user. Such methods and interfaces optionally complement or replace conventional methods for providing extended reality experiences to users. Such methods and interfaces reduce the number, extent, and/or nature of the inputs from a user by helping the user to understand the connection between provided inputs and device responses to the inputs, thereby creating a more efficient human-machine interface.

The above deficiencies and other problems associated with user interfaces for computer systems are reduced or eliminated by the disclosed systems. In some embodiments, the computer system is a desktop computer with an associated display. In some embodiments, the computer system is portable device (e.g., a notebook computer, tablet computer, or handheld device). In some embodiments, the computer system is a personal electronic device (e.g., a wearable electronic device, such as a watch, or a head-mounted device). In some embodiments, the computer system has a touchpad. In some embodiments, the computer system has one or more cameras. In some embodiments, the computer system has (e.g., includes or is in communication with) a display generation component (e.g., a display device such as a head-mounted device (HMD), a display, a projector, a touch-sensitive display (also known as a “touch screen” or “touch-screen display”), or other device or component that presents visual content to a user, for example on or in the display generation component itself or produced from the display generation component and visible elsewhere). In some embodiments, the computer system has one or more eye-tracking components. In some embodiments, the computer system has one or more hand-tracking components. In some embodiments, the computer system has one or more output devices in addition to the display generation component, the output devices including one or more tactile output generators and/or one or more audio output devices. In some embodiments, the computer system has a graphical user interface (GUI), one or more processors, memory and one or more modules, programs or sets of instructions stored in the memory for performing multiple functions. In some embodiments, the user interacts with the GUI through a stylus and/or finger contacts and gestures on the touch-sensitive surface, movement of the user's eyes and hand in space relative to the GUI (and/or computer system) or the user's body as captured by cameras and other movement sensors, and/or voice inputs as captured by one or more audio input devices. In some embodiments, the functions performed through the interactions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a transitory and/or non-transitory computer readable storage medium or other computer program product configured for execution by one or more processors.

There is a need for electronic devices with improved methods and interfaces for interacting with a three-dimensional environment. Such methods and interfaces may complement or replace conventional methods for interacting with a three-dimensional environment. Such methods and interfaces reduce the number, extent, and/or the nature of the inputs from a user and produce a more efficient human-machine interface. For battery-operated computing devices, such methods and interfaces conserve power and increase the time between battery charges.

In some embodiments, a computer system controls a user interface element based on input from a directional control. In some embodiments, a computer system performs an operation in connection with a virtual content item based on input focus at the computer system. In some embodiments, a computer system reduces the visual prominence of virtual content that is obscuring visibility of one or more objects based on object type. In some embodiments, a computer system reduces the visual prominence of virtual content that is obscuring visibility of one or more objects based on whether the objects are being held by a user. In some embodiments, a computer system reduces the visual prominence of virtual content that is obscuring visibility of one or more objects differently based on object type. In some embodiments, a computer system scrolls through paginated content based on a range of positions of input from a directional control. In some embodiments, a computer system reduces visibility of a first portion of a hand with virtual content without reducing visibility of a second portion of the hand with virtual content based on the positions of the hands relative to virtual content. In some embodiments, a computer system reduces a visual prominence of a portion of virtual content to increase a visibility of a portion of a three-dimensional environment that includes one or more hands based on a lighting condition of the three-dimensional environment.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a block diagram illustrating an operating environment of a computer system for providing XR experiences in accordance with some embodiments.

FIGS. 1B-1P are examples of a computer system for providing XR experiences in the operating environment of FIG. 1A.

FIG. 2 is a block diagram illustrating a controller of a computer system that is configured to manage and coordinate a XR experience for the user in accordance with some embodiments.

FIG. 3A is a block diagram illustrating a display generation component of a computer system that is configured to provide a visual component of the XR experience to the user in accordance with some embodiments.

FIGS. 3B-3G illustrate the use of Application Programming Interfaces (APIs) to perform operations.

FIG. 4 is a block diagram illustrating a hand tracking unit of a computer system that is configured to capture gesture inputs of the user in accordance with some embodiments.

FIG. 5 is a block diagram illustrating an eye tracking unit of a computer system that is configured to capture gaze inputs of the user in accordance with some embodiments.

FIG. 6 is a flow diagram illustrating a glint-assisted gaze tracking pipeline in accordance with some embodiments.

FIGS. 7A-7U illustrate exemplary ways in which a computer system controls a user interface element based on input from a directional control in accordance with some embodiments of the disclosure.

FIG. 8 illustrates a flow diagram illustrating a method of a computer system controlling a user interface element based on input from a directional control in accordance with some embodiments of the disclosure.

FIGS. 9A-9U illustrate examples of a computer system performing one or more operations on virtual content items based on input focus at the computer system, in accordance with some embodiments of the disclosure.

FIG. 10 is a flowchart illustrating a method of performing one or more operations on virtual content items based on input focus at a computer system, in accordance with some embodiments of the disclosure.

FIGS. 11A-11Z illustrate examples of a computer system reducing the visual prominence of virtual content that is obscuring visibility of one or more objects based on object type in accordance with some embodiments of the disclosure.

FIG. 12 is a flowchart illustrating a method of a computer system reducing the visual prominence of virtual content that is obscuring visibility of one or more objects based on object type in accordance with some embodiments of the disclosure.

FIGS. 13A-13U illustrate examples of a computer system reducing the visual prominence of virtual content that is obscuring visibility of one or more objects based on whether the objects are being held by a user in accordance with some embodiments of the disclosure.

FIG. 14 is a flowchart illustrating a method of a computer system reducing the visual prominence of virtual content that is obscuring visibility of one or more objects based on whether the objects are being held by a user in accordance with some embodiments of the disclosure.

FIGS. 15A-15H illustrate examples of a computer system reducing the visual prominence of virtual content that is obscuring visibility of one or more objects differently based on object type in accordance with some embodiments of the disclosure.

FIG. 16 is a flowchart illustrating a method of a computer system reducing the visual prominence of virtual content that is obscuring visibility of one or more objects differently based on object type in accordance with some embodiments of the disclosure.

FIGS. 17A-17BB illustrate examples of a computer system scrolling through paginated content based on a range of positions of input from a directional control in accordance with some embodiments of the disclosure.

FIG. 18 is a flowchart illustrating a method of a computer system scrolling through paginated content based on a range of positions of input from a directional control in accordance with some embodiments of the disclosure.

FIGS. 19A-19G illustrate examples of a computer system reducing visibility of a first portion of a hand with virtual content without reducing visibility of a second portion of the hand with virtual content based on the positions of the hands relative to virtual content in accordance with some embodiments.

FIG. 20 is a flowchart illustrating a method of a computer system reducing visibility of a first portion of a hand with virtual content without reducing visibility of a second portion of the hand with virtual content based on the positions of the hands relative to virtual content in accordance with some embodiments.

FIGS. 21A-21H illustrate examples of a computer system reducing a visual prominence of a portion of virtual content to increase a visibility of a portion of a three-dimensional environment that includes one or more hands based on a lighting condition of the three-dimensional environment in accordance with some embodiments.

FIG. 22 is a flowchart illustrating a method of a computer system reducing a visual prominence of a portion of virtual content to increase a visibility of a portion of a three-dimensional environment that includes one or more hands based on a lighting condition of the three-dimensional environment in accordance with some embodiments.

### DESCRIPTION OF EMBODIMENTS

The present disclosure relates to user interfaces for providing an extended reality (XR) experience to a user, in accordance with some embodiments.

The systems, methods, and GUIs described herein improve user interface interactions with virtual/augmented reality environments in multiple ways.

In some embodiments, a computer system controls a user interface element based on input from a directional control. In some embodiments, a computer system performs an operation in connection with a virtual content item based on input focus at the computer system. In some embodiments, a computer system reduces the visual prominence of virtual content that is obscuring visibility of one or more objects based on object type. In some embodiments, a computer system reduces the visual prominence of virtual content that is obscuring visibility of one or more objects based on whether the objects are being held by a user. In some embodiments, a computer system reduces the visual prominence of virtual content that is obscuring visibility of one or more objects differently based on object type. In some embodiments, a computer system scrolls through paginated content based on a range of positions of input from a directional control. In some embodiments, a computer system reduces visibility of a first portion of a hand with virtual content without reducing visibility of a second portion of the hand with virtual content based on the positions of the hands relative to virtual content. In some embodiments, a computer system reduces a visual prominence of a portion of virtual content to increase a visibility of a portion of a three-dimensional environment that includes one or more hands based on a lighting condition of the three-dimensional environment.

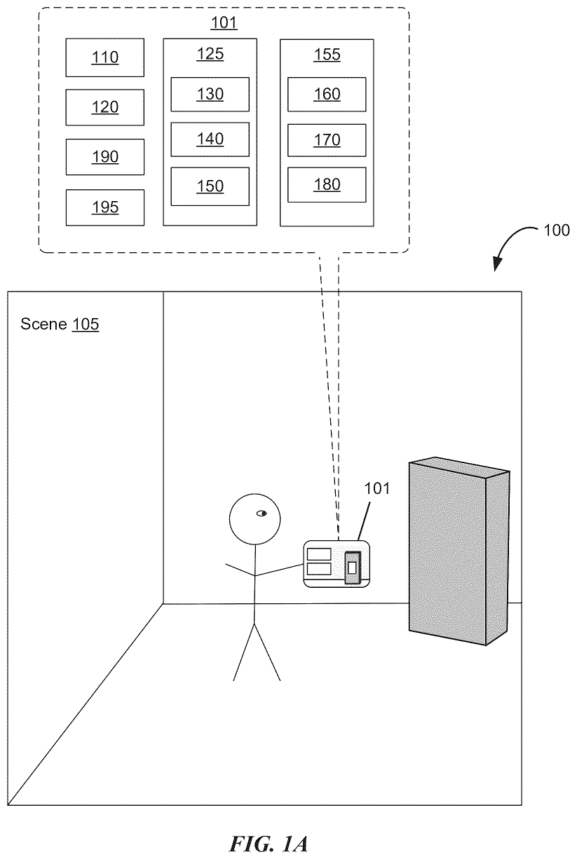

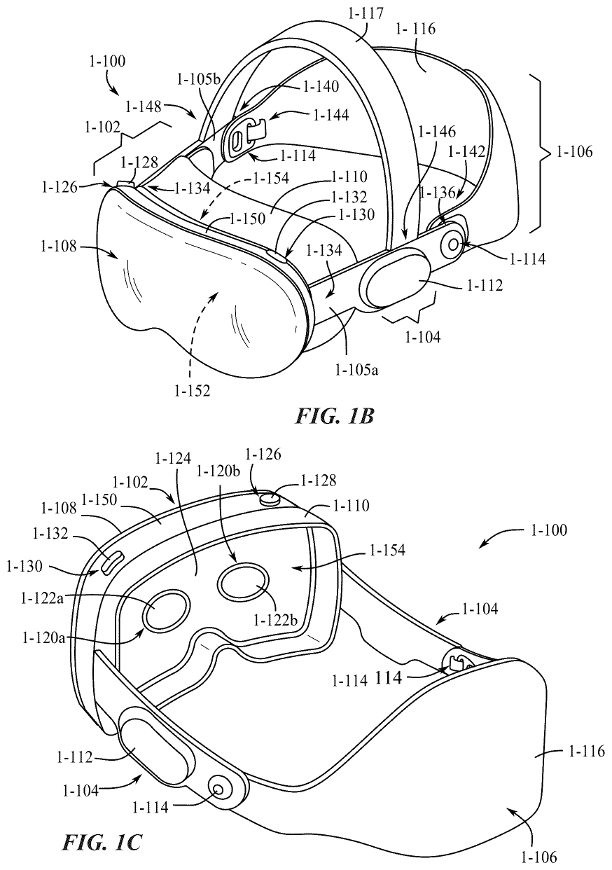

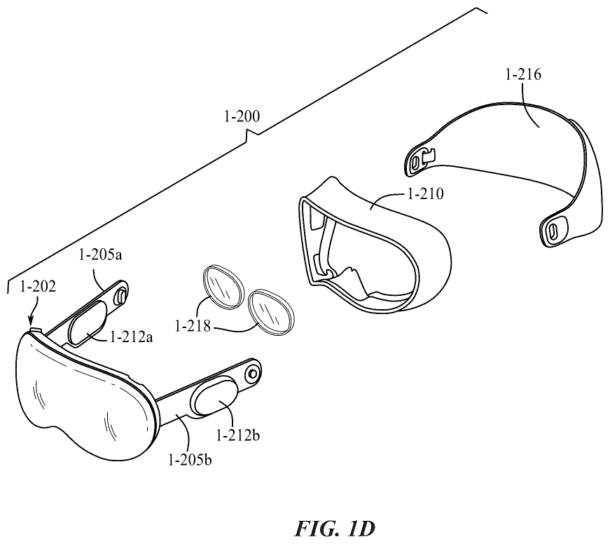

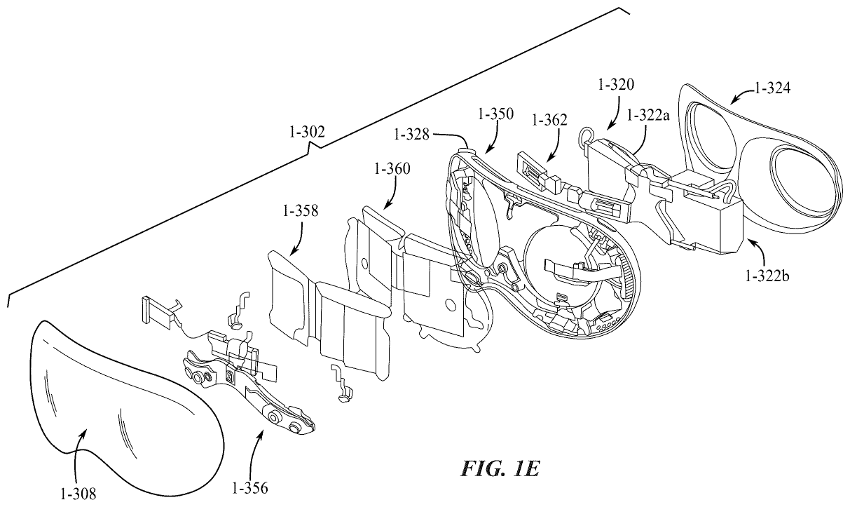

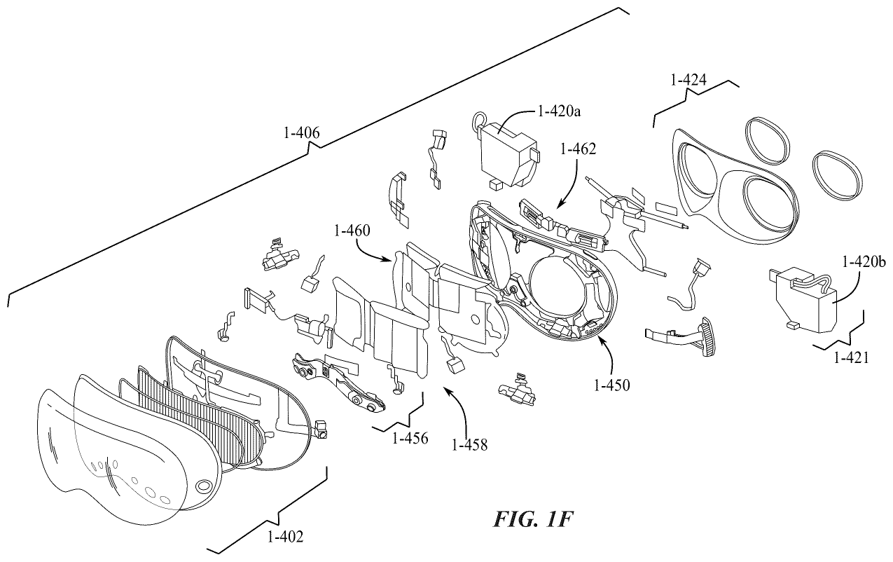

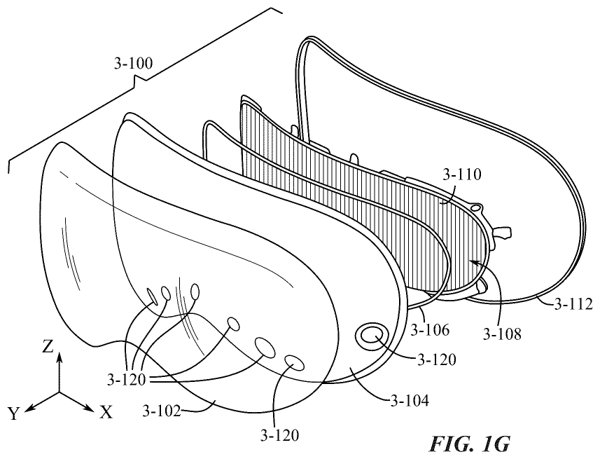

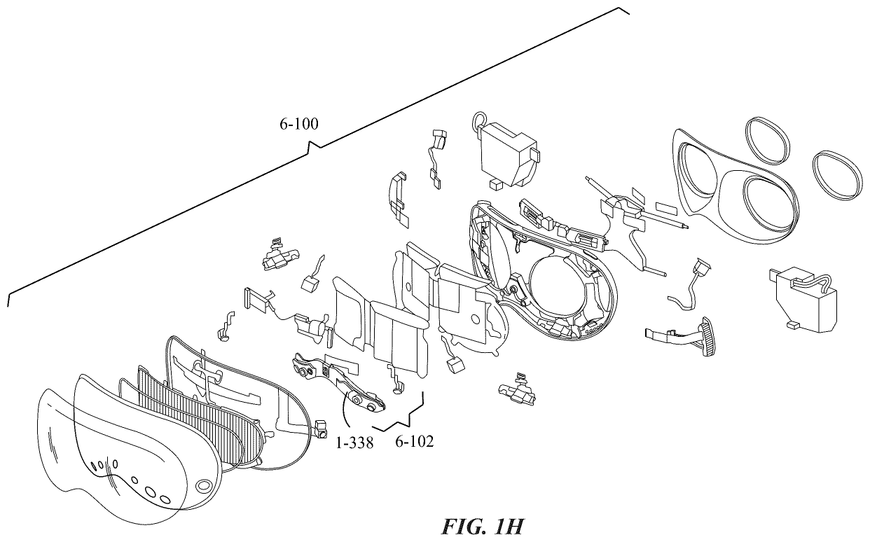

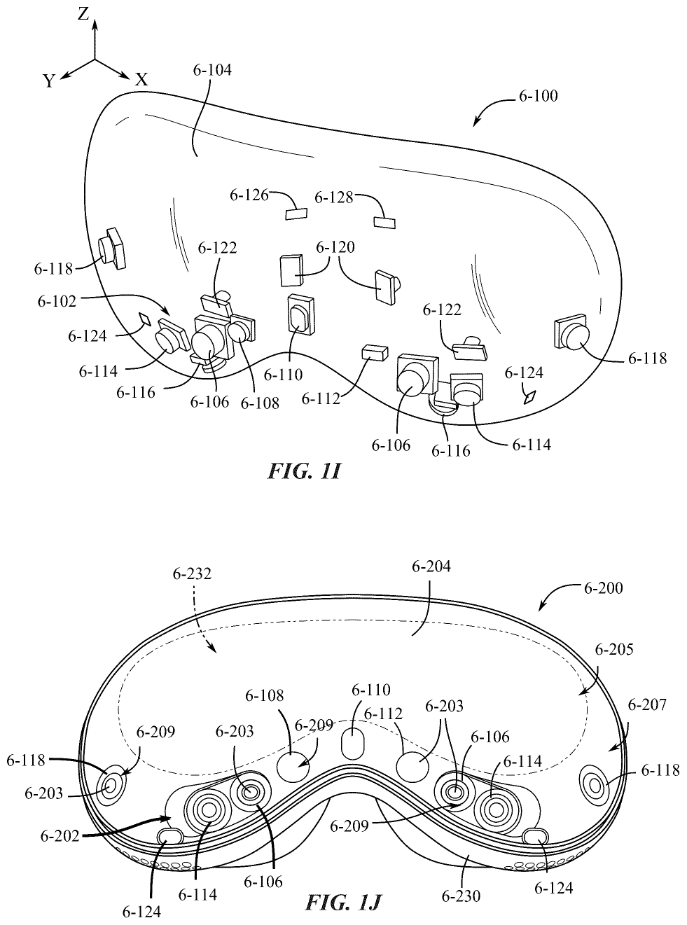

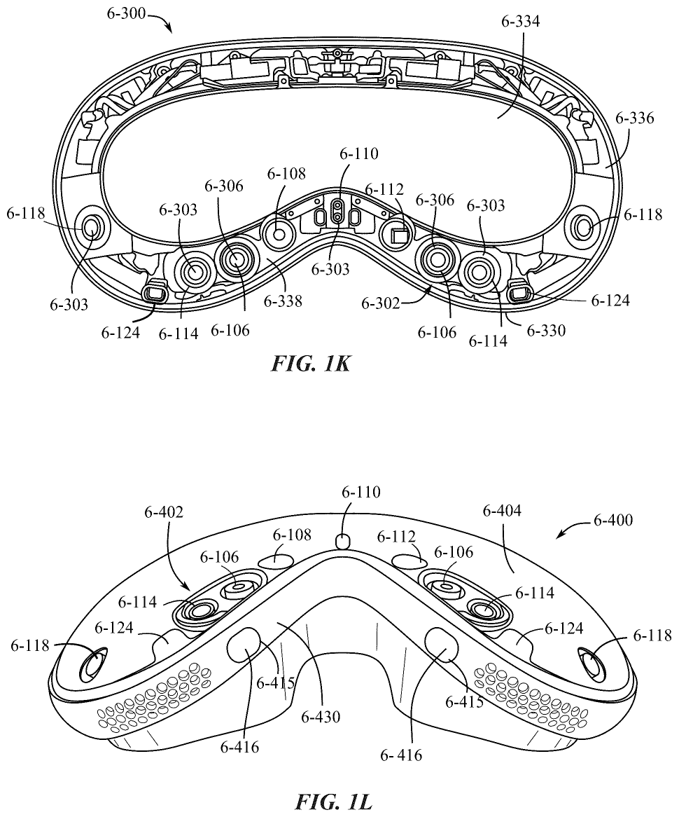

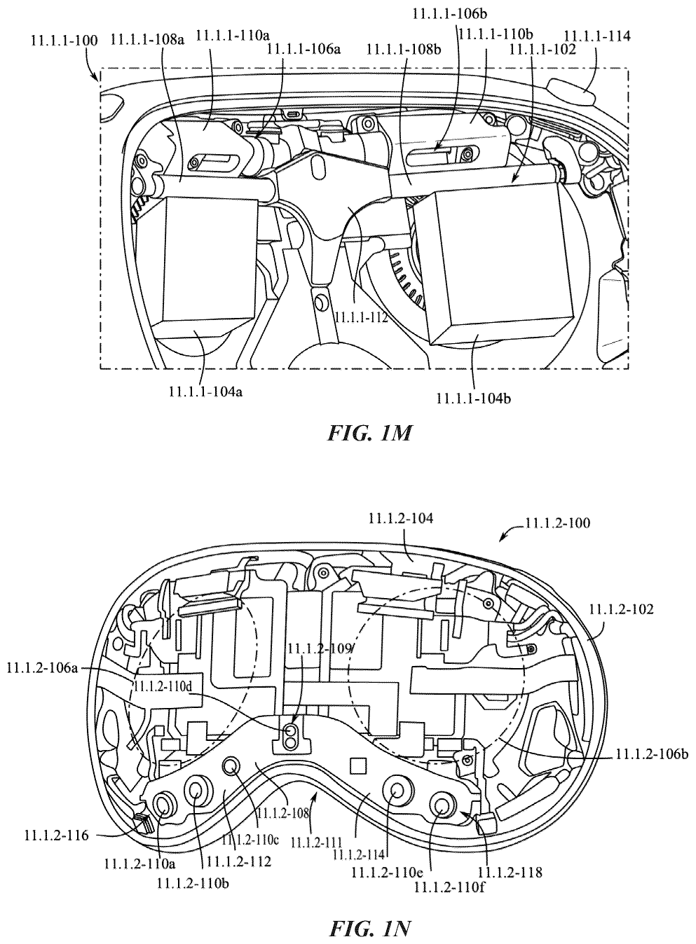

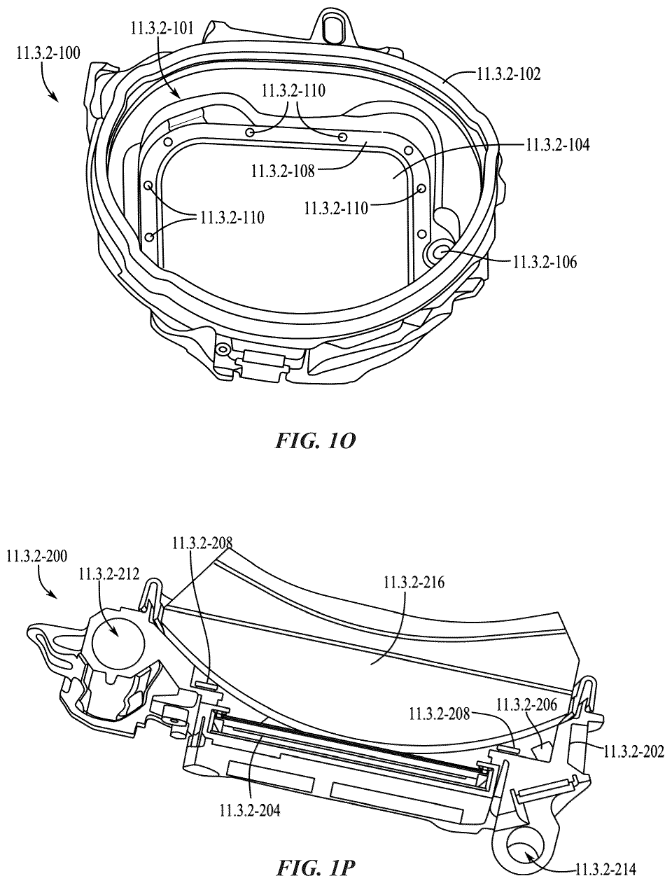

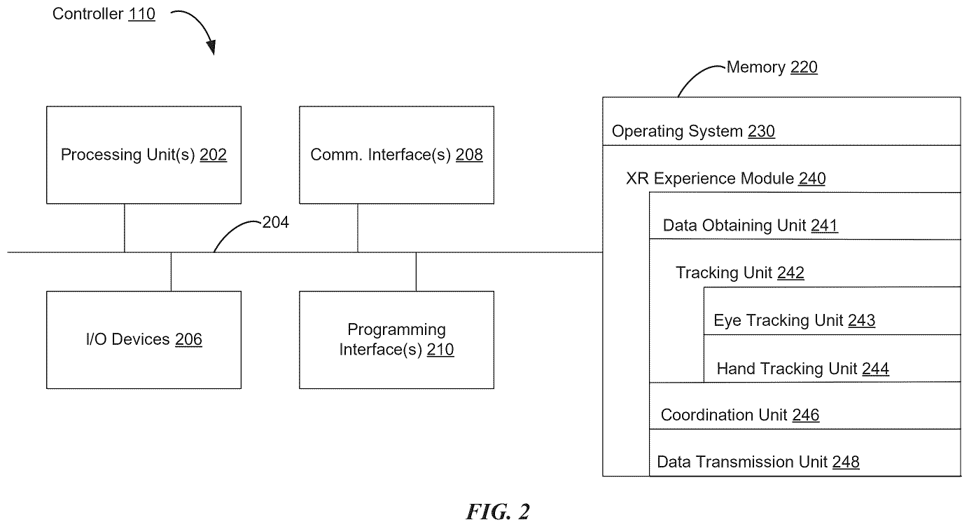

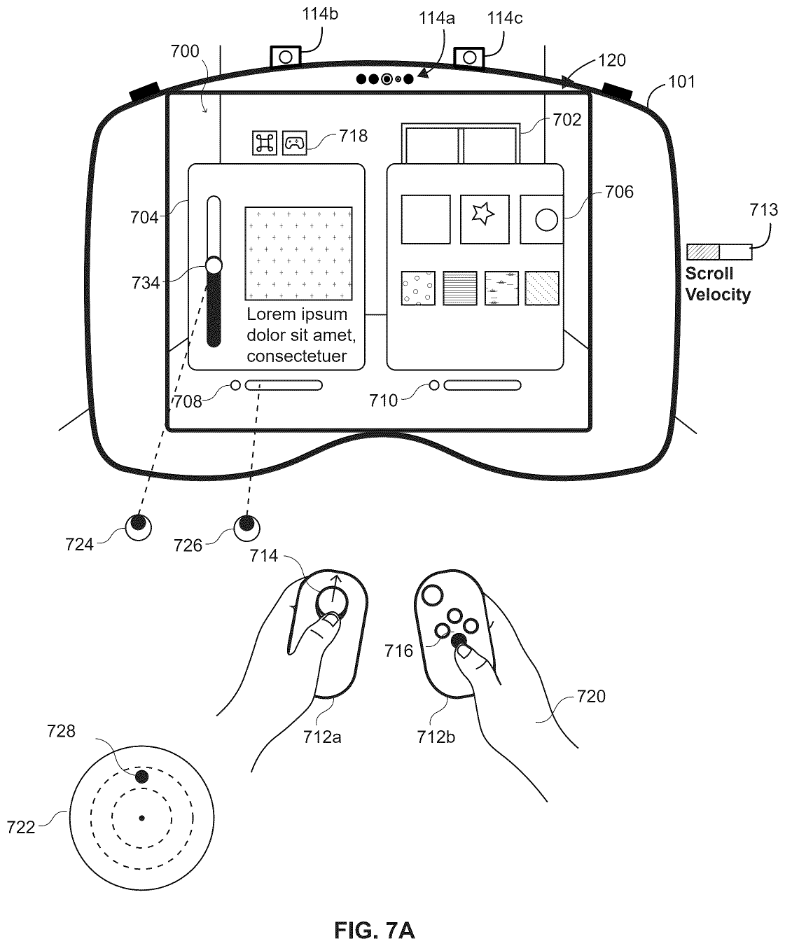

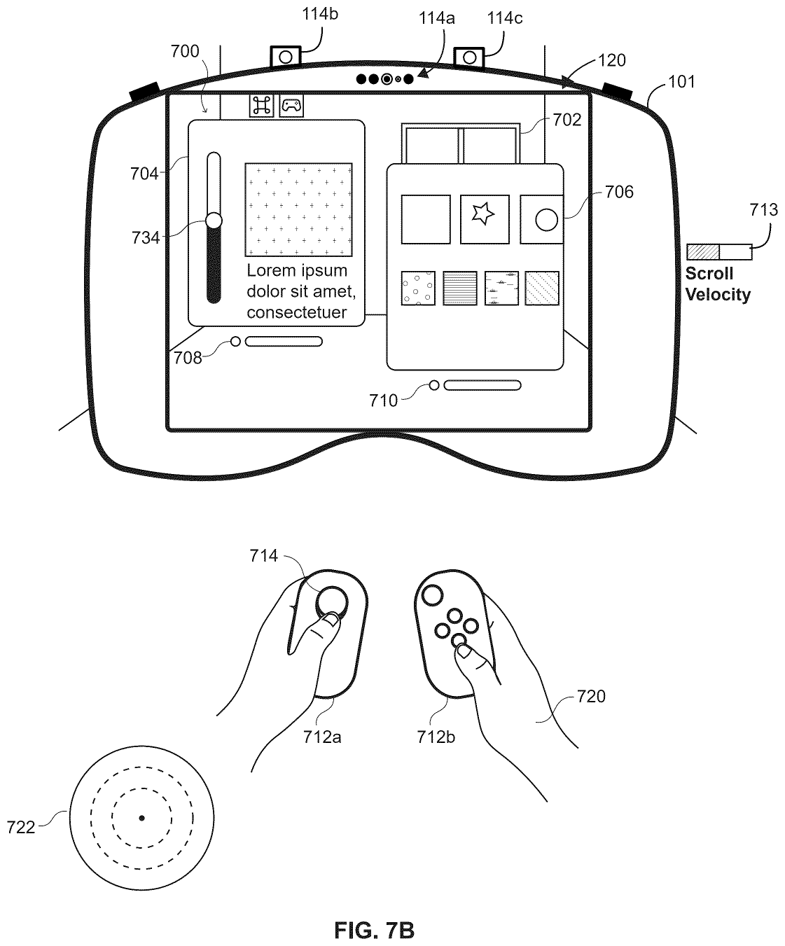

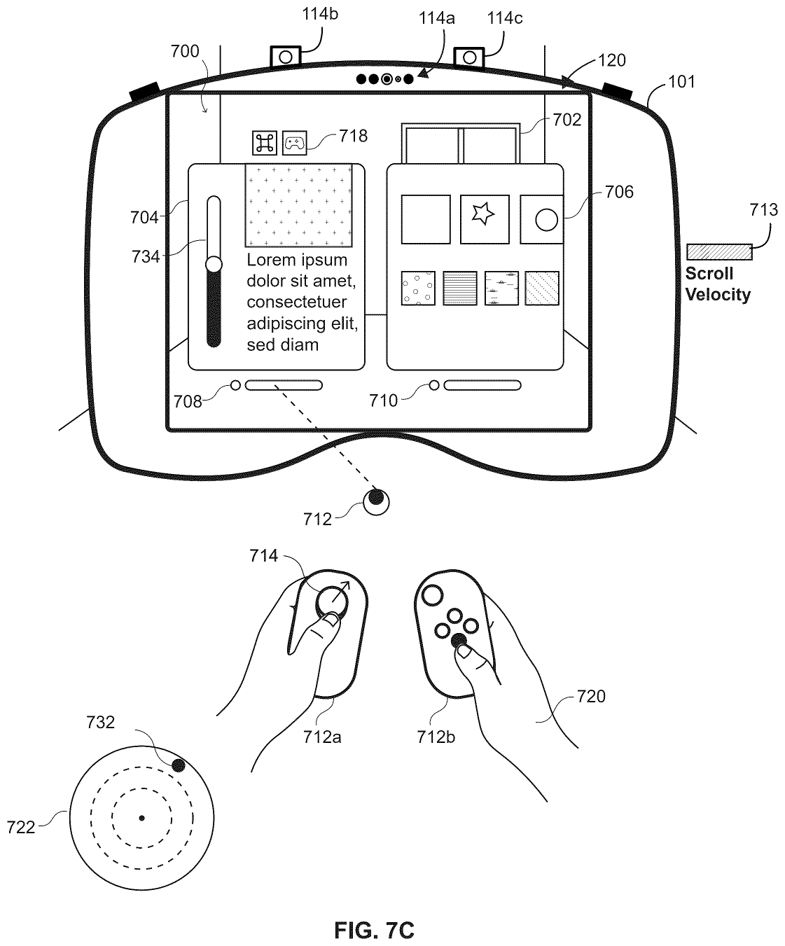

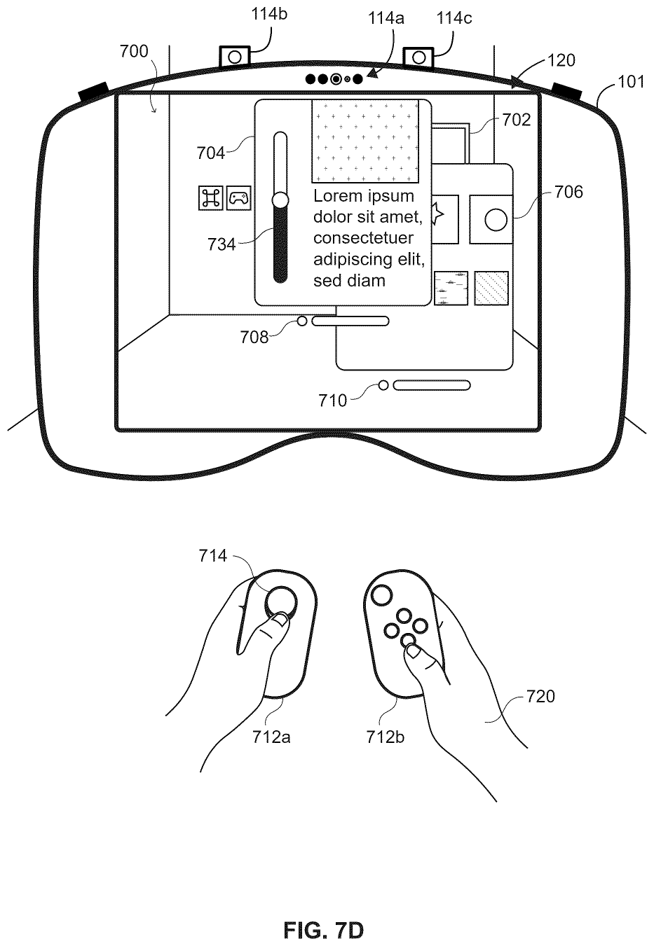

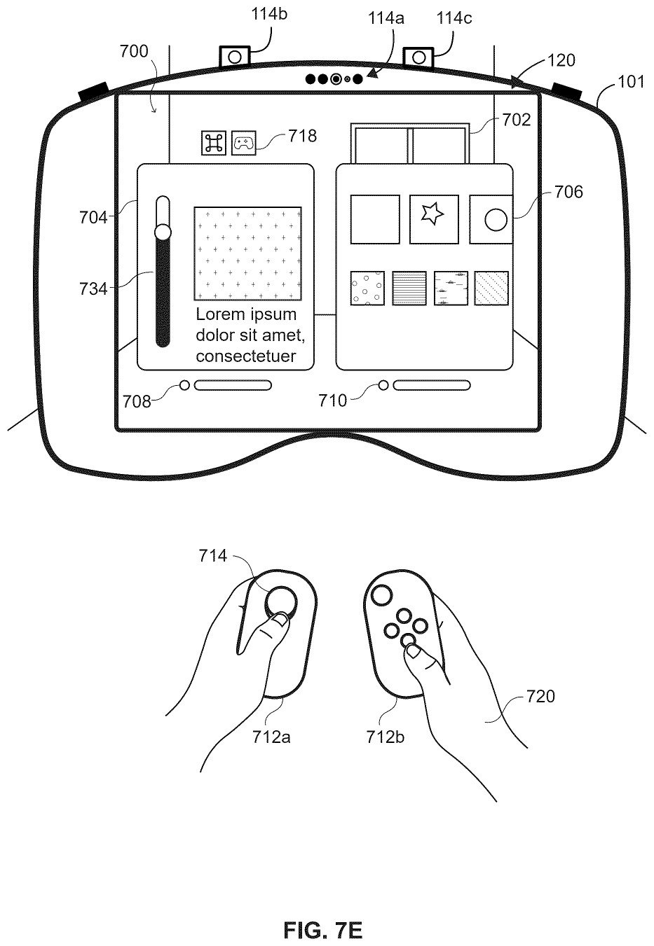

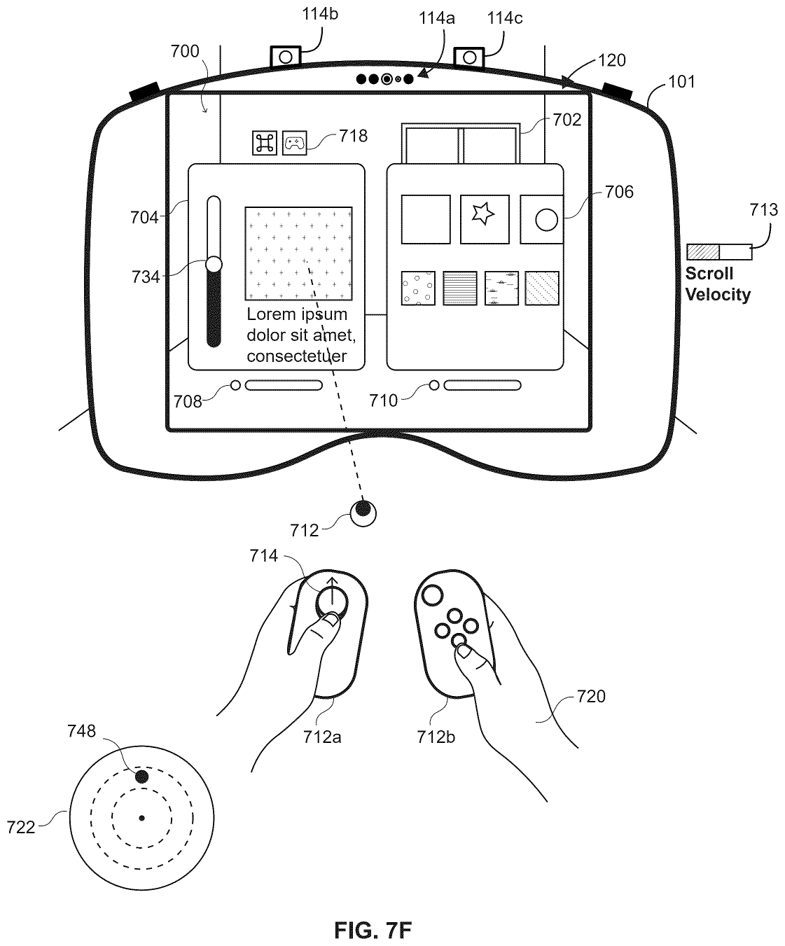

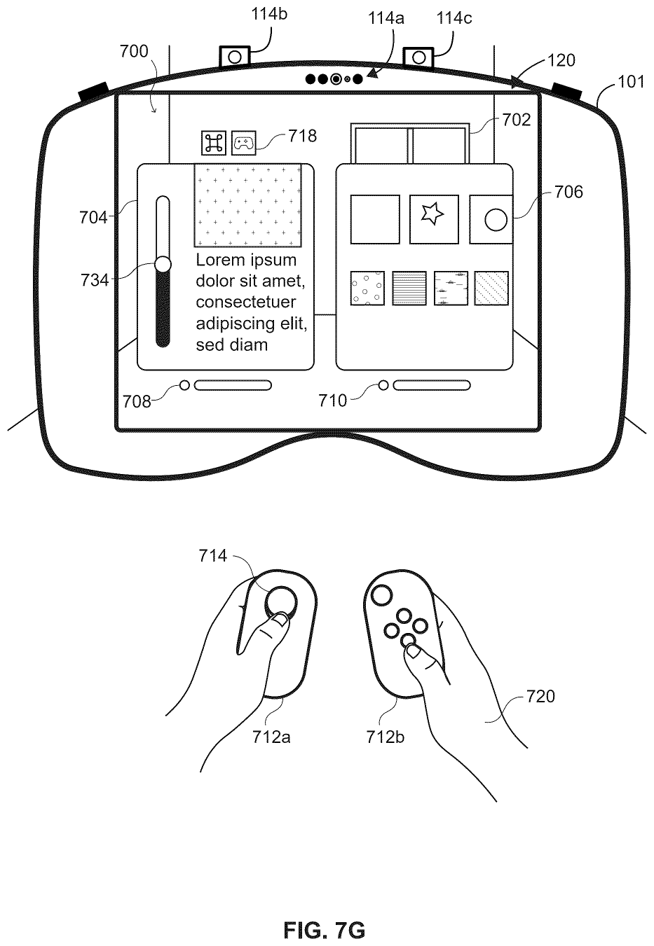

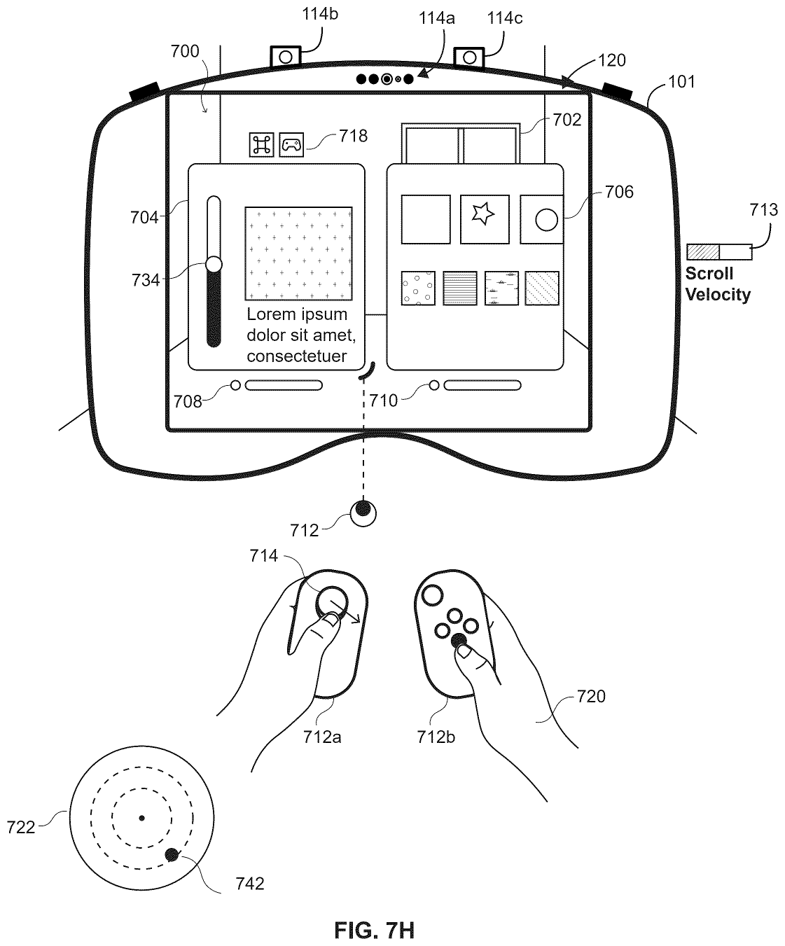

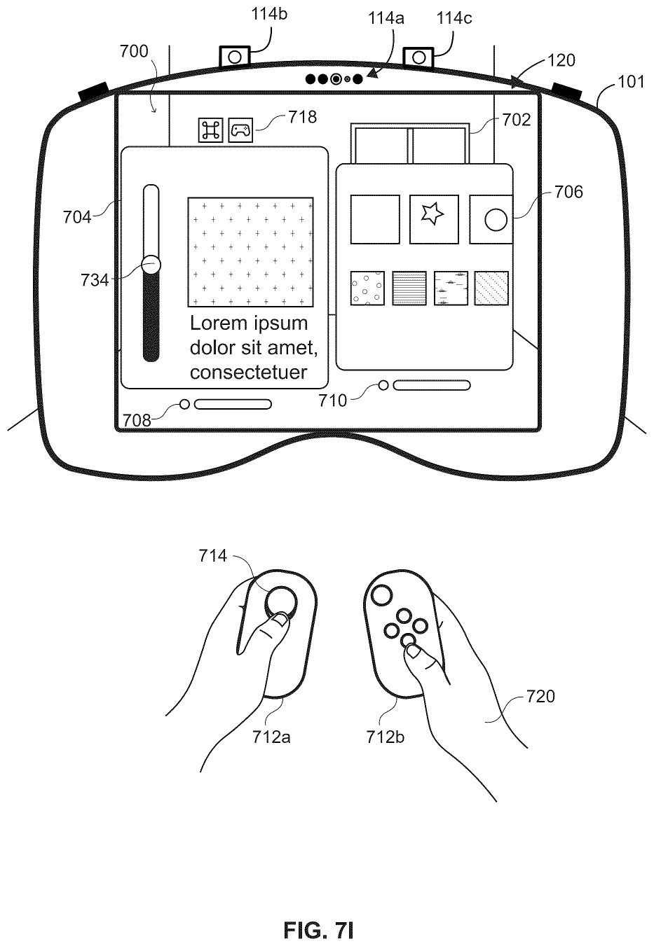

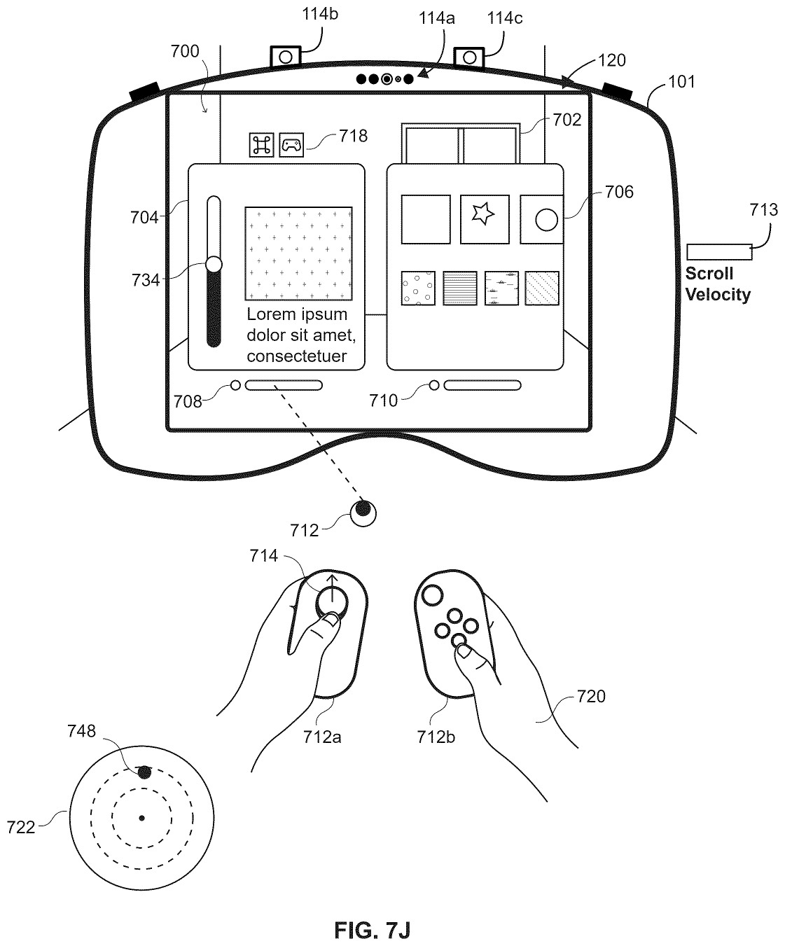

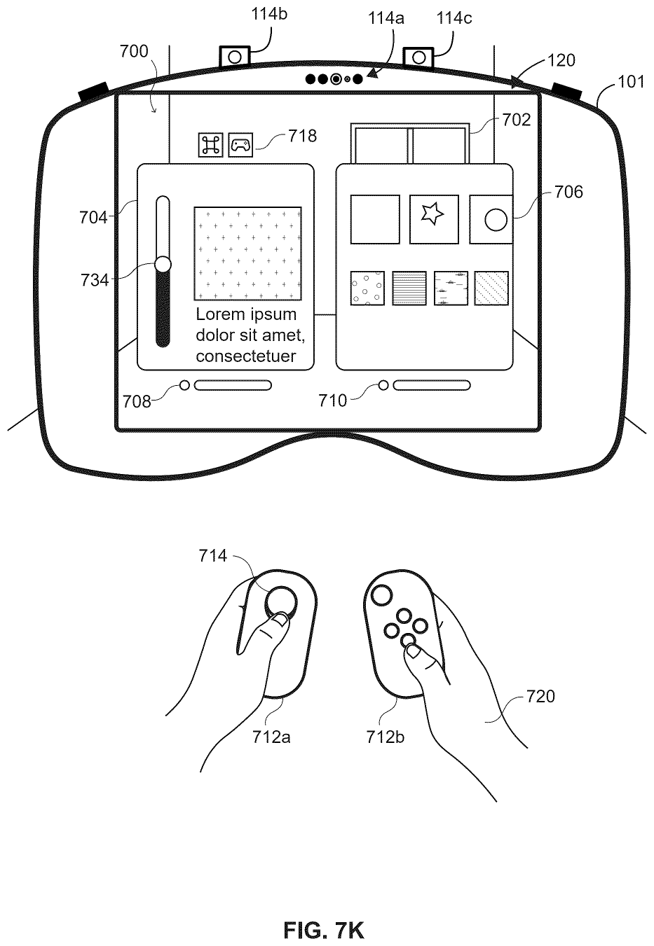

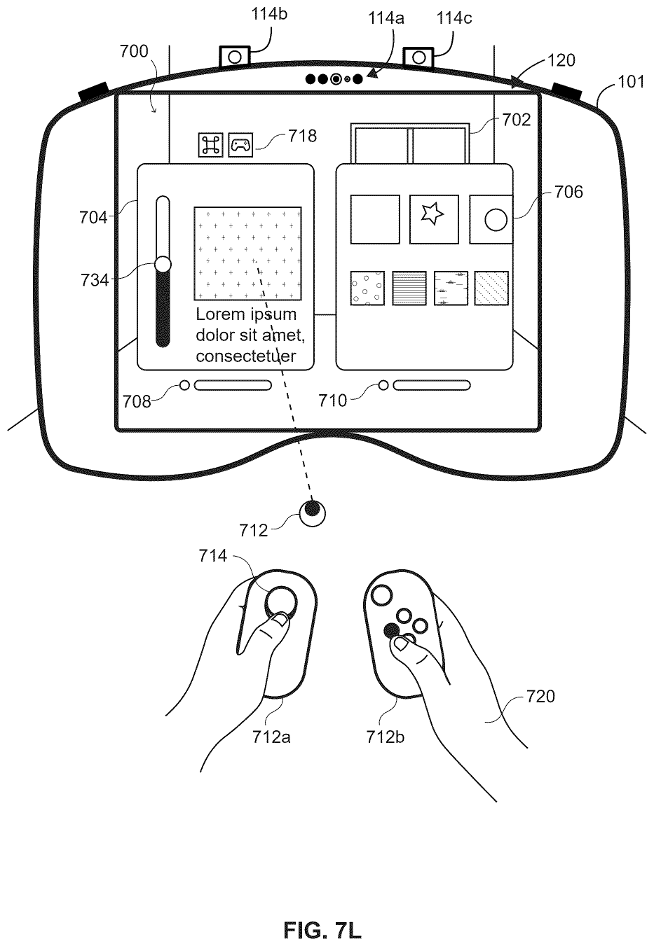

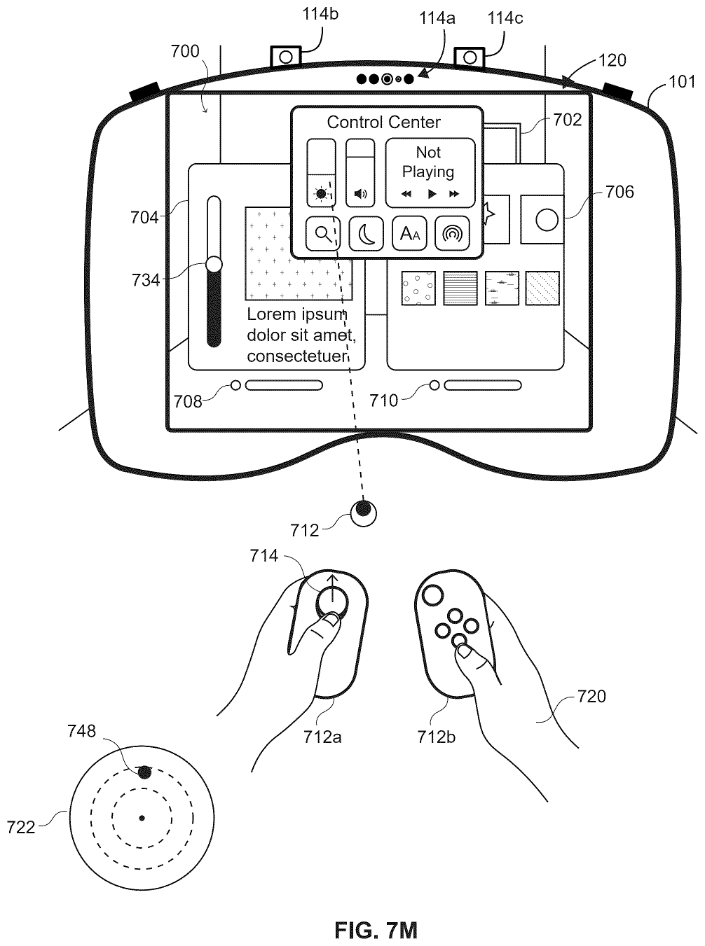

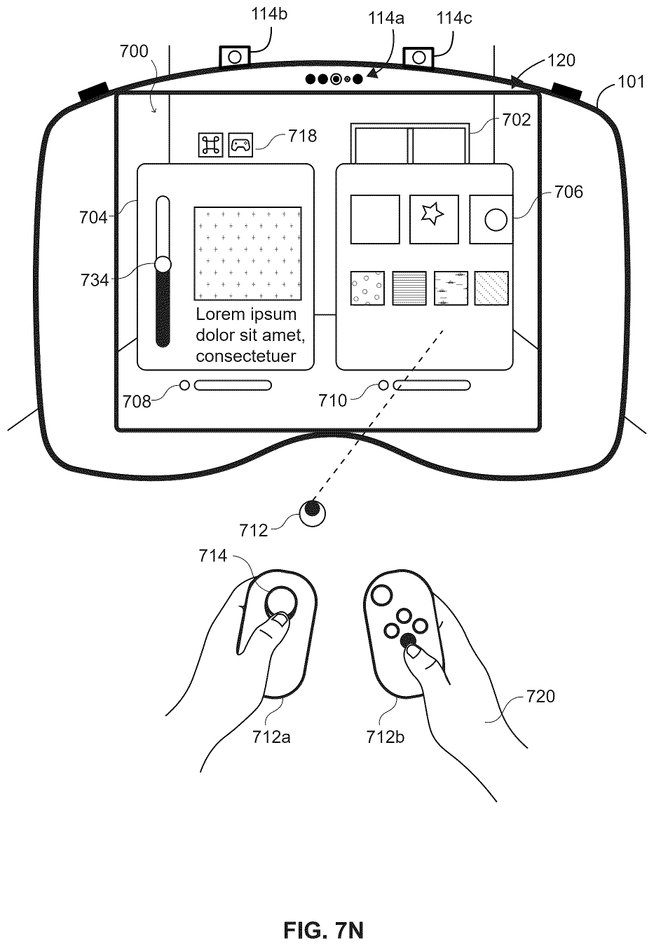

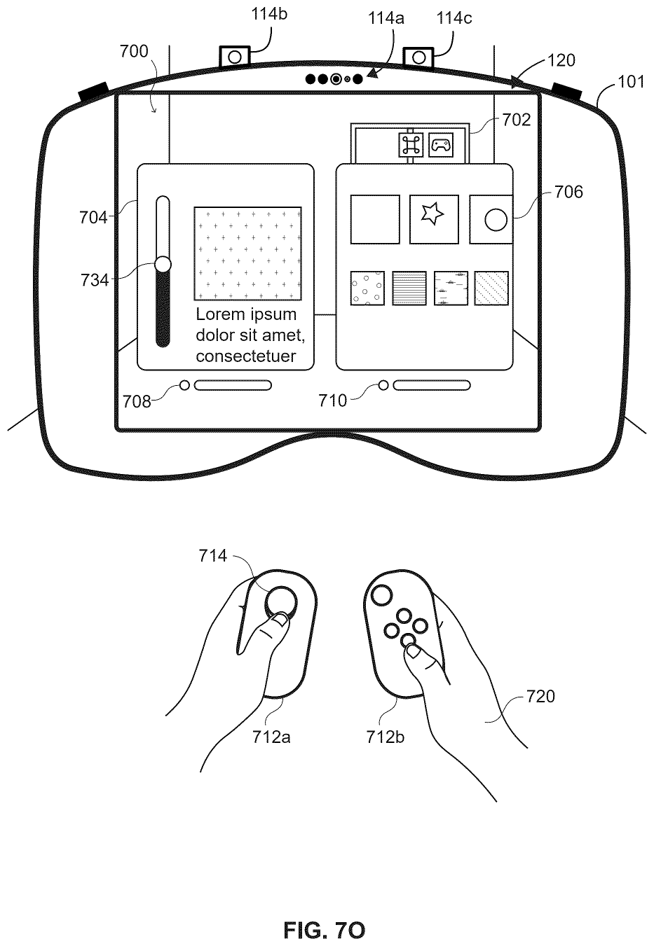

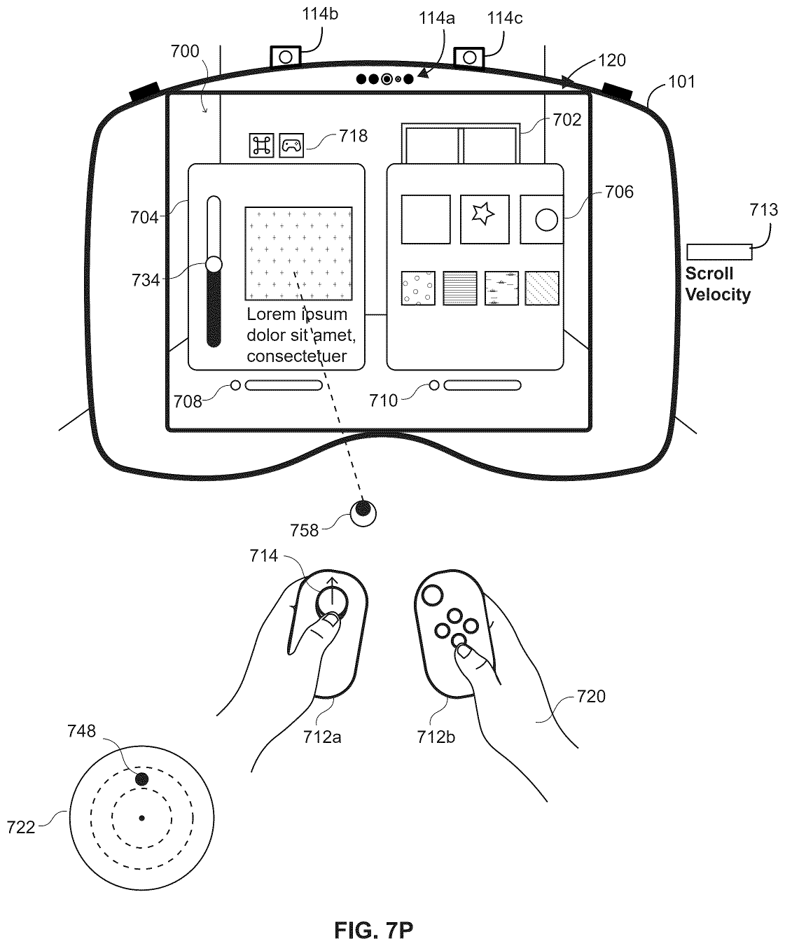

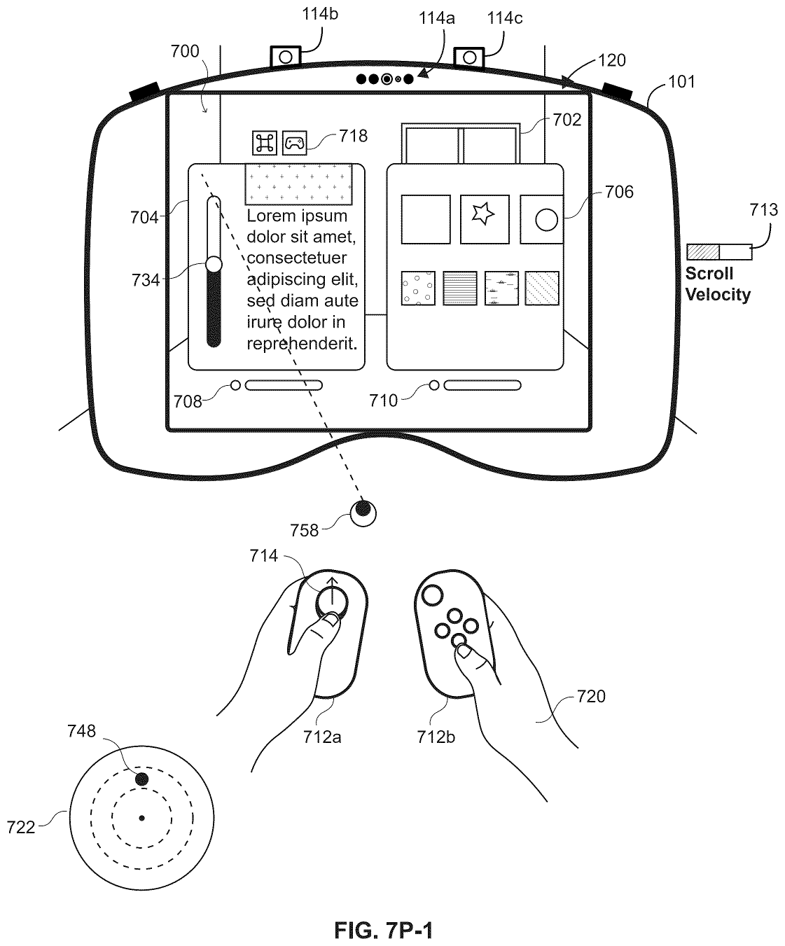

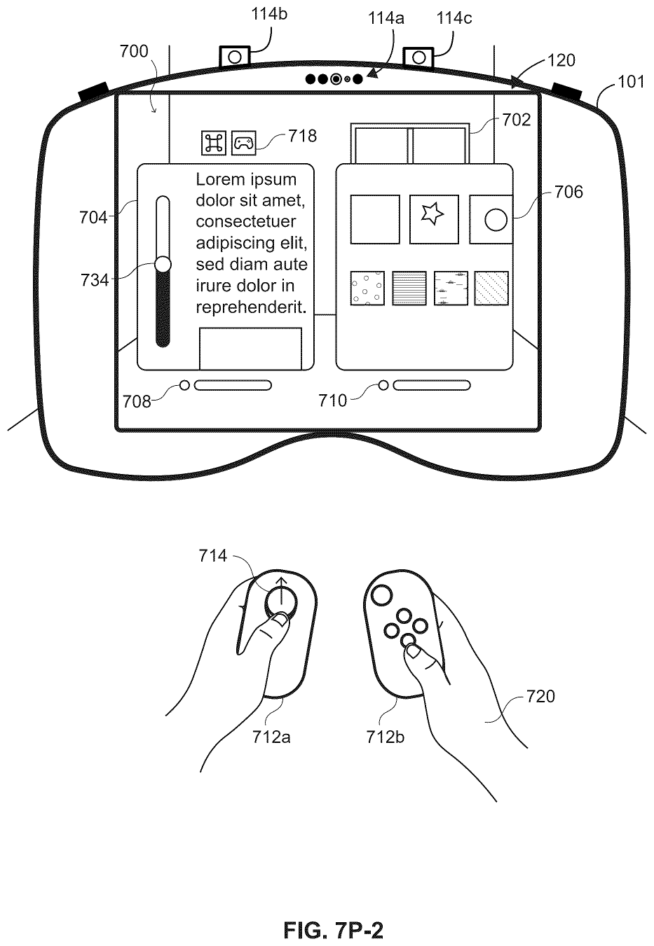

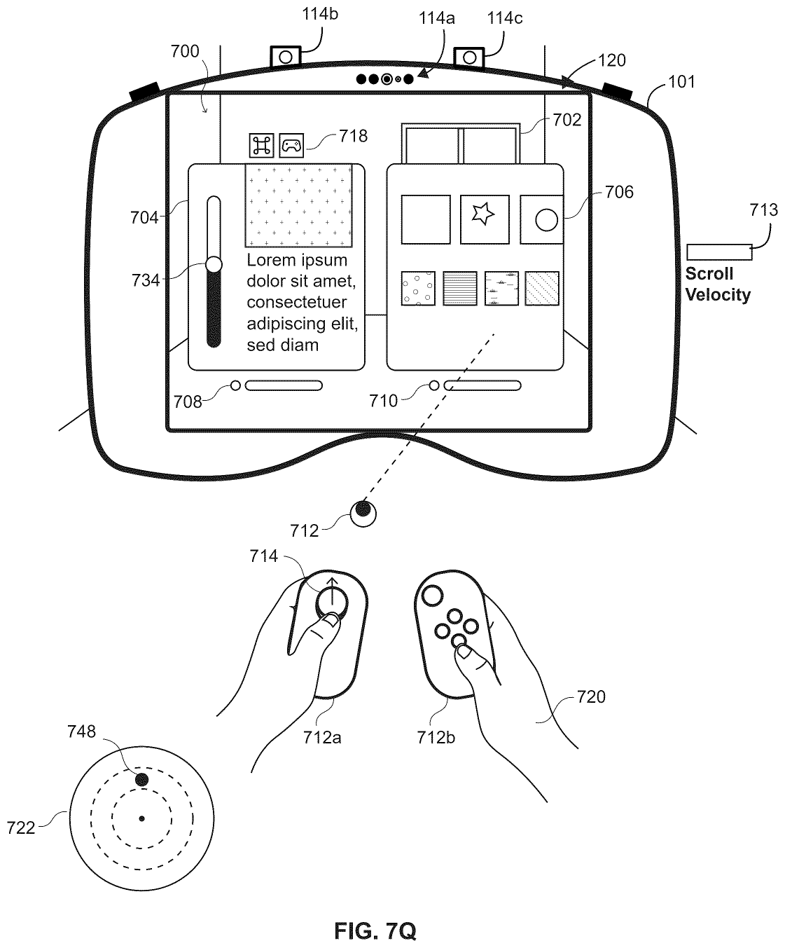

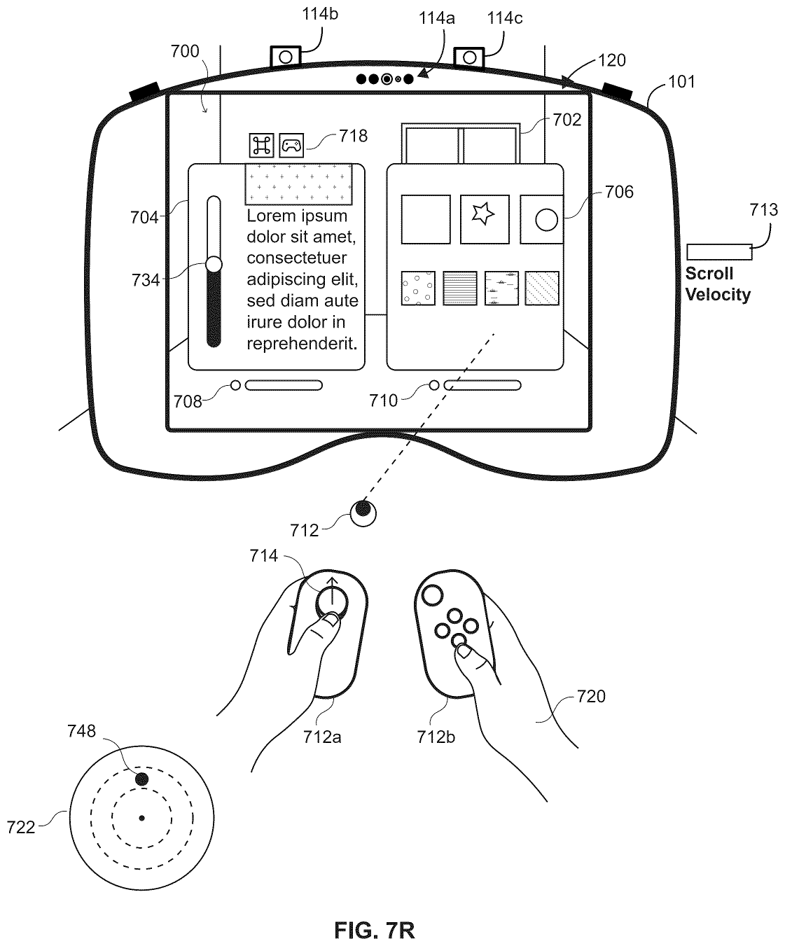

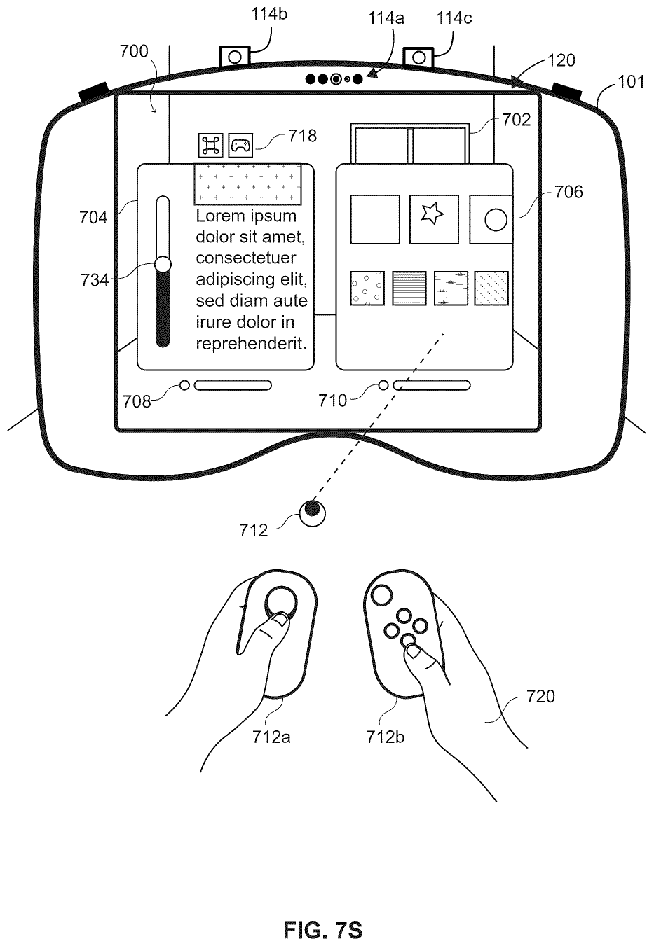

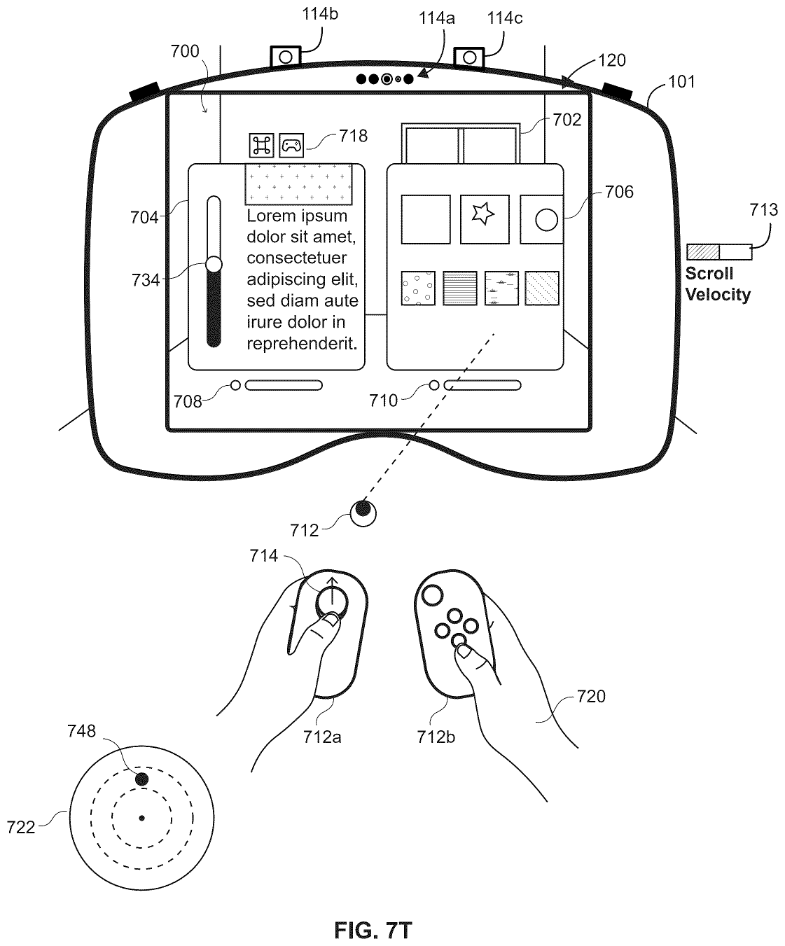

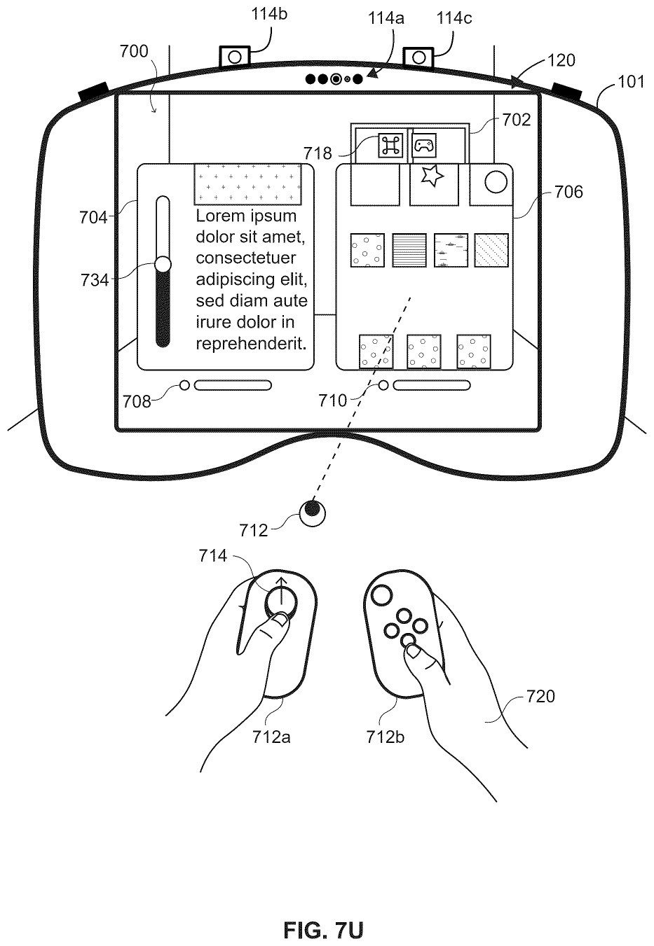

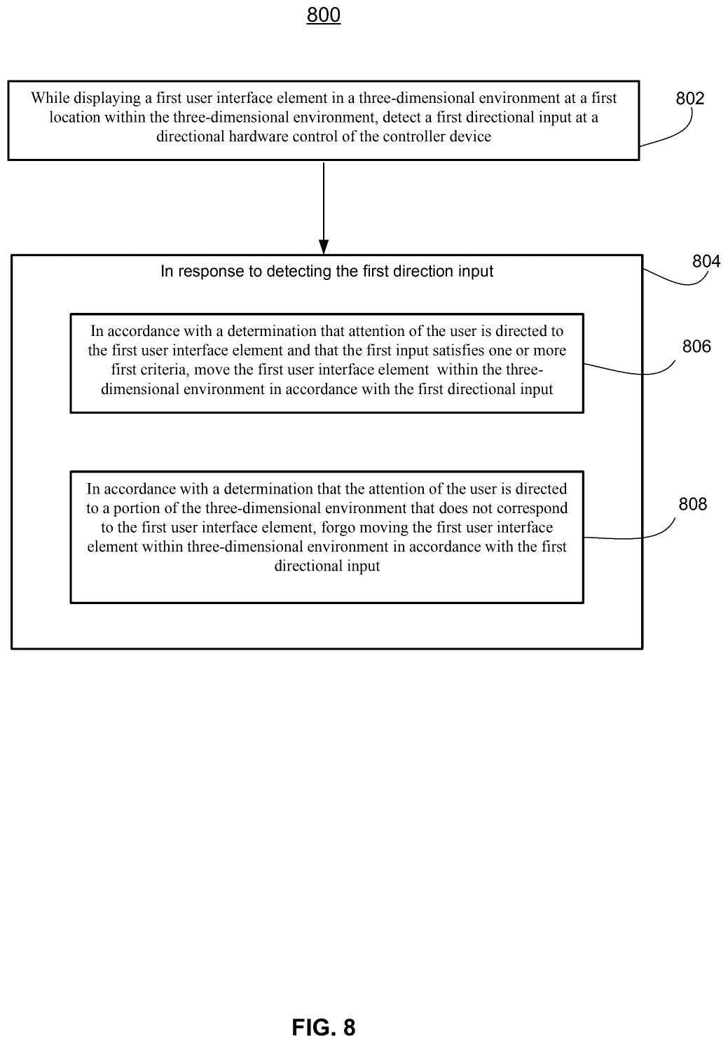

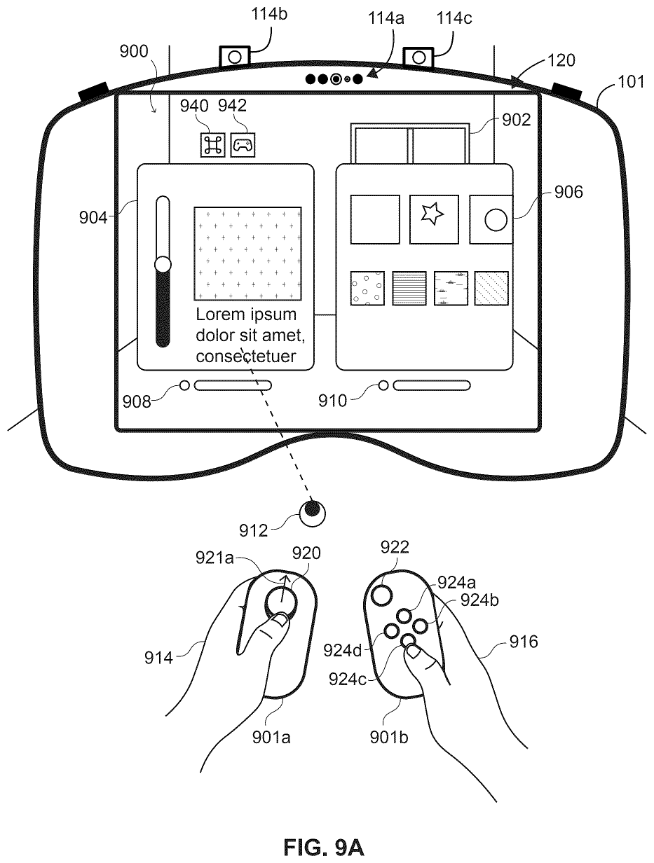

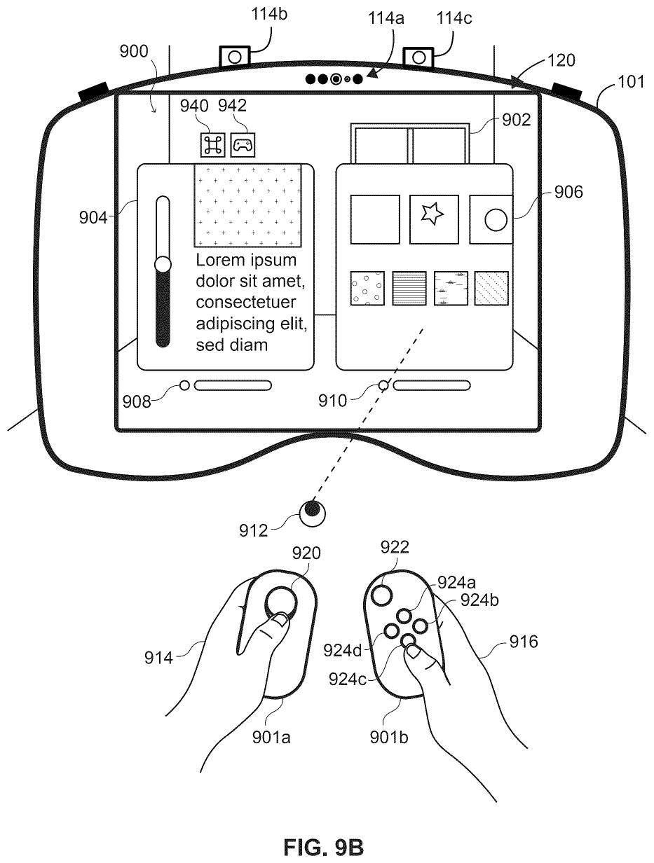

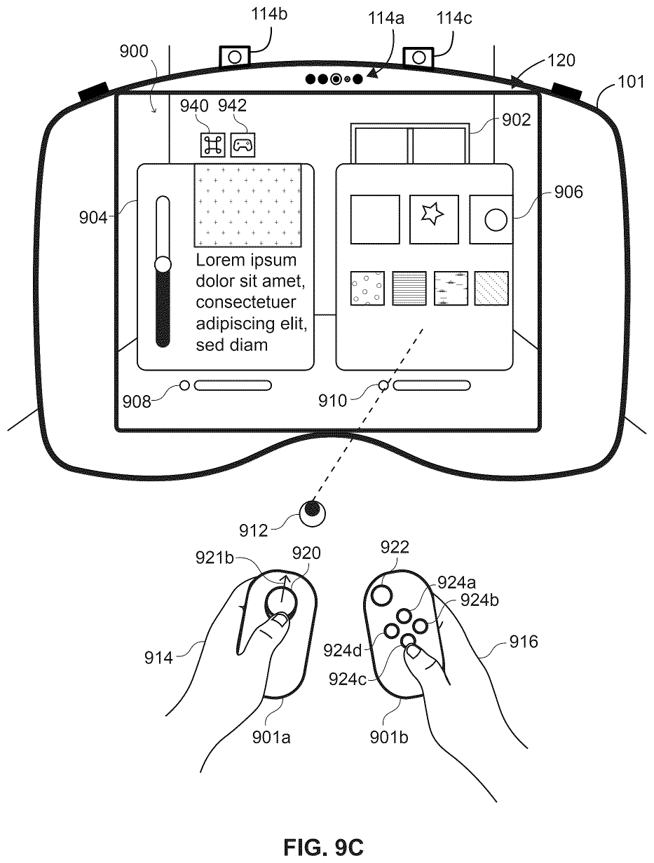

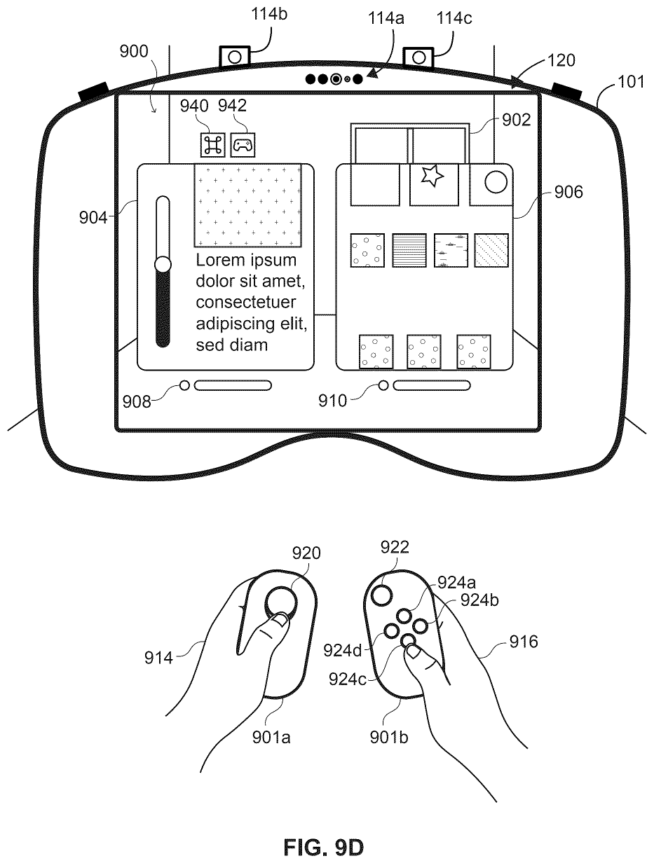

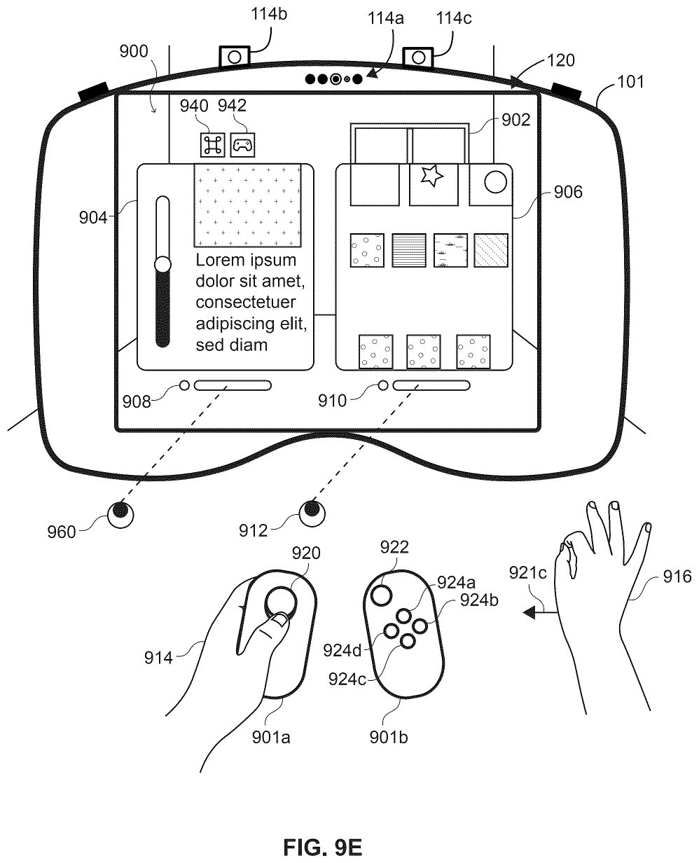

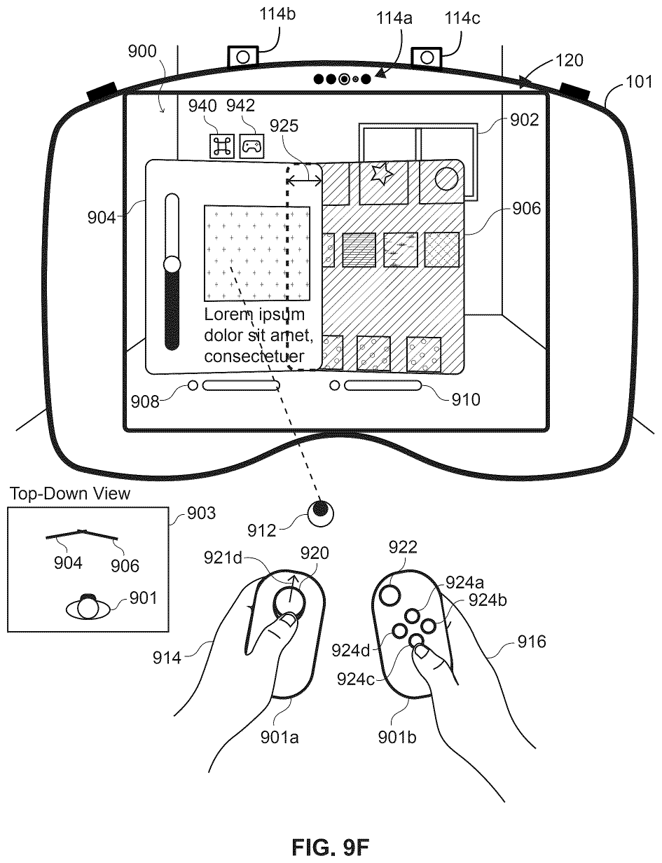

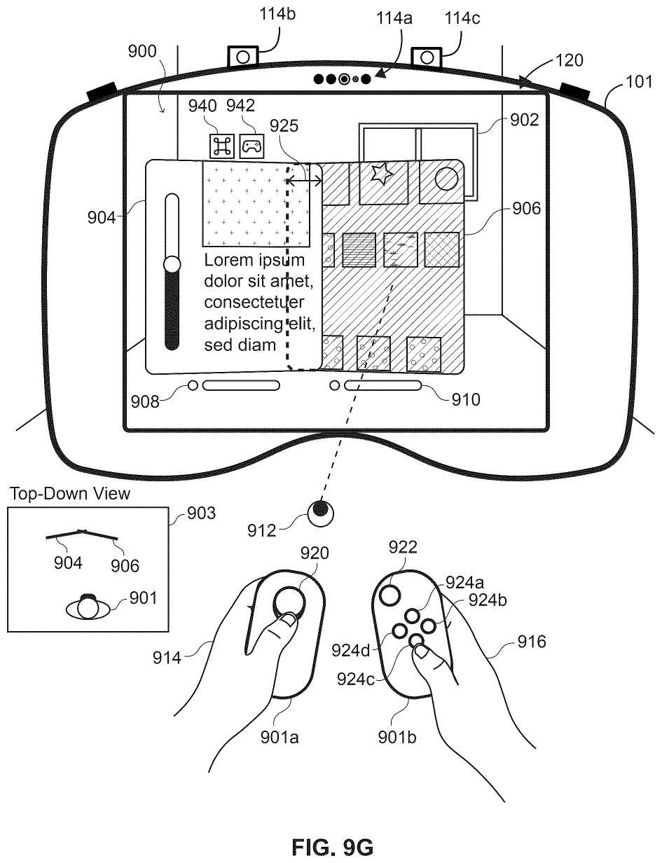

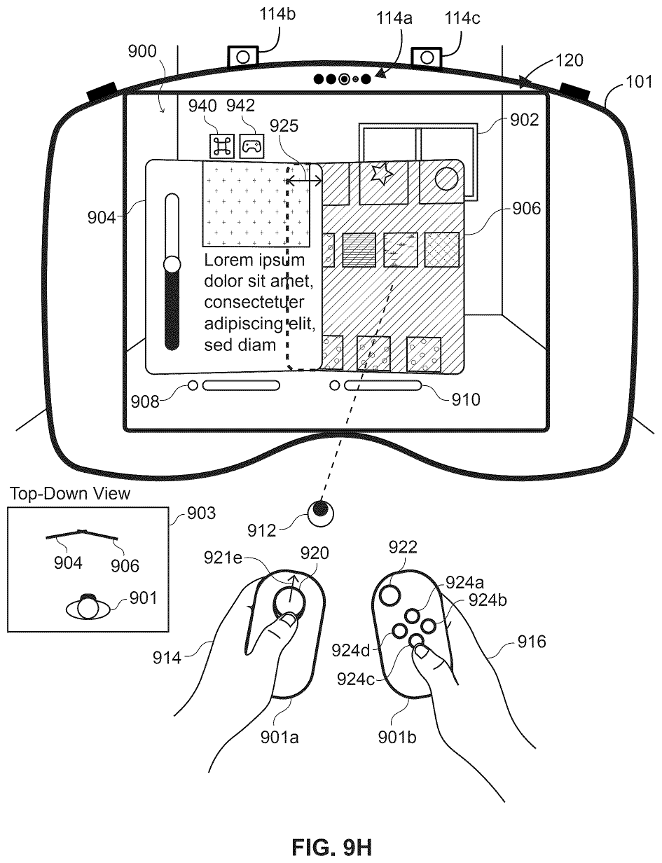

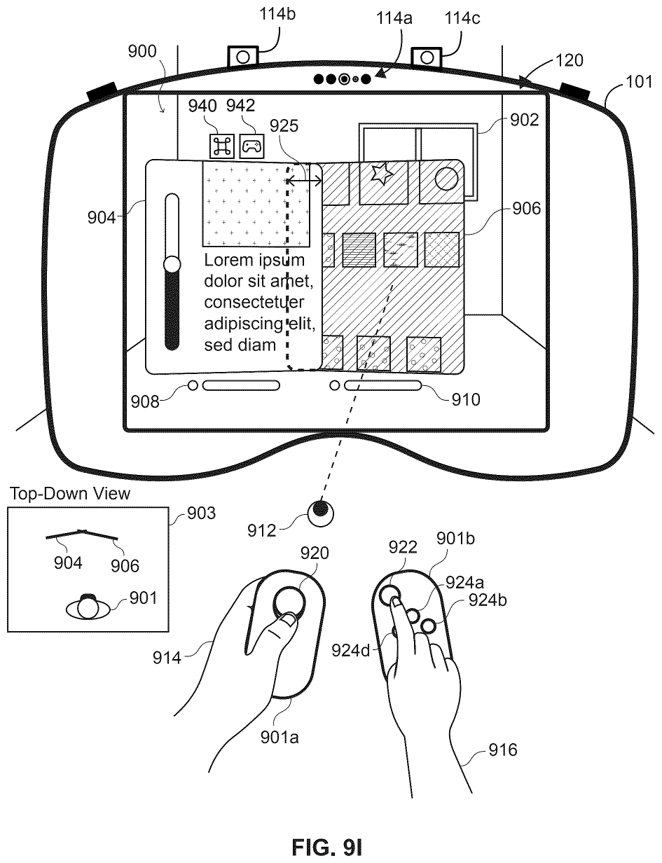

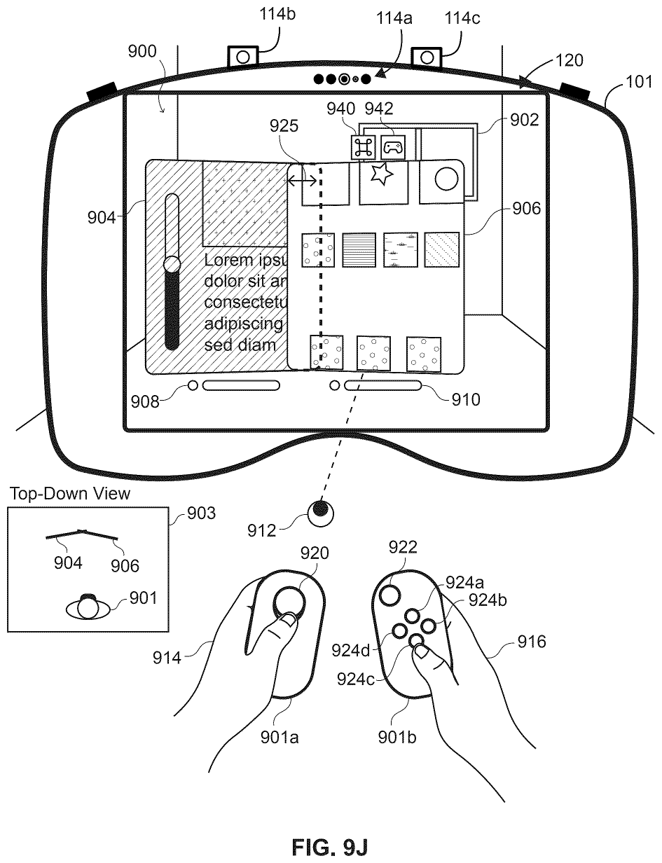

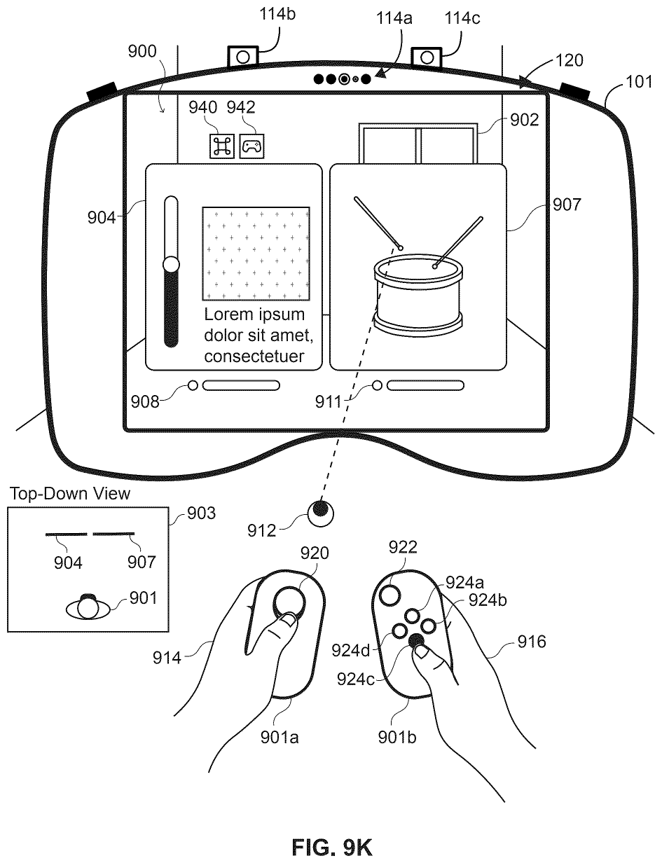

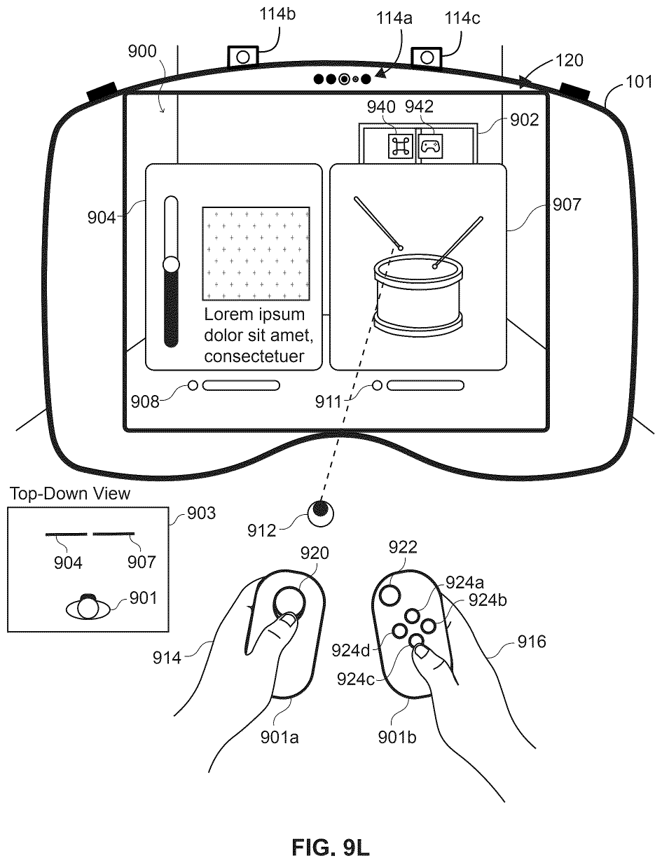

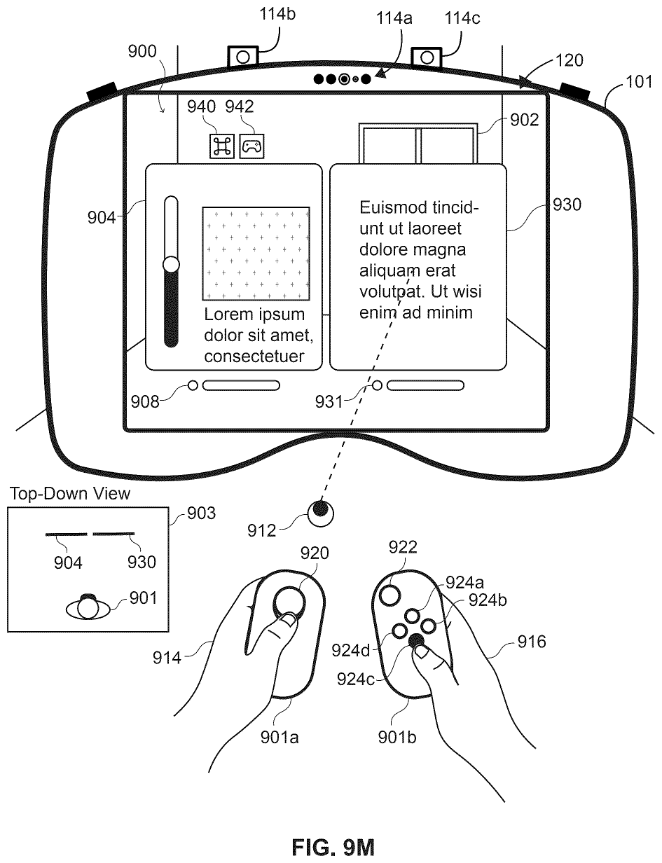

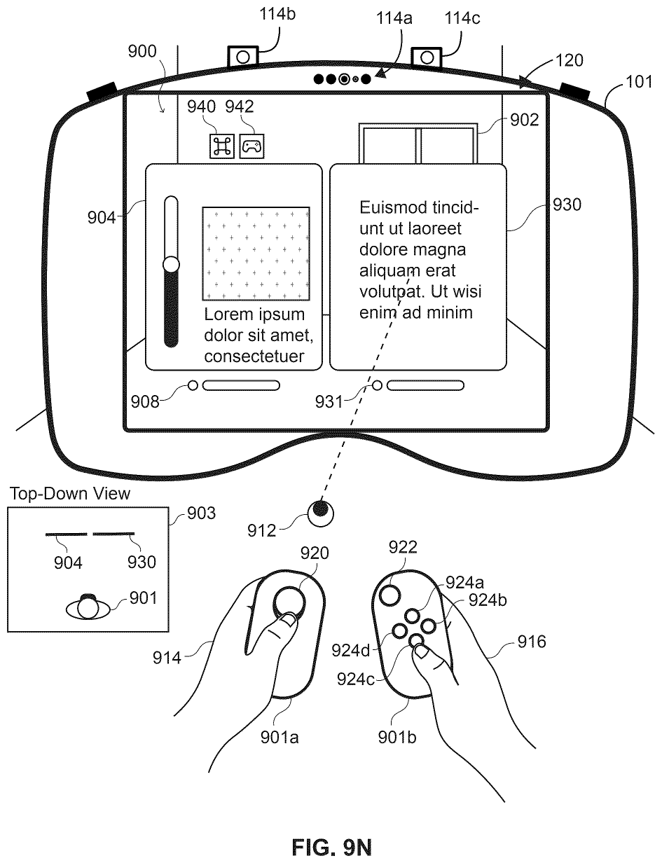

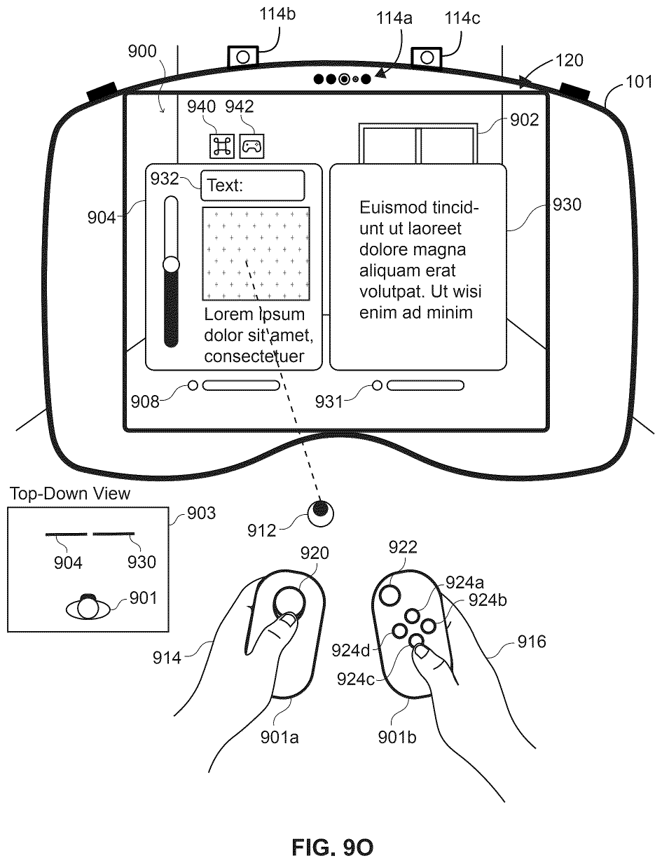

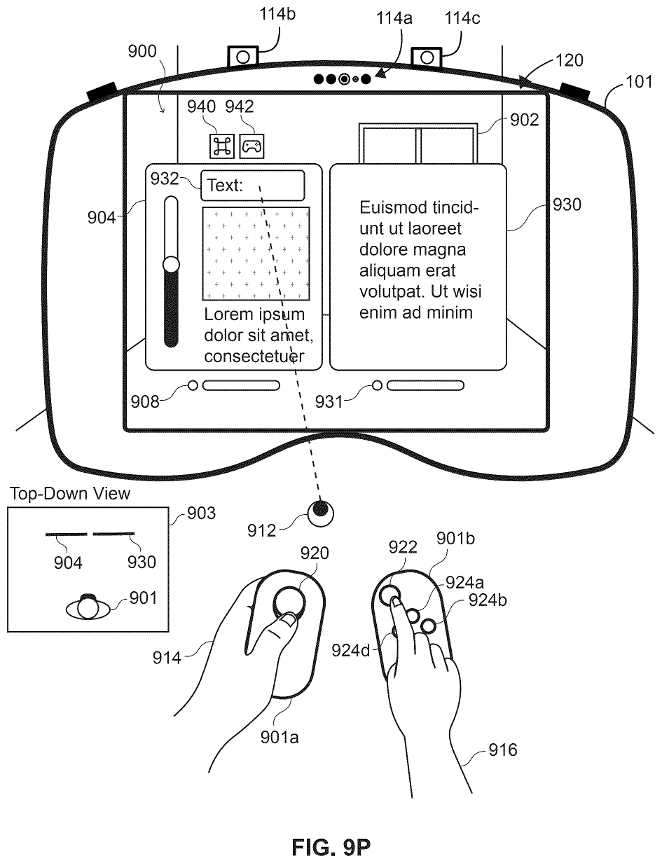

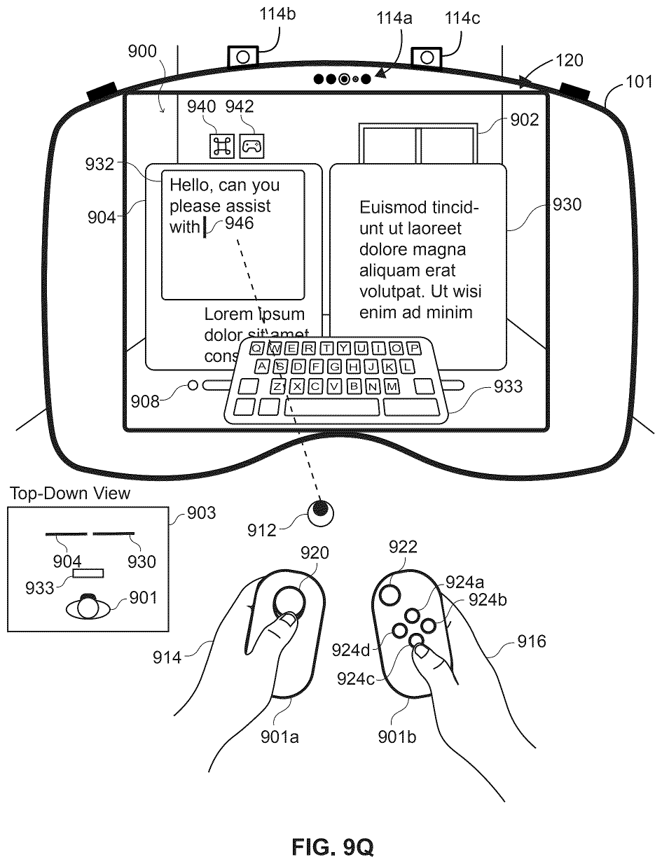

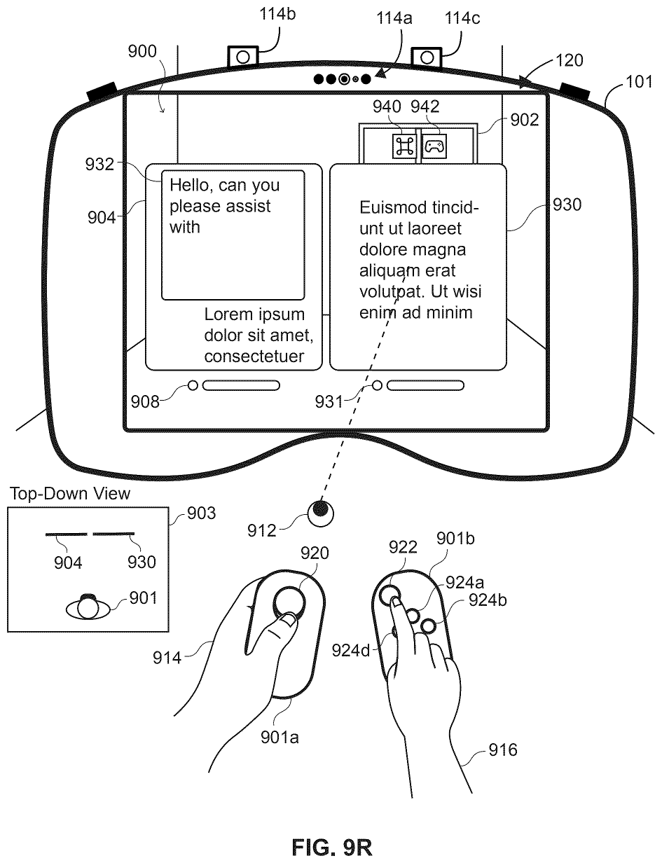

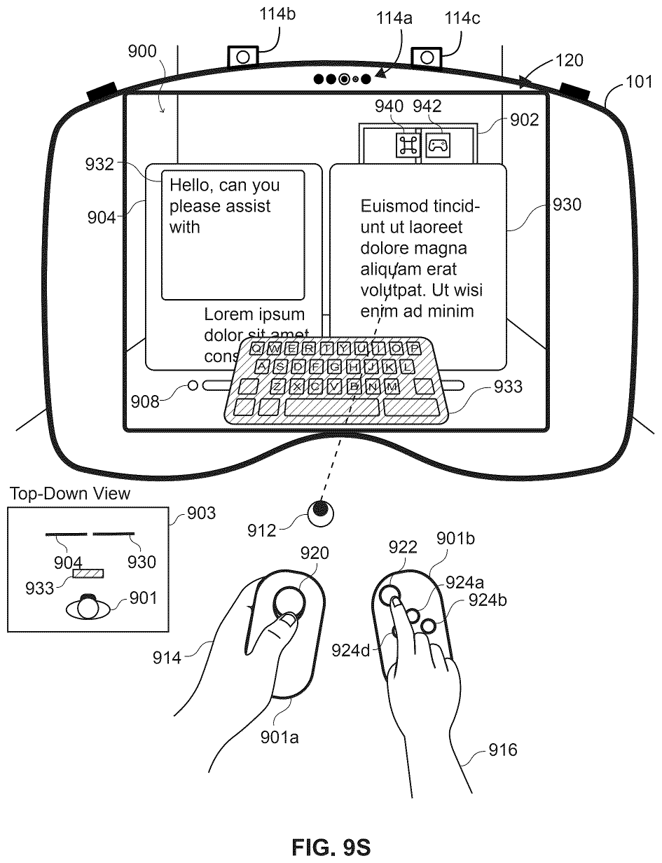

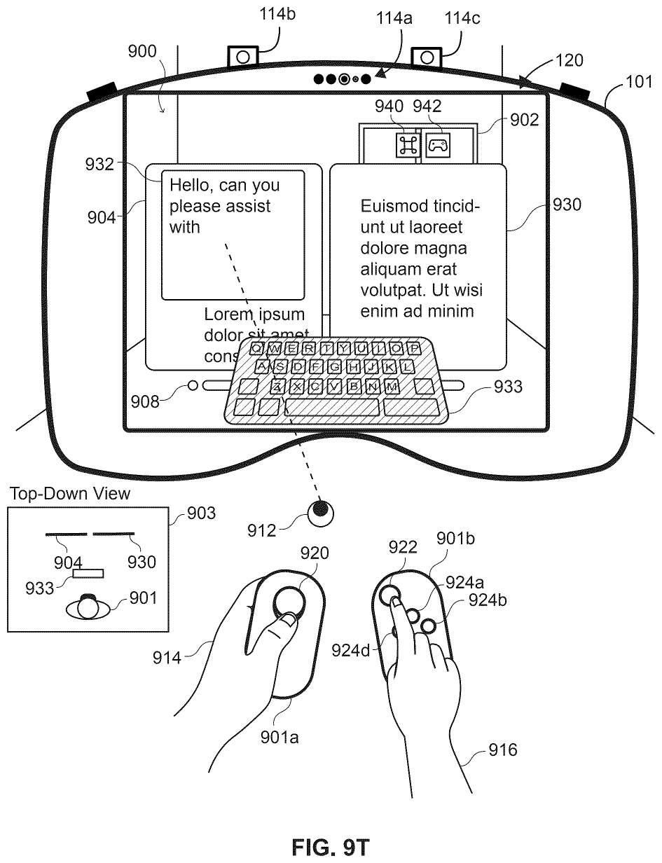

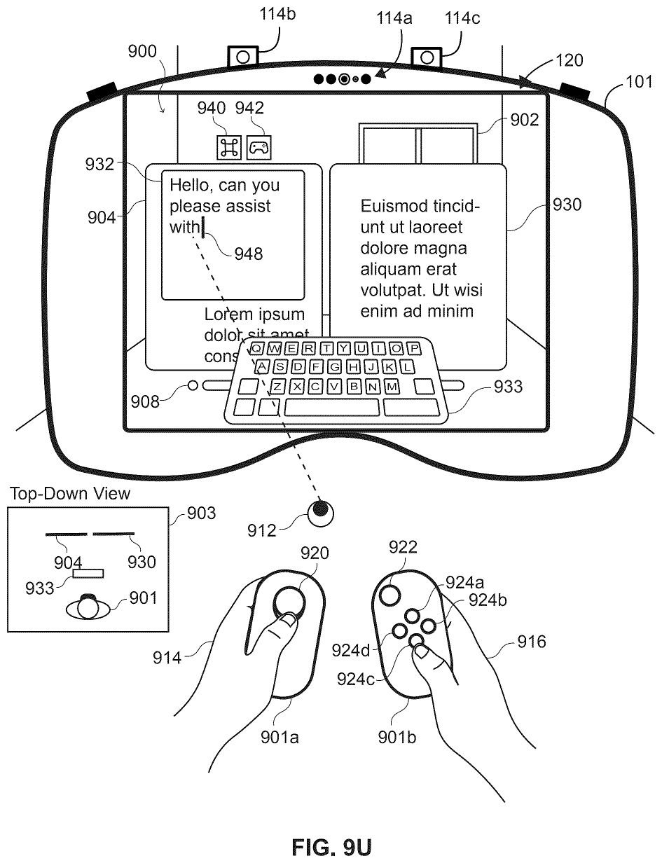

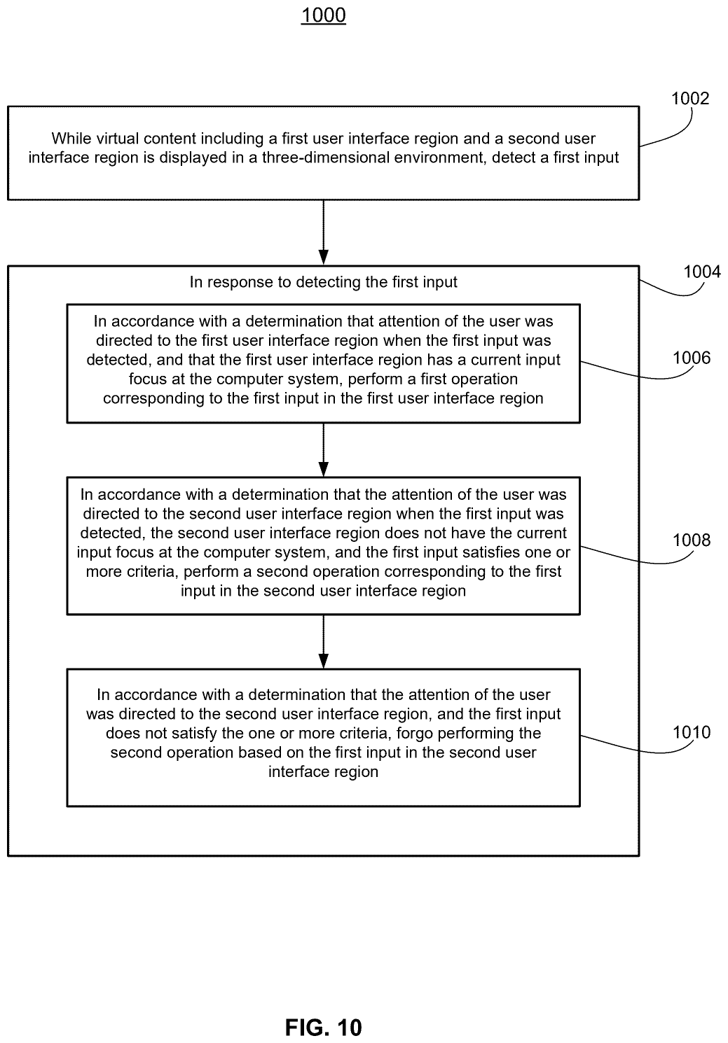

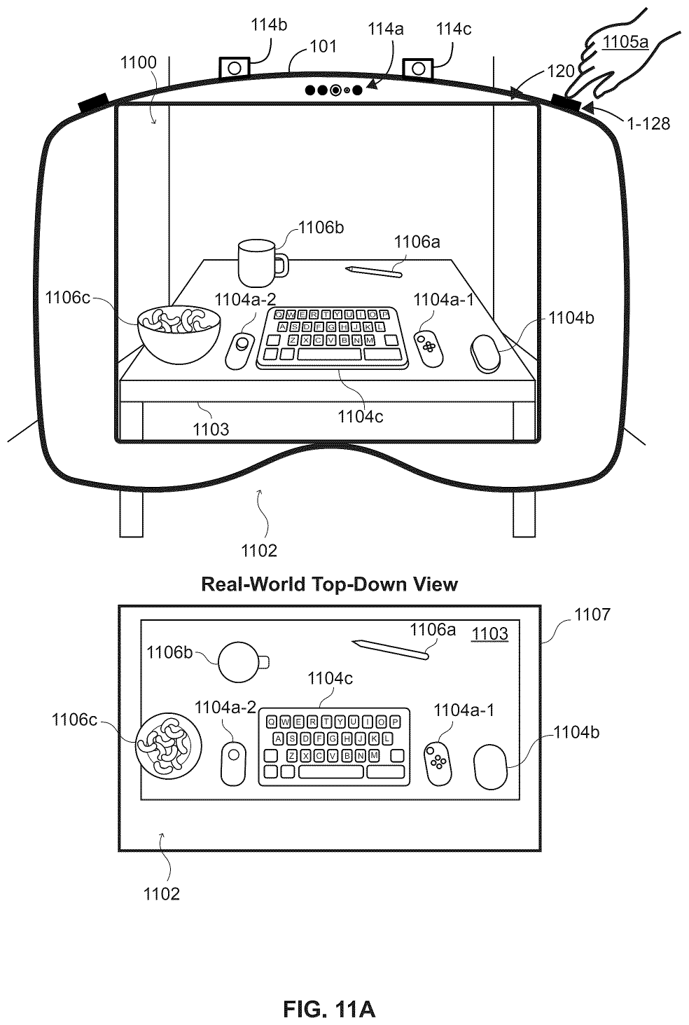

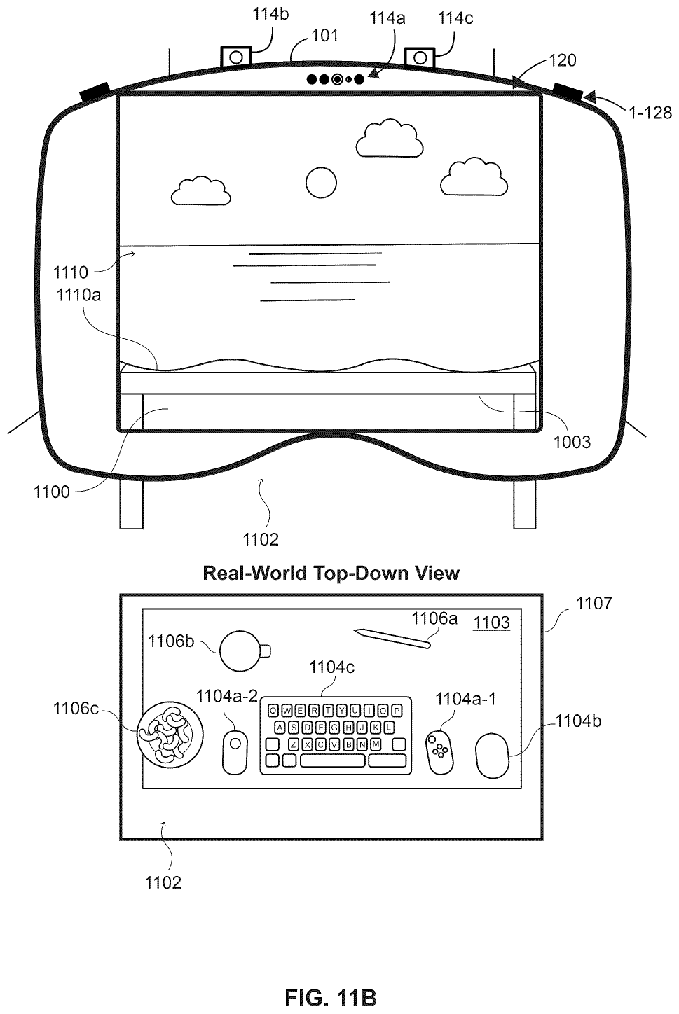

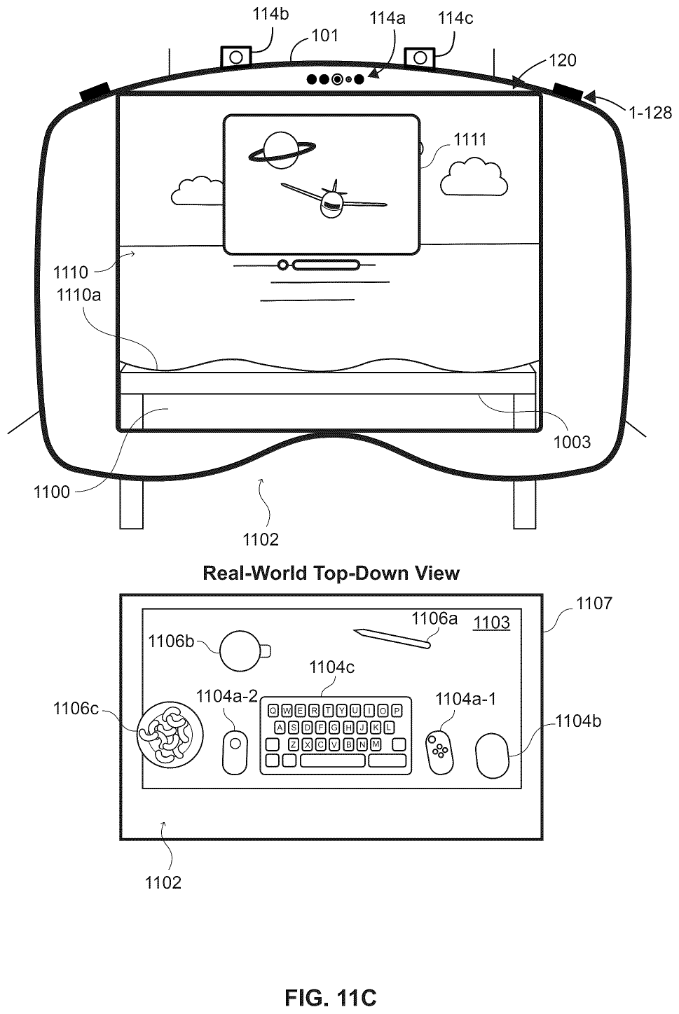

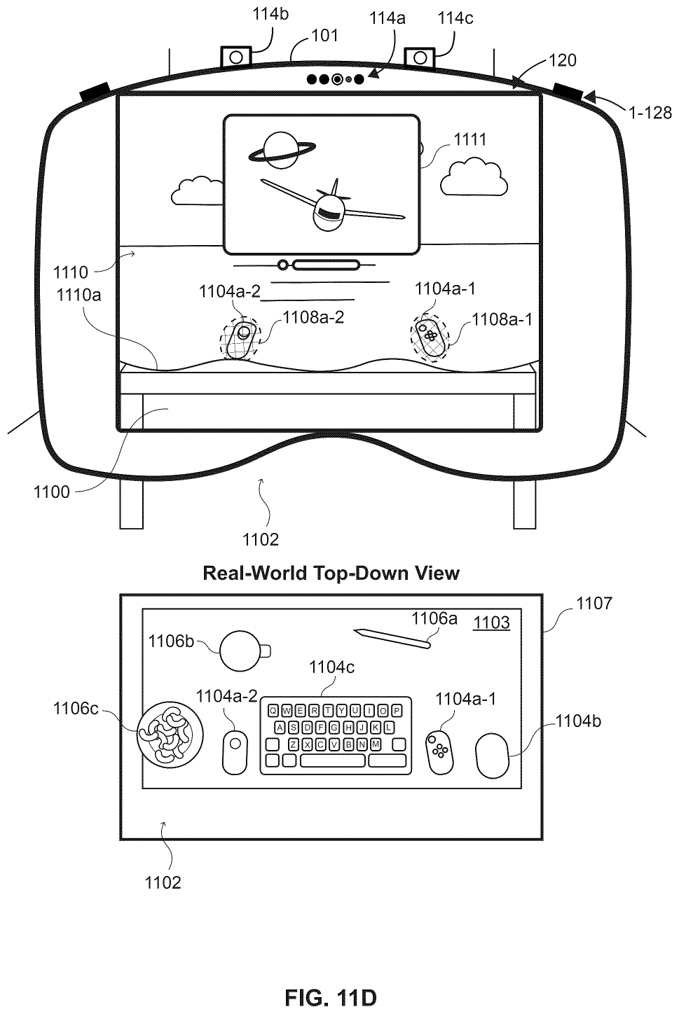

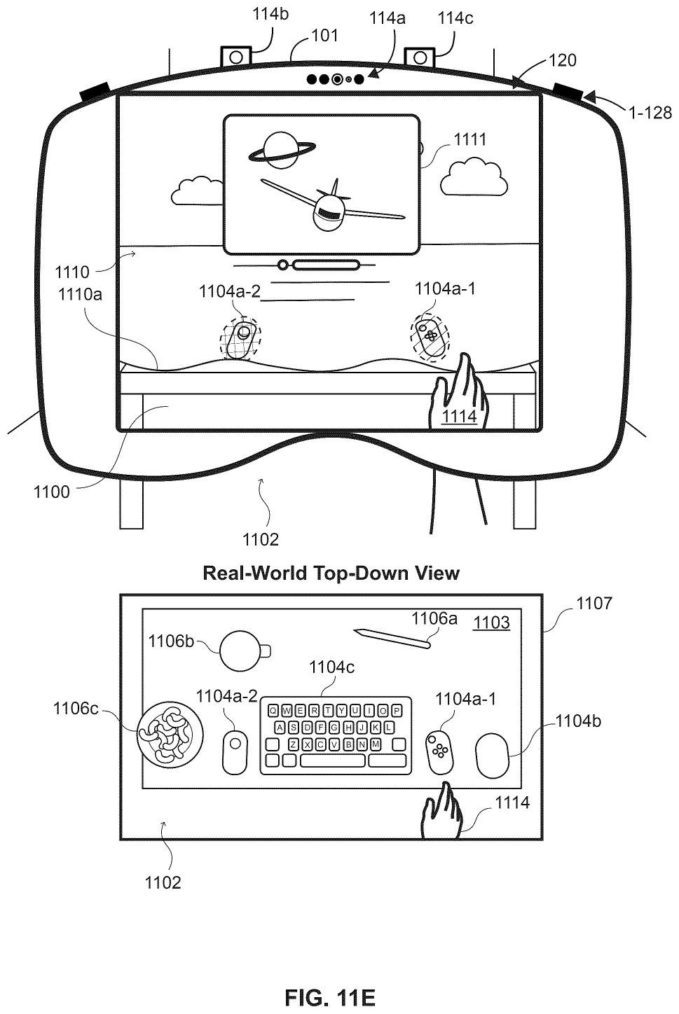

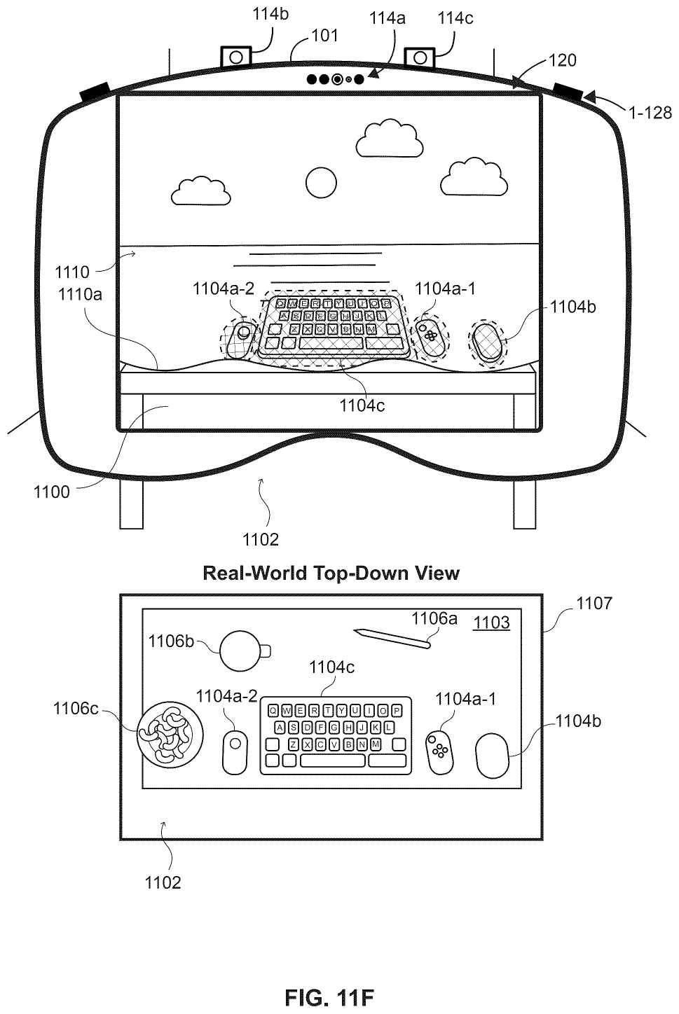

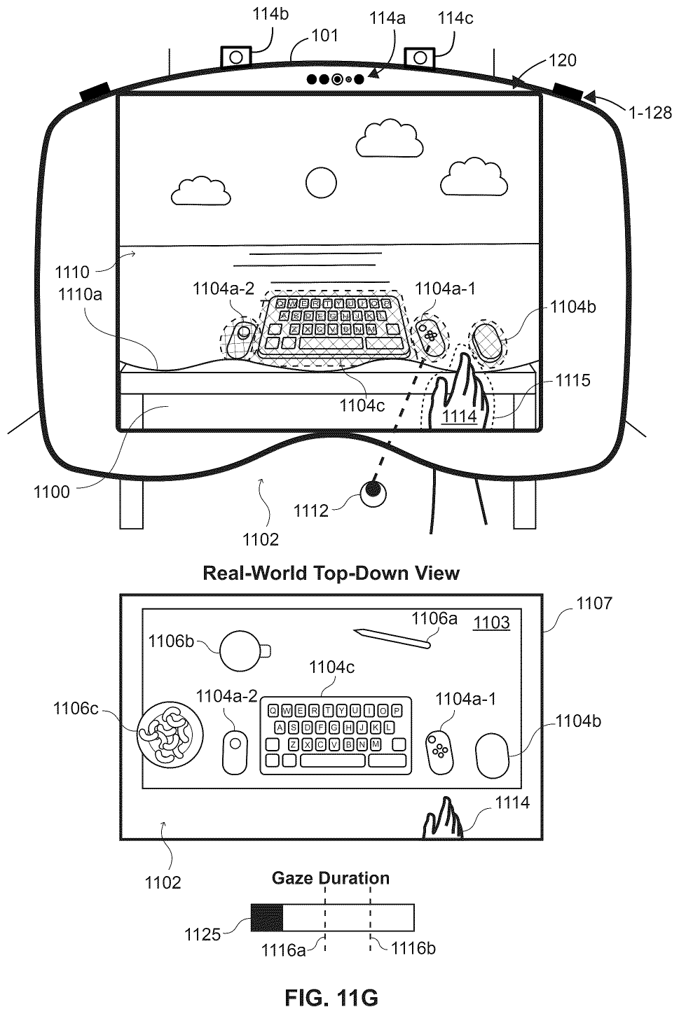

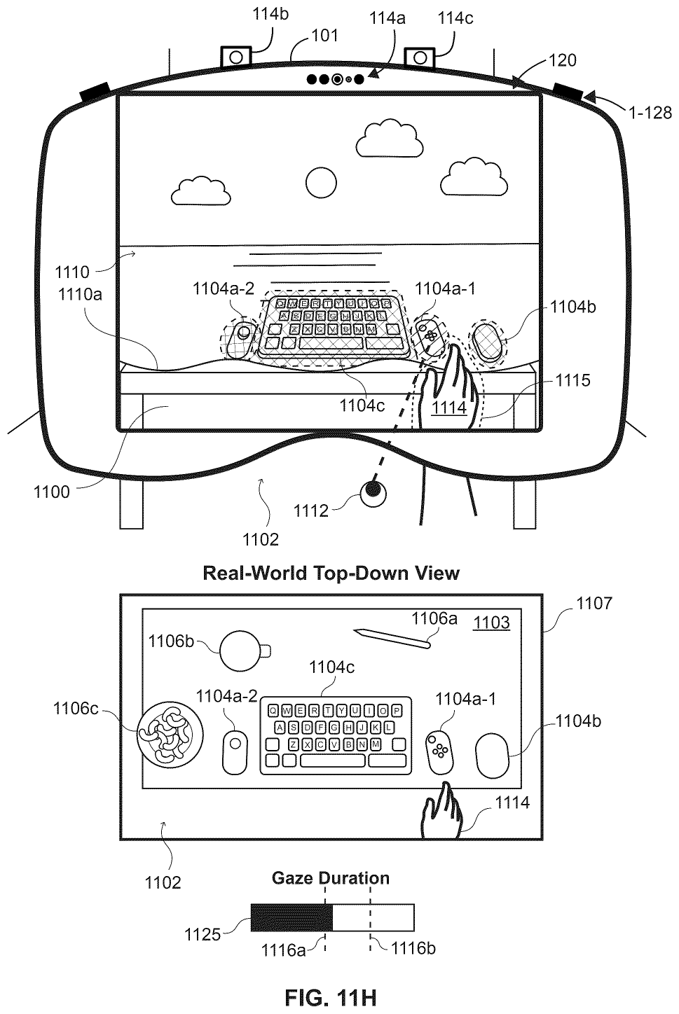

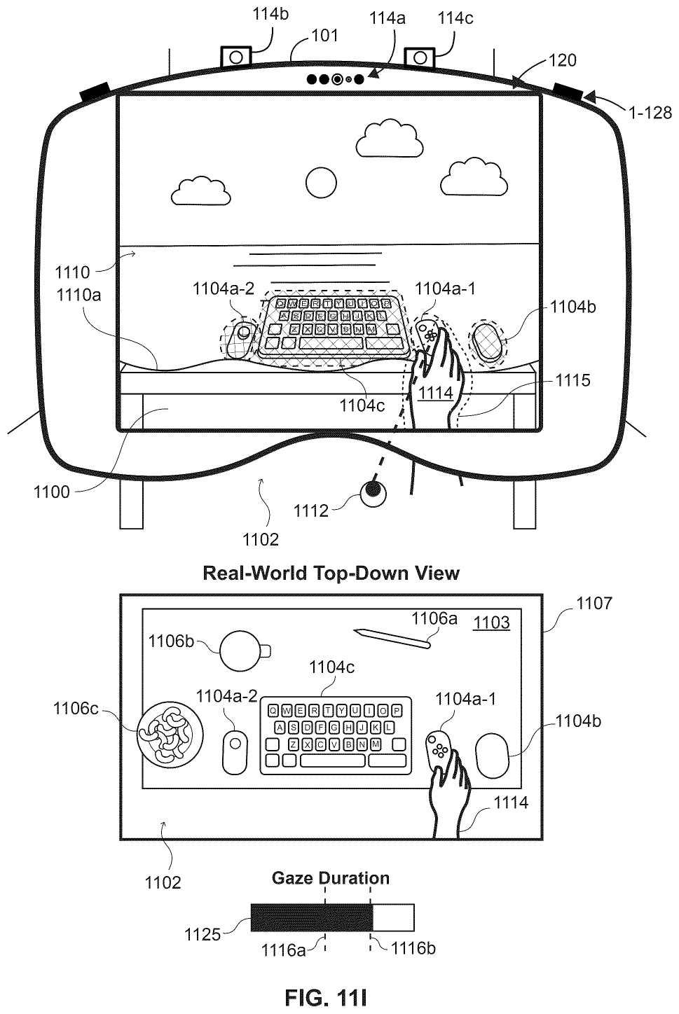

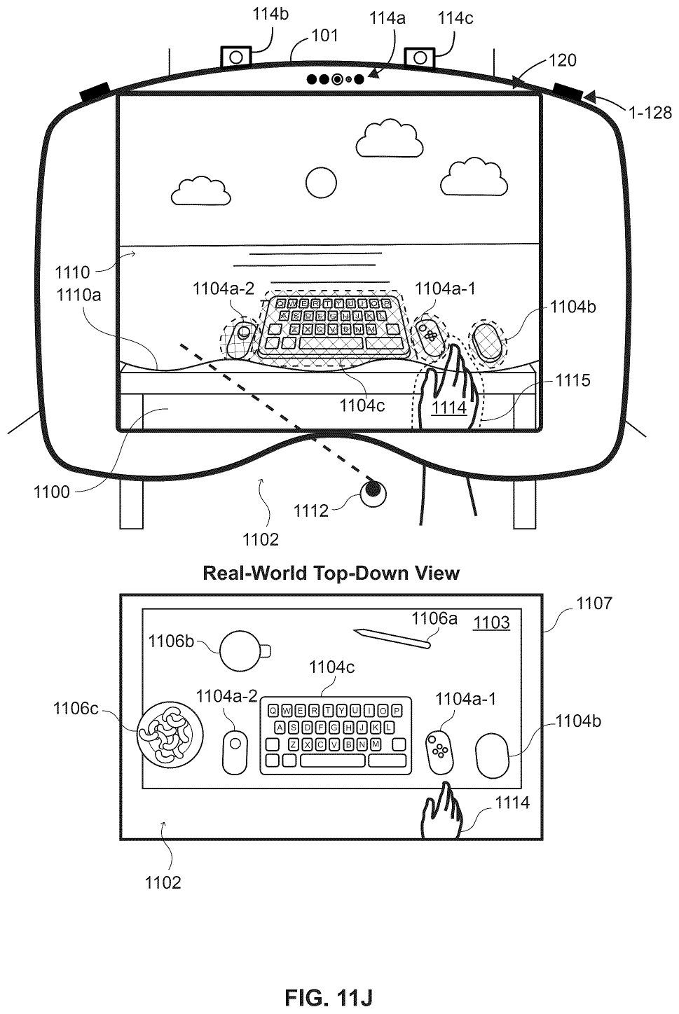

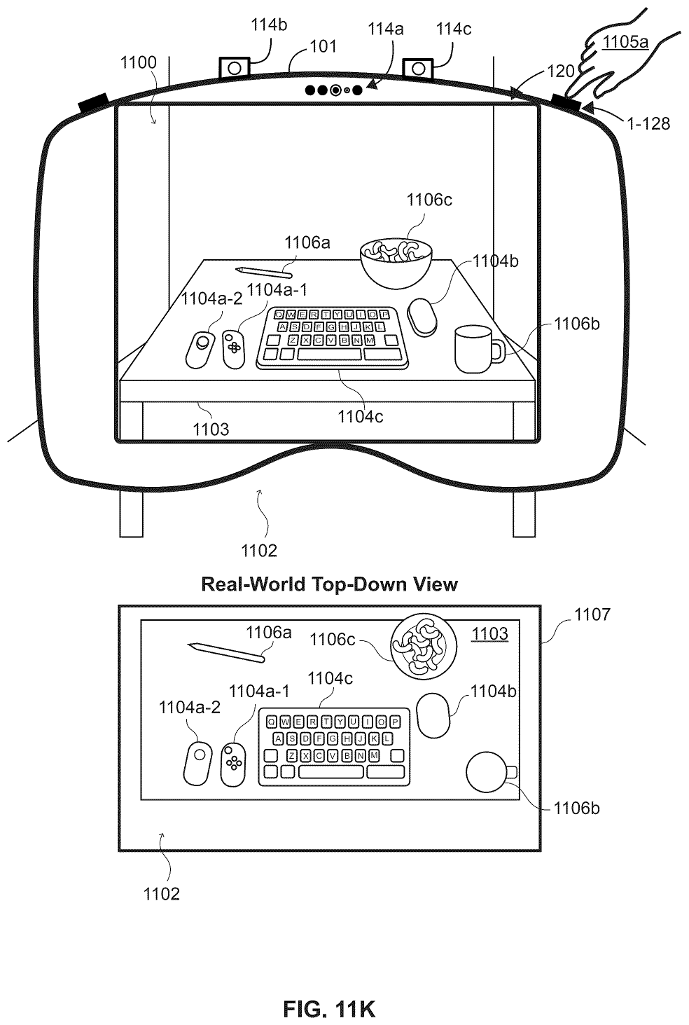

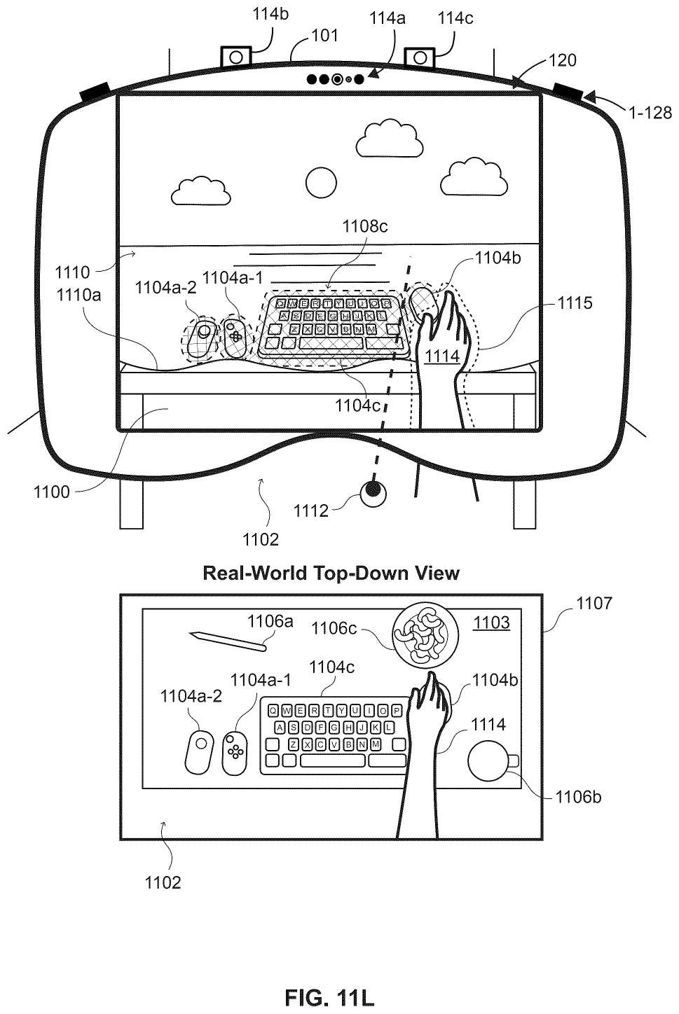

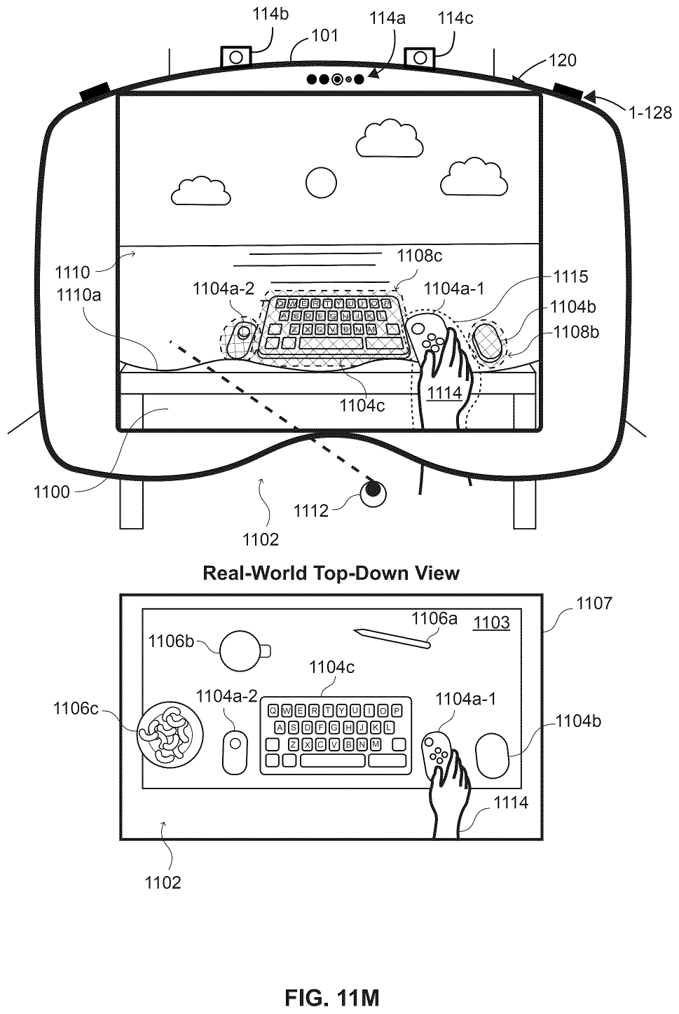

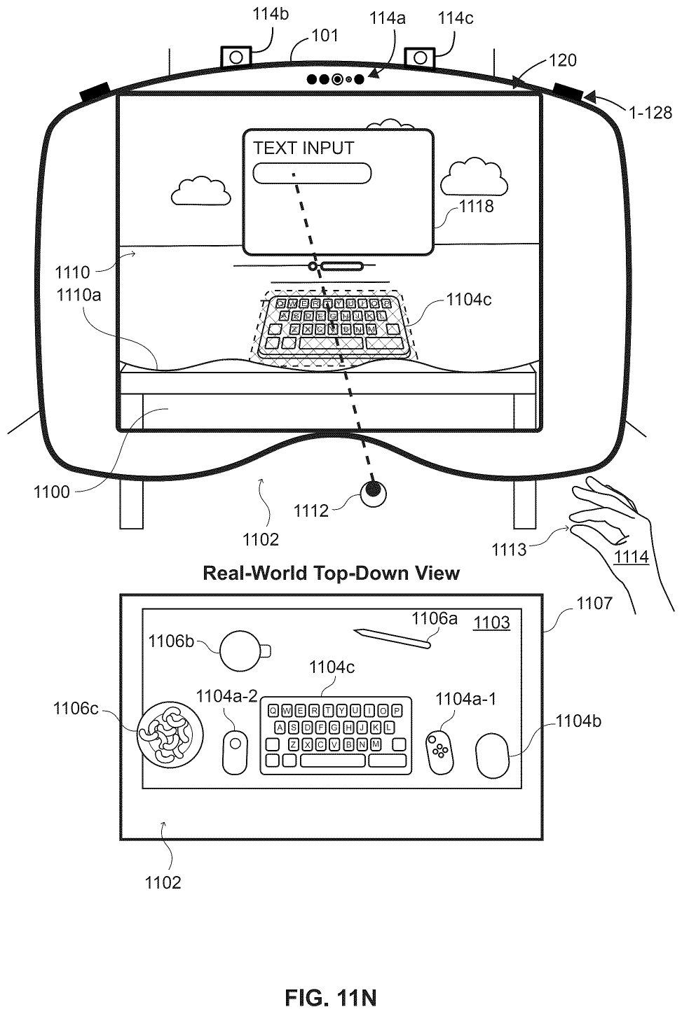

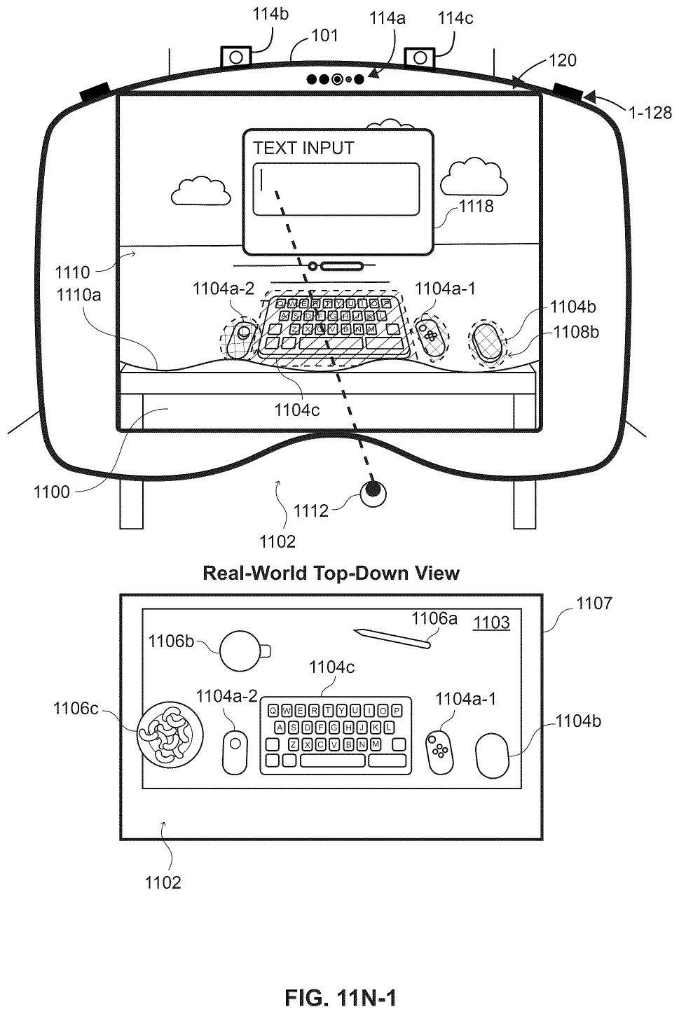

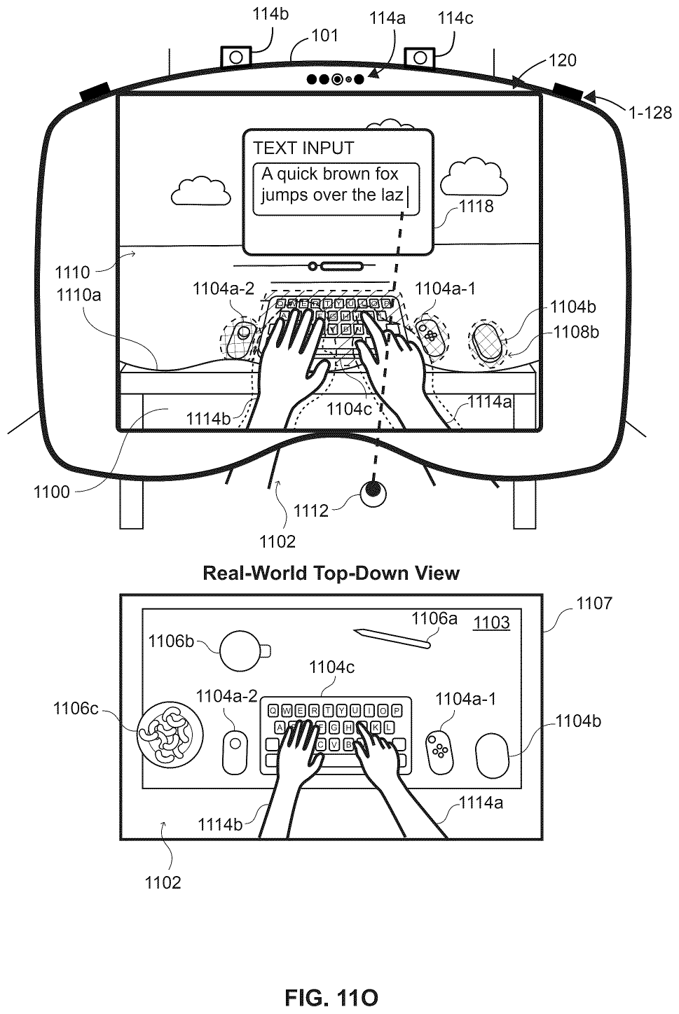

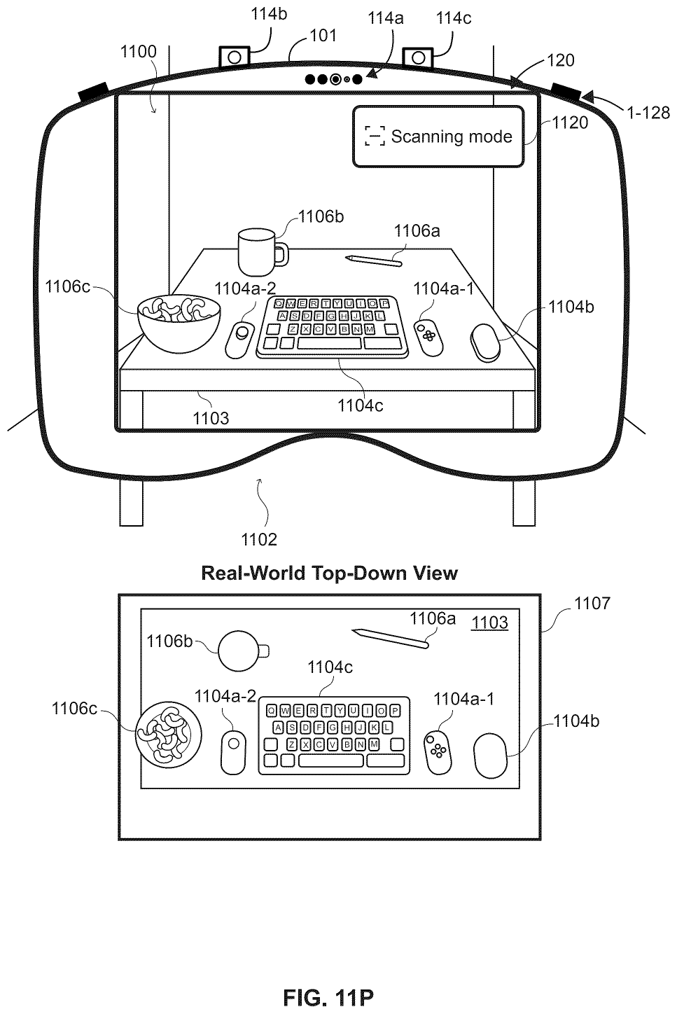

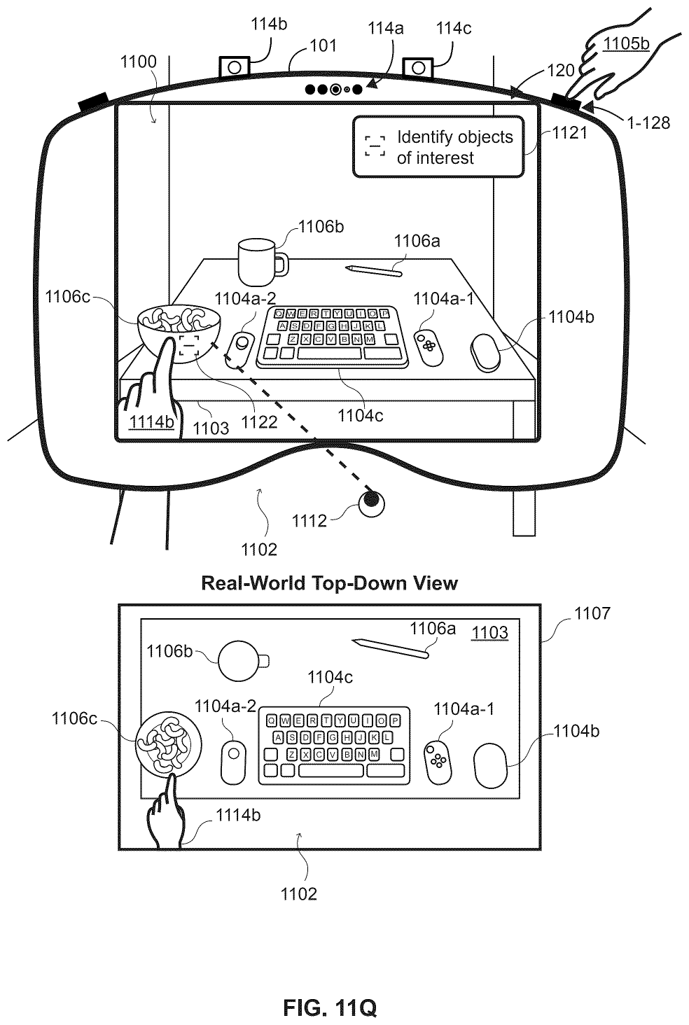

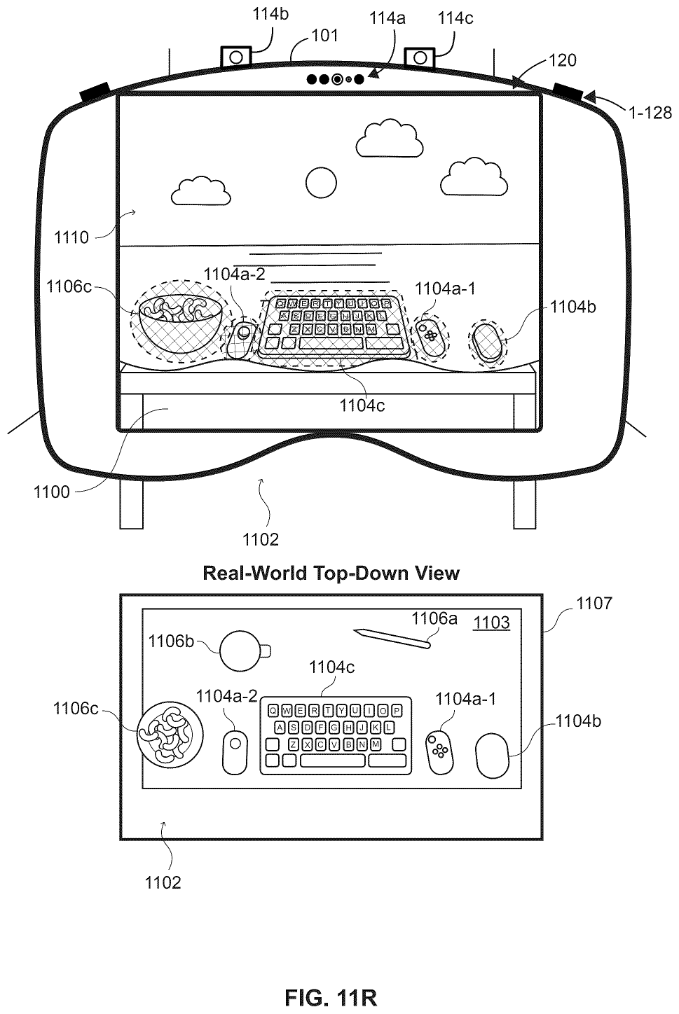

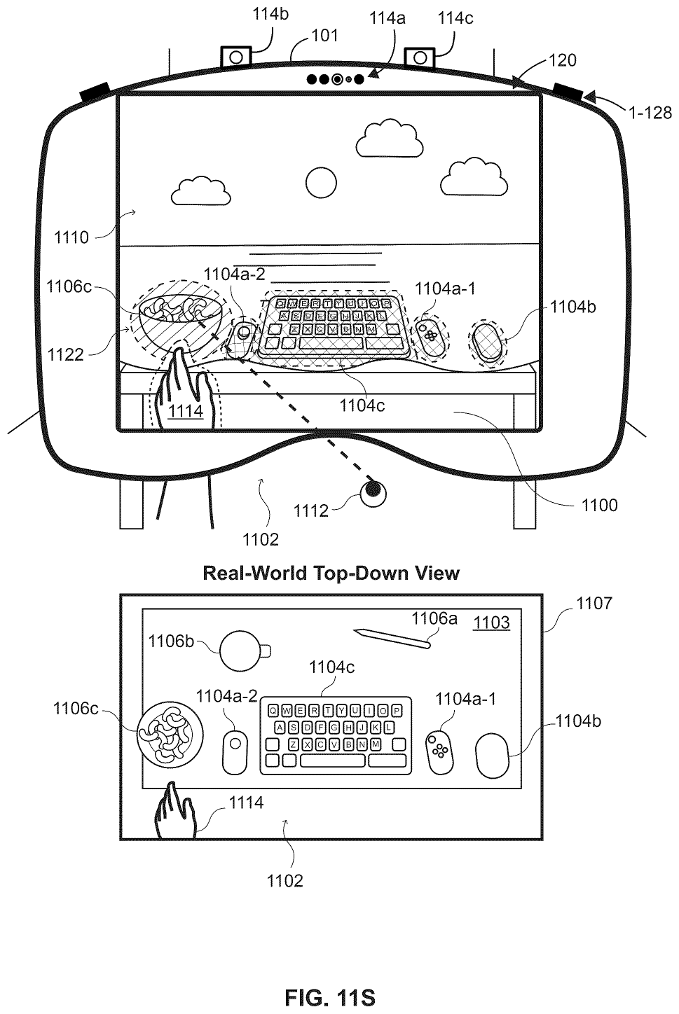

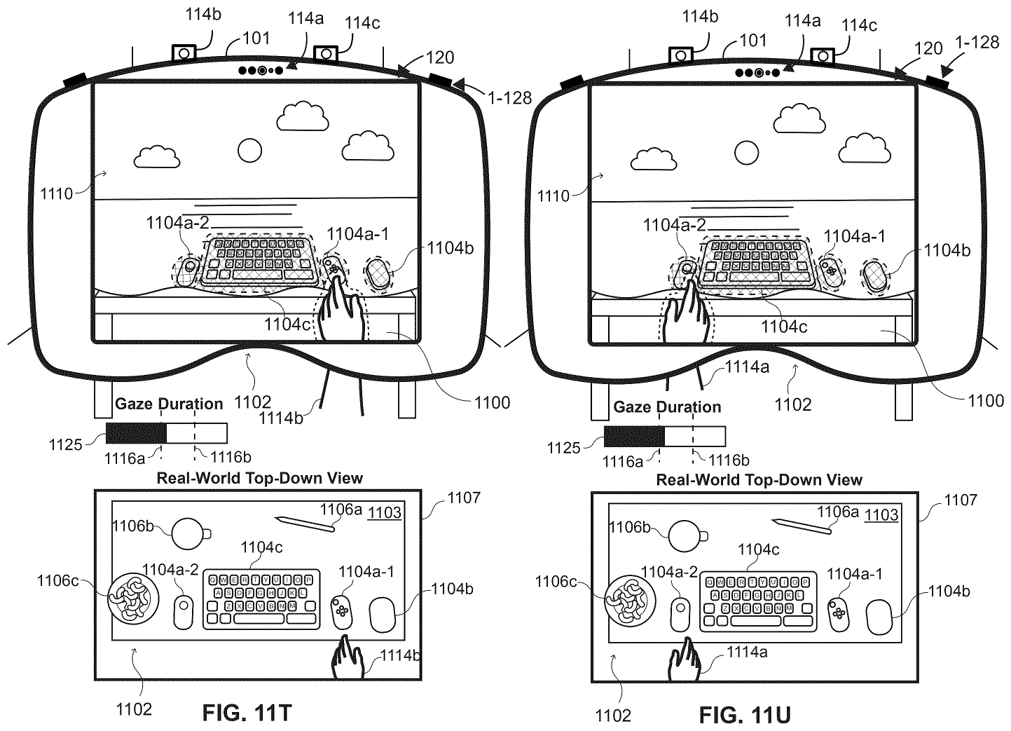

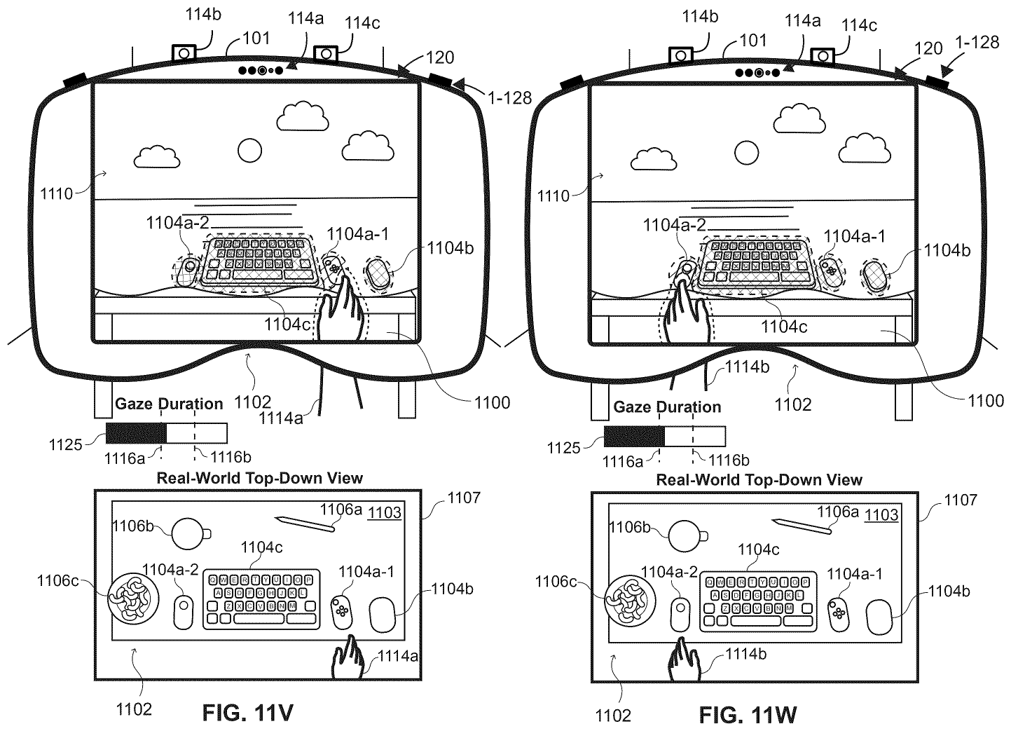

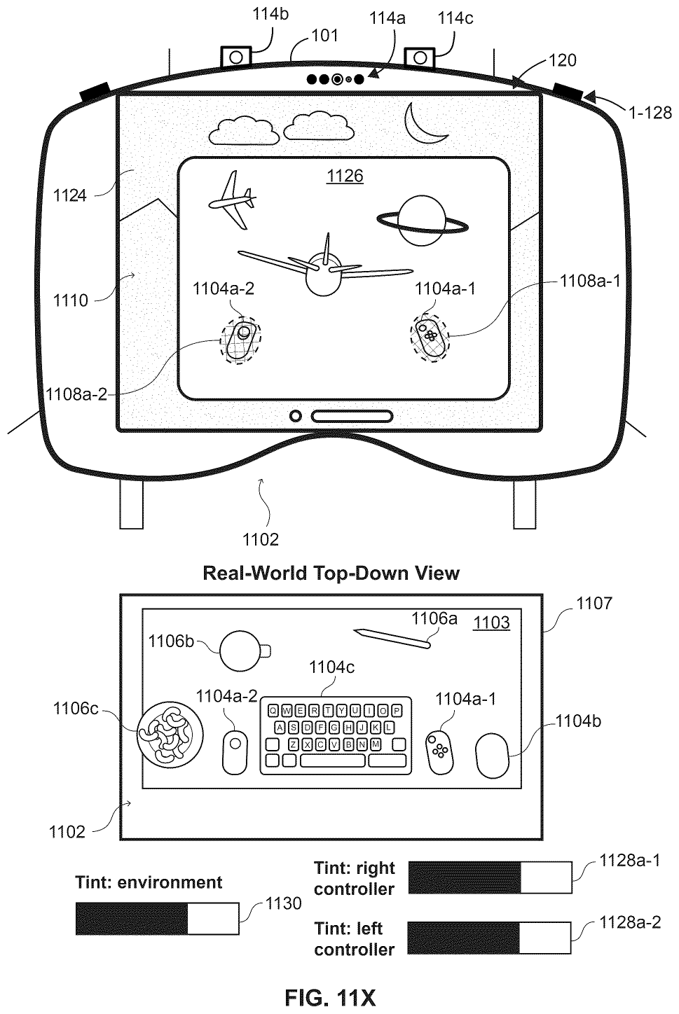

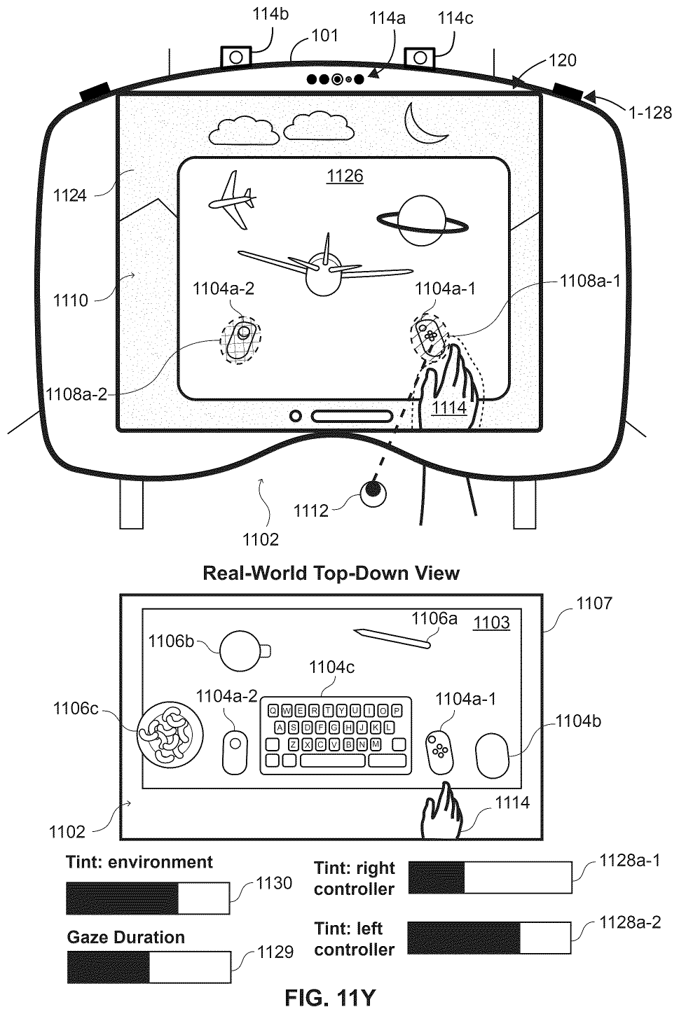

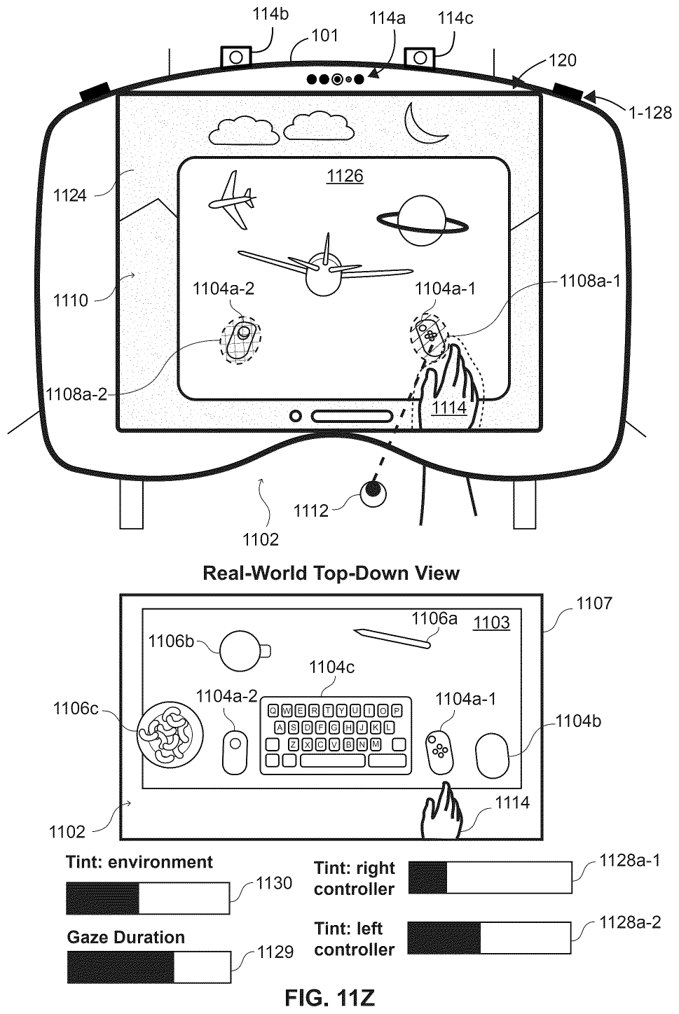

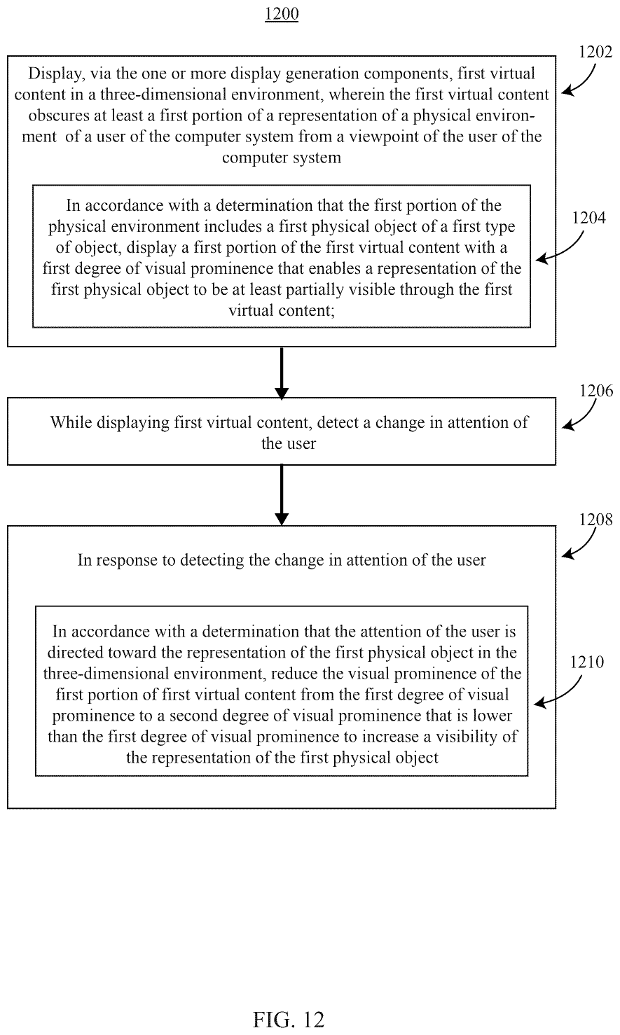

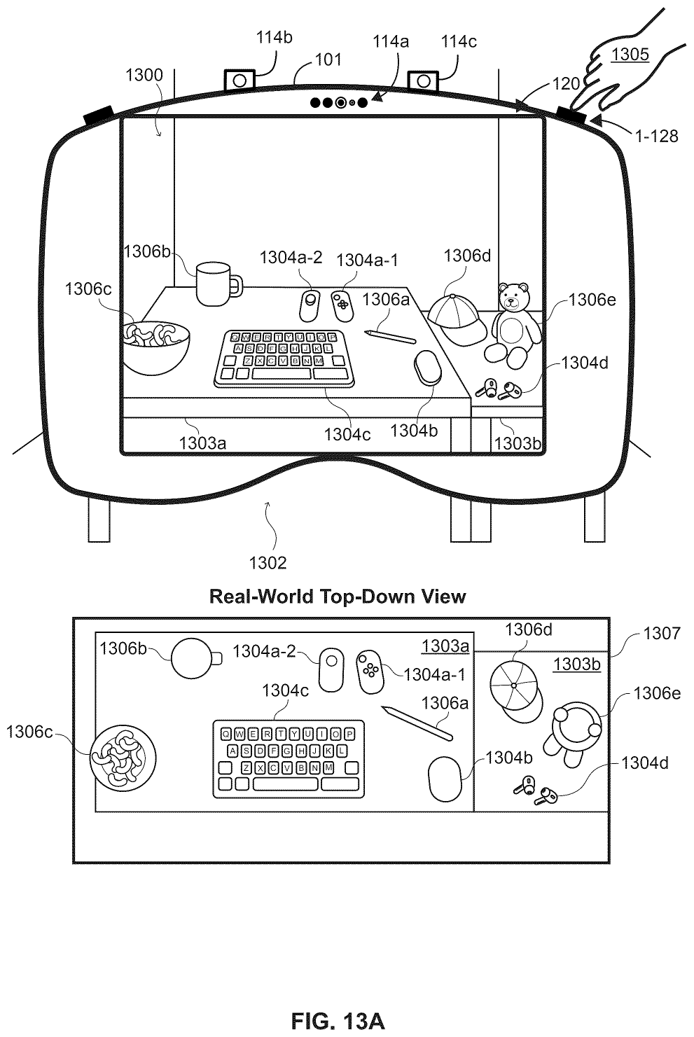

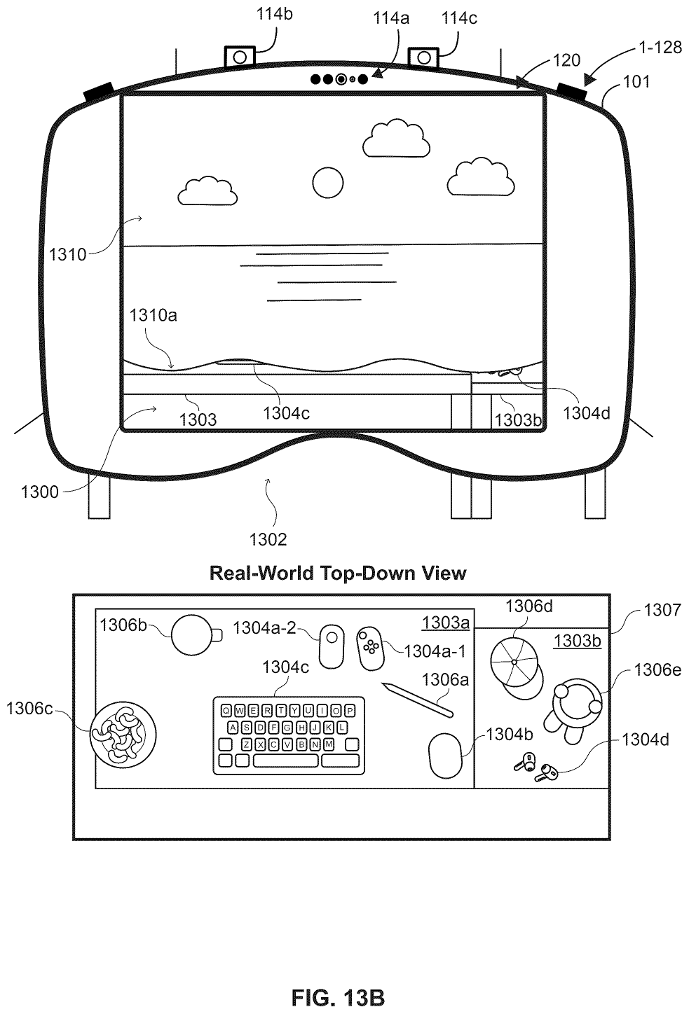

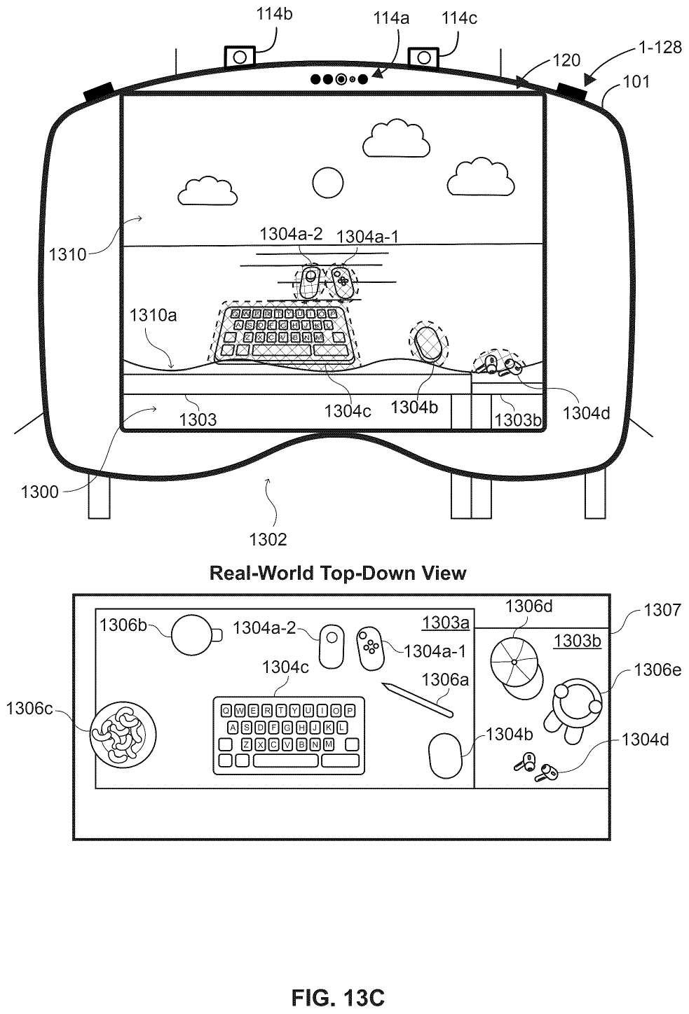

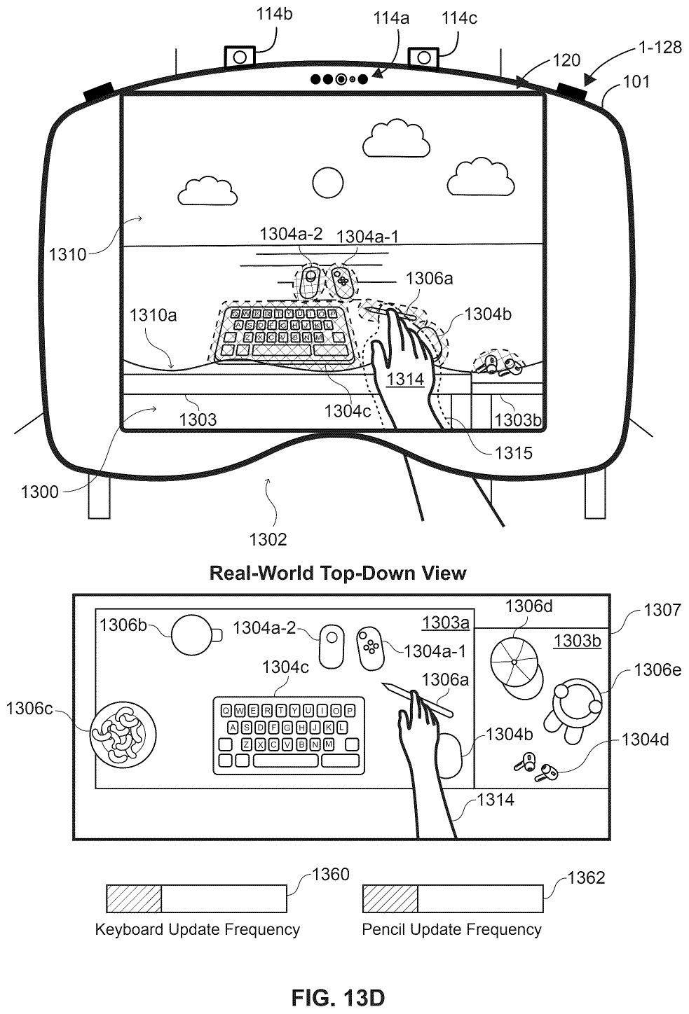

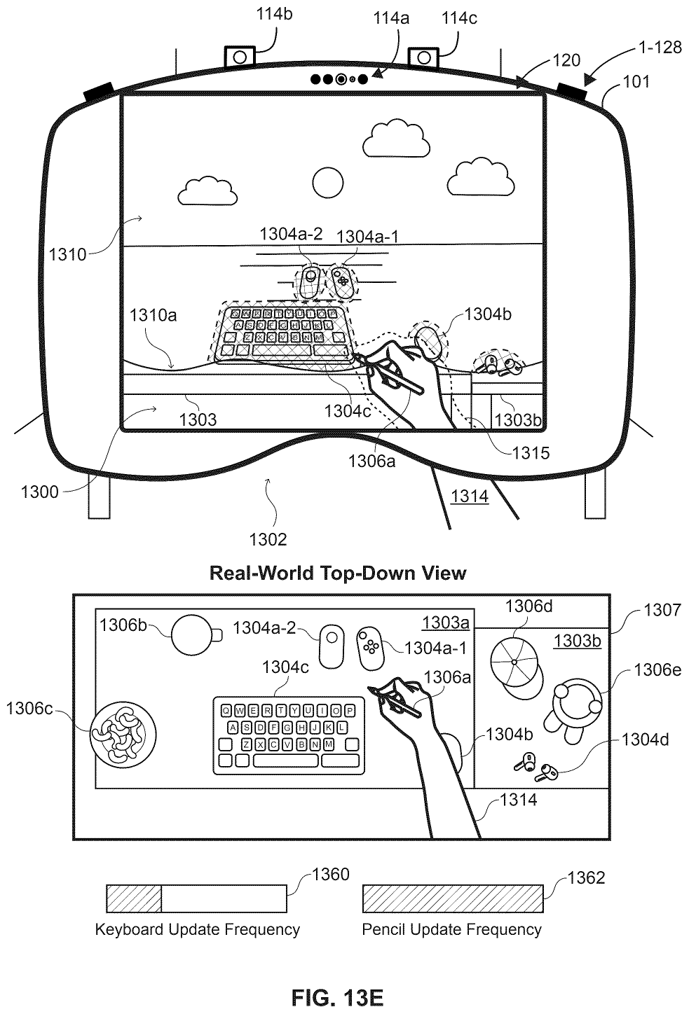

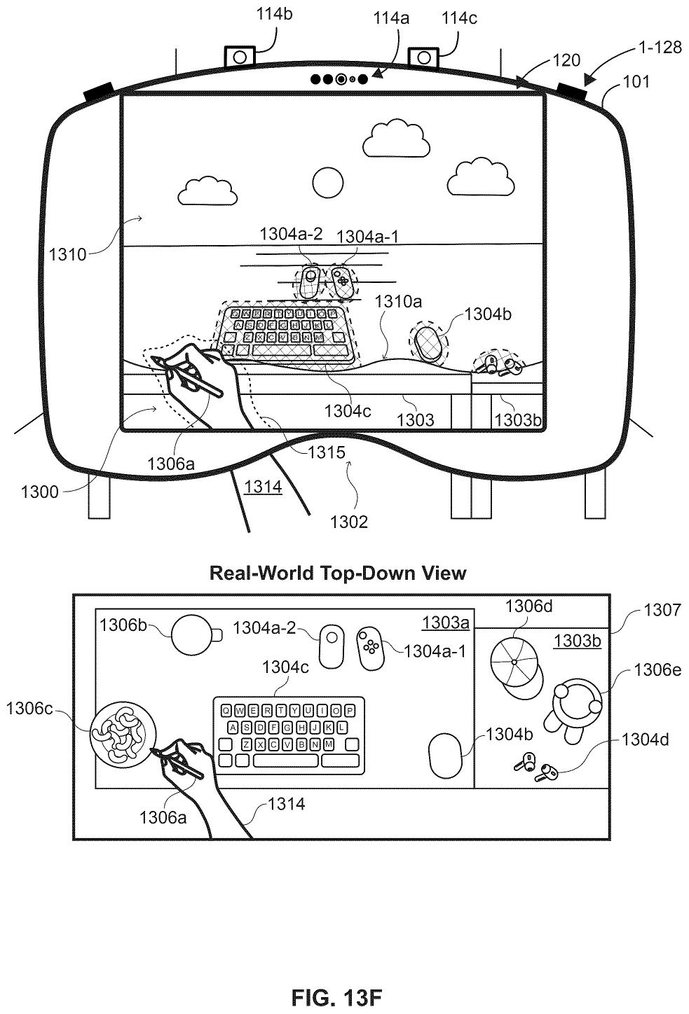

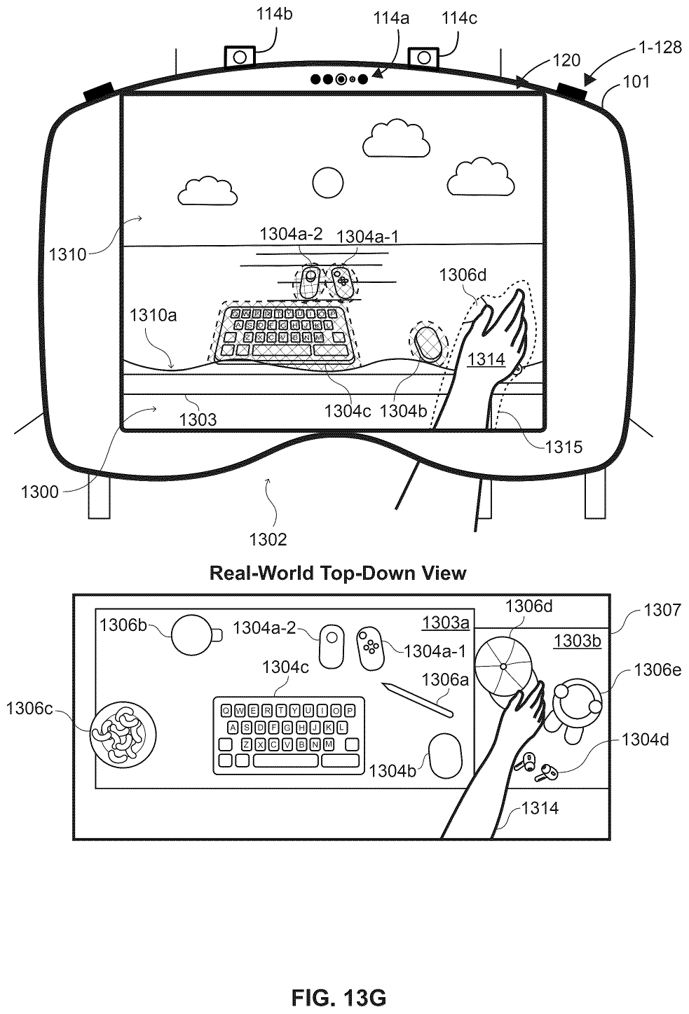

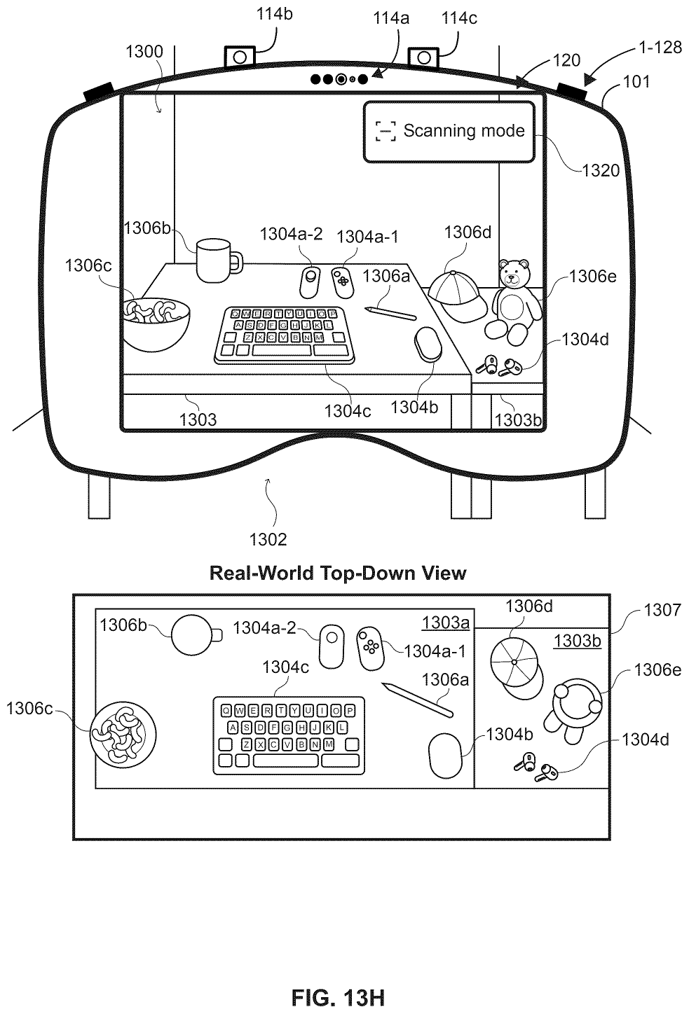

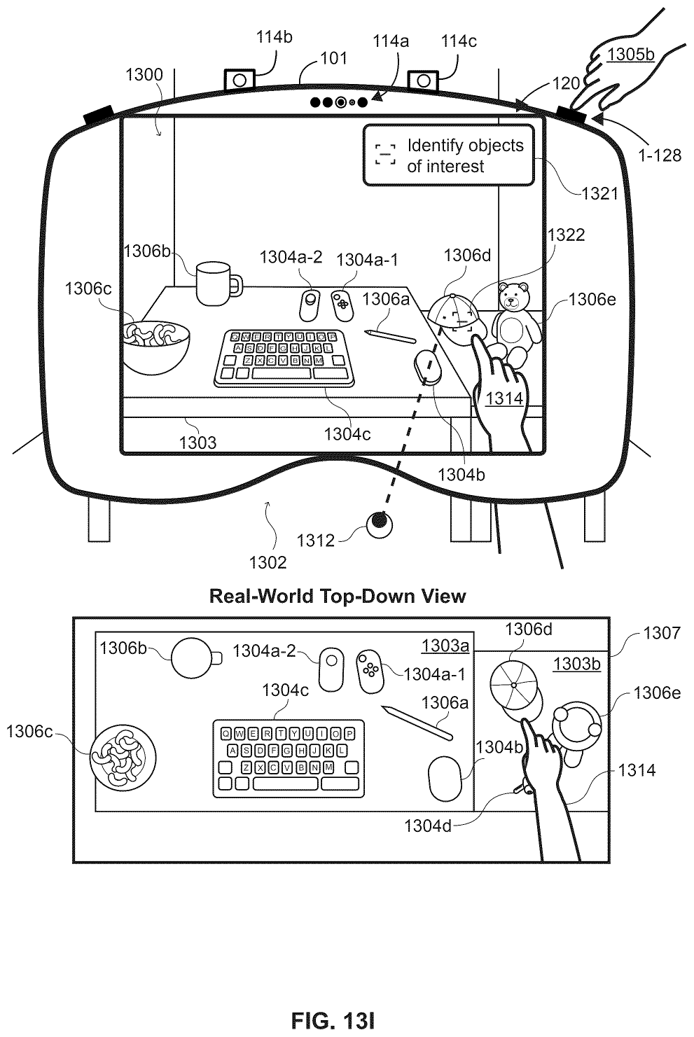

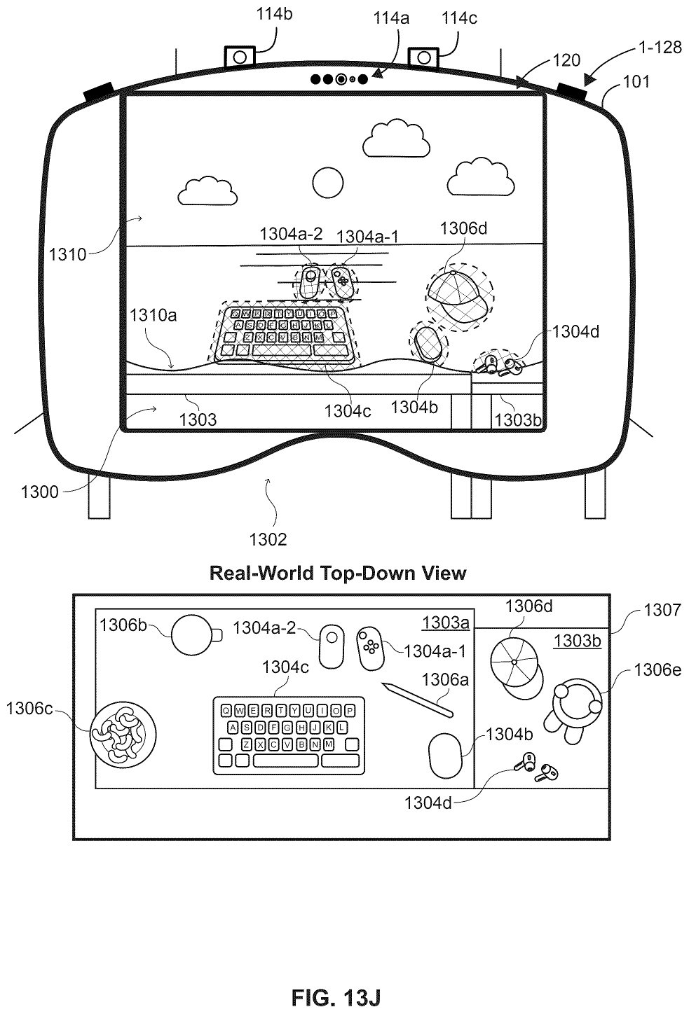

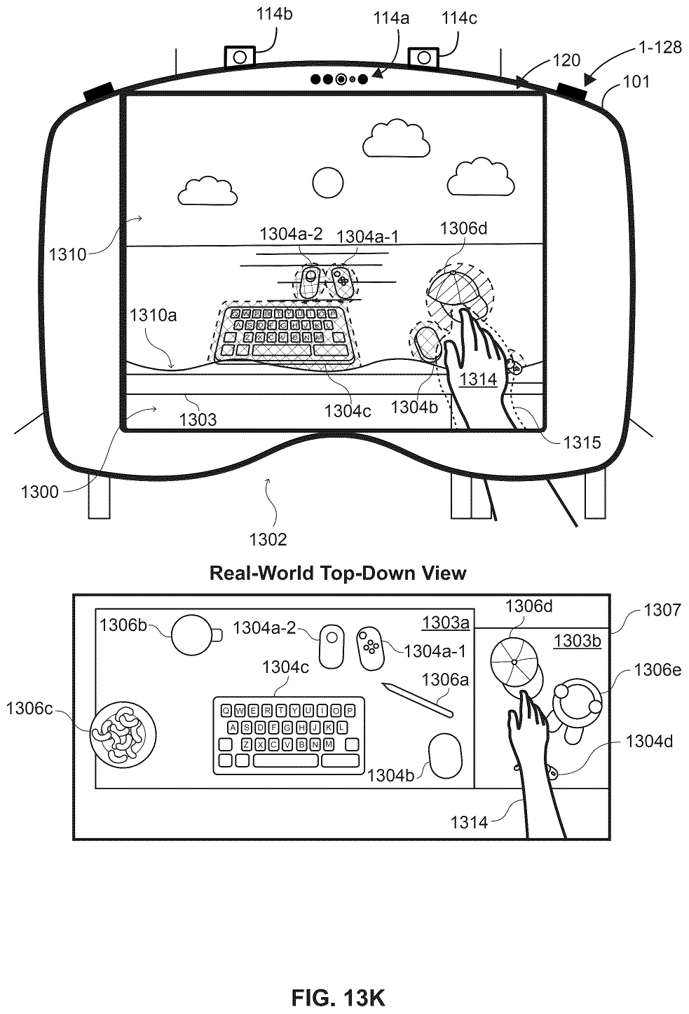

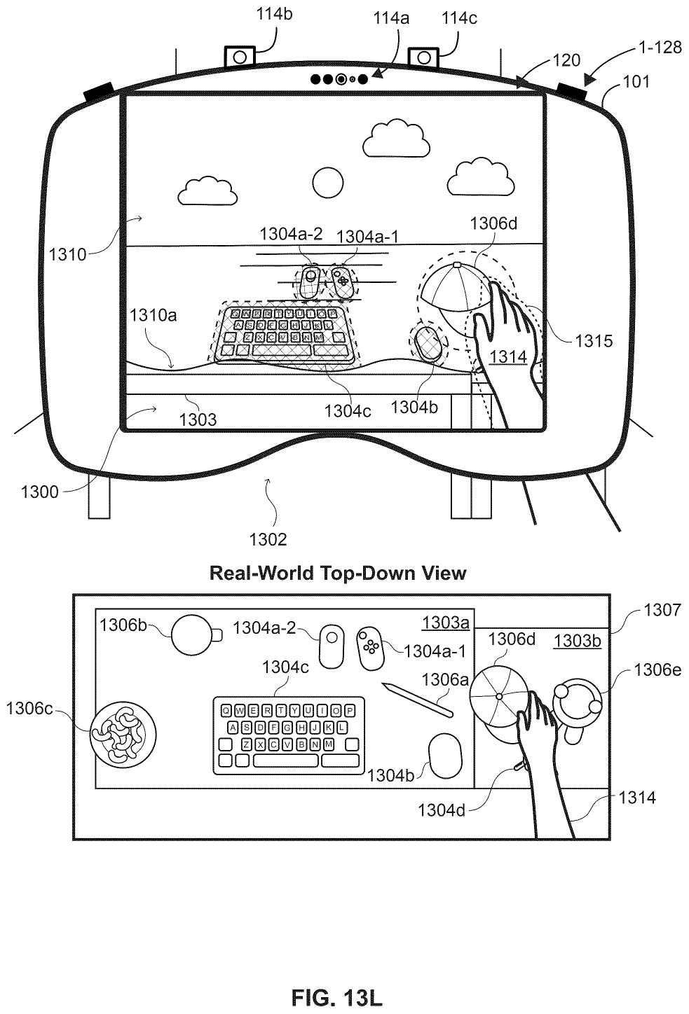

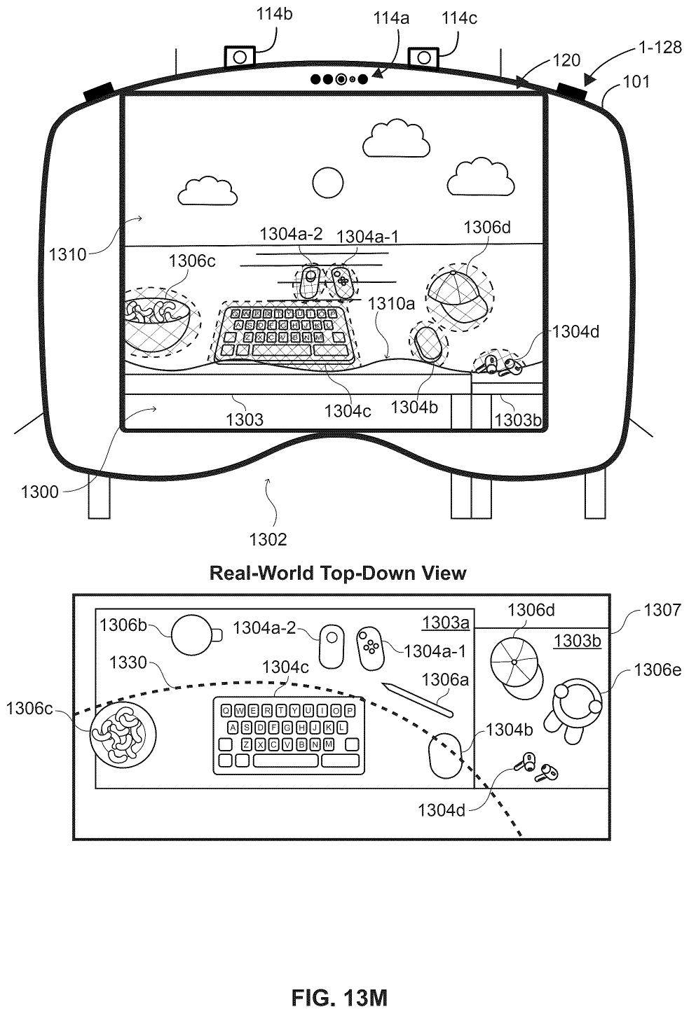

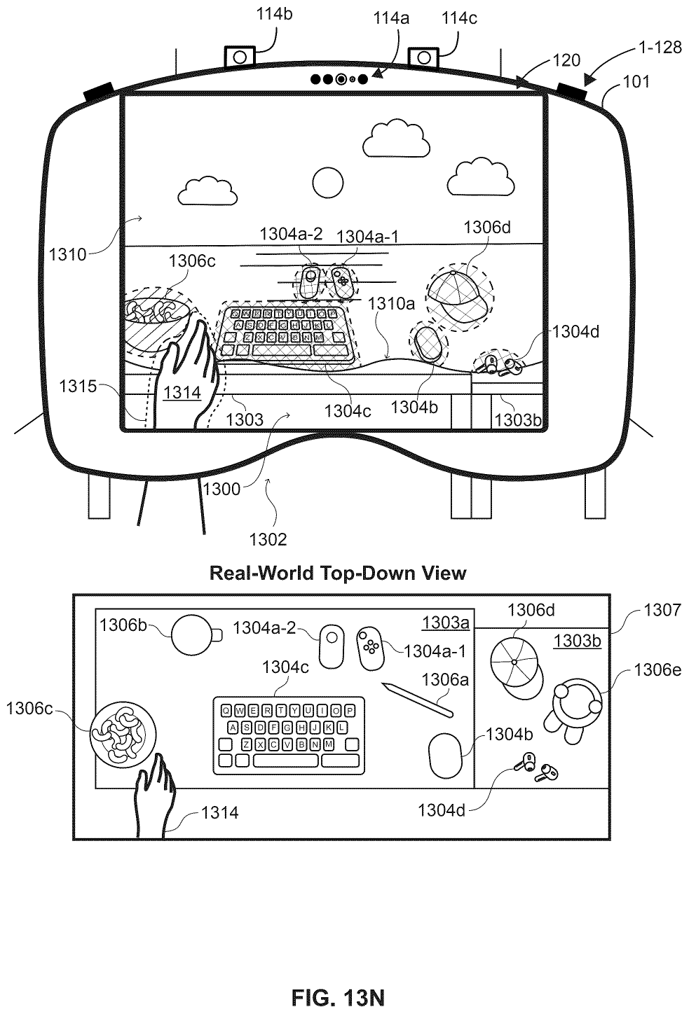

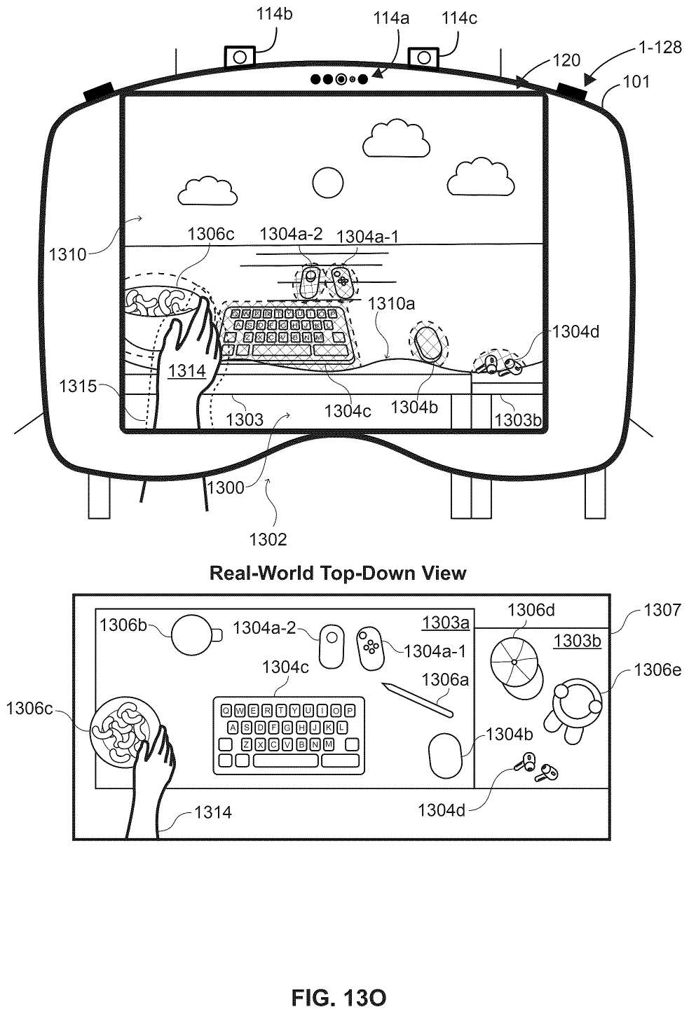

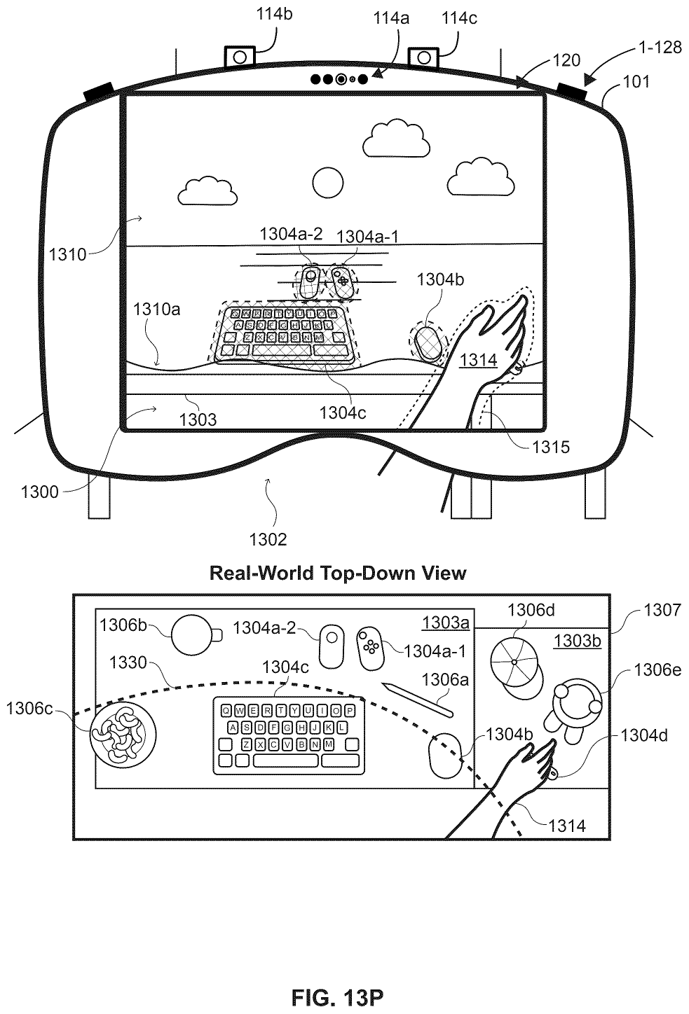

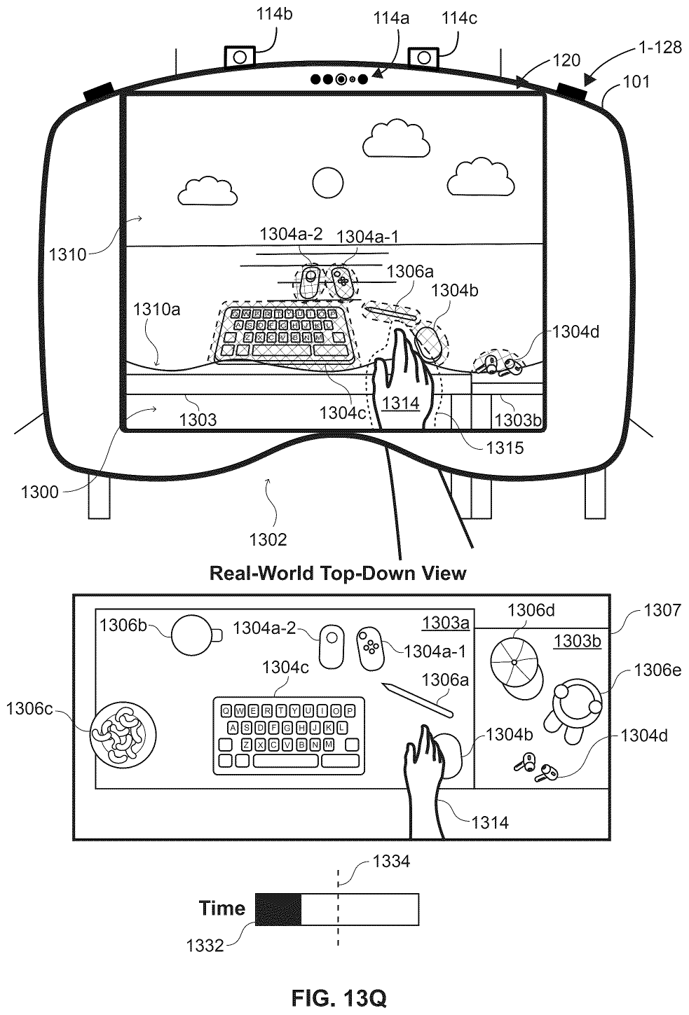

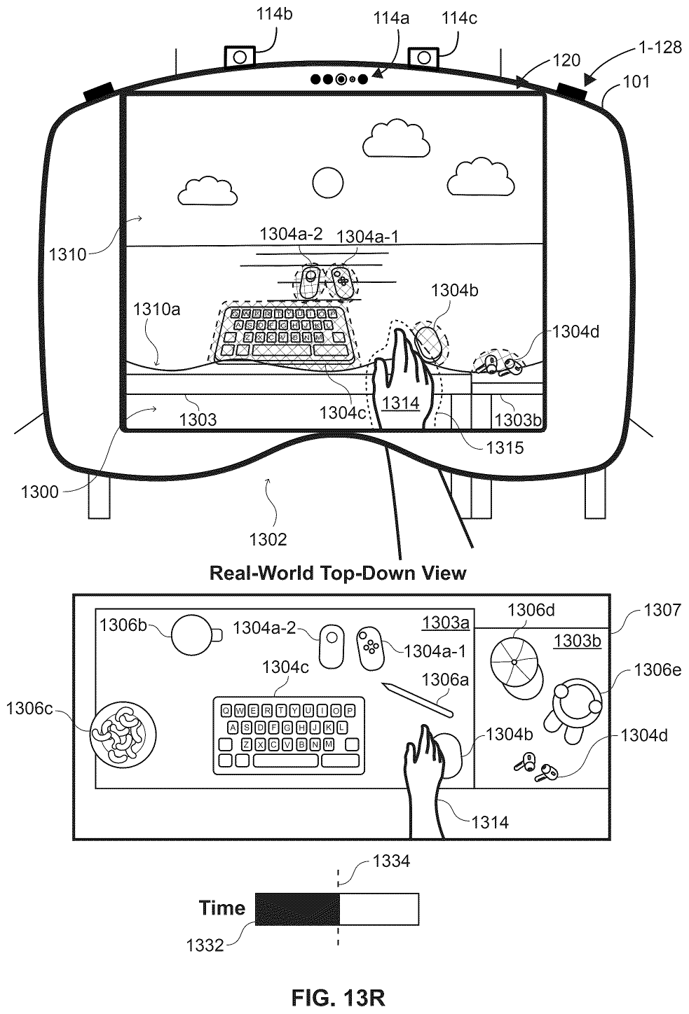

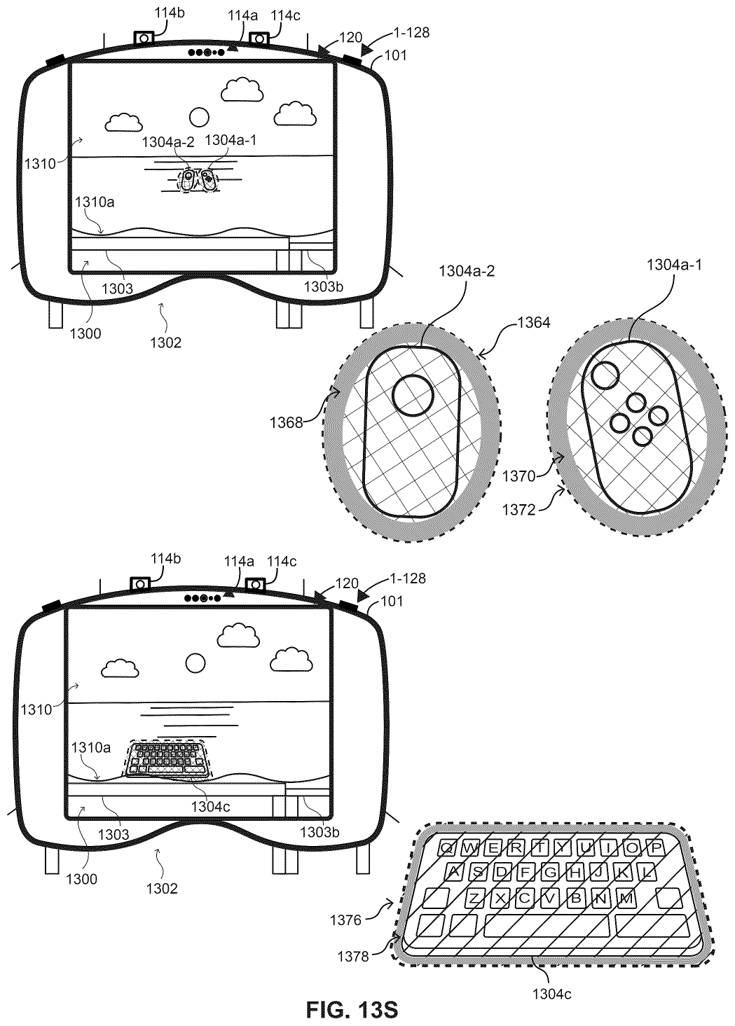

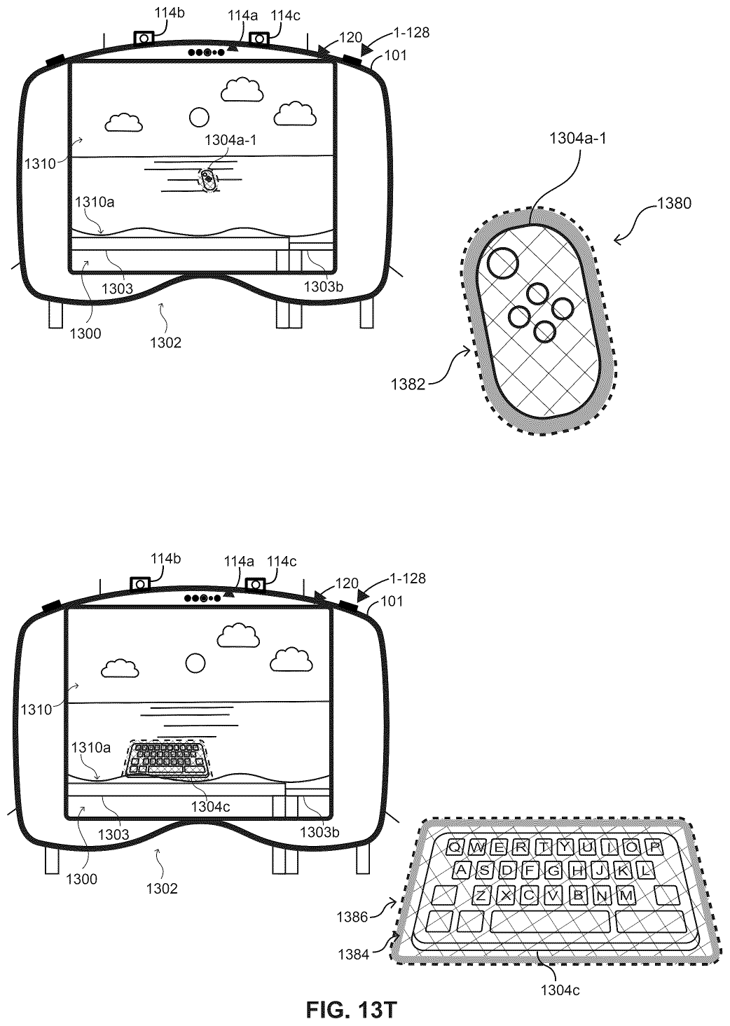

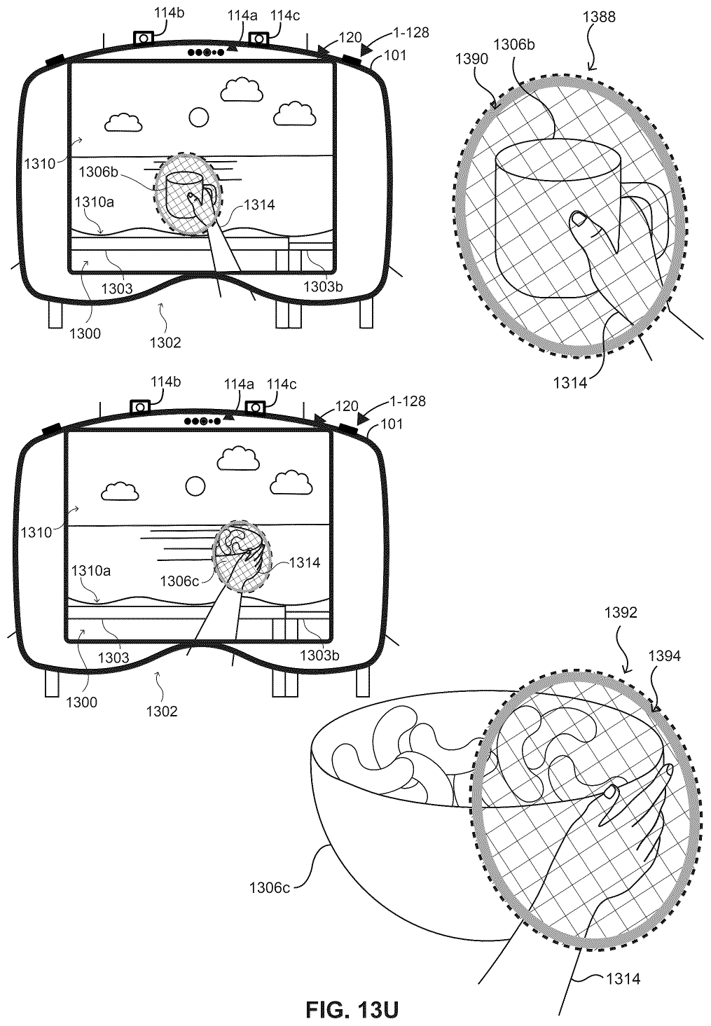

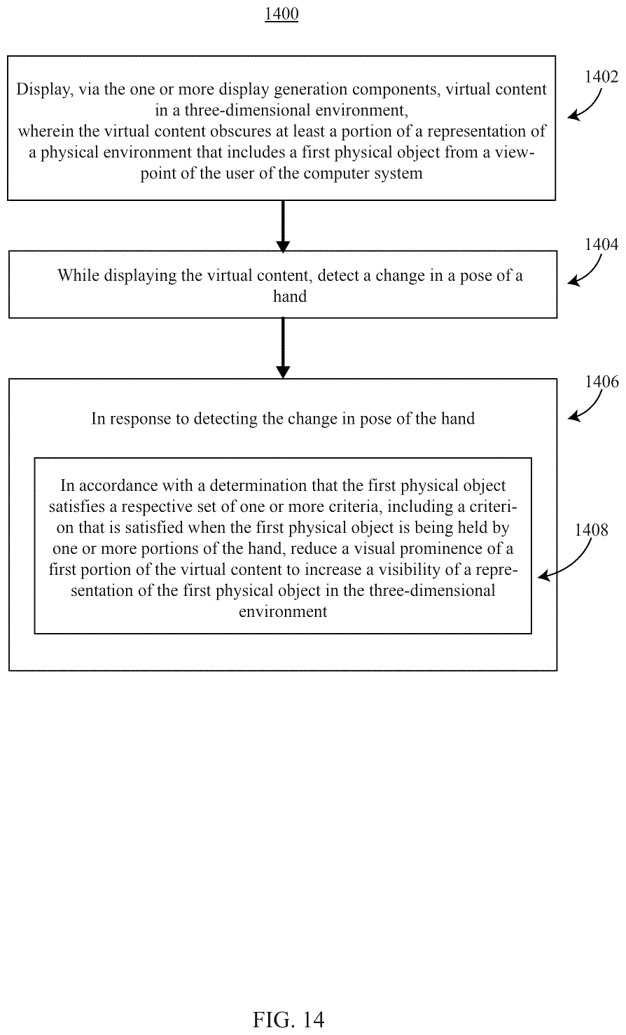

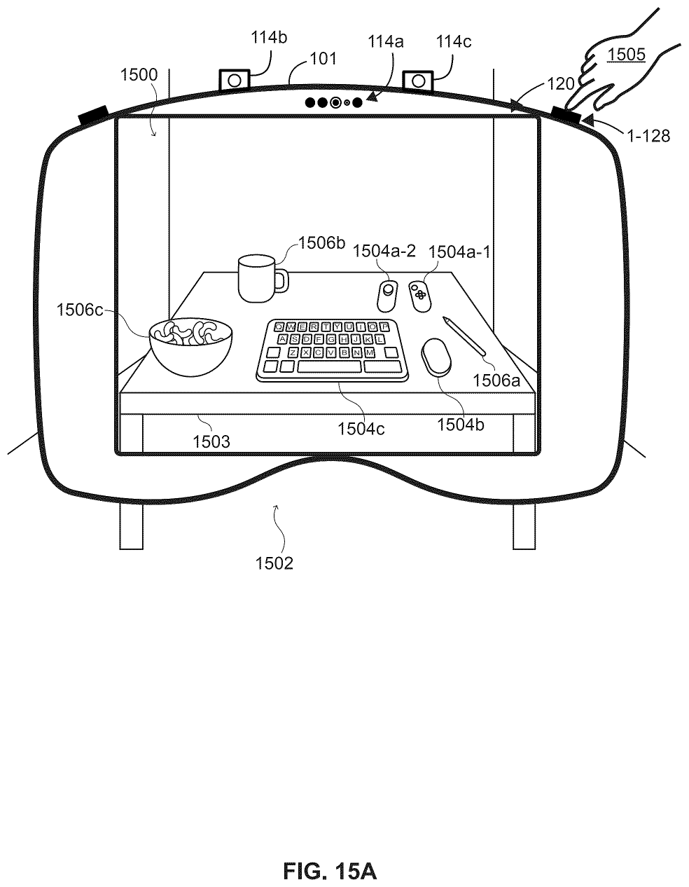

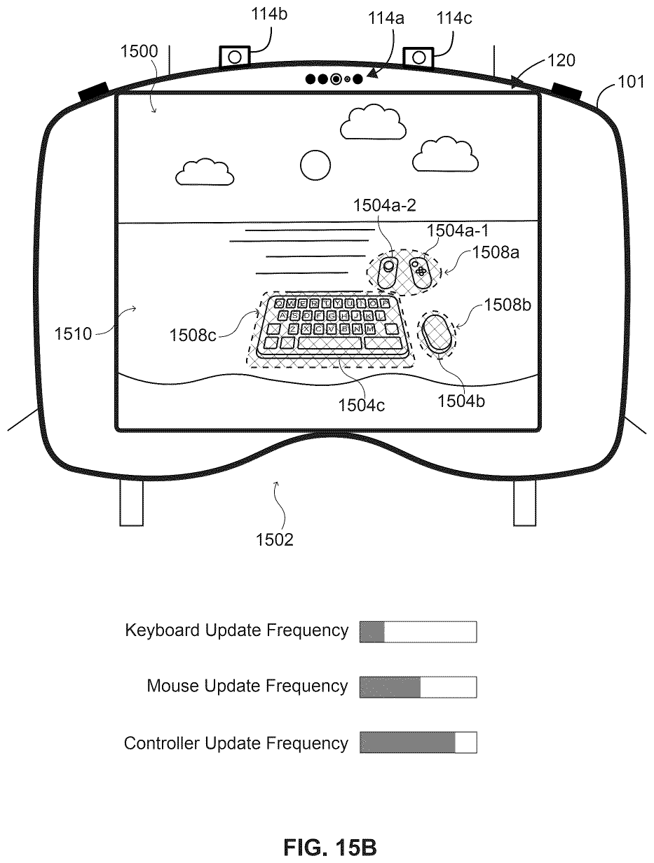

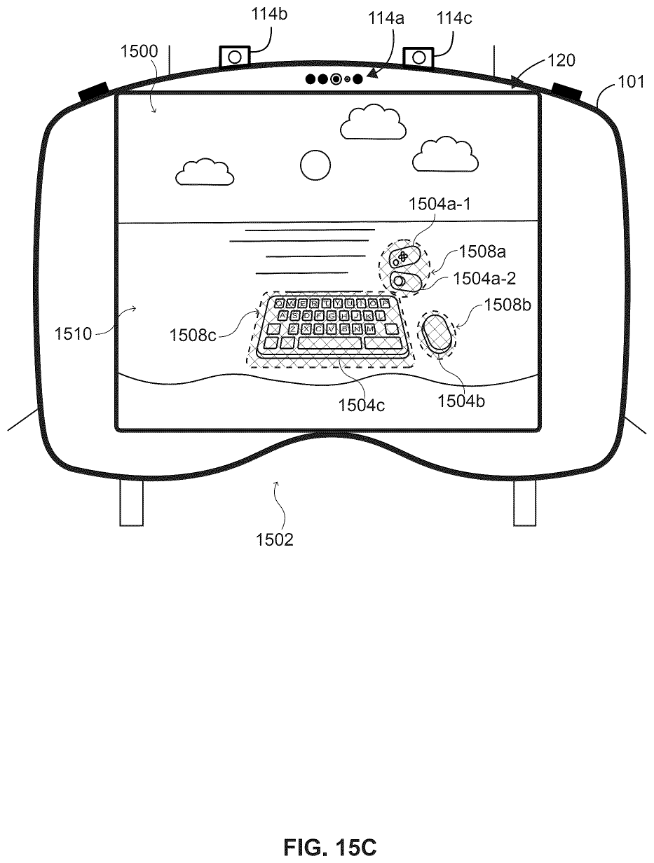

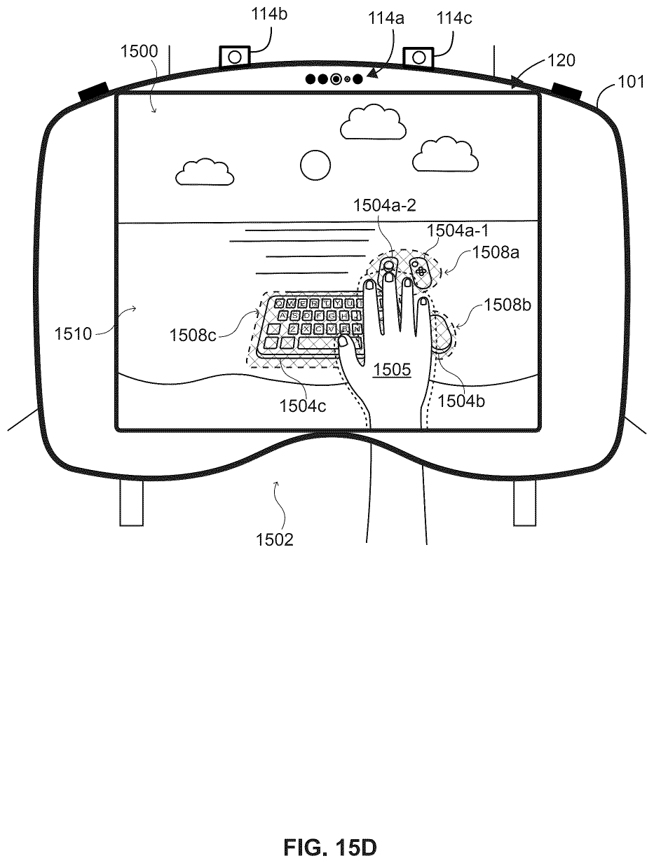

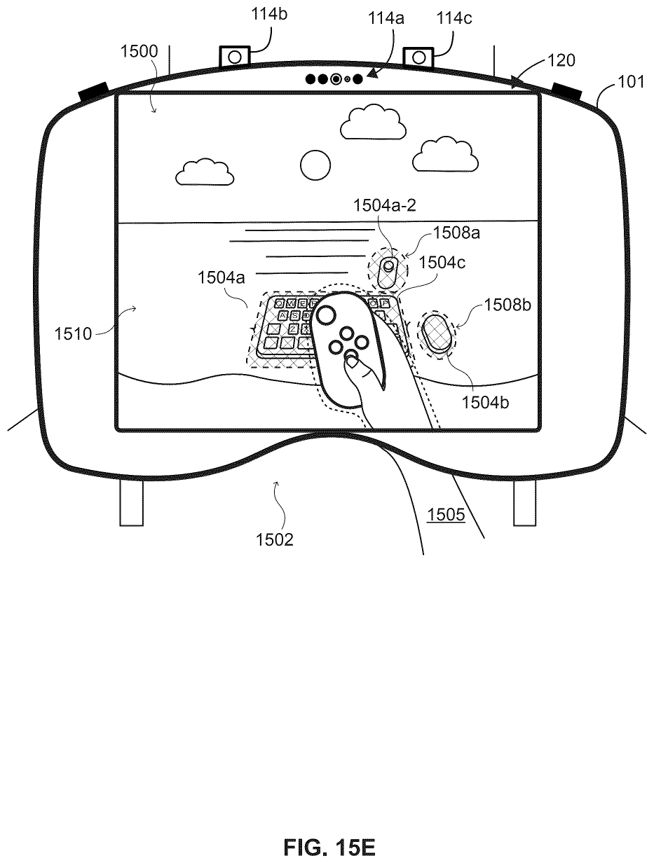

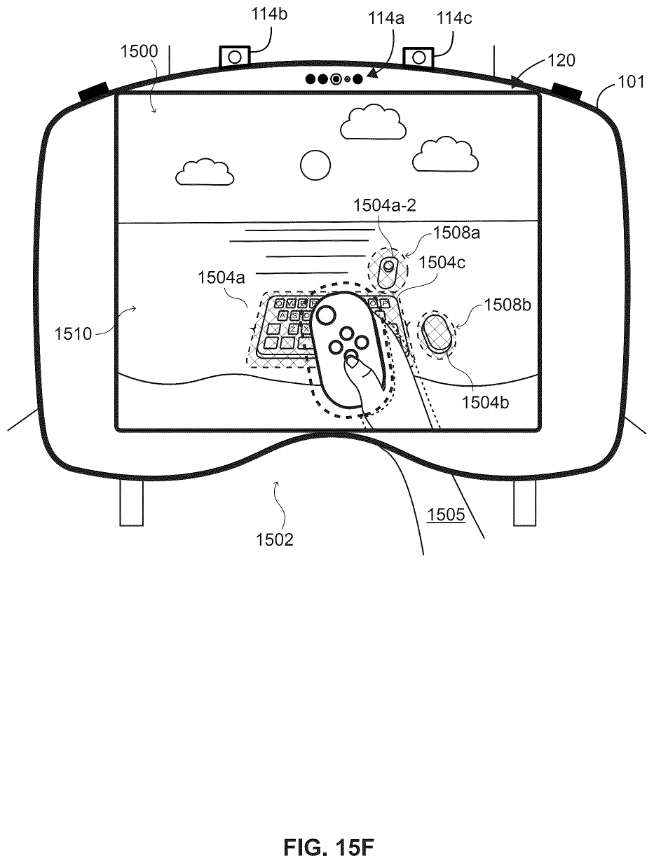

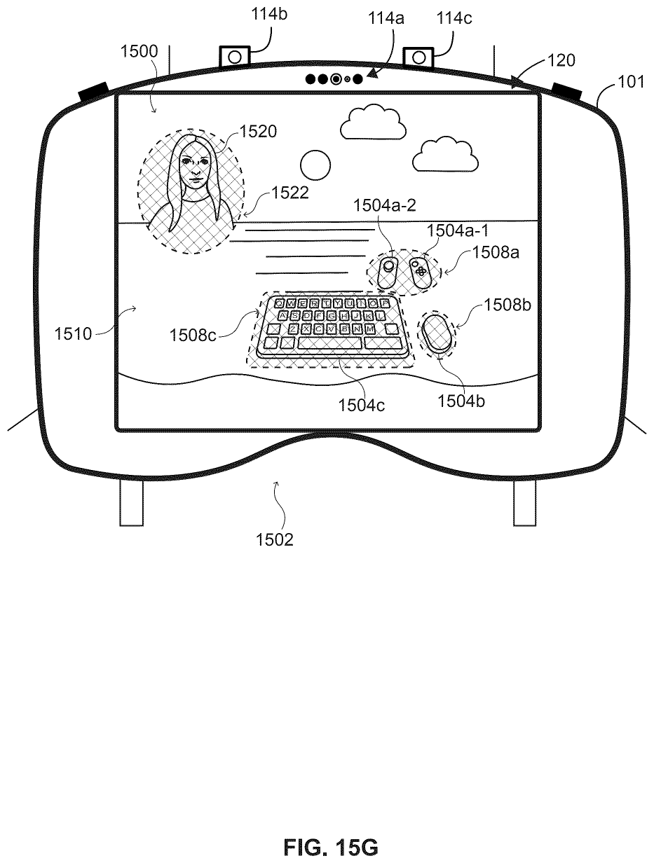

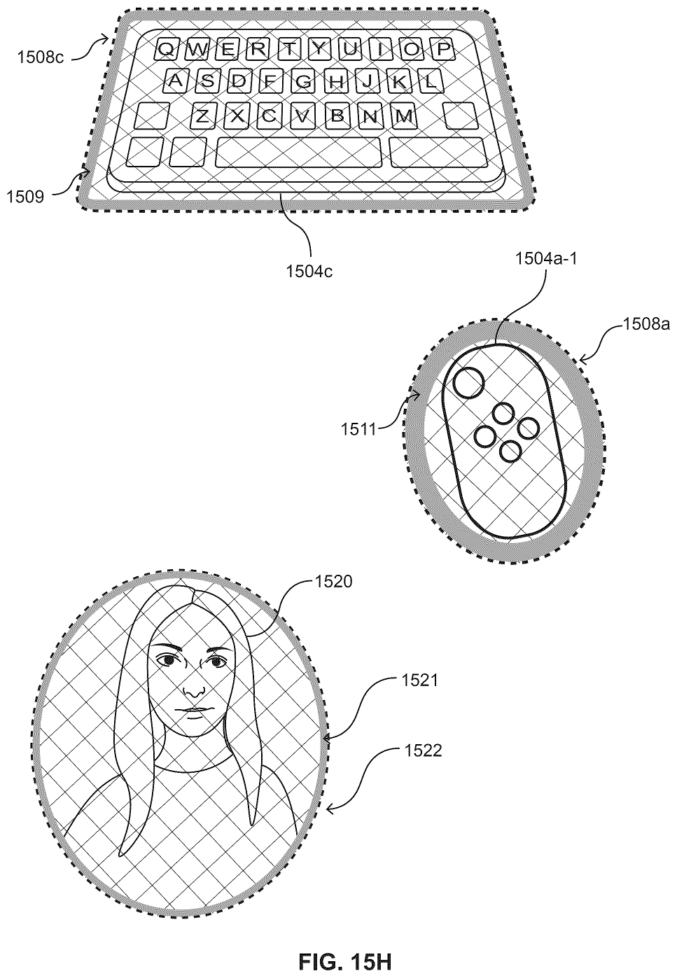

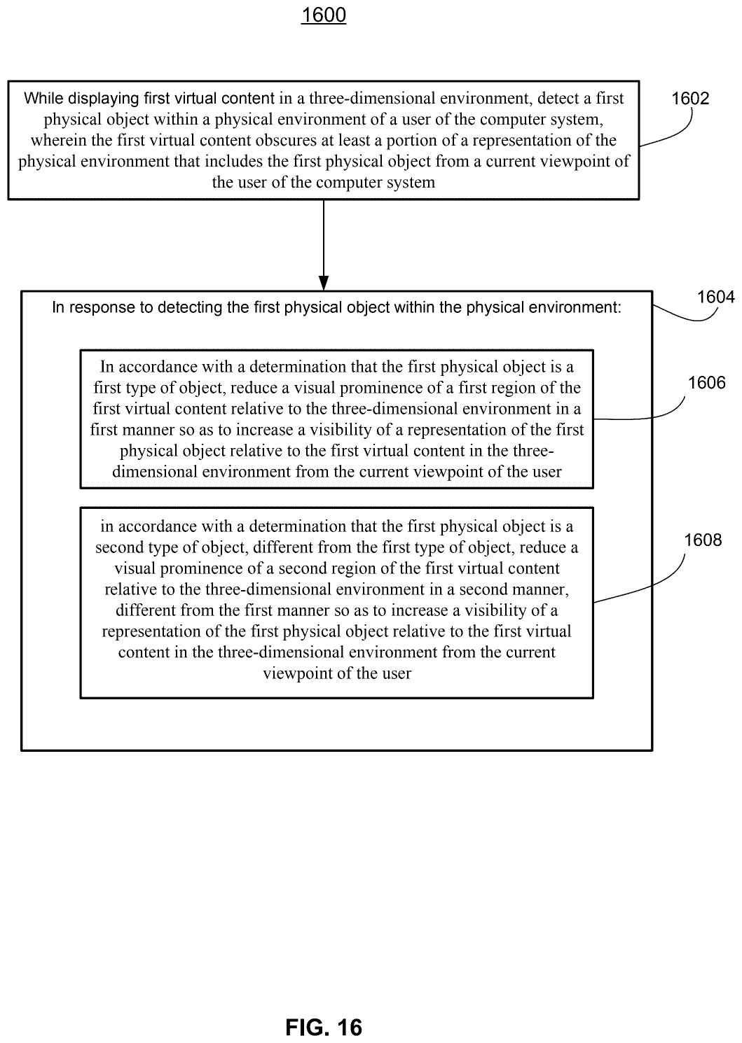

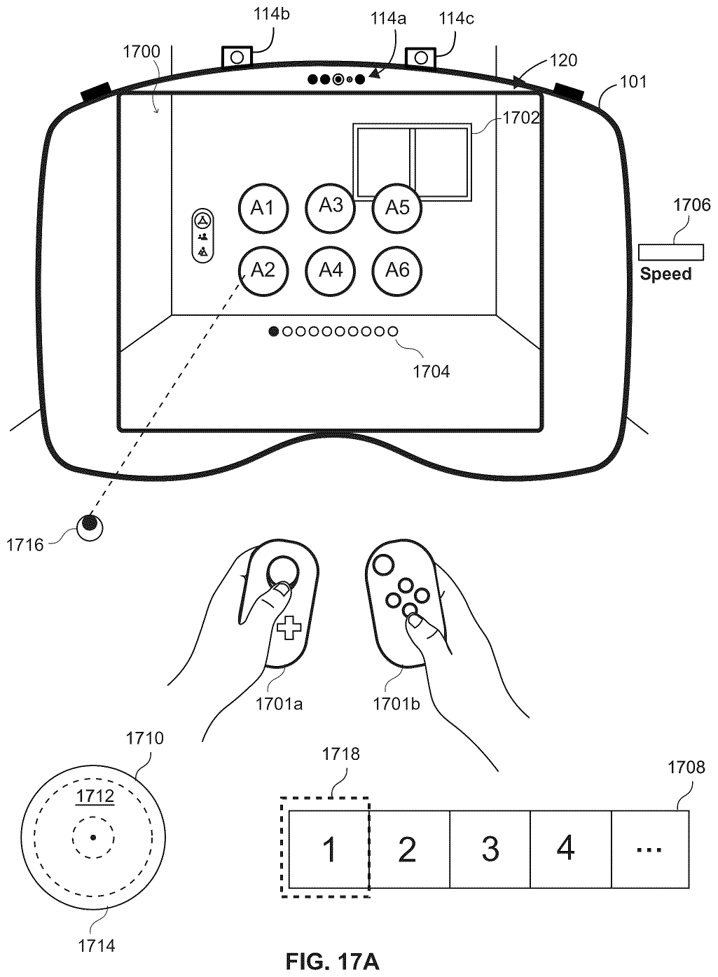

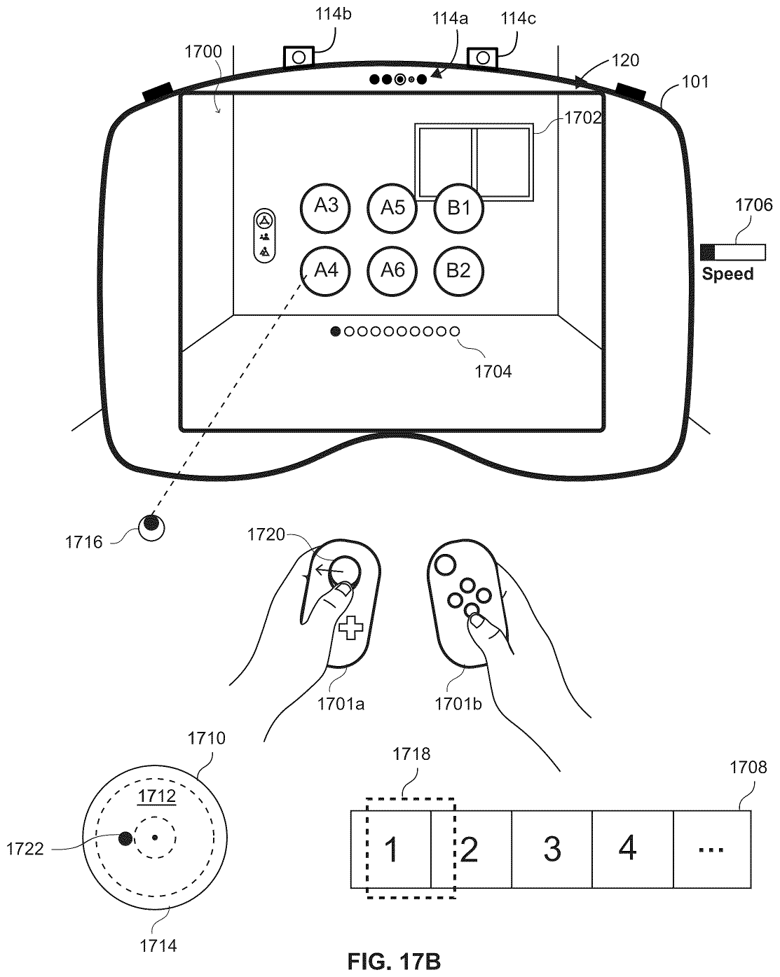

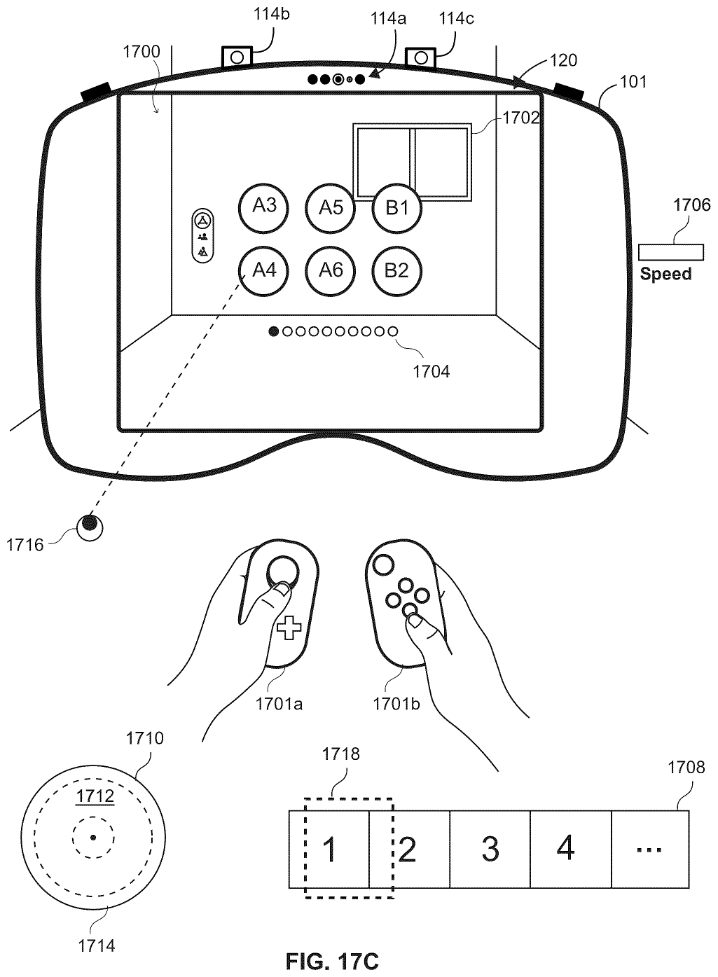

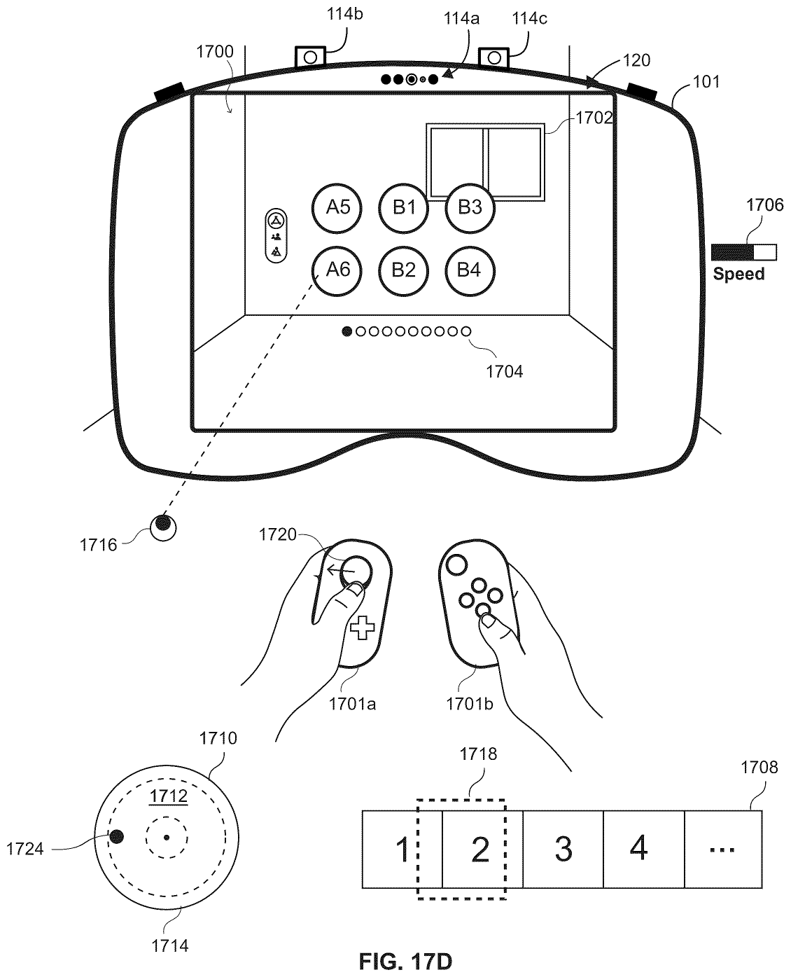

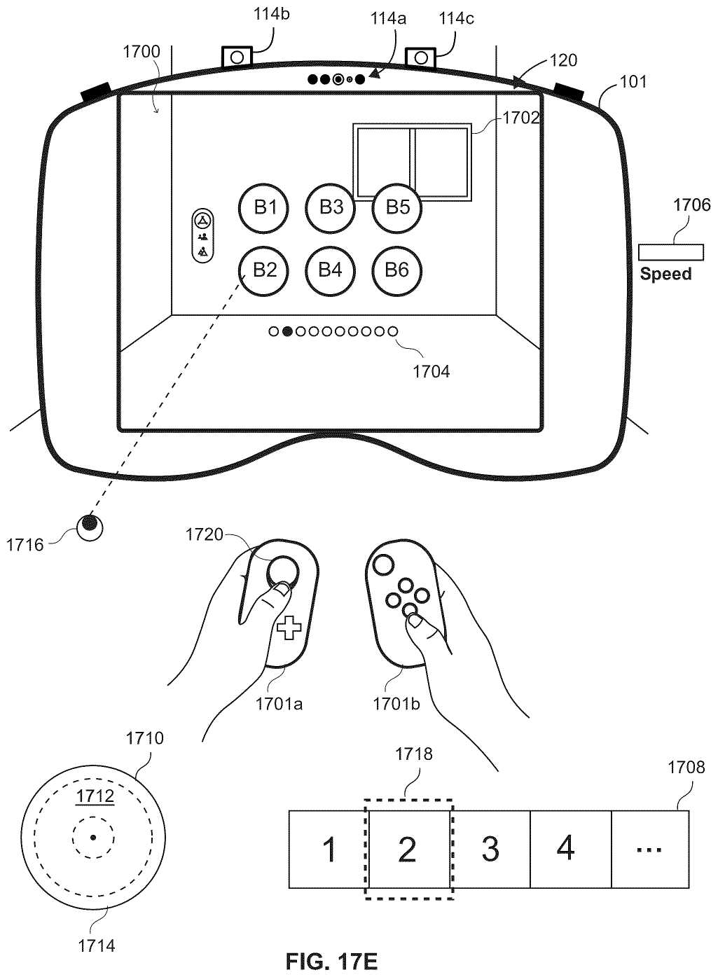

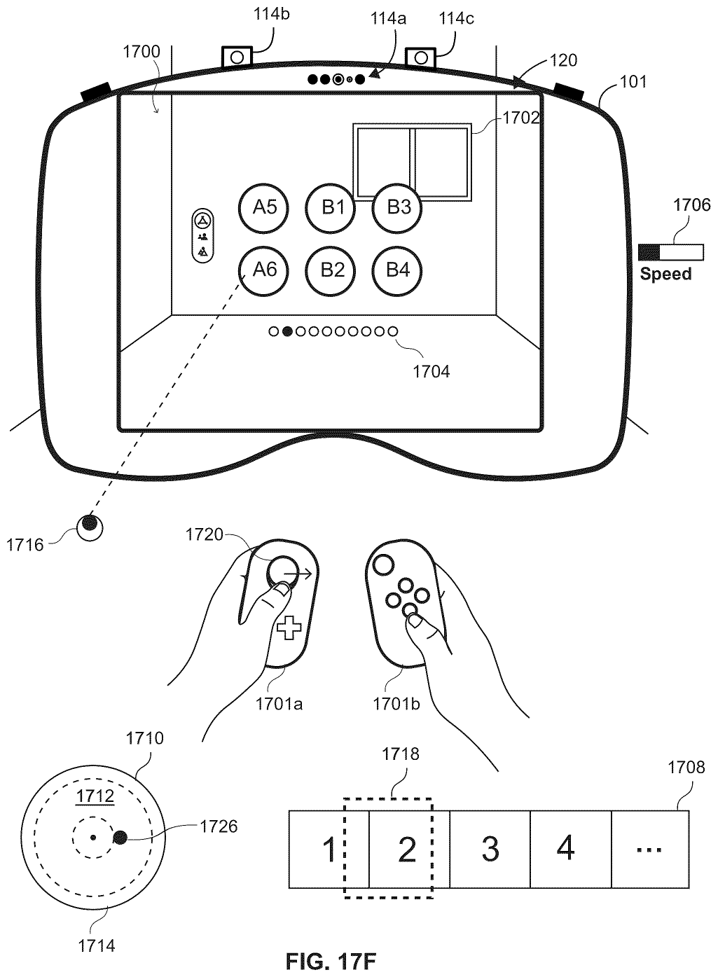

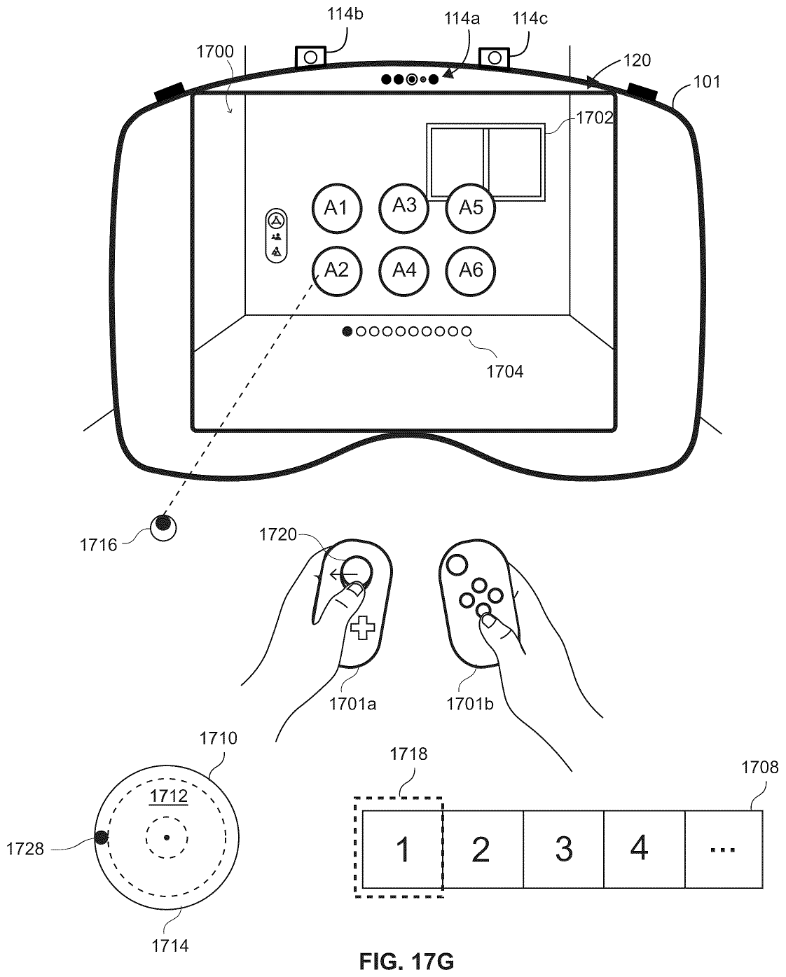

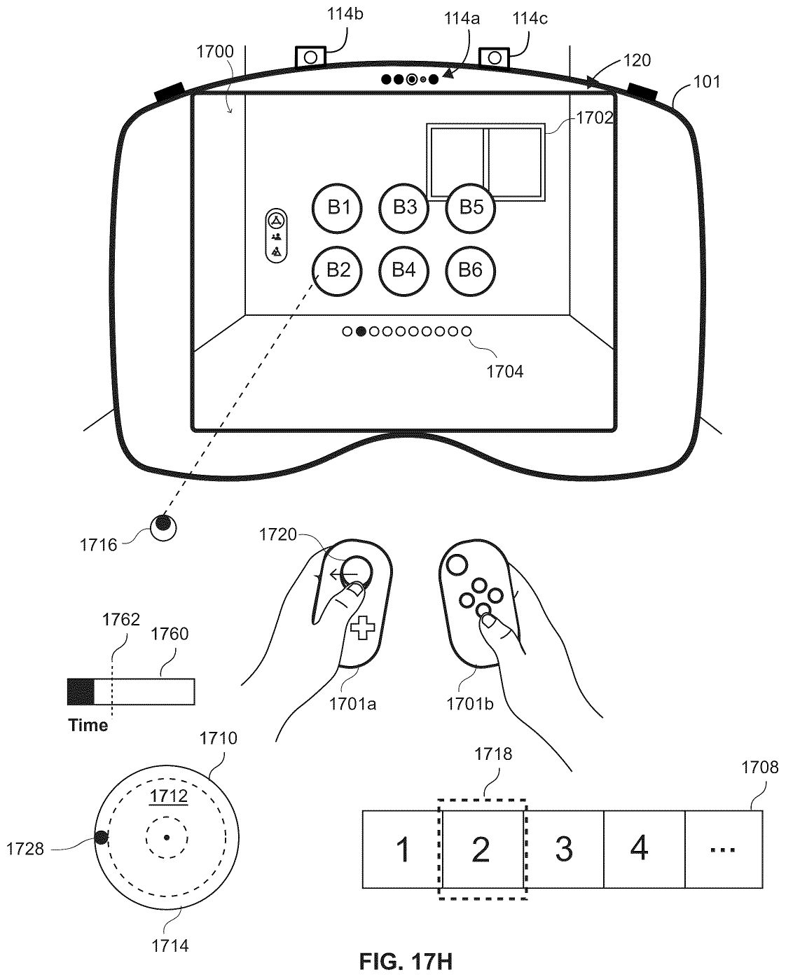

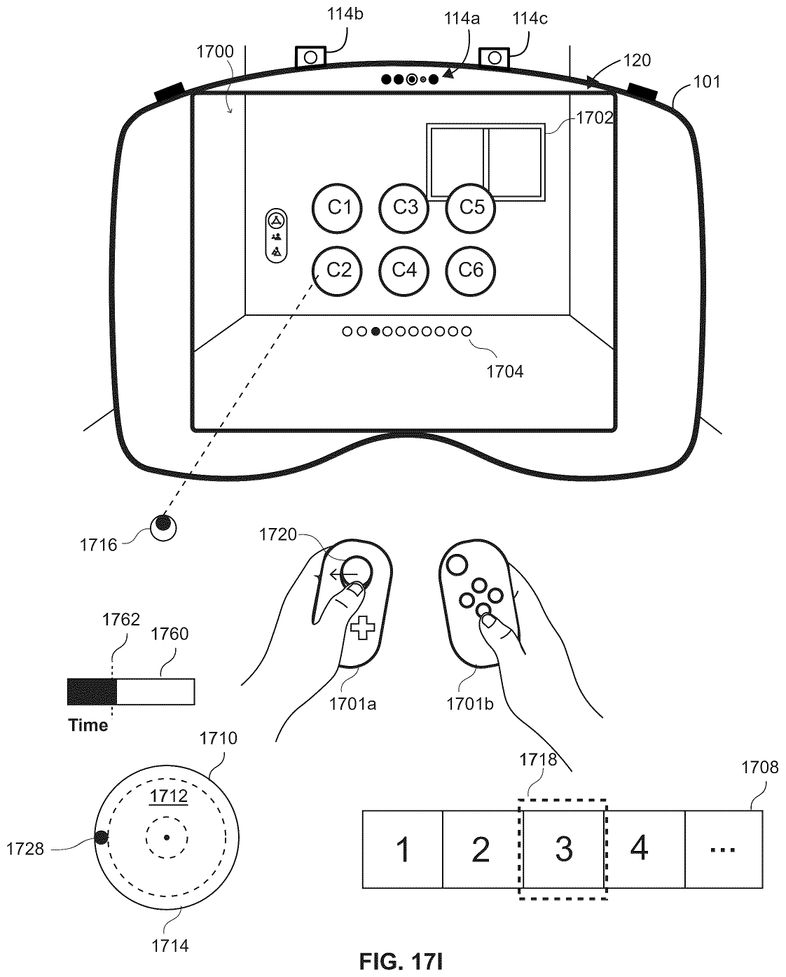

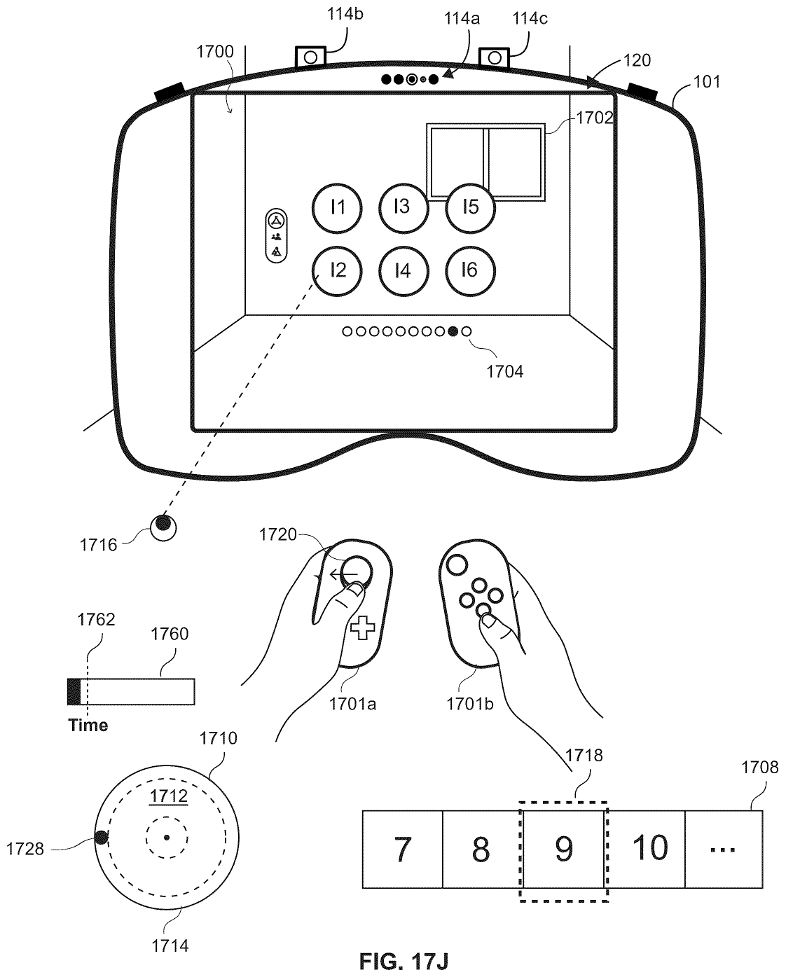

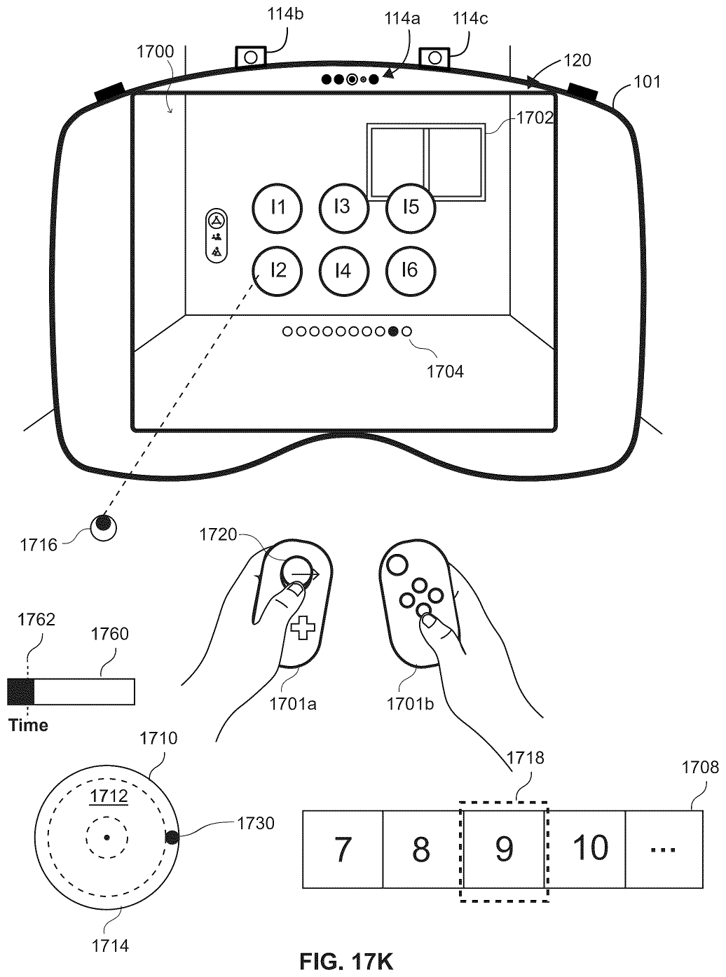

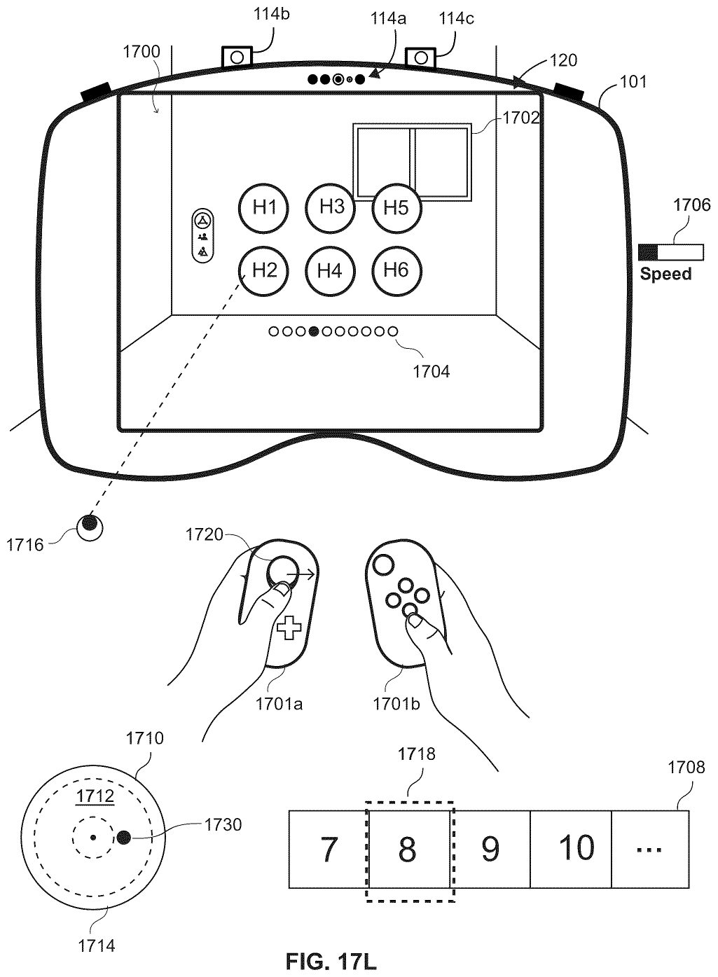

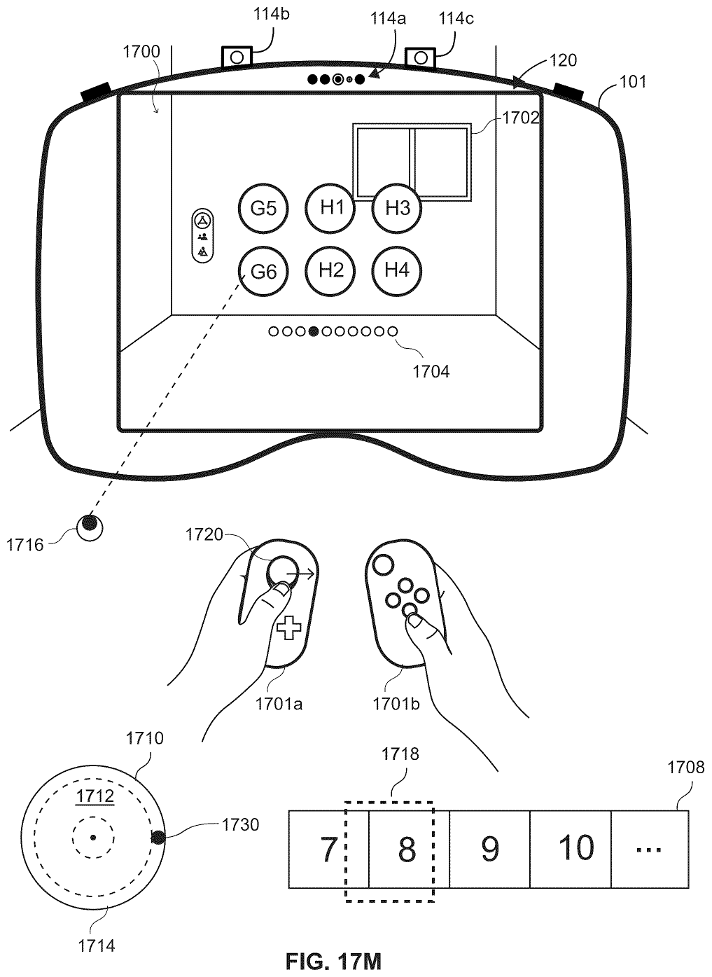

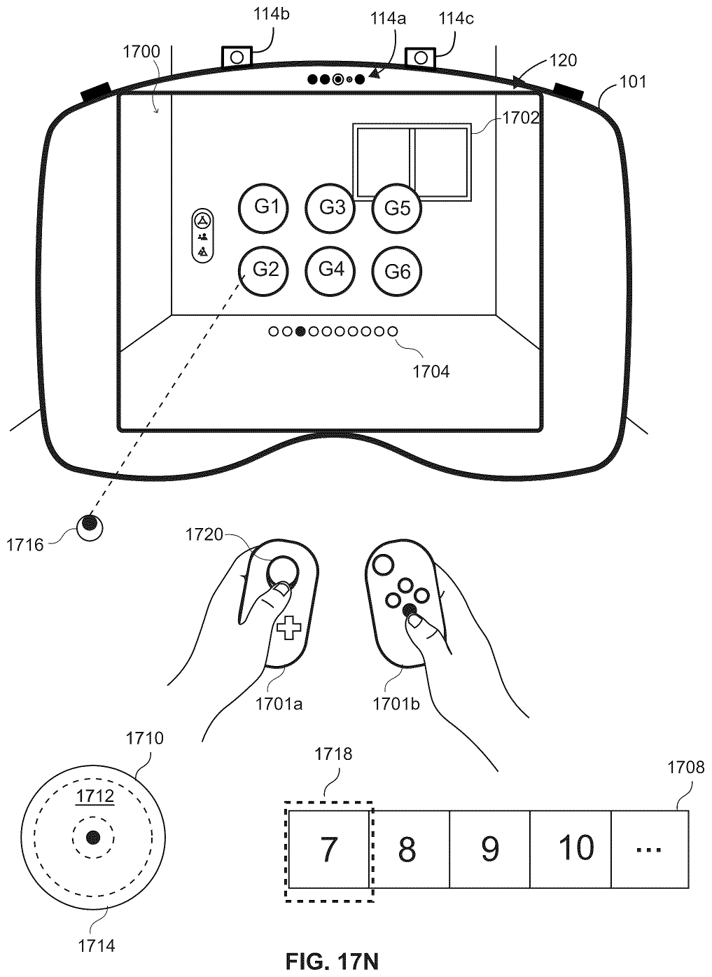

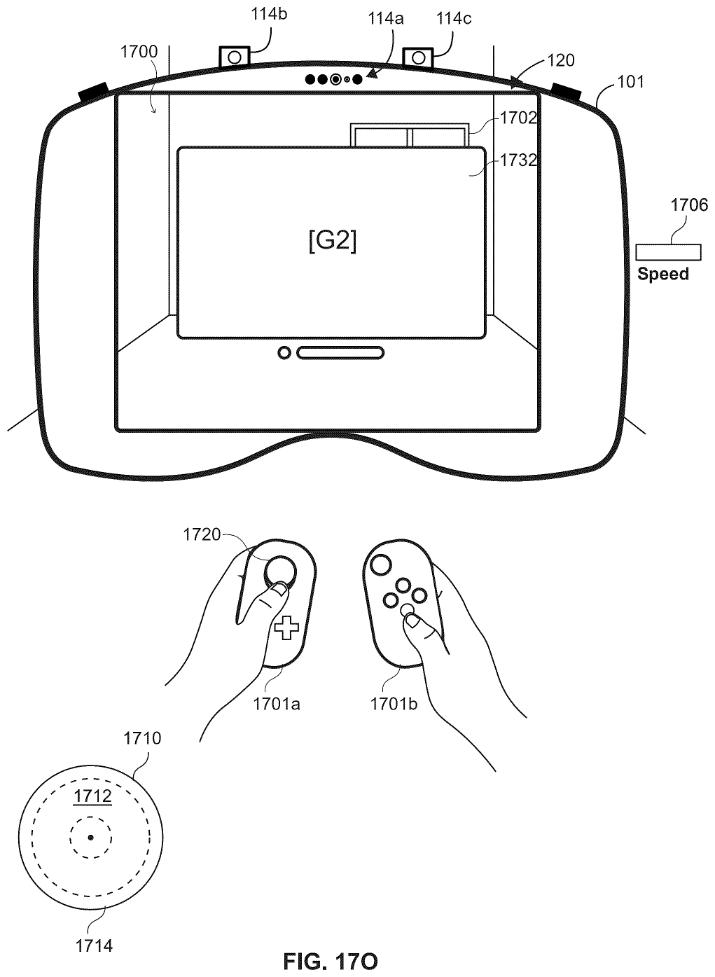

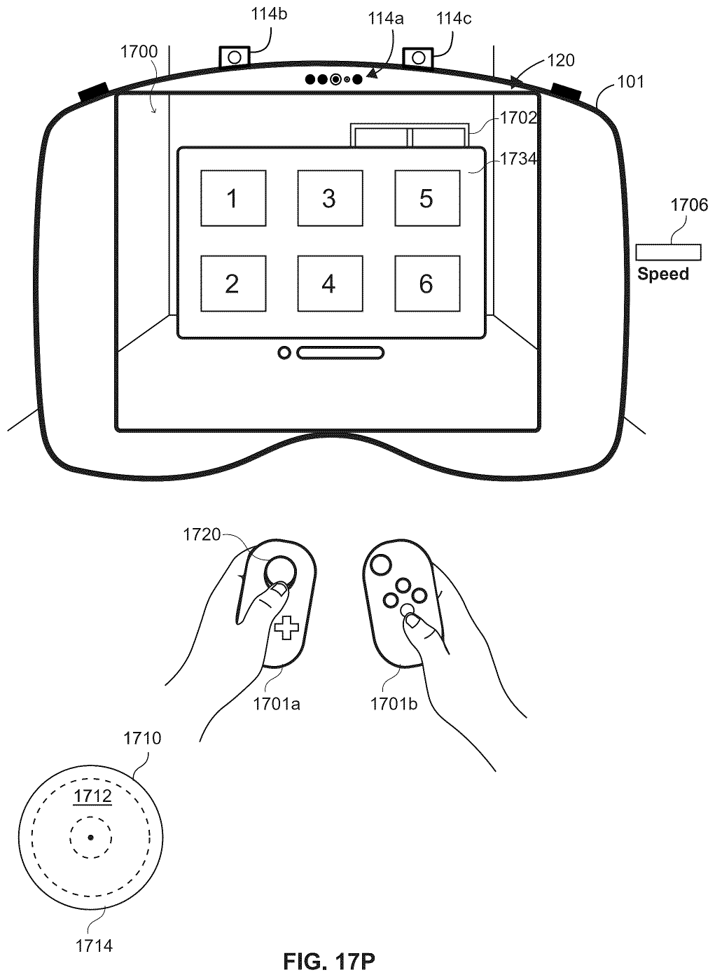

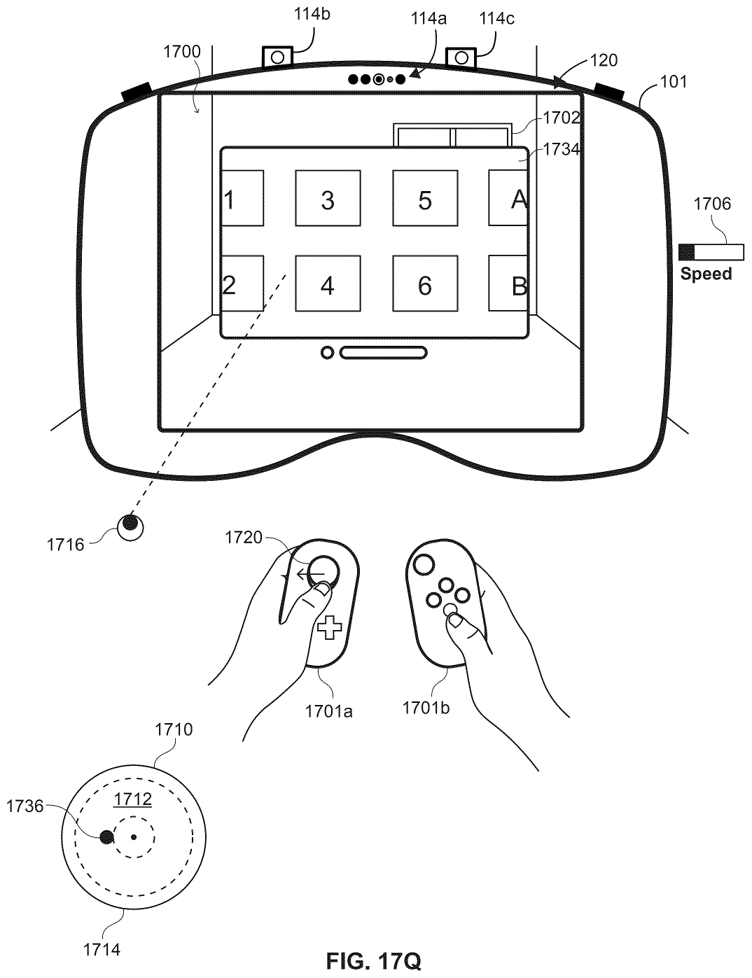

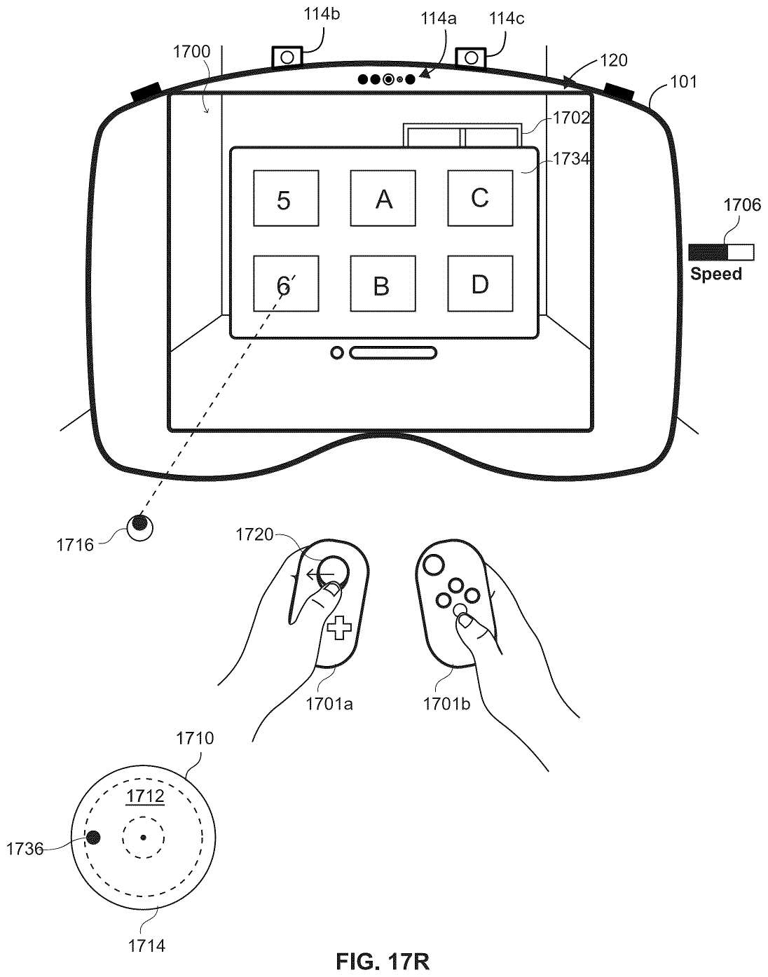

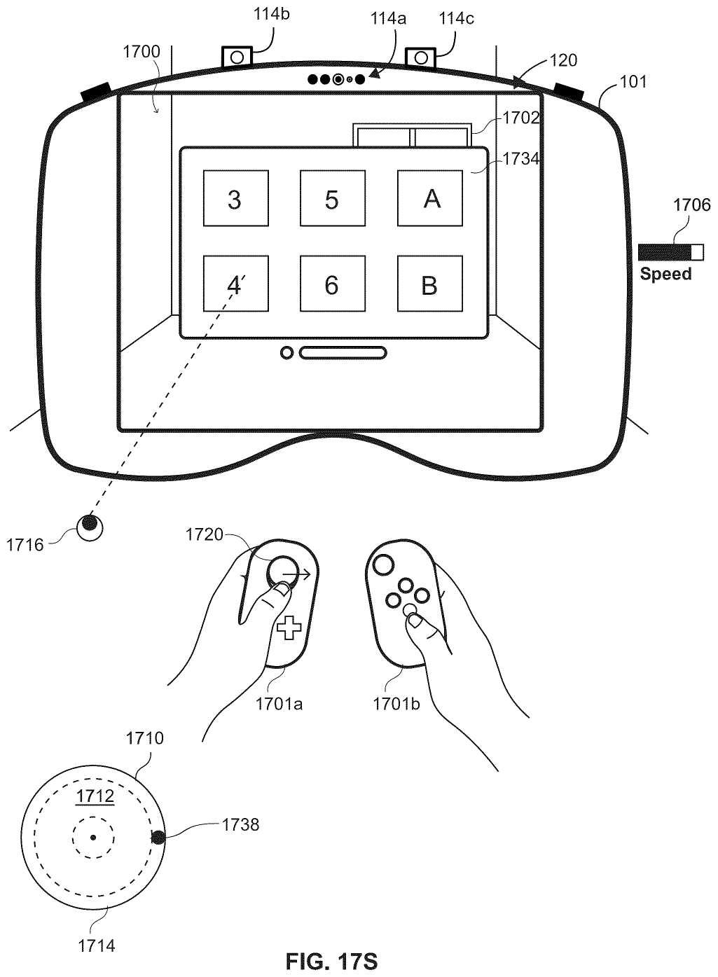

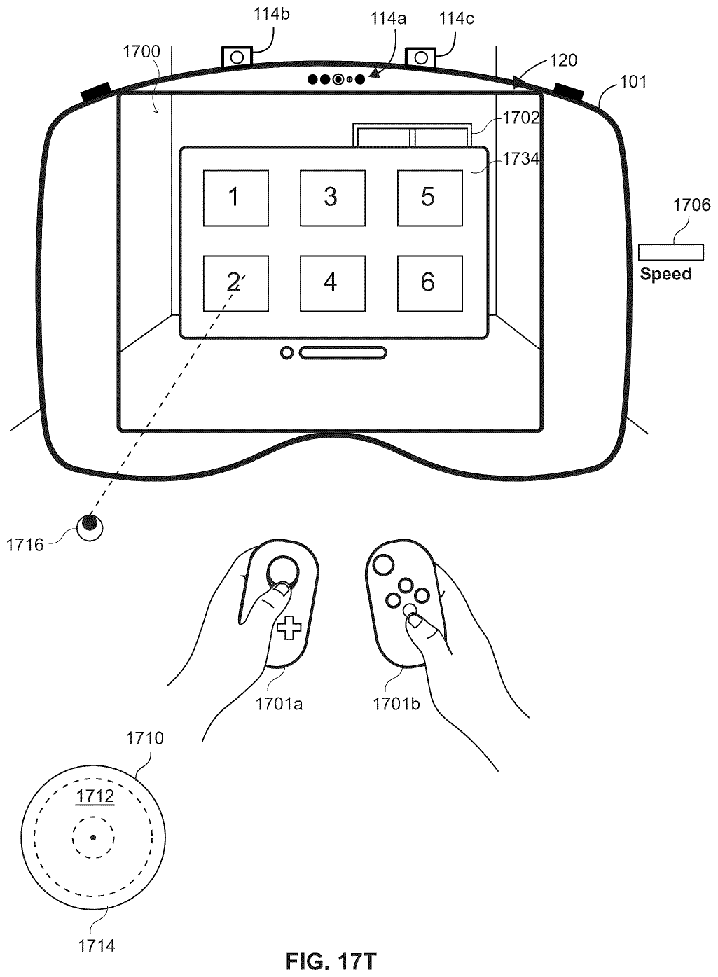

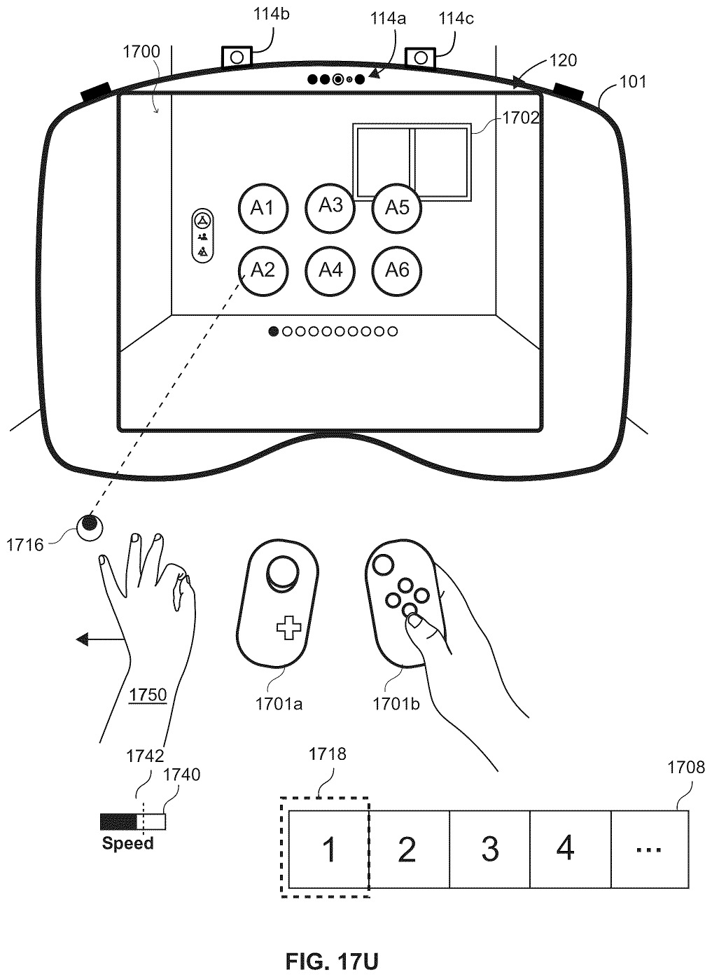

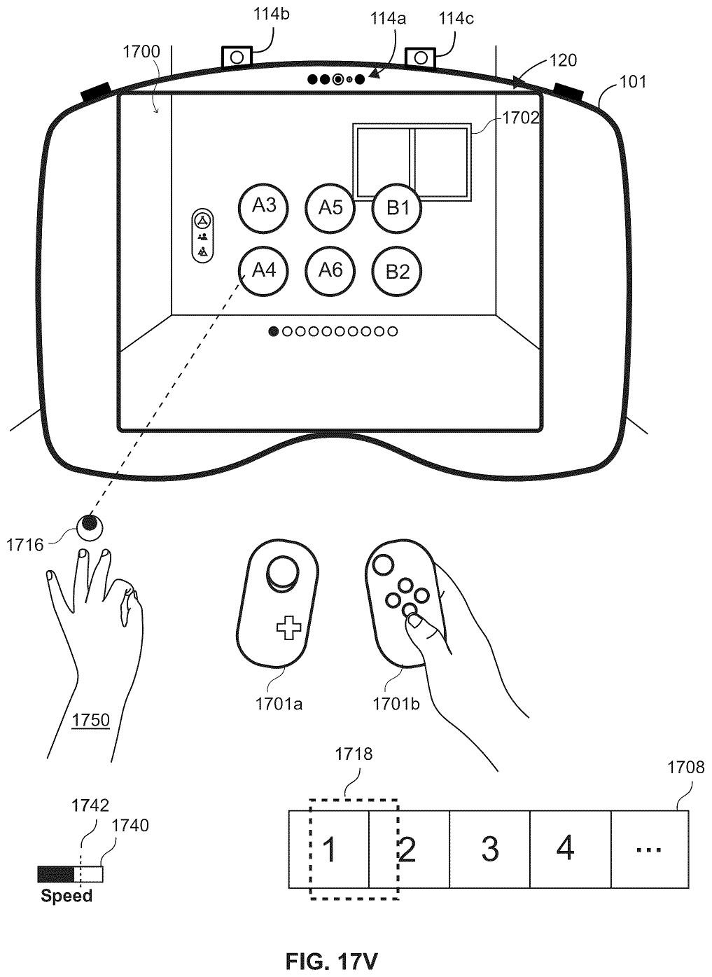

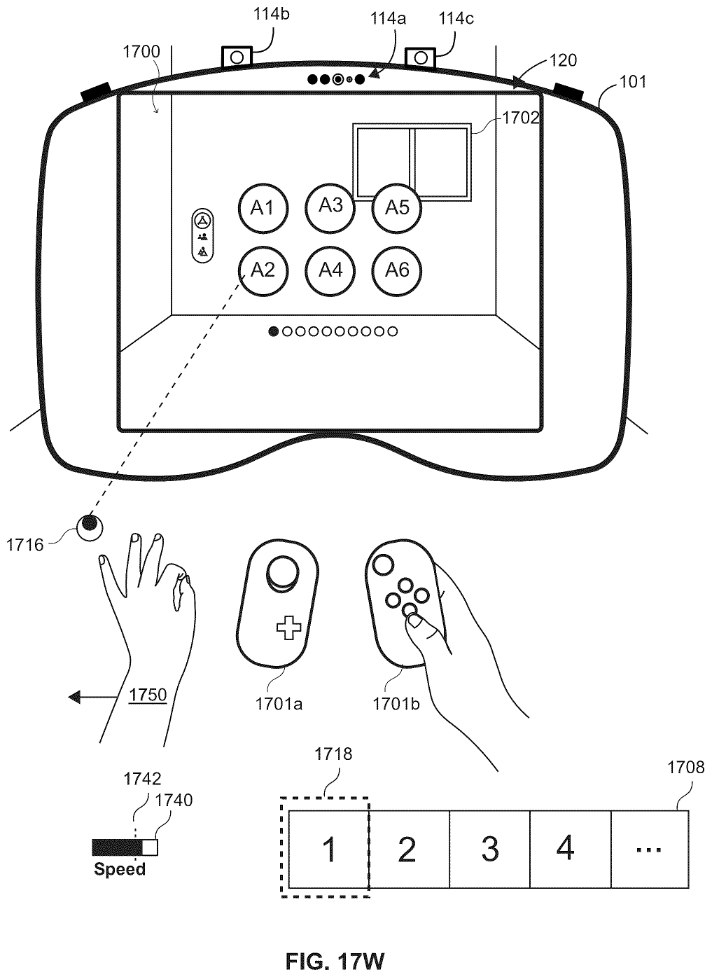

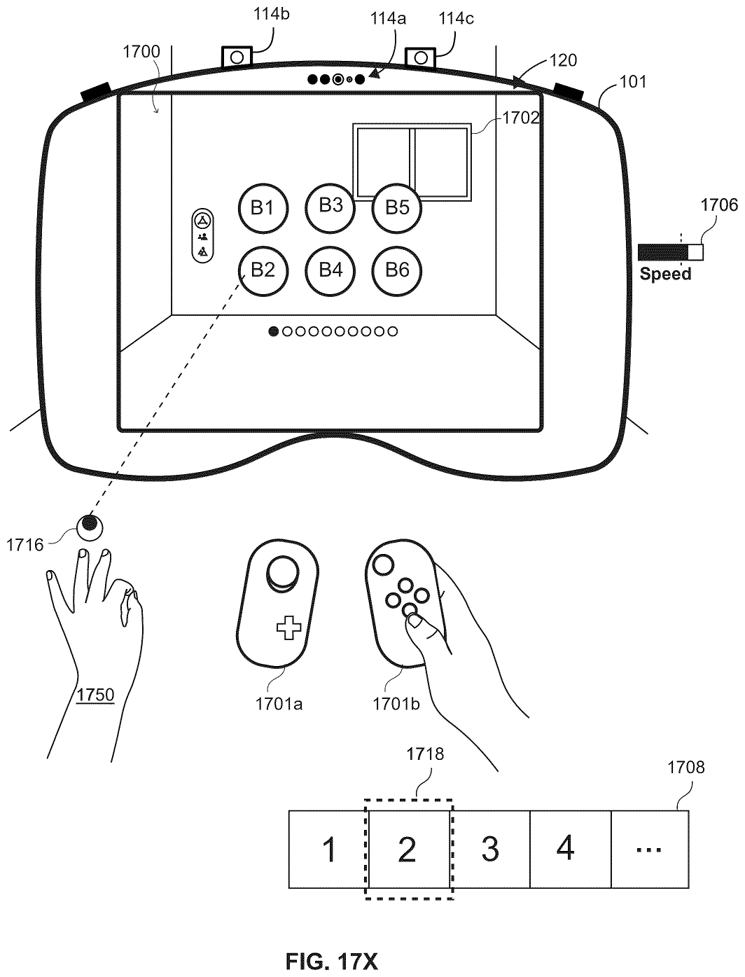

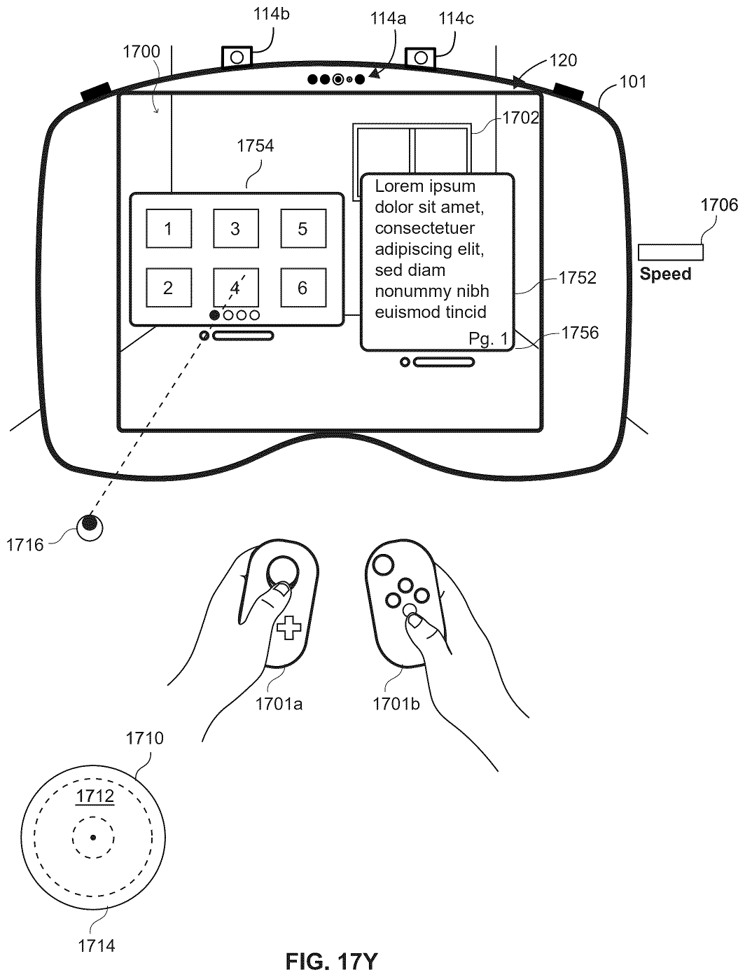

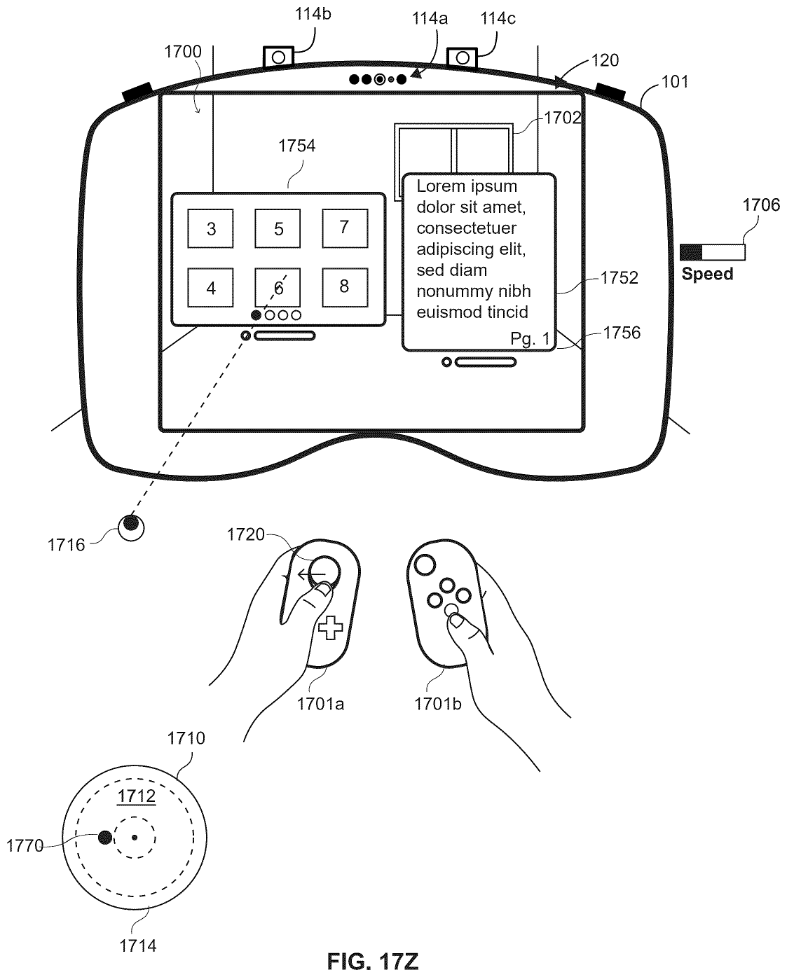

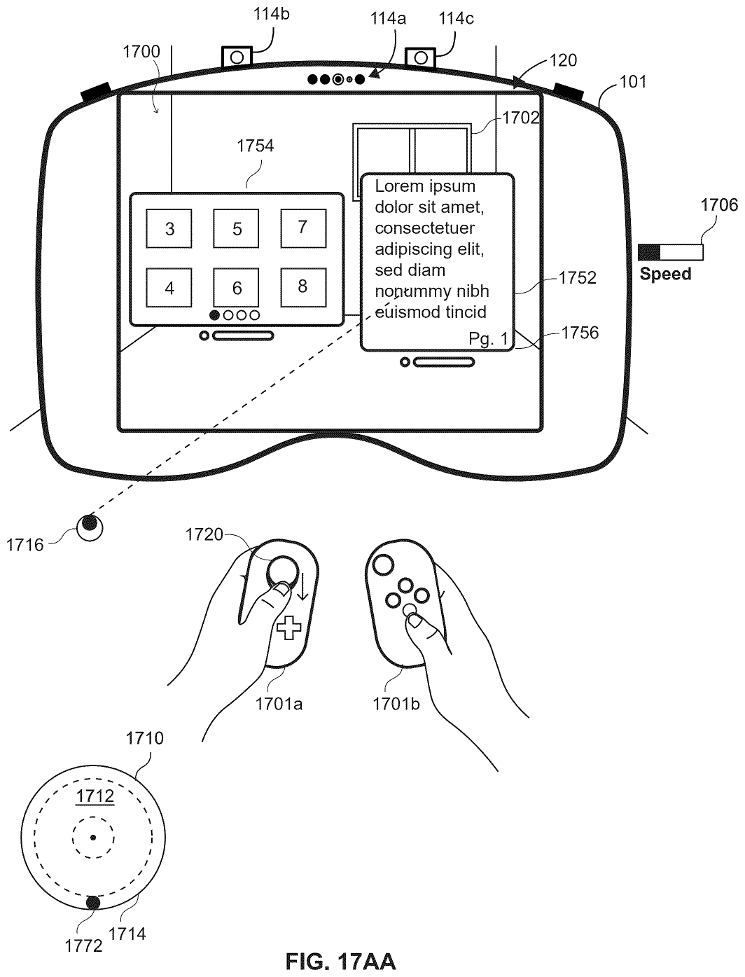

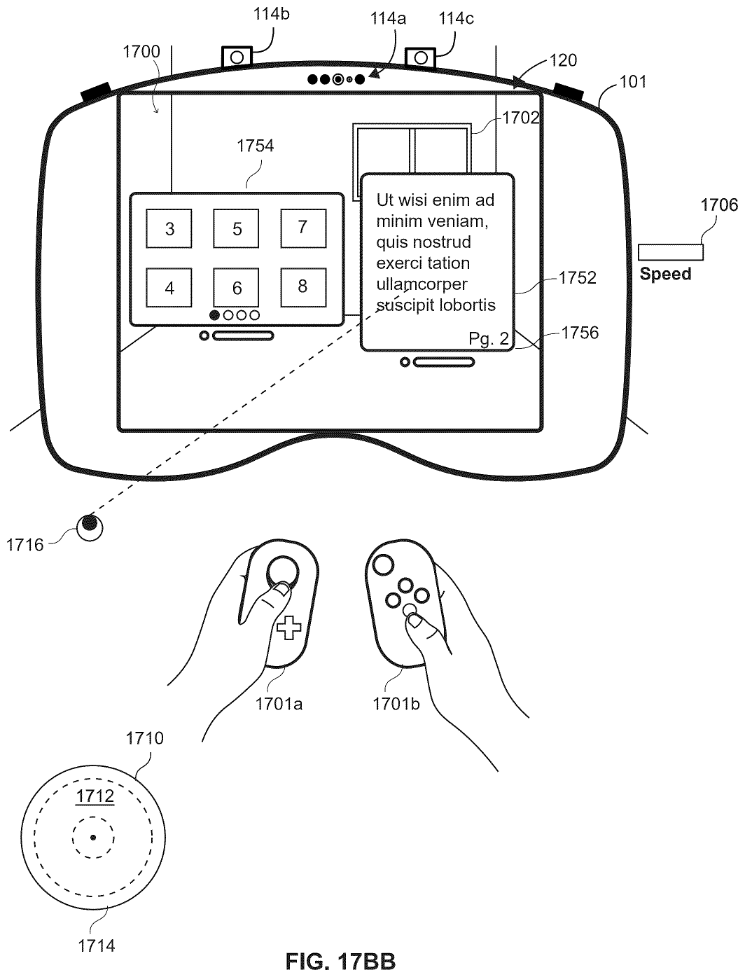

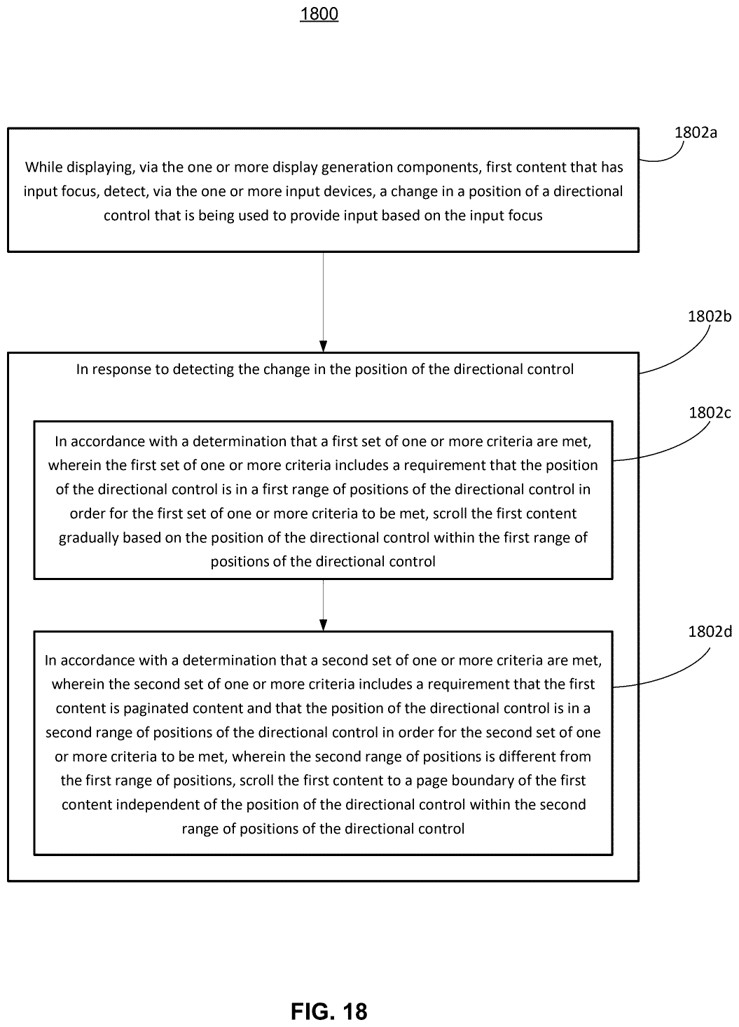

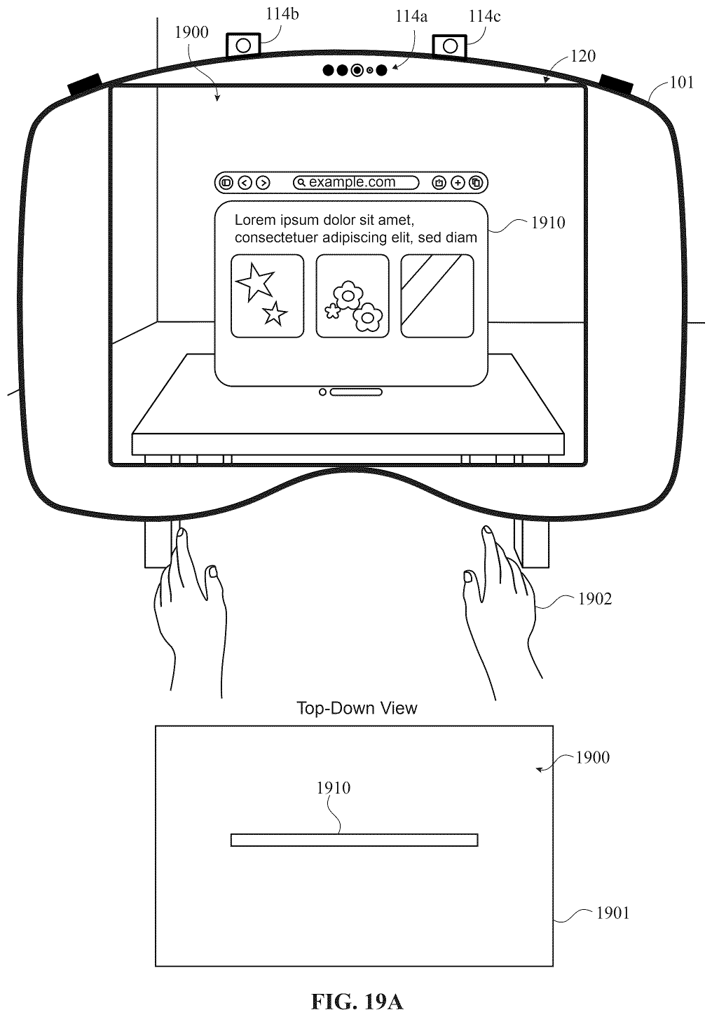

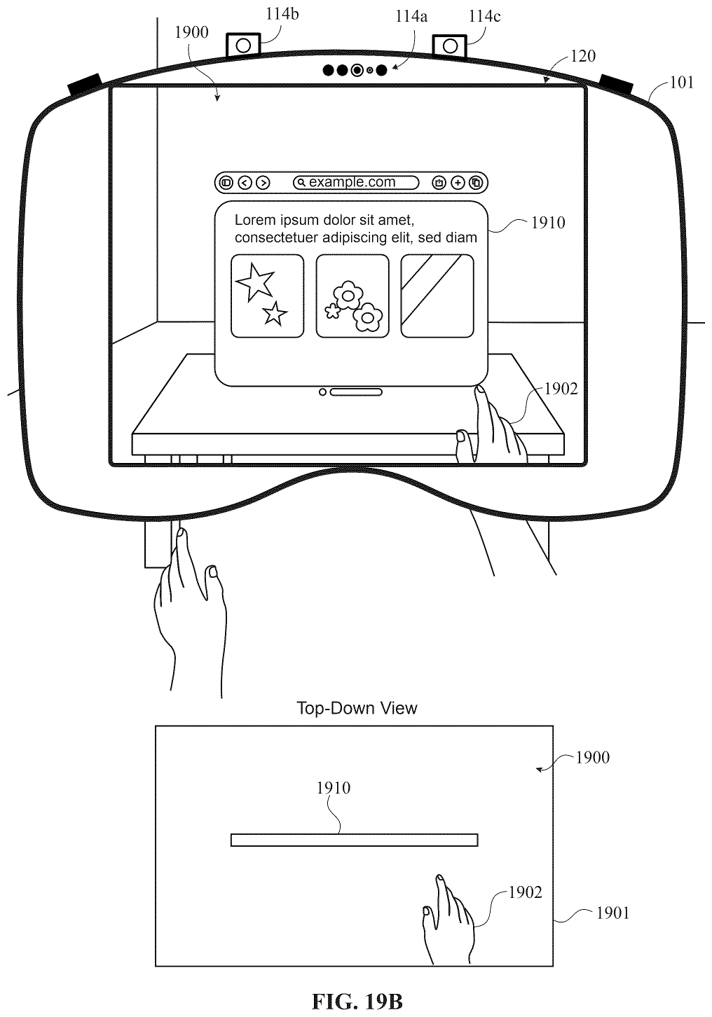

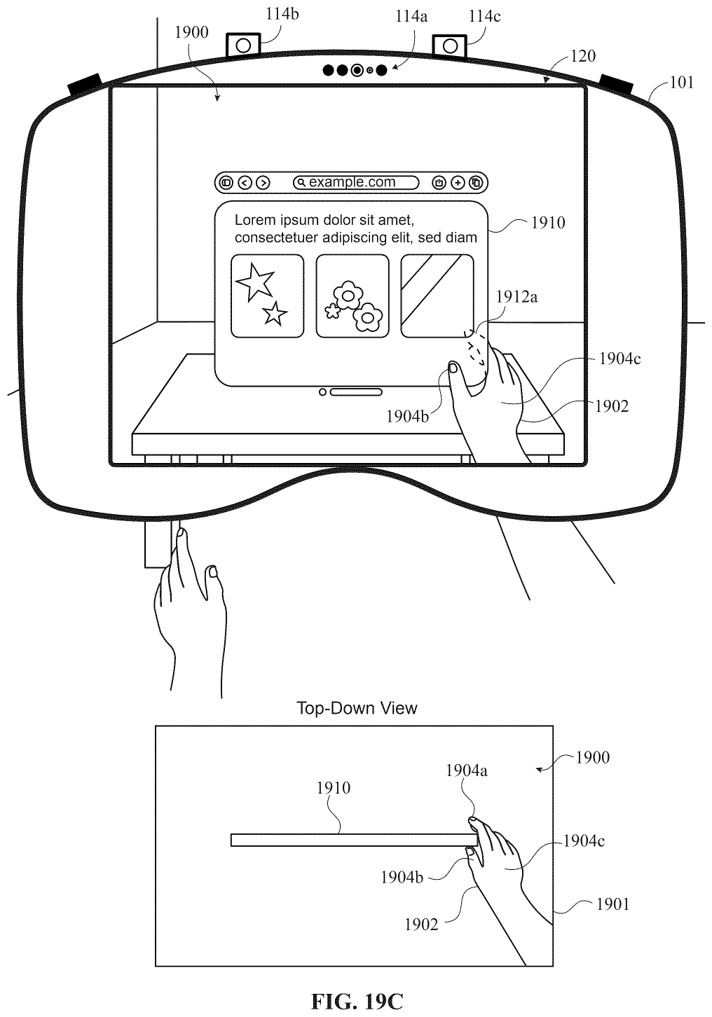

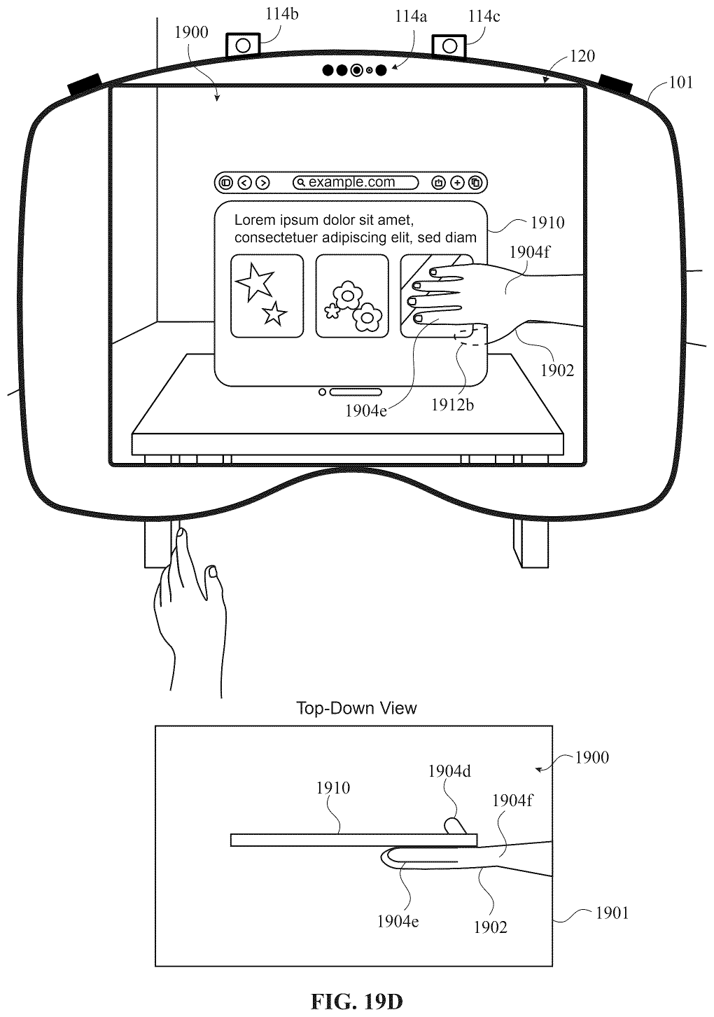

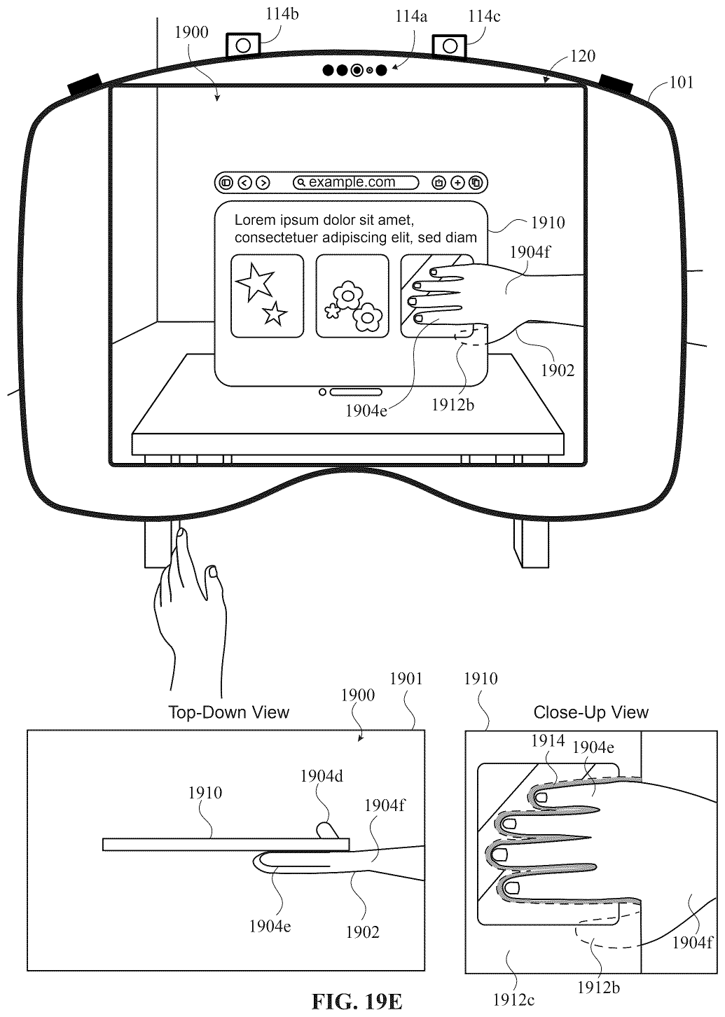

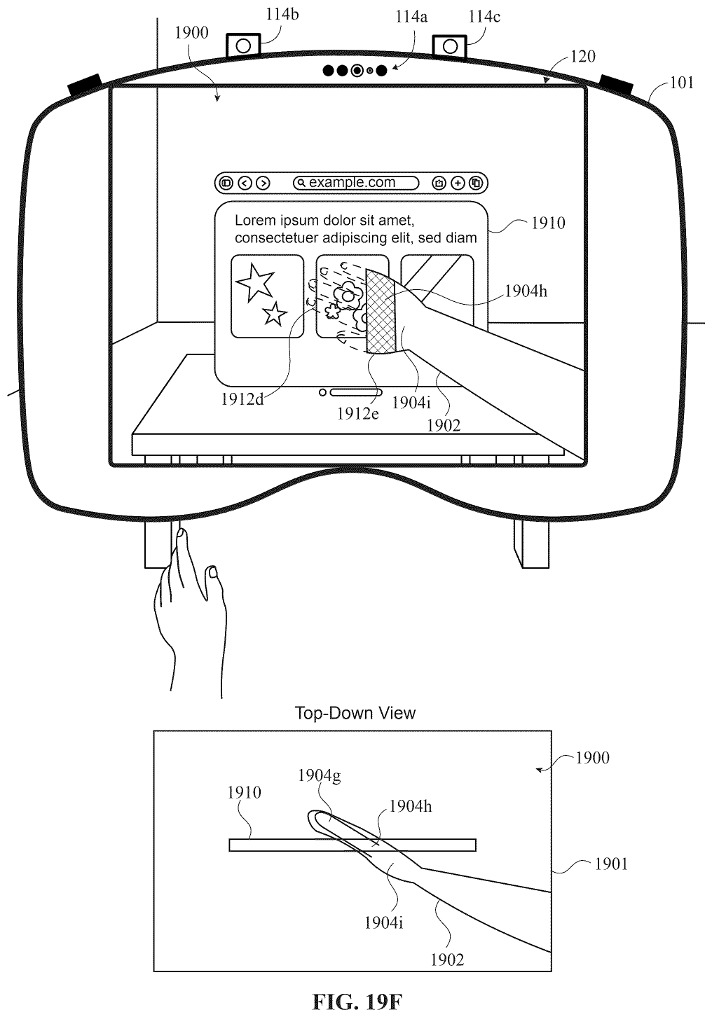

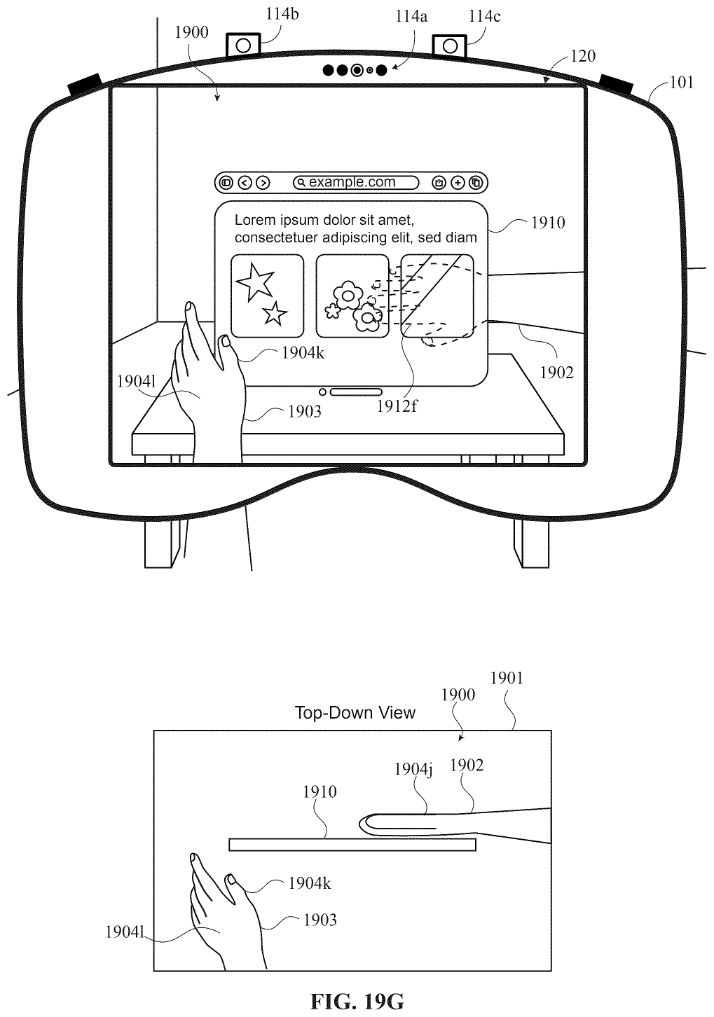

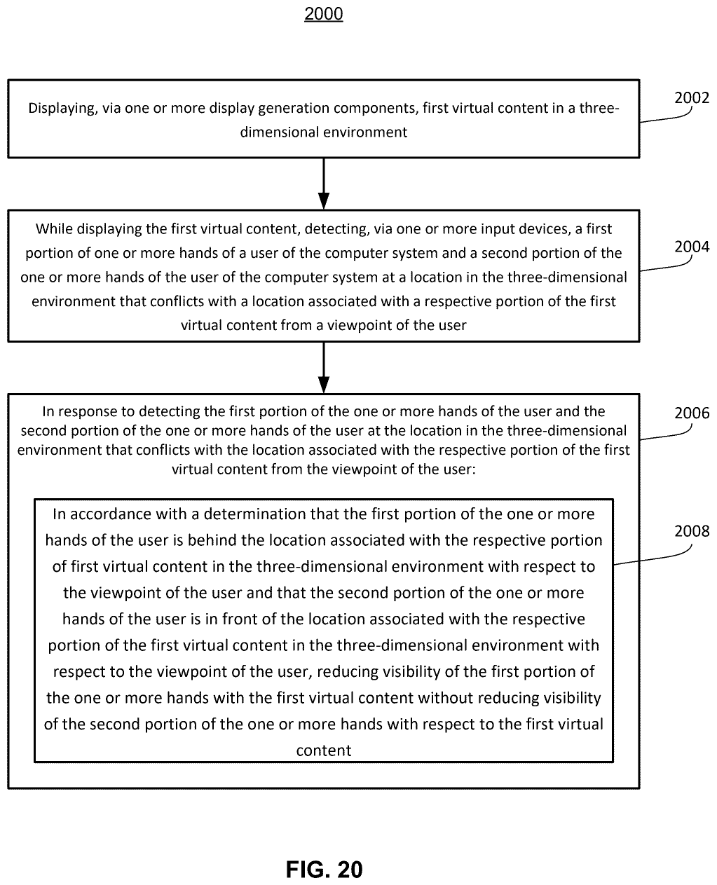

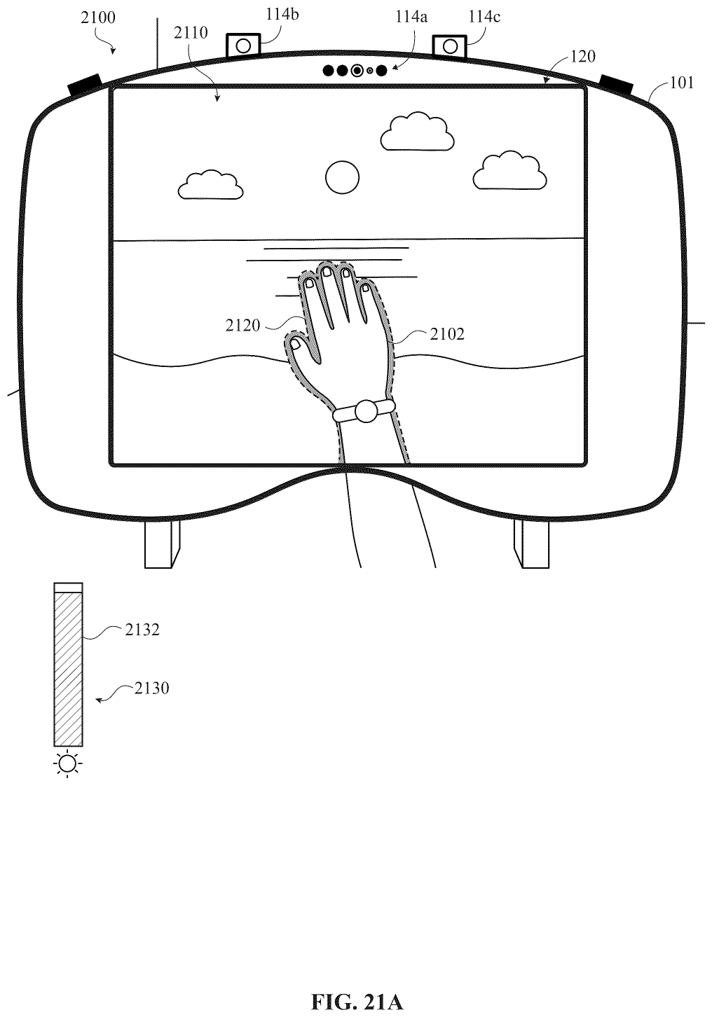

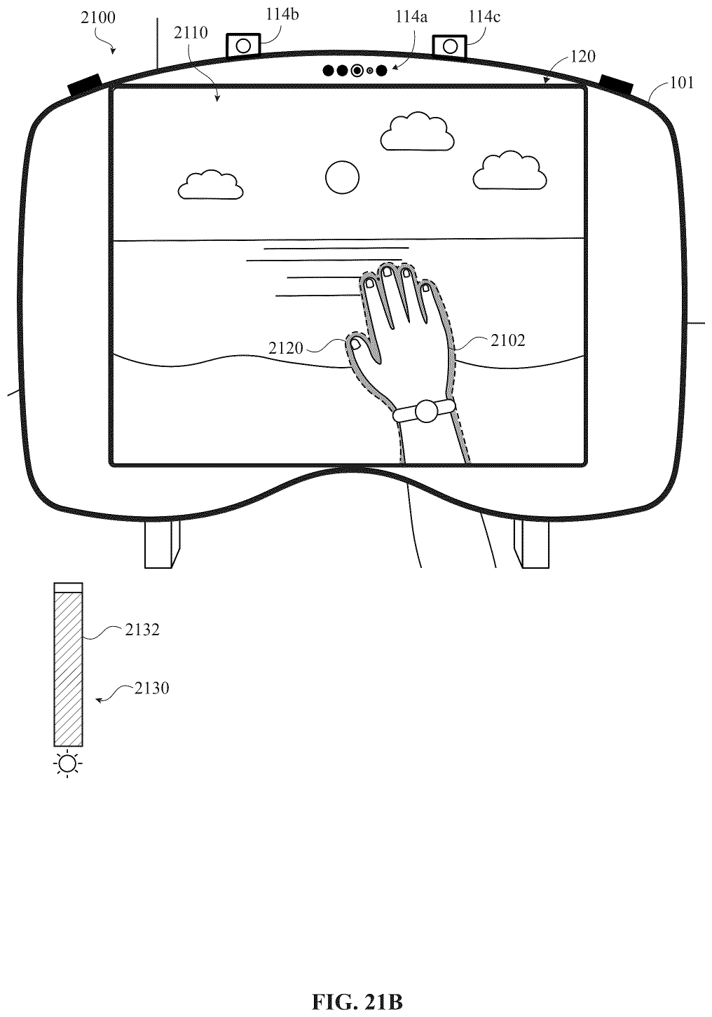

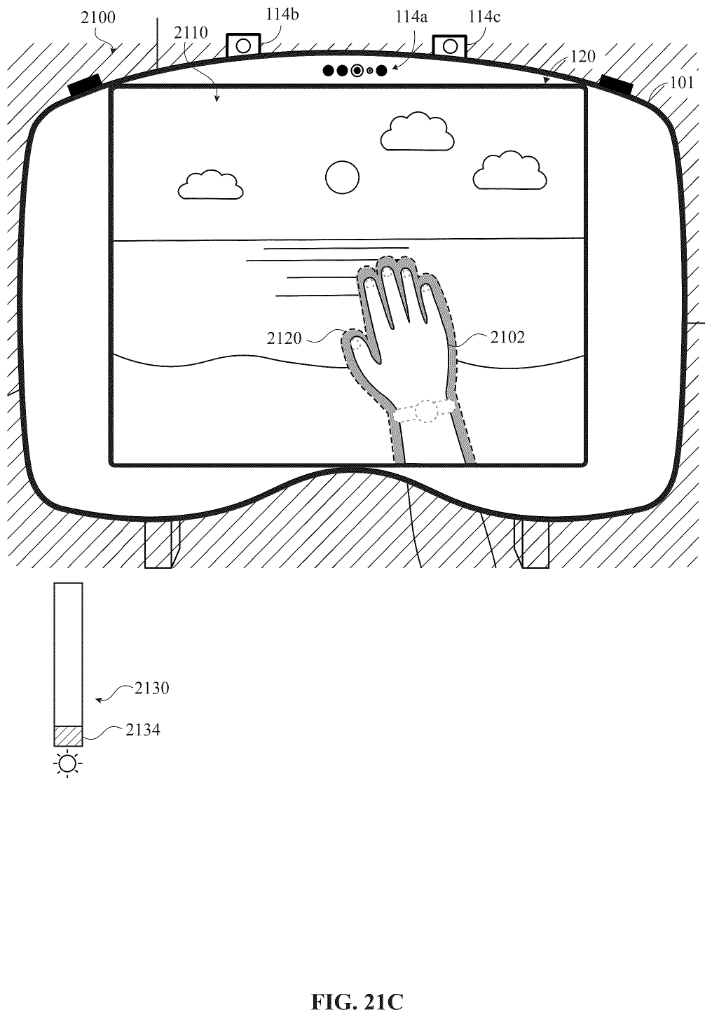

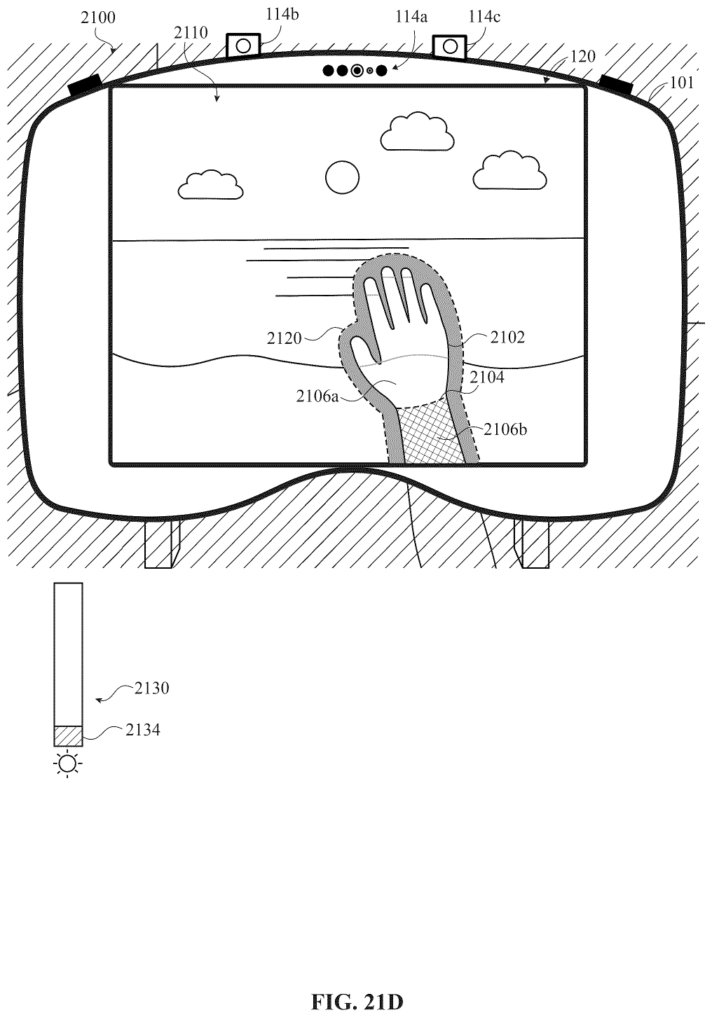

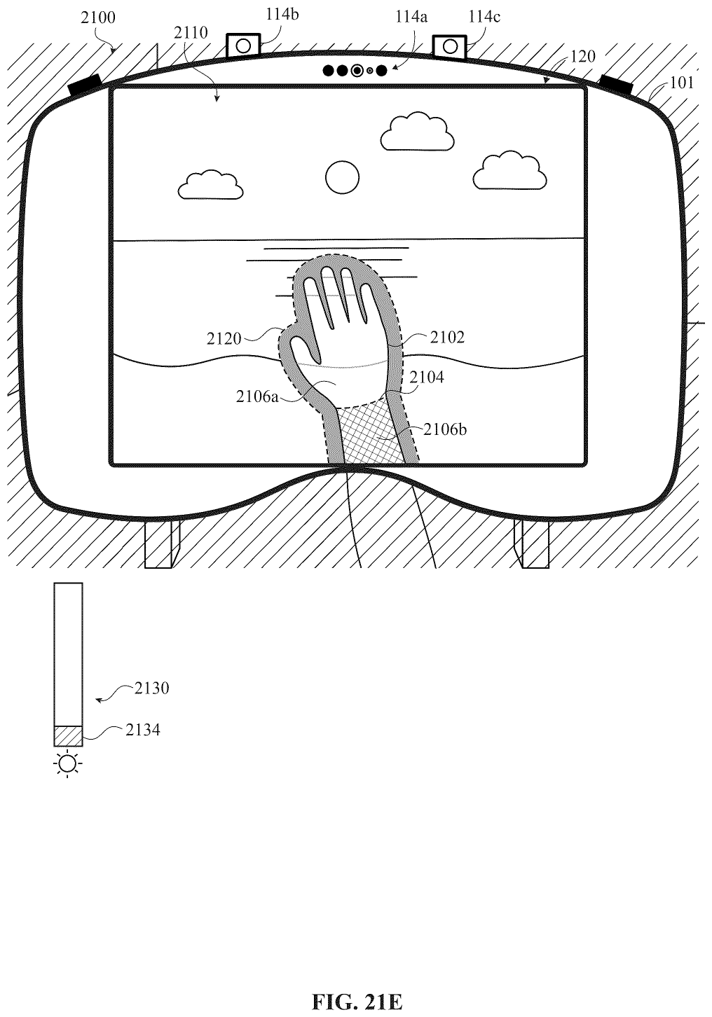

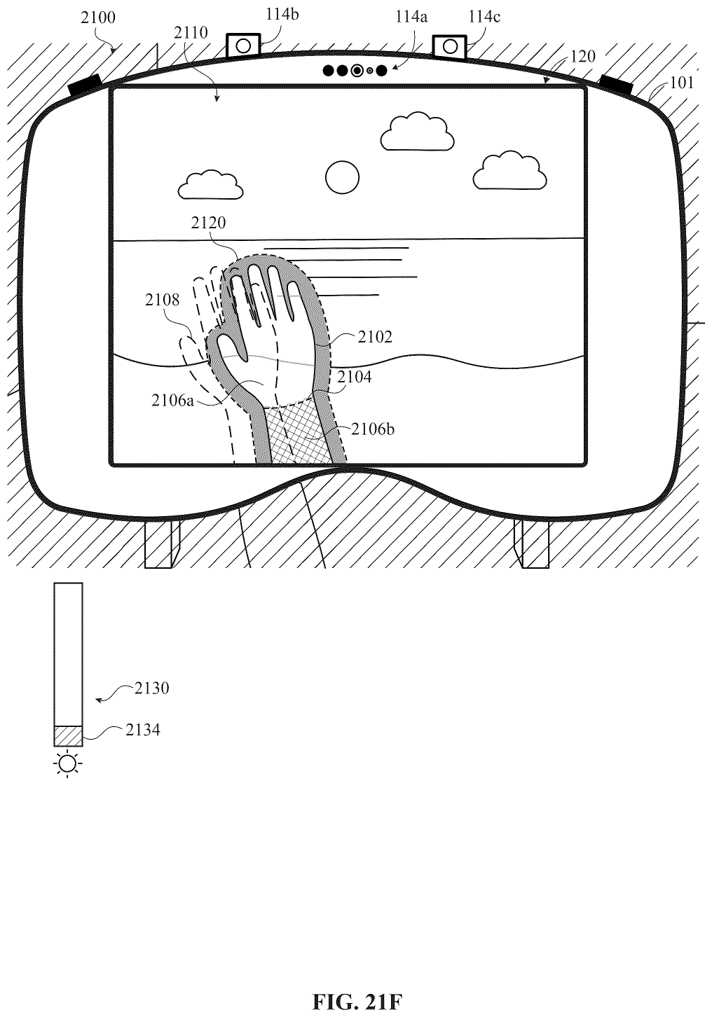

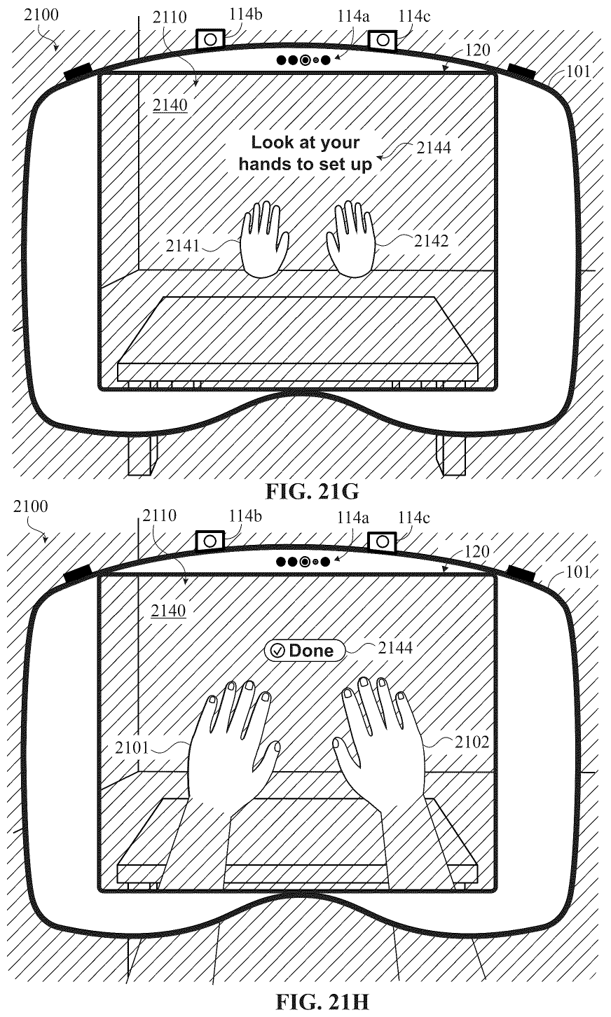

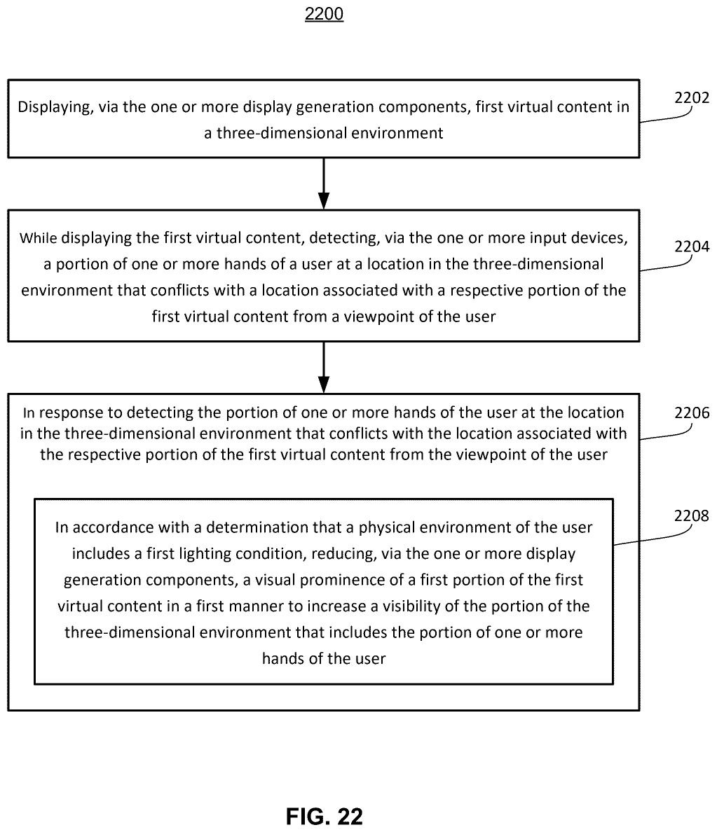

FIGS. 1A-6 provide a description of example computer systems for providing XR experiences to users (such as described below with respect to methods 800, 1000, 1200, 1400, 1600, 1800, 2000, and/or 2200). FIGS. 7A-7U illustrate example techniques of controlling a user interface element based on input from a directional control, in accordance with some embodiments. FIG. 8 illustrates a flow diagram of methods of controlling a user interface element based on input from a directional control, in accordance with some embodiments. The user interfaces in FIGS. 7A-7U are used to illustrate the processes in FIG. 8. FIGS. 9A-9U illustrate examples of a computer system performing one or more operations on virtual content items based on input focus at the computer system, in accordance with some embodiments of the disclosure. FIG. 10 is a flow diagram of methods of performing one or more operations on virtual content items based on input focus at a computer system, in accordance with some embodiments. The user interfaces in FIGS. 9A-9U are used to illustrate the processes in FIG. 10. FIGS. 11A-11Z illustrate example techniques of reducing the visual prominence of virtual content that is obscuring visibility of one or more objects based on object type, in accordance with some embodiments. FIG. 12 illustrates a flow diagram of methods of reducing the visual prominence of virtual content that is obscuring visibility of one or more objects based on object type, in accordance with some embodiments. The user interfaces in FIGS. 11A-11Z are used to illustrate the processes in FIG. 12. FIGS. 13A-13R illustrate example techniques for reducing the visual prominence of virtual content that is obscuring visibility of one or more objects based on whether the objects are being held by a user, in accordance with some embodiments. FIG. 14 illustrates a flow diagram of methods of reducing the visual prominence of virtual content that is obscuring visibility of one or more objects based on whether the objects are being held by a user, in accordance with some embodiments. The user interfaces in FIGS. 13A-13R are used to illustrate the processes in FIG. 14. FIGS. 15A-15H illustrate example techniques for reducing the visual prominence of virtual content that is obscuring visibility of one or more objects differently based on object type, in accordance with some embodiments. FIG. 16 illustrates a flow diagram of methods of reducing the visual prominence of virtual content that is obscuring visibility of one or more objects differently based on object type, in accordance with some embodiments. The user interfaces in FIGS. 15A-15H are used to illustrate the processes in FIG. 16. FIGS. 17A-17BB illustrate example techniques for scrolling through paginated content based on a range of positions of input from a directional control, in accordance with some embodiments. FIG. 18 illustrates a flow diagram of methods scrolling through paginated content based on a range of positions of input from a directional control, in accordance with some embodiments. The user interfaces in FIGS. 17A-17BB are used to illustrate the processes in FIG. 18. FIGS. 19A-19G illustrate example techniques for reducing visibility of a first portion of a hand with virtual content without reducing visibility of a second portion of the hand with virtual content based on the positions of the hands relative to virtual content, in accordance with some embodiments. FIG. 20 illustrates a flow diagram of methods of reducing visibility of a first portion of a hand with virtual content without reducing visibility of a second portion of the hand with virtual content based on the positions of the hands relative to virtual content, in accordance with some embodiments. The user interfaces in FIGS. 19A-19G are used to illustrate the processes in FIG. 20. FIGS. 21A-21H illustrate example techniques for reducing a visual prominence of a portion of virtual content to increase a visibility of a portion of a three-dimensional environment that includes one or more hands based on a lighting condition of the three-dimensional environment, in accordance with some embodiments. FIG. 22 illustrates a flow diagram of methods of reducing a visual prominence of a portion of virtual content to increase a visibility of a portion of a three-dimensional environment that includes one or more hands based on a lighting condition of the three-dimensional environment, in accordance with some embodiments. The user interfaces in FIGS. 21A-21H are used to illustrate the processes in FIG. 22.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improving privacy and/or security, providing a more varied, detailed, and/or realistic user experience while saving storage space, and/or additional techniques. These techniques also reduce power usage and improve battery life of the device by enabling the user to use the device more quickly and efficiently. Saving on battery power, and thus weight, improves the ergonomics of the device. These techniques also enable real-time communication, allow for the use of fewer and/or less-precise sensors resulting in a more compact, lighter, and cheaper device, and enable the device to be used in a variety of lighting conditions. These techniques reduce energy usage, thereby reducing heat emitted by the device, which is particularly important for a wearable device where a device well within operational parameters for device components can become uncomfortable for a user to wear if it is producing too much heat.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

In some embodiments, as shown in FIG. 1A, the XR experience is provided to the user via an operating environment 100 that includes a computer system 101. The computer system 101 includes a controller 110 (e.g., processors of a portable electronic device or a remote server), a display generation component 120 (e.g., a head-mounted device (HMD), a display, a projector, a touch-screen, etc.), one or more input devices 125 (e.g., an eye tracking device 130, a hand tracking device 140, other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, etc.), and optionally one or more peripheral devices 195 (e.g., home appliances, wearable devices, etc.). In some embodiments, one or more of the input devices 125, output devices 155, sensors 190, and peripheral devices 195 are integrated with the display generation component 120 (e.g., in a head-mounted device or a handheld device).

When describing an XR experience, various terms are used to differentially refer to several related but distinct environments that the user may sense and/or with which a user may interact (e.g., with inputs detected by a computer system 101 generating the XR experience that cause the computer system generating the XR experience to generate audio, visual, and/or tactile feedback corresponding to various inputs provided to the computer system 101). The following is a subset of these terms:

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Extended reality: In contrast, an extended reality (XR) environment refers to a wholly or partially simulated environment that people sense and/or interact with via an electronic system. In XR, a subset of a person's physical motions, or representations thereof, are tracked, and, in response, one or more characteristics of one or more virtual objects simulated in the XR environment are adjusted in a manner that comports with at least one law of physics. For example, a XR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a XR environment may be made in response to representations of physical motions (e.g., vocal commands). A person may sense and/or interact with a XR object using any one of their senses, including sight, sound, touch, taste, and smell. For example, a person may sense and/or interact with audio objects that create a 3D or spatial audio environment that provides the perception of point audio sources in 3D space. In another example, audio objects may enable audio transparency, which selectively incorporates ambient sounds from the physical environment with or without computer-generated audio. In some XR environments, a person may sense and/or interact only with audio objects.

Examples of XR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationary with respect to the physical ground.

Examples of mixed realities include augmented reality and augmented virtuality.

Augmented reality: An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

Augmented virtuality: An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

In an augmented reality, mixed reality, or virtual reality environment, a view of a three-dimensional environment is visible to a user. The view of the three-dimensional environment is typically visible to the user via one or more display generation components (e.g., a display or a pair of display modules that provide stereoscopic content to different eyes of the same user) through a virtual viewport that has a viewport boundary that defines an extent of the three-dimensional environment that is visible to the user via the one or more display generation components. In some embodiments, the region defined by the viewport boundary is smaller than a range of vision of the user in one or more dimensions (e.g., based on the range of vision of the user, size, optical properties or other physical characteristics of the one or more display generation components, and/or the location and/or orientation of the one or more display generation components relative to the eyes of the user). In some embodiments, the region defined by the viewport boundary is larger than a range of vision of the user in one or more dimensions (e.g., based on the range of vision of the user, size, optical properties or other physical characteristics of the one or more display generation components, and/or the location and/or orientation of the one or more display generation components relative to the eyes of the user). The viewport and viewport boundary typically move as the one or more display generation components move (e.g., moving with a head of the user for a head mounted device or moving with a hand of a user for a handheld device such as a tablet or smartphone). A viewpoint of a user determines what content is visible in the viewport, a viewpoint generally specfies a location and a direction relative to the three-dimensional environment, and as the viewpoint shifts, the view of the three-dimensional environment will also shift in the viewport. For a head mounted device, a viewpoint is typically based on a location an direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include display generation components with virtual passthrough, portions of the physical environment that are visible (e.g., displayed, and/or projected) via the one or more display generation components are based on a field of view of one or more cameras in communication with the display generation components which typically move with the display generation components (e.g., moving with a head of the user for a head mounted device or moving with a hand of a user for a handheld device such as a tablet or smartphone) because the viewpoint of the user moves as the field of view of the one or more cameras moves (and the appearance of one or more virtual objects displayed via the one or more display generation components is updated based on the viewpoint of the user (e.g., displayed positions and poses of the virtual objects are updated based on the movement of the viewpoint of the user)). For display generation components with optical passthrough, portions of the physical environment that are visible (e.g., optically visible through one or more partially or fully transparent portions of the display generation component) via the one or more display generation components are based on a field of view of a user through the partially or fully transparent portion(s) of the display generation component (e.g., moving with a head of the user for a head mounted device or moving with a hand of a user for a handheld device such as a tablet or smartphone) because the viewpoint of the user moves as the field of view of the user through the partially or fully transparent portions of the display generation components moves (and the appearance of one or more virtual objects is updated based on the viewpoint of the user).

In some embodiments a representation of a physical environment (e.g., displayed via virtual passthrough or optical passthrough) can be partially or fully obscured by a virtual environment. In some embodiments, the amount of virtual environment that is displayed (e.g., the amount of physical environment that is not displayed) is based on an immersion level for the virtual environment (e.g., with respect to the representation of the physical environment). For example, increasing the immersion level optionally causes more of the virtual environment to be displayed, replacing and/or obscuring more of the physical environment, and reducing the immersion level optionally causes less of the virtual environment to be displayed, revealing portions of the physical environment that were previously not displayed and/or obscured. In some embodiments, at a particular immersion level, one or more first background objects (e.g., in the representation of the physical environment) are visually de-emphasized (e.g., dimmed, blurred, and/or displayed with increased transparency) more than one or more second background objects, and one or more third background objects cease to be displayed. In some embodiments, a level of immersion includes an associated degree to which the virtual content displayed by the computer system (e.g., the virtual environment and/or the virtual content) obscures background content (e.g., content other than the virtual environment and/or the virtual content) around/behind the virtual content, optionally including the number of items of background content displayed and/or the visual characteristics (e.g., colors, contrast, and/or opacity) with which the background content is displayed, the angular range of the virtual content displayed via the display generation component (e.g., 60 degrees of content displayed at low immersion, 120 degrees of content displayed at medium immersion, or 180 degrees of content displayed at high immersion), and/or the proportion of the field of view displayed via the display generation component that is consumed by the virtual content (e.g., 33% of the field of view consumed by the virtual content at low immersion, 66% of the field of view consumed by the virtual content at medium immersion, or 100% of the field of view consumed by the virtual content at high immersion). In some embodiments, the background content is included in a background over which the virtual content is displayed (e.g., background content in the representation of the physical environment). In some embodiments, the background content includes user interfaces (e.g., user interfaces generated by the computer system corresponding to applications), virtual objects (e.g., files or representations of other users generated by the computer system) not associated with or included in the virtual environment and/or virtual content, and/or real objects (e.g., pass-through objects representing real objects in the physical environment around the user that are visible such that they are displayed via the display generation component and/or a visible via a transparent or translucent component of the display generation component because the computer system does not obscure/prevent visibility of them through the display generation component). In some embodiments, at a low level of immersion (e.g., a first level of immersion), the background, virtual and/or real objects are displayed in an unobscured manner. For example, a virtual environment with a low level of immersion is optionally displayed concurrently with the background content, which is optionally displayed with full brightness, color, and/or translucency. In some embodiments, at a higher level of immersion (e.g., a second level of immersion higher than the first level of immersion), the background, virtual and/or real objects are displayed in an obscured manner (e.g., dimmed, blurred, or removed from display). For example, a respective virtual environment with a high level of immersion is displayed without concurrently displaying the background content (e.g., in a full screen or fully immersive mode). As another example, a virtual environment displayed with a medium level of immersion is displayed concurrently with darkened, blurred, or otherwise de-emphasized background content. In some embodiments, the visual characteristics of the background objects vary among the background objects. For example, at a particular immersion level, one or more first background objects are visually de-emphasized (e.g., dimmed, blurred, and/or displayed with increased transparency) more than one or more second background objects, and one or more third background objects cease to be displayed. In some embodiments, a null or zero level of immersion corresponds to the virtual environment ceasing to be displayed and instead a representation of a physical environment is displayed (optionally with one or more virtual objects such as application, windows, or virtual three-dimensional objects) without the representation of the physical environment being obscured by the virtual environment. Adjusting the level of immersion using a physical input element provides for quick and efficient method of adjusting immersion, which enhances the operability of the computer system and makes the user-device interface more efficient.

Viewpoint-locked virtual object: A virtual object is viewpoint-locked when a computer system displays the virtual object at the same location and/or position in the viewpoint of the user, even as the viewpoint of the user shifts (e.g., changes). In embodiments where the computer system is a head-mounted device, the viewpoint of the user is locked to the forward facing direction of the user's head (e.g., the viewpoint of the user is at least a portion of the field-of-view of the user when the user is looking straight ahead); thus, the viewpoint of the user remains fixed even as the user's gaze is shifted, without moving the user's head. In embodiments where the computer system has a display generation component (e.g., a display screen) that can be repositioned with respect to the user's head, the viewpoint of the user is the augmented reality view that is being presented to the user on a display generation component of the computer system. For example, a viewpoint-locked virtual object that is displayed in the upper left corner of the viewpoint of the user, when the viewpoint of the user is in a first orientation (e.g., with the user's head facing north) continues to be displayed in the upper left corner of the viewpoint of the user, even as the viewpoint of the user changes to a second orientation (e.g., with the user's head facing west). In other words, the location and/or position at which the viewpoint-locked virtual object is displayed in the viewpoint of the user is independent of the user's position and/or orientation in the physical environment. In embodiments in which the computer system is a head-mounted device, the viewpoint of the user is locked to the orientation of the user's head, such that the virtual object is also referred to as a “head-locked virtual object.”

Environment-locked virtual object: A virtual object is environment-locked (alternatively, “world-locked”) when a computer system displays the virtual object at a location and/or position in the viewpoint of the user that is based on (e.g., selected in reference to and/or anchored to) a location and/or object in the three-dimensional environment (e.g., a physical environment or a virtual environment). As the viewpoint of the user shifts, the location and/or object in the environment relative to the viewpoint of the user changes, which results in the environment-locked virtual object being displayed at a different location and/or position in the viewpoint of the user. For example, an environment-locked virtual object that is locked onto a tree that is immediately in front of a user is displayed at the center of the viewpoint of the user. When the viewpoint of the user shifts to the right (e.g., the user's head is turned to the right) so that the tree is now left-of-center in the viewpoint of the user (e.g., the tree's position in the viewpoint of the user shifts), the environment-locked virtual object that is locked onto the tree is displayed left-of-center in the viewpoint of the user. In other words, the location and/or position at which the environment-locked virtual object is displayed in the viewpoint of the user is dependent on the position and/or orientation of the location and/or object in the environment onto which the virtual object is locked. In some embodiments, the computer system uses a stationary frame of reference (e.g., a coordinate system that is anchored to a fixed location and/or object in the physical environment) in order to determine the position at which to display an environment-locked virtual object in the viewpoint of the user. An environment-locked virtual object can be locked to a stationary part of the environment (e.g., a floor, wall, table, or other stationary object) or can be locked to a moveable part of the environment (e.g., a vehicle, animal, person, or even a representation of portion of the users body that moves independently of a viewpoint of the user, such as a user's hand, wrist, arm, or foot) so that the virtual object is moved as the viewpoint or the portion of the environment moves to maintain a fixed relationship between the virtual object and the portion of the environment.

In some embodiments a virtual object that is environment-locked or viewpoint-locked exhibits lazy follow behavior which reduces or delays motion of the environment-locked or viewpoint-locked virtual object relative to movement of a point of reference which the virtual object is following. In some embodiments, when exhibiting lazy follow behavior the computer system intentionally delays movement of the virtual object when detecting movement of a point of reference (e.g., a portion of the environment, the viewpoint, or a point that is fixed relative to the viewpoint, such as a point that is between 5-300 cm from the viewpoint) which the virtual object is following. For example, when the point of reference (e.g., the portion of the environment or the viewpoint) moves with a first speed, the virtual object is moved by the device to remain locked to the point of reference but moves with a second speed that is slower than the first speed (e.g., until the point of reference stops moving or slows down, at which point the virtual object starts to catch up to the point of reference). In some embodiments, when a virtual object exhibits lazy follow behavior the device ignores small amounts of movement of the point of reference (e.g., ignoring movement of the point of reference that is below a threshold amount of movement such as movement by 0-5 degrees or movement by 0-50 cm). For example, when the point of reference (e.g., the portion of the environment or the viewpoint to which the virtual object is locked) moves by a first amount, a distance between the point of reference and the virtual object increases (e.g., because the virtual object is being displayed so as to maintain a fixed or substantially fixed position relative to a viewpoint or portion of the environment that is different from the point of reference to which the virtual object is locked) and when the point of reference (e.g., the portion of the environment or the viewpoint to which the virtual object is locked) moves by a second amount that is greater than the first amount, a distance between the point of reference and the virtual object initially increases (e.g., because the virtual object is being displayed so as to maintain a fixed or substantially fixed position relative to a viewpoint or portion of the environment that is different from the point of reference to which the virtual object is locked) and then decreases as the amount of movement of the point of reference increases above a threshold (e.g., a “lazy follow” threshold) because the virtual object is moved by the computer system to maintain a fixed or substantially fixed position relative to the point of reference. In some embodiments the virtual object maintaining a substantially fixed position relative to the point of reference includes the virtual object being displayed within a threshold distance (e.g., 1, 2, 3, 5, 15, 20, 50 cm) of the point of reference in one or more dimensions (e.g., up/down, left/right, and/or forward/backward relative to the position of the point of reference).

Hardware: There are many different types of electronic systems that enable a person to sense and/or interact with various XR environments. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may have one or more speaker(s) and an integrated opaque display. Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. In some embodiments, the controller 110 is configured to manage and coordinate a XR experience for the user. In some embodiments, the controller 110 includes a suitable combination of software, firmware, and/or hardware. The controller 110 is described in greater detail below with respect to FIG. 2. In some embodiments, the controller 110 is a computing device that is local or remote relative to the scene 105 (e.g., a physical environment). For example, the controller 110 is a local server located within the scene 105. In another example, the controller 110 is a remote server located outside of the scene 105 (e.g., a cloud server, central server, etc.). In some embodiments, the controller 110 is communicatively coupled with the display generation component 120 (e.g., an HMD, a display, a projector, a touch-screen, etc.) via one or more wired or wireless communication channels 144 (e.g., BLUETOOTH, IEEE 802.11x, IEEE 802.16x, IEEE 802.3x, etc.). In another example, the controller 110 is included within the enclosure (e.g., a physical housing) of the display generation component 120 (e.g., an HMD, or a portable electronic device that includes a display and one or more processors, etc.), one or more of the input devices 125, one or more of the output devices 155, one or more of the sensors 190, and/or one or more of the peripheral devices 195, or share the same physical enclosure or support structure with one or more of the above.

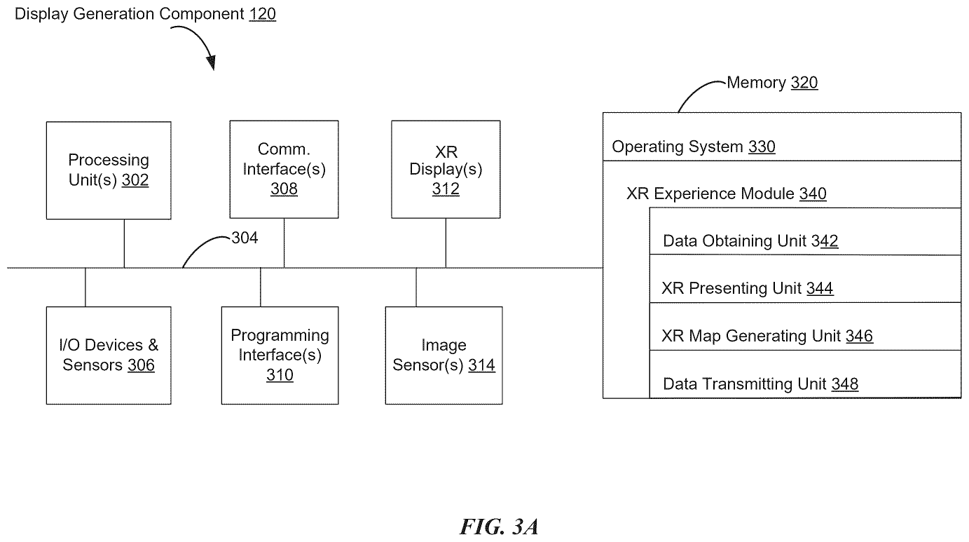

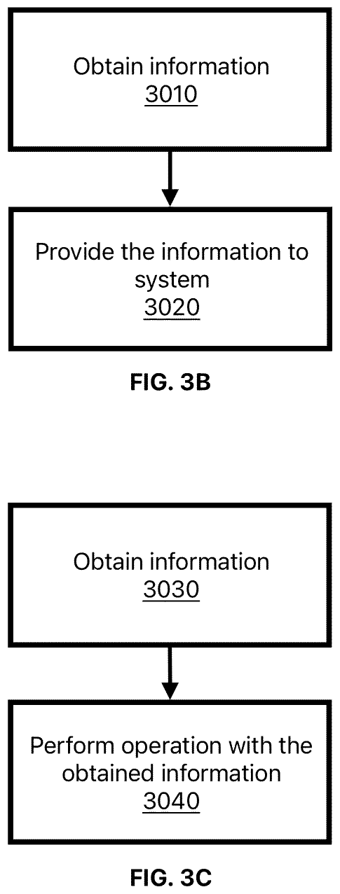

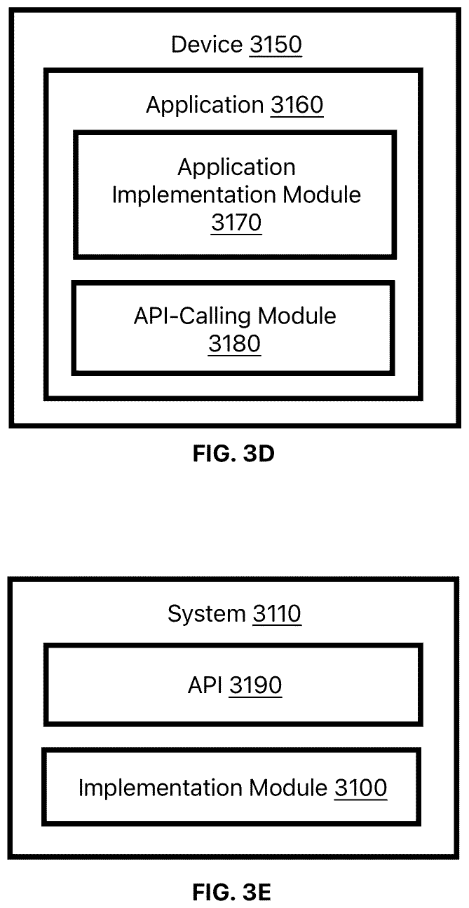

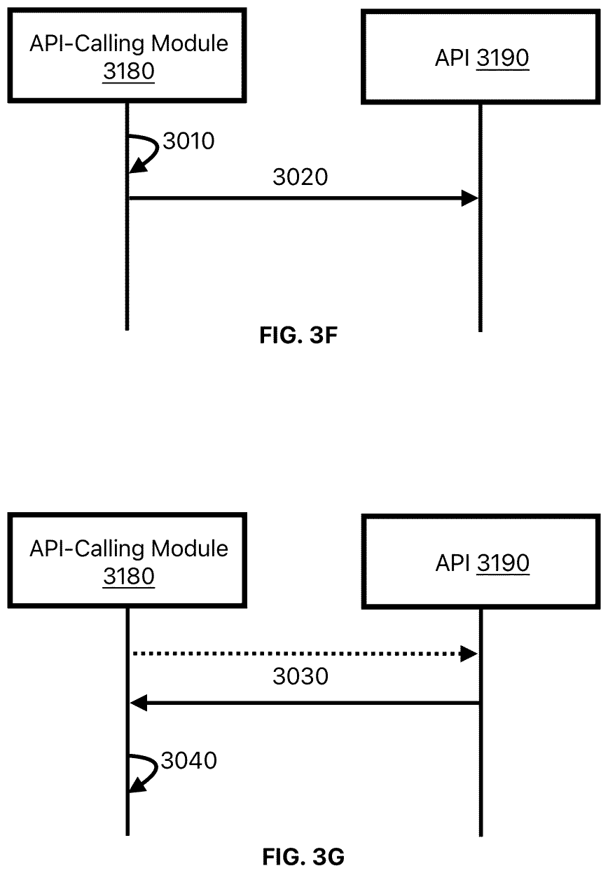

In some embodiments, the display generation component 120 is configured to provide the XR experience (e.g., at least a visual component of the XR experience) to the user. In some embodiments, the display generation component 120 includes a suitable combination of software, firmware, and/or hardware. The display generation component 120 is described in greater detail below with respect to FIG. 3A. In some embodiments, the functionalities of the controller 110 are provided by and/or combined with the display generation component 120.

According to some embodiments, the display generation component 120 provides an XR experience to the user while the user is virtually and/or physically present within the scene 105.

In some embodiments, the display generation component is worn on a part of the user's body (e.g., on his/her head, on his/her hand, etc.). As such, the display generation component 120 includes one or more XR displays provided to display the XR content. For example, in various embodiments, the display generation component 120 encloses the field-of-view of the user. In some embodiments, the display generation component 120 is a handheld device (such as a smartphone or tablet) configured to present XR content, and the user holds the device with a display directed towards the field-of-view of the user and a camera directed towards the scene 105. In some embodiments, the handheld device is optionally placed within an enclosure that is worn on the head of the user. In some embodiments, the handheld device is optionally placed on a support (e.g., a tripod) in front of the user. In some embodiments, the display generation component 120 is a XR chamber, enclosure, or room configured to present XR content in which the user does not wear or hold the display generation component 120. Many user interfaces described with reference to one type of hardware for displaying XR content (e.g., a handheld device or a device on a tripod) could be implemented on another type of hardware for displaying XR content (e.g., an HMD or other wearable computing device). For example, a user interface showing interactions with XR content triggered based on interactions that happen in a space in front of a handheld or tripod mounted device could similarly be implemented with an HMD where the interactions happen in a space in front of the HMD and the responses of the XR content are displayed via the HMD. Similarly, a user interface showing interactions with XR content triggered based on movement of a handheld or tripod mounted device relative to the physical environment (e.g., the scene 105 or a part of the user's body (e.g., the user's eye(s), head, or hand)) could similarly be implemented with an HMD where the movement is caused by movement of the HMD relative to the physical environment (e.g., the scene 105 or a part of the user's body (e.g., the user's eye(s), head, or hand)).

While pertinent features of the operating environment 100 are shown in FIG. 1A, those of ordinary skill in the art will appreciate from the present disclosure that various other features have not been illustrated for the sake of brevity and so as not to obscure more pertinent aspects of the example embodiments disclosed herein.

FIGS. 1A-1P illustrate various examples of a computer system that is used to perform the methods and provide audio, visual and/or haptic feedback as part of user interfaces described herein. In some embodiments, the computer system includes one or more display generation components (e.g., first and second display assemblies 1-120a, 1-120b and/or first and second optical modules 11.1.1-104a and 11.1.1-104b) for displaying virtual elements and/or a representation of a physical environment to a user of the computer system, optionally generated based on detected events and/or user inputs detected by the computer system. User interfaces generated by the computer system are optionally corrected by one or more corrective lenses 11.3.2-216 that are optionally removably attached to one or more of the optical modules to enable the user interfaces to be more easily viewed by users who would otherwise use glasses or contacts to correct their vision. While many user interfaces illustrated herein show a single view of a user interface, user interfaces in a HMD are optionally displayed using two optical modules (e.g., first and second display assemblies 1-120a, 1-120b and/or first and second optical modules 11.1.1-104a and 11.1.1-104b), one for a user's right eye and a different one for a user's left eye, and slightly different images are presented to the two different eyes to generate the illusion of stereoscopic depth, the single view of the user interface would typically be either a right-eye or left-eye view and the depth effect is explained in the text or using other schematic charts or views. In some embodiments, the computer system includes one or more external displays (e.g., display assembly 1-108) for displaying status information for the computer system to the user of the computer system (when the computer system is not being worn) and/or to other people who are near the computer system, optionally generated based on detected events and/or user inputs detected by the computer system. In some embodiments, the computer system includes one or more audio output components (e.g., electronic component 1-112) for generating audio feedback, optionally generated based on detected events and/or user inputs detected by the computer system. In some embodiments, the computer system includes one or more input devices for detecting input such as one or more sensors (e.g., one or more sensors in sensor assembly 1-356, and/or FIG. 1I) for detecting information about a physical environment of the device which can be used (optionally in conjunction with one or more illuminators such as the illuminators described in FIG. 1I) to generate a digital passthrough image, capture visual media corresponding to the physical environment (e.g., photos and/or video), or determine a pose (e.g., position and/or orientation) of physical objects and/or surfaces in the physical environment so that virtual objects ban be placed based on a detected pose of physical objects and/or surfaces. In some embodiments, the computer system includes one or more input devices for detecting input such as one or more sensors for detecting hand position and/or movement (e.g., one or more sensors in sensor assembly 1-356, and/or FIG. 1I) that can be used (optionally in conjunction with one or more illuminators such as the illuminators 6-124 described in FIG. 1I) to determine when one or more air gestures have been performed. In some embodiments, the computer system includes one or more input devices for detecting input such as one or more sensors for detecting eye movement (e.g., eye tracking and gaze tracking sensors in FIG. 1I) which can be used (optionally in conjunction with one or more lights such as lights 11.3.2-110 in FIG. 1O) to determine attention or gaze position and/or gaze movement which can optionally be used to detect gaze-only inputs based on gaze movement and/or dwell. A combination of the various sensors described above can be used to determine user facial expressions and/or hand movements for use in generating an avatar or representation of the user such as an anthropomorphic avatar or representation for use in a real-time communication session where the avatar has facial expressions, hand movements, and/or body movements that are based on or similar to detected facial expressions, hand movements, and/or body movements of a user of the device. Gaze and/or attention information is, optionally, combined with hand tracking information to determine interactions between the user and one or more user interfaces based on direct and/or indirect inputs such as air gestures or inputs that use one or more hardware input devices such as one or more buttons (e.g., first button 1-128, button 11.1.1-114, second button 1-132, and or dial or button 1-328), knobs (e.g., first button 1-128, button 11.1.1-114, and/or dial or button 1-328), digital crowns (e.g., first button 1-128 which is depressible and twistable or rotatable, button 11.1.1-114, and/or dial or button 1-328), trackpads, touch screens, keyboards, mice and/or other input devices. One or more buttons (e.g., first button 1-128, button 11.1.1-114, second button 1-132, and or dial or button 1-328) are optionally used to perform system operations such as recentering content in three-dimensional environment that is visible to a user of the device, displaying a home user interface for launching applications, starting real-time communication sessions, or initiating display of virtual three-dimensional backgrounds. Knobs or digital crowns (e.g., first button 1-128 which is depressible and twistable or rotatable, button 11.1.1-114, and/or dial or button 1-328) are optionally rotatable to adjust parameters of the visual content such as a level of immersion of a virtual three-dimensional environment (e.g., a degree to which virtual-content occupies the viewport of the user into the three-dimensional environment) or other parameters associated with the three-dimensional environment and the virtual content that is displayed via the optical modules (e.g., first and second display assemblies 1-120a, 1-120b and/or first and second optical modules 11.1.1-104a and 11.1.1-104b).

FIG. 1B illustrates a front, top, perspective view of an example of a head-mountable display (HMD) device 1-100 configured to be donned by a user and provide virtual and altered/mixed reality (VR/AR) experiences. The HMD 1-100 can include a display unit 1-102 or assembly, an electronic strap assembly 1-104 connected to and extending from the display unit 1-102, and a band assembly 1-106 secured at either end to the electronic strap assembly 1-104. The electronic strap assembly 1-104 and the band 1-106 can be part of a retention assembly configured to wrap around a user's head to hold the display unit 1-102 against the face of the user.

In at least one example, the band assembly 1-106 can include a first band 1-116 configured to wrap around the rear side of a user's head and a second band 1-117 configured to extend over the top of a user's head. The second strap can extend between first and second electronic straps 1-105a, 1-105b of the electronic strap assembly 1-104 as shown. The strap assembly 1-104 and the band assembly 1-106 can be part of a securement mechanism extending rearward from the display unit 1-102 and configured to hold the display unit 1-102 against a face of a user.

In at least one example, the securement mechanism includes a first electronic strap 1-105a including a first proximal end 1-134 coupled to the display unit 1-102, for example a housing 1-150 of the display unit 1-102, and a first distal end 1-136 opposite the first proximal end 1-134. The securement mechanism can also include a second electronic strap 1-105b including a second proximal end 1-138 coupled to the housing 1-150 of the display unit 1-102 and a second distal end 1-140 opposite the second proximal end 1-138. The securement mechanism can also include the first band 1-116 including a first end 1-142 coupled to the first distal end 1-136 and a second end 1-144 coupled to the second distal end 1-140 and the second band 1-117 extending between the first electronic strap 1-105a and the second electronic strap 1-105b. The straps 1-105a-b and band 1-116 can be coupled via connection mechanisms or assemblies 1-114. In at least one example, the second band 1-117 includes a first end 1-146 coupled to the first electronic strap 1-105a between the first proximal end 1-134 and the first distal end 1-136 and a second end 1-148 coupled to the second electronic strap 1-105b between the second proximal end 1-138 and the second distal end 1-140.

In at least one example, the first and second electronic straps 1-105a-b include plastic, metal, or other structural materials forming the shape the substantially rigid straps 1-105a-b. In at least one example, the first and second bands 1-116, 1-117 are formed of elastic, flexible materials including woven textiles, rubbers, and the like. The first and second bands 1-116, 1-117 can be flexible to conform to the shape of the user' head when donning the HMD 1-100.

In at least one example, one or more of the first and second electronic straps 1-105a-b can define internal strap volumes and include one or more electronic components disposed in the internal strap volumes. In one example, as shown in FIG. 1B, the first electronic strap 1-105a can include an electronic component 1-112. In one example, the electronic component 1-112 can include a speaker. In one example, the electronic component 1-112 can include a computing component such as a processor.

In at least one example, the housing 1-150 defines a first, front-facing opening 1-152. The front-facing opening is labeled in dotted lines at 1-152 in FIG. 1B because the display assembly 1-108 is disposed to occlude the first opening 1-152 from view when the HMD 1-100 is assembled. The housing 1-150 can also define a rear-facing second opening 1-154. The housing 1-150 also defines an internal volume between the first and second openings 1-152, 1-154. In at least one example, the HMD 1-100 includes the display assembly 1-108, which can include a front cover and display screen (shown in other figures) disposed in or across the front opening 1-152 to occlude the front opening 1-152. In at least one example, the display screen of the display assembly 1-108, as well as the display assembly 1-108 in general, has a curvature configured to follow the curvature of a user's face. The display screen of the display assembly 1-108 can be curved as shown to compliment the user's facial features and general curvature from one side of the face to the other, for example from left to right and/or from top to bottom where the display unit 1-102 is pressed.

In at least one example, the housing 1-150 can define a first aperture 1-126 between the first and second openings 1-152, 1-154 and a second aperture 1-130 between the first and second openings 1-152, 1-154. The HMD 1-100 can also include a first button 1-128 disposed in the first aperture 1-126 and a second button 1-132 disposed in the second aperture 1-130. The first and second buttons 1-128, 1-132 can be depressible through the respective apertures 1-126, 1-130. In at least one example, the first button 1-126 and/or second button 1-132 can be twistable dials as well as depressible buttons. In at least one example, the first button 1-128 is a depressible and twistable dial button and the second button 1-132 is a depressible button.

FIG. 1C illustrates a rear, perspective view of the HMD 1-100. The HMD 1-100 can include a light seal 1-110 extending rearward from the housing 1-150 of the display assembly 1-108 around a perimeter of the housing 1-150 as shown. The light seal 1-110 can be configured to extend from the housing 1-150 to the user's face around the user's eyes to block external light from being visible. In one example, the HMD 1-100 can include first and second display assemblies 1-120a, 1-120b disposed at or in the rearward facing second opening 1-154 defined by the housing 1-150 and/or disposed in the internal volume of the housing 1-150 and configured to project light through the second opening 1-154. In at least one example, each display assembly 1-120a-b can include respective display screens 1-122a, 1-122b configured to project light in a rearward direction through the second opening 1-154 toward the user's eyes.

In at least one example, referring to both FIGS. 1B and 1C, the display assembly 1-108 can be a front-facing, forward display assembly including a display screen configured to project light in a first, forward direction and the rear facing display screens 1-122a-b can be configured to project light in a second, rearward direction opposite the first direction. As noted above, the light seal 1-110 can be configured to block light external to the HMD 1-100 from reaching the user's eyes, including light projected by the forward facing display screen of the display assembly 1-108 shown in the front perspective view of FIG. 1B. In at least one example, the HMD 1-100 can also include a curtain 1-124 occluding the second opening 1-154 between the housing 1-150 and the rear-facing display assemblies 1-120a-b. In at least one example, the curtain 1-124 can be elastic or at least partially elastic.

Any of the features, components, and/or parts, including the arrangements and configurations thereof shown in FIGS. 1B and 1C can be included, either alone or in any combination, in any of the other examples of devices, features, components, and parts shown in FIGS. 1D-1F and described herein. Likewise, any of the features, components, and/or parts, including the arrangements and configurations thereof shown and described with reference to FIGS. 1D-1F can be included, either alone or in any combination, in the example of the devices, features, components, and parts shown in FIGS. 1B and 1C.

FIG. 1D illustrates an exploded view of an example of an HMD 1-200 including various portions or parts thereof separated according to the modularity and selective coupling of those parts. For example, the HMD 1-200 can include a band 1-216 which can be selectively coupled to first and second electronic straps 1-205a, 1-205b. The first securement strap 1-205a can include a first electronic component 1-212a and the second securement strap 1-205b can include a second electronic component 1-212b. In at least one example, the first and second straps 1-205a-b can be removably coupled to the display unit 1-202.

In addition, the HMD 1-200 can include a light seal 1-210 configured to be removably coupled to the display unit 1-202. The HMD 1-200 can also include lenses 1-218 which can be removably coupled to the display unit 1-202, for example over first and second display assemblies including display screens. The lenses 1-218 can include customized prescription lenses configured for corrective vision. As noted, each part shown in the exploded view of FIG. 1D and described above can be removably coupled, attached, re-attached, and changed out to update parts or swap out parts for different users. For example, bands such as the band 1-216, light seals such as the light seal 1-210, lenses such as the lenses 1-218, and electronic straps such as the straps 1-205a-b can be swapped out depending on the user such that these parts are customized to fit and correspond to the individual user of the HMD 1-200.

Any of the features, components, and/or parts, including the arrangements and configurations thereof shown in FIG. 1D can be included, either alone or in any combination, in any of the other examples of devices, features, components, and parts shown in FIGS. 1B, 1C, and 1E-1F and described herein. Likewise, any of the features, components, and/or parts, including the arrangements and configurations thereof shown and described with reference to FIGS. 1B, 1C, and 1E-1F can be included, either alone or in any combination, in the example of the devices, features, components, and parts shown in FIG. 1D.

FIG. 1E illustrates an exploded view of an example of a display unit 1-306 of a HMD. The display unit 1-306 can include a front display assembly 1-308, a frame/housing assembly 1-350, and a curtain assembly 1-324. The display unit 1-306 can also include a sensor assembly 1-356, logic board assembly 1-358, and cooling assembly 1-360 disposed between the frame assembly 1-350 and the front display assembly 1-308. In at least one example, the display unit 1-306 can also include a rear-facing display assembly 1-320 including first and second rear-facing display screens 1-322a, 1-322b disposed between the frame 1-350 and the curtain assembly 1-324.

In at least one example, the display unit 1-306 can also include a motor assembly 1-362 configured as an adjustment mechanism for adjusting the positions of the display screens 1-322a-b of the display assembly 1-320 relative to the frame 1-350. In at least one example, the display assembly 1-320 is mechanically coupled to the motor assembly 1-362, with at least one motor for each display screen 1-322a-b, such that the motors can translate the display screens 1-322a-b to match an interpupillary distance of the user's eyes.

In at least one example, the display unit 1-306 can include a dial or button 1-328 depressible relative to the frame 1-350 and accessible to the user outside the frame 1-350. The button 1-328 can be electronically connected to the motor assembly 1-362 via a controller such that the button 1-328 can be manipulated by the user to cause the motors of the motor assembly 1-362 to adjust the positions of the display screens 1-322a-b.

Any of the features, components, and/or parts, including the arrangements and configurations thereof shown in FIG. 1E can be included, either alone or in any combination, in any of the other examples of devices, features, components, and parts shown in FIGS. 1B-1D and 1F and described herein. Likewise, any of the features, components, and/or parts, including the arrangements and configurations thereof shown and described with reference to FIGS. 1B-1D and 1F can be included, either alone or in any combination, in the example of the devices, features, components, and parts shown in FIG. 1E.

FIG. 1F illustrates an exploded view of another example of a display unit 1-406 of a HMD device similar to other HMD devices described herein. The display unit 1-406 can include a front display assembly 1-402, a sensor assembly 1-456, a logic board assembly 1-458, a cooling assembly 1-460, a frame assembly 1-450, a rear-facing display assembly 1-421, and a curtain assembly 1-424. The display unit 1-406 can also include a motor assembly 1-462 for adjusting the positions of first and second display sub-assemblies 1-420a, 1-420b of the rear-facing display assembly 1-421, including first and second respective display screens for interpupillary adjustments, as described above.

The various parts, systems, and assemblies shown in the exploded view of FIG. 1F are described in greater detail herein with reference to FIGS. 1B-1E as well as subsequent figures referenced in the present disclosure. The display unit 1-406 shown in FIG. 1F can be assembled and integrated with the securement mechanisms shown in FIGS. 1B-1E, including the electronic straps, bands, and other components including light seals, connection assemblies, and so forth.

Any of the features, components, and/or parts, including the arrangements and configurations thereof shown in FIG. 1F can be included, either alone or in any combination, in any of the other examples of devices, features, components, and parts shown in FIGS. 1B-1E and described herein. Likewise, any of the features, components, and/or parts, including the arrangements and configurations thereof shown and described with reference to FIGS. 1B-1E can be included, either alone or in any combination, in the example of the devices, features, components, and parts shown in FIG. 1F.

FIG. 1G illustrates a perspective, exploded view of a front cover assembly 3-100 of an HMD device described herein, for example the front cover assembly 3-1 of the HMD 3-100 shown in FIG. 1G or any other HMD device shown and described herein. The front cover assembly 3-100 shown in FIG. 1G can include a transparent or semi-transparent cover 3-102, shroud 3-104 (or “canopy”), adhesive layers 3-106, display assembly 3-108 including a lenticular lens panel or array 3-110, and a structural trim 3-112. The adhesive layer 3-106 can secure the shroud 3-104 and/or transparent cover 3-102 to the display assembly 3-108 and/or the trim 3-112. The trim 3-112 can secure the various components of the front cover assembly 3-100 to a frame or chassis of the HMD device.

In at least one example, as shown in FIG. 1G, the transparent cover 3-102, shroud 3-104, and display assembly 3-108, including the lenticular lens array 3-110, can be curved to accommodate the curvature of a user's face. The transparent cover 3-102 and the shroud 3-104 can be curved in two or three dimensions, e.g., vertically curved in the Z-direction in and out of the Z-X plane and horizontally curved in the X-direction in and out of the Z-X plane. In at least one example, the display assembly 3-108 can include the lenticular lens array 3-110 as well as a display panel having pixels configured to project light through the shroud 3-104 and the transparent cover 3-102. The display assembly 3-108 can be curved in at least one direction, for example the horizontal direction, to accommodate the curvature of a user's face from one side (e.g., left side) of the face to the other (e.g., right side). In at least one example, each layer or component of the display assembly 3-108, which will be shown in subsequent figures and described in more detail, but which can include the lenticular lens array 3-110 and a display layer, can be similarly or concentrically curved in the horizontal direction to accommodate the curvature of the user's face.

In at least one example, the shroud 3-104 can include a transparent or semi-transparent material through which the display assembly 3-108 projects light. In one example, the shroud 3-104 can include one or more opaque portions, for example opaque ink-printed portions or other opaque film portions on the rear surface of the shroud 3-104. The rear surface can be the surface of the shroud 3-104 facing the user's eyes when the HMD device is donned. In at least one example, opaque portions can be on the front surface of the shroud 3-104 opposite the rear surface. In at least one example, the opaque portion or portions of the shroud 3-104 can include perimeter portions visually hiding any components around an outside perimeter of the display screen of the display assembly 3-108. In this way, the opaque portions of the shroud hide any other components, including electronic components, structural components, and so forth, of the HMD device that would otherwise be visible through the transparent or semi-transparent cover 3-102 and/or shroud 3-104.

In at least one example, the shroud 3-104 can define one or more apertures transparent portions 3-120 through which sensors can send and receive signals. In one example, the portions 3-120 are apertures through which the sensors can extend or send and receive signals. In one example, the portions 3-120 are transparent portions, or portions more transparent than surrounding semi-transparent or opaque portions of the shroud, through which sensors can send and receive signals through the shroud and through the transparent cover 3-102. In one example, the sensors can include cameras, IR sensors, LUX sensors, or any other visual or non-visual environmental sensors of the HMD device.

Any of the features, components, and/or parts, including the arrangements and configurations thereof shown in FIG. 1G can be included, either alone or in any combination, in any of the other examples of devices, features, components, and parts described herein. Likewise, any of the features, components, and/or parts, including the arrangements and configurations thereof shown and described herein can be included, either alone or in any combination, in the example of the devices, features, components, and parts shown in FIG. 1G.

FIG. 1H illustrates an exploded view of an example of an HMD device 6-100. The HMD device 6-100 can include a sensor array or system 6-102 including one or more sensors, cameras, projectors, and so forth mounted to one or more components of the HMD 6-100. In at least one example, the sensor system 6-102 can include a bracket 1-338 on which one or more sensors of the sensor system 6-102 can be fixed/secured.

FIG. 1I illustrates a portion of an HMD device 6-100 including a front transparent cover 6-104 and a sensor system 6-102. The sensor system 6-102 can include a number of different sensors, emitters, receivers, including cameras, IR sensors, projectors, and so forth. The transparent cover 6-104 is illustrated in front of the sensor system 6-102 to illustrate relative positions of the various sensors and emitters as well as the orientation of each sensor/emitter of the system 6-102. As referenced herein, “sideways,” “side,” “lateral,” “horizontal,” and other similar terms refer to orientations or directions as indicated by the X-axis shown in FIG. 1J. Terms such as “vertical,” “up,” “down,” and similar terms refer to orientations or directions as indicated by the Z-axis shown in FIG. 1J. Terms such as “frontward,” “rearward,” “forward,” backward,” and similar terms refer to orientations or directions as indicated by the Y-axis shown in FIG. 1J.

In at least one example, the transparent cover 6-104 can define a front, external surface of the HMD device 6-100 and the sensor system 6-102, including the various sensors and components thereof, can be disposed behind the cover 6-104 in the Y-axis/direction. The cover 6-104 can be transparent or semi-transparent to allow light to pass through the cover 6-104, both light detected by the sensor system 6-102 and light emitted thereby.

As noted elsewhere herein, the HMD device 6-100 can include one or more controllers including processors for electrically coupling the various sensors and emitters of the sensor system 6-102 with one or more mother boards, processing units, and other electronic devices such as display screens and the like. In addition, as will be shown in more detail below with reference to other figures, the various sensors, emitters, and other components of the sensor system 6-102 can be coupled to various structural frame members, brackets, and so forth of the HMD device 6-100 not shown in FIG. 1I. FIG. 1I shows the components of the sensor system 6-102 unattached and un-coupled electrically from other components for the sake of illustrative clarity.

In at least one example, the device can include one or more controllers having processors configured to execute instructions stored on memory components electrically coupled to the processors. The instructions can include, or cause the processor to execute, one or more algorithms for self-correcting angles and positions of the various cameras described herein overtime with use as the initial positions, angles, or orientations of the cameras get bumped or deformed due to unintended drop events or other events.

In at least one example, the sensor system 6-102 can include one or more scene cameras 6-106. The system 6-102 can include two scene cameras 6-102 disposed on either side of the nasal bridge or arch of the HMD device 6-100 such that each of the two cameras 6-106 correspond generally in position with left and right eyes of the user behind the cover 6-103. In at least one example, the scene cameras 6-106 are oriented generally forward in the Y-direction to capture images in front of the user during use of the HMD 6-100. In at least one example, the scene cameras are color cameras and provide images and content for MR video pass through to the display screens facing the user's eyes when using the HMD device 6-100. The scene cameras 6-106 can also be used for environment and object reconstruction.

In at least one example, the sensor system 6-102 can include a first depth sensor 6-108 pointed generally forward in the Y-direction. In at least one example, the first depth sensor 6-108 can be used for environment and object reconstruction as well as user hand and body tracking. In at least one example, the sensor system 6-102 can include a second depth sensor 6-110 disposed centrally along the width (e.g., along the X-axis) of the HMD device 6-100. For example, the second depth sensor 6-110 can be disposed above the central nasal bridge or accommodating features over the nose of the user when donning the HMD 6-100. In at least one example, the second depth sensor 6-110 can be used for environment and object reconstruction as well as hand and body tracking. In at least one example, the second depth sensor can include a LIDAR sensor.

In at least one example, the sensor system 6-102 can include a depth projector 6-112 facing generally forward to project electromagnetic waves, for example in the form of a predetermined pattern of light dots, out into and within a field of view of the user and/or the scene cameras 6-106 or a field of view including and beyond the field of view of the user and/or scene cameras 6-106. In at least one example, the depth projector can project electromagnetic waves of light in the form of a dotted light pattern to be reflected off objects and back into the depth sensors noted above, including the depth sensors 6-108, 6-110. In at least one example, the depth projector 6-112 can be used for environment and object reconstruction as well as hand and body tracking.

In at least one example, the sensor system 6-102 can include downward facing cameras 6-114 with a field of view pointed generally downward relative to the HDM device 6-100 in the Z-axis. In at least one example, the downward cameras 6-114 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The downward cameras 6-114, for example, can be used to capture facial expressions and movements for the face of the user below the HMD device 6-100, including the cheeks, mouth, and chin.

In at least one example, the sensor system 6-102 can include jaw cameras 6-116. In at least one example, the jaw cameras 6-116 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The jaw cameras 6-116, for example, can be used to capture facial expressions and movements for the face of the user below the HMD device 6-100, including the user's jaw, cheeks, mouth, and chin. for hand and body tracking, headset tracking, and facial avatar

In at least one example, the sensor system 6-102 can include side cameras 6-118. The side cameras 6-118 can be oriented to capture side views left and right in the X-axis or direction relative to the HMD device 6-100. In at least one example, the side cameras 6-118 can be used for hand and body tracking, headset tracking, and facial avatar detection and re-creation.

In at least one example, the sensor system 6-102 can include a plurality of eye tracking and gaze tracking sensors for determining an identity, status, and gaze direction of a user's eyes during and/or before use. In at least one example, the eye/gaze tracking sensors can include nasal eye cameras 6-120 disposed on either side of the user's nose and adjacent the user's nose when donning the HMD device 6-100. The eye/gaze sensors can also include bottom eye cameras 6-122 disposed below respective user eyes for capturing images of the eyes for facial avatar detection and creation, gaze tracking, and iris identification functions.

In at least one example, the sensor system 6-102 can include infrared illuminators 6-124 pointed outward from the HMD device 6-100 to illuminate the external environment and any object therein with IR light for IR detection with one or more IR sensors of the sensor system 6-102. In at least one example, the sensor system 6-102 can include a flicker sensor 6-126 and an ambient light sensor 6-128. In at least one example, the flicker sensor 6-126 can detect overhead light refresh rates to avoid display flicker. In one example, the infrared illuminators 6-124 can include light emitting diodes and can be used especially for low light environments for illuminating user hands and other objects in low light for detection by infrared sensors of the sensor system 6-102.

In at least one example, multiple sensors, including the scene cameras 6-106, the downward cameras 6-114, the jaw cameras 6-116, the side cameras 6-118, the depth projector 6-112, and the depth sensors 6-108, 6-110 can be used in combination with an electrically coupled controller to combine depth data with camera data for hand tracking and for size determination for better hand tracking and object recognition and tracking functions of the HMD device 6-100. In at least one example, the downward cameras 6-114, jaw cameras 6-116, and side cameras 6-118 described above and shown in FIG. 1I can be wide angle cameras operable in the visible and infrared spectrums. In at least one example, these cameras 6-114, 6-116, 6-118 can operate only in black and white light detection to simplify image processing and gain sensitivity.

Any of the features, components, and/or parts, including the arrangements and configurations thereof shown in FIG. 1I can be included, either alone or in any combination, in any of the other examples of devices, features, components, and parts shown in FIGS. 1J-1L and described herein. Likewise, any of the features, components, and/or parts, including the arrangements and configurations thereof shown and described with reference to FIGS. 1J-1L can be included, either alone or in any combination, in the example of the devices, features, components, and parts shown in FIG. 1I.

FIG. 1J illustrates a lower perspective view of an example of an HMD 6-200 including a cover or shroud 6-204 secured to a frame 6-230. In at least one example, the sensors 6-203 of the sensor system 6-202 can be disposed around a perimeter of the HDM 6-200 such that the sensors 6-203 are outwardly disposed around a perimeter of a display region or area 6-232 so as not to obstruct a view of the displayed light. In at least one example, the sensors can be disposed behind the shroud 6-204 and aligned with transparent portions of the shroud allowing sensors and projectors to allow light back and forth through the shroud 6-204. In at least one example, opaque ink or other opaque material or films/layers can be disposed on the shroud 6-204 around the display area 6-232 to hide components of the HMD 6-200 outside the display area 6-232 other than the transparent portions defined by the opaque portions, through which the sensors and projectors send and receive light and electromagnetic signals during operation. In at least one example, the shroud 6-204 allows light to pass therethrough from the display (e.g., within the display region 6-232) but not radially outward from the display region around the perimeter of the display and shroud 6-204.

In some examples, the shroud 6-204 includes a transparent portion 6-205 and an opaque portion 6-207, as described above and elsewhere herein. In at least one example, the opaque portion 6-207 of the shroud 6-204 can define one or more transparent regions 6-209 through which the sensors 6-203 of the sensor system 6-202 can send and receive signals. In the illustrated example, the sensors 6-203 of the sensor system 6-202 sending and receiving signals through the shroud 6-204, or more specifically through the transparent regions 6-209 of the (or defined by) the opaque portion 6-207 of the shroud 6-204 can include the same or similar sensors as those shown in the example of FIG. 1I, for example depth sensors 6-108 and 6-110, depth projector 6-112, first and second scene cameras 6-106, first and second downward cameras 6-114, first and second side cameras 6-118, and first and second infrared illuminators 6-124. These sensors are also shown in the examples of FIGS. 1K and 1L. Other sensors, sensor types, number of sensors, and relative positions thereof can be included in one or more other examples of HMDs.

Any of the features, components, and/or parts, including the arrangements and configurations thereof shown in FIG. 1J can be included, either alone or in any combination, in any of the other examples of devices, features, components, and parts shown in FIGS. 1I and 1K-1L and described herein. Likewise, any of the features, components, and/or parts, including the arrangements and configurations thereof shown and described with reference to FIGS. 11 and 1K-1L can be included, either alone or in any combination, in the example of the devices, features, components, and parts shown in FIG. 1J.

FIG. 1K illustrates a front view of a portion of an example of an HMD device 6-300 including a display 6-334, brackets 6-336, 6-338, and frame or housing 6-330. The example shown in FIG. 1K does not include a front cover or shroud in order to illustrate the brackets 6-336, 6-338. For example, the shroud 6-204 shown in FIG. 1J includes the opaque portion 6-207 that would visually cover/block a view of anything outside (e.g., radially/peripherally outside) the display/display region 6-334, including the sensors 6-303 and bracket 6-338.

In at least one example, the various sensors of the sensor system 6-302 are coupled to the brackets 6-336, 6-338. In at least one example, the scene cameras 6-306 include tight tolerances of angles relative to one another. For example, the tolerance of mounting angles between the two scene cameras 6-306 can be 0.5 degrees or less, for example 0.3 degrees or less. In order to achieve and maintain such a tight tolerance, in one example, the scene cameras 6-306 can be mounted to the bracket 6-338 and not the shroud. The bracket can include cantilevered arms on which the scene cameras 6-306 and other sensors of the sensor system 6-302 can be mounted to remain un-deformed in position and orientation in the case of a drop event by a user resulting in any deformation of the other bracket 6-226, housing 6-330, and/or shroud.

Any of the features, components, and/or parts, including the arrangements and configurations thereof shown in FIG. 1K can be included, either alone or in any combination, in any of the other examples of devices, features, components, and parts shown in FIGS. 11-1J and 1L and described herein. Likewise, any of the features, components, and/or parts, including the arrangements and configurations thereof shown and described with reference to FIGS. 11-1J and 1L can be included, either alone or in any combination, in the example of the devices, features, components, and parts shown in FIG. 1K.

FIG. 1L illustrates a bottom view of an example of an HMD 6-400 including a front display/cover assembly 6-404 and a sensor system 6-402. The sensor system 6-402 can be similar to other sensor systems described above and elsewhere herein, including in reference to FIGS. 1I-1K. In at least one example, the jaw cameras 6-416 can be facing downward to capture images of the user's lower facial features. In one example, the jaw cameras 6-416 can be coupled directly to the frame or housing 6-430 or one or more internal brackets directly coupled to the frame or housing 6-430 shown. The frame or housing 6-430 can include one or more apertures/openings 6-415 through which the jaw cameras 6-416 can send and receive signals.

Any of the features, components, and/or parts, including the arrangements and configurations thereof shown in FIG. 1L can be included, either alone or in any combination, in any of the other examples of devices, features, components, and parts shown in FIGS. 1I-1K and described herein. Likewise, any of the features, components, and/or parts, including the arrangements and configurations thereof shown and described with reference to FIGS. 1I-1K can be included, either alone or in any combination, in the example of the devices, features, components, and parts shown in FIG. 1L.

FIG. 1M illustrates a rear perspective view of an inter-pupillary distance (IPD) adjustment system 11.1.1-102 including first and second optical modules 11.1.1-104a-b slidably engaging/coupled to respective guide-rods 11.1.1-108a-b and motors 11.1.1-110a-b of left and right adjustment subsystems 11.1.1-106a-b. The IPD adjustment system 11.1.1-102 can be coupled to a bracket 11.1.1-112 and include a button 11.1.1-114 in electrical communication with the motors 11.1.1-110a-b. In at least one example, the button 11.1.1-114 can electrically communicate with the first and second motors 11.1.1-110a-b via a processor or other circuitry components to cause the first and second motors 11.1.1-110a-b to activate and cause the first and second optical modules 11.1.1-104a-b, respectively, to change position relative to one another.

In at least one example, the first and second optical modules 11.1.1-104a-b can include respective display screens configured to project light toward the user's eyes when donning the HMD 11.1.1-100. In at least one example, the user can manipulate (e.g., depress and/or rotate) the button 11.1.1-114 to activate a positional adjustment of the optical modules 11.1.1-104a-b to match the inter-pupillary distance of the user's eyes. The optical modules 11.1.1-104a-b can also include one or more cameras or other sensors/sensor systems for imaging and measuring the IPD of the user such that the optical modules 11.1.1-104a-b can be adjusted to match the IPD.

In one example, the user can manipulate the button 11.1.1-114 to cause an automatic positional adjustment of the first and second optical modules 11.1.1-104a-b. In one example, the user can manipulate the button 11.1.1-114 to cause a manual adjustment such that the optical modules 11.1.1-104a-b move further or closer away, for example when the user rotates the button 11.1.1-114 one way or the other, until the user visually matches her/his own IPD. In one example, the manual adjustment is electronically communicated via one or more circuits and power for the movements of the optical modules 11.1.1-104a-b via the motors 11.1.1-110a-b is provided by an electrical power source. In one example, the adjustment and movement of the optical modules 11.1.1-104a-b via a manipulation of the button 11.1.1-114 is mechanically actuated via the movement of the button 11.1.1-114.

Any of the features, components, and/or parts, including the arrangements and configurations thereof shown in FIG. 1M can be included, either alone or in any combination, in any of the other examples of devices, features, components, and parts shown in any other figures shown and described herein. Likewise, any of the features, components, and/or parts, including the arrangements and configurations thereof shown and described with reference to any other figure shown and described herein, either alone or in any combination, in the example of the devices, features, components, and parts shown in FIG. 1M.

FIG. 1N illustrates a front perspective view of a portion of an HMD 11.1.2-100, including an outer structural frame 11.1.2-102 and an inner or intermediate structural frame 11.1.2-104 defining first and second apertures 11.1.2-106a, 11.1.2-106b. The apertures 11.1.2-106a-b are shown in dotted lines in FIG. 1N because a view of the apertures 11.1.2-106a-b can be blocked by one or more other components of the HMD 11.1.2-100 coupled to the inner frame 11.1.2-104 and/or the outer frame 11.1.2-102, as shown. In at least one example, the HMD 11.1.2-100 can include a first mounting bracket 11.1.2-108 coupled to the inner frame 11.1.2-104. In at least one example, the mounting bracket 11.1.2-108 is coupled to the inner frame 11.1.2-104 between the first and second apertures 11.1.2-106a-b.

The mounting bracket 11.1.2-108 can include a middle or central portion 11.1.2-109 coupled to the inner frame 11.1.2-104. In some examples, the middle or central portion 11.1.2-109 may not be the geometric middle or center of the bracket 11.1.2-108. Rather, the middle/central portion 11.1.2-109 can be disposed between first and second cantilevered extension arms extending away from the middle portion 11.1.2-109. In at least one example, the mounting bracket 108 includes a first cantilever arm 11.1.2-112 and a second cantilever arm 11.1.2-114 extending away from the middle portion 11.1.2-109 of the mount bracket 11.1.2-108 coupled to the inner frame 11.1.2-104.

As shown in FIG. 1N, the outer frame 11.1.2-102 can define a curved geometry on a lower side thereof to accommodate a user's nose when the user dons the HMD 11.1.2-100. The curved geometry can be referred to as a nose bridge 11.1.2-111 and be centrally located on a lower side of the HMD 11.1.2-100 as shown. In at least one example, the mounting bracket 11.1.2-108 can be connected to the inner frame 11.1.2-104 between the apertures 11.1.2-106a-b such that the cantilevered arms 11.1.2-112, 11.1.2-114 extend downward and laterally outward away from the middle portion 11.1.2-109 to compliment the nose bridge 11.1.2-111 geometry of the outer frame 11.1.2-102. In this way, the mounting bracket 11.1.2-108 is configured to accommodate the user's nose as noted above. The nose bridge 11.1.2-111 geometry accommodates the nose in that the nose bridge 11.1.2-111 provides a curvature that curves with, above, over, and around the user's nose for comfort and fit.

The first cantilever arm 11.1.2-112 can extend away from the middle portion 11.1.2-109 of the mounting bracket 11.1.2-108 in a first direction and the second cantilever arm 11.1.2-114 can extend away from the middle portion 11.1.2-109 of the mounting bracket 11.1.2-10 in a second direction opposite the first direction. The first and second cantilever arms 11.1.2-112, 11.1.2-114 are referred to as “cantilevered” or “cantilever” arms because each arm 11.1.2-112, 11.1.2-114, includes a distal free end 11.1.2-116, 11.1.2-118, respectively, which are free of affixation from the inner and outer frames 11.1.2-102, 11.1.2-104. In this way, the arms 11.1.2-112, 11.1.2-114 are cantilevered from the middle portion 11.1.2-109, which can be connected to the inner frame 11.1.2-104, with distal ends 11.1.2-102, 11.1.2-104 unattached.

In at least one example, the HMD 11.1.2-100 can include one or more components coupled to the mounting bracket 11.1.2-108. In one example, the components include a plurality of sensors 11.1.2-110a-f. Each sensor of the plurality of sensors 11.1.2-110a-f can include various types of sensors, including cameras, IR sensors, and so forth. In some examples, one or more of the sensors 11.1.2-110a-f can be used for object recognition in three-dimensional space such that it is important to maintain a precise relative position of two or more of the plurality of sensors 11.1.2-110a-f. The cantilevered nature of the mounting bracket 11.1.2-108 can protect the sensors 11.1.2-110a-f from damage and altered positioning in the case of accidental drops by the user. Because the sensors 11.1.2-110a-f are cantilevered on the arms 11.1.2-112, 11.1.2-114 of the mounting bracket 11.1.2-108, stresses and deformations of the inner and/or outer frames 11.1.2-104, 11.1.2-102 are not transferred to the cantilevered arms 11.1.2-112, 11.1.2-114 and thus do not affect the relative positioning of the sensors 11.1.2-110a-f coupled/mounted to the mounting bracket 11.1.2-108.

Any of the features, components, and/or parts, including the arrangements and configurations thereof shown in FIG. 1N can be included, either alone or in any combination, in any of the other examples of devices, features, components, and described herein. Likewise, any of the features, components, and/or parts, including the arrangements and configurations thereof shown and described herein can be included, either alone or in any combination, in the example of the devices, features, components, and parts shown in FIG. 1N.

FIG. 1O illustrates an example of an optical module 11.3.2-100 for use in an electronic device such as an HMD, including HDM devices described herein. As shown in one or more other examples described herein, the optical module 11.3.2-100 can be one of two optical modules within an HMD, with each optical module aligned to project light toward a user's eye. In this way, a first optical module can project light via a display screen toward a user's first eye and a second optical module of the same device can project light via another display screen toward the user's second eye.

In at least one example, the optical module 11.3.2-100 can include an optical frame or housing 11.3.2-102, which can also be referred to as a barrel or optical module barrel. The optical module 11.3.2-100 can also include a display 11.3.2-104, including a display screen or multiple display screens, coupled to the housing 11.3.2-102. The display 11.3.2-104 can be coupled to the housing 11.3.2-102 such that the display 11.3.2-104 is configured to project light toward the eye of a user when the HMD of which the display module 11.3.2-100 is a part is donned during use. In at least one example, the housing 11.3.2-102 can surround the display 11.3.2-104 and provide connection features for coupling other components of optical modules described herein.

In one example, the optical module 11.3.2-100 can include one or more cameras 11.3.2-106 coupled to the housing 11.3.2-102. The camera 11.3.2-106 can be positioned relative to the display 11.3.2-104 and housing 11.3.2-102 such that the camera 11.3.2-106 is configured to capture one or more images of the user's eye during use. In at least one example, the optical module 11.3.2-100 can also include a light strip 11.3.2-108 surrounding the display 11.3.2-104. In one example, the light strip 11.3.2-108 is disposed between the display 11.3.2-104 and the camera 11.3.2-106. The light strip 11.3.2-108 can include a plurality of lights 11.3.2-110. The plurality of lights can include one or more light emitting diodes (LEDs) or other lights configured to project light toward the user's eye when the HMD is donned. The individual lights 11.3.2-110 of the light strip 11.3.2-108 can be spaced about the strip 11.3.2-108 and thus spaced about the display 11.3.2-104 uniformly or non-uniformly at various locations on the strip 11.3.2-108 and around the display 11.3.2-104.

In at least one example, the housing 11.3.2-102 defines a viewing opening 11.3.2-101 through which the user can view the display 11.3.2-104 when the HMD device is donned. In at least one example, the LEDs are configured and arranged to emit light through the viewing opening 11.3.2-101 and onto the user's eye. In one example, the camera 11.3.2-106 is configured to capture one or more images of the user's eye through the viewing opening 11.3.2-101.

As noted above, each of the components and features of the optical module 11.3.2-100 shown in FIG. 1O can be replicated in another (e.g., second) optical module disposed with the HMD to interact (e.g., project light and capture images) of another eye of the user.

Any of the features, components, and/or parts, including the arrangements and configurations thereof shown in FIG. 1O can be included, either alone or in any combination, in any of the other examples of devices, features, components, and parts shown in FIGS. 1P or otherwise described herein. Likewise, any of the features, components, and/or parts, including the arrangements and configurations thereof shown and described with reference to FIGS. 1P or otherwise described herein can be included, either alone or in any combination, in the example of the devices, features, components, and parts shown in FIG. 1O.

FIG. 1P illustrates a cross-sectional view of an example of an optical module 11.3.2-200 including a housing 11.3.2-202, display assembly 11.3.2-204 coupled to the housing 11.3.2-202, and a lens 11.3.2-216 coupled to the housing 11.3.2-202. In at least one example, the housing 11.3.2-202 defines a first aperture or channel 11.3.2-212 and a second aperture or channel 11.3.2-214. The channels 11.3.2-212, 11.3.2-214 can be configured to slidably engage respective rails or guide rods of an HMD device to allow the optical module 11.3.2-200 to adjust in position relative to the user's eyes for match the user's interpapillary distance (IPD). The housing 11.3.2-202 can slidably engage the guide rods to secure the optical module 11.3.2-200 in place within the HMD.

In at least one example, the optical module 11.3.2-200 can also include a lens 11.3.2-216 coupled to the housing 11.3.2-202 and disposed between the display assembly 11.3.2-204 and the user's eyes when the HMD is donned. The lens 11.3.2-216 can be configured to direct light from the display assembly 11.3.2-204 to the user's eye. In at least one example, the lens 11.3.2-216 can be a part of a lens assembly including a corrective lens removably attached to the optical module 11.3.2-200. In at least one example, the lens 11.3.2-216 is disposed over the light strip 11.3.2-208 and the one or more eye-tracking cameras 11.3.2-206 such that the camera 11.3.2-206 is configured to capture images of the user's eye through the lens 11.3.2-216 and the light strip 11.3.2-208 includes lights configured to project light through the lens 11.3.2-216 to the users' eye during use.

Any of the features, components, and/or parts, including the arrangements and configurations thereof shown in FIG. 1P can be included, either alone or in any combination, in any of the other examples of devices, features, components, and parts and described herein. Likewise, any of the features, components, and/or parts, including the arrangements and configurations thereof shown and described herein can be included, either alone or in any combination, in the example of the devices, features, components, and parts shown in FIG. 1P.

FIG. 2 is a block diagram of an example of the controller 110 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments, the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some embodiments, the one or more communication buses 204 include circuitry that interconnects and controls communications between system components. In some embodiments, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some embodiments, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some embodiments, the memory 220 or the non-transitory computer readable storage medium of the memory 220 stores the following programs, modules and data structures, or a subset thereof including an optional operating system 230 and a XR experience module 240.

The operating system 230 includes instructions for handling various basic system services and for performing hardware dependent tasks. In some embodiments, the XR experience module 240 is configured to manage and coordinate one or more XR experiences for one or more users (e.g., a single XR experience for one or more users, or multiple XR experiences for respective groups of one or more users). To that end, in various embodiments, the XR experience module 240 includes a data obtaining unit 241, a tracking unit 242, a coordination unit 246, and a data transmitting unit 248.

In some embodiments, the data obtaining unit 241 is configured to obtain data (e.g., presentation data, interaction data, sensor data, location data, etc.) from at least the display generation component 120 of FIG. 1A, and optionally one or more of the input devices 125, output devices 155, sensors 190, and/or peripheral devices 195. To that end, in various embodiments, the data obtaining unit 241 includes instructions and/or logic therefor, and heuristics and metadata therefor.

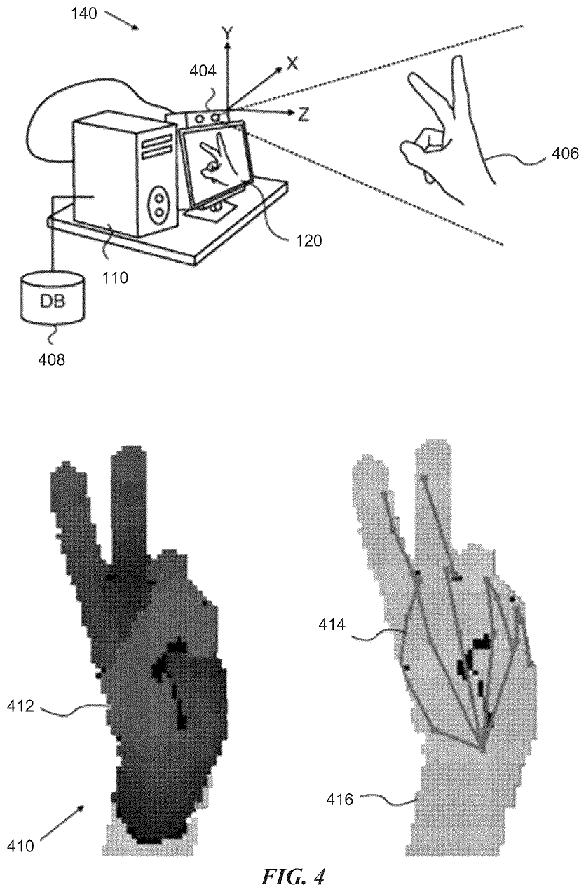

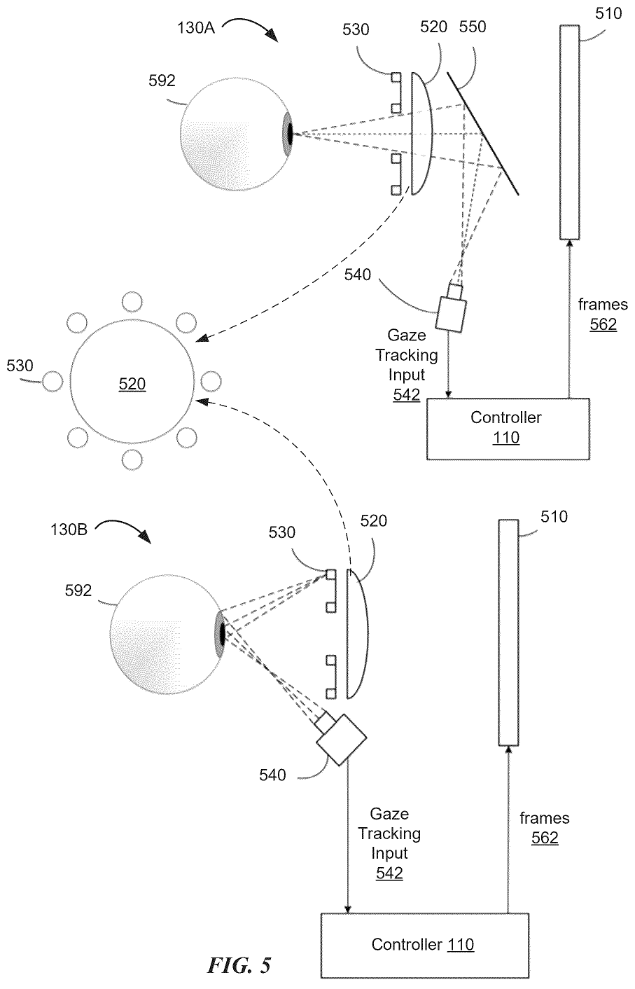

In some embodiments, the tracking unit 242 is configured to map the scene 105 and to track the position/location of at least the display generation component 120 with respect to the scene 105 of FIG. 1A, and optionally, to one or more of the input devices 125, output devices 155, sensors 190, and/or peripheral devices 195. To that end, in various embodiments, the tracking unit 242 includes instructions and/or logic therefor, and heuristics and metadata therefor. In some embodiments, the tracking unit 242 includes hand tracking unit 244 and/or eye tracking unit 243. In some embodiments, the hand tracking unit 244 is configured to track the position/location of one or more portions of the user's hands, and/or motions of one or more portions of the user's hands with respect to the scene 105 of FIG. 1A, relative to the display generation component 120, and/or relative to a coordinate system defined relative to the user's hand. The hand tracking unit 244 is described in greater detail below with respect to FIG. 4. In some embodiments, the eye tracking unit 243 is configured to track the position and movement of the user's gaze (or more broadly, the user's eyes, face, or head) with respect to the scene 105 (e.g., with respect to the physical environment and/or to the user (e.g., the user's hand)) or with respect to the XR content displayed via the display generation component 120. The eye tracking unit 243 is described in greater detail below with respect to FIG. 5.

In some embodiments, the coordination unit 246 is configured to manage and coordinate the XR experience presented to the user by the display generation component 120, and optionally, by one or more of the output devices 155 and/or peripheral devices 195. To that end, in various embodiments, the coordination unit 246 includes instructions and/or logic therefor, and heuristics and metadata therefor.

In some embodiments, the data transmitting unit 248 is configured to transmit data (e.g., presentation data, location data, etc.) to at least the display generation component 120, and optionally, to one or more of the input devices 125, output devices 155, sensors 190, and/or peripheral devices 195. To that end, in various embodiments, the data transmitting unit 248 includes instructions and/or logic therefor, and heuristics and metadata therefor.

Although the data obtaining unit 241, the tracking unit 242 (e.g., including the eye tracking unit 243 and the hand tracking unit 244), the coordination unit 246, and the data transmitting unit 248 are shown as residing on a single device (e.g., the controller 110), it should be understood that in other embodiments, any combination of the data obtaining unit 241, the tracking unit 242 (e.g., including the eye tracking unit 243 and the hand tracking unit 244), the coordination unit 246, and the data transmitting unit 248 may be located in separate computing devices.

Moreover, FIG. 2 is intended more as functional description of the various features that may be present in a particular implementation as opposed to a structural schematic of the embodiments described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 3A is a block diagram of an example of the display generation component 120 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the display generation component 120 (e.g., HMD) includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior- and/or exterior-facing image sensors 314, a memory 320, and one or more communication buses 304 for interconnecting these and various other components.

In some embodiments, the one or more communication buses 304 include circuitry that interconnects and controls communications between system components. In some embodiments, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some embodiments, the one or more XR displays 312 are configured to provide the XR experience to the user. In some embodiments, the one or more XR displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some embodiments, the one or more XR displays 312 correspond to diffractive, reflective, polarized, holographic, etc. waveguide displays. For example, the display generation component 120 (e.g., HMD) includes a single XR display. In another example, the display generation component 120 includes a XR display for each eye of the user. In some embodiments, the one or more XR displays 312 are capable of presenting MR and VR content. In some embodiments, the one or more XR displays 312 are capable of presenting MR or VR content.

In some embodiments, the one or more image sensors 314 are configured to obtain image data that corresponds to at least a portion of the face of the user that includes the eyes of the user (and may be referred to as an eye-tracking camera). In some embodiments, the one or more image sensors 314 are configured to obtain image data that corresponds to at least a portion of the user's hand(s) and optionally arm(s) of the user (and may be referred to as a hand-tracking camera). In some embodiments, the one or more image sensors 314 are configured to be forward-facing so as to obtain image data that corresponds to the scene as would be viewed by the user if the display generation component 120 (e.g., HMD) was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some embodiments, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some embodiments, the memory 320 or the non-transitory computer readable storage medium of the memory 320 stores the following programs, modules and data structures, or a subset thereof including an optional operating system 330 and a XR presentation module 340.

The operating system 330 includes instructions for handling various basic system services and for performing hardware dependent tasks. In some embodiments, the XR presentation module 340 is configured to present XR content to the user via the one or more XR displays 312. To that end, in various embodiments, the XR presentation module 340 includes a data obtaining unit 342, a XR presenting unit 344, a XR map generating unit 346, and a data transmitting unit 348.

In some embodiments, the data obtaining unit 342 is configured to obtain data (e.g., presentation data, interaction data, sensor data, location data, etc.) from at least the controller 110 of FIG. 1A. To that end, in various embodiments, the data obtaining unit 342 includes instructions and/or logic therefor, and heuristics and metadata therefor.

In some embodiments, the XR presenting unit 344 is configured to present XR content via the one or more XR displays 312. To that end, in various embodiments, the XR presenting unit 344 includes instructions and/or logic therefor, and heuristics and metadata therefor.

In some embodiments, the XR map generating unit 346 is configured to generate a XR map (e.g., a 3D map of the mixed reality scene or a map of the physical environment into which computer-generated objects can be placed to generate the extended reality) based on media content data. To that end, in various embodiments, the XR map generating unit 346 includes instructions and/or logic therefor, and heuristics and metadata therefor.

In some embodiments, the data transmitting unit 348 is configured to transmit data (e.g., presentation data, location data, etc.) to at least the controller 110, and optionally one or more of the input devices 125, output devices 155, sensors 190, and/or peripheral devices 195. To that end, in various embodiments, the data transmitting unit 348 includes instructions and/or logic therefor, and heuristics and metadata therefor.

Although the data obtaining unit 342, the XR presenting unit 344, the XR map generating unit 346, and the data transmitting unit 348 are shown as residing on a single device (e.g., the display generation component 120 of FIG. 1A), it should be understood that in other embodiments, any combination of the data obtaining unit 342, the XR presenting unit 344, the XR map generating unit 346, and the data transmitting unit 348 may be located in separate computing devices.

Moreover, FIG. 3A is intended more as a functional description of the various features that could be present in a particular implementation as opposed to a structural schematic of the embodiments described herein. As recognized by those of ordinary skill in the art, items shown separately could be combined and some items could be separated. For example, some functional modules shown separately in FIG. 3A could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform method 800 (FIG. 8), method 1000 (FIG. 10), method 1200 (FIG. 12), method 1400 (FIG. 14), method 1600 (FIG. 16), method 1800 (FIG. 18), method 2000 (FIG. 20), and/or method 2200 (FIG. 2200) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application. FIG. 4 is a schematic, pictorial illustration of an example embodiment of the hand tracking device 140. In some embodiments, hand tracking device 140 (FIG. 1A) is controlled by hand tracking unit 244 (FIG. 2) to track the position/location of one or more portions of the user's hands, and/or motions of one or more portions of the user's hands with respect to the scene 105 of FIG. 1A (e.g., with respect to a portion of the physical environment surrounding the user, with respect to the display generation component 120, or with respect to a portion of the user (e.g., the user's face, eyes, or head), and/or relative to a coordinate system defined relative to the user's hand. In some embodiments, the hand tracking device 140 is part of the display generation component 120 (e.g., embedded in or attached to a head-mounted device). In some embodiments, the hand tracking device 140 is separate from the display generation component 120 (e.g., located in separate housings or attached to separate physical support structures).

In some embodiments, the hand tracking device 140 includes image sensors 404 (e.g., one or more IR cameras, 3D cameras, depth cameras, and/or color cameras, etc.) that capture three-dimensional scene information that includes at least a hand 406 of a human user. The image sensors 404 capture the hand images with sufficient resolution to enable the fingers and their respective positions to be distinguished. The image sensors 404 typically capture images of other parts of the user's body, as well, or possibly all of the body, and may have either zoom capabilities or a dedicated sensor with enhanced magnification to capture images of the hand with the desired resolution. In some embodiments, the image sensors 404 also capture 2D color video images of the hand 406 and other elements of the scene. In some embodiments, the image sensors 404 are used in conjunction with other image sensors to capture the physical environment of the scene 105, or serve as the image sensors that capture the physical environments of the scene 105. In some embodiments, the image sensors 404 are positioned relative to the user or the user's environment in a way that a field of view of the image sensors or a portion thereof is used to define an interaction space in which hand movement captured by the image sensors are treated as inputs to the controller 110.

In some embodiments, the image sensors 404 output a sequence of frames containing 3D map data (and possibly color image data, as well) to the controller 110, which extracts high-level information from the map data. This high-level information is typically provided via an Application Program Interface (API) to an application running on the controller, which drives the display generation component 120 accordingly. For example, the user may interact with software running on the controller 110 by moving his hand 406 and changing his hand posture.

In some embodiments, the image sensors 404 project a pattern of spots onto a scene containing the hand 406 and capture an image of the projected pattern. In some embodiments, the controller 110 computes the 3D coordinates of points in the scene (including points on the surface of the user's hand) by triangulation, based on transverse shifts of the spots in the pattern. This approach is advantageous in that it does not require the user to hold or wear any sort of beacon, sensor, or other marker. It gives the depth coordinates of points in the scene relative to a predetermined reference plane, at a certain distance from the image sensors 404. In the present disclosure, the image sensors 404 are assumed to define an orthogonal set of x, y, z axes, so that depth coordinates of points in the scene correspond to z components measured by the image sensors. Alternatively, the image sensors 404 (e.g., a hand tracking device) may use other methods of 3D mapping, such as stereoscopic imaging or time-of-flight measurements, based on single or multiple cameras or other types of sensors.

In some embodiments, the hand tracking device 140 captures and processes a temporal sequence of depth maps containing the user's hand, while the user moves his hand (e.g., whole hand or one or more fingers). Software running on a processor in the image sensors 404 and/or the controller 110 processes the 3D map data to extract patch descriptors of the hand in these depth maps. The software matches these descriptors to patch descriptors stored in a database 408, based on a prior learning process, in order to estimate the pose of the hand in each frame. The pose typically includes 3D locations of the user's hand joints and finger tips.

The software may also analyze the trajectory of the hands and/or fingers over multiple frames in the sequence in order to identify gestures. The pose estimation functions described herein may be interleaved with motion tracking functions, so that patch-based pose estimation is performed only once in every two (or more) frames, while tracking is used to find changes in the pose that occur over the remaining frames. The pose, motion, and gesture information are provided via the above-mentioned API to an application program running on the controller 110. This program may, for example, move and modify images presented on the display generation component 120, or perform other functions, in response to the pose and/or gesture information.

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) or part(s) of the user's hand) for interacting with an XR environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture (e.g., an air drag gesture or an air swipe gesture) includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand. In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture performed using a first hand of the user (e.g., a pinch input, a long pinch input, or a pinch and drag input), and, in conjunction with performing the pinch input using the first hand, performing a second pinch input using the other hand (e.g., the second hand of the user's two hands).

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, attention of a user is determined to be directed to a portion of the three-dimensional environment based on detection of gaze directed to the portion of the three-dimensional environment (optionally, without requiring other conditions). In some embodiments, attention of a user is determined to be directed to a portion of the three-dimensional environment based on detection of gaze directed to the portion of the three-dimensional environment with one or more additional conditions such as requiring that gaze is directed to the portion of the three-dimensional environment for at least a threshold duration (e.g., a dwell duration) and/or requiring that the gaze is directed to the portion of the three-dimensional environment while the viewpoint of the user is within a distance threshold from the portion of the three-dimensional environment in order for the device to determine that attention of the user is directed to the portion of the three-dimensional environment, where if one of the additional conditions is not met, the device determines that attention is not directed to the portion of the three-dimensional environment toward which gaze is directed (e.g., until the one or more additional conditions are met).

In some embodiments, the detection of a ready state configuration of a user or a portion of a user is detected by the computer system. Detection of a ready state configuration of a hand is used by a computer system as an indication that the user is likely preparing to interact with the computer system using one or more air gesture inputs performed by the hand (e.g., a pinch, tap, pinch and drag, double pinch, long pinch, or other air gesture described herein). For example, the ready state of the hand is determined based on whether the hand has a predetermined hand shape (e.g., a pre-pinch shape with a thumb and one or more fingers extended and spaced apart ready to make a pinch or grab gesture or a pre-tap with one or more fingers extended and palm facing away from the user), based on whether the hand is in a predetermined position relative to a viewpoint of the user (e.g., below the user's head and above the user's waist and extended out from the body by at least 15, 20, 25, 30, or 50 cm), and/or based on whether the hand has moved in a particular manner (e.g., moved toward a region in front of the user above the user's waist and below the user's head or moved away from the user's body or leg). In some embodiments, the ready state is used to determine whether interactive elements of the user interface respond to attention (e.g., gaze) inputs.

In scenarios where inputs are described with reference to air gestures, it should be understood that similar gestures could be detected using a hardware input device that is attached to or held by one or more hands of a user, where the position of the hardware input device in space can be tracked using optical tracking, one or more accelerometers, one or more gyroscopes, one or more magnetometers, and/or one or more inertial measurement units and the position and/or movement of the hardware input device is used in place of the position and/or movement of the one or more hands in the corresponding air gesture(s). In scenarios where inputs are described with reference to air gestures, it should be understood that similar gestures could be detected using a hardware input device that is attached to or held by one or more hands of a user. User inputs can be detected with controls contained in the hardware input device such as one or more touch-sensitive input elements, one or more pressure-sensitive input elements, one or more buttons, one or more knobs, one or more dials, one or more joysticks, one or more hand or finger coverings that can detect a position or change in position of portions of a hand and/or fingers relative to each other, relative to the user's body, and/or relative to a physical environment of the user, and/or other hardware input device controls, where the user inputs with the controls contained in the hardware input device are used in place of hand and/or finger gestures such as air taps or air pinches in the corresponding air gesture(s). For example, a selection input that is described as being performed with an air tap or air pinch input could be alternatively detected with a button press, a tap on a touch-sensitive surface, a press on a pressure-sensitive surface, or other hardware input. As another example, a movement input that is described as being performed with an air pinch and drag (e.g., an air drag gesture or an air swipe gesture) could be alternatively detected based on an interaction with the hardware input control such as a button press and hold, a touch on a touch-sensitive surface, a press on a pressure-sensitive surface, or other hardware input that is followed by movement of the hardware input device (e.g., along with the hand with which the hardware input device is associated) through space. Similarly, a two-handed input that includes movement of the hands relative to each other could be performed with one air gesture and one hardware input device in the hand that is not performing the air gesture, two hardware input devices held in different hands, or two air gestures performed by different hands using various combinations of air gestures and/or the inputs detected by one or more hardware input devices that are described above.

In some embodiments, the software may be downloaded to the controller 110 in electronic form, over a network, for example, or it may alternatively be provided on tangible, non-transitory media, such as optical, magnetic, or electronic memory media. In some embodiments, the database 408 is likewise stored in a memory associated with the controller 110. Alternatively or additionally, some or all of the described functions of the computer may be implemented in dedicated hardware, such as a custom or semi-custom integrated circuit or a programmable digital signal processor (DSP). Although the controller 110 is shown in FIG. 4, by way of example, as a separate unit from the image sensors 404, some or all of the processing functions of the controller may be performed by a suitable microprocessor and software or by dedicated circuitry within the housing of the image sensors 404 (e.g., a hand tracking device) or otherwise associated with the image sensors 404. In some embodiments, at least some of these processing functions may be carried out by a suitable processor that is integrated with the display generation component 120 (e.g., in a television set, a handheld device, or head-mounted device, for example) or with any other suitable computerized device, such as a game console or media player. The sensing functions of image sensors 404 may likewise be integrated into the computer or other computerized apparatus that is to be controlled by the sensor output.

FIG. 4 further includes a schematic representation of a depth map 410 captured by the image sensors 404, in accordance with some embodiments. The depth map, as explained above, comprises a matrix of pixels having respective depth values. The pixels 412 corresponding to the hand 406 have been segmented out from the background and the wrist in this map. The brightness of each pixel within the depth map 410 corresponds inversely to its depth value, i.e., the measured z distance from the image sensors 404, with the shade of gray growing darker with increasing depth. The controller 110 processes these depth values in order to identify and segment a component of the image (i.e., a group of neighboring pixels) having characteristics of a human hand. These characteristics, may include, for example, overall size, shape and motion from frame to frame of the sequence of depth maps.

FIG. 4 also schematically illustrates a hand skeleton 414 that controller 110 ultimately extracts from the depth map 410 of the hand 406, in accordance with some embodiments. In FIG. 4, the hand skeleton 414 is superimposed on a hand background 416 that has been segmented from the original depth map. In some embodiments, key feature points of the hand (e.g., points corresponding to knuckles, finger tips, center of the palm, end of the hand connecting to wrist, etc.) and optionally on the wrist or arm connected to the hand are identified and located on the hand skeleton 414. In some embodiments, location and movements of these key feature points over multiple image frames are used by the controller 110 to determine the hand gestures performed by the hand or the current state of the hand, in accordance with some embodiments.

FIG. 5 illustrates an example embodiment of the eye tracking device 130 (FIG. 1A). In some embodiments, the eye tracking device 130 is controlled by the eye tracking unit 243 (FIG. 2) to track the position and movement of the user's gaze with respect to the scene 105 or with respect to the XR content displayed via the display generation component 120. In some embodiments, the eye tracking device 130 is integrated with the display generation component 120. For example, in some embodiments, when the display generation component 120 is a head-mounted device such as headset, helmet, goggles, or glasses, or a handheld device placed in a wearable frame, the head-mounted device includes both a component that generates the XR content for viewing by the user and a component for tracking the gaze of the user relative to the XR content. In some embodiments, the eye tracking device 130 is separate from the display generation component 120. For example, when display generation component is a handheld device or a XR chamber, the eye tracking device 130 is optionally a separate device from the handheld device or XR chamber. In some embodiments, the eye tracking device 130 is a head-mounted device or part of a head-mounted device. In some embodiments, the head-mounted eye-tracking device 130 is optionally used in conjunction with a display generation component that is also head-mounted, or a display generation component that is not head-mounted. In some embodiments, the eye tracking device 130 is not a head-mounted device, and is optionally used in conjunction with a head-mounted display generation component. In some embodiments, the eye tracking device 130 is not a head-mounted device, and is optionally part of a non-head-mounted display generation component.

In some embodiments, the display generation component 120 uses a display mechanism (e.g., left and right near-eye display panels) for displaying frames including left and right images in front of a user's eyes to thus provide 3D virtual views to the user. For example, a head-mounted display generation component may include left and right optical lenses (referred to herein as eye lenses) located between the display and the user's eyes. In some embodiments, the display generation component may include or be coupled to one or more external video cameras that capture video of the user's environment for display. In some embodiments, a head-mounted display generation component may have a transparent or semi-transparent display through which a user may view the physical environment directly and display virtual objects on the transparent or semi-transparent display. In some embodiments, display generation component projects virtual objects into the physical environment. The virtual objects may be projected, for example, on a physical surface or as a holograph, so that an individual, using the system, observes the virtual objects superimposed over the physical environment. In such cases, separate display panels and image frames for the left and right eyes may not be necessary.

As shown in FIG. 5, in some embodiments, eye tracking device 130 (e.g., a gaze tracking device) includes at least one eye tracking camera (e.g., infrared (IR) or near-IR (NIR) cameras), and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards “hot” mirrors located between the user's eyes and the display panels that reflect IR or NIR light from the eyes to the eye tracking cameras while allowing visible light to pass. The eye tracking device 130 optionally captures images of the user's eyes (e.g., as a video stream captured at 60-120 frames per second (fps)), analyze the images to generate gaze tracking information, and communicate the gaze tracking information to the controller 110. In some embodiments, two eyes of the user are separately tracked by respective eye tracking cameras and illumination sources. In some embodiments, only one eye of the user is tracked by a respective eye tracking camera and illumination sources.

In some embodiments, the eye tracking device 130 is calibrated using a device-specific calibration process to determine parameters of the eye tracking device for the specific operating environment 100, for example the 3D geometric relationship and parameters of the LEDs, cameras, hot mirrors (if present), eye lenses, and display screen. The device-specific calibration process may be performed at the factory or another facility prior to delivery of the AR/VR equipment to the end user. The device-specific calibration process may be an automated calibration process or a manual calibration process. A user-specific calibration process may include an estimation of a specific user's eye parameters, for example the pupil location, fovea location, optical axis, visual axis, eye spacing, etc. Once the device-specific and user-specific parameters are determined for the eye tracking device 130, images captured by the eye tracking cameras can be processed using a glint-assisted method to determine the current visual axis and point of gaze of the user with respect to the display, in accordance with some embodiments.

As shown in FIG. 5, the eye tracking device 130 (e.g., 130A or 130B) includes eye lens(es) 520, and a gaze tracking system that includes at least one eye tracking camera 540 (e.g., infrared (IR) or near-IR (NIR) cameras) positioned on a side of the user's face for which eye tracking is performed, and an illumination source 530 (e.g., IR or NIR light sources such as an array or ring of NIR light-emitting diodes (LEDs)) that emit light (e.g., IR or NIR light) towards the user's eye(s) 592. The eye tracking cameras 540 may be pointed towards mirrors 550 located between the user's eye(s) 592 and a display 510 (e.g., a left or right display panel of a head-mounted display, or a display of a handheld device, a projector, etc.) that reflect IR or NIR light from the eye(s) 592 while allowing visible light to pass (e.g., as shown in the top portion of FIG. 5), or alternatively may be pointed towards the user's eye(s) 592 to receive reflected IR or NIR light from the eye(s) 592 (e.g., as shown in the bottom portion of FIG. 5).

In some embodiments, the controller 110 renders AR or VR frames 562 (e.g., left and right frames for left and right display panels) and provides the frames 562 to the display 510. The controller 110 uses gaze tracking input 542 from the eye tracking cameras 540 for various purposes, for example in processing the frames 562 for display. The controller 110 optionally estimates the user's point of gaze on the display 510 based on the gaze tracking input 542 obtained from the eye tracking cameras 540 using the glint-assisted methods or other suitable methods. The point of gaze estimated from the gaze tracking input 542 is optionally used to determine the direction in which the user is currently looking.

The following describes several possible use cases for the user's current gaze direction, and is not intended to be limiting. As an example use case, the controller 110 may render virtual content differently based on the determined direction of the user's gaze. For example, the controller 110 may generate virtual content at a higher resolution in a foveal region determined from the user's current gaze direction than in peripheral regions. As another example, the controller may position or move virtual content in the view based at least in part on the user's current gaze direction. As another example, the controller may display particular virtual content in the view based at least in part on the user's current gaze direction. As another example use case in AR applications, the controller 110 may direct external cameras for capturing the physical environments of the XR experience to focus in the determined direction. The autofocus mechanism of the external cameras may then focus on an object or surface in the environment that the user is currently looking at on the display 510. As another example use case, the eye lenses 520 may be focusable lenses, and the gaze tracking information is used by the controller to adjust the focus of the eye lenses 520 so that the virtual object that the user is currently looking at has the proper vergence to match the convergence of the user's eyes 592. The controller 110 may leverage the gaze tracking information to direct the eye lenses 520 to adjust focus so that close objects that the user is looking at appear at the right distance.

In some embodiments, the eye tracking device is part of a head-mounted device that includes a display (e.g., display 510), two eye lenses (e.g., eye lens(es) 520), eye tracking cameras (e.g., eye tracking camera(s) 540), and light sources (e.g., illumination sources 530 (e.g., IR or NIR LEDs), mounted in a wearable housing. The light sources emit light (e.g., IR or NIR light) towards the user's eye(s) 592. In some embodiments, the light sources may be arranged in rings or circles around each of the lenses as shown in FIG. 5. In some embodiments, eight illumination sources 530 (e.g., LEDs) are arranged around each lens 520 as an example. However, more or fewer illumination sources 530 may be used, and other arrangements and locations of illumination sources 530 may be used.

In some embodiments, the display 510 emits light in the visible light range and does not emit light in the IR or NIR range, and thus does not introduce noise in the gaze tracking system. Note that the location and angle of eye tracking camera(s) 540 is given by way of example, and is not intended to be limiting. In some embodiments, a single eye tracking camera 540 is located on each side of the user's face. In some embodiments, two or more NIR cameras 540 may be used on each side of the user's face. In some embodiments, a camera 540 with a wider field of view (FOV) and a camera 540 with a narrower FOV may be used on each side of the user's face. In some embodiments, a camera 540 that operates at one wavelength (e.g., 850 nm) and a camera 540 that operates at a different wavelength (e.g., 940 nm) may be used on each side of the user's face.

Embodiments of the gaze tracking system as illustrated in FIG. 5 may, for example, be used in computer-generated reality, virtual reality, and/or mixed reality applications to provide computer-generated reality, virtual reality, augmented reality, and/or augmented virtuality experiences to the user.

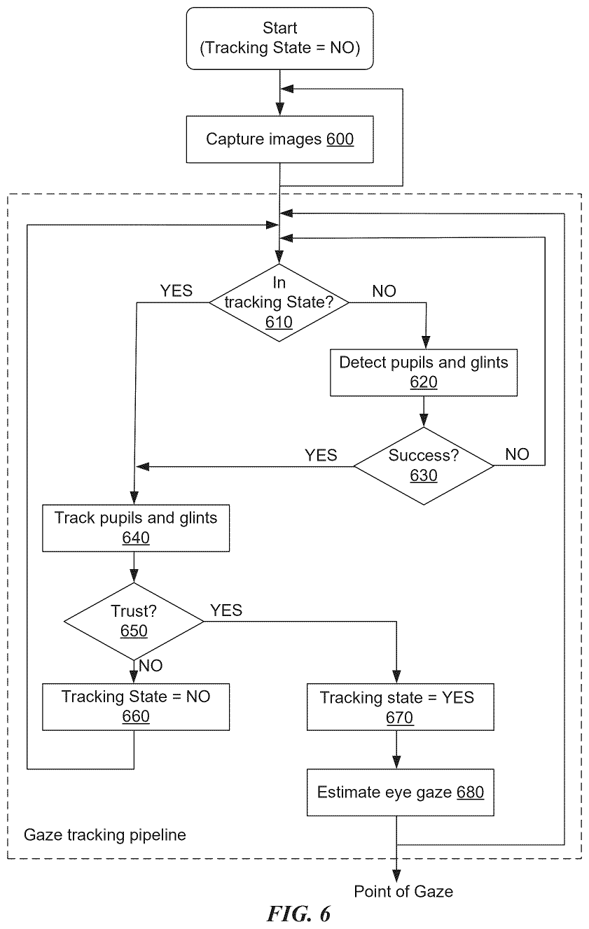

FIG. 6 illustrates a glint-assisted gaze tracking pipeline, in accordance with some embodiments. In some embodiments, the gaze tracking pipeline is implemented by a glint-assisted gaze tracking system (e.g., eye tracking device 130 as illustrated in FIGS. 1A and 5). The glint-assisted gaze tracking system may maintain a tracking state. Initially, the tracking state is off or “NO”. When in the tracking state, the glint-assisted gaze tracking system uses prior information from the previous frame when analyzing the current frame to track the pupil contour and glints in the current frame. When not in the tracking state, the glint-assisted gaze tracking system attempts to detect the pupil and glints in the current frame and, if successful, initializes the tracking state to “YES” and continues with the next frame in the tracking state.

As shown in FIG. 6, the gaze tracking cameras may capture left and right images of the user's left and right eyes. The captured images are then input to a gaze tracking pipeline for processing beginning at 610. As indicated by the arrow returning to element 600, the gaze tracking system may continue to capture images of the user's eyes, for example at a rate of 60 to 120 frames per second. In some embodiments, each set of captured images may be input to the pipeline for processing. However, in some embodiments or under some conditions, not all captured frames are processed by the pipeline.

At 610, for the current captured images, if the tracking state is YES, then the method proceeds to element 640. At 610, if the tracking state is NO, then as indicated at 620 the images are analyzed to detect the user's pupils and glints in the images. At 630, if the pupils and glints are successfully detected, then the method proceeds to element 640. Otherwise, the method returns to element 610 to process next images of the user's eyes.

At 640, if proceeding from element 610, the current frames are analyzed to track the pupils and glints based in part on prior information from the previous frames. At 640, if proceeding from element 630, the tracking state is initialized based on the detected pupils and glints in the current frames. Results of processing at element 640 are checked to verify that the results of tracking or detection can be trusted. For example, results may be checked to determine if the pupil and a sufficient number of glints to perform gaze estimation are successfully tracked or detected in the current frames. At 650, if the results cannot be trusted, then the tracking state is set to NO at element 660, and the method returns to element 610 to process next images of the user's eyes. At 650, if the results are trusted, then the method proceeds to element 670. At 670, the tracking state is set to YES (if not already YES), and the pupil and glint information is passed to element 680 to estimate the user's point of gaze.

FIG. 6 is intended to serve as one example of eye tracking technology that may be used in a particular implementation. As recognized by those of ordinary skill in the art, other eye tracking technologies that currently exist or are developed in the future may be used in place of or in combination with the glint-assisted eye tracking technology describe herein in the computer system 101 for providing XR experiences to users, in accordance with various embodiments.

In some embodiments, the captured portions of real world environment 602 are used to provide a XR experience to the user, for example, a mixed reality environment in which one or more virtual objects are superimposed over representations of real world environment 602.

Thus, the description herein describes some embodiments of three-dimensional environments (e.g., XR environments) that include representations of real world objects and representations of virtual objects. For example, a three-dimensional environment optionally includes a representation of a table that exists in the physical environment, which is captured and displayed in the three-dimensional environment (e.g., actively via cameras and displays of a computer system, or passively via a transparent or translucent display of the computer system). As described previously, the three-dimensional environment is optionally a mixed reality system in which the three-dimensional environment is based on the physical environment that is captured by one or more sensors of the computer system and displayed via a display generation component. As a mixed reality system, the computer system is optionally able to selectively display portions and/or objects of the physical environment such that the respective portions and/or objects of the physical environment appear as if they exist in the three-dimensional environment displayed by the computer system. Similarly, the computer system is optionally able to display virtual objects in the three-dimensional environment to appear as if the virtual objects exist in the real world (e.g., physical environment) by placing the virtual objects at respective locations in the three-dimensional environment that have corresponding locations in the real world. For example, the computer system optionally displays a vase such that it appears as if a real vase is placed on top of a table in the physical environment. In some embodiments, a respective location in the three-dimensional environment has a corresponding location in the physical environment. Thus, when the computer system is described as displaying a virtual object at a respective location with respect to a physical object (e.g., such as a location at or near the hand of the user, or at or near a physical table), the computer system displays the virtual object at a particular location in the three-dimensional environment such that it appears as if the virtual object is at or near the physical object in the physical world (e.g., the virtual object is displayed at a location in the three-dimensional environment that corresponds to a location in the physical environment at which the virtual object would be displayed if it were a real object at that particular location).

In some embodiments, real world objects that exist in the physical environment that are displayed in the three-dimensional environment (e.g., and/or visible via the display generation component) can interact with virtual objects that exist only in the three-dimensional environment. For example, a three-dimensional environment can include a table and a vase placed on top of the table, with the table being a view of (or a representation of) a physical table in the physical environment, and the vase being a virtual object.

In a three-dimensional environment (e.g., a real environment, a virtual environment, or an environment that includes a mix of real and virtual objects), objects are sometimes referred to as having a depth or simulated depth, or objects are referred to as being visible, displayed, or placed at different depths. In this context, depth refers to a dimension other than height or width. In some embodiments, depth is defined relative to a fixed set of coordinates (e.g., where a room or an object has a height, depth, and width defined relative to the fixed set of coordinates). In some embodiments, depth is defined relative to a location or viewpoint of a user, in which case, the depth dimension varies based on the location of the user and/or the location and angle of the viewpoint of the user. In some embodiments where depth is defined relative to a location of a user that is positioned relative to a surface of an environment (e.g., a floor of an environment, or a surface of the ground), objects that are further away from the user along a line that extends parallel to the surface are considered to have a greater depth in the environment, and/or the depth of an object is measured along an axis that extends outward from a location of the user and is parallel to the surface of the environment (e.g., depth is defined in a cylindrical or substantially cylindrical coordinate system with the position of the user at the center of the cylinder that extends from a head of the user toward feet of the user). In some embodiments where depth is defined relative to viewpoint of a user (e.g., a direction relative to a point in space that determines which portion of an environment that is visible via a head mounted device or other display), objects that are further away from the viewpoint of the user along a line that extends parallel to the direction of the viewpoint of the user are considered to have a greater depth in the environment, and/or the depth of an object is measured along an axis that extends outward from a line that extends from the viewpoint of the user and is parallel to the direction of the viewpoint of the user (e.g., depth is defined in a spherical or substantially spherical coordinate system with the origin of the viewpoint at the center of the sphere that extends outwardly from a head of the user). In some embodiments, depth is defined relative to a user interface container (e.g., a window or application in which application and/or system content is displayed) where the user interface container has a height and/or width, and depth is a dimension that is orthogonal to the height and/or width of the user interface container. In some embodiments, in circumstances where depth is defined relative to a user interface container, the height and or width of the container are typically orthogonal or substantially orthogonal to a line that extends from a location based on the user (e.g., a viewpoint of the user or a location of the user) to the user interface container (e.g., the center of the user interface container, or another characteristic point of the user interface container) when the container is placed in the three-dimensional environment or is initially displayed (e.g., so that the depth dimension for the container extends outward away from the user or the viewpoint of the user). In some embodiments, in situations where depth is defined relative to a user interface container, depth of an object relative to the user interface container refers to a position of the object along the depth dimension for the user interface container. In some embodiments, multiple different containers can have different depth dimensions (e.g., different depth dimensions that extend away from the user or the viewpoint of the user in different directions and/or from different starting points). In some embodiments, when depth is defined relative to a user interface container, the direction of the depth dimension remains constant for the user interface container as the location of the user interface container, the user and/or the viewpoint of the user changes (e.g., or when multiple different viewers are viewing the same container in the three-dimensional environment such as during an in-person collaboration session and/or when multiple participants are in a real-time communication session with shared virtual content including the container). In some embodiments, for curved containers (e.g., including a container with a curved surface or curved content region), the depth dimension optionally extends into a surface of the curved container. In some situations, z-separation (e.g., separation of two objects in a depth dimension), z-height (e.g., distance of one object from another in a depth dimension), z-position (e.g., position of one object in a depth dimension), z-depth (e.g., position of one object in a depth dimension), or simulated z dimension (e.g., depth used as a dimension of an object, dimension of an environment, a direction in space, and/or a direction in simulated space) are used to refer to the concept of depth as described above.

In some embodiments, a user is optionally able to interact with virtual objects in the three-dimensional environment using one or more hands as if the virtual objects were real objects in the physical environment. For example, as described above, one or more sensors of the computer system optionally capture one or more of the hands of the user and display representations of the hands of the user in the three-dimensional environment (e.g., in a manner similar to displaying a real world object in three-dimensional environment described above), or in some embodiments, the hands of the user are visible via the display generation component via the ability to see the physical environment through the user interface due to the transparency/translucency of a portion of the display generation component that is displaying the user interface or due to projection of the user interface onto a transparent/translucent surface or projection of the user interface onto the user's eye or into a field of view of the user's eye. Thus, in some embodiments, the hands of the user are displayed at a respective location in the three-dimensional environment and are treated as if they were objects in the three-dimensional environment that are able to interact with the virtual objects in the three-dimensional environment as if they were physical objects in the physical environment. In some embodiments, the computer system is able to update display of the representations of the user's hands in the three-dimensional environment in conjunction with the movement of the user's hands in the physical environment.

In some of the embodiments described below, the computer system is optionally able to determine the “effective” distance between physical objects in the physical world and virtual objects in the three-dimensional environment, for example, for the purpose of determining whether a physical object is directly interacting with a virtual object (e.g., whether a hand is touching, grabbing, holding, etc. a virtual object or within a threshold distance of a virtual object). For example, a hand directly interacting with a virtual object optionally includes one or more of a finger of a hand pressing a virtual button, a hand of a user grabbing a virtual vase, two fingers of a hand of the user coming together and pinching/holding a user interface of an application, and any of the other types of interactions described here. For example, the computer system optionally determines the distance between the hands of the user and virtual objects when determining whether the user is interacting with virtual objects and/or how the user is interacting with virtual objects. In some embodiments, the computer system determines the distance between the hands of the user and a virtual object by determining the distance between the location of the hands in the three-dimensional environment and the location of the virtual object of interest in the three-dimensional environment. For example, the one or more hands of the user are located at a particular position in the physical world, which the computer system optionally captures and displays at a particular corresponding position in the three-dimensional environment (e.g., the position in the three-dimensional environment at which the hands would be displayed if the hands were virtual, rather than physical, hands). The position of the hands in the three-dimensional environment is optionally compared with the position of the virtual object of interest in the three-dimensional environment to determine the distance between the one or more hands of the user and the virtual object. In some embodiments, the computer system optionally determines a distance between a physical object and a virtual object by comparing positions in the physical world (e.g., as opposed to comparing positions in the three-dimensional environment). For example, when determining the distance between one or more hands of the user and a virtual object, the computer system optionally determines the corresponding location in the physical world of the virtual object (e.g., the position at which the virtual object would be located in the physical world if it were a physical object rather than a virtual object), and then determines the distance between the corresponding physical position and the one of more hands of the user. In some embodiments, the same techniques are optionally used to determine the distance between any physical object and any virtual object. Thus, as described herein, when determining whether a physical object is in contact with a virtual object or whether a physical object is within a threshold distance of a virtual object, the computer system optionally performs any of the techniques described above to map the location of the physical object to the three-dimensional environment and/or map the location of the virtual object to the physical environment.

In some embodiments, the same or similar technique is used to determine where and what the gaze of the user is directed to and/or where and at what a physical stylus held by a user is pointed. For example, if the gaze of the user is directed to a particular position in the physical environment, the computer system optionally determines the corresponding position in the three-dimensional environment (e.g., the virtual position of the gaze), and if a virtual object is located at that corresponding virtual position, the computer system optionally determines that the gaze of the user is directed to that virtual object. Similarly, the computer system is optionally able to determine, based on the orientation of a physical stylus, to where in the physical environment the stylus is pointing. In some embodiments, based on this determination, the computer system determines the corresponding virtual position in the three-dimensional environment that corresponds to the location in the physical environment to which the stylus is pointing, and optionally determines that the stylus is pointing at the corresponding virtual position in the three-dimensional environment.

Similarly, the embodiments described herein may refer to the location of the user (e.g., the user of the computer system) and/or the location of the computer system in the three-dimensional environment. In some embodiments, the user of the computer system is holding, wearing, or otherwise located at or near the computer system. Thus, in some embodiments, the location of the computer system is used as a proxy for the location of the user. In some embodiments, the location of the computer system and/or user in the physical environment corresponds to a respective location in the three-dimensional environment. For example, the location of the computer system would be the location in the physical environment (and its corresponding location in the three-dimensional environment) from which, if a user were to stand at that location facing a respective portion of the physical environment that is visible via the display generation component, the user would see the objects in the physical environment in the same positions, orientations, and/or sizes as they are displayed by or visible via the display generation component of the computer system in the three-dimensional environment (e.g., in absolute terms and/or relative to each other). Similarly, if the virtual objects displayed in the three-dimensional environment were physical objects in the physical environment (e.g., placed at the same locations in the physical environment as they are in the three-dimensional environment, and having the same sizes and orientations in the physical environment as in the three-dimensional environment), the location of the computer system and/or user is the position from which the user would see the virtual objects in the physical environment in the same positions, orientations, and/or sizes as they are displayed by the display generation component of the computer system in the three-dimensional environment (e.g., in absolute terms and/or relative to each other and the real world objects).

In the present disclosure, various input methods are described with respect to interactions with a computer system. When an example is provided using one input device or input method and another example is provided using another input device or input method, it is to be understood that each example may be compatible with and optionally utilizes the input device or input method described with respect to another example. Similarly, various output methods are described with respect to interactions with a computer system. When an example is provided using one output device or output method and another example is provided using another output device or output method, it is to be understood that each example may be compatible with and optionally utilizes the output device or output method described with respect to another example. Similarly, various methods are described with respect to interactions with a virtual environment or a mixed reality environment through a computer system. When an example is provided using interactions with a virtual environment and another example is provided using mixed reality environment, it is to be understood that each example may be compatible with and optionally utilizes the methods described with respect to another example. As such, the present disclosure discloses embodiments that are combinations of the features of multiple examples, without exhaustively listing all features of an embodiment in the description of each example embodiment.

### User Interfaces and Associated Processes

Attention is now directed towards embodiments of user interfaces (“UI”) and associated processes that may be implemented on a computer system, such as portable multifunction device or a head-mounted device, with a display generation component, one or more input devices, and (optionally) one or cameras.

FIGS. 7A-7U illustrate methods of and systems for controlling a user interface element based on input from a directional control in accordance with some embodiments of the disclosure.

FIG. 7A illustrates a computer system 101 (e.g., an electronic device) displaying, via a display generation component 120 (e.g., display generation components 1-122a and 1-122b of FIG. 1), a three-dimensional environment 700 from a viewpoint of a user of the computer system 101.

In FIG. 7A, the computer system 101 includes one or more internal image sensors 114a oriented towards the face of the user (e.g., eye tracking cameras 540 described with reference to FIG. 5). In some embodiments, internal image sensors 114a are used for eye tracking (e.g., detecting a gaze of the user). Internal image sensors 114a are optionally arranged on the left and right portions of display generation component 120 to enable eye tracking of the user's left and right eyes. Display generation component 120 also includes external image sensors 114b and 114c facing outwards from the user to detect and/or capture the physical environment and/or movements of the user's hands.

As shown in FIG. 7A, computer system 101 captures one or more images of the physical environment around computer system 101 (e.g., operating environment 100 of FIG. 1), including one or more objects in the physical environment around computer system 101. In some embodiments, computer system 101 displays representations of the physical environment in three-dimensional environment 700. For example, three-dimensional environment 700 includes representations of the rear and side walls of the room in which the computer system 101 is located.

As discussed in more detail below, in FIG. 7A, display generation component 120 is illustrated as displaying one or more virtual objects in the three-dimensional environment 700. In some embodiments, the one or more virtual objects are displayed by a single display (e.g., display 510 of FIG. 5) included in display generation component 120. In some embodiments, display generation component 120 includes two or more displays (e.g., left and right display panels for the left and right eyes of the user, respectively, as described with reference to FIG. 5) having displayed outputs that are merged (e.g., by the user's brain) to create the view of the virtual objects shown in FIGS. 7A-7U.

Display generation component 120 has a field of view (e.g., a field of view captured by external image sensors 114b and 114c and/or visible to the user via display generation component 120) that corresponds to the virtual objects shown in FIG. 7A. Because display generation component 120 is optionally a head-mounted device, the field of view of display generation component 120 is optionally the same as or similar to the field of view of the user.

In some embodiments, a user interface illustrated and described below could also be implemented on a head-mounted display that includes the display generation component 120 that displays the user interface or three-dimensional environment to the user, and sensors to detect the physical environment and/or movements of the user's hands (e.g., external sensors facing outwards from the user), and/or attention (e.g., gaze) of the user (e.g., internal sensors facing inwards towards the face of the user) such as movements that are interpreted by the computer system as gestures such as air gestures. Additionally, in some embodiments, input to computer system 101 is provided via air gestures from hand (e.g., hand 406 of FIG. 4) and/or attention of the user (e.g., as described in more detail with reference to method 800), or via a trackpad from hand 406, and inputs described herein are optionally received via the trackpad or via air gestures/attention.

In the example of FIG. 7A, computer system 101 displays multiple user interfaces (e.g., a first user interface 704, and a second user interface 706) within three-dimensional environment. In some embodiments, first user interface 704 and second user interface 706 are content windows that display content (e.g., text and/or visual content). For instance, in the example of FIG. 7A, first user interface 704 includes both textual content and visual content (e.g., a picture) while second user interface 706 includes visual content only. In some embodiments, first user interface 704 and second user interface 706 are controllable using one or more inputs provided to hardware controllers 712a and 712b. In some embodiments, hardware controllers 712a and 712b are external hardware devices that are communicatively coupled to computer system 101 (e.g., via a wired or wireless communication link). In some embodiments, hardware controller 712a includes a directional control 714, while hardware controller 712b includes one or more buttons 716a-d (e.g., discrete inputs that when actuated by the hand of the user 720 of computer system 101, can cause one or more operations to be performed on the computer system.

In some embodiments, one or more of the user interfaces displayed in the three-dimensional environment can have a controller input focus 718 associated with it. In some embodiments, controller input focus 718 is a status that is conferred by computer system 101 to an application and/or user interface that is executed by computer system, in which inputs provided to the hardware controller 712a and 712b will be directed towards (e.g., except in certain circumstances which will be described in further detail below). In the example of FIG. 7A, the input focus 718 is indicated with a visual indicator for the purposes of illustration, but it should be understood that the visual indicator is optionally displayed or not displayed by the computer system.

In some embodiments, based on a combination of inputs provided to hardware controllers 712a and 712b, the input focus 718, and the gaze of the user (e.g., the attention of the user), the computer system performs one or more operations at a user interface. For instance, in response to detecting an input provided by the hand of the user 720 at directional control 714 that is coupled with detecting the user pressing button 716 on hardware controller 712b, and in response to the gaze of the user 726 detected by the computer system 101 as being directed to grabber bar 708 (e.g., a visual indicator that when interacted with causes user interface 704 to change locations in the three-dimensional environment), the computer system moves the location of user interface 704 within the three-dimensional environment 702 as illustrated in FIG. 7B.

In the example of FIG. 7B, in response to the input provided to directional control 714 (e.g., the thumbstick being pushed up) and button 716a of hardware controller 712a and 712b respectively, the computer system moves user interface 704 up in accordance with the detected direction of the movement of the directional control 714 as shown by the shift in the location of first user interface 704 from FIG. 7A to FIG. 7B. In some embodiments, the velocity 713 at which first user interface 704 moves and the direction that first user interface 704 moves is based on the direction and magnitude of the input provided to directional control 714 of hardware controller 712a. Referring back to example of FIG. 7A, as indicated by directional input displacement view 722, the input 728 is displaced by a magnitude and direction indicated by input 728. For instance, the distance from the center of input displacement view 722 to input 728 indicates the magnitude of the input 728, and the direction from the center indicates the direction. In some embodiments, the velocity 713 of the movement is based on the magnitude of the displacement of directional input 714 of hardware controller 712a (e.g., as indicated input displacement view 722), and the direction (e.g., as indicated in FIG. 7B) is based on the direction of input 728 to directional input 714.

In the example of FIG. 7C, in response to a different input 732 at directional input 714 of hardware controller 712a (e.g., different in both magnitude and direction as indicated by input displacement view 722 in FIG. 7C), the first user interface 704 is moved in a different direction as in indicated in FIG. 7D at a velocity 713 that is higher as indicated by velocity 713 shown in FIG. 7C. In some embodiments, the velocity 713 illustrated in FIG. 7C is higher than the velocity 713 illustrated in FIG. 7A in accordance with the magnitude of the displacement of input 732 being higher than the magnitude of the displacement of input 728. In the example of FIG. 7D, the first user interface 704 is moved up and to the right in response to a directional input 732 of hardware controller 712a that is up and to the right.

In some embodiments, the operation performed in response to detecting inputs applied to hardware controllers 712a and 712b is based on the where the gaze of the user is directed to at the time the input was applied. For instance, returning to the example of FIG. 7A, if the same inputs to hardware controller 712a and 712b were applied while the gaze of the user 723 was detected as being directed to control element 734 of user interface 704, which is illustrated as a slider bar that is controllable to slide up or down and controls some aspect of user interface 704 such as audio or visual characteristics of the user interface, the control element 734 is moved up (e.g., slid up) as illustrated in FIG. 7E. In the example of FIG. 7E, the position of control element 734 (e.g., the slider bar) has moved up in response to the directional input 714 of hardware controller 712a being moved in the up direction (e.g., as indicated by directional view 722 in FIG. 7A).

In some embodiments, certain operations associated with a user interface can be performed in response to a combination of the gaze of the user and a directional input only (without requiring a button press on the hardware controller) as illustrated in the example of FIG. 7F. In the example of FIG. 7F, user interface 704 includes scrollable content which is scrollable in response to user interface (e.g., the content can scroll up or down based on user input). In the example of FIG. 7F, in response to input 748 as illustrated in displacement view 722, and in response to the gaze of the user 738 being directed to the scrollable content of the first user interface 704, computer system 101 scrolls the content (e.g., at a velocity and direction that is based on the magnitude and direction of input 736 illustrated in the displacement view 722) as illustrated in FIG. 7G. In the example of FIG. 7G, the scrollable content has scrolled up in response to the inputs and gaze described above with respect to FIG. 7F.

In some embodiments, a user interface (e.g., such as first user interface 704) can be resized (e.g., the size of the user interface can be increased or decreased) based on a combination of the gaze of the user and inputs applied to hardware controller s 712a and 712b as illustrated in the example of FIG. 7H. In the example, of FIG. 7H, computer system detects input 742 is applied to directional input 714 of hardware controller 712a, while detecting an input applied to button 716a, and while detecting that the gaze of the user 712 is directed to a resize affordance 744 that is associated with the first user interface 704. In some embodiments, resize affordance 744 is a selectable graphical element that when interacted with, allows the user to change/modify the size of the user interface associated with the resize affordance. In response to detecting input 742 along with detecting button 716a being pushed and detecting the gaze 746 of the user directed to the resize affordance 744, computer system 101 modifies a size of the first user interface 704 as illustrated in FIG. 7I. In the example of FIG. 7I, the size of user interface 704 has increased due to the direction of displacement of input 742 illustrated in the displacement view 722 (e.g., which in FIG. 7H is shown as being down and to the right). In some embodiments, in response to detecting the displacement of the directional input 714 of hardware controller 712a being away from a center of the user interface, the computer system 101 increases the size of the user interface, and in response to detecting movement toward the center of the user interface, the computer system 101 decreases the size of the user interface.

As illustrated in the example of FIGS. 7F-7G, some operations such as content scrolling can be performed in the absence of any button pushes on the hardware controllers 712a and 712b (e.g., in response to gaze and inputs to the directional input 714 alone), however other operations (e.g., such as moving a location of a user interface or resizing) may not be performed if the directional input is not coupled with a button push as illustrated in the example of FIGS. 7J-7K. In the example of FIG. 7J, input 748 at directional input 714 of hardware controller 712a is detected along with the gaze of the user 750 being directed to grabber bar 708 by computer system 101. However, the computer system detects that the user has not pushed button 716a on hardware controller 712b (e.g., in contrast to the example of FIG. 7A), and thus in response, the computer system 101 does not move the first user interface 704 in response to the input 748 as illustrated in FIG. 7K.

In some embodiments, operations can be performed at a user interface in response to the gaze of the user and in response to a button push on hardware controller 712b, without requiring an input at the directional input 714 at hardware controller 712a as illustrated in the example of FIGS. 7L-7M. In the example of FIG. 7L, computer system 101 detects that the gaze of the user 750 is directed to user interface 704, while also detecting that button 716b (e.g., a different button than button 716a which was previously described as being associated with moving operations with respect to the first user interface) has been pressed by the user. In the example of FIG. 7L, the directional input 714 has not been pushed. In response to the detecting the gaze and the button push, the computer system 101 displays a control center user interface associated with first user interface 704 as illustrated in FIG. 7M. As illustrated in FIG. 7M, control center user interface 752 is displayed by computer system 101 in response to the inputs described above with respect to FIG. 7L. In some embodiments, the control center user interface 752 is specifically associated with first user interface 704 and can be used to control various aspects of first user interface 704 such as visual and/or audio characteristics. Alternatively, in some embodiments, computer system 101 displays a system control center user interface that controls certain aspects of the system (e.g., such as audio/visual characteristics) rather than being associated only with a single user interface. In some embodiments, the computer system 101 displays the system control center user interface in response to detecting that the user of the computer system has pushed button 716b, without requiring the gaze of the user to be detected as being directed to any particular user interface or portion of three-dimensional environment 700. In some embodiments, while control center user interface 752 is displayed, the user is able to interact with the control center user interface 752 by gazing at various selectable affordances that are part of the control center user interface 752 while providing inputs to the hardware controllers 712a and 712b.

In some embodiments, the user of the device is able to control multiple user interfaces using hardware controllers 712a and 712b by switching the input focus designation of the hardware controllers as illustrated in the example of FIGS. 7N-70. In the example of FIG. 7N, the input focus 718 associated with hardware controllers 712a-b is directed to first user interface 704. However, the user is able to shift the input focus 718 of the controllers to the second user interface 706. For instance, in response to detecting that the gaze of the user 754 is directed to the second user interface 706, and in response to detecting an input at button 716a (e.g. the same button that was used to direct movement operations in the examples of FIG. 7A-7M), computer system 101 shifts the input focus 718 from the firs user interface 704 to the second user interface 706 as illustrated in FIG. 7O. As illustrated in FIG. 7O, the input focus 718 associated with hardware controllers 712a-b is now associated with second user interface 706. Thus, in accordance with the input focus 718 associated with hardware controllers 712a-b being directed to second user interface 706, computer system 101 can perform the same operations described with in FIGS. 7A-7M on the second user interface 706.

In some embodiments, even when the input focus is directed to the second user interface 706, computer system 101 can perform operations on first user interface 704 as described with respect to the examples of FIGS. 7P-7R. In the example of FIG. 7P, while input focus 718 is directed to first user interface 704, computer system 101 in response to detecting the gaze of user 758 directed to first user interface 704 (e.g., and specifically in response to detecting the gaze of the user directed to the scrollable content of first user interface 704 described above), and in response to detecting input 756 at directional input 714, scrolls the content of first user interface 704 as shown in FIG. 7P-1. In some embodiments, even if the gaze 712 of the user moves to a different portion of user interface 704, as long as input 756 is detected as being applied to the directional input 714 of hardware controller 712a, computer system 101 continues to scroll user interface 704 as illustrated in FIG. 7P-2.

In the example of FIG. 7Q, and while the user is detected as continuing to apply input 756 to directional input 714 of hardware controller 712a, computer system 101 detects that the gaze of the user moves from the first user interface 704 to the second user interface 706. However, since input 756 was initiated prior to the computer system 101 detecting movement of the gaze of the user 758 moving from the first user interface 704 to the second user interface 706 (e.g., the input 756 was initiated or was started when the gaze of the user was directed to first user interface 704), computer system 101 continues to scroll the content on first user interface 704 despite detecting that the attention of the user is now directed to second user interface 706 as illustrated in FIG. 7R.

As described with respect to FIGS. 7P-7R, computer system 101 will in some circumstances perform operations on a user interface in response to inputs provided to hardware controllers 712a-b based on where the gaze was when the input was initiated, and so long as the input is continuously applied, the computer system 101 will continue to perform the operation on the user interface even if the gaze of the user moves to other locations within the three-dimensional environment. However, once the continuous input is detected as being terminated, computer system 101 will reset the process and perform an operation on a user interface based on the gaze of the user at the time the input to hardware controllers 712a-b is received as illustrated in FIGS. 7S-7U.

In the example of FIG. 7S, computer system 101 detects that the user is no longer providing inputs to hardware controllers 712a-b, and thus ceases scrolling of user interface 704. Once the computer system 101 had determined that the scrolling operation pertaining to first user interface 704 has terminated, the computer system 101 can detect a new combination of inputs (e.g., the gaze of the user as well as the inputs provided to hardware controllers 712a-b), and in response perform an operation based on the detected inputs. For instance, in the example of FIG. 7T, the computer system 101 detects that the gaze of the user 762 is directed to second user interface 706 while the user is providing input 760 to directional input 714 on hardware controller 712a, and pressing button 716a on hardware controller 712b, and in response scrolls the content of second user interface 706 as illustrated in FIG. 7U.

FIG. 8 is a flowchart illustrating of a computer system controlling a user interface element based on input from a directional control, in accordance with some embodiments. In some embodiments, the method 800 is performed at a computer system (e.g., computer system 101 in FIG. 1A such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 800 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 800 are, optionally, combined and/or the order of some operations is, optionally, changed.

In some embodiments, method 800 is performed at a computer system in communication with one or more display generation components and one or more input devices including a controller device. For example, a mobile device (e.g., a tablet, a smartphone, a media player, or a wearable device), or a computer or other electronic device. In some embodiments, the one or more display generation components is a display integrated with the electronic device (optionally a touch screen display), external display such as a monitor, projector, television, or a hardware component (optionally integrated or external) for projecting a user interface or causing a user interface to be visible to one or more users. In some embodiments, the one or more input devices include an electronic device or component capable of receiving a user input (e.g., capturing a user input, and/or detecting a user input.) and transmitting information associated with the user input to the computer system. Examples of input devices include a touch screen, mouse (e.g., external), trackpad (optionally integrated or external), touchpad (optionally integrated or external), remote control device (e.g., external), another mobile device (e.g., separate from the computer system), a handheld device (e.g., external), a controller (e.g., external), a camera, a depth sensor, an eye tracking device, and/or a motion sensor (e.g., a hand tracking device, a hand motion sensor), microphone for capturing voice commands or other audio input. In some embodiments, the computer system is in communication with a hand tracking device (e.g., one or more cameras, depth sensors, proximity sensors, touch sensors (e.g., a touch screen and/or trackpad)). In some embodiments, the hand tracking device is a wearable device, such as a smart glove. In some embodiments, the hand tracking device is a handheld input device, such as a remote control or stylus. In some embodiments, the controller device refers to a specialized hardware device that includes one or more mechanical input mechanisms (such as buttons, directional buttons, mechanical directional thumb sticks, and/or sliders) that when actuated by a user of the controller converts the mechanical input to an electronic signal that is then used by the computer system to perform on or more operations that are associated with receiving inputs from the controller device.

In some embodiments, while displaying, via the one or more display generation components, a first user interface element in a three-dimensional environment at a first location within the three-dimensional environment, the computer system detects (802) a first directional input at a directional hardware control of the controller device, such as input 728 applied to directional input 714 in FIG. 7A. In some embodiments, the three-dimensional environment is generated, displayed, or otherwise caused to be viewable by the first computer system. For example, the three-dimensional environment is an extended reality (XR) environment, such as a virtual reality (VR) environment, a mixed reality (MR) environment, or an augmented reality (AR) environment. In some embodiments, the three-dimensional environment at least partially or entirely includes the physical environment of the user of the computer system. For example, the computer system optionally includes one or more outward facing cameras and/or passive optical components (e.g., lenses, panes or sheets of transparent materials, and/or mirrors) configured to allow the user to view the physical environment and/or a representation of the physical environment (e.g., images and/or another visual reproduction of the physical environment). In some embodiments, the three-dimensional environment includes one or more virtual objects and/or representations of objects in a physical environment of a user of the computer system. In some embodiments, the first user interface element is a virtual content window that includes textual and/or visual content. Additionally and/or alternatively, the first user interface element refers to at least a portion of the virtual content window and/or the content that is displayed on the virtual content window. In some embodiments, the directional hardware control of the controller device includes a mechanical, optical, and/or touch-based input mechanism of the controller device that is actuated by the user in one or more directions. For instance, the directional hardware control of the controller device includes a joystick/thumb stick that is configured to be actuated by the thumb of the user (or other finger) to point the thumb stick in one or more directions (e.g., up, down, left, and/or right) thereby indicating not only the operation to be performed that is associated with the input, but also provides the computer system with the direction for the operation to be performed. For instance, in the context of the controller device being used to operate a video game that is displayed by the computer system, in response to detecting the directional hardware controller of the controller being actuated in a particular direction, the computer system moves a character of the video game in the direction indicated by the direction in which the directional hardware control was actuated. In some embodiments, detecting the first input includes detecting that the directional hardware control of the controller device has been actuated in one or more directions.

In some embodiments, in response to detecting the first directional input (804), in accordance with a determination that attention (e.g., based on a gaze or a substitute for gaze) of the user is directed to the first user interface element and that the first input satisfies one or more first criteria, the computer system moves (806) the first user interface element (e.g., from the first location within the three-dimensional environment to a second location, different from the first location,) within the three-dimensional environment in accordance with the first directional input, such as the location of user interface 704 moving up in response input 728 at directional input 714 of hardware controller 712a and in accordance with the gaze of the user 726 directed to grabber bar 708 shown in FIG. 7B.

In some embodiments, in accordance with a determination that the attention of the user is directed to a portion of the three-dimensional environment that does not correspond to the first user interface element, the computer system forgoes (808) moving the first user interface element (e.g., from the first location within three-dimensional environment to the second location) within three-dimensional environment in accordance with the first directional input (optionally independently of whether or not the one or more first criteria are satisfied), such as if computer system did not detect the gaze of the user 726 directed to any portion of user interface 704 in FIG. 7A and in response to input 728 corresponding to directional input 714 did not perform any of the operations described with respect to FIGS. 7B-7M. In some embodiments, in response to detecting that the gaze of the user is directed to the first user interface element and in response to detecting the first directional input, the computer system moves the first user interface in the direction that is indicated by the first directional input (e.g., the direction in which the directional hardware control was actuated by the user as described in further detail below). In some embodiments, moving the first user interface element (e.g., changing where the first user interface element is located within three-dimensional environment) includes moving the entirety of the first user interface (e.g., the virtual content window) from a first location within the three-dimensional environment to a second location that is different from the first location within the three-dimensional environment. Additionally and/or alternatively, moving the first user interface element includes moving a portion of the first user interface (e.g., a corner and or a side), while other portions of the user interface maintain position. In some embodiments, moving the first user interface element includes moving the content that is displayed on the first user interface (e.g., scrolling the content of the first user interface). In some embodiments, the second location is located at a portion of the three-dimensional environment that is not visible via the one or more display generation components when the first directional input is received. In some embodiments, the computer system moves first user interface element from the first location to the second location gradually (e.g., over time), such as by displaying an animation of the first user interface element moving from the first location, through one or more intermediate locations, and finally to the second location. Alternatively, the computer system optionally moves the first user interface element from the first location to the second location without displaying the first user interface element at one or more or any intermediate locations between the first location and the second location upon detecting the first input. In some embodiments, the satisfaction (or not) of the one or more criteria is irrelevant if the computer system determines that the gaze of the user is not directed to the first user interface element. In some embodiments, a second user interface element is also displayed in the three-dimensional environment. In some embodiments, the computer system moves the first user interface element in accordance with the gaze of the user and the first input without moving the location of the second user interface element within the three-dimensional environment. In some embodiments, if the computer system detects that the gaze is directed to the second user interface element (rather than the first user interface element), the computer system moves the location of the second user interface element in accordance with the first input within the three-dimensional environment without moving the first user interface element within the three-dimensional environment. Moving a user interface element in response to an input from a directional hardware control of a controller device based on the gaze of the user being directed towards the user interface, minimizes the amount of inputs from the user that are required to move the location of the user interface in a three-dimensional environment and also reduces the likelihood that an incorrect user interface is moved or that the user interface is moved incorrectly and/or unintentionally, thus minimizing input errors from the user, thereby conserving computing resources associated with correcting erroneous input from the user.

In some embodiments, moving the first user interface element comprises in accordance with a determination that the first directional input at the directional hardware control of the controller device is in a first direction of displacement, moving the first user interface element in a first direction corresponding to the first direction of displacement, such as the direction of input 742 at directional input 714 resizing the user interface 704 in the direction of input 742 in FIG. 7H, and in accordance with a determination that the first directional input at the directional hardware control of the controller device is in a second direction of displacement, different from the first direction of displacement, moving the first user interface element in a second direction corresponding to the first direction of displacement, such as the direction of input 748 at directional input 714 being in the upwards direction that in turn causes the computer system to scroll the content in the upwards direction in FIG. 7F. In some embodiments, the directional input at the directional hardware control of the controller device, includes displacing the directional hardware control according to a vector that includes both direction and magnitude. In some embodiments, the movement of the first user interface element is accordance with the direction of the displacement of the directional hardware control when the directional input is applied to the directional hardware control of the controller device. For instance, in the example where the directional hardware control of the controller device is a joystick or d-pad, the directional input includes both a magnitude of how far from the default position of the joystick or d-pad (when no input is applied) the directional input moves the joystick or d-pad, as well as a direction from the default position that the joystick or d-pad is moved in. Moving a user interface element in accordance with a direction of an input to a directional input control minimizes the amount of inputs from the user that are required to move the user interface element, thus minimizing input errors from the user, thereby conserving computing resources associated with correcting erroneous input from the user.

In some embodiments, the first direction of displacement includes a component in a first dimension and a component in a second dimension, different from the first dimension, such as if input 748 to directional input 7F included both a horizontal component and a vertical component, and wherein moving the first user interface element in the first direction includes moving the first user interface element in a first movement direction that corresponds to the first dimension in accordance with the component in the first dimension of the first direction of displacement, such as scrolling the content of first user interface 704 only in the upwards direction even if there was a horizontal component to the input in FIG. 7G, and forgoing moving the first user interface in a second movement direction that corresponds to the second dimension, such as not scrolling the first user interface element 704 in accordance with both directions of displacement in FIG. 7G. In some embodiments, the first movement direction and second movement direction corresponds to the direction that the first user interface element moves in response to displacement in the first direct and/or second direction respectively. In some embodiments, the first movement direction matches the first direction of displacement. Additionally and/or alternatively the movement direction is different than the first direction of displacement. As an example, moving the thumbstick of the controller away from the user of the computer system causes the content to scroll up with reference to the user. In some embodiments, the direction of the directional input with respect to the user is along one and/or two orthogonal directions (e.g., X and Y). For instance, the directional input can be along the Y axis (e.g., up/down) and/or along the X axis (left/right) with respect to the viewpoint of the user. In some embodiments, movement in the first direction causes corresponding movement in a specific direction relative to the directional input (e.g., when the user pushes the joystick up, the movement of the user interface element is in the same direction) or alternatively, movement in the first direction is in the opposite direction as the directional input (e.g., when the user pushes the joystick up, the movement of the user interface element is down). In some embodiments, in the example where the first direction of displacement is along two dimensions (e.g., the displacement includes a component in the X-direction and the Y-direction), the computing device ignores the component of displacement that is not compatible with the operation being performed on the first user interface. For instance, if the operation is scrolling scrollable content, and scrolling is only configured to scroll up and down, then optionally in response to displacement of the directional input in the Y-direction and the X-direction, the computer system ignores the X-direction component since the scrolling operation is not configured to scroll horizontally. Moving a user interface element along a single dimension in accordance with movement of the directional input control in the same dimension minimizes the amount of inputs from the user that are required to move the user interface element, thus minimizing input errors from the user, thereby conserving computing resources associated with correcting erroneous input from the user.

In some embodiments, the first direction of displacement includes a component in a first dimension and a component in a second dimension, different from the first dimension, such as the input 742 applied to directional input 714 in FIG. 7H, and moving the first user interface element in the first direction includes, moving the first user interface element in a first movement direction that corresponds to the first dimension in accordance with the component in the first dimension of the first direction of displacement, such as resizing the first user interface in FIG. 7I along vertical axis in accordance with the vertical component of input 742 in FIG. 7I, and moving the first user interface in a second movement direction that corresponds to the second dimension in accordance with the component in the second dimension of the first direction of displacement, resizing the first user interface in FIG. 7I along horizontal axis in accordance with the vertical component of input 742 in FIG. 7I. In some embodiments, the direction of the of directional input is along both of the two orthogonal directions (e.g., X and Y) with respect to the controller. For instance, the directional input can be both up and to the right/left, or down and to the right/left (e.g., the directional input contains both and X and Y component) with respect to the viewpoint of the user. In some embodiments, movement in the first movement direction (with respect to the user) is in the same direction as the directional input with respect to the controller (e.g., when the user pushes the joystick up and to the right, the movement of the user interface element is in the same direction) or alternatively, movement in the first movement direction is in the opposite direction as the directional input (e.g., when the user pushes the joystick up and to the right, the movement of the user interface element is down and to the left). Moving a user interface element along a plurality of dimensions in accordance with movement of the directional input control in the same dimensions minimizes the amount of inputs from the user that are required to move the user interface element, thus minimizing input errors from the user, thereby conserving computing resources associated with correcting erroneous input from the user.

In some embodiments, moving the first user interface element comprises: in accordance with a determination that a magnitude of displacement of the first directional input at the directional hardware control of the controller device is a first magnitude, moving the first user interface element by a first amount corresponding to the first magnitude of displacement, such as in accordance with the magnitude of input 732 applied to directional input 714, moving the first user interface element 704 in FIG. 7D, and in accordance with a determination that the magnitude of displacement of the first directional input at the directional hardware control of the controller device is a second magnitude, different from the first magnitude, moving the first user interface element by a second amount, different from the first amount, corresponding to the second magnitude of displacement, such as in accordance with the magnitude of input 728 applied to directional input 714, moving the first user interface element in FIG. 7B. In some embodiments, the magnitude of displacement refers to the amount of displacement experienced by the directional input at the directional hardware control of the controller device in response to a user input. For instance, in the example of a thumb stick directional input, the thumb stick is centered when no input is being applied to it. In response to an input, the thumb stick is displaced in a specific direction, but also by a specific amount from its default center position. In some embodiments, the amount of displacement from the center is detected by the computer system, and in response the computer system moves the first user interface element (e.g., moves the user interface and/or scrolls the user interface) by an amount that is proportional to the amount of displacement of the thumb stick detected by the computer system. In some embodiments, the amount of the movement is thus based on the magnitude of displacement of the directional input. In some embodiments, the amount of movement of the first user interface element is based on the magnitude of displacement as well as the amount of time that the input to the directional input is determined to have been applied for by the computer system. Thus, in some embodiments, a first input that causes a higher magnitude of displacement than a second input, can nonetheless cause the same amount of movement of the first user interface element if the duration of time of the first input is shorter than the duration of time of the second input. Moving a user interface element in accordance with the magnitude of displacement of the directional input of the directional input control minimizes the amount of inputs from the user that are required to move the user interface element, thus minimizing input errors from the user, thereby conserving computing resources associated with correcting erroneous input from the user.

In some embodiments, moving the first user interface element further comprises in accordance with the determination that the magnitude of displacement of the first directional input at the directional hardware control of the controller device is the first magnitude, moving the first user interface element at a first velocity corresponding to the first magnitude of displacement, such as indicated by the scroll velocity 713 in accordance with the magnitude of input 728 in FIG. 7A, and in accordance with the determination that the magnitude of displacement of the first directional input at the directional hardware control of the controller device is the second magnitude, different from the first magnitude, moving the first user interface element at a second velocity, different from the first velocity, corresponding to the second magnitude of displacement, such as indicated by the scroll velocity 713 in accordance with the magnitude of input 732 in FIG. 7C. In some embodiments, the magnitude of displacement shares one or more characteristics with the magnitude of displacement of the directional input of the directional hardware control described herein. In some embodiments, and similarly to the amount of the movement, the velocity of the movement of the first user interface element is proportional and/or based on the magnitude of displacement of the directional input detected by the computer system in response to user input at the directional input control. In some embodiments, if the first magnitude is smaller than the second magnitude, then the first velocity is smaller than the second velocity. In some embodiments, the amount of movement of the first user interface element is based on the magnitude of displacement as well as the amount of time that the input to the directional input is determined to have been applied for by the computer system. In some embodiments, the duration of movement is based on the duration of the input such that the total amount of movement is based on both the duration of the input and the velocity. For instance, if the magnitude of displacement of a first input is higher than a second input (e.g., the velocity of movement of the first user interface element in response to the first input is higher than the velocity of movement of first user interface element in response to the second input) the computer system will move the first user interface element by the same amount in response to both the first input and the second input, if the duration of the first input is accordingly shorter than the duration of the second input since the velocity of the first user interface element of the first input is higher than the velocity in response to the second input. Moving a user interface element at a velocity in accordance with the magnitude of displacement of the directional input of the directional input control minimizes the amount of inputs from the user that are required to move the user interface element, thus minimizing input errors from the user, thereby conserving computing resources associated with correcting erroneous input from the user.

In some embodiments, the first user interface element is a virtual object, and moving the first user interface element comprises moving the virtual object from the first location in the three-dimensional environment to a second location, different from the first location, in the three-dimensional environment, such as moving first user interface element 704 shown in FIG. 7D. In some embodiments, the virtual object to be moved shares one or more characteristics with the virtual object described herein and with respect to methods 1000, 1200, 1400, and/or 1600. In some embodiments, a virtual object includes a content window, a displayed representation of a physical object in the environment of the user, and/or a purely virtual object that is displayed in the three-dimensional environment, and that can be manipulated or otherwise interacted with by the computer system in response to detecting one or more user inputs. In some embodiment, the action/operation performed on the first user interface element includes moving a location of the first user interface element within the three-dimensional environment. In some embodiments, and as described herein, the amount and/or velocity of movement of virtual object (e.g., the first user interface element) is based on and proportional to a magnitude and/or duration of displacement of the directional input control detected by the computer system in response to a user input at the directional input control. In some embodiments, the virtual object (e.g., first user interface element) can be moved along any one of three-dimensions (X, Y, and Z) based on the direction of displacement detected by the computer system at the directional input control. Moving a virtual object in accordance with an input at the directional input of the directional input control minimizes the amount of inputs from the user that are required to move the user interface element, thus minimizing input errors from the user, thereby conserving computing resources associated with correcting erroneous input from the user.

In some embodiments, the first user interface element is a portion of a virtual object, and moving the first user interface element comprises modifying a size of the virtual object from a first size to a second size, different from the first size, such as the resizing of first user interface element 704 in FIG. 7I. In some embodiments, the virtual object to be resized shares one or more characteristics with the virtual object described herein and with respect to methods 1000, 1200, 1400, and/or 1600. In some embodiments, the computer system resizes the virtual object in response to detecting that the attention of the user (e.g., the gaze of the user) is directed to a resize affordance associated with the first user interface element (e.g., virtual object) and in response to detecting an input at the directional input control. In some embodiments, the first user interface element is resized based on the direction of the input detected as being applied to the directional input control. For instance, in response to movement away from the center of the virtual object, the computer system expands the size of the virtual object (by moving the portion of the virtual object to expand the size of the virtual object) in proportion to the amount of displacement detected at the directional input control. In response to movement towards a center of the virtual object, the computer system contracts (e.g., shrinks) the size of the virtual object. In some embodiments, the portion of the virtual object that is moved during a resize operation includes but is not limited to a corner of the virtual object, a side of the virtual object, and/or a region of the virtual object (e.g., a portion that includes a corner and/or a side of the virtual object). Modifying a size of a virtual object in accordance with an input at the directional input of the directional input control minimizes the amount of inputs from the user that are required to change the size of the user interface element, thus minimizing input errors from the user, thereby conserving computing resources associated with correcting erroneous input from the user.

In some embodiments, the first user interface element is a scrollable content portion of content, and moving the first user interface element comprises scrolling the scrollable content portion from displaying first content to displaying second content different from the first content, such as scrolling the content of first user interface element 704 in FIG. 7B. In some embodiments, the scrollable content is a user interface element of an application, such as a web browser application or an application other than the web browser application, such as an electronic reading application, media content application, or a platform control application. For example, the user interface element is optionally a window or volume configured to present two-dimensional and/or three-dimensional content that is optionally bounded to the window. In some embodiments, the scrollable content portion corresponds to web content, a word processing document, a spreadsheet document, email content, presentation content, application content, or other displayed virtual objects. In some embodiments, the scrollable content includes visual and/or textual content (e.g., images and text) that is not all displayed on a respective content window (or volume) at once (e.g., a portion of the visual and/or textual content are not visible on the respective content window at any given moment in time). In some embodiments, in response to detecting the attention of the user (e.g., the gaze of the user) directed to the scrollable content (e.g., the first user interface element), and in response to detecting movement of the directional input, the computer system scrolls the content (e.g., causes the scrollable content to move in a direction that is in accordance with the direction of the input on the directional input) such that the first user interface goes from displaying the first content to displaying the second content. In some embodiments, the first content and the second content are mutually exclusive. Alternatively, the first content and the second content share one or more content items in common. In some embodiments, prior to receiving the input, the computer system displays a first scrollable content portion, and in response to receiving the input, scrolls the scrollable content so that the second scrollable content portion is displayed. In some embodiments, the direction of scrolling is based on the direction of displacement of the directional input. For instance, in response to the thumbstick being displaced in an upward direction, the scrollable content scrolls up. In some embodiments, if the scrollable content can only be scrolled along a single dimension (e.g., up and/or down), the computer system ignores components of the directional input that correspond to directions that are along dimensions other than the single dimension (e.g., left and/or right components of the directional input). In some embodiments, the velocity of the scrolling is in accordance with the magnitude of the displacement of the directional input detected by the computer system. Scrolling scrollable content in accordance with an input at the directional input of the directional input control minimizes the amount of inputs from the user that are required to scroll content, thus minimizing input errors from the user, thereby conserving computing resources associated with correcting erroneous input from the user.

In some embodiments, the first user interface is an interactive control element that controls a value of a parameter at the computer system, such as control 734 in FIG. 7E, and moving the first user interface element comprises adjusting the interactive control element to change the value from a first value of the parameter to a second value of the parameter, such as shown in FIG. 7E with the slider bar of control element 734 sliding up in response to input 728 detected in FIG. 7A. In some embodiments, the second value of the parameter is different from the first value of the parameter. In some embodiments, an interactive control element refers to a virtual representation of a mechanical control (e.g., a slider or switch) that when actuated in response to a user input performs an operation on a virtual object or at a content window (such as modifying a value associated with the computer system and/or an application that is being executed by the computer system). In some embodiments, the interactive control element includes one or more settings/values. For instance, in the case of a switch, the one or more settings include an “on” setting and an “off” setting (e.g., a first value and a second value). In the example of a slider control, the one or more settings includes each possible position of the slider (e.g., each position on the slider corresponds to a different value). In some embodiments, the user interacts with the interactive control (e.g., the user interface element) when the computer system detects the attention (e.g., gaze of the user) directed to the control and detects that an input to the directional input control has been applied by the user. In some embodiments, the second value is based on the detected amount/magnitude of displacement applied to the directional input control. In some embodiments, modification of the value in response to the control element input is based on the direction of the directional input control. For instance, in response to detecting that the directional control is in the up direction, the computer system increases the value from the first value. Adjusting an interactive control element in accordance with an input at the directional input of the directional input control minimizes the amount of inputs from the user that are required to interact with an interactive control element, thus minimizing input errors from the user, thereby conserving computing resources associated with correcting erroneous input from the user.

In some embodiments, the one or more first criteria include a criterion that is satisfied when the first directional input is accompanied by a button press of the controller device, such as the button press of input 716 on controller 712b illustrated in FIG. 7C. In some embodiments, in response to detecting the first directional input, in accordance with a determination that attention of the user is directed to the first user interface element, and that the first directional input is not accompanied by the button press of the controller device, such as no operation being performed in response to input 748 in FIG. 7K, the computer system performs an operation at the first user interface element, different from moving the first user interface element, such as not moving interface 704 in FIG. 7K. In some embodiments, if the first directional input is detected as being accompanied by the button press of the controller, the computer system moves the first user interface element as described above. In some embodiments, the controller device includes a plurality of buttons (e.g., inputs that convert mechanical inputs into electronic signals that can be received at the computer system) that are separate from the directional input control described herein. In some embodiments, the computer system determines that the first directional input is accompanied by a button press of the one or more buttons of the controller device. In some embodiments, “accompanied by” refers to detecting that the button press occurred within a time window prior to the first directional input (e.g., 0.01, 0.1, 0.5, or 1 second), occurred while the first directional input was being applied, and/or occurred within a time window after the first directional input was applied (e.g., 0.01, 0.5, or 1 second). In some embodiments, the operation that is performed in response to determining that the one or more criteria are not satisfied (e.g., the directional input is not accompanied by a button press) includes, but is not limited to a scrolling operation and/or a resizing operation. In some embodiments, the operation that is performed is dependent on where the gaze of the user is directed within the three-dimensional environment. For instance, in the example of the first user interface element corresponding to a virtual content window, when the device detects that a first button is being pressed while the directional input is being applied, the computer system moves the virtual content window in accordance with the directional input. In response to no button being pressed while the directional input is being applied, the computer system performs a resizing operation in which the virtual content window is resized according to the directional input being applied. Performing operations on virtual objects based on a button press that occurs concurrently with a directional input minimizes the amount of inputs from the user that are required to perform various operations on or at user interface elements, thus minimizing input errors from the user, thereby conserving computing resources associated with correcting erroneous input from the user.

In some embodiments, while displaying, via the one or more display generation components, the first user interface element and a second user interface element, different from the first user interface element, and while a controller device focus is directed to the first user interface element, such as input focus 718 being directed to first user interface element 704 in FIG. 7N, the computer system detects a first button press at the controller device, such as the button press in FIG. 7N. In some embodiments, in response to detecting the first button press at the controller device, the computer system changes the controller device focus from being directed to the first user interface element to being directed to the second user interface element, such as the input focus 718 moving from the first user interface element 704 to the second user interface element 706 shown in FIG. 7O. In some embodiments, the controller device focus refers to a state in which a particular virtual object and/or virtual content window is configured to be controlled by the controller device. For instance, in response to determining that the first user interface element has the controller device focus (e.g., the controller device focus is directed to the first user interface element), in response to receiving inputs at the controller device (such as a button press or directional input), the computer system performs operations directed to or at the first user interface (optionally independent of and/or without the need for attention of the user to be directed to the first user interface element). Similarly, in response to the controller focus being directed to the second user interface element, and in response to an input at the controller device, the computer system performs operations directed to or at the second user interface (optionally independent of and/or without the need for attention of the user to be directed to the second user interface element). In some embodiments, the first button press includes detecting that a specific button of a plurality of buttons has been pressed. In some embodiments, the button press is accompanied by detecting that the gaze of the user is directed to the user interface where the controller device focus is to be directed to. For instance, if the controller device focus is directed to the first user interface element, and the computer system detects that the gaze of the user is directed to the second user interface element when the button corresponding to changing the controller device focus is pressed, the computer system changes the controller device focus from the first user interface element to the second user interface element. In some embodiments, in response to determining that the first button press does not include a specific button of the plurality of buttons, the computer system does not change the input focus from the first user interface element to the second user interface element. In some embodiments, the switching of input focus and/or the first button press shares one or more characteristics with the input focus and button press input described with respect to method 1000. Changing controller device focus by detecting a button press on the controller device minimizes the amount of inputs from the user that are required to change controller device focus, thus minimizing input errors from the user, thereby conserving computing resources associated with correcting erroneous input from the user.

In some embodiments, while displaying, via the one or more display generation components, the first user interface element, such as first user interface element 704 shown in FIG. 7L, the computer system detects a first button press at the controller device, such as the button press of controller 712b shown in FIG. 7L. In some embodiments, in response to detecting the first button press at the controller device, the computer system displays, via the one or more display generation components, a system user interface in the three-dimensional environment, such as the control center interface in FIG. 7M. In some embodiments, a button press on the controller device initiates display of a system user interface in three-dimensional environment. In some embodiments, the system user interface refers to a user interface in which the computer system displays one or more selectable options for configuring the computer system, and/or an application running on the computer system. In some embodiments, the one or more selectable options includes settings relating to the computer system and/or an application running on the computer system. In some embodiments, the system user interface corresponds to a home screen of the computer system (e.g., a display of one or more selectable options pertaining to applications that are available to be executed by the computer system), and in response to detecting selection of the one of the one or more selectable options, the computer system launches the corresponding application. In some embodiments, the system user interface is displayed not only in reaction to the button press, but also in response to a determination as where the gaze of the user is directed. For instance, if the gaze of the user is directed to the first user interface element while the button press is detected, the computer system displays a system user interface associated with the application that is associated with the first user interface element. Similarly, if the gaze of the user directed to a second user interface element, different from the first user interface element while the button press is detected, the computer system displays a system user interface associated with the application that is associated with the second user interface element. In some embodiments, the button is the same button that is used to change the input focus of the controller device. Alternatively, the button is a different button than the butt that is used to change the input focus of the controller device. Opening a system user interface in response to a button press on the controller device minimizes the amount of inputs from the user that are required to access a system user interface, thus minimizing input errors from the user, thereby conserving computing resources associated with correcting erroneous input from the user.

In some embodiments, while displaying, via the one or more display generation components, the first user interface element and a second user interface element in the three-dimensional environment and after moving the first user interface element (e.g., from the first location within the three-dimensional environment to a second location, different from the first location,) within the three-dimensional environment in accordance with the first directional input and in accordance with the determination that the attention (e.g., based on a gaze or a substitute for gaze) of the user was directed to the first user interface element and that the first input satisfied one or more first criteria, wherein the attention of the user was directed to a first location in the three-dimensional environment when the first input was detected, the computer system detects, via the one or more input devices, a change in the attention of the user from the first location in the three-dimensional environment to a second location such as the gaze of the user 712 moving from first user interface element 704 to second user interface element 702 in FIG. 7Q, different from the first location, in the three-dimensional environment, and the computer system detects a second directional input at the directional hardware control of the controller device when the attention of the user is directed to the second location, such as the input 748 at the controller 712a in FIG. 7Q. In some embodiments, in response to detecting the second directional input, the computer system performs a first operation corresponding to the second directional input, such as the scrolling operation performed on second user interface 706 in FIG. 7U. In some embodiments, the computer system causes one or more operations (e.g., first operation) to be performed based on both a directional input applied to the controller device as well as detected movement of the attention (e.g., based on gaze) of the user of the computing device. In some embodiments, the movement of the gaze occurs before the directional input is detected. Additionally or alternatively, the movement of the gaze is detected after the directional input is detected. In some embodiments, the operations performed in response the directional input and based on the gaze of the user include but are not limited to moving a user interface element (as described herein), providing an input to a particular application that is executing on the computer system, and/or interacting with virtual content displayed in the three-dimensional environment. In some embodiments, a magnitude associated with the first operation (e.g., a speed) is based on a magnitude of the second directional input. Performing operations on the computer system in response to a directional input on a controller device and based on the location where the attention of the user is directed minimizes the amount of inputs from the user that are required to interact with virtual content, thus minimizing input errors from the user, thereby conserving computing resources associated with correcting erroneous input from the user.

In some embodiments, in accordance with a determination that the second location in the three-dimensional environment corresponds to the first user interface element, the computer system performs the first operation on the first user interface element, such as scrolling user interface element 704 in FIG. 7R. In some embodiments, if the movement of the gaze from the first location to the second location were both in the first user interface element, then the computer system determines that the directional input was directed to the first user interface element and performs an operation on the first user interface element (e.g., moving the first user interface element, resizing the first user interface element, moving a control element of the first user interface element, and/or scrolling content on the first user interface). Performing operations on the computer system in response to a directional input on a controller device and based on the location where the attention of the user is directed minimizes the amount of inputs from the user that are required to interact with virtual content, thus minimizing input errors from the user, thereby conserving computing resources associated with correcting erroneous input from the user.

In some embodiments, the first location corresponds to the first user interface element, such as first user interface element 704, the second location corresponds to the second user interface element, such as user interface 706. In some embodiments, performing the first operation comprises, in accordance with a determination that the second directional input is a continuation of the first directional input that was directed to the first user interface element, performing the first operation on the first user interface element (and, optionally, not the second user interface element), such as shown in FIG. 7R where user interface 704 continues to scroll while the gaze 712 of the user is directed to user interface 706, and in accordance with a determination that second directional input is not a continuation of the first respective input that was directed to the first user interface element, performing the first operation on the second user interface element (and not the first user interface element), such as shown in FIG. 7T where user interface 706 scrolls in accordance with the gaze 712 of the user being directed to second user interface element 706. In some embodiments, and upon detecting that the second location of the attention of the user (e.g., gaze) is directed to a second user interface element that is different from the first user interface element, the computer system determines the temporal relationship between the second directional input and the movement of the gaze to determine which of the interface elements the directional input was directed to. In some embodiments, if the computer system determines that the second directional input began when the attention of the user was directed to the first user interface element and was continued (e.g., the directional input was still being applied) when the attention of the user moved to the second user interface element, the computer system determines that the second directional input was directed to the first user interface element and thus performs the operation in response to the directional input on the first user interface element. In some embodiments, if the computer system determines that the second directional input was applied after (e.g., initiated after) or concurrently with the movement of the gaze of the user (e.g., the second directional input was not a continuation of the first input), the computer system determines that the second directional input was directed to the second user interface element and performs an operation on the second user interface element (e.g., moving the second user interface element). In some embodiments, the second directional input is detected as being applied after or concurrently with the movement of the gaze of the user, when the computer system detects that there is a termination of the first input (e.g., in the case of the thumbstick, the thumbstick is returned to a default position or a position that is associated with no input being applied to the thumbstick) followed by a reengagement of the directional input. In some embodiments, if the computer system does not detect a termination of the first input prior to or concurrently with the movement of the gaze from the first user interface element to the second user interface element, the computer system determines that the second input is a continuation of the first input, and performs the operation in the first user interface element instead of the second user interface element. Performing operations on the computer system in response to a directional input on a controller device and based on the location where the attention of the user is directed minimizes the amount of inputs from the user that are required to interact with virtual content, thus minimizing input errors from the user, thereby conserving computing resources associated with correcting erroneous input from the user.

In some embodiments, while moving the first user interface element in accordance with the determination that the attention of the user is directed to the first user interface element and that the first directional input satisfies the one or more first criteria, and while the first directional input is ongoing, such as while scrolling interface 704 in FIG. 7P, the computer system determines, via the one or more input devices, that the attention of the user is no longer directed to the first user interface element 704, such as shown in FIG. 7R. In some embodiments, the computer system continues movement of the first user interface element in accordance with the first directional input, while the attention of the user is no longer directed to the first user interface element, such as shown in FIG. 7R. In some embodiments, if the computer system is performing an operation (e.g., moving the first user interface element) in response to a directional input and in accordance with a determination that the gaze of the user was directed to the first user interface element when the directional input was initiated, the computer system initiates movement of the first user interface element. In some embodiments, and while the movement of the first interface element is ongoing (e.g., continuing on from the initiation of the movement such that a termination of the input has not been detected), if the computer system detects that the attention of the user moves away from the first user interface while the directional input is still being applied, the computer system continues moving the first user interface element in accordance with the magnitude and/or direction of the directional input (even if the magnitude and/or direction change during the course of the first input being applied). In some embodiments, once the computer system determines that the directional input has ceased, the computer system ceases movement of the first user interface element regardless as to whether the attention of the user is directed to the first user interface element or is directed to somewhere else in three-dimensional environment. Performing and maintaining operations on a user input element in response to a directional input even if the attention of the user moves away from the user interface element while the directional input is being applied minimizes disruptions to operations caused by momentary movements of the attention of the user, thus minimizing input errors from the user, thereby conserving computing resources associated with correcting erroneous input from the user.

It should be understood that the particular order in which the operations in method 800 have been described is merely exemplary and is not intended to indicate that the described order is the only order in which the operations could be performed. One of ordinary skill in the art would recognize various ways to reorder the operations described herein. In some embodiments, aspects/operations of method 800 may be interchanged, substituted, and/or added between these methods. For example, various object manipulation techniques and/or object movement techniques of method 800 is optionally interchanged, substituted, and/or added between these methods. For brevity, these details are not repeated here.

FIGS. 9A-9U illustrate examples of a computer system performing one or more operations on virtual content items based on input focus at the computer system, in accordance with some embodiments of the disclosure.

In the examples of FIGS. 9A-9U, computer system 101 includes one or more display generation components 120. In some embodiments, the computer system 101 displays the one or more virtual objects in the three-dimensional environment 900 via display generation component 120. In some embodiments, the computer system 101 captures one or more images of the physical environment around computer system 101 (e.g., operating environment 100), including one or more objects in the physical environment around computer system 101. In some embodiments, the computer system 101 displays representations of the physical environment in three-dimensional environment 900. For example, as shown in FIG. 9A, the three-dimensional environment 900 includes a representation of a window 902. In FIG. 9A, the computer system 101 includes one or more internal image sensors 114a oriented towards the face of the user (e.g., eye tracking cameras 540 described with reference to FIG. 5). In some embodiments, internal image sensors 114a are used for eye tracking (e.g., detecting a gaze of the user). Internal image sensors 114a are optionally arranged on the left and right portions of display generation component 120 to enable eye tracking of the user's left and right eyes. Computer system 101 also includes external image sensors 114b and 114c facing outwards from the user to detect and/or capture images representing or otherwise corresponding to the physical environment and/or movements of the user's hands.

In some embodiments, the one or more display generation components 120 include one or more displays (e.g., display 510 and/or left and right display panels for the left and right eyes of the user, respectively, as described with reference to FIG. 5) by which the content is displayed in the three-dimensional environment 900. In some embodiments, display generation component 120 has a field of view (e.g., a field of view captured by external image sensors 114b and 114c and/or visible to the user via one or more display generation components 120) that corresponds to the content shown in FIG. 9A. For example, in some embodiments, display generation component 120 optionally includes a head-mounted device (HMD). In some embodiments, the field of view of display generation component 120 corresponds (e.g., in extent) to the viewport of the user. In some embodiments, the field of view of display generation component 120 is larger (e.g., in extent) than the viewport of the user.

As described above, the computer system 101 is configured to display content in the three-dimensional environment 900 using the one or more display generation components 120. In some embodiments, the content includes one or more virtual objects corresponding to first user interface region 904 and/or second user interface region 906. In some embodiments, the first user interface region 904 and/or the second user interface region 906 are separate virtual content windows or separate regions of the same virtual content window. In some embodiments, the first user interface region 904 and/or the second user interface region 906 are regions in three-dimensional environment 900 corresponding to respective graphical user interfaces of the computer system 101, or respective applications in and at which the computer system 101 receives input from the user and/or provides output to the user, as described in further detail with reference to methods 800, 1000, and 1200.

FIG. 9A illustrates the computer system 101 detecting inputs at controller 901 while displaying one or more virtual objects in three-dimensional environment 900, in accordance with some embodiments. As shown in FIG. 9A, the one or more virtual objects include a first user interface region 904 (“first user interface region 904” or “user interface 904”) and a second user interface region 906 (“second user interface region 906” or “user interface 906”), and the input includes input 921a from controller(s) 901a and 901b (collectively, “controller 901”). In some embodiments, input 921a (e.g., corresponding to movement of the thumbstick 920 by the user) is detected when a gaze (“attention 912”) of the user is directed to the first user interface region 904 while the first user interface region 904 has input focus 940 and controller device focus 942, as shown in FIG. 9A. In some embodiments, input 921a includes directional input corresponding to a directional control signal indicating an upwards direction that is generated at controller(s) 901a from actuation of thumbstick 920 in an upwards direction, as described in further detail with reference to method 800.

In some embodiments, controller 901 shares one or more characteristics with the controller described with reference to method 800. For example, in some embodiments, controller 901 includes one or more input mechanisms such as a directional pad, joystick, control stick, and/or thumbstick (“thumbstick 920”); a home button, a start button, and/or a select button (“start/select button 922” or “home/start/select button 922”); and one or more face buttons (“face button 924a,” “face button 924b,” “face button 924c,” and/or “face button 924d”). Such depiction is intended to be exemplary rather than limiting; for example, the controller(s) 901a and 901b can otherwise include any suitable hardware controller, gamepad, and/or the like.

In some embodiments, the first user interface region 904 and/or the second user interface region 906 are, optionally, individual user interfaces of respective applications containing content (e.g., a plurality of selectable options, images, text, and/or video), or any other element displayed by computer system 101 that is not included in the physical environment of display generation component 120. For example, as shown in FIG. 9A, the first user interface region 904 and/or the second user interface region 906 are respective user interfaces, such as of a web-browsing application containing website content including, for example, text, images, video, hyperlinks, and/or audio content. It should be understood that the content discussed above is exemplary and that, in some embodiments, additional and/or alternative content and/or user interfaces are provided in the three-dimensional environment 900, such as in the content described below with reference to methods 800, 1000, 1200, 1400, and/or 1600.

In some embodiments, the input focus 940 shares one or more characteristics with the input focus described with reference to method 800. In some embodiments, the computer system 101 indicates input focus 940 in connection with input received and/or detected at the computer system 101, in which the received and/or detected input includes non-controller input and/or input that is not from a controller such as controller 901, such as described herein. For example, in some embodiments, the computer system 101 indicates input focus 940 in connection with the first user interface region 904 to thereby designate the first user interface region 904 as having a characteristic corresponding to current input focus, to indicate that subsequently received and/or detected inputs (e.g., corresponding to a hand gesture, a soft keyboard, a trackpad, a mouse or a hardware keyboard) at the computer system 101, while the first user interface region 904 has input focus 940, will be directed to the first user interface region 904. In some embodiments, the controller device focus 942 shares one or more characteristics with the controller device focus described with reference to method 800 and/or 1000. For example, in some embodiments, the computer system 101 indicates controller device focus 942 in connection with input received and/or detected at the computer system 101, in which the received and/or detected input includes controller input from a controller such as controller 901, such as described herein. For example, in some embodiments, controller device focus 942 refers to a setting in which a particular virtual object and/or virtual content window is configured to be controlled by controller input (e.g., thumbstick movements or button presses) from controller 901.

In some embodiments, when the input focus 940 at the computer system 101 is indicated in connection with the first user interface region 904, and in response to detecting input including input indicating that attention 912 of the user is directed at the first user interface region 904, the computer system 101 performs one or more operations in the first user interface region 904, as shown and described in further detail with reference to FIG. 9B.

FIG. 9B illustrates the computer system 101 performing one or more operations in connection with the one or more virtual objects in response to detecting the input shown in FIG. 9A, in accordance with some embodiments. In some embodiments, the one or more operations are performed in, at, or in connection with the first user interface region 904 to scroll the content of the first user interface region 904 based on the input 921a provided in FIG. 9A, when the attention 912 was directed to the first user interface region 904 while the first user interface region 904 had input focus 940 and controller device focus 942. Thus, in response to detecting the attention 912 of the user directed to user interface 904 while input 921a is received, computer system 101 scrolls the content of user interface 904.

As shown in FIG. 9B, the scroll operation is performed to move, navigate, and/or otherwise scroll the content of the first user interface region 904 to display previously hidden content located at a position extending beyond the displayed region of the first user interface region 904 shown in FIG. 9A, as described in further detail with reference to method 800 and/or 1000. In some embodiments, the scroll operation is performed to scroll the content of the first user interface region 904 in a direction corresponding to the direction of input 921a, such as by scrolling the content of the first user interface region 904 upwards and/or vertically based on the upwards indication of direction associated with or otherwise corresponding to input 921a.

In some embodiments, the computer system 101 continues to perform the scroll operation in connection with the first user interface region 904 while the first user interface region 904 has input focus 940 until the attention 912 is subsequently diverted or otherwise directed away from the first user interface region 904, such as shown in FIGS. 9A-9B. In some embodiments, the computer system 101 continues to perform the one or more operations in the first user interface region 904 in response to receiving the inputs until input focus 940 is caused to transition or otherwise be withdrawn from the first user interface region 904, such as shown and described in further detail herein with reference to FIGS. 9J-9V.

FIG. 9C illustrates the computer system 101 detecting input while displaying the one or more virtual objects in the three-dimensional environment 900, in accordance with some embodiments. In some embodiments, input 921b is detected while the attention 912 is directed to the second user interface region 906, and while the first user interface region 904 has input focus 940 and controller device focus 942. In some embodiments, input 921b includes directional input corresponding to a directional control signal indicating an upwards direction that is generated at controller(s) 901a and 901b from actuation of thumbstick 920 in an upwards direction, as shown in FIG. 9C and described in further detail with reference to method 800.

FIG. 9D illustrates the computer system 101 performing one or more operations in connection with the one or more virtual objects in response to detecting the input shown in FIG. 9C, in accordance with some embodiments. In some embodiments, the one or more operations are performed in the second user interface region 906 to scroll the content of the second user interface region 906 based on the input 921b shown in FIG. 9C, while the attention 912 was directed to the second user interface region 906, and while the first user interface region 904 had input focus 940 and controller device focus 942. In some embodiments, a scroll operation is performed at user interface 906 while the first user interface region 904 continues to have input focus 940 and controller device focus 942. As shown in FIG. 9D, the scroll operation is performed to move, navigate, and/or otherwise scroll the content of the second user interface region 906 to display previously hidden content located at a position extending beyond the displayed region of the second user interface region 906 shown in FIG. 9C, as described in further detail with reference to methods 800 and/or 1000. In the example of FIG. 9D, the user interface 906 is scrolled in response to the attention 912 of the user being directed to the second user interface 906 and the input 921b even though the input focus 940 and the controller input focus 942 is still on user interface 904, thus demonstrating that at least some operations can be performed in connection with virtual objects for which input focus (e.g., input focus 940) and/or controller device focus (e.g., controller device focus 942) is not currently indicated and/or otherwise designated, such as in the example of scrolling user interface 906 even when the input focus 940 and the controller device focus 942 is on the first user interface 904 and not the user interface 906, to which the operations are performed, as shown in FIG. 9D. For example, in some embodiments, the computer system performs at least some operations in connection with the second user interface region 906, for which input focus and/or controller device focus is not currently indicated and/or otherwise designated, when the attention 912 of the user is directed to the second user interface region, as shown in FIGS. 9C-9D.

FIG. 9E illustrates the computer system 101 detecting input while displaying the one or more virtual objects in the three-dimensional environment 900, in accordance with some embodiments. In some embodiments, the first user interface region 904 includes grabber bar 908 and the second user interface region 906 includes grabber bar 910. In some embodiments, input 921c (e.g., the hand 916 performing an air pinch gesture followed by movement of the user's hand 916) is detected (e.g., via external image sensors 114b and 114c) while the attention 912 is directed to the grabber bar 910. In some embodiments, in response to detecting the attention 912 of the user directed to grabber bar 910 while detecting input 921c, computer system performs a drag operation on user interface 906 and moves the location of user interface region 906, as illustrated in FIG. 9F.

As illustrated in FIG. 9F, in response to subsequently detecting a change in position of input 921c from the first position and to a second position (e.g., as in when the user is performing a dragging gesture while maintaining the pinching gesture), computer system 101 moves the second user interface region 906, from the first position to the second position, based on the change in the position of input 921c.

In some embodiments, while the attention 912 of the user is directed to the grabber bar 910, the computer system 101 detects input 921c as shown in FIG. 9E. In some embodiments, detecting input 921c includes detecting the hand 916 of the user engaged in an air pinch while the hand is moving laterally. In some embodiments, computer system responds to input 921c by moving user interface 904 in accordance with the movement of input 921c. Additionally or alternatively, in some embodiments, while attention 960 of the user is directed to the grabber bar 908 when the computer system 101 detects input (not shown) while the attention 960 of the user is directed to grabber bar 908, computer system 101 moves the first user interface region 904, that can result in the spatial conflict between the first user interface region 904 and the second user interface region 906, as shown in FIG. 9F.

In some embodiments, detecting the spatial conflict includes detecting an overlap exceeding a predetermined overlap threshold such as between the second user interface region 906 and the first user interface region 904 when the second user interface region 906 at least partially coincides, corresponds, overlaps, or is otherwise in spatial conflict with the first user interface region 904 beyond a predetermined overlap threshold 925. In some embodiments, the spatial conflict is detected in response to detecting an extent of an instance of spatial conflict exceeding the predetermined overlap threshold 925, as shown in FIG. 9F.

For example, in some embodiments, the spatial conflict is detected relative to a viewpoint of the user, as shown in Top-Down View 903, corresponding to a top-down view of the three-dimensional environment shown in FIG. 9F. In some embodiments, the one or more operations performed in response to detecting the spatial conflict between the first user interface region 904 and the second user interface region 906 shown in FIG. 9F include visually deemphasizing the second user interface region 906 relative to the first user interface region 904 by displaying the second user interface region 906 with a predetermined level of reduced prominence, as shown in FIG. 9F and described in further detail with reference to method 1000. For example, in some embodiments, in response to detecting the spatial conflict between the first user interface region 904 and the second user interface region 906, the computer system 101 visually deemphasizes the second user interface region 906 according to a determination that the first user interface region 904 has input focus 940 and controller input focus 942, as shown in FIG. 9F.

As shown in FIG. 9F, the computer system 101 detects input 921d while the attention 912 is directed to the first user interface region 904, and while the first user interface region 904 has input focus 940 and controller device focus 942. As illustrated in FIG. 9F, input 921d is detected in connection with the first user interface region 904 while the second user interface region 906 is visually deemphasized. In some embodiments, input 921d includes directional input corresponding to a directional control signal indicating an upwards direction that is generated at controller 901a from actuation of thumbstick 920 in an upwards direction. In response to detecting input 921d while the attention 912 of the user is directed to user interface 904, computer system performs a scroll operation on user interface 904 as illustrated in FIG. 9G.

As illustrated in FIG. 9G, in response to input 921d (shown in FIG. 9F), computer system 101 scrolls the content of the first user interface region 904 while second user interface region 906 is visually deemphasized. In some embodiments, the scroll operation is performed while the first user interface region 904 continues to have input focus 940 and controller device focus 942, and while the second user interface region 906 remains visually deemphasized.

FIG. 9H illustrates the computer system 101 detecting input while displaying the one or more virtual objects in the three-dimensional environment 900, in accordance with some embodiments. As shown in FIG. 9H, the input includes input 921e from controller(s) 901a and 901b. In some embodiments, input 921e is detected when attention 912 is directed to the second user interface region 906 while the first user interface region 904 has input focus 940 and controller device focus 942, and the second user interface region 906 is visually deemphasized (described above). In some embodiments, input 921e includes directional input corresponding to a directional control signal indicating an upwards direction that is generated at controller(s) 901a from actuation of thumbstick 920 in an upwards direction. In some embodiments, in accordance with a determination that user interface 906 is in spatial conflict with user interface 904 (described above), and in accordance with determining that user interface 906 is visually deemphasized, computer system 101 forgoes performing an operation (e.g., scrolling) on user interface 906 in response to input 921e while attention 912 of the user is directed to the second user interface 906, as illustrated in FIG. 9I.

In the example of FIG. 9I, computer system 101 foregoes performing the one or more operations in response to detecting the input 921e shown in FIG. 9H, while the first user interface region 904 has input focus 940 and controller device focus 942, and the second user interface region 906 is visually deemphasized. In some embodiments, the computer system 101 foregoes performing the one or more operations in response to detecting the input 921e when the computer system 101 determines that the input 921e is not of a predetermined type while the first user interface region 904 has input focus 940 and controller device focus 942, and the second user interface region 906 is visually deemphasized, as shown in FIG. 9H. For example, in some embodiments, the input that is not of the predetermined type optionally includes input that does not include discrete input including a selection input of controller 901, as shown in FIG. 9I.

As shown in FIG. 9I, in some embodiments, computer system 101 detects input corresponding to actuation of button 922, which is detected while the first user interface region 904 has input focus 940 and controller device focus 942, the second user interface region 906 is visually deemphasized, and the attention 912 is directed to the second user interface region 906, as shown in FIG. 9I. In some embodiments, the input corresponding to actuation of button 922 includes input of a predetermined type that, when detected, causes the computer system 101 to move the controller device focus 942 and the input focus 940 to user interface 906, as illustrated in FIG. 9J.

FIG. 9K illustrates the computer system 101 detecting input while displaying one or more virtual objects in three-dimensional environment 900, in accordance with some embodiments. As shown in FIG. 9K, the one or more virtual objects include the first user interface region 904 and a user interface region 907. In some embodiments, user interface region 907 is associated with an application of a first type, including an interactive, multimedia application (e.g., a video game application) that utilizes inputs at controllers 901a and 901b to control operation of the video game. In some embodiments, and as illustrated in FIG. 9K, computer system 101 detects input corresponding to actuation of button 924c from controller(s) 901 when the first user interface region 904 has input focus 940 and controller device focus 942 while detecting that the attention 912 is directed to the user interface region 907. Additionally or alternatively, in some embodiments, the computer system 101 detects input corresponding to device motion of controller(s) 901, in which the device motion includes 6 degrees of freedom. For example, in some embodiments, the computer system 101 detects the input corresponding to the device motion of controller(s) 901 in 6 degrees of freedom to move elements (e.g., the representations of the drumsticks) of the user interface region in a corresponding manner (e.g., to control the movement of the representation of the drumsticks in the user interface region 907).

In some embodiments, in response to detecting input corresponding to actuation of button 924c, computer system 101 shifts the input focus 940 and the controller input focus 942 to user interface region 907, as illustrated in the example of FIG. 9L. As shown in FIG. 9L, the computer system designates user interface region 907 as having input focus 940 and controller device focus 924 based on the input corresponding to actuation of button 924c, such that subsequently received inputs are directed to the fifth user interface region 907, accordingly, such as described in further detail with reference to method 1000.

As shown in FIG. 9M, the one or more virtual objects include the first user interface region 904 and a sixth user interface region 930. In some embodiments, the sixth user interface region 930 is associated with an application of a second type, different from the first type, including a web-browsing application containing website content (e.g., content including text, images, video, hyperlinks, and/or audio content). In some embodiments, the computer system 101 foregoes focus switching in response to detecting the input corresponding to actuation of button 924c when the attention 912 directed to the sixth user interface region 930 in accordance with a determination that the sixth user interface region 930 is associated with an application of the second type, different from the first type, as illustrated in FIG. 9M. In some embodiments, the sixth user interface region 930 is of a type that generally does not typically receive inputs from a controller. In some embodiments, in response to detecting input to button 924c, computer system 101 forgoes shifting the input focus from first user interface 904 to sixth user interface region 930 as illustrated in FIG. 9N. In contrast to the example of FIGS. 9K-9L, since the sixth user interface region 930 is not a gaming application (or other application that typically receives input from the controller), the controller does not shift input focus to the controller in response to actuation of button 924c.

FIGS. 9O-9V illustrates various scenarios and examples in which a hardware controller is used to interact with an text entry field that is part of a user interface. In the example of FIG. 9O, the first user interface region 904 is displayed with a text entry field 932 (“text entry field 932” or “text field 932”). In some embodiments, the text entry field 932 at the first user interface region 904 is associated with an input session that can be initialized and/or designated to receive operations or inputs from the user, as described in further detail with reference to method 1000. In some examples, computer system 101 initiates a text entry session in response (at least in part) to user inputs received at controller 901 as illustrated in the example of FIG. 9P.

As shown in FIG. 9P, the input includes input corresponding to actuation of button 922 from controller 901b. In some embodiments, input corresponding to actuation of button 922 is detected while the attention 912 is directed to the text entry field 932 at the first user interface region 904 and while the first user interface region 904 has input focus 940 and controller device focus 942, and in response, computer system 101 initiates an active text input session on user interface 904 as illustrated in FIG. 9Q.

In the example of FIG. 9Q, in response to actuation of button 922 from controller 901b (and while the attention the attention 912 is directed to the text entry field 932 at the first user interface region 904 and while the first user interface region 904 has input focus 940 and controller device focus 942), computer system 101 initiates an active input session at text entry field 932. In some embodiments, initiating an active input session at text entry field 932 includes expanding a size of the text field, displaying a virtual keyboard 933, and displaying a cursor element 946 in the text field to indicate the location at which input will be entered based on input detected at the virtual keyboard 933. In some embodiments, the virtual keyboard 933 is displayed at a position located between the viewpoint of the user and the first user interface region 904 and the sixth user interface region 930, as shown in the Top-Down View 903 of FIG. 9Q. In some embodiments, computer system displays text within the text entry field 932 in response to detecting input at virtual keyboard 933. In some embodiments, and while computer system 101 has initiated an input session at text entry field 932, the computer system 101 terminates the input session in response to detecting a change in the input focus of the controller as illustrated in the example of FIG. 9R.

In the example of FIG. 9R, in response to detecting a focus-switching event including input indicating a shift in the attention 912 from the first user interface region 904 and to the sixth user interface region 930, and input corresponding to actuation of button 922 of controller 901, computer system 101 terminates the active input session at text entry field 932 in first user interface 904. In some embodiments, the focus switching event shares one or more characteristics with the event described with reference to method 1000. In some embodiments, terminating the text entry field 932 at the first user interface region 904 includes ceasing the display of the virtual keyboard 933, and ceasing display of the cursor element 946 in the text field 932, as shown in FIG. 9R.

Additionally or alternatively, instead of terminating the input session, computer system 101 pauses the input session in response to detecting an input focus switching event as illustrated in the example of FIG. 9S. In the example of FIG. 9S, in response to detecting a focus-switching event including input indicating attention 912 directed to the sixth user interface region 930 (illustrated in FIG. 9Q), and input corresponding to actuation of button 922 of controller 901 (illustrated in FIG. 9Q), computer system 101 pauses the active input session at text entry field 932 in first user interface 904. In some embodiments, pausing the active input session at text entry field 932 includes visually deemphasizing (but optionally maintaining at least partial display of) the virtual keyboard 933, and ceasing display of the cursor element in the text field of the text entry field 932, as shown in FIG. 9S.

In some embodiments, in response to detecting a focus switching event (e.g., including input corresponding to attention 912 directed at user interface 904 and input corresponding to actuation of button 922) causing the input focus 940 and the controller device focus 942 to switch back to the user interface 904 (e.g., that includes the paused input session), computer system 101 resumes the input session 932 as illustrated in FIG. 9U. In some embodiments, the one or more operations are performed based on the input shown in FIG. 9T to resume the input session 932 at the user interface 904 include operations to visually re-emphasize the virtual keyboard 933, as shown in FIG. 9U.

As shown in FIG. 9U, the computer system 101 detects input corresponding to actuation of button 922 while the attention 912 is directed to the first user interface region 904 and while the sixth user interface region 930 has input focus 940 and controller device focus 942, as shown in FIG. 9T. In some embodiments, in response to detecting the input in FIG. 9T, the computer system performs one or more operations to resume the input session (e.g., corresponding to text entry field 932) at the first user interface region 904, including displaying the cursor element 948 in the text field of the text entry field 932 while displaying the virtual keyboard 933 such that the virtual keyboard 933 is not visually deemphasized, as shown in FIG. 9U.

FIG. 10 is a flowchart illustrating a method of performing one or more operations on virtual content items based on input focus at a computer system, in accordance with some embodiments of the disclosure. In some embodiments, the method 1000 is performed at a computer system (e.g., computer system 101 in FIG. 1A such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 1000 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1000 are, optionally, combined and/or the order of some operations is, optionally, changed.

In some embodiments, the method 1000 is performed at a computer system (e.g., 101) in communication with one or more display generation components (e.g., 120) and one or more input devices (e.g., one or more internal image sensor(s) 114a, one or more external image sensor(s) 114b and 114c, and controller 901). The computer system optionally shares one or more characteristics of the computer systems described with respect to methods 800, 1200, 1400, or 1600. The one or more display generation components optionally share one or more characteristics of the one or more display generation components described with respect to methods 800, 1200, 1400, or 1600. The one or more input devices optionally share one or more characteristics of the input devices described with respect to methods 800, 1200, 1400, or 1600.

In some embodiments, while displaying, via the one or more display generation components, virtual content in a three-dimensional environment (e.g., 900), including a first user interface region (e.g., 904) and a second user interface region (e.g., 906), the computer system detects (1002), via the one or more input devices (e.g., one or more remote body tracking devices such as cameras, motion sensors, proximity sensors or depth sensors), a first input, such as input 921a (e.g., directional input corresponding to a directional control signal indicating an upwards direction) from controller 901, as shown in FIG. 9A. In some embodiments, the three-dimensional environment at least partially incorporates a representation of the real-world physical environment of the user while using the computer system (e.g., via active or passive passthrough). In some embodiments, the three-dimensional environment is an extended reality (XR) environment, such as a virtual reality (VR) environment, a mixed reality (MR) environment, or an augmented reality (AR) environment. Examples of the one or more virtual objects include, but are not limited to, content windows (e.g., virtual content windows or application windows), graphical user interfaces, or objects that are not part of a physical real-world environment that is visible via the one or more display generation components. In some embodiments, the first and second user interface regions are separate virtual content windows or separate regions of the same virtual content window. In some embodiments, a virtual content window is a region corresponding to a graphical user interface of the computer system or an application in and at which the computer system receives input from the user (e.g., user input) or provides output to the user. In some embodiments, the virtual content window is configurable (e.g., in size or position) and defined (e.g., designated as a region from which to accept input or provide output) based on user input. In some embodiments, the virtual content in the three-dimensional environment includes one or more virtual objects/content that are displayed by the computer system when the first input is detected. Examples of the first input include, but are not limited to air gestures, controller inputs (e.g., thumb stick movements, or button presses), touch inputs on a touchpad, or the like. In some embodiments, the first input includes one or more air gestures such as an air pinch and release gesture; an air pinch and drag gesture; an air pinch, drag, and release gesture; and the like. In some embodiments, detecting the first input includes receiving or otherwise detecting, via the one or more input devices, controller input (e.g., thumbstick movements or button presses) from a controller. In some embodiments, the one or more input devices includes a controller such as a hardware controller (e.g., gamepad) including a directional control mechanism (e.g., joystick, thumbstick, or lever connected to pivot) configured to be actuated by the user in one or more directions. For instance, the controller is configured to generate analog or discrete data (e.g., for input to the computer system) corresponding to actuation of the directional control mechanism, including displacement or movement of the directional control mechanism (e.g., from an initial zero-input position) corresponding to a direction and extent of displacement associated with the actuation of the directional hardware control mechanism. For instance, directional control mechanism includes a joystick/thumb stick that is configured to be actuated (e.g., pivoted, displaced, or otherwise moved) by the thumb of the user (or other finger) in a desired direction (e.g., up, down, left, or right), to thereby indicate not only the user's desire for the computer system to perform an operation in association with the first input, but also the direction of the desired operation to be performed, as well as the extent or magnitude to which the desired operation is to be performed. In some embodiments, the first input shares one or more characteristics with the first input described with reference to method 800, above. In some embodiments, the one or more input devices include a controller such as a hardware controller including a discrete input mechanism (e.g., button), a continuous input mechanism (e.g., trigger), or the like. For instance, the controller is configured to generate analog (e.g., in the case of a trigger input mechanism) or discrete (e.g., in the case of a button input mechanism) data indicating actuation of the respective input mechanism. Additionally or alternatively, the analog or discrete data is generated to indicate an extent or magnitude (e.g., corresponding to a duration of an input from the discrete input mechanism, a magnitude of displacement associated with an input from the continuous input mechanism). In some embodiments, the controller shares one or more characteristics with the directional hardware control of the controller device as described with respect to method 800.

In some embodiments, in response to detecting (1004) the first input, in accordance with a determination that attention (e.g., based on a gaze or a substitute for gaze such as a point of focus) of the user was directed to the first user interface region when the first input was detected, and that the first user interface region has a current input focus at the computer system, the computer system performs (1006) a first operation corresponding to the first input in the first user interface region, such as in response to detecting attention 912 of the user coincide with a position of the first user interface region 904 when the first input 921a was detected while the first user interface region 904 had input focus 940 and controller input focus 942, as shown in FIG. 9A, the computer system 101 performs a scroll operation in connection with the first user interface region 904, as shown in FIG. 9B (e.g., without regard to whether or not the first input satisfies the one or more respective interaction criteria, and optionally not performing an operation in the second user interface region). In some embodiments, the first input is received before detecting an attention of the user. In some embodiments, the first input is received while detecting the attention of the user. In some embodiments, the first input is received after detecting the attention of the user. In some embodiments, the computer system determines that the attention of the user is directed to the first user interface region when eye tracking data indicates the attention is directed to a location in proximity with a position of the first user interface region (e.g., within 0.05, 0.1, 1, 10, 100, or 1000 mm) for more than a predetermined threshold of time (e.g., 0.01, 0.02, 0.05, 0.1 s, 1 s, or 5 s.). In some embodiments, the input focus at the computer system corresponds to a characteristic of a virtual object by which the virtual object is emphasized, active, or otherwise designated to receive operations or inputs (also referred to herein as an active virtual object) from the user. For example, the first input optionally includes an input received at the computer system from an input device such as a controller. In some embodiments, the input focus at the computer system is determined in response to detecting a focus switching event in connection with a virtual object. For example, a focus switching event includes an event in which the input focus of the computer system transitions between virtual objects, such as between the first user interface region and the second user interface region. In some embodiments, in response to detecting a focus switching event in connection with a virtual object, the virtual object is thereby designated as having input focus (and otherwise becomes an active virtual object). In some embodiments, a particular virtual object or region retains input focus until a subsequent focus switching event is detected or otherwise occurs. For example, while a first virtual object such as the first user interface region has current input focus, and in response to detecting a subsequent focus switching event in connection with a second virtual object such as the second user interface region, the designation or characteristic of current input focus changes from the first virtual object and to the second virtual object, or is otherwise withdrawn from the first virtual object and associated with the second virtual object, which then retains the current input focus until yet another subsequent focus switching event is detected or otherwise occurs. In some embodiments, a focus switching event is triggered in response to user input (e.g., input corresponding to selection of a virtual object) received in connection with or directed to a virtual object such as the first user interface region, the second user interface region, or the like. In some embodiments, detecting the focus switching event includes detecting a predetermined input directed to the virtual object. In some embodiments, the predetermined input is defined by or selected at the computer system or an application associated with the first user interface region or the second user interface region. In some embodiments, the predetermined input includes input corresponding to a predetermined input gesture (e.g., a touchless input gesture such as an air pinch) or input corresponding to a predetermined controller input (e.g., detecting a “select” input from a controller). For example, if the computer system detects an input corresponding to a predetermined input gesture such as an “air pinch” gesture directed to a virtual object such as the first user interface region, the computer system designates, based on the predetermined input, the first user interface region as having input focus (e.g., such that subsequently received inputs are directed to the first user interface region) and subsequently performs operations at the first user interface region (or at a software application associated with the first user interface region) based on subsequently received inputs. As another example, if the computer system detects an input corresponding to a predetermined controller input such as a discrete input (e.g., a selection input such as a button press or a trackpad click) directed to a virtual object such as the first user interface region, the computer system designates, based on the predetermined input, the first user interface region as having input focus (e.g., such that subsequently received inputs are directed to the first user interface region) and subsequently performs operations at the first user interface region (or at a software application associated with the first user interface region) based on subsequently received inputs. Additionally or alternatively, detecting the focus switching event includes detecting the predetermined input in connection with a determination that an attention of the user is directed to a virtual object such as the first user interface region or the second user interface region). In some embodiments, the operations include a first operation, including an operation performed in or otherwise directed to a virtual object that currently has input focus. In some embodiments, the first operation includes a scroll operation, a zoom operation, a text entry operation, a navigation operation, a selection operation (e.g., selection of a button in the first user interface region), or the like. In some embodiments, the first operation is performed based on input corresponding to controller input (e.g., “select”), or the like. For example, in some embodiments, the computer system performs an operation such as the first operation in the first user interface region, including a scroll operation that is performed based on first input corresponding to a directional hardware control input from a controller device (e.g., corresponding to actuation of a joystick in an upwards direction) while the first user interface region has current input focus such that the first operation is performed to affect scrolling of the first user interface region in a direction (e.g., an upwards direction) corresponding to the first input in response to detecting or otherwise receiving the first input. As another example, in some embodiments, the computer system performs an operation such as the first operation in the first user interface region, including a drag operation that is performed based on first input corresponding to an air pinch and drag gesture (e.g., corresponding to selection of a virtual object in which the selection is held for more than a predetermined threshold and an initial position and subsequent position of the virtual object is different) while the first user interface region has current input focus such that the first operation is performed to affect selection and dragging of a portion of the first user interface region in a manner corresponding to the first input corresponding to the air pinch and drag gesture in response to receiving the first input.

In some embodiments, in response to detecting (1004) the first input, in accordance with a determination that the attention (e.g., based on a gaze or a substitute for gaze) of the user was directed to the second user interface region when the first input was detected, the second user interface region does not have the current input focus at the computer system, and the first input satisfies one or more criteria (e.g., one or more respective interaction criteria), the computer system 101 performs (1008) a second operation corresponding to the first input in the second user interface region, such as in response to detecting attention 912 of the user coincided with a position of the second user interface region 906 when the first input 921b was detected while the second user interface region 906 did not have input focus 940 and/or controller input focus 942, as shown in FIG. 9C, the computer system 101 performs a scroll operation in connection with the second user interface region 904, as shown in FIG. 9D (and optionally not performing an operation in the first user interface region).

In some embodiments, the first operation is performed independent of whether the one or more criteria are satisfied, such as in the case of the second operation, as described below. In some embodiments, when the computer system determines that the first input satisfies one or more criteria (also referred to as “interaction criteria”), and further determines that an attention of the user is or was (e.g., within a predetermined threshold amount of time) directed to the inactive virtual object when the first input was detected, the computer system performs operations such as the second operation in connection with an inactive virtual object (e.g., the second user interface region) that does not have current input focus at the computer system. In some embodiments, the first operation or the second operation is performed based on the first input. In some embodiments, the second operation includes an operation such as the first operation (e.g., the second operation includes a scroll operation, a zoom operation, a text entry operation, a navigation operation, a selection operation such as in controller input corresponding to “select”, or the like). In some embodiments, the first operation and the second operation are different and are performed based on the first input because the current input focus at the computer system is designating the first user interface region as being active and the second user interface region as being inactive, or vice-versa. In some embodiments, the first operation and the second operation are different and are performed based on the first input because a content type associated with the first user interface region and the second user interface region are different. For example, in some embodiments, when the computer system determines that the first user interface region includes content of a first content type (e.g., including scrollable content), the computer system performs the first operation in the first user interface region based on the first input. As another example, in some embodiments, when the computer system determines that the second user interface region includes content of a second content type, different from the first type (e.g., draggable content without scrolling underlying content), the computer system performs the second operation in the second user interface region based on the first input.

In some embodiments, in response to detecting (1004) the first input, in accordance with a determination that the attention (e.g., based on a gaze or a substitute for gaze) of the user was directed to the second user interface region, and the first input does not satisfy the one or more criteria (e.g., one or more respective interaction criteria), the computer system forgoes (1010) performing the second operation (and/or any operation) based on the first input in the second user interface region, such as in response to detecting attention 912 of the user coincided with a position of the second user interface region 906 when the first input 921e was detected while the first user interface region 904 had input focus 940 and controller input focus 942, and the second user interface region 906 was visually deemphasized, as shown in FIG. 9H, the computer system 101 forgoes performing a scroll operation, as shown in FIG. 9I.

In some embodiments, the one or more criteria include a criterion that is satisfied based on the first input being of a predetermined type, such as when the first input includes input corresponding to controller input, input including a gesture, or the like. In some embodiments, the one or more criteria include a criterion that is satisfied in response to determining that the attention of the user is directed to the inactive virtual object (e.g., corresponding to the first user interface region) for more than a predetermined threshold of time (e.g., 0.1 s, 1 s, or 5 s) or within a predetermined threshold amount of time of having received the first input (e.g., 0.1 s, 1 s, or 5 s.). In some embodiments, the first user interface region includes a virtual content window of a first type associated with an interactive media application such as a video game application. In some embodiments, the second user interface region includes a virtual content window of a second type associated with a browser such as a web browser, a system browser, or the like. For instance, the computer system performs a subset of operations in the second user interface region when the first user interface region has input focus (e.g., a subset of, and not all of, the operations that would be available if the second user interface region had the current input focus when the first input was received). Performing operations in different user interface regions based on attention, input focus or whether the input satisfies criteria enables operations to be dynamically performed with respect to virtual content that does not have the current input focus (optionally without moving the input focus to that virtual content) while also avoiding erroneous inputs directed to the virtual content that does not have the current input focus, thereby facilitating dynamic and accurate determination as to the intended operation to be performed, minimizing input errors, and providing for more efficient user interaction with the computer system.

In some embodiments, the one or more criteria comprises a criterion that is satisfied when the first input is initiated after the attention of the user has moved to the second user interface region, such as when the attention 912 of the user was shifted to the position of the second user interface region 906, as shown in FIG. 9B, before input 921b was detected before the first input 921b was detected, as shown in FIG. 9C, causing the computer system 101 to scroll the second user interface region 906, as shown in FIG. 9D. In some embodiments, the one or more criteria include a criterion that is satisfied when the first input is initiated or otherwise received after the computer system detects that the attention of the user has moved to the second user interface region. For example, in some embodiments, the one or more criteria include a criterion that is not satisfied when the first input is initiated or otherwise received before the computer system detects that the attention of the user has moved to the second user interface region. In some embodiments, the one or more criteria include a criterion that is satisfied when the first input is initiated or otherwise received after the computer system detects that the attention of the user has moved to the second user interface region while the first user interface region has input focus. In some embodiments, the computer system determines that the first input was initiated after the attention of the user has moved to the second user interface region in response to receiving the first input after a predetermined time threshold of having detected the attention of the user at the second user interface region. For example, in some embodiments, the predetermined time threshold corresponds to a time period of approximately 0.05 s, 0.1 s, 0.2 s, 0.5 s, 1 s, 2 s, or 5 s. In some embodiments, the predetermined time threshold is measured from the point in time at which the computer system detects that the attention of the user has moved to the second user interface region. In some embodiments, the predetermined time threshold is measured, with a delay, from the point in time at which the computer system detects that the attention of the user has moved to the second user interface region. For example, in some embodiments, the delay corresponds to a time period of approximately 1 s, or the like. In some embodiments, when the first input satisfies the one or more criteria, and the computer system determines that the attention of the user was directed to the second user interface region when the first input was detected, and the computer system performs a second operation corresponding to the first input in the second user interface region. For example, in some embodiments, the second operation includes scrolling the second user interface region based on the first input, moving the second user interface region based on the first input, or the like. Performing operations in different user interface regions based on determinations of user attention and determinations of when inputs were applied with respect to the determinations of user attention facilitates dynamic and accurate determination as to the intended operation to be performed, minimizing input errors, and providing for more efficient user interaction with the computer system.

In some embodiments, the one or more criteria comprise a criterion that is satisfied when the second user interface region is not visually deemphasized (e.g., relative to the first user interface region and/or relative to the three-dimensional environment), such as when the second user interface region 906 is not visually deemphasized, as shown in FIGS. 9C-9D. In some embodiments, the one or more criteria is satisfied when it is determined that the attention of the user was directed to the second user interface region and it is also determined that the second user interface region is not visually deemphasized when the first input is received. As used herein, a virtual object such as a user interface region that is not visually deemphasized refers to a virtual object that is not displayed in a minimized or otherwise reduced visibility state. For example, in some embodiments, a virtual object such as the second user interface region is not visually deemphasized when it is not displayed in a minimized state or with otherwise reduced visibility, such as in being displayed with a predetermined, reduced level of prominence, contrast, or opacity, being displayed out of alignment, at reduced scale, without an animation, or the like (e.g., relative to other virtual objects). Additionally or alternatively, in some embodiments, displaying a virtual object (e.g., the second user interface region) with visual deemphasis includes displaying the virtual object with a reduced level of opacity, brightness, distortion, focus, contrast, color, and/or the like. Performing operations with respect to one or more virtual objects from a plurality of virtual objects under conditions in which one or more criteria are satisfied when the one or more virtual objects are not visually deemphasized, improves the user experience by limiting or otherwise guiding the user's attention to the one or more virtual objects to which inputs are being applied, enabling contextual presentation of the one or more virtual objects, thereby reducing power requirements, enhancing user engagement, minimizing input, and providing for more efficient user interaction with the computer system.

In some embodiments, the second user interface region is visually deemphasized (e.g., relative to the first user interface region and/or relative to the three-dimensional environment) in accordance with a determination that one or more respective criteria are satisfied, including a criterion that is satisfied when the second user interface region has a first focus order, and an object (e.g., a physical or virtual object) visible in the three-dimensional environment has a second focus order, higher than the first focus order, and the second user interface region is in spatial conflict with the object (optionally from the viewpoint of the user), such as when the second user interface region 906 is visually deemphasized when the computer system determines that the second user interface region 906 is in spatial conflict with the first user interface region 904 in response to determining that a measure of overlap between the second user interface region 906 and the first user interface region 904 exceeds a predetermined overlap threshold 925, and the second user interface region 906 is spatially positioned at a first distance from a viewpoint of the user and the first user interface region 904 is spatially positioned at a second distance, less than the first distance, from the viewpoint of the user, as shown in FIG. 9F.

In some embodiments, for one or more virtual objects from a plurality of virtual objects in the three-dimensional environment such as the second user interface region and an object (e.g., a virtual object), the computer system indicates relative focus order of the second user interface region relative to the object by visually deemphasizing the second user interface region or the object. For example, in some embodiments, when the computer system determines that the second user interface region has a first focus order and an object displayed in the three-dimensional environment has a second focus order, higher than the first focus order, and the second user interface region at least partially coincides, corresponds, overlaps, or is otherwise in spatial conflict with the object (optionally from the viewpoint of the user), the computer system visually deemphasizes the second user interface region to indicate the relative focus order of the virtual objects. Additionally or alternatively, in some embodiments, for one or more virtual objects from a plurality of virtual objects in the three-dimensional environment such as the first user interface region and an object (e.g., a virtual object), the computer system indicates relative focus order of the second user interface region relative to the object by visually deemphasizing the first user interface region or the object. For example, in some embodiments, when the computer system determines that the first user interface region has a first focus order and an object displayed in the three-dimensional environment has a second focus order, higher than the first focus order, and the first user interface region at least partially coincides, corresponds, overlaps, or is otherwise in spatial conflict with the object (optionally from the viewpoint of the user), the computer system visually deemphasizes the first user interface region to indicate the relative focus order of the virtual objects.

In some embodiments, determining focus order of one or more virtual objects, such as the second user interface region and the object, from a plurality of virtual objects in the three-dimensional environment, includes determining an order or sequence in which the one or more virtual were most recently interacted with, based on input. For example, in some embodiments, determining the focus order for one or more virtual objects such as the second user interface region and the object, in which the second user interface was interacted with at a first time and the object was interacted with at a second time, in which the second time is more recent than the first time, includes determining that the focus order of the second user interface region is a first focus order and the focus order of the object is a second focus order, higher than the first focus order.

In some embodiments, determining focus order of one or more virtual objects, such as the second user interface region and the object, from a plurality of virtual objects in the three-dimensional environment, includes determining a relative spatial arrangement of the one or more virtual objects (including indications as to relative depth of the one or more virtual objects from a viewpoint of the user in the three-dimensional environment) based on characteristics (also referred to as “virtual object characteristics”) of the one or more virtual objects, respectively. For example, in some embodiments, the spatial arrangement of the second user interface in the three-dimensional environment is determined based on first virtual object characteristics indicating a position of the second user interface in the three-dimensional environment and the spatial arrangement of the object in the three-dimensional environment is determined based on second virtual object characteristics, different from the first virtual object characteristics, indicating a position of the object in the three-dimensional environment. In some embodiments, the spatial arrangement of the second user interface and the object in the three-dimensional environment, relative to a position and/or orientation of a viewpoint of the user in the three-dimensional environment, is determined based on the first virtual object characteristics, the second virtual object characteristics, and the position and/or the orientation of the viewpoint of the user.

In some embodiments, the computer system detects spatial conflicts between virtual objects, including determining the relative positions or occupied space of the virtual objects, respectively in the three-dimensional environment. In some embodiments, the computer system detects spatial conflicts between virtual objects, including determining the relative positions or occupied space of the virtual objects, relative to the position and/or the orientation of the viewpoint of the user in the three-dimensional environment. For example, in some embodiments, when the user is located at a first position and/or orientation in the three-dimensional environment such that the user has a first viewpoint of the spatial arrangement of the second user interface and the object in the three-dimensional environment, the computer detects a spatial conflict between the second user interface and the object in the three-dimensional environment. As another example, in some embodiments, when the user is located at a second position and/or orientation, different from the first position and/or orientation, in the three-dimensional environment, such that the user has a second viewpoint, different from the first viewpoint, of the spatial arrangement of the second user interface and the object in the three-dimensional environment, the computer does not detect a spatial conflict between the second user interface and the object in the three-dimensional environment. Additionally or alternatively, the virtual object characteristics optionally include characteristics indicating previous focus order, including historical focus order in which the one or more virtual objects were previously (e.g., within a predetermined time threshold) respectively emphasized, active, or otherwise designated, relative to each other, to receive operations or inputs from the user.

For example, in some embodiments, for virtual objects in spatial conflict, such as when the second user interface region that has a first focus order and a virtual object that has a second focus order, higher than the first focus order, are in spatial conflict, the virtual object with the higher focus order receives input focus instead of the virtual object (e.g., the second user interface region) with lower focus order receiving input focus. For example, in some embodiments, the computer system visually deemphasizes the second user interface region in response to determining the second user interface region has a first focus order, and an object (e.g., a virtual object) displayed in the three-dimensional environment has a second focus order, wherein the second focus order is higher than the first focus order, and wherein the second user interface region is in spatial conflict with the object. Visually deemphasizing virtual objects based on a focus order hierarchy that is determined in accordance with predefined criteria facilitates operation of the computer system by enabling more intuitive feedback based on user input, thereby facilitating dynamic and accurate determination as to the intended operation to be performed, minimizing input errors, and providing for more efficient user interaction with the computer system. Moreover, displaying virtual objects in spatial conflict based on relative spatial arrangement and the user's viewpoint facilitates greater realism and emersion while also improving intuitive operation of the computer system, further improving dynamic and accurate determination as to the intended operation to be performed, minimizing input errors, and providing for more efficient user interaction with the computer system.

In some embodiments, the second user interface region is in spatial conflict with the object displayed in the three-dimensional environment when the second user interface region overlaps the object by more than an overlap threshold amount from a viewpoint of the user (and optionally when the second user interface region is farther away from the viewpoint of the user than the object displayed in the three-dimensional environment or optionally when the object is farther away from the viewpoint of the user than the second user interface region), such as when the computer system 101 determines that the second user interface region 906 is in spatial conflict with the first user interface region 904 in accordance with a determination that a measure of overlap between the second user interface region 906 and the first user interface region 904 exceeds the predetermined overlap threshold 925, as shown in FIGS. 9F-9G.

In some embodiments, detecting a spatial conflict of or between virtual objects in the three-dimensional environment includes determining that a ratio corresponding to an extent of an overlap (also referred to as “overlap ratio”) of a first space or volume of a first virtual object (e.g., the second user interface region) by a second space or volume of a second virtual object (e.g., the object) exceeds a predetermined threshold (also referred to as “predetermined threshold overlap” or “predetermined threshold overlap amount”). In some embodiments, the value of the overlap ratio represents the proportion (as a percentage) of the first virtual object that is overlapped by the second virtual object. In some embodiments, the predetermined threshold overlap amount is selected or defined to correspond to 0.5%, 1%, 5%, 10%, 15%, 20%, or the like. For example, in some embodiments, if the predetermined threshold overlap amount is selected to correspond to 10%, the spatial conflict between virtual objects such as the second user interface region and the object is detected when the computer system determines the extent of the overlap of the second user interface region by the object exceeds 10%. As another example, in some embodiments, if the predetermined threshold overlap amount is selected to correspond to 5%, the spatial conflict between virtual objects such as the second user interface region and the object is optionally detected when the computer system determines a value of the overlap ratio corresponding to the extent of the overlap between the second user interface region and the object exceeds 5%. In some embodiments, if the overlap ratio is determined not to exceed the predetermined threshold overlap, no spatial conflict is detected.

In some embodiments, determining that the overlap ratio corresponding to the extent of the overlap ratio of the first space or volume of the first virtual object by the second space or volume of the second virtual object (e.g., the object) exceeds the predetermined threshold includes determining the spatial arrangement of the second user interface and the object in the three-dimensional environment, relative to a position and/or orientation of a viewpoint of the user in the three-dimensional environment, based on the first virtual object characteristics, the second virtual object characteristics, and the position and/or the orientation of the viewpoint of the user. For example, in some embodiments, when the user is located at the first position and/or orientation in the three-dimensional environment, determining the overlap ratio includes determining a first overlap ratio based on the first virtual object characteristics, the second virtual object characteristics, and the first position and/or the orientation of the viewpoint of the user. As another example, in some embodiments, when the user is located at the second position and/or orientation in the three-dimensional environment, determining the overlap ratio includes determining a second overlap ratio, different from the first overlap ratio, based on the first virtual object characteristics, the second virtual object characteristics, and the second position and/or the orientation of the viewpoint of the user.

In some embodiments, when the second user interface region has a first focus order and the object displayed in the three-dimensional environment has a second focus order, higher than the first focus order, and the second user interface region is in spatial conflict with the object, the computer system visually deemphasizes the second user interface region to indicate the relative focus order of the virtual objects by presenting the second user interface region at a first depth and presenting the object at a second depth, lesser than the first depth. For example, in some embodiments, the computer system visually deemphasizes the second user interface region by presenting the second user interface region at a greater depth (e.g., the first depth) relative to the depth (e.g., the second depth) at which the object is displayed. Visually emphasizing and visually deemphasizing virtual objects to indicate focus order based on spatial conflicts between virtual objects improves the user interface by reducing clutter and directing the user's focus thereby facilitating dynamic and accurate determination as to the intended operation to be performed, minimizing input errors, and providing for more efficient user interaction with the computer system.

In some embodiments, in response to detecting the first input (e.g., 921d), the first operation is performed in the first user interface region (e.g., 904) that has a first focus order, such as when the computer system 101 scrolls the content of the first user interface region 904 vertically, as shown in FIG. 9G, in response to detecting the first input 921d, as shown in FIG. 9F. In some embodiments, the second user interface region has a second focus order, the first focus order is higher than the second focus order, and the first user interface region spatially conflicts with the second user interface region, such as when the second user interface region 906 is in spatial conflict with the first user interface region 904, as shown in FIGS. 9F-9G. In some embodiments, the computer system determines relative focus order for one or more virtual objects from a plurality of virtual objects in the three-dimensional environment, such as for the first user interface region and the second user interface region, to facilitate the user's navigation through the computer system, as well as the user's interactions with the one or more virtual objects in the three-dimensional environment. In some embodiments, determining the relative focus order and/or determination of spatial conflict shares one or more characteristics of the focus order and/or spatial conflict described above. In some embodiments, the focus order of the user interface regions is based on an order in which the user has been determined to interact with a particular user interface regions such that higher focus order user interfaces correspond to user interfaces that were most recently interacted with by the user. In some embodiments, when two user interfaces are in spatial conflict with one another, the computer system uses focus order to determine which user interface to perform an operation on in response to a user input on the directional input of the controller. In some embodiments, the computer system indicates input focus in connection with the first user interface region in response to determining the first user interface region is in spatial conflict with the second user interface region (e.g., in response to determining the first position and the second position at least partially correspond in the three-dimensional environment), when the computer system determines that the first user interface region has a first focus order and the second user interface region has a second focus order, in which the first focus order is higher than the second focus order. Performing operations in different user interface regions based on relative focus order of virtual objects in a three-dimensional environment, improves the user interface by reducing clutter and directing the user's focus to thereby facilitating dynamic and accurate determination as to the intended operation to be performed, minimizing input errors, and providing for more efficient user interaction with the computer system.

In some embodiments, the one or more criteria include a criterion that the first input is a continuous input, such as when the input 921e is received from controller 901 and corresponds to actuation of a continuous input mechanism of a hardware controller, such as in actuation of thumbstick 920 of controller 901a, as shown in FIG. 9H. In some embodiments, the one or more criteria include a criterion that is satisfied in response to determining that the first input includes input corresponding to analog or otherwise continuous input. Additionally or alternatively, in some embodiments, the one or more criteria include a criterion that is not satisfied in response to determining that the first input includes input corresponding to discrete input. In some embodiments, the discrete input shares one or more characteristics of the input described with respect the input described in further detail below and includes but is not limited to detecting buttons being pushed on a controller device. In some embodiments, the continuous input shares one or more characteristics of the input described with respect to method 800, above. For example, in some embodiments, the continuous input corresponds to spatial movement associated with an air gesture. Additionally or alternatively, in some embodiments, the continuous input corresponds to input received from a hardware controller via a trackpad, or the like (also referred to as “trackpad input”). For example, in some embodiments, the continuous input corresponds to continuous trackpad input representing the continuous motion of input received at the trackpad from a user, such as in scrolling inputs, and the like. Additionally or alternatively, in some embodiments, the first input is a continuous input corresponding to actuation of a continuous input mechanism of a hardware controller, such as in actuation of a trigger or displacement of a thumbstick or d-pad of the hardware controller, and the like. Performing operations with respect to one or more virtual objects based on input type improves the user experience and increases user engagement by enabling finer and more dynamic control over the user interface and the virtual objects in the user interface, via specific, input-based control over the one or more virtual objects, thereby avoiding erroneous inputs directed to the virtual content that does not have the current input focus, thereby facilitating dynamic and accurate determination as to the intended operation to be performed, minimizing input errors, and providing for more efficient user interaction with the computer system.

In some embodiments, the first user interface region has the current input focus when the first input is detected, such as when the first user interface region 904 has input focus 940 and controller input focus 942 when input 921e is detected, as shown in FIG. 9H. In some embodiments, in response to detecting the first input, in accordance with a determination that the attention of the user was directed to the second user interface region when the first input was detected, and that the first input is a discrete input of a first type, the computer system moves the current input focus from the first user interface region to the second user interface region, such as in response to detecting attention 912 of the user coincides with a position of the second user interface region 906 when input corresponding to actuation of button 922 was detected while the first user interface region 904 had input focus 940 and controller input focus 942, as shown in FIG. 9I, causing the computer system 101 to move the input focus 940 and controller input focus 942 from the first user interface region 904 and to the second user interface region 906, as shown in FIG. 9J. In some embodiments, in response to detecting the first input, in accordance with a determination that the attention of the user was directed to the second user interface region when the first input was detected, and that one or more respective criteria are satisfied, including a criterion that is satisfied when the first input is a discrete input of a second type, different from the first type, the computer system forgoes moving the current input focus from the first user interface region to the second user interface region, such as in response to detecting attention 912 of the user coincides with a position of the second user interface region 906 when the input corresponding to actuation of button 924c was detected while the first user interface region 904 had input focus 940 and controller input focus 942, in which the input corresponding to the actuation of button 924c is a discrete input of a second type, different from the input of the first type (e.g., input corresponding to actuation of button 922), the computer system 101 forgoes moving the input focus 940 and controller input focus 942 from the first user interface region 904 and to the second user interface region 906, as shown in FIGS. 9M-9N. In some embodiments, the one or more criteria include a criterion that is satisfied in response to determining that the first input includes input corresponding to non-continuous or otherwise discrete input of a first type. In some embodiments, the discrete input of the first type shares one or more characteristics of the input described with respect to method 800, above. In some embodiments, the discrete input of the first type includes input associated with a first button on a controller, while the second type includes inputs associated with a second button, different from the first button on the controller. For example, in some embodiments, the first button includes a start button, a select button, and/or the like. Additionally or alternatively, in some embodiments, the second button includes a different button, such as a button that is not a start button, a select button, and/or the like.

In some embodiments, when the computer system detects the first input and determines that the first input includes input corresponding to the discrete input of the first type, and while the first user interface region has input focus, the computer system moves the input focus from the first user interface region and to the second user interface region based on the first input. In some embodiments, when the computer system detects the first input and determines that the first input includes input corresponding to the discrete input of the second type (e.g. a different button input), the computer system performs an operation on the second user interface region without moving the input focus to the second user interface region.

In some embodiments, the one or more criteria include a criterion that is satisfied in response to determining that the first input includes input corresponding to a non-continuous or otherwise discrete input of a second type. In some embodiments, the non-continuous or otherwise discrete input of the second type includes input corresponding to the discrete input of the first type, as described above. In some embodiments, the non-continuous or otherwise discrete input of the second type includes input different from the first type. In some embodiments, the discrete input of the second type shares one or more characteristics of the input described with respect to method 800, above. In some embodiments, the discrete input of the second type includes input associated with a command or instruction of a second type, different from the first type. For example, in some embodiments, the command or instruction of the second type includes a command for performing a local operation, such as to execute an operation in an application that currently has input focus, navigate within a menu of an application that currently has input focus (e.g., to scroll through or select from one or more selectable items in the menu), to access a different part of an application that currently has input focus, or the like. For example, in some embodiments, the discrete input of the second type includes input corresponding to a discrete data signal, command, or instruction associated with a button press, a key press, a trackpad click, a mouse click, or the like, or the like. Examples of the discrete input of the second type optionally include input associated with pressing or actuating a button or control mechanism of a directional pad, pressing or actuating a face button of a gamepad, pressing or actuating a shoulder button, pressing or actuating a touchpad or motion sensor, or the like. Other examples of the discrete input of the second type optionally include the discrete input of the first type, as described above. In some embodiments, when the computer system detects the first input and determines that the first input includes input corresponding to the discrete input of the second type, and while the first user interface region has input focus, the computer system moves the input focus from the first user interface region and to the second user interface region based on the first input.

Performing operations in accordance with determinations as to whether the input is of a first type or a second type facilitate dynamic interactions between the user and the computer system that support multitasking across one or more virtual objects effectively simultaneously, while also avoiding erroneous inputs directed to the virtual content that does not have the current input focus by limiting the input required to transition input focus to inputs of predetermined types (e.g., as in the first type and the second type of input) to specific buttons, thereby facilitating dynamic and accurate determination as to the intended operation to be performed, minimizing input errors, and providing for more efficient user interaction with the computer system.

In some embodiments, the one or more respective criteria include a criterion that is not satisfied when the second user interface region is a first type of user interface region, and satisfied when the second user interface region is a second type of user interface region, different from the first type of user interface region, such as when the second user interface region 907 is an interactive, multimedia application (e.g., a video game application), as shown in FIGS. 9K-9L, and when the second user interface region 907 is not an interactive, multimedia application (e.g., not a video game application), as shown in FIGS. 9M-9N. In some embodiments, in response to detecting the first input, in accordance with the determination that the first input is a discrete input of the second type, and that the one or more respective criteria are not satisfied because the second user interface region is the first type of user interface region, the computer system (e.g., 101) moves the current input focus to the second user interface region, such as in response to detecting input corresponding to actuation of button 924c when the second user interface region 907 is an interactive, multimedia application (e.g., a video game application), as shown in FIGS. 9K-9L. In some embodiments, when the computer system determines the first input includes input corresponding to the discrete input of the second type, and determines that the second user interface region is a first type of user interface region, the computer system moves the input focus from the first user interface region and to the second user interface region based on the first input. In some embodiments, the first type of user interface region includes a user interface region associated with an interactive, multimedia application (e.g., a video game application). Additionally or alternatively, in some embodiments, in response to detecting the first input, in accordance with a determination that the computer system determines the first input includes input corresponding to the discrete input of the second type, and that the second user interface region is a second type of user interface region, different from the first type of user interface region, the computer system forgoes moving the input focus from the first user interface region and to the second user interface region based on the first input. In some embodiments, the second type of user interface region includes a user interface region associated with a system application, a system utility application, and the like (e.g., a non-game application). In some embodiments, the one or more criteria include a criterion that is satisfied when the first user interface region and the second user interface region are of a first type of user interface region. Additionally or alternatively, in some embodiments, the one or more criteria include a criterion that is satisfied when the first user interface region is of the first type of user interface region and the second user interface region is of a second type, different from the first type of user interface region. Additionally or alternatively, in some embodiments, the second type of user interface region includes any virtual object, such as a user interface region associated with any application that is different from the first type of user interface region (e.g., a web browser, a system window, a menu button, a tile, a control panel, a dialog box, a system tray, or a taskbar), or the like. Moving input focus to one or more user interface regions based on an input, based on the type of user interface facilitates effective interactions with the user by minimizing erroneous shifts of the input focus between user interfaces, while also avoiding erroneous inputs directed to the virtual content that does not have the current input focus, thereby facilitating dynamic and accurate determination as to the intended operation to be performed, minimizing input errors, and providing for more efficient user interaction with the computer system. Moreover, moving the input focus when the first user interface region and the second user interface region are of the first type of user interface region improves multitasking at the computer system by enabling seamless transition between virtual objects. Similarly, forgoing moving the input focus when the first user interface region is of a first type and the second user interface region is of a second type, different from the first type of user interface region, improves multitasking at the computer system by limiting and thereby preventing inadvertent focus switching between different virtual objects.

In some embodiments, while the first user interface region has the current input focus at the computer system, and while the first user interface region has an active input session at the computer system, the computer system detects an event that causes the current input focus to change from the first user interface region to the second user interface region, such as in detecting attention 912 of the user coincides with the position of the first user interface region 904 when the first user interface region 904 has the input focus 940 and the input session 932 and when input corresponding to actuation of button 922 is detected, as shown in FIG. 9P, and subsequently, detecting attention 912 of the user coincides with the position of the second user interface region 930 and input corresponding to actuation of button 922, as shown in FIG. 9R. In some embodiments, in response to detecting the event that causes the current input focus to change from the first user interface region to the second user interface region, the computer system (e.g., 101) terminates the active input session at the first user interface region, such as when the computer system 101 visually deemphasizes keyboard 933 in response to detecting attention 912 of the user coincides with the position of the second user interface region 930 when input corresponding to actuation of button 922 is detected, and shifts the input focus 940 and controller input focus 942 to the second user interface region 930 has an active input session 932, as shown in FIG. 9S. In some embodiments, when the computer system detects an event that causes the current input focus to transition from the first user interface region and to the second user interface region while the first user interface region has current input focus as well as an active input session at the computer system, the computer system terminates the active input session at the first user interface region, in response to detecting the event that caused the current input focus to transition or otherwise change from the first user interface region and to the second user interface region. In some embodiments, detecting an event that causes the current input focus to transition (e.g., between the first user interface region and the second user interface region) shares one or more characteristics of the focus switching described with respect to method 1000. In some embodiments, terminating the active input session causes the display of the active input session to be terminated or otherwise ended. In some embodiments, terminating the active input session causes any input provided to the input session that wasn't previously stored to be lost. In some embodiments, an active input session at the computer system includes any active virtual object that is designated to receive operations or inputs from the user. In some embodiments, an active input session at the computer system includes an active virtual object corresponding to a user interface region which is designated to receive operations or inputs from the user. In some embodiments, an active input session at the computer system, such as in a user interface region which is designated to receive operations or inputs from the user, includes a text field, a dropdown menu, or the like. Additionally or alternatively, in some embodiments, an active input session at the computer system, such as in a user interface region which is designated to receive operations or inputs from the user, includes any element associated with a virtual object (such as a user interface region) that is configured to receive input or to which input is otherwise directed for the purpose of changing a characteristic or state of the virtual object. For example, in some embodiments, for an active input session corresponding to a text field displayed in connection with an active virtual object (e.g., the first user interface region), displaying the active input session includes displaying a virtual keyboard and a cursor element in the text field indicating the location at which input will be entered based on input detected at the virtual keyboard. As another example, in some embodiments, for an active input session corresponding to a text field displayed in connection with an active virtual object (e.g., the first user interface region), terminating the active input session includes ceasing the display of the virtual keyboard, ceasing display of the cursor element in the text field, and/or the like. In some embodiments, an active input session of a user interface region includes a user interface region including a scroll bar to which input (e.g., scrolling, dragging, etc.) can be directed to scroll the contents of the user interface region. In some embodiments, detecting an event that causes the current input focus to transition from the first user interface region and to the second user interface region includes detecting a focus switching event in connection with the second user interface region while the first user interface region has the current input focus and the active input session. In some embodiments, terminating the active input session at the first user interface region includes stopping the execution of tasks associated with the active input session at the first user interface region. For example, in some embodiments, input mechanisms by which the input is received at the active input sessions include a soft keyboard, a physical keyboard, controller input, mouse input, trackpad input, and/'or the like. Controlling the execution of operations with respect to one or more virtual objects based on the attention of the user, and shifts in attention of the user, improve interactions via the computer system by reducing clutter in the three-dimensional environment, thereby reducing distractions for the user while also avoiding erroneous inputs directed to the virtual content that does not have the current input focus, thereby facilitating dynamic and accurate determination as to the intended operation to be performed, minimizing input errors, and providing for more efficient user interaction with the computer system.

In some embodiments, while the first user interface region has the current input focus at the computer system, and while the first user interface region has an active input session at the computer system, the computer system detects a first event (e.g., a first focus-switching event) that causes the current input focus to change from the first user interface region to the second user interface region, such as shown in FIG. 9R, in which the first event is detected in response to detecting eye tracking data indicating that the attention 912 of the user has shifted from the first user interface region 904 and to the second user interface region 930, and input corresponding to actuation of button 922 of controller 901, as shown in FIG. 9R. In some embodiments, in response to detecting the first event that causes the current input focus to change from the first user interface region to the second user interface region, the computer system pauses the active input session at the first user interface region, including visually deemphasizing virtual keyboard and ceasing display of cursor element, as shown in FIG. 9S. In some embodiments, while the second user interface region has the current input focus at the computer system, the computer system detects a second event (e.g., a second focus-switching event) that causes the current input focus to change from the second user interface region back to the first user interface region, such as shown in FIG. 9T, in which the second event is detected in response to detecting eye tracking data indicating that the attention 912 of the user has shifted back to the first user interface region 904 and input corresponding to actuation of button 922 of controller 901, as shown in FIG. 9T. In some embodiments, in response to detecting the second event that causes the current input focus to change from the second user interface region back to the first user interface region, the computer system resumes the paused the active input session at the first user interface region, such as when the computer system 101 displays the virtual keyboard 933 and the cursor element 948, as shown in FIG. 9U. In some embodiments, input mechanisms by which the input is received at the active input sessions optionally share characteristics with the input mechanisms described above. In some embodiments, when the computer system detects an event (e.g., a first event) that causes the current input focus to change from the first user interface region and to the second user interface region while the first user interface region has the current input focus as well as an active input session at the computer system, the computer system pauses the active input session at the first user interface region in response to detecting the event (e.g., the first event) that caused the current input focus to change from the first user interface region and to the second user interface region. In some embodiments, detecting the event that causes the current input focus to transition shares one or more characteristics of the focus switching described herein. Additionally or alternatively, in some embodiments, when the computer system detects an event (e.g., a second event subsequent to the first event) that causes the current input focus to change from the second user interface region back to the first user interface region while the second user interface region has the current input focus at the computer system, the computer system resumes, in response to detecting the event (e.g., the second event) that caused the current input focus to change from the second user interface region back to the first user interface region, the active input session at the first user interface region. Additionally or alternatively, in some embodiments, detecting an event (e.g., a first event) that causes the current input focus to transition from the first user interface region and to the second user interface region includes detecting a focus switching event in connection with the second user interface region while the first user interface region has the current input focus and the active input session. In some embodiments, pausing the active input session at a first virtual object such as the first user interface region includes temporarily storing a state of an element of the first virtual object, such as in storing a state of a text field of the first virtual object, prior to detecting a first focus switching event in connection with a second virtual object while the first virtual object has input focus. For example, in some embodiments, for an active input session corresponding to a text field displayed in connection with an active virtual object (e.g., the first user interface region), pausing the active input session includes visually deemphasizing one or more elements associated with the active virtual object, such as in visually deemphasizing a virtual keyboard associated with the text field, visually deemphasizing a cursor element in the text field, and/or the like. As another example, in some embodiments, for an active input session corresponding to a text field displayed in connection with an active virtual object (e.g., the first user interface region), pausing the active input session includes visually deemphasizing one or more elements associated with the active virtual object (e.g., as in changing a display parameter associated with the previously active input session, or an element associated with the previously active input session), such as in reducing a brightness, opacity, size, color, and/or the like, of the virtual object and/or virtual keyboard. In some embodiments, resuming the active input session includes restoring the state of the text field in response to detecting a subsequent focus switching event in connection with the first virtual object while another virtual object (e.g., the second virtual object) has input focus, thereby returning input focus to the first virtual object. For example, if the user had typed some text in a text field (but hadn't hit enter), when the active input session resumes, the text that was typed so far would be shown, and the user would be able to add to it. Performing operations in different user interface regions, including pausing and resuming active input sessions, enables temporal continuity in the user interface, thereby enhancing user engagement and improving the user experience, as well as enabling operations to be dynamically performed with respect to virtual content that does not have the current input focus (optionally without moving the input focus to that virtual content) while also avoiding erroneous inputs directed to the virtual content that does not have the current input focus, thereby facilitating dynamic and accurate determination as to the intended operation to be performed, minimizing input errors, and providing for more efficient user interaction with the computer system.

In some embodiments, while the first user interface region has the current input focus at the computer system, and while the first user interface region has a first active input session at the computer system, the computer system detects an event that causes the current input focus to change from the first user interface region to the second user interface region, such as shown in FIGS. 9Q-9R, in which the computer system 101 detects attention 912 of the user coincides with the position of the second user interface region 930 when input 922 is detected, as shown in FIGS. 9Q-9R. In some embodiments, in response to detecting the event that causes the current input focus to change from the first user interface region to the second user interface region, the computer system pauses the active input session at the first user interface region, such as when the computer system 101 ceases display of the keyboard 933 and ceases display of cursor element 948 at the first user interface region, and displays input session 934 at the second user interface region 930, as shown in FIGS. 9Q-9R. In some embodiments, while the current input focus is at the second user interface region, and in accordance with a determination that one or more focus switching criteria are satisfied, the computer system starts a second active input session at the second user interface region, such as detecting attention 912 of the user coincides with the position of the second user interface region 930 when input 922 is detected, and displays input session 934 at the second user interface region 930, as shown in FIG. 9R. In some embodiments, input mechanisms by which the input is received at the active input sessions share characteristics with the input mechanisms described above. In some embodiments, the active input session shares one or more characteristics with the active input session described above. In some embodiments, when the computer system detects an event that causes the current input focus to change from the first user interface region and to the second user interface region while the first user interface region has the current input focus and an active input session at the computer system, the computer system pauses, in response to detecting the event that caused the current input focus to change from the first user interface region and to the second user interface region, the active input session at the first user interface region. In some embodiments, pausing the active input session optionally shares one or more characteristics with pausing the first user interface region as described above. Additionally or alternatively, in some embodiments, when the computer system detects an event that causes the current input focus to change from the second user interface region back to the first user interface region while the second user interface region has the current input focus at the computer system, the computer system initializes or otherwise starts, in response to determining that one or more focus switching criteria is satisfied, a second active input session at the second user interface region. In some embodiments, the one or more focus switching criteria include a criterion that is satisfied when the computer system detects an event that causes the current input focus to change from the first user interface region and to the second user interface region while the first user interface region has the current input focus, and, subsequently, receives input (e.g., scrolling input) directed to the second user interface region. For example, in some embodiments, the second active input session at the second user interface region includes a text field, such as described herein. Additionally or alternatively, in some embodiments, the second active input session at the second user interface region includes an active input session associated with a virtual object element other than a text entry field, such as a dropdown menu including one or more selectable options, a slider element (e.g., for volume control), a checkbox or radio button, an interactive map (e.g., zooming or panning), or the like. Pausing operations in a first virtual object and initializing operations in a second virtual object in accordance with determinations as to input focus enables the computer system to efficiently utilize system resources based on how the user is using the system at any given time, thereby improving the user experience and providing for more efficient user interaction with the computer system.

In some embodiments, the input is a controller input detected at a hardware control (e.g., that is separate from the computer system and/or separate from a head mounted display or other display generation component), such as controller 901, as shown in FIGS. 9A-9V. In some embodiments, the first input shares one or more characteristics of the input described with respect to method 800, above. For example, in some embodiments, the first input includes a controller input from a controller device, such as a game controller, a trackpad, a mouse, or other controller input devices such as described with reference to methods 800, 1200, 1400, and/or 1600. Performing operations based on controller input in different user interface regions based on attention, input focus, or whether the input satisfies criteria enables operations to be dynamically performed with respect to virtual content that does not have the current input focus (optionally without moving the input focus to that virtual content) while also avoiding erroneous inputs directed to the virtual content that does not have the current input focus, thereby facilitating dynamic and accurate determination as to the intended operation to be performed, minimizing input errors, and providing for more efficient user interaction with the computer system.

In some embodiments, the first input includes a thumbstick input, such as input 921e from controller 901, as shown in FIG. 9H. In some embodiments, the first input shares one or more characteristics of the input described with respect to method 800, above. For example, in some embodiments, the first input includes a thumbstick input, such as described with reference to methods 800, 1200, 1400, and/or 1600. In some embodiments, the thumbstick input includes input corresponding to displacement of a directional control mechanism such as a control stick, analog stick, joystick, or the like. Performing operations based on controller input including thumbstick input in different user interface regions based on attention, input focus, or whether the input satisfies criteria enables operations to be dynamically performed with respect to virtual content that does not have the current input focus (optionally without moving the input focus to that virtual content) while also avoiding erroneous inputs directed to the virtual content that does not have the current input focus, thereby facilitating dynamic and accurate determination as to the intended operation to be performed, minimizing input errors, and providing for more efficient user interaction with the computer system.

In some embodiments, the first input includes a button press input, such as input 924c, as shown in FIG. 9M. In some embodiments, the first input shares one or more characteristics of the input described with respect to method 800, above. For example, in some embodiments, the first input includes a button press input at a controller, or other button press input such as described with reference to methods 800, 1200, 1400, and/or 1600. Performing operations based on controller input including button press input in different user interface regions based on attention, input focus, or whether the input satisfies criteria enables operations to be dynamically performed with respect to virtual content that does not have the current input focus (optionally without moving the input focus to that virtual content) while also avoiding erroneous inputs directed to the virtual content that does not have the current input focus, thereby facilitating dynamic and accurate determination as to the intended operation to be performed, minimizing input errors, and providing for more efficient user interaction with the computer system.

In some embodiments, the first input includes a device motion input, such as in motion of controller 901 and/or the user's hands 914 and 916, as shown in FIG. 9K. In some embodiments, the first input shares one or more characteristics of the input described with respect to method 800, above. In some embodiments, the first input shares one or more characteristics of the input described with respect to method 800, above. For example, in some embodiments, the first input includes input including data corresponding to motion of the user, input including data corresponding to device motion, such as motion of the computer system, and/or input including data corresponding to motion of other devices or controllers (also referred to as “one or more body or controller motion tracking devices”), such as described herein and/or with reference to methods 800, 1200, 1400, and/or 1600. In some embodiments, the computer system receives input such as the first input via one or more input devices. For example, in some embodiments, the one or more input devices include one or more body or controller motion tracking devices such as one or more cameras, motion sensors, proximity sensors, or depth sensors. Additionally or alternatively, in some embodiments, the one or more body or controller tracking devices include one or more motion sensors or orientation sensors, such as one or more accelerometers at the controller, one or more gyroscopes at the controller, and the like. Additionally or alternatively, in some embodiments, the one or more body or controller tracking devices include one or more cameras such as one or more motion tracking cameras, and the like. Additionally or alternatively, in some embodiments, the one or more body or controller tracking devices include one or more infrared light sources directed at the user for emitting signals to the controller (e.g., via one or more infrared light sensors for receiving reflected signals corresponding to the emitted signals after being reflected from the user), and the like. In some embodiments, the computer system tracks the motion of the user, the device motion, and/or the motion of the one or more body or controller motion tracking devices based on input such as the first input, including data from the one or more body or controller motion tracking devices. In some embodiments, the computer system transitions input focus between virtual objects, such as from the first user interface region and to the second user interface region, based on input such as the first input, including data corresponding to device motion or device orientation.

In some embodiments, the computer system transitions the input focus between virtual objects such as the first user interface region and the second user interface region based on input such as the first input, including data indicating a measure of the device motion, direction, and/or orientation. In some embodiments, the data indicating a measure of the device motion, direction, and/or orientation includes data indicating a magnitude of the device motion, data indicating a direction of the device motion, data indicating the device orientation, and/or the like. For example, in some embodiments, the computer system transitions the input focus between virtual objects, such as from the first user interface region and to the second user interface region, based on input such as the first input, including data corresponding to a measure of device motion exceeding a predetermined threshold and indicating a device direction and/or a device orientation directed to the second user interface region. As another example, in some embodiments, the computer system forgoes transitioning the input focus between virtual objects such as the first user interface region and the second user interface region based on input such as the first input, including data corresponding to a measure of device motion that does not exceed the predetermined threshold.

In some embodiments, detecting a focus switching event in connection with virtual objects, such as the first user interface region and the second user interface region, includes detecting data corresponding to signals from the one or more body or controller motion tracking devices, in which the detected data includes data indicating a magnitude of motion exceeding a predetermined motion threshold. As another example, detecting a focus switching event in connection with virtual objects, such as the first user interface region and the second user interface region, includes detecting data corresponding to signals from the one or more body or controller motion tracking devices, in which the detected data includes data indicating a magnitude of a displacement or change position exceeding a predetermined position threshold. For example, in some embodiments, detecting a focus switching event in connection with the first user interface region that currently has input focus and the second user interface region includes detecting data corresponding to tilting of the controller towards the second user interface region or away from the first user interface region (e.g., data corresponding to a measure of device motion exceeding a predetermined threshold and indicating a device direction and/or a device orientation directed to the second user interface region or away from the user interface region). Performing operations based on input corresponding to device motion enables a greater range of operations to be performed based on a greater variety of inputs thereby facilitating dynamic and accurate determination as to the intended operation to be performed, minimizing input errors, and providing for more efficient user interaction with the computer system.

In some embodiments, the first input includes a hand gesture (e.g., an air gesture from a hand of the user), such as input 921c, corresponding to an air pinch and drag gesture, as shown in FIGS. 9E-9F. In some embodiments, the first input shares one or more characteristics of the input described with respect to method 800, above. For example, in some embodiments, the first input includes input corresponding to a hand gesture, such as described herein and/or with reference to methods 800, 1200, 1400, and/or 1600. Additionally or alternatively, in some embodiments, the first input includes input corresponding to a hand gesture includes input corresponding to one or more air gestures such as an air pinch and release gesture; an air pinch and drag gesture; an air pinch, drag, and release gesture; and the like. Additionally or alternatively, in some embodiments, the first input including the input corresponding to a hand gesture includes input indicating a measure of motion, direction, and/or orientation of the hand gesture. In some embodiments, the computer system transitions the input focus between the virtual objects based on input such as the first input, including input corresponding to a hand gesture and indicating a measure of motion, direction, and/or orientation of the hand gesture, such as in transitioning the input focus based on the data indicating a measure of the device motion, direction, and/or orientation, as described herein. Performing operations based on input corresponding to a hand gesture in different user interface regions based on attention, input focus, or whether the input satisfies criteria enables operations to be dynamically performed with respect to virtual content that does not have the current input focus (optionally without moving the input focus to that virtual content) while also avoiding erroneous inputs directed to the virtual content that does not have the current input focus, thereby facilitating dynamic and accurate determination as to the intended operation to be performed, minimizing input errors, and providing for more efficient user interaction with the computer system.

It should be understood that the particular order in which the operations in method 1000 have been described is merely exemplary and is not intended to indicate that the described order is the only order in which the operations could be performed. One of ordinary skill in the art would recognize various ways to reorder the operations described herein. In some embodiments, aspects/operations of method 1000 may be interchanged, substituted, and/or added between these methods. For example, various object manipulation techniques and/or object movement techniques of method 1000 is optionally interchanged, substituted, and/or added between these methods. For brevity, these details are not repeated here.

FIGS. 11A-11Z illustrate exemplary ways in which a computer system, while displaying one or more first portions of a representation of a physical environment of a user, optionally provides increased visual access to physical objects and/or representations of physical objects which are obscured and/or occluded by virtual content (e.g., virtual environment, application window, and/or notification window) displayed by the computer system. The criteria based on which the computer system determines if a user of the computer system should be provided increased visual access to a representation of a physical object, and how much visual access is increased and/or decreased, depends on factors determined by the computer system including, but not limited to: the type of object which the representation of the first physical object corresponds to, attention level(s) of the user directed toward (or away from) the representation of the first physical object, movement(s) of one or more portions of the user in relation to the representation of the first physical object, physical contact between the user (e.g., a first hand) and the physical object, request(s) for input from an active application running on the computer system, and/or what type of virtual content is obscuring the representation of the first physical object. FIGS. 11A-11Z include real-world top-down view 1107 providing a secondary view of the physical environment 1102 corresponding to the representation of the physical environment viewed by the user, such as a physical environment which the user is presently in.

FIG. 11A illustrates a computer system 101 (e.g., an electronic device) displaying, via a display generation component (e.g., display generation component 120 of FIGS. 1 and 3), a three-dimensional environment (e.g., representation of the physical environment 1100) from a viewpoint of a user. In some embodiments, computer system 101 includes a display generation component 120. In FIG. 11A, the computer system 101 includes one or more internal image sensors 114a oriented towards the face of the user (e.g., eye tracking cameras 540 described with reference to FIG. 5). In some embodiments, internal image sensors 114a are used for eye tracking (e.g., detecting a gaze of the user). Internal image sensors 114a are optionally arranged on the left and right portions of display generation component 120 to enable eye tracking of the user's left and right eyes. Computer system 101 also includes external image sensors 114b and 114c facing outwards from the user to detect and/or capture the physical environment 1102 and/or movements of the user's hands.

As discussed in more detail below, in FIG. 11A, display generation component 120 is illustrated as displaying one or more virtual objects in the three-dimensional environment 1110. In some embodiments, the one or more virtual objects are displayed by a single display (e.g., display 510 of FIG. 5) included in display generation component 120. In some embodiments, display generation component 120 includes two or more displays (e.g., left and right display panels for the left and right eyes of the user, respectively, as described with reference to FIG. 5) having displayed outputs that are merged (e.g., by the user's brain) to create the view of the virtual objects shown in FIGS. 11A-11Z.

As illustrated in FIG. 11A, the representation of the physical environment 1100 of the user includes one or more representations of physical objects which are in the physical environment 1102 of the user. For instance, the representation of the physical environment 1100 as shown, includes game controllers 1104a (e.g., right game controller 1104a-1, and left game controller 1104a-2), a computer mouse 1104b, a keyboard 1104c, a pencil 1106a, a coffee mug 1106b, and a bowl of snacks 1106c resting upon a table 1103. Each of the representations of the objects shown within the representation of the physical environment 1100 (e.g., computer mouse 1104b, keyboard 1104c, pencil 1106a, coffee mug 1106b, and bowl of snacks 1106c) by the computer system 101 corresponds to a physical object in the physical environment 1102 of the user. In response to receiving a first user input 1105a corresponding to an indication to display a virtual environment, such through button 1-128, the computer system 101 optionally displays virtual content such as virtual environment 1110 shown in FIG. 11B.

As shown in FIG. 11B, the computer system 101 displays the virtual environment 1110 which obscures at least a portion of the representation of the physical environment 1100. As shown, a portion of the representation of the table 1103 remains visible below the water line 1110a of the beach scene represented by the virtual environment 1110 (thus the environment while immersive does not completely occupy the viewport of the user). The representations of the physical objects remain obscured and out of sight from the viewpoint of the user until the computer system 101 receives an indication from the user, or the computer system (e.g., via an application) which corresponds with providing an increased amount of attention to a representation of an object within the representation of the physical environment.

When the computer system receives an input from the user, such as first input 1105a (at FIG. 11A) corresponding to an indication to display virtual content, such as gaming window 1111, the computer system optionally displays gaming window 1111 in a manner which obscures a portion of the three-dimensional environment including a portion of the virtual environment 1110. As shown in FIG. 11C, the computer system 101 displays a gaming window 1111 which requires one or more inputs from game controllers 1104a to perform operations associated with a gaming application which are displayed on gaming window 1111. When the computer system 101 receives the indication to display the gaming window 1111 which requires one or more inputs from the user through the game controllers 1104a, the computer system initiates an operation to provide increased visibility of the game controllers 1104a so that the user of the computer system can ascertains the whereabouts of controller 1104a even though the virtual environment 1110 is obscuring the game controllers.

As shown in FIG. 11D, the computer system 101 provides increased visibility of the representation of the game controllers 1104a by displaying one or more portions 1108a (e.g., 1108a-1, and 1108a-2) of the virtual environment 1110, corresponding with the representation of the game controllers 1104a, with a first level degree of visual prominence as illustrated with double hash-line pattern herein. By displaying the portion of the virtual environment corresponding with the representation of the game controllers 1104a with the first degree of visual prominence, the computer system 101 provides an increased level of visibility of the representation of the game controllers 1104a from the viewpoint of the user. Visual prominence as discussed herein corresponds with visual characteristics related to the visibility of one or more portions of the virtual environment such as transparency, translucency, and/or opacity. For instance, displaying a portion of the virtual environment with a reduced visual prominence and/or reducing the visual prominence of the portion of the virtual environment optionally includes reducing the opacity and/or increasing the transparency of the portion of the virtual environment to reveal and/or provide increased visual access to content (e.g., virtual content, representation of the physical environment, and/or a representation of a physical object) from the viewpoint of the user. Accordingly, displaying a portion of the virtual environment with a reduced visual prominence and/or reducing the visual prominence of the portion of the virtual environment optionally allows the user to view, and/or provides increased portions of the virtual environment which are otherwise obscured by the virtual content. The portions (e.g., 1108a) of the virtual content (e.g., virtual environment 1110) discussed herein are illustrated as regions which correspond to one or more representations of physical objects. As illustrated herein, the portions of the virtual content corresponding to the representation of the physical objects coincide with the boundary of the representation of the corresponding physical object and/or are offset from the representation of the physical object. In some embodiments the portion(s) of the virtual content corresponding to the representation of the physical object(s) optionally mimic the outline of (e.g., have the same shape as) the representation of the physical object as seen from the user's viewpoint, and/or optionally include a shape which is unrelated to the corresponding representation of the physical object. The computer system 101 determines the location and/or shape of physical objects (e.g., game controllers 1104a) through the use of cameras 114a-c to determine the shape of the physical objects from the viewpoint of the user, which corresponds to the shape of the portion 1108a of the virtual environment.

As shown in FIG. 11E, when the computer system detects that a hand 1114 of the user is reaching toward the right game controller 1104a-2, the computer system 101 reduces the visual prominence of the portion of the virtual environment 1110 corresponding to the representation of the right game controller to a second degree of visual prominence. The second degree of visual prominence, illustrated with a single hash-line pattern herein, is less than the first degree of visual prominence (at FIG. 11D), which results in increased visibility of the representation of the right game controller 1104a-1 in contrast with the visibility of the representation of the left game controller 1104a-2. For example, the computer system optionally increases the visibility of the representation of the right game controller by increasing the transparency and/or reduces the opacity of the portion of the virtual environment which corresponds to the location of the representation of the right game controller.

As illustrated in FIG. 11F, while the computer system 101 displays the virtual environment, when the computer system 101 determines that the representation of one or more physical objects (e.g., 1104a-1104c, and 1106a-1106c) are obscured by the virtual environment 1110, the computer system optionally displays portions of the virtual environment which obscure representations of objects that correspond to a first object type (e.g., input devices 1104a-1104c) with a first degree of visual prominence, which enables the representations of the physical objects 1104a-1104c to be at least partially visible through the virtual environment. In some embodiments, the computer system 101 scans for physical objects within the physical environment of the user and/or for representations of objects that are within the viewport of the user. When the computer system detects physical objects within the physical environment of the user and/or representations of objects that are within the viewport of the user which correspond with a certain category (e.g., objects communicatively connected with the computer system, commonly used objects, and/or input devices) the computer system reduces the visual prominence of the portion of virtual environment corresponding to the location of those objects. As illustrated in FIG. 11F, the computer system provides increased visual access to the representations of physical objects corresponding with input devices (e.g., game controllers 1104a, mouse 1104b, and/or keyboard 1104c) by displaying corresponding portions of the virtual content with a reduced degree (e.g., first degree) of visual prominence. When the computer system detects one or more physical objects within the physical environment of the user and/or one or more representations of physical objects within the viewport of the user which do not correspond with the certain category, the computer system foregoes reducing the visual prominence of the portion of the virtual content (e.g., virtual environment 1110) corresponding to the location of the one or more objects detected by the user which do not correspond with the certain category.

As illustrated in FIG. 11G, the computer system 101 optionally detects the gaze 1112 of the user and/or the position and/or movement(s) of a hand of a user 1114 in relation to a representation of a first physical object (e.g., game controller 1104a) as an indicator of the attention level of the user toward the representation of the first physical object. For instance, proximity of the gaze and/or proximity of the hand of the user from the representation of the physical object is an indicator of an increased attention of the user toward the representation of the first physical object. In some embodiments the attention of the user is based on the gaze 1112 of the user, and/or the location and/or movements of one or more portions of the user (e.g., hand of the user 1114). When the attention of the user is detected as increasing (e.g., gaze of the user directed to, and/or hand of the user moving toward, and/or the hand of the user within a threshold distance) toward the representation of the game controller 1104a, the computer system 101 optionally reduces the visual prominence of the portion 1108a of the virtual environment 1110 corresponding to the representation of the game controller 1104a to enable increased visibility of the representation of the game controller 1104a. Timer 1125 indicates the amount of time which has elapsed since the computer system 101 has detected that the gaze of the user is directed to the right controller 1104a-1. As shown in FIG. 11G, the gaze 1112 of the user is detected by computer system 101 as directed to the representation of game controller 1104a-1, however in the example of FIG. 11G, the gaze of the user 1112 has not been detected as having been directed to the representation of the right game controller for longer than a first gaze threshold time 1116a. Accordingly, the computer system 101 does not reduce the visual prominence of the portion of the virtual environment corresponding to the representation of the right game controller 1104a-1.

As shown in FIG. 11G, the computer system 101 displays a portion 1115 of the virtual content (e.g., virtual environment 1110) corresponding with representation of the hand 1114 of the user with a third degree of visual prominence, less than the first degree and the second degree of visual prominence, which provides increased visual access of the representation of the hand of the user 1114 with respect to portions of the virtual environment with a reduced visual prominence and/or portions of the virtual environment which do not include a reduced visual prominence. The visual prominence of the portion 1115 which corresponds to the representation of the hand 1114 of the user, is optionally reduced to a degree of visual prominence which is less than the visual prominence of other portions of the virtual content which do not correspond to the location of the representation of the hand 1114 of the user. Additionally or alternatively, the visual prominence with which the portion 1115 corresponding to the hand 1114 of the user is reduced to optionally maximizes the visibility of the hand 1114 of the user from the viewpoint of the user in relation to portions of the virtual content which do not correspond with the portion 1115 which corresponds to the location of the hand 1114 of the user.

As illustrated in FIG. 11H, when the computer system 101 determines that the attention of the user directed toward the representation of the right game controller 1104a-1 is at a first level of attention, the computer system 101 reduces the visual prominence of the portion of the virtual environment 1110 which corresponds to the representation of game controller 1104a from the first degree of visual prominence to a second degree of visual prominence to increase the visibility of the representation of the right game controller 1104a-1. In the example of FIG. 11H, computer system 101 determines that the attention of the user is at a first level of attention in relation to the representation of the game controller 1104a due to the gaze 1112 of the user being directed to the representation of game controller 1104a for a length of time which exceeds a first gaze threshold time 1116a. Additionally or alternatively, the computer system 101 determines that the attention level of the user is at the first level when the first hand of the user 1114 is detected as moving toward the right game controller 1104a-1 as shown in FIG. 11G-11H. Furthermore, while the gaze 1112 of the user is directed toward the representation of the game controller 1104a, the computer system optionally determines that the motions of the first hand 1114a of the user are directed toward in the direction of the game controller 1104a, and not directed toward the mouse 1104b, or the keyboard 1104c, resulting in the computer system 101 determining that the attention of the user toward the right game controller is at the first level of attention.

As illustrated in FIG. 11I, when the computer system 101 determines that the attention of the user directed toward the representation of the right game controller 1104a-1 is at a second level of attention, the computer system 101 reduces the visual prominence of the portion of the virtual environment which corresponds to the representation of the right game controller 1104a-1 from the second degree of visual prominence (e.g., as shown in FIG. 11H) to a third degree of visual prominence to increase the visibility of the representation of the right game controller 1104a-1. For instance, as shown in FIG. 11I, the computer system reduces the visual prominence of the right game controller 1104a-1 to match the visual prominence of the hand 1114 which has a degree of visual prominence which is less than the second degree of visual prominence. The computer system 101 optionally determines that the attention of the user is at the second level of attention in relation to the representation of the game controller 1104a-1 when the gaze 1112 of the user is directed to the representation of game controller 1104a-1 for a length of time which exceeds a second gaze threshold time 1116b. Additionally or alternatively, the computer system 101 determines that the attention level of the user is at second level when the first hand of the user 1114a is detected as physically touching the right game controller 1104a-1.

As illustrated in FIG. 11J, when the attention of the user is based on gaze, and the computer system 101 detects the gaze 1112 of the user is directed away from the representation of the right game controller 1104a-1, the computer system 101 determines that the attention of the user is not directed to the representation of the game controller 1104a-1. Accordingly, when the hand of the user is detected as directed to and/or reaching toward the right game controller 1104-1 and the gaze of the user is detected as being directed away from the representation of the right game controller 1104a-1, the computer system 101 does not reduce the visual prominence of the portion of the virtual environment 1110 which corresponds to the representation of the right game controller 1104a-1, accordingly the portion of the virtual environment which corresponds to the representation of the right game controller remains displayed at the first degree of visual prominence.

FIG. 11K illustrates an alternate exemplary representation of the physical environment 1100 of the user wherein the location of the physical objects within the physical space of the user, including the location of the game controller 1104a and the location of the bowl of snacks 1106c have changed positions as related to previous FIGS. 11A-11J. Changing locations of the physical objects as shown further demonstrates that the display of the portions of the virtual content with a first degree of visual prominence corresponds to the type of object, rather than the location of the object. In the example of FIG. 11K, the computer system 101 receives a first user input 1105a, through button 1-128, providing an indication to the computer system 101 to display virtual content such as virtual environment 1110 shown in FIG. 11L.

As illustrated in FIG. 11L, the computer system displays a virtual environment 1110 which obscures portions of the representation of the physical environment 1100. Accordingly, the computer system 101 displays portions of the virtual environment 1110 corresponding to the location of the representation of each of the input devices 1104a-1104c with a first degree of visual prominence to provide increased visual access to the representation of the input devices. Although the computer system detects the attention (e.g., gaze 1112, and/or hand 1114) of the user directed to the representation of the bowl of snacks 1106c, the computer system 101 forgoes displaying the portion of the virtual environment 1110 corresponding to the representation of the bowl of snacks 1106c with a reduced visual prominence as the bowl of snacks do not correspond to the first object type, nor do the bowl of snacks 1106c correspond to a pre-defined object type that the computer system recognizes as an object that initiates displays of reduced visual prominence of the virtual environment 1110.

As illustrated in FIG. 11M, the computer system 101 detects that the right game controller 1104a-1 is picked up by the hand 1114 of the user, following the hand of the user being directed to the right game controller in FIG. 11J. The representation of the first hand of the user 1114a is displayed by the computer system in a manner which provides increased visual access to the first hand of the user 1114a as related to the virtual environment 1110. Although the gaze 1112 of the user is directed away from the representation of the right game controller 1104a-1, when the first hand 1114a of the user is detected as picking up the right game controller 1104a-1, the computer system 101 reduces the visual prominence of the portion of the virtual environment corresponding to the representation of the game controller 1104a from the first degree of visual prominence to the third degree of visual prominence corresponding to the visual prominence with which the representation of the hand 1114 is displayed. Furthermore, as displayed, when the computer system 101 detects that the hand 1114 of the user has picked up the right game controller 41104a-1, the portion 1115 of the virtual environment corresponding to the representation of the hand 1114 of the user is updated and/or modified to encompass the representation of the right game controller 1104a-1.

In some embodiments, when textual input from the user is required by the computer system 101 and/or an active application, the computer system 101 displays an application window 1118 which includes a text input field requiring input through keyboard 1104c, such as illustrated in FIG. 11N. In response to displaying the text input field 1118 which requests user input through the keyboard 1104c, the computer system reduces the visual prominence of the portion of the virtual environment which corresponds to the representation of the keyboard 1104c to a first degree of visual prominence, such as shown in FIG. 11N. In response to detecting that the attention of the user is directed toward the application window 1118, such as the gaze 1112 of the user and/or an air gesture 1113 performed by the hand of the user 1114a, the computer system 101 optionally displays the portion of the virtual environment 1110 that corresponds to the representation of the keyboard 1104c with a reduced degree of visual prominence (after, optionally, identifying the location of the representation of the keyboard 1104c using one or more sensors), such as shown in FIG. 11N-1, to provide the user with increased visual access of the keyboard 1104c. In response to detecting that the user has interacted with a input element such as selecting a text entry field for input (e.g., with a selection input such as a gaze and air pinch input), the computer system 101 optionally displays the portion of the virtual environment 1110 that corresponds to the representation of the keyboard 1104c with a reduced degree of visual prominence (e.g., further reduced over a degree of visual prominence that the portion of the virtual environment that corresponds to the representation of the keyboard was displayed at when the attention of the user was directed to the application window), such as shown in FIG. 11N-1 for instance. In some embodiments the computer system 101 displays the portion of the virtual environment 1110 that corresponds to the representation of the keyboard 1104c with a reduced degree of visual prominence in response to the active application, corresponding to the application window 1118, requesting a user input.

As illustrated in FIG. 11N-1, when the computer system 101 detects a selection (e.g., such as detected in relation to FIG. 11N) of the text input field 1118 resulting in activating the text input field (e.g., as represented with an active cursor), the computer system reduces the visual prominence of the of the portion of the virtual environment corresponding to the representation of the keyboard 1104c to a second degree of visual prominence, to provide increased visibility of the representation of the keyboard 1104c from the viewpoint of the user as compared to the visual prominence of the portion of the virtual environment corresponding to the representation of the keyboard 1104c in relation to a non-active text input field as shown in FIG. 11N. As illustrated in FIG. 11O, when the computer system 101 detects one or more hands of the user 1114 (e.g., right hand 1114a, and/or left hand 1114b) actively providing input via an input device (e.g., the keyboard 1104c), the computer system 101 reduces the visual prominence of the portion of the virtual environment 1110 corresponding to the location of the representation of the keyboard 1104c to increase visibility of representation of the keyboard 1104c during the active input session, as compared to the visual prominence of the portion of the virtual environment corresponding to the representation of the keyboard 1104c being displayed with the first degree of visual prominence as shown in FIG. 11N for example. For instance, the computer system 101 optionally determines that the user is actively providing input by detecting via the one or more cameras 114a-c that one or more hands 1114 of the user obscure the keyboard, and/or that the computer system 101 is receiving inputs from the keyboard corresponding with user interaction with the keyboard (e.g., typing of keys). When the computer system determines that the user is actively providing input through the keyboard 1104c, the computer system optionally reduces the visual prominence of the portion of the virtual environment corresponding to the location of the keyboard from the first degree of visual prominence to the second degree of visual prominence to provide increased visibility of the representation of the keyboard from the viewpoint of the user. Additionally or alternatively, following the computer system reducing the visual prominence of the portion of the virtual environment corresponding to the representation of the keyboard 1104c from a first degree to a second degree of visual prominence in response to the activation of the text input field 1118, such as shown in FIG. 11N-1 for instance, in response to detecting that the user is actively providing input via the keyboard 1104c, the computer system further reduces the visual prominence of the portion of the virtual environment corresponding to the representation of the keyboard 1104c from the second degree of visual prominence to a third degree of visual prominence, such as if the visual prominence of the portion of the virtual environment corresponding to the representation of the keyboard 1104c in FIG. 11O were displayed with a third degree of visual prominence. The third degree of visual prominence is optionally less than, equal to, or greater than the visual prominence of the portion of the portion of the virtual environment corresponding to the representation of hands 1114 of the user.

As previously illustrated in FIGS. 11F-11L, in some embodiments the computer system 101 forgoes displaying certain portions of the virtual environment 1110 corresponding with the representation of certain objects with a reduced degree of visual prominence. For instance, as shown in FIG. 11F, the computer system 101 forgoes displaying the portion of the virtual environment corresponding to the location of the representation of the bowl of snacks 1106c with a reduced visual prominence due to the bowl of snacks 1106c not corresponding to a first object type. Additionally or alternatively, as shown in FIG. 11M, the computer system 101 forgoes displaying the portion of the virtual environment 1110 corresponding with the location of a representation of the bowl of snacks 1106c with a reduced degree of visual prominence with the attention of the user directed to the representation of bowl of snacks 1106c. However, when the user decides that they want an object such as the bowl of snacks, when detected by the computer system, to be recognized as an object of interest which should be visible when obscured by the virtual content, the user optionally initiates a scanning operation which allows the user to provide one or more inputs to identify one or more objects as objects of interest. Once the scanning mode is initiated, the computer system allows the user to identify one or more objects as objects of interest as described with respect to FIGS. 11P-11R. As shown in FIG. 11P, when the scanning mode is initiated, the computer system optionally provides a notification 1120 that the scanning operation has been initiated allowing to allow the user to identify objects of interest which do not correspond to the first object type.

As illustrated in FIG. 11Q, when the computer system 101 receives a user input 1105b corresponding to a scanning operation, such as at button 1-128, the computer system displays a visual prompt 1121, prompting the user to identify objects to scan for identification as an object of interest. Following receiving the user input 1105b corresponding to an indication to initiate the scanning process, the computer system 101 initiates a scanning operation to identify objects of interest that includes receiving an indication of the user identifying an object of interest such as a bowl of snacks 1106c through an identifying user input (e.g., detecting the user directing their hand 1114b toward the bowl of snacks 1106c). While engaged in the identification process, computer system 101 detects the hand of the user 1104 directed toward the bowl of snacks 1106c. In response, the computer system provides a visual confirmation 1122 to indicate to the user that the bowl of snacks 1106c has been identified as an object of interest and scanned accordingly.

In response to bowl of snacks being identified as an object of interest, the computer system going forward will treat the bowl of snacks as an object of interest as illustrated in FIG. 11R. In the example of FIG. 11R, after the computer system 101 identifies and scans the bowl of snacks 1106c as an object of interest, the computer system 101 recognizes the bowl of snacks 1106c as an object of interest and accordingly, when the virtual environment 1110 is displayed in a manner which obscures representation of the physical environment including the representation of bowl of snacks 1106c, the computer system 101 displays the portion of the virtual environment 1110 corresponding to the location of the representation of the bowl of snacks 1106c with a reduced degree (e.g., the first degree) of visual prominence to enable increased visual access to the representation of the bowl of snacks 1106c.

As illustrated in FIG. 11S, when the computer system detects that the attention of the user is directed toward the representation of the bowl of snacks 1106c, and/or the computer system 101 detects that the attention of the user is at a first level with respect to the attention of the user has increased toward the representation of the bowl of snacks 1106c in relation to the attention of the user as described with respect to FIG. 11G-FIG. 11I, the computer system reduces visual prominence of the portion of the virtual environment 1110 corresponding to the bowl of snacks 1106c from the first degree of visual prominence to the second degree of visual prominence.

As illustrated in FIG. 11T-11W, some objects, such as game controllers 1104a-1 and 1104a-2 are identified as being associated with a particular hand (e.g., right hand 1114a-1, or left hand 1114a-2. FIG. 11T-11W illustrate the permutations of the computer system 101 detecting the right hand 1114a, or left hand 1114b of the user reaching for the right game controller 1104a-1 or the left game controller 1104a-2.

In FIG. 11T, the computer system 101 detects the left hand 1114b reaching for the right game controller 1104a-1, and due to the mismatch of the left hand to the hand to right game controller, the computer system forgoes reducing the visual prominence of the portion of the virtual environment corresponding to the representation of the right game controller 1104a-1.

In FIG. 11U, the computer system 101 detects the right hand 1114a reaching for the left game controller 1104a-2, and due to the mismatch of the right hand to the left game controller, the computer system forgoes reducing the visual prominence of the portion of the virtual environment corresponding to the representation of the left game controller 1104a-2.

In FIG. 11V, the computer system 101 detects the right hand 1114a reaching for the right game controller 1104a-1, and due to the right hand corresponding to the right game controller, the computer system reduces the visual prominence of the portion of the virtual environment corresponding to the representation of the right game controller 1104a-1.

In FIG. 11W, the computer system 101 detects the left hand 1114a reaching for the left game controller 1104a-2, and due to the left hand corresponding to the left game controller, the computer system reduces the visual prominence of the portion of the virtual environment corresponding to the representation of the left game controller 1104a-2.

As illustrated in FIG. 11X, in some embodiments the virtual environment 1110 is displayed with a visual effect (e.g., tint 1124, atmospheric effect, and/or environmental effect). While displaying a visual effect, such as a virtual environment 1110 with a tint 1124, when the computer system 101 receives an indication to provide increased visibility of a representation of a physical object, and the computer system reduces the visual prominence of the portion of the virtual content which corresponds to the representation of the physical object, the computer system also applies the visual effect to the portion of the virtual content which corresponds to the representation of the physical object. By applying the visual effect to the portion of the virtual content which corresponds to the representation of the physical object, a continuity of the visual effect and/or immersive experience is maintained while providing increased visibility to one or more representation of physical objects. For instance, when the virtual environment corresponds with a night scene with a tint 1124, when a portion of the virtual content (e.g., virtual environment, and/or content window) is displayed with a reduced visual prominence to reveal a portion of the representation of the physical environment, the portion of the virtual content which is displayed with a reduced visual prominence includes the tint 1124 in order to maintain the user's experience of being in a night scene. As shown in FIG. 11X, a virtual content window 1126 (e.g., gaming application) is displayed in a manner which obscures the virtual environment 1110 depicting a night scene. The computer system 101 detects that the gaming application requires and/or requests input from the game controllers 1104a. Accordingly, the computer system 101 has reduced the visual prominence of the portions 1108a (e.g., 1108a-1, and/or 1108a2) of the virtual content (e.g., virtual content window, and/or the virtual environment) corresponding to the representation of the game controllers 1104a to provide increased visibility of the representation of the game controllers 1104a to the user. As illustrated, when the computer system reduces the visual prominence of portions 1108a such as illustrated and described with respect to FIG. 11X-FIG. 11Z, the computer system optionally applies the visual effect (e.g., tint 1124) to portions 1108a. For instance, when the portions 1108a of the virtual content are displayed with a reduced visual prominence, and the visual effect of the virtual environment is at an intensity 1130, the visual effect of the virtual environment is applied to the portions 1108a corresponding to the right game controller 1104a-1 and the left game controller 1104a-2 equally at an intensity (1128a-1, 1128a-2) equal to or similar to the intensity 1130 of the virtual environment.

In the example of FIG. 11Y, when the computer system 101 detects the attention of the user (e.g., in relation to the hand of the user 1114, the gaze 1112 of the user, and/or the gaze duration 1129 of the user) increasing with respect to one or more physical objects (e.g., game controller 1104a-1) the computer system 101 reduces the visual effect (e.g., the tint) applied to the representation of the corresponding physical object. For instance, when the computer system detects that the attention has increased toward the right game controller 1104a-1, such as detecting an increase of attention as described herein in reference to FIG. 11G-11W, the computer system reduces the intensity 1128a-1 of the visual effect of the portion 1108a-1 of the virtual content corresponding to the representation of the right game controller 1104a-1, while the intensity 1128a-2 of the visual effect of the portion 1108a-2 corresponding to the representation of the left game controller 1104a-2 remains unchanged and/or equal to the intensity 1130 of the visual effect of the virtual environment. When the computer system reduces the intensity of the visual effect, the reduction of intensity provides increased visibility to the representation of the physical object toward which the attention of the user is directed. For instance, in the case of a night scene tint, the computer system 101 optionally increases the brightness of tint 1124 when reducing the intensity of the tint.

As illustrated in FIG. 11Z, as the gaze duration 1129 as related to the gaze of the user being directed to controller 1104a-1 in FIG. 11Y increases, the computer system further reduces the intensity 1130 of the visual effect of the virtual environment, reduces the intensity 1128a-1 of the visual effect of portion 1108a-1 of the virtual content corresponding to the representation of the right game controller 1104a-1, and reduces the intensity 1128a-2 of the visual effect of portion 1108a-2 of the virtual content corresponding to the representation of the left game controller 1104a-2. As a result, the intensity 1128a-1 of the portion 1108a-1 corresponding to the representation of the right game controller is less than the intensity 1128a-2 of the visual effect of the portion 1108a-2 corresponding to the representation of the left game controller, and less than the intensity 1130 of the visual effect of the virtual environment. When the computer system reduces the visual effect of the portion of the virtual content corresponding with the left game controller 1104a-2 and the environment 1110 in addition to the portion of the virtual content which corresponds with the right game controller 1104a-1, the computer system 101 provides increased visibility of the left game controller 1104a-2 for situations such as when the gaming application 1126 requires input from both gaming controllers 1104a. Additionally or alternatively, the intensity 1128a-2 of the visual effect of the portion 1108a-2 corresponding to the representation of the left game controller is optionally equal to, greater than, or less than the intensity 1130 of the visual effect as applied to the virtual environment.

FIG. 12 is a flowchart illustrating a method of reducing the visual prominence of virtual content that is obscuring visibility of one or more objects based on object type, in accordance with some embodiments. In some embodiments, the method 1200 is performed at a computer system (e.g., computer system 101 in FIG. 1A such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 1200 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1200 are, optionally, combined and/or the order of some operations is, optionally, changed.

In some embodiments, a method 1200 is performed at computer system is in communication with one or more display generation components, and one or more input devices. For example, a computer system, the one or more input devices, and/or the one or more display generation components have one or more characteristics of the computer system(s), the one or more input devices, and/or the one or more display generation components(s) described with reference to FIG. 1-FIG. 2. In some embodiments the computer system is configured to provide a view of a physical environment surrounding a user, however the embodiments discussed herein are not limited thereto. In some embodiments: the computer system, the one or more display generation components, and the one or more input devices share one or more characteristics with the corresponding aspects and/or elements described with respect to methods 800, 1000, 1400, and/or 1600.

In some embodiments, the computer system displays (1202), via the one or more display generation components, first virtual content in a three-dimensional environment, wherein the first virtual content obscures at least a first portion of a representation of a physical environment (e.g., a physical environment, and/or the three-dimensional environment) of a user of the computer system from a viewpoint of the user of the computer system, such as shown in FIG. 11B. In some embodiments, for instance referencing FIG. 11D, displaying the first virtual content (e.g., virtual environment 1110) includes, in accordance with a determination that the first portion (e.g., corresponding to the location of right game controller 1104a-1) of the physical environment includes a first physical object (e.g., right game controller 1104a-1) of a first type of object, displaying (1204) a first portion (e.g., portion 1108a-1) of the first virtual content with a first degree of visual prominence, such as shown corresponding to portion 1108a-1, that enables a representation of the first physical object to be at least partially visible through the first virtual content. In some embodiments, displaying of the first virtual content in the three-dimensional environment, obscuring of the representation of the first physical object by the first virtual content, the first physical object, and/or the viewpoint of the user of the computer system share one or more characteristics with corresponding aspects and/or elements described with respect to methods 800, 1000, 1400, and/or 1600. In some embodiments, the first virtual content shares one or more characteristics with the content window(s) described with respect to methods 1400 and 1600.

The first virtual content is optionally displayed in response to receiving an input from the user corresponding to an indication (e.g., user input) to display the first virtual content and/or in response to a preceding operation, however embodiments discussed herein are not limited thereto. In some embodiments, the first virtual content includes multiple overlapping first virtual content elements (e.g., first window, and second window), which obscure at least a portion of representation of the first physical object, from the viewpoint of the computer system and/or the user of the computer system.

In some embodiments, the first virtual content optionally obscures (e.g., blocks visual access to) and/or obscures at least a portion of the representation of the first physical object within the representation of the physical environment from the viewpoint of the user of the computer system. As described herein, the representation of the first physical object is optionally determined to be obscured if the first virtual content partially or entirely obscures and/or obscures visibility of the representation of the first physical object. When the first virtual content is displayed to obscure the representation of the first physical object, the first virtual content is optionally displayed in a manner simulating that the first virtual content is closer to the viewpoint of the computer system and/or the user of the computer system than the first physical object and/or the representation of the first physical object. The first physical object as discussed in relation to method 1200 optionally includes a virtual object, a virtual object corresponding to a physical object, and/or a physical object.

In some embodiments, the first portion corresponds to the portion of the first virtual content interfering with the visual access to the representation of the first physical object from the viewpoint of the computer system and/or the user of the computer system. The first portion optionally includes a central aspect of the first virtual content, an edge of the first virtual content, a corner of the first virtual content, and/or a portion of the first virtual content therebetween. In reducing the visual prominence of the first portion of the first virtual content by a first amount, the computer system enables the user to view, partially or in whole, the representation of the first physical object which is obscured by the first virtual content. When the first virtual content includes multiple first virtual content elements (e.g., multiple windows), the first portion optionally corresponds to the location of the representation of the first physical object from the viewpoint of the computer system and/or the user of the computer system in relation to the multiple first virtual content elements.

“Visual prominence” as used herein optionally corresponds to levels of visibility of the representation of the first physical object in relation to the first virtual content from the viewpoint of the user. For instance an increased degree of visual prominence of the first virtual content in relation to an object (e.g., representation of the first physical object) obscured by the first virtual content optionally results in an increased level of visibility of the first virtual content relative to the object, and a decreased level of visibility of the object relative to the first virtual content. Additionally or alternatively, a decreased degree of visual prominence of the first virtual content in relation to an object (e.g., representation of the first physical object) optionally results in a decreased level of visibility of the first virtual content relative to the object, and an increased level of visibility of the object relative to the first virtual content. In some embodiments, varying degrees of visual prominence of the first portion provides varying degrees of visibility through the first portion of the first virtual content. The computer system optionally modifies one or more characteristics of the first virtual content and/or an object (e.g., representation of the first physical object) to modify the visibility of the object in relation to the first virtual content. Degrees of visual prominence are optionally modified by for example: modification of transparency of the first virtual content (e.g., the first portion) and/or the object, modification of visual density of the first virtual content and/or the object, modification of a depth of the first virtual content and/or the object relative to the viewpoint of the user, modification of brightness of the first virtual content and/or the object, and/or modification of one or more visual characteristics of the first virtual content and/or the representation of the first physical object including modification of displayed characteristics (e.g., dithering, and/or density).

In some embodiments, changing the visual prominence of some or all of the first virtual content shares one or more characteristics with the changing of visual prominence described with respect to methods 1400 and/or 1600.

As described herein, the first portion of the first virtual content optionally corresponds to the representation of the first physical object when the first portion of the first virtual content interferes with the visual access to the representation of the first physical object from the viewpoint of the user of the computer system. The first portion is optionally shaped according to the shape of the representation of the first physical object (e.g., coffee mug shaped), and/or according to a predetermined shape (e.g., circular, or rectangular). In some embodiments, the first portion is optionally sized according to the perceived size of the representation of the first physical object. Furthermore, the first portion is optionally determined based on the portion of the representation of the first physical object which is obscured by the first virtual content. For instance, when the first virtual content obscures and/or obscures the entirety of the representation of the first physical object, the first portion of the first virtual content optionally corresponds to the entirety of the representation of the first physical object. Additionally or alternatively, for instance, when the first virtual content obscures and/or obscures a half of the representation of the first physical object, the first portion of the first virtual content corresponds to the half of the representation of the first physical object obscured by the first virtual content. While embodiments discussed herein are directed to the reduction of the visual prominence of the first portion that forms a portion of the first virtual content by one or more amounts, embodiments wherein the visual prominence of the entirety of the first virtual content is reduced by one or more amounts in accordance with satisfying one or more criteria (e.g., a portion of the first virtual content occluding the representation of the first physical object) are within the spirit and scope. In some embodiments, the first portion of the first virtual content corresponds to where a vector between the viewpoint of the user and the representation of the first physical object intersects the first virtual content. Additionally or alternatively, the first virtual content optionally comprises multiple portions (e.g., first portion, and/or second portion) which are displayed at reduced visual prominence degrees (e.g., same degree of visual prominence, or different degree of visual prominence) are within the spirit and scope of the present disclosure.

In some embodiments, reducing the visual prominence of the first portion of the first virtual content by the first amount optionally alters (e.g., increases) the visibility of the representation of the first physical object to the user. In some embodiments, the first portion of the first virtual content is displayed without reducing the degree of visual prominence, thus the first virtual content occluding the representation of the first physical object entirely restricts visual access of the representation of the first physical object through the first virtual content (e.g., 0% transparency). Additionally or alternatively, the visual prominence of the first portion of the first virtual content is optionally reduced by a first amount, such that the first portion of the first virtual content partially restricts visual access of the representation of the first physical object through the first virtual content (e.g., 50% transparency). In relation to described levels of transparency in some embodiments, the first portion of the first virtual content having 0% transparency corresponds with a maximum degree of visual prominence (e.g., the first virtual content is opaque), resulting in minimum or no visual access to the representation of the first physical object obscured by the first virtual content. Similarly, a maximum reduction of visual prominence of the first portion of the first virtual content (e.g., 100% transparency, and/or ceasing to display) of the first virtual content corresponds with a minimum level of visibility of the first virtual content (e.g., the first virtual content is no longer visible, and/or no longer displayed), resulting in a lack of visibility of the first portion of the first virtual content, and maximum or full visual access to the representation of the first physical object.

In some embodiments, the computer system determines when the representation of the first physical object which is obscured by the first virtual content corresponds to a first type of object. When the computer system determines that the representation of the first physical object corresponds to a first type of object, the computer system displays the first portion of the first virtual content with a first degree of visual prominence. For instance, when the user is sitting at computer desk, and the computer system determines that a content window obscures an electronic device (e.g., keyboard, mouse, input device, and/or headphones), desktop item (e.g., pen, phone, and/or printer), and/or a commonly used item (e.g., coffee mug, and/or water glass), the computer system optionally displays the first portion of the first virtual content with a first degree of visual prominence to allow increased visibility to the one or more representations of the physical objects.

In some embodiments, the obscuring of the representation of the first physical object is based on an amount of the representation of the first physical object that is not visible from the viewpoint of the user of the computer system due to the first virtual content limiting visual access and/or visibility of the representation of the first physical object. For example, an object (e.g., the first physical object, and/or representation of the first physical object) is optionally determined to be obscured based on first virtual content blocking visual access to a fraction of the representation of the first physical object (e.g., 1/1000 of the representation of the first physical object, 1/500 of the representation of the first physical object, 1/250 of the representation of the first physical object, 1/100 of the representation of the first physical object, 1/50 of the representation of the first physical object, 1/10 of the representation of the first physical object, ¼ of the representation of the first physical object, ½ of the representation of the first physical object, and/or greater than ½ of the representation of the first physical object). In some embodiments the obscuring of the representation of the first physical object is based on physical measurements. For example, an object (e.g., representation of the first physical object) is determined to be obscured based on first virtual content blocking visual access to a fraction of a millimeter, 0.5 mm, 1 mm, 2 mm, 5 mm, 10 mm, 50 mm, 1 meter, and/or greater than 1 meter of the object. In some embodiments, the obscuring of the representation of the first physical object by first virtual content partially blocks visual access to the representation of the first physical object such that a portion of the representation of the first physical object is obscured by first virtual content, and a portion of the representation of the first physical object is not blocked by first virtual content. Additionally or alternatively, the obscuring of the representation of the first physical object by first virtual content completely blocks visual access to the representation of the first physical object such that no part of the representation of the first physical object is visible from the viewpoint of the user.

In some embodiments, while the computer system displays first virtual content, the computer system detects a change in attention of the user (1206), such as the hand 1114 of the user reaching toward the right game controller 1104a-1 as shown in FIG. 11E. (e.g., a change in a portion of the three-dimensional environment to which the attention of the user is directed, optionally including detecting movement of the attention of the user).

In some embodiments, in response to detecting the change in attention of the user (1208), in accordance with a determination that the attention of the user is directed toward the representation of the first physical object (e.g., right game controller 1104a-1 in FIG. 11E) in the three-dimensional environment, the computer system reduces (1210) the visual prominence of the first portion of first virtual content from the first degree of visual prominence to a second degree of visual prominence, such as shown corresponding game controller 1104a-1, that is lower than the first degree of visual prominence to increase a visibility of the representation of the first physical object. In some embodiments, when a computer system determines that the attention of the user changes (e.g., increases) in relation to the representation of first physical object which is obscured by the first virtual content, the computer system reduces the visual prominence (e.g., transparency, color, shape, size, opacity, brightness, and/or color saturation) of the first portion of the first virtual content by a first amount wherein the first portion of the first virtual content optionally corresponds to the representation of the first physical object. In some embodiments, reducing the visual prominence of the first portion by a first amount corresponds to displaying the first portion of the first virtual content according to a first degree of visual prominence. Reducing the first portion of the first virtual content by a first amount results in providing increased visibility of the representation of the first physical object which has been obscured.

In some embodiments, the attention of the user includes the gaze of the user directed toward the first physical object and/or the representation of the first physical object. In some embodiments, the attention of the user includes one or more fingers of the hand of the user pointing towards the first physical object.

In some embodiments, in response to detecting that the attention of the user is directed toward the first physical object and/or the representation of the first physical object, further reducing the visual prominence of the first portion of the first virtual content by a second amount relative to the three-dimensional environment (optionally so as to further increase the visibility of the representation of the first physical object through the first portion of the first virtual content from the viewpoint of the user).

In some embodiments, when the computer system detects that the user's attention is directed toward the first physical object and/or the representation of the first physical object (e.g., gaze, hand moving toward the first physical object, and/or user input via input device) the computer system further reduces the visual prominence of the first portion of the first virtual content by a second amount. The second amount by which the computer system reduces the visual prominence of the first portion of the first virtual content is optionally lower than, more than, or equal to the first amount.

In some embodiments, reducing the visual prominence of the first portion by a second amount corresponds to displaying the first portion of the first virtual content according to a second degree of visual prominence, lower than the first degree of visual prominence. For instance, while the first portion of the first virtual content is displayed according to a visual prominence reduced by a first amount (e.g., 25% transparency), when the computer system determines that the user's gaze is directed toward the first physical object and/or the representation of the first physical object, the computer system updates the first portion of the first virtual content to reduce the visual prominence by a second amount (e.g., 75% transparency), thereby providing increased visibility of the representation of the first physical object to the user. Additionally or alternatively, in some embodiments while the visual prominence of the first portion of the first virtual content reduced by a first amount (e.g., 25% transparency), when the computer system determines that one or more portions of a user are moving toward (and/or pointing toward) the first physical object and/or the representation of the first physical object, the computer system updates the visual prominence of the first portion of the first virtual content to be reduced by a second amount (e.g., 75% transparency), thereby further increasing visibility of the representation of the first physical object to the user. In some embodiments, the application of one or more degrees of visual prominence is performed gradually over a first period of time (e.g., 0.1 seconds, 0.5 seconds, 1 second, or greater than 1 second). Additionally or alternatively, in some embodiments the application of one or more degrees of visual prominence is performed instantaneously or within a second period time (e.g., less than 0.1 seconds, less than 0.05 seconds, or less than 0.001 seconds).

In some embodiments, while the visual prominence of the first portion of the first virtual content is reduced by a first amount, (e.g., 25% transparency), such as in response to determining that the attention of the user changes in relation to the representation of the first physical object changes (e.g., increases) the first virtual content obscures and/or obscures the representation of the first physical object from the viewpoint of the user, when the computer system determines that the attention of the user is not directed toward the first physical object (and/or the representation of the first physical object) and/or is directed away from the first physical object (and/or the representation of the first physical object), the computer system optionally forgoes reducing the visual prominence of the first virtual content. Additionally or alternatively, while the attention of the user is directed at the first physical object and/or the representation of the first physical object, and the visual prominence of the first portion of the first virtual content is reduced by a second amount, when the attention of the user ceases to be directed at the first physical object and/or the first portion of the first virtual content corresponding to the representation of the first physical object, the computer system reverts to the reduction of the visual prominence of the first portion of the first virtual content by the first amount, such that the visual access to the first access is decreased.

Modifying (e.g., increasing and/or reducing) the visual prominence of the first virtual content (e.g., a first portion of the first virtual content, multiple portions of the first virtual content, and/or the entirety of the first virtual content) allows the computer system to provide increased or decreased visual access to objects (e.g., first physical object, and/or the representation of the first physical object) which are obscured by the first virtual content, and allows a user to view and/or interact with obscured objects without requiring further user inputs to modify (e.g., move, minimize, and/or rescale) the first virtual content. By displaying the first portion of the first virtual content with a first degree of visual prominence when the first representation of the first physical object corresponds with a first type of object, the computer system optionally provides at least partial visual access one or more physical objects within their physical environment. In providing the partial visual access to the one or more first representation of the first physical objects, the user is aware of and/or able to direct their attention toward the one or more representation of the first physical objects for increased visual access (e.g., reduction of the visual prominence of the first portion of the first virtual content).

In some embodiments displaying the first virtual content includes, in accordance with a determination that the first portion of the representation of the physical environment does not include the first physical object of the first type of object, displaying, via the one or more display generation components, the first portion of the first virtual content with a third degree of visual prominence that is higher than the first degree of visual prominence, such as shown for instance in FIG. 11O where the representation of the bowl of snacks 1106c is not visible, representing that the portion of the virtual content is displayed with a third degree of visual prominence (e.g., full visual prominence), which is a higher than the first degree of visual prominence. In some embodiments, when the computer system detects that the first portion of the physical environment does not include a first physical object corresponding to the first type of object, the computer system displays the first portion of the first virtual content with a third degree of visual prominence to enable increased visibility of the first portion of the first virtual content (e.g., and thus reducing the visual prominence of the first physical object). The third degree of visual prominence optionally corresponds to full display (e.g., 0% transparency) of the first virtual content. For instance, when a virtual content window displaying a video obscures at least a portion of the representation of the physical environment, and the physical environment does not include a physical object which is relevant to the user and/or the context of the video, the computer system displays the first virtual content with a third degree of visual prominence. By displaying the first virtual content with a third degree of visual prominence, greater than the first degree of visual prominence, the computer system avoids revealing distracting elements which are within the representation of the physical environment which enables the focus of the user to remain on first virtual content.

In some embodiments, displaying the first virtual content includes, in accordance with a determination that a second portion of the representation of the physical environment includes a second physical object of the first type of object, displaying, via the one or more display generation components, a second portion of the first virtual content with the first degree of visual prominence that enables a representation of the second physical object to be at least partially visible through the first virtual content, such as shown in FIG. 11D for instance, wherein both a first portion 1108a-1 corresponding to a right game controller 1104a-1 and a second portion 1108a-2 corresponding to a left game controller are displayed with a first degree of visual prominence. In some embodiments, when the electronic device determines that the first virtual content displayed obscures a representation of a second physical object which corresponds to the first type of object, the computer system displays a second portion of the first virtual content with the first degree of visual prominence to allow increased visibility of the representation of the second physical object. The display of the second portion of the first virtual content with the first degree of visual prominence is optionally performed simultaneously with and/or subsequent to the display of the first portion of the first virtual content with the first degree of visual prominence. For instance, when a computer system determines that the desktop of a user obscured by a virtual content window includes a keyboard which corresponds to a first type of object (e.g., commonly used), and the desktop further includes a coffee mug which also corresponds to the first type of object (e.g., commonly used), the computer system displays the first portion of the first virtual content and the second portion of the first virtual content with the first degree of visual prominence. In some embodiments, the first portion and the second portion of the first virtual content are independent of each other and/or intersect. Additionally or alternatively, the first portion and the second portion of the first virtual content optionally intersect and/or overlap each other. In some embodiments the second portion, and the reduction of visual prominence of the second portion shares one or more characteristics with the first portion, and the reduction of the first portion described herein. In some embodiments, when the computer system determines that the attention of the user is directed to (e.g., gaze directed toward, and/or hand of the user reaching toward) the representation of the second physical object, the computer system optionally reduces the visual prominence of the second portion of the first virtual content corresponding to the second physical object. When the computer system detects that a second object corresponds to the first type of object, the computer system optionally reduces the visual prominence of the second portion of the first virtual content, corresponding with the location of the representation of the second physical object, to increase the visual access to the representation of the second physical object. Additionally or alternatively, when the computer system reduces the visual prominence of the second portion of the first virtual content, the computer system optionally increases the visual prominence of the first portion. By displaying a first portion of the first virtual content and a second portion of the first virtual content, respectively corresponding with representation of the physical objects of a first type, with a first degree of visual prominence, the computer system provides visual access to multiple types of object simultaneously. The simultaneous visual access provided through the first virtual content allows the user to see multiple objects corresponding to potential objects of interest which they have access to within their physical environment.

In some embodiments, such as shown in FIG. 11J for instance, in response to detecting the change in attention of the user (e.g., gaze 1112), in accordance with a determination that the attention of the user is not directed toward the representation of the first physical object, the computer system forgoes reducing the visual prominence of the first portion (e.g., such as the portion corresponding to the right game controller 1104a-1) of the first virtual content from the first degree of visual prominence to the second degree of visual prominence (e.g., maintaining or increasing the degree of visual prominence of the first portion of the first virtual content). In some embodiments, when the computer system detects the attention of the user changes, and further detects that the attention is directed to a location that does not correspond to the representation of the first physical object, indicating that the user's attention is not directed at the representation of the first physical object the computer system optionally forgoes reducing the visual prominence of the first portion of the first virtual content. Furthermore, when the user's attention is directed toward a representation of the second physical object and/or an alternate portion of the first virtual content, the computer system optionally increases the visual prominence of the first portion of the first virtual content corresponding to the representation of the first physical object. After the computer system increases the visual prominence of the first portion of the first virtual content due to the attention of the user being directed away from the representation of the first physical object, when the computer system subsequently detects the attention of the user is directed toward the representation of the first physical object, the computer system optionally reduces the visual prominence of the first portion of the first virtual content from the first degree of visual prominence to the second degree of visual prominence. By forgoing reducing the visual prominence of the first portion of the first virtual content when the attention of the user is not directed toward the representation of the first physical object, the computer system prevents distracting the user by presenting and/or increasing visual access to one or more objects which are not of interest to the user, and avoids unnecessarily disrupting the interaction with the content by the user.

In some embodiments, detecting the change in the attention of the user includes detecting, via the one or more input devices, that a location of a gaze of the user in the three-dimensional environment has changed, such as shown for instance in FIG. 11H wherein the gaze 1112 of the user is directed to game controller 1104a-1 for longer than a first gaze threshold time 1116a. In some embodiments, the computer system detects the attention of the user by detecting a location where the location of the gaze of the user is directed in relation to the three-dimensional environment and/or when the location of the gaze changes. When the computer system detects that gaze of the user changes (e.g., the location in the three-dimensional environment where the first object is located), the computer system optionally determines that the attention of the user has changed (e.g., increased) and accordingly reduces the visual prominence of the first portion of the first virtual content. The first location and the second location optionally include locations corresponding to a two-dimensional plane, and/or a three-dimensional portion within the three-dimensional environment (e.g., the location of the gaze includes a depth parameter). In some embodiments the computer system detects the location of the gaze of the user corresponding to the first virtual content, the three-dimensional environment, and/or a representation of the first physical object. In some embodiments the first location corresponds to the representation of the first physical object, and/or the representation of the second physical object. When the computer system detects the change in the location of the gaze of the user and/or where the gaze of the user is directed (e.g., a first location) within the three-dimensional environment, the computer system allows the user to optionally provide further visual access to one or more objects (e.g., representation of the first physical object) simply by directing their gaze toward it.

In some embodiments, detecting the change in the attention of the user includes detecting, via the one or more input devices, that a first hand of the user is moving toward a first location in the three-dimensional environment corresponding to the first physical object, such as shown for instance in FIG. 11H. In some embodiments, detecting changes in the attention of the user includes detecting movements as related to a hand of the user. When the computer system detects the first hand of the user is directed toward the first location (e.g., a moving toward the first physical object), the computer system optionally determines that the attention of the user changes (e.g., increases) with respect to first location. Accordingly, the computer system optionally reduces the visual prominence of the first portion of the first virtual content in accordance with a determination that the first location corresponds to the location of the three-dimensional environment corresponding to the first object. Detecting the movement of the first hand of the user in relation to the representation of the first physical object within the three-dimensional environment optionally corresponds to the movements of the first hand of the user in the real physical world, and/or movements of the representation of the first hand of the user toward the first location. In some embodiments the first location corresponds to the representation of the first physical object, and/or the representation of the second physical object. When the attention of the user includes the first hand of the user moving toward the first location (e.g., toward the representation of the first physical object) within the three-dimensional environment, the computer system allows the user to optionally provide further visual access to one or more objects (e.g., representation of the first physical object) simply by moving their hand toward it.

In some embodiments, in response to detecting the first hand of the user moving toward the first location, in accordance with a determination that a gaze of the user is directed toward the representation of the first physical object, the computer system reduces the visual prominence of the first portion of the first virtual content from the first degree of visual prominence to the second degree of visual prominence, such as shown in FIG. 11H wherein the hand of the user 1114 is detected as being closer in relation to the right game controller 1104a-1 as compared with the location of the hand of the user 1114 previously shown in FIG. 11G, resulting in the computer system displaying the game controller with a reduced degree (e.g., second degree) of visual prominence as shown in FIG. 11H. When the computer system determines that the first hand of the user is moving toward the first physical object, the computer system optionally reduces the visual prominence of the first portion of the first virtual content only when the gaze of the user is detected as being directed toward the representation of the first physical object. For instance, when the computer system detects that the user reaches for a coffee mug while looking at the coffee mug, the computer system optionally reduces the visual prominence of the first portion of the first virtual content to the second degree of visual prominence to provide increased visual access the coffee mug.

In some embodiments, in response to detecting the first hand of the user moving toward the first location, in accordance with a determination that the gaze of the user is directed away from the representation of the first physical object, the computer system forgoes reducing the visual prominence of the first portion of the first virtual content from the first degree of visual prominence to the second degree of visual prominence, such as shown in FIG. 11J wherein the computer system 101 in response to detecting the gaze 1112 of the user move away from the right game controller 1104a-1, while the hand 1114 is directed toward the right game controller, the css increases the visual prominence of portion of the virtual environment corresponding to right game controller 1104a-1 to the first degree of visual prominence from the second degree of visual prominence as shown in FIG. 11I for example. When the computer system determines that the first hand of the user is moving toward the first physical object, but the gaze of the user is not detected as being directed toward the representation of the first physical object, the computer system optionally forgoes reducing the visual prominence of the first portion of the first virtual content from the first degree of visual prominence to the second degree of visual prominence. For instance, when the computer system detects the user's hand is moving toward a coffee mug while the user is looking at a representation of a computer mouse, the computer system optionally does not reduce the visual prominence of the first portion of the first virtual content corresponding to the coffee mug. Additionally or alternatively, while the visual prominence of the first portion of the first virtual content is reduced to the second degree of visual prominence, and the computer system detects the gaze of the user change such that the gaze of the user is no longer directed toward the representation of the first physical object, the computer system optionally increases the visual prominence of the first portion of the first virtual content to the first degree of visual prominence. By forgoing reducing the visual prominence of the first portion of the first virtual content when the gaze of the user is not directed toward the representation of the first physical object, the computer system prevents distracting the user by presenting and/or increasing visual access to one or more objects which are not of interest to the user.

In some embodiments, while displaying the first portion of the first virtual content according to the second degree of visual prominence, the computer system detects, via the one or more input devices, that an attention level of the user directed toward the representation of the first physical object has increased from the first level to a second level, such as displayed in FIG. 11H with respect to detecting the gaze of the user 1112 and the hand 1114 of the user directed to the right game controller 1104a-1, wherein the visual prominence portion of the virtual content corresponding to the location of the representation of the right game controller is reduced to a second degree of visual prominence. In some embodiments, while the computer system is displaying the first portion of the first virtual content according to the second degree of visual prominence according to the attention of the user being directed toward the first representation of the first physical object, the computer system optionally detects the attention of the user increasing from a first level of attention (e.g., gaze directed toward the first representation of the first physical object) to a second level of attention (e.g., first hand of the user reaches toward the representation of the first physical object).

In some embodiments, while displaying the first portion of the first virtual content according to the second degree of visual prominence (such as shown in FIG. 11H), in response to detecting that the attention level of the user directed toward the representation of the first physical object has increased from the first level to a second level (now referencing FIG. 11I), greater than the first level due to the computer system detecting the hand 1114 of the user is touching the right game controller 1104a-1, the computer system reduces the visual prominence of the first portion of the user interface to a third degree of visual prominence, lower than the second degree of visual prominence, such as shown in FIG. 11I in reference to the portion of the virtual content corresponding to the location of the representation of the game controller. When the computer system detects that the attention of the user increases from the first level of attention to the second level of attention, the computer system optionally reduces the visual prominence of the first portion of the first virtual content further from the second degree of visual prominence to a third degree of visual prominence. In certain embodiments the third degree of visual prominence is different than (e.g., lower than) the second degree of visual prominence, providing increased visual access to the representation of the first physical object. For instance, when the first portion of the first virtual content corresponds to a coffee mug, and the coffee mug is a first type of object, the computer system optionally displays the first portion with a first degree of visual prominence (e.g., 10% transparency). When the gaze of the user is detected as directed toward the coffee mug, the attention of the user is optionally determined to be at a first level of attention, and the computer system reduces the visual prominence of the first portion of the first virtual content to the second degree of visual prominence (e.g., 25% transparency). When the first hand of the user is detected as reaching toward the coffee mug in addition to the gaze of the user being directed toward the coffee mug, the attention of the user is optionally determined to be the second level of attention, and the computer system optionally further reduces the first portion of the first virtual content to a third degree of visual prominence (e.g., 50% transparency). Accordingly, as the attention of the user increases toward the representation of the first physical object, the computer system increases the visual access to the representation of the first physical object. By increasing reducing the visual prominence of the first portion of the first virtual content as the attention of the user increases with respect to the representation of the first physical object, the computer system enables a user to have increased visual access to physical objects and/or representations of physical objects without requiring additional inputs from the user aside from directing their attention toward the objects.

In some embodiments, detecting, via the one or more input devices, that an attention level of the user directed toward the representation of the first physical object is the first level of attention includes detecting that a gaze of the user has been directed toward the representation of the first physical object for a first duration, such as shown in FIG. 11H wherein the gaze 1112 is detected as being directed to the right game controller 1104a-1 for longer than the first gaze threshold time 1116a, and in response the computer system reduces the visual prominence of the portion of the virtual environment corresponding to the representation of the right game controller 1104a-1 from the first degree of visual prominence (e.g., as shown in FIG. 11G) to a second degree of visual prominence (e.g., as shown in FIG. 11H), for instance (e.g., without determining that the gaze of the user has been directed toward the representation of the first physical object for more than a second duration). In some embodiments, the level of attention of the user is determined by the duration that the gaze of the user is detected as being directed toward the representation of the first physical object. In some embodiments, when the computer system determines that the gaze of the user has been directed toward the representation of the first physical object for a first duration (e.g., exceeding a first gaze threshold time period), the computer system determines that the attention of the user directed toward the representation of the first physical object is at the first level of attention. A first gaze threshold time period optionally includes a time period including: 0.1 seconds, 0.5 seconds, 1 second, or greater than 1 second. Upon determining that the attention of the user is at a first level, the computer system optionally reduces the visual prominence of the first portion of the first virtual content to provide increased visual access to the representation of the first physical object. In some embodiments reducing the visual prominence of the first portion of the first virtual content includes reducing the visual prominence of the first portion from the first degree of visual prominence to the second degree of visual prominence.

In some embodiments, detecting, via the one or more input devices, that an attention level of the user directed toward the representation of the first physical object is the second level of attention includes detecting that the gaze of the user has been directed toward the representation of the first physical object for a second duration, longer than the first duration, such as shown in FIG. 11I for instance wherein the gaze 1112 of the user is detected as directed to the representation of the right game controller 1104a-1 for longer than the second gaze threshold time 1116b, and in response the computer system reduces the visual prominence of the portion of the virtual environment corresponding to the representation of the right game controller 1104a-1 from the second degree of visual prominence (e.g., as shown in FIG. 11H) to a third degree of visual prominence (e.g., as shown in FIG. 11I). When the computer system determines that the gaze of the user has been directed toward the representation of the first physical object for a second duration (e.g., exceeding a second gaze threshold time period), longer than the first gaze threshold time period, the computer system optionally determines the attention of the user directed toward the representation of the first physical object to be the second level of attention. A second gaze threshold time period optionally includes a time period including: 0.2 seconds, 0.75 seconds, 1.5 seconds, or greater than 1 second. When the computer system determines that the attention of the user is at a second level of attention, the computer system optionally further reduces the visual prominence of the first portion from the second degree of visual prominence to the third degree of visual prominence, thus providing increased visual access to the representation of the first physical object. By detecting a first level of attention and a second level of attention based on the length of time which the gaze of the user is directed toward the representation of the first physical object, the computer system allows a user to increase visual access to an object or representation of an object through only the use of their gaze, and without requiring further actions (e.g., hand movements, active input via a connection input device).

In some embodiments, detecting, via the one or more input devices, that an attention level of the user directed toward the representation of the first physical object is the first level of attention includes detecting that a movement of a first hand of the user toward the first physical object meets a first threshold (e.g., within a first threshold distance of the physical object, and without determining that the hand of the user meets a second threshold. In some embodiments, when the computer system determines that the first hand of the user is within a first threshold distance the computer system determines that the attention of the user is at the first level of attention. In some embodiments the threshold distances are measured in virtual distance units (e.g., pixels) as related to a distance the one or more portions of the user (e.g., representation of the hand of the user) is from the representation of the first physical object in the three-dimensional environment. In some embodiments the first threshold includes virtual distances of: 25 pixels, 50 pixels, or 100 pixels. In some embodiments the threshold distances are measured in physical distance units (e.g. mm, cm, and/or m) as related to a distance the one or more portions of the user moves in a physical environment. In some embodiments the first threshold includes physical distances of: 25 cm, 50 cm, or 1 m. When the first hand of a user is detected as moving toward the representation of the first physical object in excess of the first movement threshold time period, the computer system determines that the attention of the user is at the first level of attention. In some embodiments, the first movement threshold time period shares one or more characteristics with the first gaze threshold time period, and/or the second gaze threshold time period as described herein.

In some embodiments, detecting, via the one or more input devices, that an attention level of the user directed toward the representation of the first physical object is the second level of attention includes detecting that the movement of the first hand of the user toward the first physical object meets a second threshold (e.g., within a second threshold distance of the physical object, less than the first threshold distance), less than the first threshold, such as shown in FIG. 11I for instance wherein the hand of the user 1114 is detected as touching the right game controller 1104a-1 representing a second level of attention, in contrast to when the hand of the user is detected as being near (e.g., not touching) to the right game controller in FIG. 11H representing a first level of attention. In some embodiments, when the computer system determines that the first hand of the user is within a second threshold distance, the computer system determines that the attention of the user is at the second level of attention. In some embodiments the first threshold includes virtual distances of: touching, near touching (e.g., less than 1 pixel), 5 pixels, 10 pixels, 20 pixels, or 50 pixels. In some embodiments the first threshold includes physical distances of: touching, near touching (e.g., under 5 mm), 1 cm, 5, cm, or 15 cm, or 50 cm. When the first hand of a user is detected as moving toward the first physical object exceeding of the second movement threshold time period, the computer system optionally determines that the attention of the user is at the second level. In some embodiments, the second movement threshold time period shares one or more characteristics with the first gaze threshold time period, and/or the second gaze threshold time period as described herein. For instance, when the computer system determines that the first hand of the user is moving toward and/or directed toward the first physical object exceeding of the first movement threshold time period, the computer system optionally reduces the visual prominence of the first portion of the first virtual content to the second degree of visual prominence to provide increased visual access to the of the first physical object. Furthermore, when the computer system determines that the first hand of the user is moving toward and/or directed toward the first physical object in excess of the second movement threshold time period, the computer system optionally further reduces the visual prominence of the first portion of the first virtual content to the third degree of visual prominence to provide further increased visual access to the first physical object. In some embodiments the first threshold and the second threshold as related to the movement of the movement of the first hand of the user in relation to the representation of the first physical object corresponds to a threshold distance (e.g., first threshold distance, and/or second threshold distance).

Additionally or alternatively, when the one or more portions of the user (e.g., the first hand of the user) is detected as having moved toward the first physical object or the representation of the first physical object by a first amount, the computer system determines that the attention of the user is at the first level of attention (optionally independently of, or without consideration of, any threshold amount of movement). When the first hand of the user is detected as having moved toward the first physical object or the representation of the first physical object by a second amount, greater than the first amount, the computer system determines that the attention of the user is at the second level of attention (optionally independently of, or without consideration of, any threshold amount of movement). By reducing the visual prominence of the first portion of the first virtual content in accordance with the first hand of the user exceeding the first movement threshold time period, and/or the second movement threshold time period, the computer system provides the user with increased visual access to the first physical object through detection of the movements of the first hand and without requiring further actions (e.g., active input via a connection input device).

In some embodiments, detecting, via the one or more input devices, that an attention level of the user directed toward the representation of the first physical object is the first level of attention includes detecting that the first hand of the user is in physical contact with the first physical object, such as shown in FIG. 11I, wherein the computer system 101 reduced the visual prominence (e.g., as compared with the visual prominence displayed in FIG. 11H) of the portion of the virtual environment 1110 corresponding to the representation of the right game controller 1104a-1 in response to the hand 1114 of the user touching the right game controller wherein the hand of the user 1114 makes contact with controller 1104a-1 for instance (e.g., without determining that the first hand of the user is holding the first physical object). In some embodiments, determining the attention level of the user is based on a level of physical contact between the first hand of the user and the first physical object (e.g., real world contact). For instance, when the computer system determines that the first hand of the user is in physical contact with the first physical object, the computer system determines that the attention level of the user is at the first level of attention. Additionally or alternatively, the computer system optionally determines that the attention of the user is at the first level when the representation of the first hand is determined to be in virtual contact with the representation of the first physical object in a virtual three-dimensional environment.

In some embodiments, detecting, via the one or more input devices, that an attention level of the user directed toward the representation of the first physical object is the second level of attention includes detecting that the first hand of the user is holding the first physical object, such as shown in FIG. 11M, wherein hand 1114 is holding the right game controller 1104a-1 and in response the computer system 101 has further reduced the visual prominence (as compared with FIG. 11L) of the portion of the virtual environment corresponding to the right game controller for instance. In some embodiments, when the computer system determines that the first hand of the user is holding the first physical object, the computer system determines that the attention level of the user is at the second level of attention. For instance, while the first portion of the first virtual content is displayed with a first degree of visual prominence, when the computer system determines that the first hand of the user is in physical contact with the first physical object, the computer system optionally reduces the visual prominence of the first portion of the first virtual content from the first degree of visual prominence to the second degree of visual prominence. Furthermore, when the computer system determines that the first hand of the user is in physical contact with the first physical object, the computer system optionally further reduces the visual prominence of the first portion of the first virtual content from the second degree of visual prominence to the third degree of visual prominence. In some embodiments, the computer system optionally reduces the visual prominence of the first portion of the first virtual content from the first degree of visual prominence to the third degree of visual prominence, and forgoing reducing the visual prominence of the first portion of the first virtual content. Additionally or alternatively, the computer system optionally determines the attention of the user is at the second level of attention when the representation of the first hand of the user is determined to be holding the representation of the first physical object. By reducing the visual prominence of the first portion of the first virtual content in accordance with the first hand of the user having physical contact with and/or holding the first physical object, the computer system provides the user with increased visual access to the representation of the first physical object through interaction(s) of the hand with the first physical object and without requiring further actions from the user (e.g., active input via a connection input device).

In some embodiments the computer system detects, via the one or more input devices, that the first physical object has been picked up by one or more portions of the user (e.g., first hand, and/or second hand). In some embodiments, in response to detecting that the first physical object has been picked up by the one or more portions of the user, the computer system reduces the visual prominence of the first portion of the first virtual content to a third degree of visual prominence, lower than the second degree of visual prominence, to increase the visibility of the representation of the first physical object, such as shown in FIG. 11M for instance wherein the visual prominence or the portion of the virtual environment corresponding to the location of the representation of the right game controller 1104a-1 is displayed at the same level of visual prominence as the representation of the hand 1114 of the user. In some embodiments, reducing the visual prominence of the first portion of the first virtual content to a third degree of visual prominence is independent of the attention of the user being directed toward the representation of the first physical object (e.g., independent of whether or not gaze is directed toward the representation of the first physical object and/or how long gaze has been directed toward the representation of the physical object). In some embodiments, when the computer system detects that the first physical object is picked up and/or held by one or more portions of the user, the computer system further reduces the first portion of the first virtual content to a third degree of visual prominence, which is lower than the second degree of visual prominence, to provide increased visual access to the representation of the first physical object. In some embodiments the third degree of visual prominence corresponds to displaying the first portion of the first virtual content with 100% transparency, wherein the first portion of the visual prominence is not visible to the user. The third degree of visual prominence optionally corresponds to a fourth degree of visual prominence of portions of the first virtual content which corresponds to (e.g., is the same as) the location of the representation(s) of the one or more portions of the user (e.g., hand(s) of the user). For instance, when one or more hands of the user are detected within the viewport of the computer system, the computer system optionally reduces the portion corresponding to the location of the representation of the hands of the user to a fourth degree of visual prominence (e.g., 100% transparency) to provide increased visual access to the representation of the hands of the user in relation to the three-dimensional environment. Accordingly, the computer system optionally displays the first physical object, when held and/or picked up by the one or more hands of the user, with the third degree of visual prominence, optionally the same as the fourth degree of visual prominence (e.g., 100% transparency). Additionally or alternatively, the computer system optionally reduces the visual prominence of the first portion of the first virtual content to the fourth degree of visual prominence, when the first physical object is not held and/or picked up by the hand of the user. In some embodiments, when the computer system detects that the first physical object is held and/or picked up by the one or more portions of the user, the computer system updates the shape of the first portion of the first virtual content from a predetermined shape (e.g., ellipse, circle, or rectangle) to a shape that corresponds to a shape of the physical object. For instance, while a game controller is visible at a first degree of visual prominence, the first portion of the first virtual content optionally has an oval shape configured to reveal most or all of the game controller. When the computer system determines that the game controller is picked up by the hand of the user, the computer system reduces the visual prominence of the first portion of the first virtual content corresponding to the location of the representation of the game controller to the third degree of visual prominence, and updates the shape of the first portion of the first virtual content to mimic the shape of the game controller from the viewpoint of the user. In some embodiments, reducing the visual prominence of the first portion of the first virtual content in response to the computer system detecting that the first physical object has been picked up by the user shares one or more characteristics described with respect to reducing the visual prominence of a portion of the first virtual content corresponding to a representation of a physical object in methods 1400 and/or 1600.

In some embodiments, the response to detecting that the physical object is picked up and/or held by the one or more portions of the user, the computer system ceases to display the first portion of the first virtual content to provide increased visual access to the representation of the first physical object.

In some embodiments, when the computer system detects that first physical object is picked up and/or held by one or more portions of the user (e.g., first hand, second hand, representation of the first hand, and/or representation of the second hand), the computer system displays the first portion of the first virtual content in a manner to increase, and/or maximize, the visual access to the representation of the first physical object. For instance, when the computer system detects that the first physical object is picked up and/or held by the user, the computer system optionally displays the first portion of the first virtual content in a manner which simulates and/or is perceived that the first portion of the first virtual content is located behind the representation of the first physical object. In some embodiments, to simulate that the first portion of the first virtual content is located behind the representation of the first physical object, the computer system ceases to display the first portion of the first virtual content. In some embodiments, when the computer system detects that the one or more portions of the user have picked up and/or held the first physical object, the computer system displays the entirety of the first virtual content in a manner which simulates moving the first virtual content away from a location corresponding to the user, and behind the representation of the first physical object. By reducing the visual prominence of the first portion of the first virtual content to a third degree when the first physical object is picked up and/or held by the one or more portions of the user, the computer system provides increased visual access to the representation of the first physical object without further input from the user.

In some embodiments, the first type of object is an input controller (e.g., a hardware control that is separate from the computer system and/or separate from a head mounted display or other display generation component). In some embodiments, the first type of object includes an input controller (e.g., mouse, keyboard, and/or game controller, electronic device which is communicatively connected to the computer system), such as shown in FIG. 11H wherein the game controllers 1104a, the mouse 1104b, and the keyboard 1104c are each examples of input controllers. When the computer system determines that the first physical object is an input controller, the computer system optionally displays the first portion of the first virtual content with the first degree of visual prominence in accordance with the input controller corresponding to the first type of object. By displaying the first portion of the first virtual content at a first degree of visual prominence when the first physical object corresponds with an input controller, the user is optionally provided increased visual access to the input controller without requiring a request and/or active input from the user.

In some embodiments, the input controller is communicatively coupled to the computer system, such as input devices in FIG. 11H were communicatively connected with the computer system. In some embodiments, when the input controller is communicatively coupled to the computer system such as through wired and/or wireless communication protocols (e.g., BLUETOOTH, WI-FI, and/or another wireless communication protocol). When the computer system determines that the first physical object is an input controller which is connected to the computer system, the computer system optionally displays the first portion of the first virtual content with the first degree of visual prominence. In some embodiments, the computer system reduces the visual prominence of the first portion of the first virtual content subsequent to when the input controller is communicatively connected with the computer system. Additionally or alternatively, the computer system optionally reduces the visual prominence of the first portion of the first virtual content in response to the input controller communicatively connecting with the computer system. In some embodiments, the computer system determines that the first physical object and/or the representation of the first physical object does not correspond to the first type of object when the first physical object is not communicatively connected with the computer system. By displaying the first portion of the first virtual content at a first degree of visual prominence when the first physical object corresponds with an input controller, the user is optionally provided increased visual access to the input controller without a user request or user input.

In some embodiments the first type of object is a trackpad, such as if the mouse 1104b in FIG. 11H were a trackpad, and the gaze 1112 of the user were directed toward the representation of the trackpad. In some embodiments, the first type of object includes a trackpad. A “trackpad” as used herein optionally corresponds to an input device which is configured to be communicatively connected with the computer system which includes a surface configured to receive touch inputs (e.g., one or more portions of the user, and/or stylus) corresponding to motion, selection, and/or other inputs (e.g., left click, right click, middle click, drag, resize, swipe, and/or multi-finger gestures). When the computer system determines that the first physical object is trackpad, the computer system optionally displays the first portion of the first virtual content with the first degree of visual prominence to provide increased visual access to the trackpad for the user. By displaying the first portion of the first virtual content at a first degree of visual prominence when the first physical object is a trackpad, the user is optionally provided increased visual access to the trackpad without requiring a request and/or active input from the user.

In some embodiments, the first type of object is a keyboard, such as keyboard 1104c in FIG. 11H, as if the gaze 1112 of the user were directed toward the representation of the keyboard. In some embodiments, the first type of object includes a keyboard. When the computer system determines that the first physical object is a keyboard, the computer system optionally displays the first portion of the first virtual content with the first degree of visual prominence to provide increased visual access to the keyboard for the user. In some embodiments the keyboard includes one or more touch-sensitive keys and/or mechanical keys for providing one or more user inputs. By displaying the first portion of the first virtual content at a first degree of visual prominence when the first physical object is a keyboard, the user is optionally provided increased visual access to the trackpad without requiring a request and/or active input from the user.

In some embodiments, the first type of object is a handheld controller, such as illustrated in FIG. 11H (e.g., game controller, and/or stylus). When the computer system determines that the input controller is a handheld controller, the computer system optionally displays the first portion of the first virtual content with the first degree of visual prominence to provide increased visual access to the handheld controller for the user. A “handheld controller” as described herein optionally corresponds to an input controller configured to be held and/or picked up by one or more hands of the user. Furthermore, a handheld controller optionally corresponds to an input controller ergonomically configured to conform to a user's hand and/or fingers. In certain embodiments, a handheld controller corresponds to a game controller configured to be held with two hands, a stylus, a mouse, and/or a trackball. By displaying the first portion of the first virtual content at a first degree of visual prominence when the first physical object is a handheld controller, the user is optionally provided increased visual access to the handheld controller without requiring a request and/or active input from the user.

In some embodiments the first physical object is an input device, and while displaying the first portion of the first virtual content at the second degree of visual prominence, the computer system detects that the input device is part of an active input session to the computer system, such as shown in FIG. 11O in relation to the hands (1114a, and 1114b) are detected as typing at the keyboard 1104c. In some embodiments, when the computer system detects that the user is actively providing input or has recently provided input (e.g., within previous 0.5 seconds, previous 2 seconds, or previous 5 seconds) the computer system determines that the input device is part of an active input session. Additionally or alternatively, the computer system optionally determines that an input device is part of an active input session when an entry field (e.g., text entry field) is selected, and/or an input through the input device is requested by an active application.

In some embodiments, in response to detecting that the input device is part of the active input session to the computer system, the computer system reduces the visual prominence of the first portion of the first virtual content from the second degree of visual prominence to a third degree of visual prominence, lower than the second degree of visual prominence, to increase the visibility of the representation of the input device, such as if the portion of the virtual environment 1110 corresponding to the location of the representation of the keyboard 1104c (at FIG. 11O) were reduced to a third degree of visual prominence, optionally matching the visual prominence of the portion of the virtual environment corresponding to the representation of the hands of the user. In some embodiments, when the computer system determines that the first physical object is an input device, and the input device is part of an active input session to the computer system, the computer system optionally reduces the visual prominence of the first portion of the first virtual content to a third degree of visual prominence, which is lower than the second degree of visual prominence, to provide increased visual access of the representation of the first physical object to the user. A physical interaction optionally includes when one or more portions of the user (e.g., first hand, first foot, first finger, and/or other portion of the user) come in physical contact with, pick up, manipulate and/or move the first physical object. For instance, a keyboard is optionally displayed with a second degree of visual prominence in accordance with the keyboard corresponding to a first object type, and in accordance with the attention of the user being directed toward the keyboard. When the user reaches their first hand toward keyboard and presses one or more keys, the computer system optionally reduces the visual prominence of the first portion of the first virtual content to the third degree of visual prominence to provide increased visual access to the keyboard. In some embodiments the keyboard is communicatively connected with the computer system, however such connection is not required. Additionally or alternatively, the computer system optionally reduces the visual prominence of the representation of the first physical object without requiring that the representation of the first physical object to be displayed at the first degree of visual prominence or reduced to the second degree of visual prominence prior to the physical interaction with the first physical object. By reducing the visual prominence of the first portion of the first virtual content when one or more portions of the user physically interact with the first physical object, the computer system provides increased visual access to the first physical object without requiring a request and/or active input from the user.

In some embodiments, detecting that the input device is part of the active input session to the computer system includes detecting a request for the input device (e.g., input request, and/or connection request) from one or more active applications running on the computer system. In some embodiments, when the computer system detects a request for the input device (e.g., for one or more inputs from a keyboard and/or mouse) from one or more active applications running on the computer system, and the input device is optionally communicatively connected with the computer system, the computer system displays and/or reduces the visual prominence of the first portion of the first virtual content in accordance with the first degree of visual prominence to provide increased visual access to the input device. Additionally or alternatively, in some embodiments, when the computer system receives a request from one or more active applications running on the computer system, for connection to an input device (e.g., keyboard, and/or mouse), the computer system displays and/or reduces the visual prominence of the first portion of the first virtual content in accordance with the first degree of visual prominence to provide increased visual access to the requested input device. For instance, when the computer system determines that an active application requires the user's information (e.g., name, username, and/or password), the computer system optionally reduces and/or displays the first portion of the first virtual content corresponding to a keyboard in accordance with the first degree of visual prominence. Additionally or alternatively, when the computer system determines that the input device is required for required user input(s), and the input device is not detected as being communicatively connected with the computer system, the computer system optionally requests connection to the input device and displays and/or reduces the visual prominence of the first portion of the first virtual content in accordance with the first degree of visual prominence to provide increased visual access to the requested input device. In some embodiments, the computer system determines that an input device is requested by an active application when an application is launched which uses the input device, or the application initiates an operation (e.g., starting a gaming session) which uses the input device. An active application as discussed herein includes applications which are actively displayed by the computer system as well as those which are running on the computer system but not actively displayed. By displaying the first portion of the first virtual content in accordance with the first degree of visual prominence when the computer system detects that an input device (e.g., input request, and/or connection request) is requested by one or more active applications, the user is provided increased visual access to the input device, thus providing increased visual access to the input device corresponding to the request.

In some embodiments, the first type of object includes an object of interest that was previously identified as being an object of interest by the user of the computer system, such as illustrated in FIG. 11R in relation to the bowl of snacks 1106c following the scanning operation as illustrated in relation to FIG. 11P-11Q. In some embodiments, the first type of object includes an object of interest (e.g., physical object and/or representation of a physical object) that was previously identified by a user as being of interest to the user of the computer system. While the user is actively using the computer system, the computer system optionally detects that a user has identified one or more objects of interest by detecting one or more user inputs (e.g., selection, scanning, and/or keyboard input) indicating that a particular representation of a physical object is an object of interest. Additionally or alternatively, the computer system optionally saves the one or more objects of interest for recognition as the first type of object for future identification. For instance, a user optionally selects a menu item generically identifying a type of object of interest (e.g., input devices), and/or the user optionally identifies a particular object of interest (e.g., a baseball cap) within the physical environment of the user. In some embodiments, objects which are identified by the user correspond with the first type of object. Accordingly, the first type of object is optionally modifiable to include and/or exclude certain object types from the first type of object (e.g., different objects will be considered the first type of object depending on which objects the user designates as being of interest). By allowing the user to identify an object as being of interest, the computer system allows the user to customize their experience such that the computer system provides increased visual access to objects that are of immediate interest or general interest to the user.

In some embodiments, the identification of the object of interest by the user includes detecting that the user initiated a scanning operation on the object, such as the initiation of the scanning operation in response to user input 1105b shown in FIG. 11Q. In some embodiments, the user identifying a physical object as the object of interest includes the user initiating a scanning operation on the object of interest. The initiating of the scanning operation on the physical object to identify it as an object of interest optionally includes capturing one or more visual captures of the physical object. For instance, when the computer system receives user input identifying a baseball cap as an object of interest within the viewpoint of the computer system and/or the viewpoint of the user of the computer system, the computer system the computer system initiates a scanning operation to capture one or more visual captures of the baseball cap. In some embodiments, the computer system initiates the scanning operation in response to the user providing one or more inputs to the computer system (e.g., hand gesture(s), input device input(s), button actuation, and/or head gesture(s)) corresponding to an input requesting the computer system to initiate the scanning operation. Upon initiating the scanning operation the computer system optionally captures, via one or more sensors of the computer system, information about an appearance of the object (e.g., captures visual information about a baseball cap that the user has identified as an object of interest). Additionally or alternatively, in some embodiments the identification of the object of interest includes the computer system receiving a digital representation (e.g., a photo, a rendering, a two-dimensional representation, and/or a three-dimensional representation) of the object of interest for saving to the memory of the computer system, wherein the object of interest was previously scanned or virtually generated prior to being uploaded the computer system. To determine when a representation of the first physical object corresponds with the first object type (e.g., previously identified object of interest), the computer system optionally compares the representation of the first physical object within the view of the computer system to one or more representations of physical objects stored to memory, such that if one or more characteristics of the representation of the first physical object corresponds with one or more characteristics of the one or more physical objects stored to memory, the computer system optionally determines that the representation of the first physical object corresponds to the first object type and reduces the visual prominence of the first portion. By allowing the user to identify an object of interest by scanning a physical object provides the user an efficient way to include any object which is an object of interest to the one or more objects which correspond to the first type of object.

In some embodiments, detecting the change in attention of the user includes detecting one or more portions of a user moving toward the first physical object, wherein the first physical object is configured for use by the first hand of the user (and optionally not configured for use by a second hand of the user). FIG. 11V, for instance, illustrates the computer system reducing the visual prominence of the portion of the virtual environment 1110 in response to detecting that the right hand 1114a of the user is reaching toward the right game controller 1104a-1, which is configured for user with the right hand of the user. In some embodiments, detecting the change in attention of the user includes detecting one or more portions (e.g., first hand, and/or second hand) of the user moving toward the first physical object. The first physical object optionally comprises an input device (e.g., controller) which is configured for user by the first hand (e.g., right hand, or left hand) of the user.

When the computer system determines that the first hand (e.g., correct hand) of the user is moving toward (e.g., reaching) the first physical object, the computer system reduces the visual prominence of the first portion of the first virtual content from the first to the second degree of visual prominence as described herein. For instance, when the right hand of the user is detected by the computer system as moving toward a right-hand controller (e.g., a controller that is configured to be operated by the right hand or that is typically operated with the right hand), the computer system optionally reduces the visual prominence of the first portion of the first virtual content to increase visual access to the representation of the first physical object. A right-hand controller as discussed herein optionally includes a controller located closer to the right hand of the user than to the left hand of the user, and/or a controller previously used by the right hand of the user.

In some embodiments, in accordance with a determination that a second hand of the user, different from the first hand, is moving toward the representation of the first physical object, the computer system reduces the visual prominence of the first portion of the first virtual content from the first degree of visual prominence to the second degree of visual prominence. FIG. 11T, for instance, illustrates the computer system forgoes reducing the visual prominence of the portion of the virtual environment 1110 in response to detecting that the left hand 1114b of the user is reaching toward the right game controller 1104a-1, which is not configured for use with the right hand of the user. However, when the computer system determines that a second hand (e.g., left hand) of the user is detected as moving toward the representation of the first physical object, the computer system optionally forgoes reducing the visual prominence of the first portion of the first virtual content from the first degree of visual prominence to the second degree of visual prominence. Additionally or alternatively, when the computer system determines that a second hand (e.g., left hand) of the user is detected as moving toward the representation of the first physical object, the computer system optionally reduces the visual prominence of the first portion of the first virtual content from a first degree of visual prominence to a third degree of visual prominence, such that the third degree of visual prominence is less than the first degree of visual prominence and greater than the second degree of visual prominence. Additionally or alternatively, when the computer system determines that a second hand (e.g., left hand) of the user is detected as moving toward the representation of the first physical object, the computer system optionally increases the visual prominence of the first portion of the first virtual content from the first degree of visual prominence to a third degree of visual prominence, thereby reducing visual access to the representation of the first physical object. Additionally or alternatively, when the computer system detects the left hand of the user is moving toward a left-hand controller (e.g., controller configured for use by the left hand of the user, controller located closer to the left hand of the user than to the right hand, and/or controller previously used by the left hand of the user), the computer system optionally reduces the visual prominence of the first portion of the first virtual content to increase visual access to the representation of the first physical object. By selectively reducing the visual prominence of the first portion of the first virtual content when the first hand (e.g., correct hand) of the user is detected as reaching toward the representation of the first physical object and/or the first physical object, and increasing the visual prominence of the first portion of the first virtual content when the second hand (e.g., incorrect hand) of the user is detected as reaching toward the representation of the first physical object and/or the physical object, the computer system mitigates misinterpretation of the movements of the user and avoids unnecessarily distracting the user by providing increased visual access to items which the user does not intend to interact with.

In some embodiments, forgoing reducing the visual prominence of the first portion of the first virtual content from the first degree of visual prominence to the second degree of visual prominence includes maintaining the visual prominence of the first portion of the first virtual content at the first degree of visual prominence, such as illustrated in FIG. 11T for instance wherein the portion of the virtual environment 1110 remains displayed a the first degree of visual prominence when the computer system detects that the left hand 1114b of the user is reaching toward the right game controller 1104a-1, which is not configured for use with the right hand of the user. Additionally or alternatively, when the computer system determines that the second hand (e.g., incorrect hand) is reaching toward the first physical object, the computer system optionally forgoes reducing the visual prominence of the first portion of the first virtual content (e.g., does not reduce the visual prominence from the first degree to the second degree), and maintains the visual prominence of the first portion of the first virtual content at the first degree of visual prominence. By forgoing reducing the visual prominence of the first portion of the first virtual content when the incorrect hand is detected as reaching toward the first physical object (e.g., controller configured for user by a particular hand of the user), the computer system avoids distracting the user, and avoids performing unnecessary operations which results in less processor tasking and less power consumption.

In some embodiments, the computer system displays, via the one or more display generation components second virtual content (such as virtual content window 1126 in FIG. 11X), different from the first virtual content, in the three-dimensional environment, such that the second virtual content obscures at least a second portion of the representation of the physical environment from the viewpoint of the user of the computer system. In some embodiments, displaying the second virtual content includes, in accordance with a determination that the second portion of the representation of the physical environment includes a second physical object, and that the second virtual content corresponds to a user-selected content type, displaying a first portion of the second virtual content with the first degree of visual prominence that enables a representation of the second physical object to be at least partially visible through the second virtual content, such as if computer system had received user input identifying gaming windows as user-selected content type, and as a result, the portion of the virtual content 1108a corresponding to the representation of the game controllers 1104a was displayed with the first degree of visual prominence.

In some embodiments, while displaying second virtual content, the computer system detects the change in attention of the user (e.g., a change in a portion of the three-dimensional environment to which the attention of the user is directed, optionally including detecting movement of the attention of the user).

In some embodiments, in response to detecting the change in attention of the user, in accordance with a determination that the attention of the user is directed toward the representation of the second physical object in the three-dimensional environment, the computer system reduces the visual prominence of the first portion of second virtual content from the first degree of visual prominence to the second degree of visual prominence that is lower than the first degree of visual prominence to increase a visibility of the representation of the second physical object, such as in response to the attention of the user (e.g., gaze 1112 and/or hand 1114) is directed to the right game controller 1104a-1 as shown in FIG. 11Y. In some embodiments, the computer system allows the user of the computer system to select one or more content types (e.g., application window, environments, alerts, and/or notifications) for which the computer system will display a first portion of the second virtual content with a first degree of visual prominence to provide increased visual access to the representation of the first physical object. Virtual content optionally includes a content window, an environment, and/or an immersive application. For instance, the computer system optionally receives a user input that visual notifications correspond to a user-selected content type which portions thereof (e.g., first portion and/or second portion) are optionally displayed in a manner (e.g., first degree of visual prominence, and/or second degree of visual prominence) to allow increased visual access to the representation of the first physical object when the visual notification obscures the representation of the first physical object. Accordingly, when a visual notification is displayed in a manner which obscures the representation of the first physical object, a first portion of the visual notification which corresponds to the location of the representation of the first physical object is displayed with the first degree of visual prominence to provide increased visual access to the representation of the first physical object through the visual notification. In some embodiments, when the second virtual content does not correspond to a user-selected content type, the computer system optionally forgoes displaying the first portion of second virtual content with the first degree of visual prominence when it obscures the representation of the first physical object which corresponds to the first object type. For instance, when a representation of a physical object corresponding to the first object type is detected behind an application window, and application windows are not included (e.g., not specified by the user) as corresponding to the one or more content types, the computer system forgoes displaying the first portion of the second virtual content with a first degree of visual prominence. Additionally or alternatively, the computer system allows the user to specify order of priority of contents, physical objects, and/or representations of physical objects. For instance, when a user optionally prioritizes visual notifications as a first content type over application windows as a second content type, when the computer system determines that a first portion of the first application window obscures the first visual notification, the computer system optionally displays the first portion of the application window with the first degree of visual prominence. Additionally or alternatively, when the computer system determines that a first portion of the first visual notification obscures the first application window, the computer system optionally forgoes displaying the first portion of the first visual notification with the first degree of visual prominence. By allowing the user to selectively specify one or more contents for which the computer system provides uninterrupted and/or increased visual access through one or more contents by displaying the first portion of second virtual content with the first degree of visual prominence, the computer system provides the ability to customize user experience and provide increased visual access to objects of interest to the user according to interest and/or importance to the user.

In some embodiments, the user-selected content type includes a virtual environment, such as illustrated in FIG. 11D. In some embodiments, the one or more selected content types include environments (e.g., virtual environments, and/or representations of physical environments). Examples of an environment optionally include a representation of a natural environment (e.g., beach and ocean-view, mountain, river, and/or lakes), entertainment environments (e.g., concert), a manmade environment (e.g., building, and/or room), and/or an existing physical environment (e.g., representation of a real physical location). The user of the computer system optionally does not identify environments as a content type, for instance, when they wish to have a more relaxing, and/or immersive experience. Additionally or alternatively, when environments are selected as a content type, when a first environment as displayed obscures the representation of the first physical object corresponding to the first object type, the computer system displays portions (e.g., the first portion) of the environment corresponding with the representation of the first physical object with a first degree of visual prominence to provide increased visual access to the representation of the physical object. For instance, when the three-dimensional environment includes beach view, the computer system optionally displays portions (e.g., a first portion) of virtual content which obscure items which corresponds to the first object type (e.g., common desktop objects). By allowing the user to optionally identify environments as a virtual content type which can be displayed with reduced degrees of visual prominence when it obscures a representation of the first physical object which corresponds to the first object type, the computer system is selectively instructed by the user to display portions of the environment(s) which obscure the representation of the first physical object with a reduced amount of visual prominence for increased visual access to the representation of the first physical object, or forgo displaying the visual prominence of the environment(s) to maintain visual access to the environment(s) and/or elements within the environment(s).

In some embodiments, the user-selected content type includes a content window or volume, such as virtual content window 1126 as illustrated in FIG. 11X. In some embodiments, the one or more selected content types include windows (e.g., application windows). Content windows and/or volumes (e.g., a content window that includes one or more depth characteristics) are optionally moveable within the three-dimensional environment and are optionally displayed in a manner which a portion of the representation of the physical environment is visible via the display generation component and/or while a virtual environment is displayed. The user of the computer system optionally does not identify windows as corresponding to the content type, for instance, when they wish to focus on virtual content displayed within one or more windows such as when watching a film and/or working. Additionally or alternatively, when windows are selected as a content type, when first application window as displayed obscures the representation of the first physical object which corresponds to the first object type, the computer system optionally displays the first portion of the application window corresponding to the representation of the first physical object with the first degree of visual prominence to provide increased visual access to the representation of the first physical object. For instance, when a word processing window is displayed within the three-dimensional environment which obscures an input device (e.g., game controller) which corresponds to the first object type, and application windows are identified as a user selected content type, the first portion of the application window is displayed with at least the first degree of visual prominence. Additionally or alternatively, when application windows are not identified as a user selected content type, when the word processing window is displayed in a manner which obscures the game controller, the computer system forgoes displaying the first portion of the word processing with the first degree of visual prominence. By allowing the user to optionally identify content windows as a virtual content type which can be displayed with reduced degrees of visual prominence when it obscures a representation of the first physical object which corresponds to the first object type, the computer system is selectively instructed by the user to display portions of the content window(s) which obscure the representation of the first physical object with a reduced amount of visual prominence for increased visual access to the representation of the first physical object, or forgo displaying the visual prominence of the content window(s) to maintain visual access to the content window(s) and/or elements within the content window(s).

In some embodiments, the user selected content type includes an immersive application, such as if virtual content window 1126 as illustrated in FIG. 11X were an immersive application. In some embodiments, the one or more selected content types include immersive applications (e.g., simulated environments). An immersive application is optionally an application which is permitted to display content that is spatially distributed throughout an available display area (e.g., a volume or region that is optionally constrained by a portal or other boundary) of the three-dimensional environment. For example, the three-dimensional environment is generated, displayed, or otherwise caused to be viewable by the computer system (e.g., an extended reality (XR) environment such as a virtual reality (VR) environment, a mixed reality (MR) environment, or an augmented reality (AR) environment). In some embodiments, the content presented by the respective application in the three-dimensional environment is capable of being displayed at a location in the environment corresponding to an object associated with the respective application (e.g., within a portal for displaying content of the application) and/or at a location outside the portion of the environment corresponding to the object associated with the respective application (e.g., outside the portal discussed above). Accordingly, in some embodiments, the computer system displays the content presented by the immersive application within the portal and outside the portal. For example, if the immersive application includes a media player application, a portion of the content provided by the media player application (e.g., images, video (e.g., movies, television episodes, and/or other video clips), text, and/or three-dimensional objects (e.g., shapes, models, and/or other renderings)) can be displayed within (and/or overlaid on) a virtual window associated with the media player application, and another portion of the content provided by the media player application can be displayed in locations outside of the virtual window (e.g., beside the virtual window, in front of the virtual window, and/or behind the virtual window) from a viewpoint of the user. When immersive applications are selected as a content type, and an immersive application related content is displayed in a manner which obscures the representation of the first physical object, the computer system optionally displays a first portion of the immersive application content with the first degree of visual prominence to provide increased visual access to the representation of the first physical object. For instance, when immersive applications are selected as a content type, when the user is detected as using an immersive yoga application which includes content which obscures a yoga accessory (e.g., yoga block) which corresponds to the first type of object, the computer system optionally displays the first portion of the immersive yoga application with a reduced degree of visual prominence (e.g., second degree, or third degree) based on one or more factors (e.g., user preference) to provide increased visual access to the yoga block. However, when immersive applications are not identified as a content type which the computer system will display with reduced visual prominence, when the immersive application displays content which obscures the representation of the physical object (e.g., the yoga block), the computer system optionally forgoes displaying the first portion of the immersive application with the first degree of visual prominence. By allowing the user to optionally identify immersive applications as a virtual content type which can be displayed with reduced degrees of visual prominence when it obscures a representation of the first physical object which corresponds to the first object type, the computer system is selectively instructed by the user to display portions of the immersive application(s) which obscure the representation of the first physical object with a reduced amount of visual prominence for increased visual access to the representation of the first physical object, or forgo displaying the visual prominence of the immersive application(s) to maintain visual access to the immersive application(s) and/or elements within the immersive application(s).

In some embodiments, displaying, via the one or more display generation components, the first virtual content in a three-dimensional environment includes displaying a virtual environment which obscures a first portion of the representation of the physical environment, and a second portion of the representation of the physical environment that is visible while the virtual environment is displayed with a visual effect that changes an appearance of the second portion of the representation of the physical environment. In some embodiments, the computer system displays a virtual environment which includes a visual effect (e.g., a tint). A tint as described herein optionally includes: a colorization intended for physiological effects (e.g., light temperature configure for periods of waking and/or resting), colorization to simulate environmental changes and/or an atmospheric effect (e.g., seasonal, time of day, sunrise, and/or sunset), and/or colorization in accordance with an immersive environment (e.g., forest in the pacific

In some embodiments, displaying the first portion of the virtual environment with the first degree of visual prominence that enables the first portion of the representation of the physical environment (including the representation of the first physical object) to be at least partially visible through the first portion of the virtual environment, includes displaying the first portion of the representation of the physical environment with the visual effect, such as shown in FIG. 11X wherein the portions (1108a-1, and/or 1108a-2) are displayed with a first degree of visual prominence with the same tint 1124 as displayed in relation to the virtual environment 1110. In some embodiments the computer system detects that a first portion of the representation of the physical environment, optionally includes an object of interest (e.g., object corresponding to a first type of object) which is obscured by the first virtual content (e.g., virtual environment), wherein the first virtual content is displayed with the visual effect, and portions of the representation of the physical environment which are visible while the virtual content is displayed (e.g., second portion of the representation of the physical environment) are also displayed with the visual effect. Additionally or alternatively, when the computer system reduces the visual prominence of the first portion of the first virtual content, the computer system optionally maintains the visual effect such that objects within the first portion of the representation of the physical environment which are newly visible due to displaying the first portion of the first virtual content with the first degree of visual prominence, are optionally visible with the visual effect (e.g., the visual effect applied to them, and/or through the visual effect) of the first virtual content. For instance, when the first virtual content includes a virtual environment, simulating a beach scene at sunset, obscures a first portion of the representation of the physical environment which includes a representation of an input device (e.g., a keyboard identified as an object of interest), and the virtual environment does not obscure a second portion of the representation of the physical environment, wherein the virtual environment includes a visual effect simulating sunset, when the computer system displays the first portion of the virtual environment with the first degree of visual prominence to provide visibility to the keyboard, the keyboard is visible with the visual effect simulating sunset. Additionally or alternatively, the computer system optionally displays the second portion of the representation of the physical environment, the portion which is not obscured by the displayed virtual environment, with the visual effect simulating sunset. By displaying the first portion and/or the second portion of the first virtual content with visual effect as applied to the visible portions of the representation of the physical environment, the computer system simulates to the user a visual indication that the object of interest shares one or more characteristics (e.g., location, real vs. virtual, and/or distance from the user) with the virtual environment.

In some embodiments, in accordance with displaying the first portion of the virtual environment with the first degree of visual prominence, the computer system reduces a magnitude of the visual effect applied to the first portion of the virtual environment, such as shown in FIG. 11Y wherein the computer system reduces the magnitude of the tint 1128a-1 in accordance with displaying portion 1108a-1 with a second degree of visual prominence. In some embodiments, when the computer system displays the first portion of the first virtual content with the first degree of the visual prominence, the computer system reduces the magnitude of the visual effect to provide increased visual access to the representation of the first physical object. In some embodiments, reducing the magnitude of the visual effect optionally includes: increasing brightness, increasing color, and/or reducing blurring. For instance, when the computer system reduces the visual prominence of the first portion of the virtual environment to provide increased visual access to a keyboard in relation to the virtual environment, the virtual environment, including the first portion corresponding to the keyboard, is optionally displayed with of the visual effect with a reduced magnitude. For instance, when a virtual environment simulating a moonscape after evening twilight is displayed, the virtual environment includes a visual effect which reduces brightness and visibility as to simulate the reduced visibility after evening twilight. When the first portion of the virtual environment is displayed with a first degree of visual prominence, the computer system optionally increases the brightness of the visual effect to provide increased visibility of the keyboard. By reducing the visual effect the computer system further increases the visual access to the representation of the first physical object.

In some embodiments, in addition to reducing the magnitude of the visual effect applied to the first portion of the virtual environment, the computer system reduces the magnitude of the visual effect applied to a portion of the representation of the physical environment that is outside of the first portion of the virtual environment (e.g., the second portion of the representation of the physical environment, a representation of one or more hands of the user, a representation of a person or other object that has broken through the first virtual content, and/or a representation of a portion of the physical environment that is outside of a portal that contains virtual content and/or a virtual environment), such as shown in FIG. 11Z wherein the magnitude of the tint 1130 of the virtual environment, the tint 1128a-1 right game controller, and/or the tint 1128a-2 of the left game controller are each reduced (optionally symmetrically and/or asymmetrically). In some embodiments, when the first portion of the first virtual content is displayed with the first degree of visual prominence, and the computer system reduces the magnitude of the visual effect, the computer system also reduces the magnitude of the visual effect corresponding to portions of the virtual environment and/or the representation of the physical environment which do not correspond to the first portion of the virtual environment (e.g., the second portion of the representation of the physical environment, a representation of one or more hands of the user, a representation of a person or other object that has broken through the first virtual content, and/or a representation of a portion of the physical environment that is outside of a portal that contains virtual content and/or a virtual environment). For instance, when the user of the computer system is displaying a virtual environment which includes a beach scene at sunset which is displayed with a visual effect simulating sunset, and the visual prominence of the first portion of the beach scene is reduced to provide increased visual access to a phone of the user which is ringing, the magnitude of the visual effect of the first portion of the virtual environment, and/or the magnitude of the visual effect of one or more portions of the three-dimensional environment which do not correspond to the first portion of the virtual environment (e.g., one or more portions of the virtual environment which do not correspond to the first portion of the environment, the second portion of the representation of the physical environment, and/or a representation of one or more hands of the user) are reduced to increase visibility to phone of the user, portions of the virtual environment, and/or portions of the representation of the physical environment. Additionally or alternatively, the computer system optionally pauses video and/or animations related to the virtual environment upon reducing the visual prominence of the first portion of the virtual environment. By reducing the magnitude of the visual effect of the first portion of the first virtual content, portions of the virtual content not corresponding to the first portion of the virtual content, and/or other portions of the representation of the physical environment which are not obscured by the virtual environment, the computer system optionally provides the user increased visibility to objects of interest, increased visibility to the representation of the physical environment, and/or provides contextual information as related to the representation of the physical environment, and/or indicates to the user that the representation of the first physical object is within the representation of the physical environment.

In some embodiments, in addition to reducing the magnitude of the visual effect applied to the first portion of the virtual environment, the computer system reduces the magnitude of the visual effect applied to a portion of the representation of the physical environment that is outside of the first portion of the virtual environment (e.g., a representation of one or more hands of the user, a representation of a person or other object that has broken through the first virtual content, and/or a representation of a portion of the physical environment that is outside of a portal that contains virtual content and/or a virtual environment) such that reducing the magnitude of the visual effect applied to the first portion of the virtual environment includes reducing the magnitude of the visual effect by a first amount, such as shown in FIG. 11Z wherein the magnitude of the tint 1128a-1 of portion 1108a-1 is reduced by a first amount (in comparison to as shown in FIG. 11Y). When the computer system displays the visual prominence of the first portion of the virtual content (e.g., virtual environment) and/or reduces the visual prominence of the first portion of the virtual content to a second degree and/or third degree, the computer system optionally reduces the magnitude of the visual effect corresponding to the first portion of the virtual content by a first amount.

In some embodiments, reducing the magnitude of the visual effect applied to a portion of the representation of the physical environment that is outside of the first portion of the virtual environment includes reducing the magnitude of the visual effect by a second amount that is different from (e.g., less than) the first amount, such as shown in FIG. 11Z wherein the magnitude of the tint 1128a-2 of portion 1108a-2 is reduced by a different amount (in comparison to as shown in FIG. 11Y). In conjunction with reducing the magnitude of the visual effect corresponding the first portion of the virtual content by a first amount, the computer system optionally reduces the visual effect of a portion of the representation of the physical environment that is outside of the first portion of the virtual environment (e.g., a representation of one or more hands of the user, a representation of a person or other object that has broken through the first virtual content, and/or a representation of the portion of the physical environment that is outside of a portal that contains virtual content and/or a virtual environment) by a second amount which is different (e.g., less than or greater than) the first amount. In some embodiments, the computer system updates the amount by which the magnitude of the visual effect is reduced by the computer system based upon the distance of the portion of the representation of the physical environment that is outside the first portion of the virtual environment from the first portion of the virtual content. For instance, when the portion of the representation of the physical environment that is outside the first portion of the virtual environment is a first distance (e.g., 50 pixels, 100 pixels, 500 pixels, or 1000 pixels) from the first portion of the virtual content, the computer system optionally reduces the magnitude of the visual effect applied to the portion of the representation of the physical environment that is outside the first portion of the virtual environment by a third amount. When the portion of the representation of the physical environment that is outside the first portion of the virtual environment is a second distance (e.g., 25 pixels, 50 pixels, 250 pixels, or 500 pixels), less than the first distance, from the first portion of the virtual content, the computer system optionally reduces the visual effect of the portion of the representation of the physical environment that is outside the first portion of the virtual environment by a fourth amount, which is greater than the third amount, such that reduction of the visual effect by the fourth amount provides increased visibility to the portion of the representation of the physical environment that is outside the first portion of the virtual environment than a reduction of the visual effect by the third amount. By reducing the visual effect of the first portion of the virtual content and the portion of the representation of the physical environment which is outside the first portion of the virtual content, the computer system optionally increases visibility to other portions of the representation of the physical environment, and provides increased visibility to the representation of the first physical object, thus highlighting the location of the representation of the first physical object while providing increased context and spatial awareness pertaining to the representation of the physical environment from the viewpoint of the user.

It should be understood that the particular order in which the operations in method 1200 have been described is merely exemplary and is not intended to indicate that the described order is the only order in which the operations could be performed. One of ordinary skill in the art would recognize various ways to reorder the operations described herein. In some embodiments, aspects/operations of method 1200 may be interchanged, substituted, and/or added between these methods. For example, various object manipulation techniques and/or object movement techniques of method 1200 is optionally interchanged, substituted, and/or added between these methods. For brevity, these details are not repeated here.

FIGS. 13A-13U illustrate exemplary ways in which a computer system, while displaying one or more first portions of a representation of a physical environment of a user, optionally provides increased visual access to physical objects and/or representations of physical objects which are obscured and/or occluded by virtual content (e.g., virtual environment, application window, and/or notification window) displayed by the computer system. The criteria based on which the computer system determines if a user of the computer system should be provided increased visual access to a representation of a physical object, and how much the visual access is increased and/or decreased, depends on factors determined by the computer system including, but not limited to: detecting that the hand of the user is holding the object, the type of object which the representation of the first physical object corresponds to, attention level(s) of the user directed toward (or away from) the representation of the physical object, movement(s) of one or more portions of the user in relation to the representation of the physical object, physical contact between the user (e.g., a first hand) and the physical object, size of the physical object, and/or location of the physical object. FIGS. 13A-13U include real-world top-down view 1307 providing a secondary view of the physical environment 1302 before the user in the physical environment with the physical objects present within the physical environment of the user.

FIG. 13A illustrates a computer system 101 (e.g., an electronic device) displaying, via a display generation component (e.g., display generation component 120 of FIGS. 1 and 3), a three-dimensional environment (e.g., representation of the physical environment 1300) from a viewpoint of a user. In some embodiments, computer system 101 includes a display generation component 120. In FIG. 13A, the computer system 101 includes one or more internal image sensors 114a oriented towards the face of the user (e.g., eye tracking cameras 540 described with reference to FIG. 5). In some embodiments, internal image sensors 114a are used for eye tracking (e.g., detecting a gaze of the user). Internal image sensors 114a are optionally arranged on the left and right portions of display generation component 120 to enable eye tracking of the user's left and right eyes. Computer system 101 also includes external image sensors 114b and 114c facing outwards from the user to detect and/or capture the physical environment 1302 and/or movements of the user's hands.

As illustrated in FIG. 13A, the representation of the physical environment 1300 of the user includes one or more representations of physical objects which are in the physical environment 1302 of the user. For instance, the representation of the physical environment 1300 as shown, includes game controllers 1304a (e.g., right game controller 1304a-1, and left game controller 1304a-2), a computer mouse 1304b, a keyboard 1304c, a pencil 1306a, a coffee mug 1306b, and a bowl of snacks 1306c, resting upon a first table 1303a. Furthermore, as illustrated in FIG. 13A, ballcap 1306d, a stuffed bear 1306e, and headphones 1304d rest upon a second table 1303b which is further from the user and/or the viewpoint of the user compared to first table 1303a. Each of the representations of the objects shown within the representation of the physical environment 1300 by the computer system 101, optionally corresponds to a physical object in the physical environment 1302 of the user. In response to receiving a first user input 1305a, through button 1-128, the computer system 101 optionally displays virtual content such as virtual environment 1310 shown in FIG. 13B.

In the example of FIG. 13B, the computer system displays a virtual environment 1310 in response to the first user input 1305a illustrated in FIG. 13A which obscures representation of physical objects which correspond to physical objects within the physical environment of the user. Displaying virtual content (e.g., a virtual environment 1310) shares one or more characteristics with displaying virtual content such as described in relation to FIG. 11A-11B, and as described in relation to method 1200. As shown, all representations of objects and/or portions of representation of the physical objects obscured by the virtual environment are no longer visible from the viewpoint of the user. As shown, a portion of the representation of the physical environment 1300 is visible below the water line 1310a of the beach scene represented by the virtual environment 1310 such that portions of the representation of the first table 1303a, the representation of the second table 1303b, the representation of the keyboard 1304c, and the representation of the headphones 1034d remain visible because they are not obscured by the virtual environment.

As illustrated in FIG. 13C, computer system 101 detects that the virtual environment 1110 obscures visibility of objects corresponding to an object type (e.g., electronic objects communicatively connected with the computer system 101) such as the game controllers 1304a, the computer mouse 1304b, the keyboard 1304c, and/or the headphones 1304d. In response to detecting an object corresponding to the object type, the computer system 101 displays portions of the virtual environment corresponding with the representations of the objects corresponding with electronic objects which are communicatively coupled with the computer system in a manner (e.g., reducing visual prominence, and/or increasing transparency) to increase visibility of the representation of the physical objects. Reducing the visual prominence of a portion of the virtual content shares one or more characteristics with reducing the visual prominence of a portion of the virtual content in relation to FIG. 11D-11Z, and as described in relation to method 1200 to provide the user increased visibility of the objects which correspond to the first object type when objects (e.g., physical objects and/or representation of physical object) corresponding to object types are obscured partially and/or entirely by virtual content displayed by the display generation component(s). Additionally or alternatively, the computer system forgoes displaying portions of the virtual content which correspond with the location of representations of objects which do not correspond to the first object type (e.g., objects which are not communicatively connected with the computer system) such as the pencil 1306a, the coffee mug 1306b, the bowl of snacks 1306c, the ballcap 1306d and the stuffed bear 1306e.

As illustrated in FIG. 13D, when the computer system detects hand 1314 reaching toward a physical object (e.g., pencil 1306a), the computer system 101 displays the visual prominence of the portion of the virtual environment corresponding to the location of the representation of the pencil 1306a with a first degree of visual prominence in order to provide the user increased visibility of the representation of the pencil 1306a such as described in relation to FIGS. 11A-11B, and as described in relation to method 1200. For instance, when the hand 1314 of the user is detected as obscuring and/or moving toward the pencil from the viewpoint of the user, the computer system optionally determines that the hand 1314 is reaching toward the pencil 1306a. Furthermore, the computer system reduces the visual prominence of the portion 1315 corresponding with the hand 1314 of the user in a manner as described in relation to FIG. 11G and in relation to method 1200. As shown in FIG. 13D, the computer system 101 displays a portion 1315 of the virtual content (e.g., virtual environment 1310) corresponding with representation of the hand 1314 of the user with a third degree of visual prominence, less than the first degree and a second degree of visual prominence (such as discussed with respect to FIG. 11A-11Z), which provides increased visual access of the representation of the hand of the user 1314 with respect to portions of the virtual environment with a reduced visual prominence and/or portions of the virtual environment which do not include a reduced visual prominence. The visual prominence of the portion 1315 which corresponds to the representation of the hand 1314 of the user, is optionally reduced to a degree of visual prominence which is less than the visual prominence of other portions of the virtual content which do not correspond to the location of the representation of the hand 1314 of the user. Additionally or alternatively, the visual prominence with which the portion 1315 corresponding to the hand 1314 of the user is reduced to optionally maximize the visibility of the hand 1314 of the user from the viewpoint of the user in relation to portions of the virtual content which do not correspond with the portion 1315 which corresponds to the location of the hand 1314 of the user.

As illustrated in FIG. 13E, the computer system 101 detects that the hand 1314 of the user, displayed with the third degree of visual prominence, has picked up the pencil 1306a which was previously displayed with the first degree of visual prominence (see FIG. 13D). When the computer system detects that the hand 1314 of the user has picked up the pencil 1306a, the computer system updates the portion 1315 of the three-dimensional environment (e.g., representation of the physical environment, and/or the virtual environment) corresponding to the location of the representation of the hand of the user to encompass the pencil 1306a with the hand 1314 of the user, which is now holding the pencil, and the updated portion 1315 is displayed with the third degree of visual prominence.

In some embodiments, the virtual content corresponding to objects that are detected as being held in a hand of the user is updated at a higher frequency than for objects that are not detected as being held in the hand of the user. For instance, returning to the example of FIG. 13D, as pencil 1306a, which is currently being displayed with the first degree of visual prominence, is not currently detected by computer system 101 as being held in the hand 1314 of the user, an update frequency 1362 of the virtual content corresponding to pencil 1306a (e.g., the frequency at which the computer system updates the visual prominence of the virtual content corresponding to pencil 1306a) is equal to the update frequency 1360 of the virtual content corresponding to keyboard 1304c which is also detected by computer system 101 as not being held by the hand 1314 of the user. However, turning to the example of FIG. 13E, once computer system 101 detects hand 1314 holding pencil 1306a, computer system 101 increases the update frequency 1362 of the virtual content corresponding to pencil 1306a such that it is higher than the update frequency 1360 of the virtual content corresponding to keyboard 1304c, and in accordance with the methods for increasing the update frequency of an object held in the hand of the user described with respect to method 1400.

As illustrated in FIG. 13F, computer system 101 detects that the hand 1314 of the user holding the pencil 1306a moves in relation to the viewpoint of the user (compare the location of hand 1314 in FIG. 13E to the location of the hand 1314 in FIG. 13F), and in response the computer system updates the location of the portion 1315 of the three-dimensional environment corresponding to the representation of the hand of the user to follow movements of the hand of the user. Accordingly, the computer system maintains increased visibility of the hand 1314 of the user and the pencil 1306a by continuing to display the portion corresponding to the representation of the hand holding the pencil with the third degree of visual prominence.

In the example of FIG. 13G, the computer system 101 detects that the hand 1314 of the user has picked up the ballcap 1306d which does not correspond to a first object type. As the computer system 101 does not recognize the ballcap 1306d as corresponding to the first object type (e.g., objects that are communicatively coupled to the computer system), the computer system forgoes reducing the visual prominence of the portion of the virtual environment 1310 corresponding to the location of the representation of the ballcap 1306d, and forgoes reducing the visual prominence of the portion corresponding to the representation of the ballcap 1306d in response to detecting that the hand 1314 of the user is holding the ballcap. As shown in FIG. 13G, the computer system optionally forgoes reducing the visual prominence of the portion of the virtual content corresponding to the location of the representation of the ballcap, and a portion of the virtual content corresponding to the representation of the hand, which is displayed with a reduced visual prominence to increase visibility of the representation of the hand of the user, visually overlaps (e.g., from the viewpoint of the user) with the portion of the virtual content corresponding to of the location of the representation of the ballcap, a portion of the representation of the ballcap is visible from the viewpoint of the user due to the where the location of the representation of the ballcap coincides with the portion of the virtual content corresponding to the representation of the hand of the user. The computer system optionally allows the user to identify objects such as the ballcap 1306d, such that when the identified objects are detected by the computer system, the computer system recognizes the identified object as an object of interest which should be visible when obscured by the virtual content. When the computer system receives an indication from the user which initiates a scanning operation such as described in relation to FIG. 11P-11Q, and as described in method 1200, the computer system allows the user to provide one or more inputs to identify one or more objects as objects of interest. As illustrated in FIG. 13H, when the user activates the scanning mode, the computer system 101 provides a notification 1320 and scanning process allowing the user to identify objects of interest such as further described in FIGS. 13H-13L.

FIG. 13I illustrates an exemplary scanning process for identifying objects. As illustrated in FIG. 13I, when the computer system 101 receives a user input 1305b corresponding to a scanning process 1105b, such as at button 1-128, the computer system displays a visual prompt 1320, prompting the user to identify objects to scan for identification as an object of interest. Following receiving the user input 1305b corresponding to an indication to initiate the scanning process, the computer system 101 initiates a scanning operation to identify objects of interest that includes receiving an indication of the user identifying an object of interest such as the ballcap 1106d through an identifying user input (e.g., detecting the user directing their hand 1314 toward the ballcap 1306d). While engaged in the identification process, computer system 101 detects the hand of the user 1104 directed toward the ballcap 1306d. In response, the computer system provides a visual confirmation 1322 to indicate to the user that the ballcap has been identified as an object of interest and scanned accordingly.

FIG. 13J illustrates the recognition of the ballcap following the scanning process as shown in FIG. 13I. As illustrated in FIG. 13J, following the scanning process of FIG. 13H-13I, and while displaying the virtual environment 1310 in a manner which obscures the visibility of the representation of the ballcap 1306d, such as shown in FIG. 13B, the computer system detects the ballcap within the viewport of the user and recognizes the ballcap as an object of interest (e.g., scanned, and/or identified by the user as an object of interest), and displays the portion of the virtual environment corresponding to the representation of the ballcap 1306d with a reduced degree of visual prominence (e.g., the first degree of visual prominence), similar to the reduced degree of visual prominence applied to the portions of the virtual environment which correspond to the representation of physical objects which correspond to the first object type.

Due to the ballcap 1306d being recognized as an object of interest following the scanning process (at FIG. 13H-13I), when the computer system detects hand 1314 of the user reaching toward ballcap 1306d as shown in FIG. 13K, the computer system applies a similar visual treatment to the portion of the virtual content which corresponds to the location of the representation of the ballcap. Accordingly, the computer system reduces the visual prominence of the portion of the virtual content corresponding to the location of the representation of the ballcap 1306d to the second degree of visual prominence, which is less than the first degree of visual prominence. Thus the user is provided increased visibility of the representation of the ballcap in relation to other objects (e.g., game controllers 1304a, mouse 1304b, and/or keyboard 1304c).

When the computer system 101 detects that the hand 1314 of the user picks up the ballcap 1306d, as shown in FIG. 13L, the computer system further reduces the visual prominence of the portion of the virtual environment corresponding to the representation of ballcap 1306d to the third degree of visual prominence, which matches the degree of visual prominence with which the portion of the virtual environment corresponding to the hand of the user is displayed with to provide further visibility of the representation of the ballcap to the user. Additionally or alternatively, in some embodiments the computer system optionally reduces the visual prominence of the portion of the virtual content corresponding to the location of the representation of the ballcap to a fourth degree of visual prominence which is less than the second degree (e.g., as shown in FIG. 13K) but greater than the third degree of visual prominence applied to the portion of the virtual environment corresponding to the location of the representation of the hand of the user. In some embodiments when a physical object (e.g., the bowl of snacks 1306c) is detected within a certain distance, the computer system optionally reduces the visual prominence of the portion of the virtual content corresponding to the location of the representation of the physical object when the attention of the user is detected as being increased and/or directed to the representation of the physical object. As illustrated in FIG. 13M, after the computer system displays the virtual environment (at FIG. 13B), the computer system 101 detects that the bowl of snacks 1306c is within the threshold distance (e.g., radial threshold distance 1330) from the location corresponding to the location of the user. Although the bowl of snacks 1306c does not correspond to the first object type, due to the bowl of snacks 1306c being within the threshold distance from the user, the computer system reduces the visual prominence of a portion of the virtual environment corresponding to a representation of a physical object, thus providing increased visibility of the representation pf the bowl of snacks to the user. As illustrated, the portion of the virtual environment corresponding to the representation of the bowl of snacks 1306c is displayed with the first degree of visual prominence.

When the computer system displays a portion of the virtual environment corresponding to a representation of an object (e.g., bowl of snacks 1306c) with a reduced degree of visual prominence, the computer system optionally changes the visual prominence of the portion of the virtual environment corresponding to the representation of an object based on changes of the attention of the user toward that representation of the object. As illustrated in FIG. 13N, the computer system 101 detects hand 1314 of the user reaching toward the bowl of snacks 1306c and in response, the computer system reduces the visual prominence of the portion of the virtual environment corresponding to the location of the representation of the bowl of snacks to a second degree of visual prominence, which is less than the first degree of visual prominence (e.g., by reducing an opacity of the portion), thus increasing the visibility of the representation of the bowl of snacks 1306c from the viewpoint of the user.

As the attention of the user toward the representation of the bowl of snacks increases, the computer system increases the visibility to the representation of the bowl of snacks accordingly. As illustrated in FIG. 13O, when the computer system 101 detects that the hand 1314 of the user picks up the bowl of snacks 1306c, the computer system further reduces the visual prominence of the portion of the virtual environment corresponding to the representation of the bowl of snacks 1306c to a third degree of visual prominence, less than the second degree of visual prominence, to provide further visibility of the representation of the bowl of snacks to the user in a manner described above.

As illustrated in FIG. 13P, when the computer system 101 detects that hand 1314 of the user reaches toward, and/or picks up an object outside the threshold distance (e.g., radial threshold distance 1330) such as the stuffed bear 1306e. However, since stuffed bear 1306e is outside the radial threshold distance 1330, computer system 101 forgoes displaying the portion of the virtual environment corresponding to the location of the representation of objects with a reduced degree of visual prominence.

When the computer system detects that the hand of the user has released an object, the computer system optionally continues to display the representation of the physical object with a reduced degree of visual prominence (e.g., first degree, second degree, third degree, and/or fourth degree) to maintain a level of increased visibility of the representation of the physical object from the viewpoint of the user. As illustrated in FIG. 13Q, following computer system 101 detecting that the hand 1314 of the user has picked up the pencil 1306a (at FIG. 13E-13F), the computer system detects that the hand 1314 of the user has released the pencil 1306e and has placed the pencil on the first table 1303a. When the computer system detects that the hand of the user has released the pencil 1306a, and the amount of time which has lapsed 1332 between the present time and when the computer system detected that the hand of the user has released the pencil is less than a threshold amount of time 1334, the computer system ceases displaying the portion of the virtual environment corresponding to the representation of the pencil with the same degree of visual prominence (e.g., third degree of visual prominence) as the portion 1315 of the three-dimensional environment which corresponds to the hand 1314 of the user, and displays the portion of the virtual environment corresponding to the representation of the pencil with an increased degree of visual prominence (e.g., first degree, and/or second degree). As the time increases from the time at which the computer system detects the hand of the user releasing the pencil, the computer system continues to increase the visual prominence of the portion of the virtual content corresponding to the location of the representation of the pencil.

As illustrated in FIG. 13R, when the amount of time which has elapsed 1332 since the computer system 101 detected that the hand 1314 of the user released the pencil 1306 exceeds the threshold amount of time 1334, the computer system further increases the visual prominence of the portion of the virtual content corresponding to the location of the pencil. In some embodiments, after the computer system 101 detects that the elapsed time 1332 exceeds the threshold amount of time 1334, the computer system optionally ceases the reduction of the visual prominence (e.g., displays with full and/or unreduced visual prominence) of the portion of the virtual content corresponding to the location of the pencil, such that the representation of the pencil is no longer visible from the viewpoint of the user through the virtual environment which obscures it.

In some embodiments, the degree to which a portion of virtual content has its visual prominence reduced by the computer system is based on object type (e.g., based on the type of object that will be displayed through that virtual content if/when the visual prominence of the virtual content is reduced). For instance, as illustrated in FIG. 13S, computer system 101 reduces the visual prominence of content corresponding to objects by an amount that is based on the identified type of object. For example, as illustrated in FIG. 13S, computer system 101 reduces the visual prominence of virtual content 1364 associated with controller 1304a-1 and 1304a-2 by a first degree of visual prominence and reduces the visual prominence of virtual content 1376 associated with keyboard 1304c by a second degree of visual prominence that is different from the first degree of visual prominence. In some embodiments, the computer system determines what degree of visual prominence to apply to a certain object based on an identification of the type of object. For instance, controller 1304a-2 and 1304a-1 are identified as controllers by computer system 101, and accordingly computer system 101 displays virtual content 1364 with the first degree of visual prominence. In contrast, computer system 101, in accordance with identifying keyboard 1304c as a keyboard, displays the virtual content 1376 associated with keyboard 1304c with a higher degree/amount of visual prominence compared to virtual content corresponding to the controller.

In some embodiments, a degree of precision associated with the reduction of visual prominence of virtual content is based on a degree of object familiarity as illustrated in FIG. 13T. In the example of FIG. 13T, the shape and/or size of virtual content 1380 associated with controller 1304a-1 has a higher degree of precision than the shape and/or size of content 1384 associated with keyboard 1304c. In some embodiments, the degree of precision refers to a distance between an edge portion of the virtual content and the object. For instance, in the example of FIG. 13T, the distance between controller 1304a-1 and the edge portion 1382 of virtual content 1380 is less than the distance between the edge portion 1386 of virtual content 1384 and keyboard 1304c; thus, the breakthrough of controller 1304a-1 is more precise than the breakthrough of keyboard 1304c. In some embodiments, the computer system applies different degrees of precision to the breakthrough based on a familiarity with the shape of an object. For instance, in the example of FIG. 13T, computer system 101 identifies controller 1304a-1 as a more familiar object (e.g., the computer system 101 has a higher degree of confidence in the shape of the controller) and thus displays the breakthrough of the controller with a higher degree of precision than the keyboard 1304c (which the computer system 101 determines is a less familiar object).

In some embodiments, the size of the breakthrough of the virtual content (e.g., the size of the portion of the virtual content that is reduced in visual prominence to allow for visibility of the underlying physical object) is limited in size by the computer system. For instance, as illustrated in FIG. 13U, computer system 101 limits the distance that the breakthrough of an object will extend from a hand of the user. For instance, in the example of coffee mug 1304b, the size of the portion of the virtual content is determined by the location of hand 1314 in the three-dimensional environment. In some embodiments, the distance between hand 1314 and the edge portion 1390 of the portion of virtual content 1388 is a predefined distance, and coffee mug 1306b is smaller in dimension that that distance. Thus, as illustrated in the corresponding head set view in FIG. 13U, when computer system 101 reduces the visual prominence of the virtual content 1310 around coffee mug 1306b, the entirety of the coffee mug 1306b is visible through that portion of the virtual content 1310.

In contrast, because the distance between the hand and the edge portion of the content is optionally limited to the above-described predefined distance, in some instances, the entirety of an object that is breaking through the virtual content is not visible. For instance, with respect to bowl of snacks 1306 (e.g., a larger object), the distance of edge portion 1394 of the portion of virtual content 1392 associated with the bowl of snacks 1306c is limited by computer system 101, and therefore as illustrated in the head set view in FIG. 13U, only a portion of the bowl of snacks 1306c is visible when the bowl of snacks 1306c is held by hand 1314 of the user, while a remaining portion of the bowl of snacks 1306c is not visible.

FIG. 14 is a flowchart illustrating a method of reducing the visual prominence of virtual content that is obscuring visibility of one or more objects based on whether the objects are being held by a user, in accordance with some embodiments. In some embodiments, the method 1400 is performed at a computer system (e.g., computer system 101 in FIG. 1A such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 1400 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1400 are, optionally, combined and/or the order of some operations is, optionally, changed.

In some embodiments, method 1400 is performed a computer system in communication with one or more display generation components, and one or more input devices. For example, a computer system, the one or more input devices, and/or the one or more display generation components have one or more characteristics of the computer system(s), the one or more input devices, and/or the one or more display generation components(s) described with reference to FIG. 1-FIG. 2. In some embodiments the computer system is configured to provide a view of a physical environment surrounding a user, however the embodiments discussed herein are not limited thereto. In some embodiments: the computer system, the one or more display generation components, and the one or more input devices share one or more characteristics with the computer systems described with respect to methods 800, 1000, 1200, and/or 1600.

In some embodiments, the computer system displays (1402), via the one or more display generation components, virtual content in a three-dimensional environment, wherein the virtual content obscures at least a portion of a representation of a physical environment that includes a first physical object from a viewpoint of the user of the computer system, such as virtual environment 1310 shown in FIG. 13B obscuring a representation of a pencil 1306a and other representations of physical objects. In some embodiments, displaying of virtual content in a three-dimensional environment, obscuring of the representation of the first physical object by the virtual content (e.g., user interface element), the first physical object, and/or the viewpoint of the user of the computer system share one or more characteristics with such aspects described with respect to methods 800, 1000, 1200, and/or 1600. In some embodiments, the virtual content shares one or more characteristics with the content window(s) described with respect to method 1200, and/or 1600. In some embodiments, the first physical object, and/or the representation of the first physical object shares one or more characteristics with the objects described with respect to method 1200 and/or 1600. In some embodiments, the three-dimensional environment is generated, displayed, or otherwise caused to be viewable by the first computer system. For example, the three-dimensional environment is an extended reality (XR) environment, such as a virtual reality (VR) environment, a mixed reality (MR) environment, or an augmented reality (AR) environment. In some embodiments, the three-dimensional environment shares one or more characteristics with the three-dimensional environments of methods 800, 1000, 1200 and/or 1600.

As described herein, the representation of the first physical object is optionally determined to be obscured if the virtual content partially or entirely obscures and/or obscures visibility of the representation of the first physical object. Obscuring of the representation of the first physical object by the virtual content optionally shares one or more characteristics of obscuring described with reference to methods 1200 and/or 1600.

In some embodiments, while displaying the virtual content, the computer system detects (1404) a change in a pose of a hand (e.g., a hand of a user of the device), and in response to detecting the change in pose of the hand (1406), in accordance with a determination that the first physical object satisfies a respective set of one or more criteria, including a criterion that is satisfied when the first physical object is being held by one or more portions of the hand, the computer system reduces (1408) a visual prominence of a first portion of the virtual content to increase a visibility of a representation of the first physical object in the three-dimensional environment (e.g., by revealing or increasing a degree of breakthrough of the representation of the first physical object relative to the virtual content), for instance as shown in FIG. 13E wherein the hand 1314 of the user has picked up the pencil 1306a, and the computer system has reduced the visual prominence of the portion of the virtual environment corresponding to the representation of the pencil 1306a. In some embodiments, detecting the change of pose of one or more portions of the hand (e.g., first hand, and/or second hand) of the user, and/or determining that the first physical object is held by one or more portions of the hand, shares one or more characteristics with such aspects related to the one or more portions of the user as described with respect to method 1600. The satisfaction (or not) of the respective set of the one or more criteria optionally indicates whether virtual content should and/or will be reduced in visual prominence when the computer system detects a change in pose of the hand (e.g., poses corresponding to reaching, grasping, clutching, holding, picking up, and/or dropping the first physical object), so as to increase visibility of an object through the virtual content. The object optionally satisfies the respective set of the one or more criteria based on object characteristics (e.g., size, color, shape, and/or object type), object location, and/or object disposition (e.g., held by user, dropped by user, standing on end, and/or laying flat). When the computer system determines that there is a change of pose of the hand of a user, and that the respective set of the one or more criteria are satisfied, the computer system optionally reduces the visual prominence of the first portion of the virtual content (e.g., such as described with reference to methods 1200, and/or 1600). Additionally or alternatively, when the representation of the first physical object detected by the computer system is obscured by the virtual content, and the first physical object is not held by one or more portions of the hand (e.g., user's hand) and/or there is not a change of pose in the hand of the user, the computer system optionally forgoes reducing the visual prominence of the first portion with the first degree of visual prominence. In some embodiments, reducing the visual prominence of the first portion by a first amount includes displaying first portion of the virtual content with the first degree of visual prominence.

In some embodiments, reducing the visual prominence of the first portion of the virtual content shares one or more characteristics with reducing the visual prominence of the first portion of the virtual content (e.g., by a first amount, and/or by a second amount) as described with respect to methods 1200 and/or 1600. In some embodiments the first portion of the virtual content shares one or more characteristics with the first portion of the virtual content as described with respect to methods 1200 and/or 1600.

In some embodiments, when the computer system determines that respective set of the one or more criteria are not satisfied, the computer system forgoes reducing the visual prominence of the first portion. In some embodiments, visual prominence and/or reducing visual prominence share one or more characteristics with methods 1200 and/or 1600. Additionally or alternatively, when the computer system determines that the respective set of the one or more criteria are satisfied, the computer system optionally reduces the visual prominence of the first portion by one or more amounts (e.g., a first amount, and/or a second amount). In some embodiments, reducing the visual prominence of the first portion by one or more amounts share one or more characteristics with reducing the visual prominence of the first portion by one or more amounts (the first amount, and/or the second amount) as described with respect to methods 1200 and/or 1600. Additionally or alternatively, in some embodiments, the location of a first portion in relation to the virtual content shares one or more characteristics with the location of a first portion as described with respect to methods 1200, and/or 1600.

In some embodiments, while the first portion of the virtual content comprises a reduced visual prominence, portions of the virtual content which do not correspond to the first portion comprise a visual prominence which is not reduced. Additionally or alternatively, the virtual content optionally includes multiple portions which comprise a reduced visual prominence, sharing one or more characteristics with multiple portions as described with respect to methods 1200, and/or 1600. Reducing the visual prominence of the virtual content (e.g., by a first amount, and/or by a second amount) allows the computer system to provide increased or decreased visual access to objects (e.g., representation of the first physical object) which are obscured by the user interface element, and/or allowing a user to view and/or interact with obscured objects by simply picking up the object. Accordingly, by modifying visual prominence of a virtual content and/or an object (e.g., representation of the first physical object), the computer system requires fewer user inputs, which translates to reduced processor tasking and reduced power consumption that would otherwise be needed to provide visual access to the object.

In some embodiments, in response to detecting the change in the pose of the hand, in accordance with a determination that the first physical object fails to satisfy the respective set of one or more criteria (e.g., because the first physical object is not being held by one or more portions of the hand), the computer system forgoes reducing the visual prominence of the first portion of the virtual content. For instance, as shown in FIG. 13D the portion of the virtual environment 1310 corresponding with the representation of the pencil 1306a is displayed with a first degree of visual prominence, if the hand of the user does not pick up the pencil, the computer system forgoes reducing the visual prominence of the portion of the virtual environment corresponding to the representation of the pencil. In some embodiments, when the computer system determines that the first physical object is not being held by one or more portions of the hand, the computer system forgoes reducing the visual prominence of the first portion of the virtual content. For instance, when the computer system detects movements of the hand of the user approaching a coffee mug, but the hand of the user is not detected as holding and/or picking up the coffee mug, the computer system optionally forgoes reducing the visual prominence of the first portion of the virtual content. Additionally or alternatively, when the computer system detects that the hand of the user moves the coffee mug, but does not pick up the coffee mug, the computer system optionally forgoes reducing the visual prominence of the first portion of the virtual content. By forgoing reducing the visual prominence of the first portion of the virtual content when one or more portions of the hand (e.g., hand of the user) is not detected as holding and/or picking up the first physical object, the computer system prevents providing increased visual access to a representation of an object which is not of interest to the user, and/or prevents performing unnecessary operations.

In some embodiments, the computer system detects movement of the first physical object 1306a from a first location (e.g., shown in FIG. 13E) in the three-dimensional environment to a second location (e.g., as shown in FIG. 13F) in the three-dimensional environment, different from the first location, while the first physical object is being held by the one or more portions of the hand. In some embodiments, in accordance with a determination that the virtual content obscures at least a portion of the representation of the first physical object from the viewpoint of the user when located at the second location and that the first physical object satisfies the respective set of one or more criteria, the computer system reduces a visual prominence (e.g., increasing an opacity of the virtual content, and/or modifying one or more visual characteristics) of a second portion of the virtual content, different from the first portion, to increase visibility of the representation of the first physical object in the three-dimensional environment, as evidenced by the updating of the portion of the virtual environment 1310 which has reduced visual prominence as the pencil 1306a moves with the hand of the user between FIG. 13E and FIG. 13F. In some embodiments when the computer system detects that the first physical object is held by the hand of the user and/or the hand of the user picks up the first physical object, and the hand of the user moves while holding the first physical object, the electronic device updates the location of the first portion of the virtual content to follow the location of the hand of the user. For instance, when the hand of the user is detected as holding a coffee mug, and the hand of the user moves while holding the coffee mug, the computer system updates the location of the first portion to correspond with (e.g., follow) the movement of the hand of the user. Additionally or alternatively, when the hand is holding the first physical object (e.g., coffee mug) and the hand of the user moves while holding the first physical object, the computer system optionally increases the visual prominence of the first portion of the virtual content corresponding to the location of the representation of the first physical object when the first physical object moves away from the first location. By updating the first portion of the virtual content to follow and/or correspond with the hand of the user, the computer system allows the user of the computer system to maintain visual access to a representation of the physical object which they are holding with their hand.

In some embodiments, the respective set of one or more criteria include a criterion that is satisfied when the first physical object is smaller than a size threshold, such as if the reduction of the visual prominence of the portion of the virtual environment 1310 corresponding to the pencil (at FIG. 13E) was at least partially based on the pencil being less than a size threshold (e.g., 15 cm). In some embodiments, the respective set of the one or more criteria include a criterion that is satisfied when the first physical object and/or the representation of the first physical object is smaller than a first size threshold. A first size threshold is optionally related to the physical size (e.g., one or more physical dimensions), the virtual size (one or more virtual dimensions), comparative size (e.g., in relation to the hand of the user), and/or in relation to one or more second physical objects within the physical environment and/or representations of one or more second physical objects within the representation of the physical environment of the user. Additionally or alternatively, when the computer system determines that the first physical object is larger than the size threshold, the computer system optionally determines that the criterion is not satisfied, and forgoes reducing the visual prominence of the first portion of the virtual content.

In some embodiments, the respective set of the one or more criteria includes a criterion that is satisfied based on the size of the first physical object and/or the size of the representation of the first physical object. In some embodiments the determination of the satisfaction of the criterion is based on the size threshold. Additionally or alternatively, the criterion is optionally based on size of the first physical object in relation to other physical objects visible from the viewpoint of the computer system, size of reference objects identified by the user.

In some embodiments the first size threshold is related to the length, width, and/or depth as individual dimensions or in combination (e.g., area, girth, and/or volume) of the first physical object. Examples of a physical size threshold include, but are not limited to: 5 mm, 10 mm, 25 mm, 50 mm, 10 cm, 25 cm, 50 cm, 1 meter, and/or greater than 1 meter. Examples of a virtual size threshold as related to a representation of the first physical object include, but are not limited to: 5 pixels, 10 pixels, 50 pixels, 100 pixels, 500 pixels, 1000 pixels, 5000 pixels, and/or greater than 5000 pixels. In some embodiments the size threshold includes a surface area and/or volumetric size threshold calculated with one or more values within the range of virtual and/or physical size thresholds as disclosed herein.

In some embodiments, when the computer system detects the hand of the user as holding the first physical object, and that the first physical object is smaller than the size threshold, the computer system displays the first portion of the virtual content with a reduced visual prominence to increase visual access to the representation of the first physical object, such as if a criterion to reduce the visual prominence of the portion of the virtual environment corresponding to the representation of the pencil 1306a as shown in FIG. 13E included that the pencil 1306a is smaller than the keyboard 1304c. For instance, in some embodiments the respective set of the one or more criteria includes a criterion that the first physical object satisfies when all dimensions of the first physical object are less than 15 cm. Accordingly, when the computer system detects a coffee mug held hand of the user, and the coffee mug is less than 15 cm in every dimension (e.g., length=10 cm, width=12 cm, height=14 cm), the computer system optionally reduces the visual prominence of first portion of the virtual content corresponding to the representation of the coffee mug. Additionally or alternatively, when the hand of the user is not detected as holding the first physical object and/or the first physical object is larger than the size threshold, the computer system forgoes reducing the visual prominence of the first portion of the virtual content corresponding to the representation of the first physical object. For instance, when the computer system detects a keyboard (e.g., length=45 cm, width=16 cm, depth=1.5 cm) held by one or more portions of the hand of the user, the computer system optionally forgoes reducing the visual prominence of the first portion of the virtual content corresponding to the representation of the keyboard as each of the length and the width of the keyboard exceed the 15 cm size threshold.

In some embodiments the respective set of the one or more criteria includes a criterion that is satisfied when the first physical object includes at least one dimension which is less than the size threshold. Accordingly, when the computer system detects a keyboard (e.g., length=45 cm, width=16 cm, or depth=1.5 cm) is held by the hand of the user, when the computer system determines that the keyboard has at least one dimension (e.g., depth) of less than 15 cm, the computer system determines that the keyboard satisfies the respective set of the one or more criteria and optionally displays the first portion of the virtual content corresponding to the representation of the keyboard with a reduced visual prominence. While examples provided reference the true physical size of the first object, in some embodiments the computer system determines when the first physical object satisfies the respective set of the one or more criteria based on the virtual size of the representation of the first physical object as seen from the viewpoint of the user and/or the computer system.

In some embodiments, the first physical object is determined to be smaller than the size threshold when the first physical object and/or the representation of the first physical object is comparatively smaller than a threshold corresponding to a reference object (e.g., second physical object, previously identified physical object, and/or a hand of the user). In some embodiments the size threshold is based on the actual physical size and/or virtual size of representation of the reference object. Furthermore, in some embodiments the size threshold corresponds to a calculated size threshold based on the reference object (e.g., twice the size of the hand of the user, and/or half the size of the desk of the user, and/or an average of one or more objects detected within the physical environment of the user). By using the respective set of the one or more criteria, including a criterion that the first object is smaller than a size threshold, the computer system optionally prevents the display of certain objects (e.g., physical objects which are too big, and/or too far from the user) with a reduced visual prominence, thereby preventing unnecessary removal of content that the user is interacting with or otherwise viewing.

In some embodiments, the respective set of one or more criteria include a criterion that is satisfied when the first physical object corresponds to a first type of object, such as if the reduction of the visual prominence of the portion of the virtual environment 1310 corresponding to the pencil (at FIG. 13E) was at least partially based on the pencil being a writing implement. In some embodiments the computer system reduces the visual prominence of the first portion of the virtual content when the first physical object corresponds to a first type of object (e.g., a predetermined object type). A first type of object shares one or more characteristics with the first type of object and/or physical objects as described with respect to methods 1200 and/or 1600. For instance, when the first type of object includes input devices, and the computer system detects a keyboard related to the change in pose of the hand of the user, the computer system optionally reduces the visual prominence of the first portion of the virtual content to provide increased visual access to the representation of the keyboard. Additionally or alternatively, when the computer system determines that the first physical object is a second type of object, and/or does not correspond to the first type of object, the criterion is not satisfied. By reducing the visual prominence of the first portion of the virtual content based on a predetermined type of object in accordance with the change in pose of the hand of the user, the computer system prevents providing increased visual access to representations of physical objects of no interest to the user, thereby reducing distractions to the user and/or reducing performing unnecessary operations, thereby preventing unnecessary removal of content that the user is interacting with or otherwise viewing, and preserving processor tasking and power consumption.

In some embodiments, the first type of object includes a common (e.g., pencil, pen, cup, phone, and/or headphones, or another object that has been detected more than threshold number of times over threshold time period and/or threshold number of sessions) desktop object type, such as if the reduction of the visual prominence of the portion of the virtual environment 1310 corresponding to the pencil (at FIG. 13E) was at least partially based on the pencil being a common desktop object. In some embodiments, the first type of object includes one or more common desktop objects. A “common desktop object”, as referred to herein, includes physical objects which are commonly associated with a workplace or home office. Examples of common desktop objects include, but are not limited to: pens, pencils, telephone, smartphone, electronic tablet, cup, mug, headphones, earbuds, computer, computer screen, input devices (e.g., keyboard, and/or mouse), lamp, cables, and/or printer.

In some embodiments a common desktop object includes one or more physical objects which are detected as being repeatedly present on the desktop of the user of the computer system in excess of a frequency threshold. For instance, the frequency threshold is optionally exceeded when a desktop object is detected on the desktop of the user in excess of a certain number of times (e.g., 2, 3, 4, 5, and/or 10 times) over the course of a threshold time period, wherein the threshold time period optionally corresponds to a length of time (e.g., 2 hrs, 6 hrs, 24 hrs, 48 hrs, or 72 hrs) and/or a number of sessions (e.g., 2, 3, 4, 5, and/or 10 session). For example, when the computer system detects a bowl of snacks on the desktop during the course of three sessions in a row, the computer system optionally recognizes the bowl as corresponding to a common desktop object. Additionally or alternatively, a common desktop object includes one or more physical objects which are detected in excess of a threshold percentage of time (e.g., 20%, 30%, 40%, 50%, and/or in excess of 50%). Accordingly, when the computer system detects the bowl of snacks as being present in excess of 30% of the time which the desk is visible from the viewpoint of the user of the computer system, the computer system optionally identifies the bowl of snacks as a common desktop object. Additionally or alternatively, when the presence of a physical object (e.g., bowl of snacks) no longer exceeds the criteria to be identified as a common desktop object, the computer system optionally ceases to identify the physical object as a common desktop object. By including one or more common desktop objects as the first type of object, such that the computer system reduces the visual prominence of the first portion of the virtual content which obscures the representation of the common desktop object, the user of the computer system is provided increased visual access to the representation of the common desktop objects without requiring the use to actively identify (e.g., scan) the first physical object.

In some embodiments, the respective set of one or more criteria include a criterion that is satisfied when the first physical object is an object that was previously scanned (and/or otherwise indicated as an object of interest based on user input) by the computer system, such as illustrated in relation to the reduction of the visual prominence of the portion of the virtual environment corresponding to the representation of the ballcap 1306d in FIG. 13L, based on the scanning process illustrated in FIG. 13H-FIG. 13I in some embodiments, the first physical object is identified as an object of interest when it corresponds to an object (e.g., physical object and/or representation of a physical object) that was previously identified by a user as being of interest to the user of the computer system. In some embodiments the object of interest includes a physical object which was scanned by the computer system and/or uploaded to the computer system. Scanning the first physical object and/or uploading a representation of the first physical object shares one or more characteristics with the scanning operation and/or uploading as described in relation to method 1200. By using a criterion which is satisfied when the first physical object corresponds to (e.g., same object as, and/or shares one or more characteristics with) an object that was previously scanned by the user, the computer system optionally provides increased visual access to objects which are of interest and previously identified by the user.

In some embodiments, the respective set of one or more criteria include a criterion that is satisfied when the representation of the first physical object is in a first location (and/or region) of the three-dimensional environment (e.g., elevated surface, table, desk, and/or physical environment of the user), prior to being held by the one or more portions of the hand, such as shown in FIG. 13N in relation to the bowl of snacks 1306c as a result of the bowl of snacks being within the radial threshold distance 1330 (at FIG. 13M) prior to being picked up in FIG. 13N. In some embodiments the respective set of the one or more criteria include a criterion that is related to the location (e.g., first location) of the first physical object (e.g., the first physical object in the physical environment, and/or the representation of the first physical object in the three-dimensional environment) in relation to a location (e.g., second location) of the user (e.g., viewpoint of the user) of the computer system, before the first physical object is picked up by the user. In some embodiments the criterion includes that the first physical object is in a first location in the physical environment which is within a threshold distance from the user. A threshold distance, as related to the distance of the first physical object from the user, optionally includes distances based on measurements (e.g., 25 cm, 50 cm, 1 meter, 2 meters, or more than 2 meters) and/or distances based on the user's physiology (e.g., 1 arm length, 1.5 arm lengths, 2 arm lengths, or more than 2 arm lengths). For instance, when a stuffed animal is located within a 1-meter threshold from the location corresponding to the location of the user, the computer system optionally displays the portion of the virtual content corresponding to the representation of the stuffed animal with a reduced visual prominence when held by the one or more portions of the hand of the user. Additionally or alternatively, when the stuffed animal is further than the 1-meter threshold, the computer system optionally forgoes displaying the portion of the virtual content corresponding to the representation of the stuffed animal with a reduced visual prominence when held by the one or more portions of the hand of the user.

In some embodiments, the criterion includes that the representation of the first physical object is in a first location in the three-dimensional environment which is within a threshold distance from a location corresponding to the user in the three-dimensional environment, as measured in virtual distances (e.g., pixels). A threshold distance, as related to the representation of the first physical object from the location corresponding to the user in the three-dimensional environment optionally includes measured virtual distances (e.g., less than 1 pixel, 1 pixel, 10 pixels, 25 pixels, 100 pixels, 500 pixels, 1000 pixels, and/or more than 1000 pixels), and/or a determination if a representation of one or more portions of the user overlap the representation of the first physical object.

In some embodiments the criterion that is satisfied when the physical object is in a first location, includes that the first physical object is in an elevated location (e.g., tabletop, and/or desktop). Accordingly, when the computer system detects that the stuffed animal is detected as being on a tabletop prior to being held by the one or more portions of the hand of the user, the computer system optionally displays the portion of the virtual content corresponding to the representation of the stuffed animal with a reduced visual prominence when held by the one or more portions of the hand of the user. Additionally or alternatively, when the computer system detects that the stuffed animal is detected as being on the floor prior to being held by the one or more portions of the hand of the user, the computer system optionally forgoes displaying the portion of the virtual content corresponding to the representation of the stuffed animal with a reduced visual prominence when held by the one or more portions of the hand of the user.

In some embodiments, the criterion is satisfied when the representation of the first physical object is in a location with respect to the viewpoint of the user, such as to the lower left or lower right of the viewport of the computer system, and/or within a region of the viewport of the computer system. Additionally or alternatively, the criterion is optionally satisfied when the first physical object when the first location corresponds to a location where the computer system detected that the user placed the object (e.g., a phone placed on a desktop). Additionally or alternatively, the criterion is optionally satisfied when the computer system determines that the first physical object is oriented in a manner which corresponds a configuration for user by the user. For instance, when a keyboard is facing the user in a configuration for use, the criterion is optionally satisfied. However, when the keyboard is facing away from the user, the criterion is optionally not satisfied. By using a criterion that is satisfied when the first physical object is located within a threshold distance of the user and/or in a particular location (e.g., elevated location, tabletop, and/or desktop) prior to being held by the user, and/or used by the user, the computer system only identifies physical objects which are likely to be picked up by the user, thereby preventing unnecessary removal of content that the user is interacting with or otherwise viewing and reducing unnecessary computational analysis and/or power consumption.

In some embodiments, while displaying the first portion of the virtual content with a reduced visual prominence in response to detecting that the first physical object is being held by the one or more portions of the hand such as shown in FIG. 13E, the computer system detects, via the one or more input devices, a release of the pose of the hand. In some embodiments, in response to detecting the release of the pose of the hand, the computer system increases, via the one or more display generation components, the visual prominence of the first portion of the virtual content, less than a full degree of visual prominence (e.g., 0% transparency), to decrease the visibility of the representation of the first physical object in the three-dimensional environment, such as shown in FIG. 13Q wherein the pencil 1306a is released by the hand of the user and in response, the computer system increases the visual prominence of the portion of the virtual environment 1310 corresponding to the location of the representation of the pencil. In some embodiments, subsequent to the computer system detecting that the one or more portions of the hand of the user are holding the first physical object, and while the first portion of the virtual content corresponding to the first physical object is displayed with the reduced visual prominence, when the computer system determines (e.g., detects) that the one or more portions of the hand of the user releases the first physical object, in response, the computer system increases the visual prominence of the first portion of the virtual content to reduce visual access (e.g., decrease visibility) to the first representation of the first physical object. For instance, subsequent to the computer system detecting that the user is holding a coffee mug (e.g., with their hand), and while the first portion of the virtual content corresponding to the location of the representation of the coffee mug and/or the hand of the user are displayed with the reduced visual prominence (e.g., 50% transparency), when the computer system detects that the user releases the coffee mug from their hand (e.g., places coffee mug on tabletop) the computer system optionally increases the visual prominence (e.g., to 20% transparency) of the first portion of the virtual content to decrease visual access to the representation of the coffee mug. The computer system optionally determines that the first hand is no longer holding the first physical object (e.g., released the first physical object) based on a change in pose of the hand which corresponds to the release of the pose of the hand, and/or based on detected movement of the first physical object independent of detected movement of the hand. By modulating the visual access to the representation of the first physical object through the virtual content according to one or more portions of the hand holding, or not holding, the first physical object, the computer system optionally controls the visual access to the representation of the first physical object in a manner which corresponds to when the attention of the user is directed toward, or not directed toward the representation of the first physical object and/or the first physical object thereby preventing unnecessary removal of content that the user is interacting with or otherwise viewing.

In some embodiments, while displaying the first portion of the virtual content with a reduced visual prominence in response to detecting that the first physical object is being held by the one or more portions of the hand, the computer system detects, via the one or more input devices, that the first physical object is dropped by one or more portions of the hand.

In some embodiments, in response to detecting the release of the pose of the hand, the computer system ceases to display the first portion of the virtual content with the reduced visual prominence, resulting in the visual prominence of the first portion of the virtual content being at a full degree of visual prominence (e.g., 0% transparency), such as shown in FIG. 13R following the hand 1314 releasing the pencil as shown in FIG. 13Q.

Additionally or alternatively, when the computer system detects that the one or more portions of the hand releases the first physical object (e.g., coffee mug), the computer system optionally ceases to display the first portion of the virtual content with a reduced visual prominence (e.g., changing from 50% transparency to 0% transparency) to cease providing increased visual access to the representation of the first physical object through the obscuring virtual content. By modulating the visual access to the representation of the first physical object through the virtual content according to one or more portions of the hand holding, or not holding, the first physical object, the computer system optionally controls the visual access to the representation of the first physical object in a manner which corresponds to when the attention of the user is directed toward, or not directed toward the representation of the first physical object and/or the first physical object thereby preventing unnecessary removal of content that the user is interacting with or otherwise viewing.

In some embodiments, while displaying, via the one or more display generation components, the virtual content in the three-dimensional environment, the computer system detects, via the one or more input devices, the hand within the physical environment, wherein the virtual content obscures at least a portion of a representation of the physical environment that includes the hand from the viewpoint of the user, and wherein a position of the hand is between a position corresponding to the virtual content and a position corresponding to the viewpoint of the user.

In some embodiments, in response to detecting the hand within the physical environment, the computer system reduces, via the one or more display generation components, a visual prominence of a second portion of the virtual content, to increase a visibility of the representation of the hand in the three-dimensional environment, wherein the second portion has a first shape corresponding to a profile of the hand from the viewpoint of the user, such as the portion of the virtual environment 1310 corresponding to the representation of the hand 1314 of the user being shown with reduced visual prominence in FIG. 13D, wherein the shape of the second portion of the virtual environment corresponds to the shape of the representation of the hand from the viewpoint of the user. In some embodiments, when the computer system detects one or more portions of the hand in the physical environment, the computer system displays the hand in a manner to provide increased visibility of the representation of the hand within the three-dimensional environment. When the computer system detects the hand within view of the computer system and/or the user of the computer system, the computer system optionally reduces the visual prominence of a second portion of the virtual content to increase the visibility of the hand from the viewpoint of the user. For instance, when a user at the computer system brings their hand into view, the computer system optionally reduces the portion (e.g., second portion) of the virtual content corresponding to the hand of the user to provide increased visual access to the hand. The shape of the second portion (e.g., first shape) optionally corresponds with the profile of the hand of the user from the viewpoint of the user.

In some embodiments, while the second portion of the virtual content with the first shape has the reduced visual prominence, the computer system detects, via the one or more input devices, that a second physical object is being held by the one or more portions of the hand, and in response to detecting that the hand is holding the second physical object, the computer system modifies the second portion from the first shape to a second shape, corresponding to a profile of the hand holding the second physical object from the viewpoint of the user, such as shown in FIG. 13E. The second physical object is optionally different from the first object, or optionally the same as the first physical object. When the computer system detects that the hand is holding the second physical object, the computer system optionally modifies and/or updates the shape of the second portion of the virtual content in a manner in to include the second object. For instance, while the second portion of the virtual content corresponding to the hand is displayed with a reduced visual prominence the second portion is shaped like the profile of the hand from the viewpoint of the user. When the computer system detects that the hand picks up a coffee mug, the computer system updates the shape of the second portion from the profile of the hand from the viewpoint of the user, to a profile of the hand and the coffee mug as held by the hand from the viewpoint of the user.

In some embodiments the computer system reducing the visual prominence as related to the hand or the hand holding the second physical object increases, and/or maximizes, visual access to the representation of the first physical object. For instance, when a coffee mug is detected as being held by the first hand of the user, the computer system optionally ceases to display the first portion of the virtual content which corresponds to the location of the representation of the coffee mug. Additionally or alternatively, increasing, and/or maximizing, visual access optionally access includes displaying the second portion of the virtual content with 100% transparency. Additionally or alternatively, increasing, and/or maximizing, visual access optionally includes displaying the representation of the first physical object in a manner which simulates the representation of the first physical object as being closer to the viewpoint of the user than the virtual content. In some embodiments, reducing one or more portions (e.g., the first portion) of the virtual content when the first physical object is picked up and/or held by the hand of the user shares one or more characteristics with detecting that one or more physical objects have been picked up by one or more hands of the user described with respect to method 1200, and/or method 1600. Furthermore, in some embodiments, the reduction of the visual prominence of portions of the virtual content which obscure the representation of the hand of the user, and/or portions of the virtual content which obscure the representation of a physical object held by the hand of the user share one or more characteristics with reducing portions of virtual content as described with respect to method 1200, and/or method 1600.

In some embodiments, increasing, and/or maximizing, visual access optionally includes increasing one or more characteristics (e.g., intensity, brightness) of the representation of the first physical object. In some embodiments, increasing, and/or maximizing, visual access includes displaying with a tint and/or reducing the visual prominence of the portions of the virtual content which do not correspond to the location of the representation of the first physical object. Displaying with a tint optionally shares one or more characteristics with displaying with a tint described with respect to method 1200. By increasing, and/or maximizing, the visual access to the representation of the first physical object, the computer system provides increased, full, and/or augmented visual access to the representation of the first physical object, allowing the user to focus primarily on a representation of an object of interest in contrast to virtual content displayed which obscures the representation of the first physical object.

In some embodiments, while displaying, via the one or more display generation components, the virtual content in the three-dimensional environment, the computer system detects, via the one or more input devices, the hand within the physical environment, wherein the virtual content obscures at least a portion of a representation of the physical environment that includes the hand from the viewpoint of the user. In some embodiments detecting the hand within the physical environment, wherein the virtual content obscures at least a portion of the representation of the first physical environment that includes the hand from the viewpoint of the user shares one or more characteristics with the detection of the hand of the user and elements of the virtual content obscuring portions of the physical environment as described herein.

In some embodiments, in response to detecting the hand within the physical environment, the computer system reduces, via the one or more display generation components, a visual prominence of a second portion of the virtual content, to increase a visibility of the representation of the hand in the three-dimensional environment, wherein the second portion has a first shape corresponding to a profile of the hand from the viewpoint of the user, such as shown in FIG. 13N, wherein the shape of the second portion of the virtual environment 1110 corresponding to the representation of the hand 1314 of the user, corresponds to the shape of the representation of the hand from the viewpoint of the user. In some embodiments reducing the visual prominence of the second portion of the virtual content shares one or more characteristics with reducing the visual prominence of the first portion of the virtual content as described herein.

In some embodiments, while the second portion of the virtual content with the first shape has the reduced visual prominence, the computer system detects, via the one or more input devices, that a second physical object is being held by the one or more portions of the hand, and in response to detecting that the hand is holding the second physical object, and while the second portion of the virtual content is displayed with a reduced visual prominence and maintains a shape corresponding to a profile of the hand from the viewpoint of the user, the computer system reduces, via the one or more display generation components, a visual prominence of a third portion of the virtual content, different from the second portion, to increase a visibility of a representation of the second physical object in the three-dimensional environment, wherein a location of the third portion corresponds to the representation of the second physical object in the three-dimensional environment, such as shown in FIG. 13O wherein the computer system has reduced the visual prominence of the portion of the virtual environment 1310 corresponding to the representation of the bowl of snacks 1306c is different than the portion of the virtual environment which corresponds to the representation of the hand 1314 of the user. In some embodiments detecting that the hand is holding the second physical object shares one or more characteristics with detecting that the hand is holding the first physical object as described herein.

In some embodiments reducing the visual prominence of the third portion of the virtual content shares one or more characteristics with reducing the visual prominence of the first portion of the virtual content as described herein.

In some embodiments, when the computer system detects one or more portions of the hand in the physical environment, the computer system displays the hand in a manner to provide increased visibility of the representation of the hand within the three-dimensional environment, such as shown in FIG. 13O for instance wherein the computer system has reduced the visual prominence of the portion of the virtual environment corresponding to the representation of the hand 1314 of the user, wherein the portion of the virtual environment corresponding to the representation of the hand 1314 of the user has a first shape corresponding to the shape of the representation of the hand of the user. When the computer system detects the hand within view of the computer system and/or the user of the computer system, the computer system optionally reduces the visual prominence of a second portion of the virtual content to increase the visibility of the hand from the viewpoint of the user. For instance, when a user at the computer system brings their hand into view, the computer system optionally reduces the portion (e.g., second portion) of the virtual content corresponding to the hand of the user to provide increased visual access to the hand. The shape of the second portion (e.g., first shape) optionally corresponds with the profile of the hand of the user from the viewpoint of the user.

In some embodiments, while the second portion with a first shape, corresponding to the location and shape of the hand from the viewpoint of the user, is displayed with a reduced visual prominence (e.g., such as shown in FIG. 13O), and the hand is detected as holding the second physical object, the computer system optionally reduces the visual prominence of a third portion of the virtual content corresponding to the location of the representation second physical object within the three-dimensional environment, such as shown in FIG. 13O for instance wherein the computer system has reduced the visual prominence of the portion of the virtual environment corresponding to the bowl of snacks 1306c, wherein the portion of the virtual environment corresponding to the bowl of snacks has a second shape which is different than the first shape. The third portion optionally comprises a second shape, different from the first shape of the second portion. The second shape is optionally different from the first shape. In some embodiments the second shape of the third portion optionally corresponds to the shape of the second physical object from the viewpoint of the user. Additionally or alternatively, the third shape of the second portion optionally corresponds to a predetermined shape (e.g., oval, circle, or rectangular). The first shape of the second portion corresponding to location of the hand of the user, and the second shape of the third portion corresponding to the location of the representation of the second physical object are optionally different, individually and/or combined, than a single shape corresponding to a portion of the virtual content with reduced visual prominence which corresponds to a representation of a hand of a user holding an object. For instance, while the second portion is displayed with a reduced visual prominence, and the computer system detects that the hand picks up and/or is holding a pencil, the computer system optionally maintains the reduced visual prominence of the second portion, and reduces the visual prominence of a third portion of the virtual content corresponding to the representation of the pencil. Accordingly, the second portion corresponding to the representation of the hand remains unmodified in response to determining that the hand of the user has picked up the second physical object, and the computer system reduces the visual prominence of third portion corresponding to the representation of the pencil independently of the second portion. The visual prominence of the first portion, second portion, and/or the third portion are optionally different. Additionally or alternatively, the visual prominence of the first portion, second portion, and/or the third portion are optionally the same. By increasing the visual access to the representation of the hand of the user in addition to the first physical object, the computer system provides increased, full, and/or augmented visual access to the representation of the hand of the user in conjunction with the representation of the first physical object, allowing the user to focus primarily on a representation of the first physical object while having full view of the representation of their hand, thereby allowing the user to physically interact and/or manipulate the first physical object with their hand.

In some embodiments, in response to detecting the change in the pose of the hand, in accordance with the determination that the first physical object satisfies the respective set of one or more criteria, including the criterion that is satisfied when the first physical object is being held by one or more portions of the hand, the computer system updates a spatial arrangement (e.g., size, shape, and/or position) of the first portion of the virtual content (e.g., that has the reduced visual prominence to increase the visibility of the first physical object) at a first rate, such as update frequency 1362 increasing between FIG. 13D to FIG. 13E in response to the computer system detecting pencil 1306a is being held by a hand 1314 of the user.

In some embodiments, in response to detecting the change in the pose of the hand, in accordance with a determination that the first physical object does not satisfy the respective set of one or more criteria because the first physical object is not being held by one or more portions of the hand, the computer system updates the spatial arrangement (e.g., size, shape, and/or position) of the first portion of the virtual content (e.g., that has the reduced visual prominence to increase the visibility of the first physical object) at a second rate, different from the first rate, such as update frequency 1362 in FIG. 13D when the hand 1314 of the user is not holding pencil 1306a. In some embodiments, the rate at which the spatial arrangement of the first portion of the virtual content is updated refers to a refresh rate of the display of the first portion of the virtual content (e.g., the rate at which the computer system renders and replaces images that are displayed on the one or more display generation units). In some embodiments, updating spatial arrangement includes updating a position of the first portion such that updating the visual prominence at a first rate and/or the second rate includes a rate at which the position of the first portion is updated. In some embodiments, in response to detecting that the physical object is being held in the hand of the user, the computer system refreshes the spatial arrangement of the first portion at a first rate (e.g., 0.1, 10, 20, 50, 100, 120, or 200 Hz). In some embodiments, the first rate is faster than a refresh rate of other portions of the three-dimensional environment. For instance, in response to detecting the hand of the user holding the physical object, the computer system refreshes the spatial arrangement of the first portion of the virtual content at 120 Hz while updating the other content and/or portions of the three-dimensional environment at a slower rate (e.g., 100 Hz). In some embodiments, the first rate is equal to the second rate. In some embodiments, the refresh of the other content and/or portions of the three-dimensional (e.g., not the first portion) are refreshed at a general refresh rate of the display (e.g., the rate at which the display is refreshed). In some embodiments, the computer system detects that the physical object is being held by one or more portions of the hand in accordance with the examples described herein. In some embodiments, the computer system detects that the first physical object does not satisfy the respective set of one or more criteria by detecting that no portion of the hand of the user is holding and/or making contact with the first physical object. Updating the spatial arrangement of the first portion of the virtual content based on detecting that the hand is holding the physical object allows the computer system to display motion of the physical object moving in the three-dimensional environment smoothly while also preserving computing resources and/or battery that would otherwise be needed to display the entire displayed three-dimensional environment at the same refresh rate.

In some embodiments, reducing the visual prominence of the first portion of the virtual content to increase the visibility of the representation of the first physical object in the three-dimensional environment includes, in accordance with a determination that the first physical object is a first object type, reducing the visual prominence of the first portion of the virtual content by a first amount (e.g., to a first degree of visual prominence and/or in a first manner), such as reducing the visual prominence of virtual content 1364 by a first amount in response to detecting controllers 1304a-1 and 1304a-2 in FIG. 13S.

In some embodiments, reducing the visual prominence of the first portion of the virtual content to increase the visibility of the representation of the first physical object in the three-dimensional environment includes, in accordance with a determination that the first physical object is a second object type, different from the first object type, reducing the visual prominence of the first portion of the virtual content by a second amount, different from the first amount (e.g., to a second degree of visual prominence, different from the first degree of visual prominence and/or in a second manner, different from the first manner), such as reducing the visual prominence of virtual content 1376 in response to detecting keyboard 1304c in FIG. 13S. In some embodiments, the amount of reduction of visual prominence of the first portion of the virtual content is based on a determined type of object of the first physical object. For instance, for physical objects that are of the type that are more likely to be handled (e.g., held and/or moved) by the hand of the user, the reduction in the visual prominence of the first portion is greater than it is for objects that are of a type (e.g., the second object type) that are not likely to be handled and or moved by the hand of the user. For example, the first object type is a game controller and the second object type is a computer keyboard. In some embodiments, the object types are based on a pre-determined need for the user of the computer system to view the physical object while touching the object. For instance, the first object type is a computer keyboard, while the second object type is a coffee mug. In some embodiments, a difference between the first amount and the second amount includes a difference in one or more visual characteristics of the first portion such as transparency, brightness, color saturation, and/or tint. In some embodiments, the objects are pre-defined during an enrollment process, for instance as described with respect to method 1200. In some embodiments, the first type of object includes an object of interest (e.g., physical object and/or representation of a physical object) that was previously identified by a user as being of interest to the user of the computer system. While the user is actively using the computer system, the computer system optionally detects that a user has identified one or more objects of interest by detecting one or more user inputs (e.g., selection, scanning, and/or keyboard input) indicating that a particular representation of a physical object is an object of interest. Additionally or alternatively, the computer system optionally saves the one or more objects of interest for recognition as the first type of object for future identification. For instance, a user optionally selects a menu item generically identifying a type of object of interest (e.g., input devices), and/or the user optionally identifies a particular object of interest (e.g., a baseball cap) within the physical environment of the user. In some embodiments, objects which are identified by the user correspond with the first type of object. Accordingly, the first type of object is optionally modifiable to include and/or exclude certain object types from the first type of object (e.g., different objects will be considered the first type of object depending on which objects the user designates as being of interest). In some embodiments, the first amount (e.g., 0.5%, 1%, 5%, or 10%) is less than the second amount (e.g., 10%, 25%, 50%, 75%, or 100%). By reducing the visual prominence of the first portion based on object type, the computer system provides increased visual access to objects that are of immediate interest and or have a higher likelihood of needing to be visualized by the user of the computer system when interacting with a three-dimensional environment.

In some embodiments, the first object type includes one or more objects with a shape that is known with a first degree of certainty by the computer system, and wherein reducing the visual prominence of the first portion of the virtual content by the first amount (e.g., to a first degree of visual prominence and/or in a first manner) includes displaying a boundary of the first portion of the virtual content with a first level of precision relative to a boundary of the first physical object, such as the precision of edge portion 1382 with respect to the shape of controller 1304a-1 in FIG. 13T.

In some embodiments, the second object type includes one or more objects with a shape that is known with a second degree of certainty by the computer system, less than the first degree of certainty. In some embodiments, reducing the visual prominence of the first portion of the virtual content to by the second amount (e.g., to a second degree of visual prominence and/or in a second manner) includes displaying the boundary of the first portion of the virtual content with a second level of precision, less than the first level of precision, relative to the boundary of the first physical object, such as the precision of edge portion 1386 with respect to the shape of keyboard 1304c in FIG. 13T. In some embodiments, a shape that is known with a first or second degree of certainty refers to a confidence level that a shape of a particular object is known to the computer system. For instance, in some embodiments, a degree of certainty refers to one or more categories of certainty such as highly certain, moderately certain, and not certain. For instance, a game controller is delineated as a as having a highly certain shape (e.g., because the controller is associated with the computer system) and thus has a first degree of certainty, while a track pad may have a moderately certain shape (because the track pad is a third-party hardware device) and thus is delineated as a second degree of certainty, different from the first degree of certainty. In some embodiments, the computer system records the confidence at which particular physical objects are scanned by the computer system (e.g., based on lighting conditions when the scan was performed, and/or other factors that would otherwise have an effect on certainty) and bases the degree of certainty on the observed confidence level. In some embodiments, the degree of certainty is pre-defined (e.g., by the user of the computer system during an enrollment process associated with the computer system and/or by the developer of the application associated with the application that displays the virtual content).

In some embodiments, the computer system determines a level of precision at which to reduce the visual prominence of virtual content based on the determined degree of certainty. In some embodiments, the level of precision refers to a distance between a boundary (e.g., edge) of the first portion of the virtual content and the boundary of the physical object as displayed on the computer system. Additionally or alternatively, the level of precisions refers to how sharp the boundary of the first portion is (e.g., the width of the boundary). In some embodiments, the level of precision is inversely proportional to the distance between the boundary of the first portion of the virtual content and the boundary of the physical object (e.g., the distance is smaller for objects that are more familiar). In some embodiments, a boundary of the first portion of the virtual content refers to the portion first portion where the gradient in the reduction of visual prominence begins. In some embodiments, the first level of precision (e.g., 0.1 mm, 0.5 mm, 1 mm, 10 mm, or 100 mm) is greater than the second level of precision when the first degree of familiarity includes object that are more familiar to the computer system than objects with a second degree of familiarity. Reducing the visual prominence of the first portion in which a distance from the edge of the first portion to the physical object is based on the certainty of the shape of the physical object enhances user interactions with the computer system by improving processing time needed to reduce the visual prominence of portions of the virtual content that occludes the physical object and improving visibility of the physical object without requiring receiving a user input, and thus reducing the number of inputs needed to interact with the virtual object thereby conserving additional computing resources needed for additional inputs.

In some embodiments, the first object type includes objects with a size within a first range of sizes, and reducing the visual prominence of the first portion of the virtual content by the first amount includes displaying a boundary of the first portion of the virtual content such that an entirety of the first physical object is visible through the virtual content, such as coffee mug 1306b being classified within the first range of sizes and thus computer system 101 displaying the entirety of coffee mug 1306b in FIG. 13U.

In some embodiments, the second object type includes objects with a size within a second range of sizes, wherein the second range of sizes includes sizes that are larger than the sizes included in the first range of sizes, and reducing the visual prominence of the first portion of the virtual content by the second amount includes displaying the boundary of the first portion of the virtual content such that a portion, and not the entirety, of the first physical object is visible through the virtual content, such as bowl of snacks 1306c being classified within the second range of sizes and thus computer system 101 partially displaying bowl of snacks 1306c in FIG. 13U. In some embodiments, a range of sizes refers to a classification of the physical object that is based on an area and/or volume of the physical object. For instance, the first range of size includes smaller virtual object (e.g., objects that have an area less than 1, 0.5, 0.25, or 0.1 square meters and/or objects that have a volume less than 1 m3, 0.125 m3, or 0.01 m3) and the second range of sizes includes larger virtual objects (e.g., objects that have an area larger than (0.1, 0.25, 0.5, or 1 square meters and/or have a volume greater than 0.01 m3, 0.125 m3, or 1 m3). In some embodiments, the difference between the first range of sizes and the second range of sizes includes differences in volume and/or area. In some embodiments, the computer system determines which size range the object belongs to based on data provide by the one or more cameras that are communicatively coupled to the computer system. Additionally and/or alternatively, the size of the virtual object is provided to the computer system by an application associated with the virtual object. In some embodiments, in accordance with a determination that the first object is within the first range of sizes, the computer system reduces the visual prominence of the first portion such that the entire first physical object is visible. For instance, in some embodiments, the computer system displays the first portion such that a boundary of the first portion (described herein) circumscribes (e.g., encapsulates) the entirety of the physical object such that the entirety of the physical object is displayed by the computer system. In some embodiments, in accordance with a determination that the physical object belongs to the second range of sizes (e.g., is a larger object), the computer system displays the first portion such that a boundary of the first portion (described herein) intersects with a portion of the physical object such that only a portion of the physical object is visible. In some embodiments, the percentage of the physical object that is visible (e.g., 10%, 20%, 50% or 75%) is inversely proportional to the size of the physical object. For instance, the larger the physical object, the smaller the percentage of the object is visible through the virtual content. In some embodiments, the amount of visual prominence of first portion is inversely proportional to the size of the object such that visual prominence of the first portion is reduced by less for larger objects than for smaller objects. In some embodiments, when the first physical object is the second object type, the entirety of the first physical object would be within the viewport of the user, but is occluded at least in part by the virtual content. In some embodiments, if the size of the first portion of the virtual content is larger than the size of the first physical object, then the computer system displays the entirety of the physical object. By limiting the size of the first portion to display the entirety of the physical object or a portion of the physical object based on the size of the physical object conserves computing resources that would otherwise be consumed to display the entirety of the physical objects no matter the size of the physical object.

In some embodiments, displaying the boundary of the first portion of the virtual content includes in accordance with a determination that an edge of the first physical object extends less than a threshold distance from the hand of the user, displaying, via the one or more display generation components, visual deemphasis of content such that an edge of the first portion of the virtual content at a first distance from the hand of the user that is greater than a distance between the edge of the first physical object and the hand of the user, such as edge portion 1390 extending a distance away from hand 1314 of the user that is greater than the distance from the edge of coffee mug 1306b and the hand 1314 in FIG. 13U. In some embodiments, the threshold distance is based on a determined size of the first physical object such that larger physical objects have a greater threshold distance (e.g., the edge of the first portion of the virtual content is displayed at a first location) than smaller physical objects (e.g., the edge of the first portion of the virtual content is displayed at a second location, different from the first location).

In some embodiments, displaying the boundary of the first portion of the virtual content includes, in accordance with a determination that the edge of the first physical object extends further than the threshold distance from the hand of the user, displaying, via the one or more display generation components, visual deemphasis of content such that the edge of first portion of the virtual content at a distance from the hand of the user that is less than a distance between the edge of the first physical object and the hand of the user. In some embodiments, the distance between the edge of the first physical object and the hand of the user is a fixed distance, for physical objects that are above a threshold size. In some embodiments, once the threshold size has been exceeded, the distance between the edge of the first physical object and the hand of the user is the same regardless of the size of the first physical object, such as edge portion 1394 extending a distance away from hand 1314 of the user that is less than the distance from the edge of the bowl of snacks 1306c and the hand 1314 in FIG. 13U. In some embodiments, the edge region of the first physical object refers to the portion of the first physical object that is furthest away from the hand of the user. In some embodiments, the edge of the first portion of the virtual content shares one or more characteristics with the boundary of the first portion of the virtual content described herein. In some embodiments, the computer system limits the size of the boundary of the first portion such that a distance between the boundary and the hand of the user is less than a threshold distance (e.g., 0.1, 0.2, 0.5, 1, and/or 5 cm). In some embodiments, the distance from the hand of the user is the same as the threshold distance. In some embodiments, the distance between the boundary and the hand is measured from the boundary of the first portion and a center of the hand. Additionally and/or alternatively, the distance between the boundary and the hand is measured from the boundary of the first portion and an edge of the hand that is closest to the boundary of the first portion. In some embodiments, when the first physical object is small enough such that the distance of edge region of the first physical object from the hand of the user is less than the threshold distance, the computer system reduces the visual prominence of first portion of the virtual content such that the entirety of the first physical object is more visible and/or visible through the virtual content. In some embodiments, when the first physical object is large such that the distance of the edge region of the first physical object from the hand of the user is more than the threshold distance, the computer system reduces the visual prominence of the first portion of the virtual content such that the portion of the first physical object that is within the threshold distance is more visible and/or visible through the virtual content while one or more portions of the physical object that are outside the threshold distance from the hand of the user are less visible because a visual prominence of the content that occludes those portions of the physical object is not decreased. Limiting the size of the first portion such that the distance between a boundary portion of the first portion and the hand is below a threshold distance conserves computing resources that would otherwise be consumed to display the entirety of larger physical objects.

In some embodiments, in response to detecting the change in pose of the hand, in accordance with a determination that the first physical object does not satisfy the respective set of one or more criteria because the object is not being held by one or more portions of the hand (e.g., the object is not in the hand and/or a threshold number of fingers of the hand are not wrapped around at least a portion of the object, such as one, two, three, four, or five fingers), the computer system forgoes reducing the visual prominence of the first portion of the virtual content, such as if the computer system obscured pencil 1306a because hand 1314 has not yet grabbed pencil 1306a in FIG. 13D. In some embodiments, detecting the change of pose of one or more portions of the hand (e.g., first hand, and/or second hand) of the user, and/or determining that the first physical object is held by one or more portions of the hand, shares one or more characteristics with such aspects related to the one or more portions of the user as described with respect to method 1600. The satisfaction (or not) of the respective set of the one or more criteria optionally indicates whether virtual content should and/or will be reduced in visual prominence when the computer system detects a change in pose of the hand (e.g., poses corresponding to reaching, grasping, clutching, holding, picking up, and/or dropping the first physical object), so as to increase visibility of an object through the virtual content. In some embodiments, determining that the first physical object is not being held by the one or more portions of the hand (e.g., does not satisfy the one or more respective criteria) shares one or more characteristics with such aspects related to the one or more portions of the user as described with respect to method 1600. In some embodiments, forgoing reducing the visual prominence of the first portion includes occluding the first physical object with the first portion with respect to the viewpoint of the user. Forgoing reducing the visual prominence of the virtual content in accordance with a determination that the hand of the user is not holding an object allows the computer system to provide increased or decreased visual access to objects (e.g., representation of the first physical object) which are obscured by the user interface element, and/or allowing a user to view and/or interact with obscured objects by simply picking up the object. Accordingly, by modifying visual prominence of a virtual content and/or an object (e.g., representation of the first physical object), the computer system requires fewer user inputs, which translates to reduced processor tasking and reduced power consumption that would otherwise be needed to provide visual access to the object.

It should be understood that the particular order in which the operations in method 1400 have been described is merely exemplary and is not intended to indicate that the described order is the only order in which the operations could be performed. One of ordinary skill in the art would recognize various ways to reorder the operations described herein. In some embodiments, aspects/operations of method 1400 may be interchanged, substituted, and/or added between these methods. For example, various object manipulation techniques and/or object movement techniques of method 1400 is optionally interchanged, substituted, and/or added between these methods. For brevity, these details are not repeated here.

FIGS. 15A-15H illustrate methods of and systems for reducing the visual prominence of virtual content that is obscuring visibility of one or more objects differently based on object type in accordance with some embodiments of the disclosure.

FIG. 15A illustrates a computer system 101 (e.g., an electronic device) displaying, via a display generation component 120 (e.g., display generation components 1-122a and 1-122b of FIG. 1), a three-dimensional environment 1500 from a viewpoint of a user of the computer system 101.

In FIG. 15A, the computer system 101 includes one or more internal image sensors 114a oriented towards the face of the user (e.g., eye tracking cameras 540 described with reference to FIG. 5). In some embodiments, internal image sensors 114a are used for eye tracking (e.g., detecting a gaze of the user). Internal image sensors 114a are optionally arranged on the left and right portions of display generation component 120 to enable eye tracking of the user's left and right eyes. Computer system 101 also includes external image sensors 114b and 114c facing outwards from the user to detect and/or capture the physical environment and/or movements of the user's hands.

As shown in FIG. 15A, computer system 101 captures one or more images of the physical environment around computer system 101 (e.g., operating environment 100 of FIG. 1), including one or more objects in the physical environment around computer system 101. In some embodiments, computer system 101 displays representations of the physical environment in three-dimensional environment 1500. For example, three-dimensional environment 1500 includes representations of the rear and side walls of the room in which the computer system 101 is located.

As discussed in more detail below, in FIG. 15A, display generation component 120 is illustrated as displaying one or more virtual representations of physical objects in the three-dimensional environment 1500. In some embodiments, the one or more representations are displayed by a single display (e.g., display 510 of FIG. 5) included in display generation component 120. In some embodiments, display generation component 120 includes two or more displays (e.g., left and right display panels for the left and right eyes of the user, respectively, as described with reference to FIG. 5) having displayed outputs that are merged (e.g., by the user's brain) to create the view of the virtual objects shown in FIGS. 15A-15H.

As illustrated in FIG. 15A, the representation of the physical environment 1502 of the user includes one or more representations of physical objects which are in the physical environment of the user. For instance, the representation of the physical environment 1502 as shown, includes game controllers 1504a (e.g., right game controller 1504a-1, and left game controller 1504a-2), a computer mouse 1504b, a keyboard 1504c, a pencil 1506a, a coffee mug 1506b, and a bowl of snacks 1506c resting upon a table 1503. Each of the representations of the objects shown (e.g., game controllers 1504a, computer mouse 1504b, keyboard 1504c, pencil 1506a, coffee mug 1506b, and bowl of snacks 1506c) within the representation of the physical environment 1502 by the computer system 101, corresponds to a physical object in the physical environment of the user. In some embodiments, computer system 101 displays one or more virtual environments on display generation component 120 in response to receiving one or more user inputs. For instance, in response to receiving a user input 1505 at input button 1-128, computer system 101 displays a virtual environment as virtual environment 1510 shown in FIG. 15B.

In the example of FIG. 15B, computer system 101 displays virtual environment 1510 in response to the input provided in the example of FIG. 15A. In some embodiments, virtual environment 1510 occludes the representations of the physical environment that were previously displayed prior to the display of virtual environment 1510 including the representations of the physical room of the user (such as table 1503), and one or more of the representations of the physical objects (such as pencil 1506a, a coffee mug 1506b, and the bowl of snacks 1506c). However, as illustrated in the example of FIG. 15B, some portions of the physical environment are displayed with a first degree of visual prominence so as to make certain representations of the physical objects at least somewhat visible to the user when the virtual environment 1510 is displayed by computer system 101. For instance, in the example of FIG. 15B, keyboard 1504c, mouse 1504b and controllers 1504a-1 and 1504a-2, are still at least partially visible even when virtual environment 1510 is displayed by computer system 101.

In some embodiments, computer system displays one or more portions of virtual environment 1510 with a first degree of reduced visual prominence in response to identifying one or more objects of interest in the physical environment of the user. In some embodiments, computer system 101 identifies objects of interest through a pre-defined process in which a user selects objects of interest that will displayed with some visibility by computer system 101 even when obscured by a virtual environment such as described with respect to method 1200 and illustrated in the example of FIGS. 11P-11Q. In the example of FIG. 15B, computer system 101 having identified keyboard 1504c, controllers 1540a-1 and 1504a-2, and mouse 1504b as objects of interest, displays portions 1508c, 1508a-1, 1508a-2, and 1504a-b of virtual environment 1510 respectively with a reduced degree of visual prominence (e.g., with a reduced level of opacity and a feathering treatment as described in further detail below). In some embodiments, computer system 101 refreshes the display of portions 1508a-1, 1508a-2, 1508b, and 1508c based on the identity of the object that the portions correspond to. In some embodiments, refreshing the display of portions 1508a-1, 1508a-2, 1508b, and 1508c includes updating the location of the portions based on detected movement of the objects corresponds to the portions and/or updating the size or other visual characteristics associated with the portions. For instance, as shown in FIG. 15B, portion 1508c corresponding to keyboard 1504c refreshes at a rate 1512, portion 1508b corresponding to mouse 1504b refreshes at rate 1514, and portion 1508 corresponding to controllers 1504a-1 and 1504a-2 refresh at rate 1516. In some embodiments, the refresh rates 1512, 1514, and 1516 are proportional to the propensity of movement of the objects while being operated. For instance, since keyboard 1504c is most likely to remain stationary even while being operated, the refresh rate 1512 is lower than refresh rate 1514 corresponding to mouse 1504b. Similarly, since mouse 1514b is less likely to move in three-dimensional environment 1500 than controllers 1504a-1 and 1504a-2, refresh rate 1514 is lower than refresh rate 1516.

In some embodiments, computer system 101 displays the portions of virtual environment 1510 that are displayed with a reduced degree of visual prominence are displayed at an orientation that corresponds to the orientation of the representations of the physical objects that the portions correspond to as illustrated in FIG. 15C. In the example of FIG. 15C, computer displays portion 1508a at an orientation that is different from the orientation displayed in the example of FIG. 15b due to controllers 1504a-1 and 1504a-2 being detected at a different orientation (e.g., the orientation is rotated 90° counterclockwise, due to the controllers 1504a-1 and 1504a-2 being orientation 90° counterclockwise relative to their orientation in FIG. 15B).

In some embodiments, the hand of the user 1505 is displayed with increased visibility by reducing the prominence of the portion of the virtual environment (e.g., the virtual environment 1510 corresponding to the hand 1505 of the user) as illustrated in FIG. 15D. In the example of FIG. 15D, in response to detecting hand 1505, computer system 101 displays the portion of virtual environment 1510 corresponding to hand 1505 with reduced visual prominence, with the outline of the portion corresponding to the profile of the hand of the user from the viewpoint of the user. In contrast to portions 1508a-c, the portion of the virtual environment 1510 corresponding to hand 1505 is displayed with 100% transparency (e.g., so that the hand 1505 is fully visible) and the outline of the portion corresponding to hand 1505 coincides with the outline of the profile of the hand, rather than coinciding with a shape that surrounds the hand but also includes portions of the virtual environment that are not part of the hand.

In some embodiments, if hand 1505 is detected as picking up one of the objects 1504a-c, the object that is detected as being picked up is displayed as if it were part of the hand is thus part of the profile of the hand for the purposes of displaying the virtual environment with reduced prominence as illustrated in FIG. 15E. In the example of FIG. 15E, computer system 101 detects that hand 1505 has picked up and is holding controller 1504a-1. In response to detecting that hand 1505 has picked up controller 1504a-1, computer system 101 modifies the portion of virtual environment 1510 that is displayed with reduced visual prominence and corresponds to the outline of hand 1505, so that the shape of the portion includes the joint profile that is formed by the combination of hand 1505 and controller 1504a-1. As illustrated in FIG. 15E, the portion 1508a-1 that was previously displayed with reduced visual prominence ceases to be displayed with reduced visual prominence, and instead the shape of the portion corresponding to hand 1505 is modified to accommodate the profile of controller 1504a-1 while portion 1508a-1 is no longer displayed with reduced visual prominence by computer system 101.

Alternatively and/or additionally to the example of FIG. 15E, in some embodiments, in response to detecting that the hand 1505 picks up an object, computer system 101 continues to display two separate portions of visual environment 1510 with reduced visual prominence, with one portion corresponding to the hand of the user and the other corresponding to the object itself as illustrated in the example of FIG. 15F. In the example of FIG. 15F, computer system 101 detects hand 1505 picking up controller 1504a-1, and in response continues to display the portion of virtual environment 1510 corresponding to hand 1505 with a reduced degree of visual prominence, while simultaneously updating the location of portion 1508a-1 to coincide with the location of controller 1504a-1 as it is being held by hand 1505. In the example of FIG. 15F, rather than displaying the hand 1505 and the controller 1504a-1 with increased visibility by reducing a visual prominence of a single portion of virtual environment 1510, computer system 101 continues to track and display two separate portions of virtual environment 1510 with reduced visual prominence independently of one another.

In some embodiments, in addition to objects, computer system 101 upon detecting that a person is within the viewport of the user can also display a portion of the virtual environment corresponding to the face of the person with a reduced degree of visual prominence as illustrated in FIG. 15G. In the example of FIG. 15G, computer system 101 detects that person 1520 is within the viewport of the user of computer system 101 and in response displays portion 1522 of virtual environment 1510 with a reduced visual prominence so that the person 1520 is at least partially visible to the user of the computer system. As illustrated in FIG. 15G, the shape of portion 1522 is such that the face of the person and some features of the person such as the head and shoulders of the person 1520 are visible.

In some embodiments, in addition to the shape of the portion of virtual environment 1510 displayed with reduced visual prominence being based on the object corresponding to the portion, other aspects of the portion displayed with reduced visual prominence are different depending on the object that corresponds to the portion as illustrated in FIG. 15H. FIG. 15H illustrates detailed views of the portions of virtual environment 1510 that are displayed with reduced visual prominence. For instance, with respect to keyboard 1504c, the portion 1508c of virtual environment 1510 corresponding to keyboard 1504c that is displayed with reduced visual prominence has a shape that is slightly wider (e.g., larger) than keyboard 1504c such that the entirety of keyboard 1504c is visible to the user. In some embodiments, portion 1508c is displayed with a “feathering treatment” region 1509. In some embodiments, a feather treatment refers to reducing the visual prominence of the portion according to a gradient such that the maximum amount of reduction of visual prominence occurs in a portion of the portion of the virtual environment displayed with reduced visual prominence that is closest to the physical object, and while a minimum amount of reduction of visual prominence occurs in a portion of the first region that is furthest away from the physical object (e.g., the region that did not have its visual prominence reduced in response to detecting the first physical object within the physical environment). In the example of keyboard 1504c, the feathering treatment 1509 is displayed with a thickness that is based on the object that the portion 1508c corresponds to (e.g., keyboard 1504c).

In the example controller 1504a-1, the portion 1508a of virtual environment 1510 that is displayed with reduced visual prominence is displayed with a different shape that is based on the shape of controller 1504a-1 as shown in FIG. 15H. In some embodiments, the edges of the portion 1508a are farther away from controller 1504a-1 when compared to the edges of portion 1508c with respect to keyboard 1504c. In some embodiments, the distance is based on the propensity of movement of the object. Thus, as illustrated in FIG. 15H, the edge of portion 1508c is closer to keyboard 1504c versus the distance between the edge of portion 1508a and controller 1504a-1. With respect to controller 1504a-1, the feathering treatment region 1511 is thicker than feathering treatment region 1509 of portion 1508c.

With respect to person 1520, portion 1522 is displayed with a shape that allows for the shoulders, head, and face of the person 1520 to be visible while the feathering treatment region 1521 is thinner than region 1509 and region 1511.

FIG. 16 is a flowchart illustrating a method of reducing the visual prominence of virtual content that is obscuring visibility of one or more objects differently based on object type, in accordance with some embodiments. In some embodiments, the method 1600 is performed at a computer system (e.g., computer system 101 in FIG. 1A such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 1600 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1600 are, optionally, combined and/or the order of some operations is, optionally, changed.

In some embodiments method 1600 is performed at a computer system in communication with one or more display generation components and one or more input devices. In some embodiments, the computer system, display generation component, and input devices share one or more characteristics with the computer systems described with respect to methods 800, 1000, 1200, and/or 1400. In some embodiments, while displaying, via the one or more display generation components, first virtual content in a three-dimensional environment, such as content 1510 in FIG. 15B, the computer system detects (1602) a first physical object within a physical environment of a user of the computer system, wherein the first virtual content obscures at least a portion of a representation of the physical environment that includes the first physical object from a current viewpoint of the user of the computer system, such as the keyboard, mouse and controllers in FIG. 15B. In some embodiments, the three-dimensional environment shares one or more characteristics with the three-dimensional environments described with respect to methods 800, 1000, 1200, and/or 1400. In some embodiments, the first virtual content is a virtual content window that includes textual and/or graphical information that is viewable by the user of the computer system. In some embodiments, the first virtual content shares one or more characteristics with the user interface elements and/or virtual content described with respect to methods 1200 and 1400. In some embodiments, the first physical object is a virtual object (e.g., in the three-dimensional environment of the user). Alternatively, the first physical object is a physical object (e.g., in a physical environment of the user). In some embodiments, the object is being held by a hand of the user and thus shares one or more characteristics of the handheld objects described with respect to method 1400. In some embodiments, detecting the first physical object includes detecting from image data acquired by the computer system (for instance through one or more externally facing image sensors that are communicatively coupled to and/or part of the computer system) that the first physical object is present in the physical environment. In some embodiments, the first physical object is one of one or more predefined or identified objects that have been defined by the user of the computer system (e.g., objects eligible for breaking through virtual content) using a process such as described with respect to method 1200. Additionally or alternatively, the first physical object is one of one or more predefined objects that have been defined by the computer system (e.g., objects eligible for breaking through virtual content). In some embodiments, and using the acquired image data, the computer system (and/or a processor communicatively coupled to the computer system) uses image recognition to identify the first physical object in the environment of the user. In some embodiments, the first physical object includes physical items that are used by a user of the computer system such as a mobile phone, wallet, keyboard, mouse, controller, headphones, and/or other personal items. In some embodiments, the first physical object shares one or more characteristics with the objects described with respect to methods 1200 and/or 1400. In some embodiments, the first physical object is occluded by the first virtual content when all or a portion of the first physical object is behind the first content window from the viewpoint of the user of the computer system such that at least a portion and/or the entirety of the first physical object is not visible to the user of the computer system due to the first virtual content at least partially blocking the user's view of the first physical object.

In some embodiments, in response to detecting the first physical object within the physical environment (1604), in accordance with a determination that the first physical object is a first type of object, the computer system reduces (1606) a visual prominence of a first region of the first virtual content relative to the three-dimensional environment in a first manner so as to increase a visibility of a representation of the first physical object relative to the first virtual content in the three-dimensional environment from the current viewpoint of the user, such as shown with portion 1508a in FIG. 15B. In some embodiments, in response to detecting the first physical object within the physical environment, in accordance with a determination that the first physical object is a second type of object, different from the first type of object, the computer system reduces (1608) a visual prominence of a second region of the first virtual content relative to the three-dimensional environment in a second manner, different from the first manner so as to increase a visibility of a representation of the first physical object relative to the first virtual content in the three-dimensional environment from the current viewpoint of the user, such as shown with portion 1508c in FIG. 15B. In some embodiments, the first region is the same as the second region (e.g., same shape and/or size and/or location). In some embodiments, the first region is different from the second region (e.g., different shape and/or size and/or location). In some embodiments, the computer system, having identified the first physical object (as described above), determines if the identified object is a first type of object for instance by using a look-up table or similar list that includes associations between objects and types of object. For instance, if the computer system identifies a mobile phone in the three-dimensional environment, the computer system using a look-up-table determines that the mobile phone is a personal electronic device (e.g., a type of object), as the look-up table optionally stores the association between the mobile phone and the personal electronic device type. In some embodiments, multiple objects are associated with a common type of object. For instance, using the example of the personal electronic device type, in addition to a mobile phone, other types of electronic devices including tablet devices, personal organizers, music players, and/or other media content players are optionally also associated with the personal electronic device type, such that when the computer system determines that any of those devices is present in the acquired imaged data, the computer system identifies the objects as belonging to the personal electronic device type. In some embodiments, the associations between objects and types of objects are set by the user. In some embodiments, in accordance with identifying the first physical object as belonging to a certain object type (e.g., a first type of object and/or a second type of object), the computer displays one or more regions of the first virtual content with a visual prominence (e.g., reduced visual prominence) associated with the type of object. In some embodiments, reducing and/or modifying visual prominence includes modifying one or more visual characteristics that are applied to the first virtual content (or at least a portion of the first virtual content) so that the user is able to view the first physical object despite the first virtual content occluding the first physical object (e.g., being positioned closer to the viewpoint of the user than the first physical object, and intersecting with a vector extending from the viewpoint of the user to the first physical object). In some embodiments, and as described in further detail below, modifying the visual prominence of virtual content includes modifying one or more visual characteristics of the virtual content (and specifically the first region of the virtual content) such as but not limited to: shape, feather treatments, brightness, opacity, matting, and/or color. In some embodiments, reducing the visual prominence in a specific manner includes modifying a particular set of visual characteristics. Thus, in some embodiments, modifying the visual prominence in a first manner includes modifying one or more visual characteristics that are distinct from the one or visual characteristics that are modified when the visual prominence is reduced in the second manner. In some embodiments, reducing the visual prominence of the virtual content shares one or more characteristics of reducing visual prominence described with respect to methods 1200 and/or 1400. In some embodiments, the first physical object is a pre-defined type of object (such as described with respect to methods 1200 and 1400). In some embodiments, if it is determined that the first physical object is not one of the pre-defined types of objects, then the visual prominence of the first region and/or second region of the first virtual content is not modified. In some embodiments, the location of the first (and/or second) region with respect to the virtual content is based on the location of the first physical object relative to the virtual content (e.g., different for different locations of the first physical object relative to the virtual content). Displaying virtual content with reduced visual prominence, wherein the visual prominence is reduced in a manner that is based on a type of object that is occluded allows the computer system to provide customized visual access to objects. Customizing visual access to an object based on its type allows a user to view and/or interact with occluded objects without requiring additional user inputs to modify (e.g., move, minimize, and/or rescale) the virtual content to permit visual access to the object. Accordingly, by modifying visual prominence of virtual content based on object type, the computer system requires fewer user inputs, which translates to reduced processor tasking and reduced power consumption that would otherwise be needed to provide visual access to the object.

In some embodiments, the first type of object is a controller device, such as controller 1504a, and the second type of object is a keyboard input device, such as keyboard 1504c. In some embodiments, the controller device shares one or more characteristics with the controller device described with respect to methods 800 and 1000. For instance, in some embodiments the controller device is video game controller that includes a directional control (e.g., a joystick, d-pad, or thumbstick) and a plurality of buttons that are selectable by the user. In some embodiments the keyboard input device is a keyboard that is configured to allow the user to enter textual input to the computer system (for instance by including one or more buttons corresponding to letters that the user can select to enter the textual input). In some embodiments, the computer system upon determining that the first physical object is a controller device, reduces the visual prominence of the region by modifying a portion of the region that is similarly shaped to a controller device and/or in a shape that allows for the entire controller to be seen through the region. In the example of the keyboard, reducing the visual prominence of the second region (the portion of the virtual content that obscures the keyboard) by modifying a portion of the second region that is similarly shaped to the keyboard input device. Displaying virtual content with reduced visual prominence to allow for a controller device and/or a keyboard input device to visible when virtual content is obscuring the devices, wherein the visual prominence is reduced in a manner that is customized to the controller device and/or keyboard input device allows a user to view and/or interact with occluded devices without requiring additional user inputs to modify (e.g., move, minimize, and/or rescale) the virtual content to permit visual access to the devices. Accordingly, by modifying visual prominence of virtual content in a manner that is based on whether the object is a controller device and/or a keyboard input device, the computer system requires fewer user inputs, which translates to reduced processor tasking and reduced power consumption that would otherwise be needed to provide visual access to the object.

In some embodiments, the first type of object is a hand of a person (e.g., a hand of the user of the computer system) holding a controller device, such as hand 1505 in FIG. 15E, and the second type of object is the hand of a person (e.g., the user) that is not holding a controller device, such as hand 1505 in FIG. 15D. In some embodiments, the computer system differentiates the manner in which the visual prominence of the virtual content is reduced based on whether the object is a hand of the user or whether the object is the hand that is holding a controller device (or other input device). For instance, in the example of hand holding a controller, the region in which the visual prominence is reduced is larger in size than if the object is just hand that is not holding an input device. In some embodiments, the reduction of visual prominence that is used when the detected object is hand holding a controller versus just a hand differs not only in size but differs in other respects (e.g., visual characteristics) including but not limited to the feathering treatment, brightness, opacity, matting, and/or color. In some embodiments, the reduction in visual prominence used when the object is a hand holding a controller is configured to allow the user of the computer system to visualize what inputs are being selected on the controller (e.g., the direction control and/or the plurality of buttons) and is also configured to allow for visualization of the controller device when the controller device is moved by the hand (e.g., intentionally and/or unintentionally). In some embodiments, the reduction in the visual prominence of the virtual content when the object is a hand that is not holding any type of device is configured to minimize the area of the region that has reduced visual prominence that is beyond the bounds of the hand of the user. Displaying virtual content with reduced visual prominence to allow for a hand holding a controller device and/or a hand that is not holding a controller device to be more visible, wherein the visual prominence is reduced in a manner that is customized to the hand holding the controller device and/or the hand allows a user to view and/or interact with occluded devices and/or portions of the user without requiring additional user inputs to modify (e.g., move, minimize, and/or rescale) the virtual content to permit visual access to the devices. Accordingly, by modifying visual prominence of virtual content in a manner that is based on whether the object is a hand holding a controller device and/or a hand that is not holding a controller device, the computer system requires fewer user inputs, which translates to reduced processor tasking and reduced power consumption that would otherwise be needed to provide visual access to the object.

In some embodiments, the first type of object is a person in the physical environment of the user of the computer system, such as person 1520 in FIG. 15H, and the second type of object is a keyboard input device, such as keyboard 1504c in FIG. 15H. In some embodiments, the computer system detects at least a portion of a person (other than the user of the computer system) in the physical environment of the user and in response reduces the visual prominence of the first virtual content so as to make the representation of the user visible in the three-dimensional environment. In some embodiments, the portion of the person in the physical environment includes but is not limited to hands, arms, head, torso, and/or feet of the person. In some embodiments, the first manner includes but is not limited to reducing the visual prominence according to a particular shape that is in accordance with the shape of the portion of the person that has been detected. In some embodiments, the first manner includes reducing the visual prominence according to the one or more visual characteristics described herein. In some embodiments, the manner in which the visual prominence of the virtual content is reduced based on a determination that the object is a keyboard input device, shares one or more characteristics of the keyboard input device described above. Displaying virtual content with reduced visual prominence to allow for a person and/or a keyboard input device to be more visible, wherein the visual prominence is reduced in a manner that is customized to the type of object (e.g., portion of a person vs. keyboard input device) allows a user to view and/or interact with occluded devices and/or people present in the physical environment without requiring additional user inputs to modify (e.g., move, minimize, and/or rescale) the virtual content to permit visual access to the devices. Accordingly, by modifying visual prominence of virtual content in a manner that is based on whether the object is a another person in the physical environment and/or a keyboard input device, the computer system requires fewer user inputs, which translates to reduced processor tasking and reduced power consumption that would otherwise be needed to provide visual access to the object.

In some embodiments, the first region has a first shape, such as the shape of region 1508c in FIG. 15H, the second region has a second shape, such as the shape of region 1508a in FIG. 15H, and the second shape is different from the first shape. In some embodiments, the reduction in visual prominence of a region of the visual content is performed according to a particular shape. For instance, the reduction in visual prominence is applied to the region in a portion of the region that is a particular shape such that the visual characteristics within the boundary of the shape are modified to reduce the visual prominence of the region. For instance, in the example where the shape is a circle, the modification of the visual characteristics are applied to a circular shaped portion of the region. In some embodiments, the center of the circular shaped portion coincides with a detected center of the object such that the circular region surrounds the object. In some embodiments, the shapes include but are not limited to a rectangle, circle, pear, oval, and/or capsule shape. In some embodiments, the shape corresponds to the object type that corresponds to the physical object. For instance, in the event that the computer system determines that the physical object is a keyboard input device, the portion of the first region that the visual prominence is reduced over is a rectangular shape, thus coinciding with the expected shape of a keyboard input device. Similarly, if the object is a controller device, the shape is a capsule shape to coincide with the expected shape of a controller device. Displaying virtual content with reduced visual prominence according to shape that is based on the type of object detected allows a user to view and/or interact with occluded devices and/or portions of the user without requiring additional user inputs to modify (e.g., move, minimize, and/or rescale) the virtual content to permit visual access to the devices. Accordingly, by modifying visual prominence of virtual content according to a shape that is based on the type of object, the computer system requires fewer user inputs, which translates to reduced processor tasking and reduced power consumption that would otherwise be needed to provide visual access to the object.

In some embodiments, the first shape is asymmetrical, such as the shape of the portion of the virtual content that is reduced in visual prominence for the hand and/or controller in FIG. 15E. In some embodiments, in accordance with a determination that the first physical object has a first orientation of the object relative to the three-dimensional environment, the first shape has a first orientation of the first shape relative to the three-dimensional environment, such as the orientation of the hand and/or controller in FIG. 15E, and in accordance with a determination that the first physical object has a second orientation of the object, different from the first orientation of the object, relative to the three-dimensional environment, the first shape has a second orientation of the first shape, different from the first orientation of the first shape, relative to the three-dimensional environment, such as if the orientation of the hand and/or controller in FIG. 15E were different. In some embodiments, the shape is asymmetrical so as to accommodate objects that themselves are asymmetrical (e.g., so as to make it more likely that the reduction in visual prominence makes the entirety of the physical object visible through the visual content). Thus, in some embodiments, since the asymmetry is based on the expected shape of the object, the displayed orientation of the region in which the visual prominence is reduced is based on the orientation of the physical object relative to three-dimensional environment so as to increase the probability that the shape of the reduced visual prominence region is aligned with the orientation of the physical object. For instance, in the example where the shape is an egg shape (e.g., an asymmetric shape) the egg-shaped region of reduced visual prominence is oriented so that the larger portion of the egg (e.g., the bottom) is aligned with a portion and/or dimension of the physical object that is larger to increase the probability that the physical object will be visible to the user of the computer system. Displaying virtual content with reduced visual prominence that is based on the orientation of the physical object increases the probability that the entirety of the physical object will be visible, thus allowing a user to view and/or interact with occluded devices and/or portions of the user without requiring additional user inputs to modify (e.g., move, minimize, and/or rescale) the virtual content to permit visual access to the devices. Accordingly, by modifying visual prominence of virtual content according to a shape that is based on the type of object, the computer system requires fewer user inputs, which translates to reduced processor tasking and reduced power consumption that would otherwise be needed to provide visual access to the object.

In some embodiments, the second shape is asymmetrical; In some embodiments, in accordance with a determination that the first physical object has an orientation of the object relative to the three-dimensional environment, the second shape has a first orientation of the second shape relative to the three-dimensional environment, and in accordance with a determination that the first physical object has a second orientation of the object, different from the first orientation of the object, relative to the three-dimensional environment, the second shape has a second orientation of the second shape, different from the first orientation of the second shape, relative to the three-dimensional environment. In some embodiments, the shape is asymmetrical so as to accommodate objects that themselves are asymmetrical (e.g., so as to make it more likely that the reduction in visual prominence makes the entirety of the physical object visible through the visual content). Thus, in some embodiments, since the asymmetry is based on the expected shape of the object, the displayed orientation of the region in which the visual prominence is reduced is based on the orientation of the physical object relative to three-dimensional environment so as to increase the probability that the shape of the reduced visual prominence region is aligned with the orientation of the physical object. For instance, in the example where the shape is an egg shape (e.g., an asymmetric shape) the egg-shaped region of reduced visual prominence is oriented so that the larger portion of the egg (e.g., the bottom) is aligned with a portion and/or dimension of the physical object that is larger to increase the probability that the physical object will be visible to the user of the computer system. Displaying virtual content with reduced visual prominence that is based on the orientation of the physical object increases the probability that the entirety of the physical object will be visible, thus allowing a user to view and/or interact with occluded devices and/or portions of the user without requiring additional user inputs to modify (e.g., move, minimize, and/or rescale) the virtual content to permit visual access to the devices. Accordingly, by modifying visual prominence of virtual content according to a shape that is based on the type of object, the computer system requires fewer user inputs, which translates to reduced processor tasking and reduced power consumption that would otherwise be needed to provide visual access to the object.

In some embodiments, reducing the visual prominence of the first region in the first manner comprises reducing a visual prominence of an edge region of the first region according to a first feather treatment, wherein the first feather treatment defines a transition between the visual prominence of the first region of the first virtual content and a visual prominence of a third region of the first virtual content outside of the first region of the first virtual content that did not have its visual prominence reduced in response to detecting the first physical object within the physical environment, such as shown with the edge region of region 1508c in FIG. 15H, and reducing the visual prominence of the second region in the second manner comprises reducing a visual prominence of an edge region of the second region according to a second feather treatment, different from the first feather treatment, wherein the second feather treatment defines a transition between the visual prominence of the second region of the first virtual content and a visual prominence of a fourth region of the first virtual content outside of the second region of the first virtual content that did not have its visual prominence reduced in response to detecting the first physical object within the physical environment, such as shown with the edge region of region 1508a in FIG. 15H. In some embodiments, reducing the visual prominence of the first region includes applying a feather treatment to the first region. In some embodiments, applying a feather treatment refers to reducing the visual prominence of the first region according to a gradient such that the maximum amount of reduction of visual prominence occurs in a portion of the first and/or second region that is closest to the physical object, and while a minimum amount of reduction of visual prominence occurs in a portion of the first region that is furthest away from the physical object (e.g., the region that did not have its visual prominence reduced in response to detecting the first physical object within the physical environment). Similarly, the second region also has a feather treatment applied to it that shares one or more characteristics with the feather treatment applied to the first region. In some embodiments, the first feather treatment and the second feather treatment differ in one or more ways including but not limited to, the distance from the physical object at which the visual prominence begins to reduce, the rate of the gradient, and/or the distance from the physical object that the reduction in visual prominence is no longer displayed. Reducing the visual prominence of region according to a feather treatment that is based on the type of physical object enhances user interactions with the computer system by improving processing time needed to reduce the visual prominence of portions of the virtual content that occludes the physical object and improving visibility of the physical object without requiring receiving a user input, and thus reducing the number of inputs needed to interact with the virtual object thereby conserving additional computing resources needed for additional inputs.

In some embodiments, reducing the visual prominence of the edge region of the first region according to the first feather treatment comprises displaying, via the one or more display generation components, a boundary of the first region at a first distance from a boundary of the first physical object, such as the distance between the boundary of region 1508a and controller 1504a in FIG. 15H, and reducing the visual prominence of the edge region of the second region according to the second feather treatment comprises displaying, via the one or more display generation components, a boundary of the second region at a second distance, different from the first distance, from a boundary of the first physical object, such as the distance between the boundary of region 1508c and keyboard 1504c in FIG. 15H. In some embodiments, an edge region of the first region and/or second region refers to the portion of the region where the gradient in the reduction of visual prominence begins. Thus, in some embodiments, from a center portion of the displayed visual object, to the edge region of the first region, the computer system displays the first region according to a uniform level of visual prominence, and beginning from the edge region an outer edge of the first, a gradient is applied to the amount of reduction of visual prominence until at the edge of the first region there is no more reduction in visual prominence is displayed. In some embodiments, a difference between the first feather treatment and the second feather treatment includes the distance from the physical object that the feather treatment begins and/or the distance between an outer edge of the feather treatment and the beginning of the feather treatment. For instance, in the first feather treatment, the edge of the feather treatment is closer to the outer edge of the first region when compared to the second feather treatment. In some embodiments, the manner in which the feather treatment is applied to the first region is based on an estimate and/or measurement of the stability of the first physical object. For instance, for a physical object that is likely to move while being displayed in the three-dimensional environment (e.g., a hand holding a controller device), the distance between the physical object (e.g., a center of the physical object) and the edge of the feather treatment is greater than the distance for an object that is stable (e.g., a keyboard). Reducing the visual prominence of region according to a feather treatment in which the distance from the edge of the feather treatment to the physical object is based on the stability of the physical object in the three-dimensional environment enhances user interactions with the computer system by improving processing time needed to reduce the visual prominence of portions of the virtual content that occludes the physical object and improving visibility of the physical object without requiring receiving a user input, and thus reducing the number of inputs needed to interact with the virtual object thereby conserving additional computing resources needed for additional inputs.

In some embodiments, reducing the visual prominence of the first region of the first virtual content relative to the three-dimensional environment in the first manner comprises updating, via the one or more display generation components, one or more characteristics of the first region at a first frequency over time, such as the keyboard update frequency in FIG. 15B, and reducing the visual prominence of the second region of the first virtual content relative to the three-dimensional environment in the second manner comprises updating one or more characteristics of the second region at a second frequency, different from the first frequency, over time, such as the controller update frequency in FIG. 15B. In some embodiments, the displayed first region and/or second regions are updated (e.g., one or more characteristics of the regions are refreshed) according to a frequency that is based on the type of physical object. For instance for an object that is less likely to move (e.g., a keyboard) the region in which the visual prominence is reduced refreshes at a first frequency (e.g., 1, 10, 20, or 30 Hz). For an object that more likely to move (e.g., a controller device that is being held by a hand) the region in which the visual prominence is reduced refreshes at a second frequency that is faster than the first frequency (e.g., 10, 20, 30, 40, 50, or 60 Hz). In the event that the physical object moves between refreshes of the first region, the computer system updates the location of the first region to correspond to the moved location of the physical object. Thus, for physical object that are more likely to move, a higher frequency rate of refresh of the region ensures that the motion of the physical object is tracked by the region in which the visual prominence is reduced. In some embodiments, the characteristics of the regions that are refreshed include, but are not limited to the location, shape, size, orientation, and/or visual prominence of the region. In some embodiments, the characteristics that are refreshed are controlled according to the examples described herein. Updating a region in which the visual prominence is reduced at a frequency that is based on the type of physical object enhances user interactions with the computer system by improving processing time needed to reduce the visual prominence of portions of the virtual content that occludes the physical object, reducing power by lowering the frequency of updates for certain objects, and improving visibility of the physical object without requiring receiving a user input, and thus reducing the number of inputs needed to interact with the virtual object thereby conserving additional computing resources needed for additional inputs.

In some embodiments, the first type of object is a handheld object, such as controller 1504a, the second type of object is a non-handheld object, such as keyboard 1504c, and the first frequency is higher than the second frequency, such as shown with the controller and keyboard frequencies in FIG. 15B. In some embodiments, the region in which the visual prominence is reduced corresponds toa handheld object (e.g., a controller device) and accordingly the update frequency of the region will be higher (e.g., more frequent) that an update frequency of the region corresponding to a non-handheld object (e.g., an object that normally sits on desk such as a keyboard input device). In some embodiments, a handheld object is more likely to move within the three-dimensional environment than a non-handheld object and thus regions of the virtual content corresponding to object types that are handheld receive more frequent updates (e.g., are refreshed at a higher frequency) than regions that correspond to non-held objects. Updating a region in which the visual prominence is reduced at a frequency that is based on whether the physical object is generally handheld or is non-handheld enhances user interactions with the computer system by improving processing time needed to reduce the visual prominence of portions of the virtual content that occludes the physical object and improving visibility of the physical object without requiring receiving a user input, and thus reducing the number of inputs needed to interact with the virtual object thereby conserving additional computing resources needed for additional inputs.

In some embodiments, while displaying, via the one or more display generation components, the first virtual content in the three-dimensional environment, the computer system detects, via the one or more input devices, a hand of the user of the computer within the physical environment of the user of the computer system, such as hand 1505 in FIG. 15D, wherein the first virtual content obscures at least a portion of a representation of the physical environment that includes the hand of the user from the current viewpoint of the user, and, wherein a position of the hand of the user is between a position corresponding to the first virtual content and the current viewpoint of the user. In some embodiments, the computer system ensures that the hand of the user is visible in the three-dimensional environment based on the location of the hands with respect to content in the three-dimensional environment. For instance, when the position of the hand of the user is between the first virtual content and the current viewpoint, to ensure that the hands are visible, the computer system reduces the visual prominence of the virtual content (or some portion thereof) corresponding to the location of the hands, such that the hands are visible to the user of the computer system (e.g., from the current viewpoint of the user).

In some embodiments, in response to detecting the hand of the user within the physical environment, the computer system reduces, via the one or more display generation components, a visual prominence of a third region of the first visual content in the three-dimensional environment from the current viewpoint of the user so as to increase a visibility of a representation of the hand of the user relative to the first virtual content in the three-dimensional environment from the current viewpoint of the user, such as shown with hand 1505 and virtual content 1510 in FIG. 15D, wherein a shape of the third region is a first shape that corresponds to a profile of an outer boundary of a portion of the hand of the user that is facing the current viewpoint of the user, such as shown with hand 1505 and virtual content 1510 in FIG. 15D. In some embodiments, reducing the visual prominence of the third region shares one or more characteristics with the reduction of visual prominence associated with the first and second regions described herein. In some embodiments reducing the visual prominence according to a first shape shares one or more characteristics of the reduction of visual prominence of a region described with respect to methods 1200 and/or 1400. In some embodiments, the third region is centered on the detected hand of the user, such that as the computer system determines that the location of the hand moves in the three-dimensional environment, the computer system correspondingly moves the location of the third region. In some embodiments, a shape of the third region is based on the shape of the hand of the user, for instance, the shape of the third region is in the shape of a glove cutout (e.g., a profile of an outer boundary of the portion of the hand of the user that is facing the current viewpoint of the user) with the size of the glove cutout being slightly larger than the size of the hand (so as to make the entirety of the portion of the hand that is facing the current viewpoint of the user visible).

In some embodiments, while the third region of the first virtual content with the first shape has the reduced visual prominence, the computer system detects, via the one or more input devices, that the hand of the user is holding a second physical object that is within the physical environment, such as hand 1505 holding the controller in FIG. 15E, and in response to detecting that the hand of the user is holding the second physical object, the computer system modifies the shape of the third region from the first shape to a second shape, different from the first shape, such as the modified shape of the portion of the virtual content that is reduced in visual prominence in FIG. 15E, wherein the third region with the second shape has a reduced visual prominence relative to the first virtual content and wherein the second shape does not correspond to a profile of an outer boundary of a portion of the hand of the user that is facing the current viewpoint of the user. In some embodiments, when the hand is detected as holding a physical object (e.g., the second physical object), the computer system modifies the shape of the third region by expanding the boundary so that the second shape encompasses both the hand of the user as well as the physical object. For instance, when the hand is detected as holding a controller device (for instance as described with respect to methods 800 and 1000), the shape of the third region changes from the glove cutout that is centered on the hand, to a capsule shape that encompasses both the hand and the controller device. In some embodiments, when the computer system detects that the hand holding the controller device has moved, the computer system correspondingly moves the location of the third region with the second shape. In some embodiments, if the computer system subsequently detects that the hand is no longer holding the second physical object, the computer system returns the shape of the third region to the first shape (e.g., the glove cutout). In some embodiments, the shape of the third region has a shape that corresponds to an outer boundary of the second physical object and/or the hand of the user that is facing the current viewpoint of the user. In some embodiments, and in response to detecting that the hand is no longer holding the second physical object, the computer system re-displays a fourth region corresponding to a portion of the virtual content that is obscuring the second physical object with a reduced visual prominence that shares one or more characteristics with the reduction in visual prominence described herein. Modifying a shape of a region that is displayed at reduced visual prominence from a first shape that corresponds to a hand, to a second shape that corresponds to a hand holding a physical object enhances user interactions with the computer system by improving processing time needed to reduce the visual prominence of portions of the virtual content that occludes the physical object and improving visibility of the physical object without requiring receiving a user input, and thus reducing the number of inputs needed to interact with the virtual object thereby conserving additional computing resources needed for additional inputs.

In some embodiments, while displaying, via the one or more display generation components, the first virtual content in the three-dimensional environment, the computer system detects, via the one or more input devices, a hand of the user of the computer within the physical environment of the user of the computer system, wherein the first virtual content obscures at least a portion of a representation of the physical environment that includes the hand of the user from the current viewpoint of the user, such as hand 1505 in FIG. 15D.

In some embodiments, a position of the hand of the user is between a position corresponding to the first virtual content and the current viewpoint of the user, and in response to detecting the hand of the user within the physical environment, the computer system reduces, via the one or more display generation components, a visual prominence of a third region of the first visual content in the three-dimensional environment from the current viewpoint of the user so as to increase a visibility of a representation of the hand of the user relative to the first virtual content in the three-dimensional environment from the current viewpoint of the user, wherein a shape of the third region is a first shape that corresponds to a profile of an outer boundary of a portion of the hand of the user that is facing the current viewpoint of the user, such as the shape of the portion of virtual content 1510 that is reduced in visual prominence in FIG. 15D. In some embodiments, the first shape of the of the third region shares one or more characteristics with the shape of the reduction of visual prominence described herein and with respect to methods 1200 and/or 1400. In some embodiments, the third region is centered on the detected hand of the user, such that as the computer system determines that the location of the hand moves in the three-dimensional environment, the computer system correspondingly moves the location of the third region. In some embodiments, a shape of the third region is based on the shape of the hand of the user, for instance, the shape of the third region is in the shape of a glove cutout (e.g., a profile of an outer boundary of the portion of the hand of the user that is facing the current viewpoint of the user) with the size of the glove cutout being slightly larger than the size of the hand (so as to make the entirety of the portion of the hand that is facing the current viewpoint of the user visible). In some embodiments, a shape of the third region is based on the shape of the hand of the user (e.g., the profile of the outer boundary of the hand facing the current viewpoint of the user), for instance, the shape of the third region is in the shape of a glove cutout with the size of the glove cutout being slightly larger than the size of the hand (so as to make the entirety of the hand visible).

In some embodiments, while the third region of the first virtual content with the first shape has the reduced visual prominence, the computer system detects, via the one or more input devices, that the hand of the user is holding a second physical object that is within the physical environment, such as the controller in FIG. 15F, and in response to detecting that the hand of the user is holding the second physical object, and while the third region has the reduced visual prominence, the computer system reduces, via the one or more display generation components, a visual prominence of a fourth region of the first visual content, different from the third region so as to increase a visibility of a representation of the second physical object relative to the first virtual content in the three-dimensional environment from the current viewpoint of the user, wherein a location of the fourth region in the three-dimensional environment is based on a location of the second physical object in the three-dimensional environment, such as shown with the portion of the virtual content 1510 with reduced prominence in FIG. 15F. In some embodiments, when the hand is detected as holding a physical object (e.g., the second physical object), the computer system concurrently displays the third region of the virtual content with the reduced visual prominence with a fourth region of the virtual content at a reduced visual prominence so that collectively, the third region and the fourth region encompasses both the hand of the user as well as the physical object. In some embodiments, the combined shape of the third and fourth regions is different from a shape of a region in which the both the hand and object are made visible in a displayed single region of visual prominence, such as the modified third region described previously with reference to the third region with the second shape that does not correspond to a profile of an outer boundary of a portion of the hand of the user that is facing the current viewpoint of the user. In some embodiments, the while the hand is holding the physical object, the third region and the fourth region appear connected from the perspective of the user, such that that they appear to form a single region on the visual content of reduced visual prominence. In some embodiments, the shape of the fourth region does not have a shape that corresponds to an outer boundary of the second physical object and/or the hand of the user that is facing the current viewpoint of the user. In some embodiments, when the computer system detects that hand is no longer holding the second physical object, the computer system separates the third region and the fourth region so that the third region corresponds to the location of the hand of the user in the three-dimensional environment, while the fourth region corresponds to the location of the second physical object in the three-dimensional environment. Combining a third region of reduced visual prominence corresponding to a hand of the user with a fourth region of reduced visual prominence corresponding to a physical object, when the computer system detects that the hand is holding the physical object enhances user interactions with the computer system by improving processing time needed to reduce the visual prominence of portions of the virtual content that occludes the physical object and improving visibility of the physical object without requiring receiving a user input, and thus reducing the number of inputs needed to interact with the virtual object thereby conserving additional computing resources needed for additional inputs.

It should be understood that the particular order in which the operations in method 1600 have been described is merely exemplary and is not intended to indicate that the described order is the only order in which the operations could be performed. One of ordinary skill in the art would recognize various ways to reorder the operations described herein. In some embodiments, aspects/operations of method 1600 may be interchanged, substituted, and/or added between these methods. For example, various object manipulation techniques and/or object movement techniques of method 1600 is optionally interchanged, substituted, and/or added between these methods. For brevity, these details are not repeated here.

FIGS. 17A-17BB illustrate methods of and systems scrolling through paginated content based on a range of positions of input from a directional control in accordance with some embodiments of the disclosure.

FIG. 17A illustrates a computer system 101 (e.g., an electronic device) displaying, via a display generation component 120 (e.g., display generation components 1-122a and 1-122b of FIG. 1), a three-dimensional environment 1700 from a viewpoint of a user of the computer system 101.

In FIG. 17A, the display generation component 120 includes one or more internal image sensors 114a oriented towards the face of the user (e.g., eye tracking cameras 540 described with reference to FIG. 5). In some embodiments, internal image sensors 114a are used for eye tracking (e.g., detecting a gaze of the user). Internal image sensors 114a are optionally arranged on the left and right portions of display generation component 120 to enable eye tracking of the user's left and right eyes. Display generation component 120 also includes external image sensors 114b and 114c facing outwards from the user to detect and/or capture the physical environment and/or movements of the user's hands.

As shown in FIG. 17A, computer system 101 captures one or more images of the physical environment around computer system 101 (e.g., operating environment 100 of FIG. 1), including one or more objects in the physical environment around computer system 101. In some embodiments, computer system 101 displays representations of the physical environment in three-dimensional environment 1700. For example, three-dimensional environment 1700 includes representations of the rear and side walls of the room in which the computer system 101 is located.

As discussed in more detail below, in FIG. 17A, display generation component 120 is illustrated as displaying one or more virtual objects in the three-dimensional environment 1700. In some embodiments, the one or more virtual objects are displayed by a single display (e.g., display 510 of FIG. 5) included in display generation component 120. In some embodiments, display generation component 120 includes two or more displays (e.g., left and right display panels for the left and right eyes of the user, respectively, as described with reference to FIG. 5) having displayed outputs that are merged (e.g., by the user's brain) to create the view of the virtual objects shown in FIGS. 17A-17BB.

Display generation component 120 has a field of view (e.g., a field of view captured by external image sensors 114b and 114c and/or visible to the user via display generation component 120) that corresponds to the virtual objects shown in FIG. 17A. Because display generation component 120 is optionally a head-mounted device, the field of view of display generation component 120 is optionally the same as or similar to the field of view of the user.

In some embodiments, a user interface illustrated and described below could also be implemented on a head-mounted display that includes the display generation component 120 that displays the user interface or three-dimensional environment to the user, and sensors to detect the physical environment and/or movements of the user's hands (e.g., external sensors facing outwards from the user), and/or attention (e.g., gaze) of the user (e.g., internal sensors facing inwards towards the face of the user) such as movements that are interpreted by the computer system as gestures such as air gestures. Additionally, in some embodiments, input to computer system 101 is provided via air gestures from hand (e.g., hand 406 of FIG. 4) and/or attention of the user (e.g., as described in more detail with reference to method 800), or via a trackpad from hand 406, and inputs described herein are optionally received via the trackpad or via air gestures/attention.

In the example of FIG. 17A, computer system 101 displays, three-dimensional environment 1700 which includes virtual representations of physical objects that are visible within the field of view of image sensors 114a-c. For instance, window 1702 is a virtual representation of a real-world physical window that is visible within the field of view of image sensors 114a-c. In some embodiments, superimposed on the representation of the users physical environment, computer system 101 displays a first page of selectable content A1-A6 within three-dimensional environment 1700. As illustrated in page view 1708, selectable content items A1-A6 illustrated in the example of FIG. 17A represent a first page of selectable content items, in a set of content items that span across multiple pages (e.g., page 1, 2, 3, 4, and beyond). In some embodiments, computer system 101 displays a visual indicator 1704 that is configured to provide the user with a visual indication as to which page they are currently viewing, when the users is viewing a paginated set of selectable content items (or other paginated content). In some embodiments, and as described in further detail below, computer system displays sets of content items on a page-by-page basis or on a gradual basis depending on inputs received from hardware controllers 1701a-b. Current view 1718 in page view 1708 indicates which set of selectable content items are currently being displayed by computer system 101. For instance, as illustrated in the example of FIG. 17A, computer system 101 displays the selectable content items which are part of the first page, without displaying selectable content items that are part of the other pages.

In some embodiments, computer system 101 gradually scrolls the paginated set of content items in response to detecting inputs provided by the user on one or more hardware controllers as illustrated in the example of FIG. 17B. In the example of FIG. 17B, in response to a user input provided at directional input 1720 of controller 1701a, computer system 101 scrolls the set of content items in a gradual manner such that a portion of the set of content items belonging to page one are displayed and a portion of the set of content items belonging to page two are also displayed. For instance, as illustrated by displacement view 1710 (which is a diagram that represents the displacement of directional input 1720 in both magnitude and direction), the input at directional input 1720 is to the left in direction and is within a first displacement zone 1712 (e.g., the magnitude to the displacement is within a range of magnitudes associated with displacement zone 1712. In some embodiments, in response to detecting the input 1722 at directional input 1720 (and optionally in response to detecting gaze 1716 of the user directed to the selectable content items) having a magnitude and direction as indicated in displacement view 1710, computer system 101 scrolls the selectable content items gradually such that a portion of both page one and page two (as represented by current view 1718 of page view 1708) are displayed.

As illustrated in FIG. 7B, in response to input 1722, computer system 101 scrolls the selectable content items to the left so that selectable content items A3-A6 (which are part of the set of selectable content items belonging to page one) are visible and so that selectable content items B1-B2 (which are part of the set of selectable content items belonging to page two) are visible as well. In response to input 1722, computer system 101 ceases displayed selectable content items A1-A2, since those items have been scrolled off the current view 1718 of computer system 101. In some embodiments, when the input to directional input 1720 is terminated, computer system 101 maintains the current view 1718 until the user provides additional input as illustrated in FIG. 17C.

In some embodiments, the speed at which the selectable content items are gradually scrolled is based on the magnitude of the displacement of the directional input 1720 when an input is applied. For instance, as illustrated in the examples of FIG. 17B, in response to input 1722, computer system 101 scrolls the selectable content items at a speed indicated by speed indicator 1706. However, in the example of FIG. 17D, in response to input 1724 which is in the same direction as input 1722 but is displaced further than input 1722, computer system 101 scrolls the selectable content items at a higher speed as indicated by speed indicator 1706 in FIG. 17D. Continuing with the example of FIG. 17D, in response to input 1724, computer system 101 scrolls the selectable content items further to the right such that less of the content items associated with page one of the scrollable content are visible and more of the content items associated with page two of the scrollable content are visible. For instance, as illustrated in FIG. 17D, in response to input 1724, selectable content items A5-A6 are now visible (with selectable content items A3-A4 no longer being displayed) while selectable content items B1-B4 which are associated with page two of the content are now visible (with content items B3-B4 being newly displayed in response to input 1724). In the examples from ranging from FIG. 17A-17D, in response to inputs that are within displacement zone 1712 of directional input 1720, computer system 101 has gone from displaying all of the selectable content items associated with page one of the content items, to displaying on ⅓ of the content items associated with page one. Accordingly, computer system 101 has gone from displaying none of the selectable content items associated with page two, to displaying ⅔ of the content items associated with page two.

In some embodiments, and alternatively to the example of FIG. 17C, in some embodiments, in response to detecting termination of an input to directional input 1720, computer system “snaps” the current view 1718 to the closest page boundary as illustrated in FIG. 17E. Ine the example of FIG. 17E, in response to detecting termination input 1724 (from FIG. 17D) to directional input 1720, computer system 101 snaps the current view 1718 to page two of the selectable content items and thus displays all of the selectable content items associated with page two (e.g., selectable content items B1-B6). In some embodiments, computer system 101 snaps the current view to the nearest page boundary. For instance, referring back to the example of FIG. 17D, since the right side of current view 1718 was closer to the right boundary of page two versus the right side of current view and its distance to the boundary of page one, computer system 101 snapped the current view 1718 to page two. As further illustrated in FIG. 17E, computer system 101 updates visual indicator 1704 to indicate that page two of the selectable icons is being displayed.

In some embodiments, the direction of scrolling is based on the direction of the input applied to directional input 1720 of controller 1701a as illustrated in FIG. 17F. In the example of FIG. 17F, computer system 101 detects the user applying input 1726 to directional input 1720 of controller 1701a. As indicated by displacement view 1710, input 1726 is in the opposite direction of inputs 1722 and 1724. In the example of FIG. 17F, in response to input 1726, computer system 101 scrolls the selectable content items to the right, such that selectable content items A5-A6 associated with page one are re-displayed while selectable content items B5-B6 are no longer displayed as they have been scrolled off the current view 1718.

In some embodiments, in addition to gradually scrolling the paginated selectable content items as discussed in the examples of FIGS. 17A-17F, computer system 101 scrolls and displays the selectable content items on a page-by-page basis in response to inputs on the directional input that satisfy certain criteria as illustrated in the examples of FIG. 17G. In the example of FIG. 17G, while computer system 101 displays page one of the selectable content items (e.g., as indicated by current view 1718 of page view 1708), computer system 101 detects input 1728 being applied by the user to directional input 1720 of controller 1701a. As indicated in displacement view 1710, the magnitude of the displacement of input 1720 is within a second displacement zone 1714 that is farther (e.g., greater in magnitude) than displacement zone 1712 described above (e.g., the range of magnitudes associated with displacement zone 1714 is greater than the range of magnitudes associated with displacement zone 1712.

As illustrated in the example of FIG. 17H, in response to input 1728 (illustrated in FIG. 17G), computer system 101 displays selectable content items B1-B6 which are associated with page two of the paginated selectable content items. As indicated by current view 1718 of page view 1708, the entirety of page two is displayed with no parts of adjacent pages (e.g., page one or page three) in response to detecting input 1728 applied in the example of FIG. 17G. Thus, in contrast to the examples of FIGS. 17A-17F, in response to directional inputs that are within the second displacement zone, computer system 101 wholly replaces the selectable content items that are displayed, rather than gradually scrolling selectable items one column at a time so that portions of selectable content items belonging to different pages are displayed simultaneously.

In some embodiments, in response to a persistent input (e.g., an input that is held for a period of time), computer system 101 continuously scrolls the selectable content items on a page-by-page basis as illustrated in the examples of FIGS. 17H-17J. Continuing from the example of FIG. 17H, computer system 101 detects that input 1728 is continuously applied even after computer system 101 has scrolled the selectable content items to page two. In some embodiments, in response to scrolling the selectable content items to page two and in response to detecting that input 1728 is still being applied to the directional input 1720 of controller 1701a, computer system 101 initiates a timer that begins when the computer system scrolls to page two as indicated at timer 1760. In some embodiments, and in response to detecting that input 1728 is being maintained despite having scrolled the selectable content items, computer system 101 maintains displaying page two of the paginated selectable content items, until the time at timer 1760 crosses a threshold duration 1762 as illustrated in the example of FIG. 17I.

In the example of FIG. 17I, in response to detecting the time at timer 1760 exceeding threshold 1762, computer system 101 scrolls the selectable content items such that the content items associated with page three (e.g., selectable content items C1-C6) are displayed as illustrated in the current view 1718 of page view 1708. Thus, in some embodiments, computer system 101 when detecting a persistent input at directional input 1720 that is of magnitude within displacement zone 1714, scrolls to a new page, and then waits for a pre-defined amount of time (e.g., based on threshold 1762) before again scrolling to another page.

In some embodiments, the threshold 1762 of timer 1760 decreases as the duration of the input increases as illustrated in the examples of FIG. 17J-17K. In the example of FIG. 17J, computer system 101 is now displaying page 9 of the scrollable content items in response to detecting input 1728 being held over time (e.g., after having already scrolled through pages 4-8). In some embodiments, in response to detecting that the duration of input 1728 is increasing, computer system 101 decreases threshold 1762 of timer such that page 9 is displayed for a shorter duration before being scrolled to page 10 (shown in FIG. 17K) compared to the amount of time that page two was displayed before being scrolled to page three (shown in FIGS. 17H-17I).

In some embodiments, the direction of paginated scrolling (e.g., page-by-page scrolling) is based on the direction of the input at the directional input of the controller as illustrated in the examples of FIG. 17K-17L. As illustrated in FIG. 17K, computer system 101 detects input 1730 being applied to directional input 1720 of controller 1701a as indicated at displacement view 1710. In some embodiments, input 1730 is in the opposite direction of input 1728 but is still of a magnitude that is within the range of magnitudes of displacement zone 1714. In response to input 1720 (and optionally while gaze 1716 is directed to the selectable content items), computer system scrolls the selectable items to display selectable items H1-H6 as illustrated in FIG. 17L. In the example of FIG. 17L, the direction of scrolling from the example of FIG. 17K is in the opposite direction of scrolling illustrated in the examples of FIG. 17J-17K, since input 1730 is in the opposite direction of input 1728.

In some embodiments, in response to detecting modification to the displacement of an input, computer system 101 modifies the scrolling behavior associated with the input as illustrated in the examples of FIGS. 17L-17M. In the example of FIG. 17L, computer system 101 detects that input 1730 has been modified. For instance, computer system detects that the user has modified the input to directional control 1720 by modifying the magnitude of displacement such that input 1730 is now within displacement zone 1712 instead of within displacement 1714 in the example of FIG. 17K. As previously discussed, displacement zone 1712 is associated with gradual scrolling whereas displacement zone 1714 is associated with page-by-page scrolling. Thus, in response to detecting that input 1730 has been modified such that it is within displacement zone 1712, computer system 101 modifies the scrolling behavior associated with input 1730 to perform gradual scrolling as illustrated in the example of FIG. 17M.

In the example of 17M, in response to the modification of input 1730, computer system 101 gradually scrolls the selectable content items such that a portion of the selectable content items associated with page 7 (e.g., selectable content items G5-G6) and a portion of the selectable content items associated with page 8 (e.g., selectable content items H1-H4) are concurrently displayed on display generation component 120 as indicated by current view 1718 of page view 1708. In the example of FIG. 17M, computer system 101 detects that the user further modifies input 1730 so as to return input 1730 into displacement zone 1714 as indicated at displacement view 1710. In response to detecting the modification, computer system resumes scrolling the selectable items on a page-by page basis as illustrated in FIG. 17N. As illustrated in FIG. 17N, computer system 101 scrolls to page 7 of the selectable content items in response to detecting modification of input 1730 into displacement zone 1714 in the example of FIG. 17M.

In some embodiments, the selectable content items are selectable to view content and/or applications as illustrated in the examples of FIGS. 17N-O. In the example of FIG. 17N, computer system 101 detects that the user applies an input to controller 1701b and further detects that the gaze of the user 1716 is directed to selectable content item G2 and in response opens a content item associated with selectable content item G2 as illustrated in FIG. 17O. In the example of FIG. 17O, computer system 101 displays content item G2 in window 1732 in response to detecting selection of content item G2.

In some embodiments, computer system 101 responds to directional inputs for scrolling content items differently for a collection of non-paginated selectable content items as illustrated in the examples of FIGS. 17P-17T. In the example of FIG. 17P, computer system 101 displays selectable content items 1-6 in content window 1734. In some embodiments, in response to an input at directional input 1720 that is within the first displacement zone 1712, the selectable content items scroll gradually in the same manner as described with respect to FIGS. 17A-17F. For instance, in the example of FIG. 17Q, in response to input 1736 corresponding to directional input 1720 which has a magnitude that is within displacement zone 1712 (as indicated in displacement view 1710), computer system 101 scrolls the selectable content items gradually in the same manner as described with respect to FIGS. 17A-17F as illustrated in FIG. 17R. In the example of FIG. 17Q, gradual scrolling includes displaying portions of selectable content items. For instance as illustrated in FIG. 17Q, only a particular movement in time only a portion of selectable content items 1 and 2 are displayed as they are scrolling off screen, while a portion of selectable content items A and B are partially displayed as they are scrolled onto the display by computer system 101.

In some embodiments, the speed at which the content items are scrolled is based on the magnitude of the displacement for non-paginated selectable content items the same as for paginated selectable content items. For instance, as illustrated in FIG. 17Q, in response to input 1736, corresponding to directional input 1720, the selectable content items are scrolled gradually at a speed indicated by speed indicator 1706. In the example of FIG. 17R, in response to detecting that the magnitude of input 1736, corresponding to directional input 1720, has increased (but is still within the first displacement zone 1714, computer system 101 increases the speed at which the content items are scrolled as indicated at speed indicator 1706.

In some embodiments, inputs to directional control 1720 that are within displacement zone 1714 are treated differently by computer system 101 for non-paginated selectable content items than they are for paginated selectable content items as illustrated in FIG. 17S. In the example of FIG. 17S, in response to input 1738, corresponding to directional input 1720, which is of a magnitude that is within displacement zone 1714, computer system 101 gradually scrolls the selectable content at a speed indicated by speed indicator 1706 in accordance with the magnitude of displacement of input 1738. In the example of FIG. 17T, computer system 101 terminates scrolling the selectable content items in response to detecting no further input at directional input control 1720.

In some embodiments, paginated selectable content items are scrollable by inputs from a portion of the user such as a hand of the user as illustrated in the examples of FIG. 17U-17X. In the example of FIG. 17U, computer system 101 detects hand 1750 performing an air pinch followed by movement of hand 1750 while the gaze of the user 1716 is directed to the selectable content items, and in response computer system 101 scrolls the selectable content items. In the example 17U, computer system 101 detects the speed 1740 of the movement of hand 1750 being below a predefined threshold 1742, and accordingly gradually scrolls the selectable content as shown in FIG. 17V (e.g., in the same manner as the examples of FIG. 17A-E). In the example of FIG. 17W, in response to detecting that the speed 1740 of movement of hand 1750 is above the predefined threshold 1742, computer system 101 scrolls the selectable content items on a page-by-page bases as illustrated in FIG. 17X (e.g., in the same manner as the examples of FIG. 17F-17K.

In some embodiments, computer system 101 displays multiple content windows that include paginated scrollable items as illustrated in the examples of FIGS. 17Y-17BB. In the example of FIG. 17Y, computer system 101 displays a first user interface 1754 and a second user interface 1752 which each individually include selectable content items. For instance, user interface 1754 includes selectable content items 1-6 which are paginated and are similar to the examples described with respect to FIGS. 17A-17K. User interface 1752 is optionally a text document that includes pages of text. As discussed further below, computer system 101 scrolls the textual content of user interface 1752 in response to controller input.

In the example of FIG. 17Z, computer system 101 detecting input 1770 at directional input 1720 of controller 1701a while the gaze of the user 1716 is directed to first user interface 1754 (and specifically the selectable content items displayed on user interface 1754) and in response performs a gradual scroll (since the displacement of input 1770 is within the first displacement zone 1712 as indicated at displacement view 1710).

In the example of FIG. 17AA, computer system 101 detects input 1772 at directional input 1720 of controller 1701a while also detecting the gaze 1716 directed to the second user interface 1752. In the example of FIG. 17AA, input 1772 is in the downward direction and is also of a magnitude that is within the second displacement zone 1714 (associated with page-by-page scrolling). In response to detecting input 1772, computer system 101 scrolls down the textual document (in accordance with the direction of input 1772) displayed on user interface 1752 to page two of the document as indicated by page visual indicator 1756 (e.g., performs a page scroll rather than a gradual scroll).

FIG. 18 is a flowchart illustrating a method of a computer system scrolling through paginated content based on a range of positions of input from a directional control in accordance with some embodiments of the disclosure. In some embodiments, the method 1800 is performed at a computer system (e.g., computer system 101 in FIG. 1A such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 1800 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1800 are, optionally, combined and/or the order of some operations is, optionally, changed.

In some embodiments, a method 1800 is performed at a computer system in communication with one or more display generation components and one or more input devices, such as computer system 101 in FIG. 17A. In some embodiments, the computer system has one or more of the characteristics of the computer systems of methods 800, 1000, 1200, 1400, and/or 1600. In some embodiments, the one or more display generation components have one or more of the characteristics of the display generation components of methods 800, 1000, 1200, 1400, and/or 1600. In some embodiments, the one or more input devices have one or more of the characteristics of the one or more input devices of methods 800, 1000, 1200, 1400, and/or 1600.

In some embodiments, while displaying, via the one or more display generation components, first content that has input focus, such as the selectable content items A1-A6 shown in FIG. 17A, the computer system detects (1802a), via the one or more input devices, a change in a position of a directional control that is being used to provide input based on the input focus, such as the input 1722 in FIG. 17B. In some embodiments, first content refers to any form of digital media or information that can be displayed via the display generation components, including but not limited to, text, images, videos, applications, audio, animations, documents, web pages, icons and/or any other interactive elements. In some embodiments, the first content has one or more characteristics of the content displayed in methods 800, 1000, 1200, 1400, and/or 1600. In some embodiments, the first content is displayed in a three-dimensional environment, such as described with reference to methods 800, 1000, 1200, 1400 and/or 1600. In some embodiments, the input focus refers to the state or condition in which a particular user interface element, application, or content area (e.g., the first content) is designated as the target for receiving input from an input device, such as the controller device and/or the directional control. In some embodiments, the directional control refers to a device or component (e.g., physical/hardware or virtual/software) that allows a user to input directional commands to the computer system, enabling navigation and interaction with the first content. Some examples of directional controls include, but are not limited to, joysticks, thumbsticks, directional pads (D-pads), trackballs, trackpads, computer mice, steering wheels, gesture-based input devices (e.g., devices that detect hand movements or tilts), buttons, sliders, touch screens, or any other devices that allow users to provide an input with a direction to the computer system. In some embodiments, the directional control is included in the controller device. In some embodiments, the directional control has one or more of the characteristics of the directional controls of methods 800, 1000, 1200, 1400, and/or 1600. In some embodiments, the position of the directional control refers to the specific orientation, angle, displacement, and/or coordinates of the directional control at a given moment. In some embodiments, the position of the directional control is used by the computer system to determine the input command the user is performing. In some embodiments, when the directional control is a joystick, thumbstick, or similar device, the position refers to specific coordinates (e.g., Cartesian or polar) or displacement of the joystick or thumbstick from its neutral (e.g., center) position, indicating the direction and extent of the input. In some embodiments, when the directional control is a joystick, thumbstick, or similar device, the position refers to the tilt angle of the joystick, where different angles correspond to different directions and magnitudes of movement within the digital content. In some embodiments, when the directional control is a D-pad or similar device, the position includes the directional orientation of the D-pad, where pressing different parts of the pad corresponds to distinct directional commands. In some embodiments, the change in the position of the directional control refers to any alteration in the orientation, angle, displacement, and/or coordinates of the directional control from its previous state, indicating a new direction and/or magnitude of input.

In some embodiments, in response to detecting the change in the position of the directional control (1802b), in accordance with a determination that a first set of one or more criteria are met, wherein the first set of one or more criteria includes a requirement that the position of the directional control is in a first range of positions of the directional control in order for the first set of one or more criteria to be met, the computer system scrolls (1802c) the first content gradually based on the position of the directional control within the first range of positions of the directional control, such as shown in FIG. 17B where the magnitude of input 1722 is within the first displacement zone 1712 and in response the selectable content items are gradually scrolled as illustrated by current view 1718 of page view 1708. In some embodiments, the first set of one or more criteria includes specific conditions that must be met (e.g., regarding the position of the directional control) for the system to execute gradual scrolling of the first content based on the position and/or movement of the directional control. Some examples of criteria of the first set of one or more criteria include, but are not limited to, position thresholds (e.g., the directional control being in a position within a defined range of positions, such as the first range of positions), duration of input (e.g., the duration for which the directional control remains within the first range of positions must be longer than a threshold amount of time), directional consistency (e.g., the direction in which the directional control is moved must remain in a general direction, such as along a particular axis), speed of movement (e.g., the speed at which the directional control is moved to the position must be slower or faster than one or more predefined speeds), that the first content be paginated (e.g., as described in greater detail below), and/or any other criteria that may influence how the first content is scrolled. In some embodiments, the first range of positions refers to a specific subset of possible orientations, angles, displacements, and/or coordinates of the directional control. For example, if the directional control has a full range of positions corresponding to a range from 0 to 100 (e.g., mapping the range of possible positions to the number range of 0 to 100, where 0 corresponds to no displacement and 100 corresponds to full displacement), the first range of positions is optionally: 0-20, 0-30, 0-50, 10-20, 10-30, or 10-50. In some embodiments, when the directional control is a joystick, thumbstick, or similar device, the first range of positions refers to a relatively small tilting or movement of the joystick or thumbstick within a threshold angle or distance from the neutral position, indicating gradual or fine control input. In some embodiments, when the directional control is a joystick, thumbstick, or similar device, the first range of positions refers to a tilting or movement of the joystick or thumbstick past a neutral angle or distance from the neutral position, the neutral angle or distance defining a range of positions of the directional control that is closer to the neutral position than the first range of positions (e.g., a third range of positions, as described in greater detail below). In some embodiments, when the directional control is a D-pad, the first range of positions refers to a specific set of directional inputs detected when the D-pad is pressed with relatively light force (e.g., less force than as described with reference to the second range of positions below) or in a particular section of its range. In some embodiments, the first range of positions describes the range of positions where the input device is moved within a limited scope, indicating a preference for smooth and controlled scrolling or navigation actions. In some embodiments, scrolling refers to the movement of content in a particular direction, allowing users to view parts of the content that extend beyond the visible area of the display (e.g., because one or more portions of the content move out of the visible area of the screen, and one or more portions of the content move into the visible area of the display). In some embodiments, scrolling involves vertical movement (e.g., moving up and down through a document or webpage), horizontal movement (e.g., moving left and right through horizontally laid-out menus or content), or a combination of the two. In some embodiments, scrolling the first content gradually refers to the process of moving the displayed content in a smooth, continuous manner at a controlled pace, allowing the user to view different parts of the content progressively rather than in jumps or page-by-page transitions. In some embodiments, scrolling the first content gradually based on the position of the directional control within the first range of positions refers to the process of moving the displayed content in a smooth, continuous manner at a pace determined by the specific orientation, angle, displacement, and/or coordinates of the directional input device. In some embodiments, when the directional control is a joystick, thumbstick, or similar device, scrolling the first content gradually based on the position of the directional control within the first range of positions involves setting the scroll speed proportionally to how far the joystick or thumbstick is tilted and/or displaced from its neutral position, with greater tilts, positions, and/or displacements within the first range of positions resulting in faster scrolling, and smaller tilts, positions, and/or displacements within the first range of positions resulting in slower scrolling.

In some embodiments, in response to detecting the change in the position of the directional control (1802b), in accordance with a determination that a second set of one or more criteria are met, wherein the second set of one or more criteria includes a requirement that the first content is paginated content and that the position of the directional control is in a second range of positions of the directional control in order for the second set of one or more criteria to be met, such as shown in FIG. 17G where the magnitude of input 1728 is within the second displacement zone 1714, wherein the second range of positions is different from the first range of positions (e.g., greater than the first range of positions), the computer system scrolls (1802d) the first content to a page boundary of the first content independent of the position of the directional control within the second range of positions of the directional control, such as shown in FIG. 17H (and, optionally, stopping or pausing scrolling at the page boundary for the first content). In some embodiments, the second set of one or more criteria includes specific conditions that must be met (e.g., regarding the position of the directional control) for the system to execute page boundary scrolling of the first content based on the position and/or movement of the directional control. Some examples of criteria of the second set of one or more criteria include, but are not limited to, position thresholds (e.g., the directional control being in a position within a defined range of positions, such as the second range of positions), duration of input (e.g., the duration for which the directional control remains within the second range of positions must be longer than a threshold amount of time), directional consistency (e.g., the direction in which the directional control is moved must remain in a general direction, such as along a particular axis), speed of movement (e.g., the speed at which the directional control is moved to the position must be slower or faster than one or more predefined speeds), that the first content be paginated (e.g., as described in greater detail below), and/or any other criteria that may influence how the first content is scrolled. In some embodiments, paginated content refers to content that is divided into discrete pages or sections, each of which can be individually displayed, accessed, and/or navigated-to (e.g., similar to pages in a book or sections in a document). Some examples of paginated content include, but are not limited to, digital documents (e.g., PDFs or eBooks), web content (e.g., search results or any web page split into multiple sections), home screen interfaces (e.g., user interfaces where app icons and/or widgets are organized into multiple pages), application interfaces (e.g., home, settings, or options menus, where different categories or sections are organized into separate pages), media galleries (e.g., photo or video libraries), dashboards, data visualization tools, instructional content (e.g., tutorials or lessons), forms, questionnaires, e-commerce platforms (e.g., catalogs or product listings), user manuals, help guides, calendars, and/or planners. In some embodiments, the second range of positions refers to a specific subset of possible orientations, angles, displacements, and/or coordinates of the directional control, different from the first range of positions. For example, if the directional control has a full range of positions corresponding to a range from 0 to 100 (e.g., mapping the range of possible positions to the number range of 0 to 100, where 0 corresponds to no displacement and 100 corresponds to full displacement), the second range of positions is optionally: 50-100, 60-100, or 80-100. In some embodiments, the second range of positions includes the maximum displacement position of the directional control. In some embodiments, when the directional control is a joystick, thumbstick, or similar device, the second range of positions refers to a relatively large tilting or movement of the joystick or thumbstick past the threshold angle or distance from the neutral position, indicating a preference for rapid or significant navigation actions. In some embodiments, when the directional control is a D-pad, the second range of positions refers to a specific set of directional inputs detected when the D-pad is pressed with relatively heavy force (e.g., more force than as described with reference to the first range of positions above) or in a particular section of its range different from the section of its range corresponding to the first range of positions (e.g., pressing a combination of inputs to achieve a different navigation outcome). In some embodiments, the second range of positions describes the range of positions where the input device is moved over a relatively larger scope than the first range of positions, indicating a preference for quick and/or extensive scrolling or navigation actions. In some embodiments, the second range of positions involves the detection of additional controls or modifiers (e.g., holding down a button while moving a joystick or thumbstick) to achieve a different set of navigation commands. In some embodiments, scrolling the first content to the page boundary refers to the process of moving the displayed content directly to the start of a next page or section of the first content and/or an end of a current page or section of the first content, effectively skipping intermediate content and/or aligning the view precisely with the boundaries of the page. In some embodiments, scrolling the first content to the page boundary involves an immediate jump to the next or previous page, ensuring that the entire content of the new page is visible without partial overlap from the previous page. In some embodiments, scrolling the first content to the page boundary involves the use of one or more animations, such as sliding or fading effects. In some embodiments, scrolling the first content to the page boundary independent of the position of the directional control within the second range of positions refers to the process of moving the displayed content directly to the start or end of a designated page, regardless of the specific orientation, angle, displacement, and/or coordinates of the directional control provided that it is within the second range of positions. In some embodiments, scrolling the first content to the page boundary independent of the position of the directional control within the second range of positions involves triggering the jump to the next or previous page as soon as the computer system detects that the input control enters the second range of positions, without further consideration of the exact position within that range. In some embodiments, when the directional control is a joystick, thumbstick, or similar device, the computer system detects one or more gestures that involve the joystick or thumbstick having a position within the second range of positions at some point during the gesture. For example, the computer system may detect a flicking motion, which refers to a quick push of the joystick or thumbstick to one of its extreme positions followed by an immediate release, which optionally corresponds to a command to scroll by exactly one page. Facilitating gradual or page-by-page scrolling using a directional control based on a detected position of the hardware input control provides efficient access to multiple different scrolling modes without the need for a separate input element to do so, thereby making the user-device interaction more efficient.

In some embodiments, the first set of one or more criteria include a criterion that is satisfied when the first content is paginated content, such as the selectable content items illustrated in in FIGS. 17G-17L. In some embodiments, paginated content refers to content that is divided into discrete pages or sections, each of which can be individually displayed, accessed, and/or navigated-to (e.g., similar to pages in a book or sections in a document), as described in greater detail above. In some embodiments, the criterion that is satisfied when the first content is paginated content refers to a specific condition that is met when the content displayed by the computer system (e.g., the first content) is divided into discrete pages or sections. In some embodiments, if the first content is paginated content, scrolling through the first content includes snapping (e.g., automatically scrolling, without further user input) to a page boundary in response to detecting termination of the scrolling input (e.g., in response to the directional control moving to a neutral position, as described below). In some embodiments, the criterion does not require that the first content be paginated content, but it is satisfied even if the first content it paginated content. In some embodiments, the first set of one or more criteria require that the first content be paginated in order to be met-thus, the first set of one or more criteria are optionally not satisfied if the first content is not paginated content. The first set of one or more criteria including a criterion that is satisfied when the first content is paginated enables the system to utilize gradual scrolling behavior for paginated content when the directional control is in the first range of positions, thereby improving user experience and system performance by ensuring accurate and efficient navigation.

In some embodiments, the first content is displayed concurrently with second content, such as shown in FIG. 17Y with content window 1754 and content window 1752 (e.g., the simultaneous presentation of two different sets of content via the one or more display generation components). In some embodiments, the second content has one or more of the characteristics of the first content.

In some embodiments, while displaying, via the one or more display generation components, the first content and second content, different from the first content, the computer system detects, via the one or more input devices, a second change in the position of the directional control that is being used to provide input, such as the input 1722 at the directional input 1720 of controller 1701a in FIG. 17Z. In some embodiments, the second content has one or more characteristics of the first content described herein. In some embodiments, the second content being different from the first content refers to the two concurrently displayed content types having one or more distinct characteristics that distinguish them from one another. In some embodiments, the second change in the position of the directional control refers to any alteration in the orientation, angle, displacement, and/or coordinates of the directional control from its previous state, indicating a new direction and/or magnitude of input. In some embodiments, the second change in position of the directional control has one or more of the characteristics of the change in the position of the directional control.

In some embodiments, in response to detecting the second change in the position of the directional control that is being used to provide input, in accordance with a determination that a third set of one or more criteria are met, the computer system scrolls the first content in accordance with the second change in the position of the directional control without scrolling the second content, such as shown with selectable content of window 1754 gradually scrolling in response to input 1770 in FIG. 17Z. In some embodiments, the third set of one or more criteria has one or more characteristics of the first and/or second sets of one or more criteria described above. In some embodiments, the third set of one or more criteria refers to conditions under which the system scrolls the first content without scrolling the second content. Some example criteria of the third set of one or more criteria include, but are not limited to, the first content having the input focus, the first content having active tasks or applications the user has most recently interacted with, the first content having a higher priority and/or focus order based on user settings or predefined system or application rules than the second content, the directional control being a particular directional control associated with the first content (e.g., for devices with two or more directional controls or the directional control being locked onto the first content), a specific action associated with the first content performed by the directional control or other associated device, and/or any other criterion that necessitates the focused navigation of the first content. In some embodiments, scrolling the first content in accordance with the second change in the position of the directional control has one or more characteristics of scrolling the first content gradually and/or to the page boundary of the first content, as described above. In some embodiments, scrolling the first content in accordance with the second change in the position of the directional control without scrolling the second content refers to the action of adjusting the display of the first content based on the new position of the directional control corresponding to the second change in the position of the directional control, while the second content remains static, unaffected by the second change in the position of the directional control.

In some embodiments, in response to detecting the second change in the position of the directional control that is being used to provide input, in accordance with a determination that a fourth set of one or more criteria (e.g., different from the third set of one or more criteria) are met, the computer system scrolls the second content in accordance with the second change in the position of the directional control without scrolling the first content, such as scrolling content 1752 in FIG. 17BB in response to input 1772 at directional input 1720 in FIG. 17AA. In some embodiments, the fourth set of one or more criteria has one or more characteristics of the first, second, and/or third sets of one or more criteria described above. In some embodiments, the fourth set of one or more criteria refers to conditions under which the system scrolls the second content without scrolling the first content. Some example criteria of the fourth set of one or more criteria include, but are not limited to, the second content having the input focus, the second content having active tasks or applications the user has most recently interacted with, the second content having a higher priority and/or focus order based on user settings or predefined system or application rules than the first content, the directional control being a particular directional control associated with the second content (e.g., for devices with two or more directional controls or the directional control being locked onto the second content), a specific action associated with the second content performed by the directional control or other associated device, and/or any other criterion that necessitates the focused navigation of the second content. In some embodiments, scrolling the second content in accordance with the second change in the position of the directional control has one or more characteristics of scrolling the first content gradually and/or to the page boundary of the first content, as described above. In some embodiments, scrolling the second content in accordance with the second change in the position of the directional control without scrolling the first content refers to the action of adjusting the display of the second content based on the new position of the directional control corresponding to the second change in the position of the directional control, while the first content remains static, unaffected by the second change in the position of the directional control. Displaying the first content concurrently with second content and allowing for independent scrolling of either based on specific criteria enhances the system's multitasking capabilities, improving user efficiency and system responsiveness by enabling control and navigation of multiple content without interference.

In some embodiments, the third set of one or more criteria include a requirement that the first content has the input focus in order for the third set of one or more criteria to be met, such as shown in FIG. 17Y where the attention of the user 1716 is directed to window 1754 and in response to input 1770, window 1752 is scrolled. In some embodiments, the fourth set of one or more criteria include a requirement that the second content has the input focus in order for the fourth set of one or more criteria to be met, such as shown in FIG. 17AA. In some embodiments, the input focus refers to the state or condition in which a particular user interface element, application, or content area is designated as the target for receiving input from an input device, such as the controller device and/or the directional control and/or a hand of the user (e.g., via air gestures), as described in greater detail above. In some embodiments, the third set of one or more criteria including the requirement that the first content has the input focus refers to the set of conditions that must be met for the system to scroll the first content in accordance with the second change in the position of the directional control without scrolling the second content having as at least one of its criteria that the first content be the active area of interaction (e.g., when attention of the user, cursor, or other element denoting focus is directed to the first content; or when a window, frame, or tab associated with the first content is selected or highlighted). In some embodiments, the fourth set of one or more criteria including the requirement that the second content has the input focus refers to the set of conditions that must be met for the system to scroll the second content in accordance with the second change in the position of the directional control without scrolling the first content having as at least one of its criteria that the second content be the active area of interaction (e.g., when an attention of the user, cursor, or other element denoting focus is directed to the second content; or when a window, frame, or tab associated with the second content is selected or highlighted). In some embodiments, the first content has the input focus when it is the more recent of the first and second content to have received user input directed to it, and the second content has the input focus when it is the more recent of the first and second content to have received user input directed to it. Including the requirement that the first content or second content has the input focus in the respective sets of criteria improves the system's ability to accurately and efficiently manage user inputs, thereby reducing user errors and minimizing the need for corrective actions by the user or system, which in turn conserves computational resources and enhances overall system performance.

In some embodiments, the third set of one or more criteria include a requirement that attention of a user of the computer system is directed to the first content in order for the third set of one or more criteria to be met, such as shown in FIG. 17Y where the input focus is directed to content window 1754. In some embodiments, the fourth set of one or more criteria include a requirement that the attention of the user of the computer system is directed to the second content in order for the fourth set of one or more criteria to be met, such as shown in FIG. 17AA. In some embodiments, the third set of one or more criteria including the requirement that the attention of the user be directed to the first content refers to the set of conditions that must be met for the system to scroll the first content in accordance with the second change in the position of the directional control without scrolling the second content having as at least one of its criteria that the user have their attention be on the first content. In some embodiments, the fourth set of one or more criteria including the requirement that the attention of the user be directed to the second content refers to the set of conditions that must be met for the system to scroll the first content in accordance with the second change in the position of the directional control without scrolling the second content having as at least one of its criteria that the user have their attention be on the first content. Including a requirement that the user's attention be directed to either the first or second content in the respective sets of criteria improves the system's responsiveness and accuracy in content navigation by ensuring that scrolling actions align with the user's focus, thereby reducing user errors and the need for corrective actions, which conserves computational resources and enhances overall system performance.

In some embodiments, in response to detecting the change in the position of the directional control, in accordance with a determination that a third set of one or more criteria are met, wherein the third set of one or more criteria include a requirement that the position of the directional control is in a third range of positions, such as the position of directional input 1720 of the controller 1701a in FIG. 17N, different from the first range of positions and the second range of positions, the computer system forgoes scrolling the first content. In some embodiments, the third set of one or more criteria has one or more characteristics of any set of one or more criteria described herein. In some embodiments, the third set of one or more criteria refers to the conditions established within the system that, when met, lead to the decision not to scroll the first content despite changes in the position of the directional control. Some examples of criteria of the third set of one or more criteria Include, but are not limited to, the position of the directional control being in the third range of positions, the first content being of a static nature (e.g., not able to be scrolled), a content stability setting (e.g., a setting where the user or system preferences specify maintaining content position for ease of viewing or interaction, such as during detailed analysis or presentation), interaction locking criteria (e.g., a lock or freeze on the first content activated by the user or by the system, for example, when the system has not detected an input for a predetermined amount of time), multi-tasking locking criteria (e.g., when the system detects the user is engaging in activities other than scrolling, such as typing or data entry, that require content stability and would be hindered by scrolling), sensitivity settings (e.g., system settings that may be set to ignore minor or accidental movements of the directional control), error states (e.g., when errors or alerts within the first content or the system at large require user attention and resolution before proceeding, scrolling may be paused or disabled), and/or any other criteria where forgoing scrolling may be beneficial or necessary. In some embodiments, the third range of positions refers to a specific subset of possible orientations, angles, displacements, and/or coordinates of the directional control. In some embodiments, when the directional control is a joystick, thumbstick, or similar device, the third range of positions refers to a relatively small tilting or movement of the joystick or thumbstick within a neutral angle or distance from the neutral position (e.g., as described above with respect to the first range of positions). In some embodiments, the third range of positions defines the tilting or movement of the joystick or thumbstick between the neutral position and the neutral angle or distance, the first range of positions defines the tilting or movement of the joystick or thumbstick between the neutral angle or distance and the threshold angle or distance, and the second range of positions defines the tilting or movement of the joystick or thumbstick between the threshold angle or distance and the maximum angle or distance. For example, when the directional control has a full range of positions corresponding to a range from 0-100, the third range of positions is 0-x, the first range of positions is x-y, and the second range of positions is y−100, where x<y and x and y are any appropriate number between 0 and 100. Further to this example, x and y may be set to be equal to 0 or 100 to eliminate at least one of the ranges of positions and forgo performing their corresponding action. As another example, x and y may be set to equal to each other to eliminate the first range of positions and forgo scrolling gradually. Some example values of x include, but are not limited to, a percentage of a maximum tilt and/or displacement of the directional control (e.g., 0%, 1%, 3%, 5%, 10%, 20%, 35%, or 50%), an angle of the tilt of the directional control with respect to the neutral position (e.g., 0°, 1°, 3°, 5°, 10°, or) 25°, and/or a displacement of the directional control from the neutral position (e.g., 0 mm, 0.1 mm, 0.3 mm, 0.5 mm, 1 mm, 3 mm, 5 mm, 1 cm, 3 cm, or 5 cm). In some embodiments, when the directional control is a D-pad, the third range of positions refers to a specific set of directional inputs detected when the D-pad is pressed with relatively light force (e.g., less force than as described with reference to the first range of positions above) or in a particular section of its range. In some embodiments, the third range of positions describes the range of positions where the input device is moved within a very limited scope, indicating that the user is not intending to perform scrolling or navigation actions. In some embodiments, forgoing scrolling the first content refers to the inaction of not moving or shifting the visible portion for the first content on the display, despite a detected input from the user that might otherwise initiate a scrolling action. Forgoing scrolling the first content when the position of the directional control is in a third range of positions reduces unnecessary system processing and user interface updates, thereby conserving computational resources and improving system performance by preventing inadvertent or minor inputs from causing unintended scrolling actions.

In some embodiments, in accordance with a determination that the directional control is a first type of directional control, the third range of positions is a first respective range of positions, such as the neutral position of directional input shown in FIG. 17N being different for different controllers. In some embodiments, a type of directional control refers to the specific design, functionality, or technology of a control device used to input directional commands into the computer system. Some examples of types of directional controls include, but are not limited to, joysticks, thumbsticks, D-pads, trackballs, touchpads, computer mice, steering wheels, gesture controls, arrow keys, tilt sensors, XR-specific controllers, and/or any other type of directional control that may detect a directional input. Other examples of types of directional controls include, but are not limited to, analog controls (e.g., devices utilizing variable electrical resistance or similar methods to provide a range of outputs based on the degree of movement, such as joysticks or thumbsticks), digital controls (e.g., devices utilizing discrete inputs, such as on/off signals without in-between values, such as D-pads and arrow keys), optical tracking (e.g., devices that utilize optical sensors to detect movement relative to a surface, such as computer mice or trackballs), capacitive touch (e.g., devices that utilize changes in capacitance caused by the touch of a user digit, such as touchpads and touch-sensitive joysticks), motion sensing (e.g., devices that utilize accelerometers or gyroscopes to detect movement in space), and/or any other type of directional control that may detect a directional input. In some embodiments, the third range of positions being the first respective range of positions when the directional control is the first type of directional control refers to a specific subset of possible orientations, angles, displacements, and/or coordinates of the directional control, associated with the third range of positions described above, defined uniquely for the first type of directional control.

In some embodiments, in accordance with a determination that the directional control is a second type of directional control, different from the first type of directional control, the third range of positions is a second respective range of positions, different from the first respective range of positions, such as the neutral position of directional input 1720 shown in FIG. 17N being different for different controllers. In some embodiments, the third range of positions being the second respective range of positions when the directional control is the second type of directional control refers to a specific subset of possible orientations, angles, displacements, and/or coordinates of the directional control, associated with the third range of positions described above, defined uniquely for the second type of directional control. In some embodiments, the difference between the first and second respective ranges of positions reflects inherent differences in the physical design, sensitivity, and/or input mechanisms of the first and second types of directional controls. In some embodiments, the first type of directional control offers gradual input detection over a wide range of motion (e.g., a joystick or thumbstick), while the second type of directional control recognizes distinct directional inputs without intermediate state (e.g., a D-pad), which allows for the system to set the first respective range of positions to accommodate a wider array of inputs than the second respective range of positions. Utilizing different respective ranges of positions for different types of directional controls allows the system to tailor its input recognition and response mechanisms to the characteristics of each control type, improving input accuracy and user interaction efficiency, thereby reducing the likelihood of errors and minimizing the need for additional system corrections and processing.

In some embodiments, the second range of positions is further from a neutral position of the directional control than the first range of positions, such as shown with the ranges of the first displacement 1712 and second displacement zone 1714 in FIG. 17A. In some embodiments, the second range of positions being further from the neutral position of the directional control than the first range of positions refers to the second range of possible orientations, angles, displacements, and/or coordinates of the directional control being set to occur at a great distance or degree from the neutral position of the control compared to the first range of possible orientations, angles, displacements, and/or coordinates, as described in greater detail with reference to steps 1802. Setting the second range of positions further from the neutral position of the directional control than the first range allows the system to distinguish between more subtle and more pronounced user inputs, improving the precision of input interpretation and reducing inadvertent actions, thereby enhancing user experience and system performance by minimizing the need for corrective adjustments and processing.

In some embodiments, scrolling the first content gradually based on the position of the directional control within the first range of positions of the directional control includes, in accordance with a determination that the position of the directional control within the first range of positions is a first position, scrolling the first content at a first scrolling speed, such as the scrolling speed 1706 shown in FIG. 17B. In some embodiments, a scrolling speed refers to the rate at which content moves across a display or through a viewing area. In some embodiments, scrolling the first content at the first scrolling speed based on the first position refers to the process of moving the first content at a specific, predefined speed (e.g., 10 pixels/s, 50 pixels/s, 100 pixels/s, 300 pixels/s, 500 pixels/s, 1,000 pixels/s, 3,000 pixels/s, 5,000 pixels/s, 10,000 pixels/s, 30,000 pixels/s, or 50,000 pixels/s) that is correlated to the particular position of the directional control defined by the first position within the first range of positions. In some embodiments, when the directional control is a joystick, thumbstick, or similar device, scrolling the first content at the first scrolling speed based on the first position involves setting the scroll speed proportionally to how far the joystick or thumbstick is tilted and/or displaced from its neutral position based on the first position.

In some embodiments, scrolling the first content gradually based on the position of the directional control within the first range of positions of the directional control includes, in accordance with a determination that the position of the directional control within the first range of positions is a second position, different from the first position, scrolling the first content at a second scrolling speed, different from the first scrolling speed, such as the scrolling speed 1706 shown in FIG. 17D. In some embodiments, scrolling the first content at the second scrolling speed based on the second position refers to the process of moving the first content at a specific, predefined speed (e.g., 10 pixels/s, 50 pixels/s, 100 pixels/s, 300 pixels/s, 500 pixels/s, 1,000 pixels/s, 3,000 pixels/s, 5,000 pixels/s, 10,000 pixels/s, 30,000 pixels/s, or 50,000 pixels/s), different from the first speed, that is correlated to the particular position of the directional control defined by the second position within the first range of positions. In some embodiments, when the directional control is a joystick, thumbstick, or similar device, scrolling the first content at the second scrolling speed based on the second position involves setting the scroll speed proportionally to how far the joystick or thumbstick is tilted and/or displaced from its neutral position based on the second position. In some embodiments, when the directional control is a joystick or thumbstick, the scrolling speed is proportional to how far the joystick or thumbstick is tilted and/or displaced from its neutral position, with greater tilts, positions, and/or displacements within the first range of positions resulting in faster scrolling. For example, when the first position is associated with a tilt angle smaller than the tilt angle of the second position (or optionally the first position is associated with a displacement from the neutral position smaller than the displacement of the second position), the first scrolling speed is slower than the second scrolling speed. Scrolling the first content at different speeds based on the specific positions of the directional control within the first range improves the system's responsiveness and user control over content navigation, thereby enhancing the user experience by allowing for adjustments in scrolling speed and reducing the likelihood of overshooting or undershooting desired content areas, which minimizes the need for corrective actions and conserves computational resources.

In some embodiments, scrolling the first content gradually based on the position of the directional control within the first range of positions of the directional control includes, in accordance with a determination that the position of the directional control within the first range of positions is on a first side of a neutral position of the directional control along a first axis (e.g., a controller axis that corresponds to a direction of movement of the directional control relative to a housing of the controller), scrolling the first content in a first direction, such as the direction of scrolling in FIG. 17D. In some embodiments, a direction of scrolling refers to the vector or path along which content moves across a display or through a viewing area. In some embodiments, an axis refers to a straight line about which an object or a system (e.g., the directional control) can move and/or rotate. For example, when the first content is horizontal, the first axis may be a horizontal line split in the middle by the neutral position, and when the first content is vertical, the first axis may be a vertical line split in the middle by the neutral position. In some embodiments, a side of the neutral position of the directional control along the first axis refers to a specific spatial area or region relative to the central, resting, or default position of the directional control. For example, when the directional control is a joystick or thumbstick, the neutral position of the directional control is considered the center point with no input being registered, and moving the control in any direction away from this point can be described as moving it to a side of the neutral position, as defined by the first axis. In some embodiments, scrolling the first content in the first direction based on the first side of the neutral position refers to the process of moving the first content in a specific, predefined direction that correlates with the particular side of the neutral position of the directional control defined by the first side. In some embodiments, when the directional control is a joystick, thumbstick, or similar device, scrolling the first content in the first direction based on the first side of the neutral position involves determining the scroll direction based on what direction from the neutral position the joystick or thumbstick is tilted toward.

In some embodiments, scrolling the first content gradually based on the position of the directional control within the first range of positions of the directional control includes, in accordance with a determination that the position of the directional control within the first range of positions is on a second side of the neutral position of the directional control along the first axis, wherein the second side is different from the first side, scrolling the first content in a second direction that is different from the first direction, such as the direction of scrolling in FIG. 17F. In some embodiments, scrolling the first content in the second direction based on the second side of the neutral position refers to the process of moving the first content in a specific, predefined direction, different from the first direction, that correlates with the particular side of the neutral position of the directional control defined by the second side. In some embodiments, when the directional control is a joystick, thumbstick, or similar device, scrolling the first content in the second direction based on the second side of the neutral position involves determining the scroll direction based on what direction from the neutral position the joystick or thumbstick is tilted toward, as determined by the first axis. For example, when the first content and the first axis are horizontal, the first side may be a right side of the joystick or thumbstick and the second side may be a left side of the joystick or thumbstick, both sides split by an imaginary perpendicular (e.g., vertical) line crossing the first axis at the neutral position of the directional control, and when the first content and the first axis are vertical, the first side may be a top side of the joystick or thumbstick and the second side may be a bottom side of the joystick or thumbstick, both sides split by an imaginary perpendicular (e.g., horizontal) line crossing the first axis at the neutral position of the directional control Determining the direction of scrolling based on the position of the directional control relative to its neutral position along a first axis allows scrolling in different directions using the directional control, enhancing user control over content navigation.

In some embodiments, the first content is paginated content, such as the selectable content items in FIG. 17A. In some embodiments, while scrolling the first content gradually based on the position of the directional control within the first range of positions of the directional control and while a scroll position in the first content (e.g., the current location or point within a scrollable content area that is being viewed and/or interacted with by the user) is in between a first page and a second page of the first content, such as while scrolling in FIG. 17B, the computer system detects that the directional control has returned to a neutral position for the directional control, such as if returning to the neutral position after FIG. 17B. In some embodiments, the scroll position in the first content being in between the first page and the second page of the first content refers to the status where the displayed content is located at a transitional point between two consecutive pages, where the user is viewing parts of both the first and second pages concurrently. In some embodiments, detecting that the directional control has returned to the neutral position for the directional control refers to the process by which the system identifies that the directional control has been moved back to its central, default, or rest position after being displaced (or optionally within the third range of positions).

In some embodiments, in response to detecting that the directional control has returned to the neutral position for the directional control, in accordance with a determination that a third set of one or more criteria are met (optionally automatically, without additional user input), the computer system scrolls to a page boundary of the first page of the first content, such as if in response to returning to the neutral position after the scrolling in FIG. 17B, the computer system scrolls to the first page of icons. In some embodiments, scrolling to the page boundary of a page of the first content refers to the automated action of aligning the first content so that the beginning or end of a specified page matches the boundary of the viewing area or window where the first content is displayed. In some embodiments, scrolling to the page boundary of the first page of the first content refers to the automated action of aligning the first content so that the end of the first page matches the boundary of the viewing area or window where the first content is displayed. In some embodiments, the third set of one or more criteria has one or more characteristics of any of the sets of one or more criteria described herein. In some embodiments, the third set of one or more criteria refers to specific conditions that, when met, trigger the system to scroll the first content to the page boundary of the first page. Some examples of the third set of one or more criteria include, but are not limited to, visibility thresholds (e.g., having more than a certain percentage of the first page visible), scrolling thresholds (e.g., having scrolled less than a threshold amount into the second page), proximity thresholds (e.g., the scroll position being closer to the start of the first page than the start/end of the second page), user commands (e.g., detecting a specific user command or gesture that requests scrolling to the page boundary of the first page), user preferences or navigation patterns (e.g., a user setting or detected pattern that defines a preference for scrolling to the page boundary of the first page when the scroll position is between the first and second pages), context (e.g., scrolling to the page boundary of the first page when there are unfinished tasks in said page or other items that require the user's attention, or when the first content includes contextual clues, such as the first page being a chapter start or section header), and/or any other criteria where system logic determines that the page boundary of the first page is the most relevant page boundary to scroll to.

In some embodiments, in response to detecting that the directional control has returned to the neutral position for the directional control, in accordance with a determination that a fourth set of one or more criteria are met (optionally automatically, without additional user input), the computer system scrolls to a page boundary of the second page of the first content, such as scrolling to the second page of icons after the scroll position in FIG. 17B. In some embodiments, scrolling to the page boundary of the second page of the first content refers to the automated action of aligning the first content so that the start of the second page matches the boundary of the viewing area or window where the first content is displayed. In some embodiments, the fourth set of one or more criteria has one or more characteristics of any of the sets of one or more criteria described herein. In some embodiments, the fourth set of one or more criteria refers to specific conditions that, when met, trigger the system to scroll the first content to the page boundary of the second page. Some examples of the fourth set of one or more criteria include, but are not limited to, visibility thresholds (e.g., having more than a certain percentage of the second page visible), scrolling thresholds (e.g., having scrolled more than a threshold amount into the second page), proximity thresholds (e.g., the scroll position being closer to the end of the second page than the start/end of the first page), user commands (e.g., detecting a specific user command or gesture that requests scrolling to the page boundary of the second page), user preferences or navigation patterns (e.g., a user setting or detected pattern that defines a preference for scrolling to the page boundary of the second page when the scroll position is between the first and second pages), context (e.g., scrolling to the page boundary of the second page when there are no unfinished tasks in the first page or other items that require the user's attention, or when the first content includes contextual clues, such as the second page being a chapter start or section header), and/or any other criteria where system logic determines that the page boundary of the second page is the most relevant page boundary to scroll to. Automatically scrolling to the page boundary of either the first or second page based on specific criteria when the directional control returns to its neutral position improves the system's accuracy and efficiency in content navigation by ensuring that users are presented with complete pages, thereby reducing the likelihood of partial content views and minimizing the need for user corrections, which conserves computational resources and enhances user experience.

In some embodiments, the third set of one or more criteria include a criterion that is satisfied when less than a threshold amount of scrolling into the second page of the first content has occurred (e.g., less than 1%, 3%, 5%, 20%, 30%, or 50% amount of scrolling into the second page) when the directional control has returned to the neutral position, and scrolling to the page boundary of the first page of the first content includes scrolling the first content in a first direction. In some embodiments, the threshold amount of scrolling into the second page of the first content refers to a predefined, quantifiable limit or measure that delineates how much of the second page of the first content must be displayed or scrolled into before the system scrolls the first content in the second direction. In some embodiments, the criterion that is satisfied when less than the threshold amount of scrolling into the second page of the first content has occurred refers to a specific condition that assesses whether the user has scrolled insufficiently into the second page of the first content, as measured against the predetermined threshold amount of scrolling into the second page. In some embodiments, when the criterion that is satisfied when less than the threshold amount of scrolling into the second page of the first content has occurred is met, the system is configured to automatically scroll back to the page boundary of the first page in the first direction. For example, when the first content is arranged vertically, the first direction may be upwards when the first page is above the second page and downwards when the first page is below the second page, and when the first content is arranged horizontally, the first direction may be leftwards when the first page is to the left of the second page, and rightwards when the first page is to the right of the second page.

In some embodiments, the fourth set of one or more criteria include a criterion that is satisfied when more than the threshold amount of scrolling into the second page of the first content has occurred when the directional control has returned to the neutral position, and scrolling to the page boundary of the second page of the first content includes scrolling the first content in a second direction, different from the first direction, such as if in FIG. 17B the scroll position was more than the threshold amount of scrolling into the second page of the application icons when the directional control returned to the neutral position in FIG. 17C. In some embodiments, the criterion that is satisfied when more than the threshold amount of scrolling into the second page of the first content has occurred refers to a specific condition that assesses whether the user has scrolled sufficiently into the second page of the first content, as measured against the predetermined threshold amount of scrolling into the second page. In some embodiments, when the criterion that is satisfied when more than the threshold amount of scrolling into the second page of the first content has occurred is met, the system is configured to automatically scroll to the page boundary of the second page in the first direction. For example, when the first content is arranged vertically, the first direction may be downwards when the first page is above the second page and upwards when the first page is below the second page, and when the first content is arranged horizontally, the first direction may be rightwards when the first page is to the left of the second page, and leftwards when the first page is to the right of the second page. Determining which page to which to scroll based on the threshold amount of scrolling into the second page ensures that the system accurately determines whether to return to the page boundary of the first page or advance to the page boundary of the second page, enhancing user experience by reducing the likelihood of partial content views and minimizing user corrections. This conserves computational resources and improves the efficiency of content navigation.

In some embodiments, scrolling the first content gradually based on the position of the directional control within the first range of positions of the directional control includes gradually scrolling through a plurality of pages of the first content, such as scrolling through the first, second, third, fourth and/or fifth pages of selectable content items starting at FIG. 17A. In some embodiments, gradually scrolling through the plurality of pages of the first content refers to the controlled movement of content across multiple pages, allowing users to view a sequence of pages at a certain pace. In some embodiments, gradually scrolling through the plurality of pages of the first content is based on the position of the directional control being within the first range of positions, associated with a smoother and more continuous viewing experience as opposed to abrupt page transitions associated with the second range of positions. In some embodiments, while the position of the directional control is maintained within the first range of positions of the directional control, the system gradually scrolls through the plurality of pages of the first content, including the first page, a second page, a third page, a fourth page, and any number of additional pages, until the position of the directional control changes to be outside of the first range of positions of the directional control. Gradually scrolling through a plurality of pages based on the position of the directional control within the first range of positions improves the system's ability to provide a smooth and continuous content viewing experience, reducing abrupt transitions and enhancing the user experience, thus minimizing the need for user corrections, thereby conserving computational resources and improving the overall performance of the system.

In some embodiments, after scrolling the first content to the page boundary of the first content in accordance with the determination that the second set of one or more criteria are met (e.g., the position of the directional control is in the second range of positions of the directional control), wherein the page boundary is a page boundary of a first page of the first content, and while a current scroll position in the first content is the page boundary of the first page of the first content, such as shown in current view 1719 of page view 1708 FIG. 17H, in accordance with a determination that the position of the directional control remains in the second range of positions of the directional control, such as shown in FIG. 17H (e.g., the position of the directional control does not leave the second range of positions of the directional control, even if the position of the directional control changes), the computer system maintains the current scroll position in the first content to be the page boundary of the first page of the first content for a first threshold amount of time since scrolling the first content to the page boundary of the first page of the first content, such as shown in FIG. 17H. In some embodiments, the page boundary of the first page of the first content refers to the delineation at the beginning or end of a specific page. In some embodiments, the current scroll position in the first content being the page boundary of the first page of the first content refers to the scenario where the visible area of the first content on the display aligns exactly with the beginning and/or end of the first page.

In some embodiments, a threshold amount of time refers to a predefined, specific duration that has been set within the system or an application to trigger a particular action or event once elapsed. In some embodiments, the first threshold amount of time refers to a specified duration (e.g., 0.1 s, 0.3 s, 0.5 s, 1 s, 2 s, 5 s, or 10 s) that the system waits after the current scroll position reaches the page boundary of the first page and while the position of the directional control remains in the second range of positions before performing a subsequent action (e.g., scrolling to a new page). In some embodiments, maintaining the current scroll position in the first content to be the page boundary of the first page of the first content for the first threshold amount of time since scrolling the first content to the page boundary of the first page of the first content refers to the system keeping the display of the first content fixed at a specific page boundary (e.g., the page boundary of the first page) without any movement away from this boundary for a set duration of time, starting when the system first scrolls to the page boundary of the first page. In some embodiments, if the computer system detects that the input for scrolling the first content terminates during this first threshold amount of time (e.g., because the directional control is detected as moving back to a neutral position, as described herein), the computer system does not perform further scrolling of the first content unless or until further input for scrolling is detected. In some embodiments, after maintaining the current scroll position in the first content to be the page boundary of the first page of the first content for the first threshold amount of time since scrolling to the page boundary of the first page of the first content, the computer system detects that an amount of time since scrolling to the page boundary of the first page of the first content has met the first threshold amount of time. In some embodiments, detecting that the amount of time since scrolling to the page boundary of the first page of the first content has met the first threshold amount of time refers to the process by which the system identifies that a specified duration (e.g., the first threshold amount of time) has elapsed since the content was last scrolled to a designated page boundary (e.g., the page boundary of the first page).

In some embodiments, in response to detecting that an amount of time since scrolling to the page boundary of the first page of the first content has met the first threshold amount of time, the computer system scrolls the first content to a page boundary of a second page of the first content, different from the first page of the first content, such as shown in FIG. 17I by timer 1760 having elapsed past threshold 1762. In some embodiments, scrolling the first content to the page boundary of the second page of the first content in response to detecting that the amount of time since scrolling to the page boundary of the first page of the first content has met the first threshold amount of time refers to the automated action by the system to move the display of the first content from the boundary of the first page to the boundary of the second page when the first threshold amount of time has been met. In some embodiments, the second page is the next or previous page with respect to the first page. Maintaining the current scroll position at the page boundary of the first page for a threshold duration ensures the system does not scroll excessively, and also gives users sufficient time to confirm they are on the desired page, thereby improving user experience and system efficiency by reducing the likelihood of skipped pages and the need for corrective actions.

In some embodiments, after scrolling the first content to the page boundary of the second page of the first content in response to detecting that the amount of time since scrolling to the page boundary of the first page of the first content has met the first threshold amount of time, and while the current scroll position in the first content is the page boundary of the second page of the first content, such as shown in FIG. 17I by current view 1718 of page view 1708, in accordance with a determination that the position of the directional control remains in the second range of positions of the directional control, such as shown in FIG. 17I (e.g., the position of the directional control does not leave the second range of positions of the directional control, even if the position of the directional control changes), the computer system maintains the current scroll position in the first content to be the page boundary of the second page of the first content for a second threshold amount of time since scrolling the first content to the page boundary of the second page of the first content, wherein the second threshold amount of time is different from the first threshold amount of time, such as shown in FIG. 17J. In some embodiments, the current scroll position in the first content being the page boundary of the second page of the first content refers to the scenario where the visible area of the first content on the display aligns exactly with the beginning and/or end of the second page.

In some embodiments, the second threshold amount of time refers to a specified duration (e.g., 0.1 s, 0.3 s, 0.5 s, 1 s, 2 s, 5 s, or 10 s) that the system waits after the current scroll position reaches the page boundary of the second page and while the position of the directional control remains in the second range of positions before performing a subsequent action (e.g., scrolling to a new page). In some embodiments, the second threshold amount of time is based on the first threshold amount of time. For example, the second threshold amount of time may be a percentage of the first threshold amount of time, such as 10%, 20%, 35%, 50% (e.g., if the first threshold amount of time is 2 s, the second threshold amount of time is 1 s), 75%, or 90%, or may be a certain amount of time shorter or longer than the first threshold amount of time (e.g., 0.2 s shorter/longer, 0.5 s shorter/longer, 1 s shorter/longer, 2 s shorter/longer, or 5 s shorter/longer). In some embodiments, maintaining the current scroll position in the first content to be the page boundary of the second page of the first content for the second threshold amount of time since scrolling the first content to the page boundary of the second page of the first content refers to the system keeping the display of the first content fixed at a specific page boundary (e.g., the page boundary of the second page) without any movement away from this boundary for a set duration of time, different to the set duration of time the system waited after scrolling to the page boundary of the first page of the first content, starting when the system first scrolls to the page boundary of the second page. In some embodiments, if the computer system detects that the input for scrolling the first content terminates during this second threshold amount of time (e.g., because the directional control is detected as moving back to a neutral position, as described herein), the computer system does not perform further scrolling of the first content unless or until further input for scrolling is detected. In some embodiments, after maintaining the current scroll position in the first content to be the page boundary of the second page of the first content for the second threshold amount of time since scrolling to the page boundary of the second page of the first content, the computer system detects that an amount of time since scrolling to the page boundary of the second page of the first content has met the second threshold amount of time. In some embodiments, detecting that the amount of time since scrolling to the page boundary of the second page of the first content has met the second threshold amount of time refers to the process by which the system identifies that a specified duration (e.g., the second threshold amount of time) has elapsed since the content was last scrolled to a designated page boundary (e.g., the page boundary of the second page.

In some embodiments, in response to detecting that an amount of time since scrolling to the page boundary of the second page of the first content has met the second threshold amount of time, the computer system scrolls the first content to a page boundary of a third page of the first content, different from the second page of the first content, such as shown in FIG. 17K where time of timer 1760 has elapsed past threshold 1762. In some embodiments, scrolling the first content to the page boundary of the third page of the first content in response to detecting that the amount of time since scrolling to the page boundary of the second page of the first content has met the second threshold amount of time refers to the automated action by the system to move the display of the first content from the boundary of the second page to the boundary of the third page when the second threshold amount of time has been met. In some embodiments, the third page is the next or previous page with respect to the second page. Maintaining the current scroll position at the page boundary of the second page for a second, shorter duration allows the system to accelerate content navigation to facilitate scrolling through content with larger numbers of pages, thereby allowing users to move through content more quickly and efficiently, reducing overall interaction time and improving system responsiveness.

In some embodiments, after scrolling the first content to the page boundary of the second page of the first content in response to detecting that the amount of time since scrolling to the page boundary of the first page of the first content has met the first threshold amount of time, the computer system detects, via the one or more input devices, a second change in position of the directional control, such as the position of input 1730 in FIG. 17L. In some embodiments, the second change in the position of the directional control refers to any alteration in the orientation, angle, displacement, and/or coordinates of the directional control from its previous state, indicating a new direction and/or magnitude of input. In some embodiments, the system detects the second change in the position of the directional control before the amount of time since scrolling to the page boundary of the first page of the first content has met the first threshold amount of time and applies subsequent actions before or after waiting for the full first threshold amount of time to elapse.

In some embodiments, in response to detecting the second change in position of the directional control and in accordance with a determination that the first set of one or more criteria are met, including the requirement that the position of the directional control is in the first range of positions of the directional control, the computer system scrolls the first content gradually from the page boundary of the second page of the first content based on the position of the directional control within the first range of positions of the directional control, such as shown by the scrolling of the selectable content items from FIG. 17L to FIG. 17M. In some embodiments, the determination that the first set of one or more criteria are met, including the requirement that the position of the directional control is in the first range of positions of the directional control, refers to the system's assessment and confirmation that the specific predefined conditions associated with the first set of one or more criteria have been fulfilled following the second change in the position of the directional control (e.g., the directional control has moved from a position within the second range of positions to a position within the first range of positions). In some embodiments, the first set of one or more criteria being met following the second set of one or more criteria having been met earlier results in the system transitioning from page boundary scrolling to gradual scrolling, beginning to scroll the first content gradually from the page boundary of the second page of the first content based on the position of the directional control. In some embodiments, when the direction relative to the neutral position of the directional control is the same before and after the second change in position of the directional control (e.g., the directional control is on the same side of the neutral position before and after the second change in position, as described above with respect to the first axis), the system gradually scrolls the first content in the same direction as the page boundary scrolling. In some embodiments, when the direction relative to the neutral position of the directional control is different before and after of the second change in position of the directional control (e.g., the directional control is on a different side of the neutral position after the second change in position), the system gradually scrolls the first content in a new direction corresponding to the position of the directional control after the second change in position (optionally the opposite direction of the page boundary scrolling). Detecting a second change in the position of the directional control and transitioning from page boundary scrolling to gradual scrolling based on this input improves user control and system adaptability, allowing for a shift in scrolling behavior that reduces the need for corrective actions, enhances user experience, and optimizes system performance by efficiently responding to dynamic user inputs.

In some embodiments, after scrolling the first content to the page boundary of the second page of the first content in response to detecting that the amount of time since scrolling to the page boundary of the first page of the first content has met the first threshold amount of time, the computer system detects, via the one or more input devices, a second change in position of the directional control, such as the change in position of the directional input 1720 in FIG. 17N. In some embodiments, the second change in the position of the directional control refers to any alteration in the orientation, angle, displacement, and/or coordinates of the directional control from its previous state, indicating a new direction and/or magnitude of input. In some embodiments, the system detects the second change in the position of the directional control before the amount of time since scrolling to the page boundary of the first page of the first content has met the first threshold amount of time and applies subsequent actions before or after waiting for the full first threshold amount of time to elapse.

In some embodiments, in response to detecting the second change in position of the directional control and in accordance with a determination that a third set of one or more criteria are met, wherein the third set of one or more criteria include a requirement that the position of the directional control is in a third range of positions (e.g., the specific subset of possible orientations, angles, displacements, and/or coordinates of the directional control corresponding to the third range of positions, as described in greater detail above), different from the first range of positions and the second range of positions, the computer system forgoes scrolling the first content, such as stopping scrolling in response to the change in control position in FIG. 17N. In some embodiments, the determination that the third set of one or more criteria are met, including the requirement that the position of the directional control is in the third range of positions of the directional control (e.g., a relatively small tilting or movement of the directional control within a neutral angle or distance from the neutral position as described above), refers to the system's assessment and confirmation that the specific predefined conditions associated with the third set of one or more criteria have been fulfilled following the second change in the position of the directional control (e.g., the directional control has moved from a position within the second range of positions to a position within the third range of positions). In some embodiments, the third set of one or more criteria being met following the second set of one or more criteria having been met earlier results in the system transitioning from page boundary scrolling to ceasing to scroll, maintaining the scroll position at the page boundary of the second page of the first content. In some embodiments, forgoing scrolling the first content in response to detecting the second change in position of the directional control and in accordance with the determination that the third set of one or more criteria are met involves maintaining the display of the page that was being displayed when the second change in position was detected (e.g., the second page of the first content). Detecting a second change in the position of the directional control and transitioning from page boundary scrolling to no longer scrolling when the control moves into a third range of positions improves user experience by allowing for interruption of scrolling based on user input, reducing unnecessary content movement and minimizing the need for corrective actions, thereby conserving computational resources.

In some embodiments, in response to detecting the change in the position of the directional control, in accordance with a determination that the position of the directional control is in the second range of positions of the directional control and that the second set of one or more criteria are not met because the first content is not paginated content, the computer system scrolls the first content gradually, such as shown by the selectable content items scrolling in FIG. 17S. In some embodiments, scrolling the first content gradually when the position of the directional control is in the second range of positions and the second set of one or more criteria are not met because the first content is not paginated content refers to the system smoothly navigating through continuous, non-paginated content at a controlled pace, similar to the gradual scrolling associated with the first range of positions, despite the position of the directional control being in the second range of positions given that the first content is not paginated (e.g., page boundary scrolling is not possible). Scrolling the first content gradually when the position of the directional control is in the second range of positions and the content is not paginated ensures smooth and fast navigation through continuous content, thereby allowing users to move through non-paginated content more quickly and efficiently, reducing overall interaction time and improving system responsiveness.

In some embodiments, scrolling the first content gradually in accordance with the determination that the position of the directional control is in the second range of positions of the directional control and that the second set of one or more criteria are not met because the first content is not paginated content includes scrolling the first content gradually based on the position of the directional control within the second range of positions of the directional control, such as scrolling the content in FIG. 17S at different speeds depending on the position input 1738 in the second displacement zone 1714 of positions in FIG. 17S. In some embodiments, scrolling the first content gradually based on the position of the directional control within the second range of positions involves scrolling the first content at a certain scrolling speed and with a certain direction that is correlated to the particular position of the directional control, as described in greater detail above with respect to the scrolling speeds and scrolling direction of the first range of positions. In some embodiments, the scrolling speeds associated with the second range of positions are faster than the scrolling speeds associated with the first range of positions. In some embodiments, when the position of the directional control is in the second range of positions of the directional control and the second set of one or more criteria are not met because the first content is not paginated, when the position is at a first tilt angle or distance from the neutral position, the scrolling speed is a first scrolling speed, and when the position is at a second tilt angle or distance from the neutral position, the scrolling speed is a second scrolling speed, where, when the second tilt angle or distance is greater than the first tilt angle or distance, the second scrolling speed is faster than the first scrolling speed, and when the second tilt angle or distance is smaller than the first tilt angle or distance, the second scrolling speed is slower than the first scrolling speed. Scrolling the first content gradually based on the position of the directional control within the second range of positions, particularly with faster scrolling speeds than those in the first range, improves the efficiency of navigating continuous, non-paginated content, enhancing user experience by providing responsive and appropriately paced scrolling, thereby reducing the time spent on content navigation and conserving computational resources.

In some embodiments, the first content includes a plurality of application icons, such as shown by selectable content items A1-A6 in FIG. 17A. In some embodiments, the plurality of application icons refers to a collection or group of graphical representations or symbols that are used within a digital environment to represent and provide access to different software applications or functions. In some embodiments, the first content including the plurality of application icons is a home screen, dashboard, application launcher, and/or any other user interface that serves as a repository for application icons. In some embodiments, scrolling through the first content when the first content includes the plurality of application icons refers to the system moving the display view across the array of icons in a way that reveals one or more additional icons (or optionally a new page of icons) that were not initially visible on the display and removes one or more icons (or optionally the previous page of icons) that were previously visible. In some embodiments, upon detecting a selection input selecting an application icon of the plurality of application icons (e.g., an air gesture directed at the application icon while the attention of the user is directed at the application icon, navigating to and selecting the application icon with the directional control, a tap on a touchscreen at a location corresponding to the icon, a mouse click while a cursor is at a location corresponding to the icon, a key press on a keyboard, or a voice command), the computer system displays a user interface corresponding to an application associated with the selected application icon. Including a plurality of application icons in the first content and enabling scrolling through these icons improves user interface navigation by allowing users to efficiently access and manage multiple applications, enhancing the overall user experience and reducing the time and effort required to locate specific applications, thereby improving system usability and performance.

In some embodiments, the first content includes a plurality of content items (e.g., a plurality of representations of content), such as if the content in FIG. 17S is content items. In some embodiments, the plurality of content items refers to a collection or group of distinct pieces of content that are presented together within a single interface or digital environment. Some examples of content items include, but are not limited to, text documents, images, videos, interactive elements, links, presentations, spreadsheets, social media feeds, articles, PDFs, and/or any other digital media. In some embodiments, the first content including the plurality of content items is a digital platform, user interface, and/or any other environment that serves as a repository for diverse content items. In some embodiments, scrolling through the first content when the first content includes the plurality of content items refers to the system moving the display view across the array of content items in a way that reveals one or more additional content items (or optionally a new page of content items) that were not initially visible on the display and removes one or more content items (or optionally the previous page of content items) that were previously visible. Including a plurality of content items in the first content and enabling scrolling through these items improves the system's ability to present and manage multiple media items, enhancing user experience by facilitating efficient navigation and access to various content.

In some embodiments, while displaying, via the one or more display generation components, the first content, the computer system detects, via the one or more input devices, an air gesture (e.g., a motion or set of motions made by the user's hand/fingers/other body part which is recognized by the system as a command, such as an air pinch, drag, flick, and/or swipe) directed to the first content (e.g., detected while attention of the user (e.g., based on gaze or a substitute for gaze) is directed to the first content), such as the input from hand 1750 in FIG. 17U.

In some embodiments, in response to detecting the air gesture, in accordance with a determination that the air gesture is an air drag gesture, the computer system scrolls the first content gradually in accordance with movement included in the air drag gesture, such as shown from FIG. 17U-17V where hand 1750 performs an air pinch followed by movement. In some embodiments, the air drag gesture refers to a specific type of air gesture that involves a continuous, smooth motion of the hand/fingers/other body part through the air, simulating the action of dragging an object across a surface. In some embodiments, scrolling the first content gradually in accordance with movement included in the air drag gesture refers to the process of moving the first content across the display with a pace and direction set with respect to one or more characteristics of the air drag gesture (e.g., the speed, direction, and/or duration of the air drag gesture). In some embodiments, the computer system determines that the air gesture is an air drag gesture when the air gesture does not end (e.g., an air pinch is not released) within a threshold amount of time after the air gesture commences (e.g., when the user's fingers touch for the air pinch) and/or when a velocity of the air gesture (e.g., the velocity of the hand performing the air pinch) remains below a velocity threshold. In some embodiments, the threshold amount of time is 0.1, 0.3, 0.5, 1, 3, 5 or 10 seconds, and the velocity threshold is 0.5, 1, 3, 5, 10, or 100 cm/s. In some embodiments, in response to detecting termination of the air drag gesture (e.g., when the computer system detects the fingers of the hand of the user moving apart and no longer forming an air pinch gesture), the computer system snaps (e.g., automatically scrolls, without additional user input) the first content to a page boundary (e.g., as described previously with reference to the directional control returning to a neutral position).

In some embodiments, in response to detecting the air gesture, in accordance with a determination that the air gesture is an air flick gesture, the computer system scrolls the first content to a page boundary of the first content independent of the movement included in the air flick gesture, such as shown from FIG. 17W-17X wherein hand 1750 performs an air flick gesture and in response the selectable content items are scrolled from page one to page two. In some embodiments, the air flick gesture refers to a specific type of air gesture that involves a quick, sharp movement of the hand/fingers/other body part through the air, simulating the action of flicking something away or rapidly flipping through the page of a book. In some embodiments, the computer system determines that the air gesture is an air flick gesture when the air gesture ends (e.g., an air pinch is released) within the above threshold amount of time after the air gesture commences (e.g., when the user's fingers touch for the air pinch) and/or when the velocity of the air gesture (e.g., the velocity of the hand performing the air pinch) exceeds the above velocity threshold. In some embodiments, the computer system determines that the air gesture is an air drag gesture or an air flick gesture based on the velocity of the hand of the user at or near the end of the air gesture (e.g., within the last 0.5, 1, 3, 5, 10 or 25% of the air gesture, or within the last 0.1, 0.3, 0.5, 1, 3, 5 or 10 seconds of the air gesture). In some embodiments, if the velocity of the air gesture at or near the end of the air gesture is above the velocity threshold described above, the computer system optionally determines that the air gesture is an air flick gesture, and if the velocity of the air gesture at or near the end of the air gesture is below the velocity threshold described above, the computer system optionally determines that the air gesture is an air drag gesture. In some embodiments, scrolling the first content to the page boundary of the first content independent of the movement included in the air flick gesture refers to the process of moving the first content to align precisely with the nearest page boundary, such as the beginning or end of a page or the page boundary of the next page in the direction of the air flick gesture, regardless of certain one or more characteristics of the air flick gesture (e.g., the speed and/or duration of the air flick gesture). In some embodiments, the computer system interprets different directions of air flick gestures to correspond to different directions of page boundary scrolling, such as flicking left to move to the next page and right to return to the previous page when the first content is arranged horizontally from left-to-right. In some embodiments, when multiple air flick gestures are detected sequentially, the computer system processes each flick as a separate input for page boundary scrolling, allowing the user to navigate through multiple pages by performing a series of flicks in succession. In some embodiments, the system determines the beginning of an air gesture to be an air drag gesture and the end of the gesture to be an air flick gesture and combines both actions of scrolling the first content gradually in accordance with movement included in the air drag gesture (e.g., during the initial part of the scrolling) and scrolling the first content to a page boundary of the first content independent of the movement included in the air flick gesture (e.g., to end the scrolling). Allowing for air gestures for scrolling and responding by scrolling the first content gradually or to a page boundary improves the system's flexibility in user interaction, enhancing the user experience by allowing multiple types of scrolling input (e.g., directional control-based or hand-based).

It should be understood that the particular order in which the operations in method 1800 have been described is merely exemplary and is not intended to indicate that the described order is the only order in which the operations could be performed. One of ordinary skill in the art would recognize various ways to reorder the operations described herein. In some embodiments, aspects/operations of method 1800 may be interchanged, substituted, and/or added between these methods. For example, various object manipulation techniques and/or object movement techniques of method 1800 is optionally interchanged, substituted, and/or added between these methods. For brevity, these details are not repeated here.

FIGS. 19A through 19G generally illustrate examples of a computer system reducing visibility of a first portion of a hand with virtual content without reducing visibility of a second portion of the hand with virtual content based on the positions of the hands relative to virtual content, in accordance with some embodiments.

FIG. 19A illustrates an example of computer system 101 displaying virtual content 1910 within a three-dimensional environment 1900 (e.g., a three-dimensional user interface), in accordance with some embodiments. It should be understood that, in some embodiments, computer system 101 utilizes one or more techniques described with reference to FIGS. 19A-19G in a two-dimensional environment without departing from the scope of the disclosure. As described above with reference to FIGS. 1-6, computer system 101 optionally includes one or more display generation components 120 (e.g., a head-mounted display) and a plurality of image sensors 114a-114c. Image sensors 114a-114c optionally include one or more of a visible light camera, an infrared camera, a depth sensor, or any other sensor computer system 101 would be able to use to capture one or more images of a user or a portion of user (e.g., one or more hands of the user, such as hand 1902, or an attention of the user (e.g., based on gaze)) while the user interacts with computer system 101. In some embodiments, image sensors 114a-114c optionally capture gestures or movements of hand 1902, such as the act of pinching or the release thereof, as described in greater detail herein. In some embodiments, computer system 101 displays the user interface or three-dimensional environment 1900 to user 1902 (and/or three-dimensional environment 1900 is visible via display generation component 120, such as via passive and/or active passthrough), and uses sensors to detect the physical environment and/or movements of the user's hands (e.g., external sensors facing outwards from the user) such as movements that are interpreted by computer system 101 as gestures such as air gestures, and/or gaze of the user (e.g., internal sensors facing inwards towards the face of the user).

As shown in FIG. 19A, computer system 101 displays three-dimensional environment 1900 including virtual content 1910. In some embodiments, virtual content 1910 shares one or more characteristics with the one or more virtual contents described with respect to methods 800, 1000, 1200, 1400, 1600, 1800, 2000, and/or 2200. FIG. 19A also depicts a top-down view 1901 of virtual content 1910 within three-dimensional environment 1900.

In some embodiments, as illustrated in FIG. 19B, computer system 101 detects, via image sensors 114a-114c, hand 1902 move towards virtual content 1910 within three-dimensional environment 1900 (as also shown in top-down view 1901). In particular, FIG. 19B shows computer system 101 displaying hand 1902, via the display generation component 120, as a result of its approach towards virtual content 1910 (e.g., computer system 101 detects hand 1902 enter a viewport of the user displayed via display generation component 120). In some embodiments, hand 1902 does not visually overlap (e.g., is not in spatial conflict with) virtual content 1910 with respect to the viewpoint of the user, and as a result, computer system 101 does not reduce visibility of hand 1902 with virtual content 1910.

In some embodiments, as illustrated in FIG. 19C, computer system 101 detects, via image sensors 114a-114c, hand 1902 move further towards virtual content 1910 such that hand 1902 is at a location within three-dimensional environment 1900 that conflicts (e.g., spatially) with a location associated with virtual content 1910 (or a virtual content portion 1912a of virtual content 1910). In some embodiments, computer system 101 detects hand 1902 move such that a hand portion 1904a is behind virtual content 1910 with respect to the viewpoint of the user (e.g., behind a virtual content portion 1912a with respect to the viewpoint of the user) and hand portion 1904b is in front of virtual content 1910 with respect to the viewpoint of the user. In some embodiments, computer system 101 detects hand portions 1904a and 1904b visually overlap (e.g., are in spatial conflict with) virtual content 1910 and hand portion 1904c does not visually overlap virtual content 1910. In some embodiments, in response to detecting hand portion 1904a is behind and visually overlaps virtual content portion 1912a, computer system 101 reduces visibility of hand portion 1904a with virtual content 1910 by displaying virtual content portion 1912a and forgoing displaying hand portion 1904a. In some embodiments, in response to detecting hand portion 1904b is in front of and visually overlaps virtual content 1910 (e.g., a portion of virtual content 1910 directly behind hand portion 1904b from the viewpoint of the user), computer system 101 forgoes reducing visibility of hand portion 1904b by displaying hand portion 1904b and forgoing displaying the portion of virtual content 1910 that is directly behind hand portion 1904b from the viewpoint of the user. In some embodiments, in response to detecting hand portion 1904c does not visually overlap virtual content 1910, computer system 101 forgoes reducing visibility of the hand portion 1904c by displaying hand portion 1904c at full visual prominence.

In some embodiments, as illustrated in FIG. 19D, computer system 101 detects, via image sensors 114a-114c, hand 1902 move within three-dimensional environment 1900 with respect to virtual content 1910 (and/or virtual content 1910 move with respect to hand 1902) such that hand 1902 has a different spatial relationship with virtual content 1910. In some embodiments, upon detecting hand 1902 move within three-dimensional environment 1900, computer system 101 determines that a hand portion 1904d is behind virtual content 1910 (e.g., behind a virtual content portion 1912b) and a hand portion 1904e is in front of virtual content 1910. In some embodiments, upon detecting hand 1902 move within three-dimensional environment 1900, computer system 101 determines that hand portions 1904d and 1904e visually overlap (e.g., are in spatial conflict with) virtual content 1910 and a hand portion 1904f does not visually overlap virtual content 1910. In some embodiments, in response to detecting hand portion 1904d is behind and visually overlaps virtual content portion 1912b, computer system 101 reduces visibility of hand portion 1904d with virtual content 1910 by displaying virtual content portion 1912b at full visual prominence and forgoing displaying hand portion 1904d. In some embodiments, in response to detecting hand portion 1904e in front of and visually overlapping virtual content 1910 (e.g., a portion of virtual content 1910 directly behind hand portion 1904e from the viewpoint of the user), computer system 101 forgoes reducing visibility of hand portion 1904e by displaying hand portion 1904e and forgoing displaying the portion of virtual content 1910 that is directly behind hand portion 1904e from the viewpoint of the user. In some embodiments, in response to detecting hand portion 1904f does not visually overlap virtual content 1910, computer system 101 forgoes reducing visibility of the hand portion 1904f by displaying hand portion 1904f without displaying a portion of virtual content 1910 at a location of hand portion 1904 in three-dimensional environment 1900 from the viewpoint of the user.

In some embodiments, as illustrated in FIG. 19E, computer system 101 displays an edge region 1914 according to a feathering treatment. In some embodiments, the feathering treatment shares one or more characteristics with the feathering treatments described with respect to methods 1000, 1200, 1400, 1600, 1800, and/or 2000. In some embodiments, the feathering treatment of edge region 1914 defines a visual transition between a visual prominence of the portion of virtual content 1910 that is behind hand portion 1904e from the viewpoint of the user and a visual prominence of a portion of virtual content 1910 that is not behind hand portion 1904e (e.g., virtual content portion 1912c, which is optionally the rest of virtual content 1910 or a subset of the rest of virtual content 1910). In some embodiments, the feathering treatment refers to edge region 1914 having a gradual transition in visibility (e.g., opacity, brightness, contrast, and/or color intensity) to provide a smooth shift between the reduced-visibility portion of virtual content 1910 that is behind hand portion 1904e and virtual content portion 1912c. In some embodiments, one or more characteristics of edge region 1914 (e.g., the dimensions, opacity, brightness, contrast, color intensity, and/or sharpness of gradual transition) are determined based on one or more characteristics of three-dimensional environment 1900, hand 1902, and/or virtual content 1910, as described in greater detail with respect to method 2000.

In some embodiments, as illustrated in FIG. 19F, computer system 101 detects, via image sensors 114a-114c, hand 1902 move within three-dimensional environment 1900 with respect to virtual content 1910 (and/or virtual content 1910 move with respect to hand 1902) such that hand 1902 has a different spatial relationship with virtual content 1910. In some embodiments, upon detecting hand 1902 move within three-dimensional environment 1900, computer system 101 determines that a hand portion 1904g is behind virtual content 1910 (e.g., behind a virtual content portion 1912d), a hand portion 1904h is crossing virtual content 1910 (e.g., shares a location with a virtual content portion 1912e), and a hand portion 1904i is in front of virtual content 1910. In some embodiments, computer system 101 determines that hand portions 1904g and 1904h visually overlap (e.g., are in spatial conflict with) virtual content 1910 and a hand portion 1904i does not visually overlap virtual content 1910. In some embodiments, in response to detecting hand portion 1904g is behind and visually overlaps virtual content portion 1912d, computer system 101 reduces visibility of hand portion 1904g with virtual content 1910 by displaying virtual content portion 1912d with a first level of opacity (e.g., determined based on a distance between hand portion 1904g and virtual content portion 1912d, as described in greater detail with respect to method 1800) and displaying hand portion 1904g behind virtual content portion 1912d (e.g., at least partially occluded by virtual content portion 1912). In some embodiments, in response to detecting hand portion 1904h is crossing virtual content 1910, computer system 101 reduces visibility of hand portion 1904h with virtual content 1910 by displaying virtual content portion 1912e with a second level of opacity, less than the first level of opacity, and displaying hand portion 1904h at the same location as virtual content portion 1912e. In some embodiments, in response to detecting hand portion 1904i is in front of and visually overlaps virtual content 1910 (e.g., a portion of virtual content 1910 directly behind hand portion 1904i from the viewpoint of the user), computer system 101 forgoes reducing visibility of hand portion 1904i by displaying hand portion 1904i and forgoing displaying (or displaying with a third level of opacity, less than the second level of opacity) the portion of virtual content 1910 that is directly behind hand portion 1904i from the viewpoint of the user.

In some embodiments, as illustrated in FIG. 19G, computer system 101 detects, via image sensors 114a-114c, hand 1902 move within three-dimensional environment 1900 with respect to virtual content 1910 (and/or virtual content 1910 move with respect to hand 1902) such that hand 1902 has a different spatial relationship with virtual content 1910 (e.g., hand 1902 completely crosses and moves behind virtual content 1910). In some embodiments, computer system 101 detects hand 1903 move towards virtual content 1910 within three-dimensional environment 1900 such that computer system 101 displays hand 1903 via display generation 120 (e.g., computer system 101 detects hand 1902 enter a viewport of the user displayed via display generation component 120). In some embodiments, computer system 101 determines that a hand portion 1904j of hand 1902 is behind virtual content 1910 (e.g., behind a virtual content portion 1912f) and a hand portion 1904k of hand 1903 is in front of virtual content 1910. In some embodiments, computer system 101 determines that hand portions 1904j and 1904k visually overlap (e.g., are in spatial conflict with) virtual content 1910 and a hand portion 19041 does not visually overlap virtual content 1910. In some embodiments, in response to detecting hand portion 1904j is behind and visually overlaps virtual content portion 1912f, computer system 101 reduces visibility of hand portion 1904j with virtual content 1910 by displaying virtual content portion 1912f and forgoing displaying hand portion 1904j. In some embodiments, in response to detecting hand portion 1904k is in front of and visually overlaps virtual content 1910 (e.g., a portion of virtual content 1910 directly behind hand portion 1904k from the viewpoint of the user), computer system 101 forgoes reducing visibility of hand portion 1904k by displaying hand portion 1904k and forgoing displaying the portion of virtual content 1910 that is directly behind hand portion 1904k from the viewpoint of the user. In some embodiments, in response to detecting hand portion 19041 does not visually overlap virtual content 1910, computer system 101 forgoes reducing visibility of the hand portion 19041 by displaying hand portion 19041 with full visibility. In some embodiments, while maintaining display of hand portions 1904k and 19041 (e.g., hand 1903), computer system 101 reduces visibility of hand portion 1904j (e.g., hand 1902) by completely replacing display of hand portion 1904j with virtual content portion 1912f such that, as computer system 101 detects hand portion 1904j move with respect to virtual content 1910 (and/or virtual content 1910 move with respect to hand 1902) while remaining behind and visually overlapping virtual content 1910, computer system 101 updates virtual content portion 1912f to match an updated location of hand portion 1904j.

FIG. 20 is a flowchart illustrating a method of a computer system reducing visibility of a first portion of a hand with virtual content without reducing visibility of a second portion of the hand with virtual content based on the positions of the hands relative to virtual content in accordance with some embodiments. In some embodiments, the method 2000 is performed at a computer system (e.g., computer system 101 in FIG. 1A such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 2000 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 2000 are, optionally, combined and/or the order of some operations is, optionally, changed.

The devices, methods, and/or computer-readable storage mediums described below enhance the operability of the device and makes the user-device interface more efficient (e.g., by helping the user to provide proper inputs and reducing user mistakes when operating/interacting with the device) which, additionally, reduces power usage and/or improves battery life of the device by enabling the user to use the device more quickly and efficiently. Providing improved feedback (such as by occluding portions of a hand of the user that are in spatial conflict with virtual content, and/or displaying portions of the hand of the user that in spatial conflict with but are in front of virtual content with respect to the viewpoint of the user) enhances the operability of the device by reducing accidental and mistaken inputs, reducing energy usage by the device. Displaying user interface elements (such as virtual content in which portions of the content are displayed with reduced visibility when a portion of the hand of the user is in spatial conflict with the virtual content and are in front of the virtual content with respect to the viewpoint of the user) with different appearances at different times helps to avoid image persistence or burn in effects that are can occur with some display technologies when the same object is displayed with the same appearance at the same location repeatedly or for a long period of time.

In some embodiments, method 2000 is performed at a computer system in communication with one or more display generation components and one or more input devices, such as computer system 101 in communication with display generation component 120 and input devices 114a-114c in FIGS. 19A-19G. In some embodiments, the computer system has one or more of the characteristics of the computer systems of methods 800, 1000, 1200, 1400, 1600, and/or 1800. In some embodiments, the one or more display generation components have one or more of the characteristics of the display generation components of methods 800, 1000, 1200, 1400, 1600, and/or 1800. In some embodiments, the one or more input devices have one or more of the characteristics of the one or more input devices of methods 800, 1000, 1200, 1400, 1600, and/or 1800.

In some embodiments, the computer system performs some embodiments of method 2000 while displaying, via the one or more display generation components, first virtual content in a three-dimensional environment, such as computer system 101 displaying, via display generation component 120, virtual content 1910 in three-dimensional environment 1900 in FIG. 19A. In some embodiments, while displaying the first virtual content, the computer system detects (2002), via the one or more input devices, a first portion of one or more hands of a user of the computer system and a second portion of the one or more hands of the user of the computer system at a location in the three-dimensional environment that conflicts (e.g., spatially conflicts and/or is in a same region of a viewport that would be occupied by the first virtual content) with a location associated with a respective portion of the first virtual content from a viewpoint of the user (e.g., the first portion of the one or more hands, the second portion of the one or more hands, and the respective portion of the first virtual content are in a same region of the field of view of the three-dimensional environment), such as computer system 101 detecting, via input devices 114a-114c, hand portions 1904a and 1904b of hand 1902 of the user of computer system 101 at a location in three-dimensional environment that conflicts with a lower-right portion of virtual content 1910 in FIG. 19C.

In some embodiments, the first virtual content is a representation of a physical object, a user interface element, or a virtual object that is displayed in the viewport of the user of the computer system as described with respect to methods 800, 1000, 1200, 1400, 1600, and/or 1800. While displaying the first virtual content, the computer system optionally detects a position of a first portion of one or more hands of a user. For example, the computer system optionally detects the first portion of one or more hands using a camera, and/or by detecting a position of a controller held in the hand of a user, and/or by using an estimated hand position based on one or more features (e.g., a skeletal position). Additionally, the computer system optionally detects a position of a second portion of one or more hands of the user. In some examples, the first portion of one or more hands and the second portion of one or more hands are on and/or part of a single hand (e.g., a thumb portion, a finger portion, and/or a palm portion). Optionally, the first portion and the second portion are portions of different hands (e.g., the first portion is a portion of a left hand and the second portion is a portion of a right hand. In some embodiments, the first portion and the second portion are mutually exclusive portions of the same hand (e.g., a thumb portion and a finger portion), or on different hands (e.g., a first thumb portion of a first hand and a second thumb portion of a second hand). In some embodiments, the first portion and the second portion have at least some overlap such as a joint between the two portions. In some embodiments, the first portion or the second portion includes portions of other parts of a body of the user such as arms, legs, elbows, and/or head. For example, the first portion is optionally a portion of the arm of the user and the second portion is optionally an elbow of the user.

In some embodiments, in response to (and/or while) detecting the first portion of the one or more hands of the user and the second portion of the one or more hands of the user at the location in the three-dimensional environment that conflicts with the location associated with the respective portion of the first virtual content from the viewpoint of the user (2004), in accordance with a determination that the first portion of the one or more hands of the user is behind the location associated with the respective portion of first virtual content in the three-dimensional environment with respect to the viewpoint of the user and that the second portion of the one or more hands of the user is in front of the location associated with the respective portion of the first virtual content in the three-dimensional environment with respect to the viewpoint of the user (e.g., computer system 101 determining that hand portion 1904a is behind virtual content 1910 (e.g., behind virtual content portion 1912a) and hand portion 1904b is in front of virtual content 1910 with respect to the viewpoint of the user in FIG. 19C), the computer system reduces visibility (2006) of the first portion of the one or more hands with the first virtual content (e.g., by fully or partially occluding the first virtual content) without reducing visibility of the second portion of the one or more hands with respect to the first virtual content (e.g., maintaining the visibility of the second portion of the one or more hands of the user), such as computer system 101 reducing visibility of hand portion 1904a by displaying virtual content portion 1912a without reducing visibility of hand portion 1904b by occluding a virtual content portion that is behind hand portion 1904b from the viewpoint of the user in FIG. 19C.

In some embodiments, detecting the one or more portions of the hand (e.g., first hand or second hand and/or different portions of the same hand) of the user, and/or determining that the first portion is behind the first virtual content, shares one or more characteristics with such aspects related to the one or more portions of the user as described with respect to methods 1600 and/or 2000. In some embodiments, detecting a second portion of the hand (e.g., first hand or second hand and/or portions of the same hand) of the user, and/or determining that the second portion is in front of the first virtual content, shares one or more characteristics with such aspects related to the one or more portions of the user as described with respect to methods 1600 and/or 2000. In some embodiments, the determinations that the first portion is behind the virtual content and the second portion is in front of the first virtual content occur at least partially concurrently. In some embodiments, the reduction in visual prominence of the first portion and the forgoing of the reduction of visibility of the second portion occur at least partially concurrently as described below. In some embodiments, reducing the visibility of the first portion includes applying one or more of the following techniques for increasing the visibility of the first portion of the one or more hands including but not limited to: modifying a translucency, brightness, and or tint of the first virtual content, ceasing display of the first virtual content at the portion corresponding to the first portion of the one or more hands of the user, and/or changing an optical property of the content to enhance visibility of the one or more portions of the hands of the user. In some embodiments, the computer system, in response to determining that the first portion of the hand is at a greater depth than (e.g., behind) the first virtual content with respect to the viewpoint of the user, reduces the visual prominence (e.g., occludes) the first portion of the one or more hands with the first virtual content (e.g., at least a portion of the first virtual content that is in spatial conflict with the first portion of the hand) such that the computer system presents and/or displays the first virtual content and does not present/display the first portion of the hand that is behind the first virtual content. In some embodiments, the computer system occludes the first portion of the hand of the user in response to detecting that the first portion is both behind the first virtual content and visually overlaps (e.g., is in spatial conflict with) the first portion of the hand of the user with respect to the viewpoint of the user. In some embodiments, the computer system forgoes reducing visibility of the second portion of the hand of the user in response to detecting that the second portion is both in front of the first virtual content and visual overlaps (e.g., is in spatial conflict with) the second portion of the hand of the user with respect to the viewpoint of the user.

In some embodiments, determining a spatial conflict between the first and/or second portions of the hand of the user and the first virtual content share one or more characteristics with the determination of spatial conflicts described with respect to methods 800, 1000, 1200, 1400, 1600, and/or 1800. In some embodiments, the reduction in visual prominence or visibility of the first portion of the one or more hands includes modifying a brightness, an opacity, modifying the color, and/or modifying the resolution of the first portion of the one or more hands. In some embodiments, the reduction in visual prominence or visibility of the one or more hands includes modifying a brightness, an opacity, modifying the color, and/or modifying the resolution of the first virtual content (e.g., at least the portion of the first virtual content that visually overlaps the first portion of the hand. In some embodiments, when the computer system detects the depth of the first virtual content or the first or second portion of the hands changing, the computer system updates the display to occlude portions of the one or more hands that are at a greater depth than the first virtual content and that are in spatial conflict with the first virtual content. The computer system optionally updates the relationship (e.g., and the occlusion or presentation) of the first portion, the second portion, and the first virtual content at any time interval up to and inclusive of continuous updates (e.g., every 0.01, 0.1, 0.5, 1, and/or 5 seconds).

In some embodiments, the determination that the second portion of the user is at a lesser depth than the first virtual content results in the computer system forgoing occlusion of the second portion of the one or more hands such that the computer system presents the second portion (e.g., when the portion of the first virtual content is in spatial conflict with the second portion). In some embodiments, the computer system presents a representation of the portion of the one or more hands that is being displayed without occlusion using one or more visual characteristics described with respect to methods 1600, 2000, and/or 2200.

In some embodiments, while the first portion of the one or more hands has the reduced visibility with the virtual content and the second portion of the one or more hands does not have reduced visibility with the virtual content (e.g., hand portion 1904a having reduced visibility with virtual content portion 1912a and 1904b not having reduced visibility in FIG. 19C), the computer system detects an event corresponding to movement of the virtual content relative to the first or second portions of the one or more hands, such as computer system 101 detecting movement of hand 1902 between FIGS. 19C and 19D. In some embodiments, detecting an event corresponding to movement of the virtual content relative to the first or second portions of the one or more hands refers to determining that the virtual content and/or the first or second portions of the one or more hands have changed position and/or orientation with respect to each other from the viewpoint of the user. In some embodiments, the virtual content and/or the first or second portions of the one or more hands are determined to change position and/or orientation with respect to each other from the viewpoint of the user, when the computer system detects either that the virtual content has moved and/or the one or more portions of the hand has moved. In some embodiments, the computer system detects the event corresponding to movement of the virtual content relative to the first or second portions of the one or more hands when the virtual content remains stationary within the three-dimensional environment and at least one of the first or second portions of the one or more hands and/or the viewpoint of the user changes (e.g., the user moves their head and/or moves around their physical environment).

In some embodiments, detecting movement of the virtual content relative to the first or second portions of the one or more hands includes determining that a user input (e.g., an air pinch-accompanied with movement of the hand performing the air pinch or similar gesture) changes the location and/or orientation of the virtual content in the three-dimensional environment relative to the location associated with the one or more hands. In some embodiments, detecting movement of the virtual content relative to the first or second portions of the one or more hands refers to the computer system monitoring one or more positional, rotational, and/or size changes (e.g., translations, rotations, and/or scaling based on user inputs such as air gestures) of the virtual content and determining whether the one or more changes alter the spatial relationship between the virtual content and the one or more hands. In some embodiments, detecting movement of the virtual content relative to the first or second portions of the one or more hands includes analyzing depth and/or layering information in the three-dimensional environment to determine whether the virtual content is moving in front of or behind the one or more hands, from the viewpoint of the user.

In some embodiments, in response to detecting the event corresponding to movement of the virtual content relative to the first or second portions of the one or more hands, the computer system changes, via the one or more display generation components, visibility of the first portion and the second portion of the one or more hands based on the movement of the virtual content relative to the first or second portions of the one or more hands, such as computer system 101 changing visibility of hand portions 1904a and 1904b based on the movement of hand 1902 such that computer system 101 reduces visibility of hand portion 1904d and does not reduce visibility of hand portion 1904e in FIG. 19D. In some embodiments, changing visibility of the first portion and the second portion of the one or more hands refers to a process in which the computer system re-renders, refreshes, and/or modifies how each of the first and second portions of the one or more hands is displayed or is not displayed (e.g., by adjusting one or more of the brightness, color, resolution, and/or opacity) when viewed in the three-dimensional environment in response to one or more changes (e.g., alterations in viewpoint, relative position, and/or overlap with the first virtual content). In some embodiments, changing visibility of the first portion and the second portion of the one or more hands involves displaying portions of the one or more hands detected as behind the first virtual content (from the viewpoint of the user) with reduced visibility and portions of the one or more hands detected as in front of the first virtual content without reduced visibility. In some embodiments, the computer system periodically determines (e.g., every 0.1, 0.5, 1, 5, or 10 seconds) whether the first and/or the second portions (or different portions) of the one or more hands are behind or in front of the first virtual content, and accordingly changes the display of each portion.

In some embodiments, in response to detecting the movement of the virtual content, in accordance with a determination that at least part of the first portion of the one or more hands of the user is in front of the location associated with the respective portion of the first virtual content in the three-dimensional environment with respect to the viewpoint of the user, the computer system increases the visibility (e.g., changes the visibility) of the at least part of the first portion of the one or more hands of the user. For example, when the virtual content is moved such that a first sub-portion of the first portion is behind the location associated with the respective portion of the first virtual content and a second sub-portion of the first portion is in front of the location associated with the respective portion of the first virtual content, the computer system changes the display of the first portion to reduce (or optionally maintain reduced when the first sub-portion was previously behind the location) the visibility of the first sub-portion and to increase (or optionally maintain increased when the second sub-portion was previously in front of the location) the visibility of the second sub-portion.

In some embodiments, in response to detecting the movement of the virtual content, in accordance with a determination that at least part of the second portion of the one or more hands of the user is behind the location associated with the respective portion of the first virtual content in the three-dimensional environment with respect to the viewpoint of the user, the computer system reduces the visibility of the at least part of the second portion of the one or more hands of the user. For example, when the virtual content is moved such that a first sub-portion of the second portion is behind the location associated with the respective portion of the first virtual content and a second sub-portion of the second portion is in front of the location associated with the respective portion of the first virtual content, the computer system changes the display of the second portion to reduce (or optionally maintain reduced when the first sub-portion was previously behind the location) the visibility of the first sub-portion and to increase (or optionally maintain increased when the second sub-portion was previously in front of the location) the visibility of the second sub-portion.

In some embodiments, changing the display of the first and/or second portions of the one or more hands of the user includes modifying a third portion of the one or more hands that overlaps with the virtual content and not modifying a fourth portion of the one or more hands that does not overlap with the virtual content. In some embodiments, in accordance with a determination that the first portion of the one or more hands of the user is in front of the location associated with the respective portion of the first virtual content in the three-dimensional environment with respect to the viewpoint of the user, increasing the visibility of the second portion of the one or more hands with the virtual content. In some embodiments, in accordance with a determination that the second portion of the one or more hands of the user is behind the location associated with the respective portion of the first virtual content in the three-dimensional environment with respect to the viewpoint of the user, reducing visibility of the second portion of the one or more hands with the first virtual content.

In some embodiments, the first portion of the one or more hands and the second portion of the one or more hands are portions of the same hand, such as hand portions 1904a and 1904b in FIG. 19C. In some embodiments, the first and second portions of the one or more hands being portions of the same hand refers to both portions belonging to a single physical hand of the user. For instance, the first portion of the one or more hands is the thumb of the right hand of the user, while the second portion of the one or more hands is the four other fingers of the right hand of the user. Thus, in some embodiments, when the thumb of the hand of the user is behind the virtual content from the viewpoint of the user, it is occluded by the virtual content, and concurrently while the four other fingers of the right hand are in front of the content (e.g., from the viewpoint of the user) the four fingers occlude the portion of the virtual content that is in spatial conflict with the four fingers.

In some embodiments, the first portion of the one or more hands is a portion of a first hand of the user and the second portion of the one or more hands is a portion of a second hand of the user, different from the first hand, such as hand portion 1912f being a portion of hand 1902 and hand portion 1904k being a portion of hand 1903 in FIG. 19G. In some embodiments, the first and second portions of the one or more hands being portions of different hands refers to the first portion belonging to a first hand of the user (e.g., the right hand) and the second portion belonging to a second hand of the user (e.g., the left hand), different from the first hand of the user. Thus, in some embodiments, when the left hand of the user is behind the virtual content from the viewpoint of the user, it is occluded by the virtual content, and concurrently while the right hand of the user is front of the content (e.g., from the viewpoint of the user) the right hand occludes the portion of the virtual content that is in spatial conflict with the right hand.

In some embodiments, in response to detecting the first portion of the one or more hands of the user and the second portion of the one or more hands of the user at the location in the three-dimensional environment that conflicts with the location associated with the respective portion of the first virtual content from the viewpoint of the user (e.g., hand portions 1904a and 1904b at the location in three-dimensional environment 1900 that conflicts with the location associated with virtual content 1910 from the viewpoint of the user in FIG. 19C), in accordance with a determination that the first portion of the one or more hands of the user of the computer system and the second portion of the one or more hands of the user of the computer system are behind the location associated with the respective portion of the first virtual content in the three-dimensional environment with respect to the viewpoint of the user (e.g., if hand portions 1904a and 1904b of FIG. 19C were behind virtual content 1910 with respect to the viewpoint of the user, as in FIG. 19G), the computer system reduces visibility of both the first portion and the second portion of the one or more hands with respect to the first virtual content, such as computer system 101 reducing visibility of hand portion 1904j by displaying virtual content portion 1912f in FIG. 19G.

In some embodiments, determining that the first portion and/or the second portion of the one or more hands of the user of the computer system is at the respective location in the three-dimensional environment that conflicts with the respective location associated with the first respective portion of the virtual content shares one or more characteristics with determining that the first portion of the one or more hands of the computer system is at the location in the three-dimensional environment that conflicts with the location associated with the respective portion of the virtual content described above. In some embodiments, determining that the first portion and/or the second portion of the one or more hands of the user is behind the respective location in the three-dimensional environment associated with the first respective portion of the first virtual content shares one or more characteristics with determining that the first portion of the one or more hands of the user is behind the location in the three-dimensional environment associated with the respective portion of the virtual content described above.

In some embodiments, in response to detecting the first portion of the one or more hands of the user and the second portion of the one or more hands of the user at the location in the three-dimensional environment that conflicts with the location associated with the respective portion of the first virtual content from the viewpoint of the user (e.g., hand portions 1904a and 1904b at the location in three-dimensional environment 1900 that conflicts with the location associated with virtual content 1910 from the viewpoint of the user in FIG. 19C), in accordance with a determination that the first portion of the one or more hands of the user of the computer system and the second portion of the one or more hands of the user of the computer system are in front of the location associated with the respective portion of the first virtual content in the three-dimensional environment with respect to the viewpoint of the user (e.g., if hand portions 1904a and 1904b of FIG. 19C were in front of virtual content 1910 with respect to the viewpoint of the user), the computer system maintains visibility of both the first portion and the second portion of the one or more hands with respect to the first virtual content, such as computer system 101 maintaining visibility of hand portions 1904a and 1904b by occluding portions of virtual content 1910 behind hand portions 1904a and 1904b from the viewpoint of the user if these portions were in front of virtual content 1910 in FIG. 19C.

In some embodiments, determining that the first portion of the one or more hands and/or the second portion of the one or more hand of the user is in front of the respective location in the three-dimensional environment associated with the first respective portion of the first virtual content shares one or more characteristics with determining that the second portion of the one or more hands of the user is in front of the location in the three-dimensional environment associated with the respective portion of the virtual content described above. In some embodiments, maintaining visibility of the first portion and the second portion of the one or more hands with the first virtual content shares one or more characteristics with maintaining visibility of the second portion of the one or more hands described above.

In some embodiment, reducing visibility of (e.g., fully or partially occluding) the first portion of the one or more hands with the first virtual content without reducing visibility of the second portion of the one or more hands with the first virtual content includes reducing a visual prominence of a first region of the first virtual content corresponding to a respective location in the three-dimensional environment that conflicts with the second portion of the one or more hands, such as reducing the visual prominence of a portion of virtual content 1910 that is behind hand portion 1904e with respect to the viewpoint of the user in FIG. 19E. In some embodiments, visual prominence refers to a degree or extent to which a portion of the first virtual content (or other displayed content) is visually prominent or visually subdued relative to the viewpoint of the user in the three-dimensional environment (e.g., including aspects such as opacity, brightness, contrast, and/or color intensity). In some embodiments, the first region refers to a particular portion or subset of the first virtual content (e.g., identified by a spatial conflict with a portion of the one or more hands of the user, such as the second portion). For example, the first region optionally refers to a portion of the first virtual content that is behind the second portion of the one or more hands of the user in the three-dimensional environment from the viewpoint of the user.

In some embodiments, reducing the visual prominence of the first region includes displaying, via the one or more display generation components, an edge region of the first region according to a feathering treatment, such as computer system 101 displaying, via display generation component 120, edge region 1914 of the portion of virtual content 1910 that is behind hand portion 1904e from the viewpoint of the user according to a feathering treatment in FIG. 19E. In some embodiments, the feathering treatment defines a visual transition between the visual prominence of the first region of the first virtual content and a visual prominence of a second region of the first virtual content outside of the first region of the first virtual content that did not have its visual prominence reduced in response to reducing visibility of the first portion of the one or more hands with the first virtual content, such as the feathering treatment defining a visual transition between the visual prominence of the portion of virtual content 1910 that is behind hand portion 1904e from the viewpoint of the user and a visual prominence of a portion of virtual content 1910 that is not behind hand portion 1904e (e.g., virtual content portion 1912c, which is optionally the rest of virtual content 1910 or a subset of the rest of virtual content 1910) in FIG. 19E.

In some embodiments, the edge region and/or the feathering treatment share one or more characteristics with the edge regions and feathering treatments described respect to methods 1000, 1200, 1400, and/or 1600. In some embodiments, the edge region of the first region refers to a boundary portion of the first region of the first content that defines where a transition or gradient of visual prominence begins and ends relative to the rest of the first region. In some embodiments, the edge region of the first region spans a distance (e.g., in pixels or a percentage of the total size of the first region) that determines how smooth or sharp the transition of visual prominence is (e.g., a smaller distance corresponds to a sharper transition and a larger distance corresponds to a smoother transition). In some embodiments, the edge region of the first region is determined based on a shape and/or orientation of the first region in the three-dimensional environment.

In some embodiments, a feathering treatment refers to a gradual transition in visibility (e.g., opacity, brightness, contrast, and/or color intensity) at an edge or boundary (e.g., the edge region) of a reduced-visibility region (e.g., the first region) of the first virtual content (e.g., so that the first region merges smoothly into adjacent regions, such as the second region of the first virtual content whose visibility is not reduced). In some embodiments, the feathering treatment includes a shading algorithm, pixel-based blending techniques, color overlays (e.g., an overlay that gradually fades into one or more colors of the second region), blurring, and/or other techniques for rendering a smooth transition between the first and second regions. In some embodiments, the transition between the visual prominence of the first region and the visual prominence of the second region refers to a boundary or gradient zone (e.g., the feathered edge region) in which the visual prominence of the first virtual content changes from the first virtual prominence (e.g., applied to the first region) to the second visual prominence (e.g., applied to the second region) to provide a smooth shift between the reduced-visibility area and the normal-visibility area. In some embodiments, the feathering treatment involves modifying the visual prominence (e.g., modifying one or more of an opacity, brightness, contrast, and/or color intensity of the first virtual content) of the first region over one or more discrete or continuous steps within the first region. For example, the system optionally increases an opacity of the first region from a lower opacity nearer to the center of the first region to a higher opacity further away from the center of the first region (e.g., all within the edge region).

In some embodiments, reducing visibility of (e.g., fully or partially occluding) the first portion of the one or more hands with the first virtual content without reducing visibility of the second portion of the one or more hands with the first virtual content includes, in accordance with a determination that the first portion of the one or more hands is a first distance from the first virtual content (e.g., in front of or behind the virtual content relative to the viewpoint of the user), such as computer system 101 determining that hand portion 1904h is a respective distance from virtual content 1910, displaying, via the one or more display generation components, a first portion of the first virtual content corresponding to the first portion of the one or more hands with a first visual prominence relative to the three-dimensional environment, such as computer system 101 displaying hand portion 1904h with a respective visual prominence (e.g., by at least partially displaying virtual content portion 1912e) in FIG. 19F.

In some embodiments, the first distance refers to a predefined span of spatial separation values (e.g., depths, Euclidean distances, or projections along a line-of-sight vector) between at least part of the first portion of the one or more hands of the user and a respective location associated with a portion of the first virtual content in the three-dimensional environment. For example, the first distance is optionally expressed in metric units (e.g., 0 mm, 1 mm, 5 mm, 15 mm, 50 mm, 100 mm, 300 mm, or 500 mm) measured along a straight line between a centroid of the first portion and a nearest point on the first virtual content. In some embodiments, the first level of opacity is a visual-transparency value (e.g., a scalar between fully opaque (e.g., with an opacity value of 1.0) and fully transparent (e.g., with an opacity value of 0.0), a selectable alpha-channel, or a brightness/alpha pair) that the computer system applies to the first portion of the first virtual content whenever at least part of the first portion of the one or more hands is within the first distance range. In some embodiments, the first level of opacity is determined based on ambient-light sensor readings (e.g., translucency is optionally increased in brighter environments and decreased in and decreased in darker environments). In some embodiments, the first level of opacity is applied to the first portion of the first virtual content when the first portion of the one or more hands of the user is in front of (with respect to the viewpoint of the user) and is greater than a threshold distance (e.g., greater than 5 mm, 15 mm, 50 mm, 100 mm, 300 mm or 500 mm) from the first virtual content.

In some embodiments, reducing visibility of the first portion of the one or more hands with the first virtual content without reducing visibility of the second portion of the one or more hands with the first virtual content includes, in accordance with a determination that the first portion of the one or more hands is a second distance from the first virtual content (e.g., in front of or behind the virtual content relative to the viewpoint of the user), different from the first distance, such as computer system 101 determining that hand portion 1904g is a respective distance from virtual content 1910, different from the distance between hand portion 1904g and virtual content 1910, displaying, via the one or more display generation components, the first portion of the first virtual content corresponding to the first portion of the one or more hands with a second visual prominence, different from the first visual prominence, relative to the three-dimensional environment, such as computer system 101 displaying hand portion 1904g with a respective visual prominence (e.g., by displaying virtual content portion 1912d) in FIG. 19F.

In some embodiments, the second distance shares one or more characteristics with the first distance described above. In some embodiments, the second level of opacity shares one or more characteristics with the first level of opacity. In some embodiments, the second distance includes distances of the one or more portions of the hand of the user that are within a threshold distance (e.g., less than 50 mm, 15 mm, or 5 mm) from the virtual content regardless of whether the one or more portions of the hand are in front of or behind the virtual content with respect to the viewpoint of the user. In some embodiments, in response to detecting that at least part of the first portion of the one or more hands moves from the first distance range into the second distance range, the computer system changes the opacity of the corresponding first portion of the first virtual content from the first level of opacity to the second level of opacity. In some embodiments, when the second distance range is further from the viewpoint of the user than the first distance range, the second level of opacity is less than the first level of opacity. In some embodiments, when the first distance range is further from the viewpoint of the user than the second distance range, the first level of opacity is greater than the second level of opacity. In some embodiments, the computer system displays the second portion of the first virtual content corresponding to the second portion of the one or more hands of the user (that is in front of the virtual content) with a third level of opacity, different from the first level and second level of opacity. In some embodiments, the third level of opacity refers to a level of opacity that is displayed when the hand of the user is detected as being in front of the virtual content. In some embodiments, the third level of opacity shares one or more characteristics with the first and/or second levels of opacity described above. In some embodiments, the third level of opacity is zero, such that one or more portions of the virtual content that are behind one or more portions of the one or more hands are fully transparent.

In some embodiments, the first portion of the one or more hands of the user is a first hand of the user, and the second portion of the one or more hands of the user is a second hand of the user, such as computer system 101 detecting hands 1902 and 1903 in FIG. 19G. In some embodiments, while maintaining visibility of the second portion of the one or more hands of the user in the three-dimensional environment, and while displaying second virtual content, that replaces visibility of the first portion of the one or more hands of the user, at a first location within the three-dimensional environment (e.g., while computer system 101 maintains visibility of hand 1903 and displays virtual content portion 1912f that replaces visibility of hand 1902), the computer system detects, via the one or more input devices, movement of the first portion of the one or more hands of the user from a first location within a physical environment of the user to a second location, different from the first location, within the physical environment of the user, such as is computer system 101 detected, via input devices 114a-114c, movement of hand 1902 from its location in FIG. 19G to a different location in three-dimensional environment 1900 while remaining behind virtual content 1910.

In some embodiments, in response to detecting movement of the first portion of the one or more hands of the user from the first location to the second location in the physical environment of the user, the computer system moves, via the one or more display generation components, the second virtual content from the first location within the three-dimensional environment to a second location, different from the first location, within the three-dimensional environment such that the second virtual content continues to replace visibility of the first portion of the one or more hands of the user, such as computer system 101 moving, via display generation component 120, virtual content portion 1912f from its location in FIG. 19G to a different location in three-dimensional environment 1900 matching the new location of hand 1902 detected by computer system 101 after its movement, such that virtual content portion 1912f continues to replace visibility of hand 1902.

In some embodiments, in response to detecting movement of the first portion of the one or more hands of the user from the first location to the second location in the physical environment of the user, the computer system maintains visibility of the second portion of the one or more hands of the user in the three-dimensional environment, such as computer system 101 maintaining visibility of hand 1903 (e.g., by occluding a portion of virtual content 1910 that is behind hand 1903 from the viewpoint of the user) while hand 1902 moves behind virtual content 1910 in FIG. 19G. In some embodiments, the second virtual content replaces visibility of the first portion of the one or more hands (e.g., the right hand of the user) in response to receiving an indication from an application associated with the second virtual content to display the second virtual content and that the second virtual content is to track the motion of the first portion of the one or more hands of the user. In some embodiments, the second virtual content is a virtual hand (e.g., a representation of a hand that is not visually based on the hand of the user). In some embodiments, tracking the motion of the first portion of the one or more hands of the user includes detecting movement of the hand of the user and in response moving a location of the second virtual content. In some embodiments, the computer system moves the second virtual content in accordance with the detected motion of the one or more portions of the hand of the user. In some embodiments, the computer system moves the second virtual content proportionally with the detecting motion of the one or more portions of the hand of the user. Additionally and/or alternatively, the computer system moves the second virtual content in a non-linear manner with respect to the detected motion of the one or more portions of the hand of the user (e.g., exponentially, quadratic, and/or cubic).

In some embodiments, the size and/or shape of the second virtual content is based on the size and/or shape of the one or more portions of the hand of the user that the second virtual content is meant to replace and/or track motion of. In some embodiments, while displaying the second virtual content, the computer system maintains visibility of the one or more portions of the second hand (e.g., the left hand of the user) in accordance with the characteristics described herein. In some embodiments, the size, shape, and/or appearance of the second portion of the virtual content is defined by the application that is displaying the second virtual content. In some embodiments, the application that displays the first virtual content is the same application as the application that displays the first virtual content. In some embodiments, the application that displays the first virtual content is different than the application that displays the second virtual content. In some embodiments, the second virtual content is hand-locked (e.g., moves in any of the X, Y, or Z-directions in accordance with detected movement of the hand of the user). In some embodiments, displaying the second virtual content includes reducing visibility of the hand of the user such that no portions of the hand are displayed in front of the second virtual content relative to the viewpoint of the user.

In some embodiments, the first portion of the one or more hands is determined based on locations of (e.g., defined by and/or positioned between) a first set of one or more joints of the first hand and the second portion of the one or more hands is determined based on locations of a second set of one or more joints of the first hand, such as computer system 101 determining hand portion 1904a based on a set of joints (e.g., one or more knuckles of the index and middle fingers of hand 1902) and hand portion 1904b based on a different set of joints (e.g., one or more knuckles of the thumb of hand 1902) in FIG. 19C. For example, the first portion of the one or more hands includes portions of a first finger (e.g., phalanges of the first finger) of the first hand on one side of a first joint, and the second portion of the one or more hands includes portions of the first finger (e.g., phalanges of the first finger) on a second side (e.g., different side) of the first joint. This division of the hand along joints could apply in a similar manner to multiple fingers and/or the palm of the hand and a finger, where a joint is the dividing line between the first portion of the one or more hands and the second portion of the one or more hands. Additionally, for a single finger, unconnected portions of the finger could both be part of the first portion of the one or more hands with the second portion of the one or more hands being one of the connecting portions of the finger (e.g., where a hand is curling through a virtual object such that the palm of the hand and the tip of a finger are on one side of the virtual content and a middle phalange of the finger is on the other side of the virtual content).

In some embodiments, the first and second sets of one or more joints of the first hand are collections of skeletal landmarks (e.g., a combination of the distal inter-phalangeal (DIP), proximal inter-phalangeal, metacarpophalangeal, carpometacarpal, wrist, and/or palm-center joints) identified by the computer system as reference points for defining the spatial extent, orientation, and/or motion of the first and second respective portions of the first hand. In some embodiments, when a first joint of a finger (e.g., the distal phalanx) is behind the first virtual content with respect to the viewpoint of the user, while a second joint (e.g., the proximal phalanx) is in front of the content, the computer system occludes the first joint with the first virtual content as described above, while also making the second joint visible in accordance with the embodiments described above. In some embodiments, the visibility of the first portion and the visibility of the second portion are updated based on a detected change of the location/position of the set of one or more joints with respect to the first portion and/or the second portion. For instance, in response to detecting movement of the first portion of the one or more hands, if the detected movement is sufficient to cause the first set of one or more joints to change from being behind the first portion to being in front of the first portion or from being in front of the first portion to being behind the first portion, the computer system updates the visibility of first portion of the virtual content. In some embodiments, if the movement is not sufficient, then the computer system forgoes updating the visibility of the first portion. In some embodiments the first set of one or more joints and the second set of one or more joints are connected by the first portion of the one or more hands and/or the second portion of the one or more hands. In some embodiments, in accordance with a determination that the first portion of the one or more hands is behind the location associated with the respective portion of the first virtual content including the first set of one or more joints, the computer system forgoes increasing the visibility of the first portion of the one or more hands with the first virtual content.

It should be understood that the particular order in which the operations in method 2000 have been described is merely exemplary and is not intended to indicate that the described order is the only order in which the operations could be performed. One of ordinary skill in the art would recognize various ways to reorder the operations described herein.

FIGS. 21A through 21H generally illustrate examples of a computer system reducing a visual prominence of a portion of virtual content to increase a visibility of a portion of a three-dimensional environment that includes one or more hands based on a lighting condition of the three-dimensional environment, in accordance with some embodiments.

FIG. 21A illustrates an example of computer system 101 displaying virtual content 2110 (e.g., a simulated three-dimensional environment) within a three-dimensional environment 2100 (e.g., a physical environment of computer system 101), in accordance with some embodiments. It should be understood that, in some embodiments, computer system 101 utilizes one or more techniques described with reference to FIGS. 21A-21H in a two-dimensional environment without departing from the scope of the disclosure. As described above with reference to FIGS. 1-6, computer system 101 optionally includes one or more display generation components 120 (e.g., a head-mounted display) and a plurality of image sensors 114a-114c. Image sensors 114a-114c optionally include one or more of a visible light camera, an infrared camera, a depth sensor, or any other sensor computer system 101 would be able to use to capture one or more images of a user or a portion of user (e.g., one or more hands of the user, such as hand 2102, or an attention of the user (e.g., based on gaze)) while the user interacts with computer system 101. In some embodiments, image sensors 114a-114c optionally capture gestures or movements of hand 2102, such as the act of pinching or the release thereof, as described in greater detail herein. In some embodiments, computer system 101 displays three-dimensional environment 2100 and/or virtual content 2110 to user 2102 (and/or three-dimensional environment 2100 is visible via display generation component 120, such as via passive and/or active passthrough), and uses sensors to detect the physical environment and/or movements of the user's hands (e.g., external sensors facing outwards from the user) such as movements that are interpreted by computer system 101 as gestures such as air gestures, and/or gaze of the user (e.g., internal sensors facing inwards towards the face of the user).

As shown in FIG. 21A, computer system 101 displays (or otherwise presents) virtual content 2110 and one or more portions of three-dimensional environment 2100, such as hand 2102. In some embodiments, virtual content 2110 and three-dimensional environment 2100 share one or more characteristics with the one or more virtual contents and three-dimensional environments described with respect to methods 800, 1000, 1200, 1400, 1600, 1800, 2000, and/or 2200. FIG. 21A also illustrates a virtual content portion 2120, determined based on hand 2102, that computer system 101 uses to increase visibility of hand 2102 (e.g., by reducing the visual prominence of virtual content portion 2120). In some embodiments, virtual content portion 2120 shares one or more characteristics with the first portion of the first virtual content described with respect to method 2200. In addition, FIG. 21A depicts a lighting level 2130 (e.g., high lighting level 2132) that illustrates an amount of luminance (e.g., a lighting condition) of three-dimensional environment 2100 (e.g., the physical environment of computer system 101).

In some embodiments, a content shape of virtual content portion 2120 is based on a hand shape of hand 2102, as illustrated in FIG. 21A. In some embodiments, the content shape of virtual content portion 2120 and the hand shape of hand 2102 share one or more characteristics with the content shape of the first portion of the first virtual content and the hand shape of the portion of one or more hands of the user described with respect to method 2200. In some embodiments, a content size of the content shape of virtual content portion 2120 is based on a hand size of the hand shape of hand 2102, as illustrated in FIG. 21A and described in greater detail with respect to method 2200. In some embodiments, computer system 101 determines the hand shape of hand 2102 and/or the content shape of virtual content portion 2120 while a user of computer system 101 is currently using computer system 101, as illustrated in FIG. 21A. In some embodiments, computer system 101 determines the hand shape of hand 2102 and/or the content shape of virtual content portion 2120 during a scanning operation performed by computer system 101 on hand 2102, as described in greater detail with respect to FIGS. 21D, 21G, and 21H.

In some embodiments, as illustrated in FIG. 21B, computer system 101 detects, via image sensors 114a-114c, hand 2102 move within three-dimensional environment 2100 to a new position. In some embodiments, in response to detecting hand 2102 move to the new position, computer system 101 moves virtual content portion 2120 to match the new position of hand 2102. In some embodiments, moving virtual content portion 2120 means that computer system 101 ceases to display virtual content portion 2120 at the previous position of hand 2102 (e.g., the position of hand 2102 in FIG. 21A) and displays virtual content portion 2120 at the new position of hand 2102 (e.g., the position of hand 2102 in FIG. 21B).

In some embodiments, as illustrated in FIG. 21C, computer system 101 detects, via image sensors 114a-114c, lighting level 2130 of three-dimensional environment 2100 change from a first lighting level (e.g., high lighting level 2132 in FIG. 21B) to a second lighting level (e.g., low lighting level 2134 in FIG. 21C). In some embodiments, in response to detecting the change in lighting level 2130, computer system 101 changes one or more visual characteristics of virtual content portion 2120 (e.g., changes one or more characteristics of the reduction in visual prominence of virtual content portion 2120). For example, computer system 101 optionally changes a level of transparency of virtual content portion 2120 such that virtual content portion 2120 goes from a first level of transparency (e.g., full transparency, as in FIG. 21B) to a second level of transparency, less than the first level of transparency (e.g., some transparency, as in FIG. 21C). In some embodiments, changing one or more visual characteristics of virtual content portion 2120 in response to detecting the change in lighting level 2130 shares one or more characteristics with reducing the visual prominence of the first portion of the first virtual content in the first manner or the second manner described with respect to method 2200. In some embodiments, when the second lighting level corresponds to a higher lighting level than the first lighting level (e.g., lighting level 2130 goes from low lighting level 2134 illustrated in FIG. 21C to high lighting level 2132 FIG. 21B), computer system 101 updates virtual content portion 2120 to have a second relationship to hand 2102 (e.g., increases a level of transparency of virtual content portion 2120), as described in greater detail with respect to method 2200.

In some embodiments, in response to detecting the change in lighting level 2130, computer system 101 changes the visual prominence of virtual content portion 2120 from being reduced in a first manner to being reduced in a second manner, such that computer system 101 causes a change in an appearance of hand 2102. For example, as illustrated in FIG. 21C, computer system 101 changes the appearance of hand 2102 (e.g., makes hand 2102 appear semi-transparent) by decreasing a level of transparency of virtual content 2110 (e.g., from fully transparent to semi-transparent). In some embodiments, changing the appearance of hand 2102 shares one or more characteristics with changing the appearance of the portion of one or more hands of the user described with respect to method 2200.

In some embodiments, computer system 101 changes the visual prominence of virtual content portion 2120 gradually by temporally varying at least one rendering parameter that controls visual prominence (e.g., transparency, translucency, and/or opacity) from a first set of values (e.g., as illustrated in FIG. 21B) to a second set of values (e.g., as illustrated in FIG. 21D) over an extended interval rather than in a single frame-to-frame step (e.g., as illustrated in FIG. 21C). In some embodiments, after a time interval has passed (e.g., determined based on predetermined settings and/or a difference amount in lighting level 2130 from high lighting level 2132 to low lighting level 2134), computer system 101 displays virtual content portion 2120 with a reduced visual prominence based on lighting level 2130 (e.g., the gradual transition in the reduction of visual prominence of virtual content portion 2120 is complete), as illustrated in FIG. 21D.

In some embodiments, at low lighting level 2134 illustrated in FIG. 21D, computer system 101 determines the content shape of virtual content portion 2120 based a blurred version of the hand shape of hand 2102, as described in greater detail with respect to method 2200. For example, in accordance with a determination that low lighting level 2134 is below a predetermined threshold, computer system 101 captures one or more images of hand 2102 via image sensors 114a-114c, blurs the one or more images of hand 2102, and uses the blurred versions of the one or more images of hand 2102 to determine the content shape of virtual content portion 2120. In some embodiments, at low lighting level 2134 illustrated in FIG. 21D, computer system 101 uses a hand shape of hand 2102 and/or a content shape of virtual content portion 2120 determined based on a scanning operation 2140 (e.g., as illustrated in FIGS. 21G-21H), such as when the lighting conditions do not allow image sensors 114a-114c to capture images with sufficient fidelity to determine the hand shape of hand 2102. For example, because of low lighting level 2134, computer system 101 optionally determines that a confidence level associated with a detection of hand 2102 (e.g., and/or a confidence level associated with a determination of the hand shape and/or the content shape) is below a respective threshold.

In some embodiments, at low lighting level 2134 illustrated in FIG. 21D, computer system 101 displays virtual content portion 2120 with a different level of precision than a level of precision of the display of virtual content portion 2120 at high lighting level 2132 illustrated in FIG. 21B. For example, in response to detecting lighting level 2130 go from high lighting level 2132 to a low lighting level 2134, computer system 101 optionally increases a distance between a boundary of virtual content portion 2120 and a boundary of hand 2102 (e.g., as shown in the transition between FIGS. 21B and 21D). As another example, in response to detecting lighting level 2130 go from high lighting level 2132 to low lighting level 2134, computer system 101 optionally changes the content shape of virtual content portion 2120 to follow the hand shape of hand 2102 less closely (e.g., to resemble a mitten-like shape, rather than follow the contour of the fingers of hand 2102). In some embodiments, displaying virtual content portion 2120 with a different level of precision based on lighting level 2130 shares one or more characteristics with displaying the first portion of the first virtual content with the first or second levels of precision described with respect to method 2200.

In some embodiments, as illustrated in FIG. 21D, computer system 101 reduces the visual prominence of virtual content portion 2120 according to a feathering treatment that defines a visual transition between a hand side of a wrist portion 2104 and a forearm side of wrist portion 2104. In some embodiments, reducing the visual prominence of virtual content portion 2120 according to the feathering treatment includes reducing the visual prominence of a hand portion 2106a corresponding to the hand side of wrist portion 2104 without reducing (or, optionally, reducing by a lesser amount) the visual prominence of a hand portion 2106b corresponding to the forearm side of wrist portion 2104, as described in greater detail with respect to method 2200.

In some embodiments, as illustrated in FIG. 21E, computer system 101 detects, via image sensors 114a-114c, hand 2102 move within three-dimensional environment 2100 to a new position while lighting level 2130 remains low. In some embodiments, while hand 2102 has not moved too far from its original position (e.g., a high-confidence position, such as the position determined in FIG. 21B with high lighting level 2132), computer system 101 matches the movement of virtual content portion 2120 (e.g., the new position of virtual content portion 2120) with the movement of hand 2102 (e.g., the new position of hand 2102) closely (e.g., with high confidence).

In some embodiments, while computer system 101 is able to track movement of hand 2102 to a certain extent under low lighting level 2134 conditions, once hand 2102 moves past a certain distance from its original position (e.g., the position of hand 2102 in FIG. 21D), computer system 101 optionally does not know an exact position of hand 2102 within three-dimensional environment 2100. For example, as illustrated in FIG. 21F, when an actual position of hand 2102 within three-dimensional environment 2100 is position 2108 and computer system 101 is not able to detect hand 2102 at position 2108, computer system 101 optionally estimates a position of hand 2102 within three-dimensional environment 2100 (e.g., based on one or more images of hand 2102 captured at low lighting level 2134 and/or one or more characteristics of the movement of hand 2102 while this was still detectable (e.g., velocity, orientation, direction, and/or acceleration)). In this example, computer system 101 optionally displays hand 2102 (e.g., a representation of hand 2102 based on one or more images of hand 2102 taken during high lighting level 2132 and/or scanning operation 2140 described with respect to FIGS. 21G-21H) at the estimated position of hand 2102 within three-dimensional environment 2100.

In some embodiments, as illustrated in FIGS. 21G-21H, computer system 101 determines one or more hand shapes and/or content shapes based on a scanning operation 2140 performed on hands 2101 and 2102 of the user of computer system 101. In some embodiments, scanning operation 2140 shares one or more characteristics with the scanning operation described with respect to method 2200. In some embodiments, computer system 101 displays, via display generation component 120, hand representations 2141 and 2142 and label 2144 to guide the user of computer system 101 through one or more steps of scanning operation 2140. In some embodiments, upon detecting hands 2101 and 2102 are in appropriate positions for scanning operation 2140 within three-dimensional environment 2100 (e.g., within respective thresholds of hand representations 2141 and 2142), computer system 101 ceases to display hand representations 2141 and 2142 and performs scanning operation 2140 on hands 2101 and 2102 to generate the one or more hand shapes and/or content shapes, as described in greater detail with respect to method 2200. In some embodiments, scanning operation 2200 is part of an avatar creation process for the user of computer system 101, where the avatar is optionally for use in a communication session with one or more users of one or more external computer systems, as described in greater detail with respect to method 2200.

FIG. 22 is a flowchart illustrating a method 2200 of a computer system reducing a visual prominence of a portion of virtual content to increase a visibility of a portion of a three-dimensional environment that includes one or more hands based on a lighting condition of the three-dimensional environment in accordance with some embodiments. In some embodiments, the method 2200 is performed at a computer system (e.g., computer system 101 in FIG. 1A such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 2200 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 2200 are, optionally, combined and/or the order of some operations is, optionally, changed.

The devices, methods, and/or computer-readable storage media described below enhance the operability of the device and make the user-device interface more efficient (e.g., by helping the user to provide proper inputs and reducing user mistakes when operating/interacting with the device) which, additionally, reduces power usage and/or improves battery life of the device by enabling the user to use the device more quickly and efficiently. Providing improved feedback (such as by automatically feathering and lowering the transparency of virtual content that spatially conflicts with a detected hand shape so the user can clearly see the real hand while reaching toward the content) enhances the operability of the device by reducing accidental and mistaken inputs, reducing energy usage by the device. Performing an operation when a set of conditions has been met without requiring further user input (such as by automatically switching from the first manner to the second manner of visual prominence reduction (e.g., updating gap distance, transparency level, and feathering parameters) as soon as the ambient light measurement transitions from the first lighting condition to the second lighting condition) enhances the operability of the device by eliminating unnecessary inputs and/or steps to navigate through different user interfaces or sets of controls and shortening the time needed to adjust the display, reducing energy usage by the device. Displaying user interface elements (such as by rendering the first portion of the first virtual content with a first transparency level, first gap size, and/or first feather curve in the first lighting condition and then rendering that same portion with a second transparency level, second gap size, and/or second feather curve in the second lighting condition) with different appearances at different times helps to avoid image persistence or burn in effects that can occur with some display technologies when the same object is displayed with the same appearance at the same location repeatedly or for a long period of time.

In some embodiments, method 2200 is performed at a computer system in communication with one or more display generation components and one or more input devices, such as computer system 101 in communication with display generation component 120 and input devices 114a-114c in FIGS. 21A-21H. In some embodiments, the computer system has one or more of the characteristics of the computer systems of methods 800, 1000, 1200, 1400, 1600, 1800, and/or 2000. In some embodiments, the one or more display generation components have one or more of the characteristics of the display generation components of methods 800, 1000, 1200, 1400, 1600, 1800, and/or 2000. In some embodiments, the one or more input devices have one or more of the characteristics of the one or more input devices of methods 800, 1000, 1200, 1400, 1600, 1800, and/or 2000.

In some embodiments, the computer system displays (2202), via the one or more display generation components, first virtual content in a three-dimensional environment, such as computer system 101 displaying, via display generation component 120, virtual content 2110 in three-dimensional environment 2100 in FIG. 21A. In some embodiments, while displaying the first virtual content, the computer system detects (2204), via the one or more input devices, a portion of one or more hands of a user at a location in the three-dimensional environment that conflicts (e.g., spatially conflicts and/or is in a same region of a viewport that would be occupied by the first virtual content) with a location associated with a respective portion of the first virtual content from a viewpoint of the user (e.g., the portion of one or more hands of the user and the respective portion of the first virtual content are in a same region of the field of view of the three-dimensional environment), such as computer system 101 detecting, via input devices 114a-114c, hand 2102 at a location in three-dimensional environment 2100 that conflicts with a location associated with virtual content portion 2120 from the viewpoint of the user in FIG. 21A.

In some embodiments, the first virtual content, the representation of the physical object and the three-dimensional environment share one or more characteristics with the virtual content, representations of physical objects, and three-dimensional environments described with respect to methods 800, 1000, 1200, 1400, 1600, 1800, and/or 2000. In some embodiments, while displaying the first virtual content, the computer system detects, via the one or more input devices, that the first virtual content visually overlaps (e.g., obscures and/or is in spatial conflict with), from a viewpoint of the user, at least a portion of a representation of a physical environment that includes a hand of a user. In some embodiments, the visual overlap fully obscures the hand of the user. Additionally or alternatively, the visual overlap partially obscures the hand of the user such that a first portion of the hand of the user is obscured, while a second portion of the hand is not obscured by the first virtual content. In some embodiments, the computer system detects that the first virtual content visually overlaps the at least a portion of a representation of a physical environment that includes a hand of the user in one or more of the ways described with respect to methods 1000 and/or 2000.

In some embodiments, in response to detecting the portion of one or more hands of the user at the location in the three-dimensional environment that conflicts with the location associated with the respective portion of the first virtual content from the viewpoint of the user (2206), in accordance with a determination that a physical environment of the user (e.g., a physical environment associated with the computer system) includes a first lighting condition (e.g., computer system 101 determining that three-dimensional environment 2100 includes high lighting level 2132), the computer system reduces, via the one or more display generation components, a visual prominence of a first portion of the first virtual content in a first manner to increase a visibility of the portion of the three-dimensional environment (e.g., a portion of the physical environment that includes one or more hands of the user and is visible via optical passthrough and/or digital or virtual passthrough) that includes the portion of one or more hands of the user, such as computer system 101 reducing, via display generation component 120, the visual prominence of virtual content portion 2120 (e.g., by occluding virtual content portion 2120) to increase the visibility of hand 2102 (e.g., a portion of three-dimensional environment 2100 that includes hand 2102) in FIG. 21A.

In some embodiments, the computer system determines that a physical environment of the user includes a first lighting condition of the physical environment in which the computer system is being used. For example, the computer system measures the lighting condition and determines that the lighting condition is in a category such as “high,” “medium,” or “low” with corresponding ranges such as 6,000-8,000 lumens, 1,000-2,000 lumens, and less than 1000 lumens. In some embodiments, the computer system compares the measured lighting condition against one or more thresholds to determine the current category of lighting condition of the user. In some embodiments, the lighting condition is characterized by a value of the lighting condition (e.g., lighting intensity measured in lumens, footcandles, lux, and/or brightness). In some embodiments, the computer system determines that the measured lighting condition indicates the lighting condition is a low-light condition. As used herein, “low-light condition” is optionally a range of lighting conditions such that the luminance is below the scotopic vision level (e.g., 0.01 lux or less, 0.5 lux or less, or 1 lux or less) but is optionally any lighting condition where perception is reduced due to a reduction in luminance from a normal level of luminance. In some embodiments, the light that is being measured to determine the lighting condition is provided by natural light sources and/or artificial light sources.

In some embodiments, the computer system displays and/or increases visibility of representations of the hand(s) of the user through the first portion of the first virtual content by reducing the visual prominence of one or more portions of the virtual content that are in spatial conflict with hand(s) of the user. In some embodiments, reducing the visual prominence of the virtual content in response to detecting a spatial conflict between the virtual content and the hand of the user shares one or more characteristics with the reduction in visual prominence described with respect to methods 1600 and/or 1800.

In some embodiments, reducing the visual prominence of the first portion of the first virtual content in the first manner to increase the visibility of the portion of the three-dimensional environment that includes the portion of one or more hands of the user includes reducing the visual prominence of the first portion of the first virtual content according to a feathering treatment defining a visual transition between a first side of a wrist portion of the user that is closer to a hand associated with the wrist portion and a second side of the wrist portion that is closer to a forearm associated with the wrist portion, such as computer system 101 reducing the visual prominence of virtual content portion 2120 according to the feathering treatment defining a transition between hand portion 2106a and forearm portion 2106b separated by wrist portion 2104 in FIG. 21D. In some embodiments, the feathering treatment shares one or more characteristics with the feathering treatments described with respect to methods 1000, 1200, 1400, 1600, 1800, and/or 2000.

In some embodiments, the wrist portion of one or more hands of the user refers to a segment of the anatomy of the user that adjoins the hand and that is characterized, in a hand-tracking data set, by joint-location data corresponding to a carpal-joint cluster. In some embodiments, the wrist portion is represented by a single centroid derived from three-dimensional coordinates of a plurality of carpal landmarks, by a skeletal-model joint designated as the “wrist,” or by a contour segment obtained from a depth-image of the one or more hands of the user. In some embodiments, the first side of the wrist portion that is closer to the hand is a boundary edge of the wrist portion that adjoins the detected hand geometry. In some embodiments, the second side of the wrist portion that is closer to the forearm is a boundary edge (e.g., opposite to the boundary edge that adjoins the detected hand geometry) of the wrist portion that adjoins detected forearm geometry. In some embodiments, the visual transition between the first side and the second side of the wrist portion refers to a gradient that progresses from reduced visual prominence of the first portion of the first virtual content at the first side to substantially (or completely) unchanged visual prominence of the first portion of the first virtual content at the second side. In some embodiments, because the feathering treatment attenuates virtual content prominence only up to the second side of the wrist portion and leaves virtual pixels, texels, and/or other rendered fragments beyond the second side fully opaque, one or more portions of the forearm of the user that enter the three-dimensional environment beyond the wrist portion remain occluded by the first virtual content and therefore are not displayed by the one or more display generation components (e.g., even when the user extends their arm further forward within the three-dimensional environment).

In some embodiments, reducing the visual prominence of the first portion according to the feathering treatment of the first virtual content includes reducing a visual prominence of a portion of the first virtual content corresponding to the first side of the wrist portion without reducing the visual prominence of a portion of the first virtual content corresponding to the second side of the wrist portion, such as computer system 101 reducing the visual prominence of a sub-portion of virtual content portion 2120 that conflicts with hand 2106a (e.g., by occluding said sub-portion of virtual content portion 2120) without reducing the visual prominence of a sub-portion of virtual content portion 2120 that conflicts with forearm portion 2106b (e.g., by displaying said sub-portion with full visual prominence) in FIG. 21D. In some embodiments, the portions of the first virtual content corresponding to the first side and the second side of the wrist portion share one or more characteristics with the first portion of the first virtual content. In some embodiments, the visual prominence of the portions of the first virtual content corresponding to the first side and the second side of the wrist portion share one or more characteristics with the visual prominence of the first portion of the first virtual content. In some embodiments, the portions of the first virtual content corresponding to the first side and the second side of the wrist portion include one or more pixels, texels, and/or other rendered fragments that lie at least partially inside the first portion and whose shortest-path distance to a localized wrist portion is less than or equal to a predefined or dynamically computed threshold distance. In some embodiments, the threshold distance is expressed in a distance of user-relative space (e.g., 1 mm, 5 mm, 10 mm, 30 mm, 75 mm, 100 mm, 400 mm, 750 mm, or 1 m), in display-space pixels, or in a normalized device-independent unit.

In some embodiments, in accordance with a determination that a hand shape of the portion of one or more hands of the user is a first hand shape (e.g., computer system 101 determining the hand shape of hand 2102 in FIG. 21A), the first portion of the first virtual content, that has reduced visual prominence, has a first portion shape, wherein the first portion shape is based on (and/or corresponds to) the first hand shape, such as computer system determining a shape of virtual content portion 2120 based on the hand shape of hand 2102 in FIG. 21A.

In some embodiments, a shape is a two- or three-dimensional geometric description that defines spatial limits of an object or region. In some embodiments, the computer system generates a portion shape (e.g., the first portion shape) for the first portion of the first virtual content based on one or more geometric attributes of a hand shape (e.g., the first hand shape). In some embodiments, a hand shape (e.g., the first hand shape) and a portion shape (e.g., the first portion shape) share one or more characteristics (e.g., outline curvature, aspect ratio, orientation, area, perimeter length, and/or convexity). In some embodiments, a hand shape (e.g., the first hand shape) and a portion shape (e.g., the first portion shape) are geometrically identical (e.g., such that corresponding boundary points coincide when expressed in a common coordinate frame). In some embodiments, a hand shape (e.g., the first hand shape) and a portion shape (e.g., the first portion shape) share an overall outline but differ in scale such that the portion shape is circumscribed about, or inscribed within, the hand shape. In some embodiments, a hand shape (e.g., the first hand shape) and a portion shape (e.g., the first portion shape) are congruent except that the portion shape is uniformly offset outward or inward, whereby every point on a perimeter of the portion shape is at a common radial distance from a corresponding point on a perimeter of the hand shape. In some embodiments, the computer system selects or generates a portion shape (e.g., the first portion shape) by indexing a lookup table that maps canonical hand shapes to geometric counterparts for the first virtual content. In some embodiments, when the computer system detects (or determines) the hand shape of the portion of one or more hands of the user change from the first hand shape to a second hand shape, the computer system updates the portion shape of the first portion of the first virtual content from the first portion shape to a second portion shape. In some embodiments, when the computer system detects the first lighting condition (e.g., a dark environment), and in the absence of real-time image data of the physical hands of the user (e.g., a lack of any real-time image data of the physical hands or a lack of real-time image data that has a reliability above a threshold reliability), the computer system displays the first portion of the first virtual content with the portion shape that is based on the hand shape of the portion of one or more hands of the user.

In some embodiments, in accordance with a determination that the hand shape of the portion of one or more hands of the user is a second hand shape, different from the first hand shape (e.g., computer system 101 determining the hand shape of hand 2102 in FIG. 21D is a different shape from the hand shape of hand 2102 in FIG. 21A), the first portion of the first virtual content that has a reduced visual prominence, has a second portion shape, different from the first portion shape, wherein the second portion shape is based on (and/or corresponds to) the second hand shape, such as computer system 101 determining a shape of virtual content portion 2120 in FIG. 21D is a different shape (e.g., a mitten-like shape) than the shape of virtual content portion 2120 in FIG. 21A based on the different hand shape of hand 2102. In some embodiments, the second hand shape and the second portion shape share one or more characteristics with the first hand shape and first portion shape. In some embodiments, the second hand shape and second portion shape differ in at least one characteristic (e.g., outline curvature, aspect ratio, orientation, area, perimeter length, and/or convexity) from the first hand shape and the first portion shape.

In some embodiments, the computer system determines the hand shape and the portion shape during use of the computer system (e.g., while displaying the first virtual content), such as computer system determining the hand shape of hand 2102 and the portion shape of virtual content portion 2120 while a user of computer system 101 is using computer system 101, such as in FIG. 21A. In some embodiments, a determination occurring (or being made) during use of the computer system refers to the computer system actively executing one or more parts of method 2000 in response to contemporaneous sensor data (e.g., as opposed to being pre-computed, pre-configured, or supplied from an external source before the user interacts with the system). In some embodiments, the computer system determines that the hand shape of the portion of one or more hands of the user is the first or second hand shape and (optionally subsequently) determines, based on the hand shape, the portion shape of the first portion of the first virtual content is the first or second portion shape during an active user session each time the user changes a hand posture (e.g., past a predetermined delta), so that the computer system repeatedly updates whether the portion shape of the first portion of the first content is the first portion shape, the second portion shape, or a different portion shape while the session continues. In some embodiments, when the first lighting condition is detected, the computer system accesses the last hand shape data collected by the one or more image sensors collected during use of the computer system during a lighting condition in which the image sensor data of the hands can be reliably obtained (e.g., when there is adequate ambient light). In some embodiments, the computer system determines the portion shape of the first portion of the first virtual content after displaying the first virtual content. In some embodiments, collecting hand shape date during a lighting condition in which the image sensor data of the hands can be reliably obtained, allows the computer system to adapt to differences in the size and/or shape of hands of different user when determining the portion shape of the first portion of the first virtual content.

In some embodiments, the computer system determines the hand shape and the portion shape based on an enrollment operation performed on the one or more hands of the user, such as computer system 101 determining the hand shape of hand 2102 and the portion shape of virtual content portion 2120 in FIG. 21D based on scanning operation 2140 of FIGS. 21G-21H performed on hands 2101 and 2102. In some embodiments, performing a scanning operation (e.g., the enrollment operation) on the one or more hands of the user includes acquiring and storing data that characterizes geometric features of at least the portion of one or more hands of the user by using one or more sensing modalities (e.g., depth imaging, structured-light capture, stereo photogrammetry, time-of-flight ranging, laser triangulation, and/or ultrasound) at a time that is independent of (e.g., optionally precedes) the execution of method 2000 (e.g., occurs before displaying the first virtual content). In some embodiments, the computer system performs the scanning operation during an initial device-setup routine (or a different setup routine, such as the avatar creation process described below). In some embodiments, the computer system references scan data resulting from the scanning operation whenever real-time conditions (e.g., lighting or sensor malfunctions) are insufficient to resolve the portion of one or more hands of the user. In some embodiments, the computer system references the scan data upon detecting that live hand-tracking confidence has fallen below a threshold (e.g., for a predefined amount of time). In some embodiments, the computer system references the scan data and live hand-tracking data to determine the hand shape of the portion of one or more hands of the user and/or the portion shape of the first portion of the first virtual content. In some embodiments, the computer system determines the portion shape of the first portion of the first virtual content based on the scanning operation performed on the one or more hands of the user before displaying the first virtual content.

In some embodiments, the enrollment operation is part of an avatar creation process, and wherein the avatar is for use in a communication session with one or more users of one or more external computer systems, such as if scanning operation 2140 was part of an avatar creation process for use in a communication session with one or more users of one or more computer systems external to computer system 101 in FIGS. 21G-21H. In some embodiments, the avatar creation process refers to a set of operations that generates a digital representation (e.g., the “avatar”) of at least part of the user. In some embodiments, the avatar creation process includes one or more of acquiring source data that characterizes one or more physical features of the user (e.g., via the scanning operation), transforming the source data into geometric, photometric, rigging, and/or behavioral parameters, storing the one or more parameters in a data structure that can be transmitted to, or reconstructed on, an external computer system, and/or verifying and/or editing the resulting avatar before deployment.

In some embodiments, the scanning operation used for avatar creation is performed during an initial device-setup routine that precedes any communication session. In some embodiments, the computer system uses the hand geometry of the avatar produced by the scanning operation to apply the feathering treatment described above. In some embodiments, the “avatar” is used to visually represent the user of the computer system during a real-time communication session with one or more users of one or more external computer systems. In some embodiments, the avatar generated by the avatar creation process is a three-dimensional rigged mesh that includes skeletal joints corresponding to one or more of a head, torso, and/or one or more hands of the user. In some embodiments, the computer system detects real-time movements performed by the user (e.g., movements of the head, eye, jaw, hands, torso, and/or other body parts) to drive corresponding transformations of the avatar. In some embodiments, during the communication session with one or more users of one or more external computer systems, the computer system transmits one or more signals corresponding to the avatar (e.g., one or more characteristics and/or movements of the avatar) to the one or more external computer systems, which are configured to reconstruct and/or display the avatar (e.g., in their own three-dimensional environments). In some embodiments, during the communication session with the one or more users of the one or more external computer systems, the computer system receives one or more signals corresponding to one or more avatar of the one or more external users from the one or more external computer systems and reconstructs and/or displays the one or more avatars of the one or more external users within the three-dimensional environment of the computer system.

In some embodiments, the computer system determines the portion shape of the first portion of the first virtual content to be a shape based on a reduced fidelity (e.g., blurred, smoothed, or otherwise visually distorted to reduce a visual fidelity) version of the hand shape of the portion of one or more hands of the user, such as computer system 101 determining the portion shape of virtual content portion 2120 to be a shape based on a reduced fidelity version of the hand shape of hand 2102 (e.g., a blurred version of hand 2102 determined due to low lighting level 2134) in FIG. 21D. In some embodiments, reducing the visual prominence of the first portion of the first virtual content in the first manner includes reducing the visual prominence of the first portion of the first virtual content based on a reduced fidelity (e.g., visually distorted) image of the portion of one or more hands of the user (e.g., a blurred version of the hand shape of the portion of one or more hands of the user that is based on one or more images of the portion of one or more hands of the user that are not blurred). In some embodiments, the reduced fidelity version of the hand shape of the portion of one or more hands of the user is determined based on one or more images captured by an image sensor of the computer system while the computer system is operating in the first lighting condition (e.g., a dark and/or low light condition). In some embodiments, a reduced fidelity version of the hand shape is a condition and/or processing effect that alters an image of the portion of one or more hands of the user such that at least one photometric or geometric characteristic of the image deviates from a reference image captured under nominal sensing conditions. Some examples of portion shapes determined based on the reduced fidelity version of the hand shape include, but are not limited to, a mitten-like shape (e.g., the blur merges adjacent fingers into a single smooth lobe so the system uses one overarching shape without finger notches), an oval or “paddle” shape (e.g., fingertip valleys are smoothed into shallow arcs and the system fits an elongated ellipse aligned with the hand's long axis), a rounded-corner rectangle (e.g., a flat, blurred hand yields an almost boxy silhouette that the system approximates with four curved corners), and/or a circle (e.g., the blur inflates the hand uniformly, so the system selects a radius equal to the average inflated width and height).

In some embodiments, in accordance with a determination that a hand size of the portion of one or more hands of the user is a first hand size (e.g., computer system 101 determining the hand size of hand 2102 in FIG. 21A), a size of the first portion of the first virtual content has a first portion size (e.g., determined based on the first hand size), such as computer system 101 determining the portion size of virtual content portion 2120 based on hand size of hand 2102 in FIG. 21A. In some embodiments, size (e.g., the hand size and/or the portion size) refers to a quantitative measure of spatial extent of a region (e.g., area of a two-dimensional silhouette, volume of a three-dimensional mesh, diagonal of a minimum-bounding rectangle, or a scalar derived therefrom) and is optionally expressed in pixels, normalized device units, percentages, and/or millimeters, centimeters, meters, inches, feet or the like. In some embodiments, in response to determining that the portion of one or more hands of the user is the first hand size, the computer system assigns the first portion size to the first portion of the first virtual content (e.g., the first portion size is selected, computer, or otherwise generated based on the first hand size). For example, the first portion size is optionally computed by uniformly scaling the first hand size by a factor k, where k is a configurable parameter or a parameter adaptively selected from a range of values (e.g., based on one or more environmental or device factors, such as ambient-light intensity, camera-to-hand distance, display-pixel density, available processing headroom, battery charge level, frame-rate stability, performance modes, and/or device thermal budget). As another example, the first portion size is optionally computed by adding a fixed spatial offset (e.g., a padding distance) to the first hand size (e.g., to ensure that the first portion of the first virtual content extends beyond the detected portion of one or more hands). In some embodiments, the computer system determines the hand size of the one or more hands of the user during operation of the computer system, as described herein. Additionally and/or alternatively, the hand size of the portion of one or more hands of the user is determined during the enrollment process described herein.

In some embodiments, in accordance with a determination that the hand size of the portion of one or more hands of the user is a second hand size, different from the first hand size (e.g., if computer system 101 determined the hand size of hand 2102 in FIG. 21D is a different hand size than the hand size of hand 2102 in FIG. 21A), a size of the first portion of the first virtual content has a second portion size, different from the first portion size (e.g., determined based on the second hand size), such as computer system 101 determining the portion size of virtual content portion 2120 based on the hand size of hand 2102 in FIG. 21D, different from the hand size of hand 2102 in FIG. 21A, resulting in a different portion size of virtual content portion 2120 in FIG. 21D from the portion size of virtual content portion 2120 in FIG. 21A. In some embodiments, the second hand size and the second portion size share one or more characteristics with the first hand size and the first portion size, respectively. In some embodiments, the second hand size and the second portion size differ in at least one characteristic (e.g., overall area, maximum linear dimension (e.g., width, height, and/or diagonal), volumetric extent, perimeter length, pixel or voxel count, effective radius, and/or bounding-box aspect ratio) from the first hand size and the first portion size, respectively.

In some embodiments, reducing the visual prominence of the first portion of the first virtual content in the first manner includes displaying the shape of the first portion of the virtual content with a first level of precision relative to the hand shape of the portion of one or more hands of the user, such as computer system 101 displaying the shape of virtual content portion 2120 with the level of precision illustrated in FIG. 21B relative to the hand shape of hand 2102 (e.g., high level of precision due to high lighting level 2132). In some embodiments, the first level of precision is a quantitative tolerance or resolution (e.g., an offset gap distance or a pixel/voxel density) that specifies how closely the portion shape conforms to an outline or volumetric extent of the hand shape of the portion of one or more hands of the user. In some embodiments displaying the portion shape with the first level of precision relative to the hand shape of the portion of one or more hands of the user involves the computer system displaying a boundary between the first portion of the first virtual content and a second portion of the first virtual content outside of the first portion of the first virtual content that did not have its visual prominence reduced in response to detecting the portion of one or more hands of the user at the location in the three-dimensional environment that conflicts with the location associated with the respective portion of the first virtual content from the viewpoint of the user. In some embodiments, displaying the portion shape with the first level of precision relative to the hand shape of the portion of one or more hands of the user involves displaying the boundary between the first and second portions of the first virtual content such that every point on the boundary is offset from (or lies outside of) a nearest point on a boundary (e.g., a perimeter) of the hand shape of the portion of one or more hands of the user by a first distance to establish a gap whose magnitude reflects an approximation of the outline of the hand shape of the portion of one or more hands of the user that is suitable for the first lighting condition. For example, the first distance is optionally computed as a function of d=k*L+c, where L is an ambient-light luminance measurement associated with the first lighting condition, k is a positive coefficient (e.g., predetermined or adjusted dynamically based on user- or device-specific factors), and c is an offset that guarantees a minimum gap even in very low luminance. In some embodiments, c is equal to zero.

In some embodiments, in accordance with a determination that the physical environment of the user includes a second lighting condition, different from the first lighting condition (e.g., low lighting level 2134 of FIG. 21D, different from high lighting level 2132 of FIG. 21B), the computer system reduces the visual prominence of the first portion of the first virtual content in a second manner by displaying the shape of the first portion of the virtual content with a second level of precision, different to the first level of precision, relative to the hand shape of the portion of one or more hands of the user, such as computer system 101 displaying the shape of virtual content portion 2120 with the level of precision illustrated in FIG. 21D relative to the hand shape of 2102 (e.g., low level of precision due to low lighting level 2134). In some embodiments, the second lighting condition shares one or more characteristics with the first lighting condition described herein. In some embodiments, the second manner shares one or more characteristics with the first manner described herein. In some embodiments, the second level of precision shares one or more characteristics with the first level of precision.

In some embodiments, displaying the portion shape with the second level of precision relative to the hand shape of the portion of one or more hands of the user involves the computer system displaying the boundary between the first and second portions of the first virtual content such that every point on the boundary is offset from (or lies outside of) a nearest point on the boundary of the hand shape of the portion of one or more hands of the user by a second distance, different from the first distance, to establish a gap whose magnitude reflects an approximation of the outline of the hand shape of the portion of one or more hands of the user that is suitable for the second lighting condition. In some embodiments, the second distance is selected, computed, updated, or otherwise generated (e.g., using one or more of the techniques described with respect to the first distance) based on the second lighting condition such that the resulting gap size is different from the gap size rendered under the first lighting condition. For example, when the first lighting condition corresponds to a high luminance (e.g., >2000 lux), the system optionally displays the portion shape with a high level of precision (e.g., sets the first distance to a small gap (e.g., 10 mm)), and when the second lighting condition corresponds to a low luminance (e.g., <100 lux), the system displays the portion shape with a low level of precision (e.g., sets the second distance to a wider gap (e.g., 20 mm)). In some embodiments, the computer system stores the first distance and the second distance (and optionally more distances) as per-lighting-state variables and switches between them dynamically when lighting-condition state changes are detected (e.g., does not compute each distance but selects the first and second distances from a list including one or more distances mapped onto one or more respective lighting conditions).

In some embodiments, the computer system determines the shape of the first portion of the virtual content that has a reduced visual prominence based on a skeletal model of the one or more hands of the user (or of the portion of one or more hands of the user), such as computer system 101 determining the shape of virtual content portion 2120 based on a skeletal model of hand 2102 (e.g., using one or more joints of hand 2102) in FIG. 21A. In some embodiments, a skeletal model of one or more hands of a user refers to a hierarchical data representation that describes relative positions and/or orientations of hand-specific joints (e.g., metacarpophalangeal, interphalangeal, and/or carpometacarpal joints) and the connective kinematic chains (e.g., bones) between those joints in three-dimensional space. In some embodiments, the skeletal model includes joint-radius metadata, joint-angle limits, and/or per-joint confidence scores derived from data captured by the one or more input devices. In some embodiments, the computer system classifies a portion of the skeletal model as exhibiting a hand shape (e.g., the first hand shape or the second hand shape) when a set of joint positions and/or joint angles for the portion satisfies shape-specific geometric criteria (e.g., inter-joint distances, relative bone orientations, and/or pose templates) to enable shape identification without relying on direct texture or silhouette data.

In some embodiments, the computer system falls back to shape determination via skeletal model when silhouette-based shape classification (e.g., as described above with reference to the determination during use of the computer system and/or the scanning operation) confidence drops below a threshold (e.g., poor lighting conditions). In some embodiments, the skeletal model is derived from a user-specific calibration scan (e.g., during a device-setup routine or an avatar-creation process), and the same calibrated bone lengths are used at run time to determine the hand shape. In some embodiments, the skeletal model is determined during an enrollment process as described herein. Additionally and/or alternatively, the skeletal model is received from an external computing system (e.g., a server) that stores skeletal information pertaining the one or more hands of the user and/or one or more human hands generally. In some embodiments, the computer system determines the hand shape based on the skeletal model of the one or more hands of the user (or of the portion of one or more hands of the user) and, in response, determines the portion shape based on the hand shape determined based on the skeletal model. In some embodiments, the computer system determines the portion shape of the first portion of the first virtual content directly based on the skeletal model of the one or more hands of the user (or of the portion of one or more hands of the user) without determining the hand shape of the portion of one or more hands of the user. In some embodiments, determining that the hand shape and the portion shape are based on the skeletal model of the one or more hands of the user includes retrieving boundary parameters that are pre-associated with the skeletal model without analyzing one or more images (e.g., current or past images) of the portion of one or more hands to obtain a boundary of the portion shape. In some embodiments, one or more images are used to localize joints of the skeletal model, which the computer system uses to project the stored boundary parameters around the joints to generate the hand shape (and thus the portion shape).

In some embodiments, reducing the visual prominence of the first portion of the first virtual content in the first manner to increase the visibility of the portion of the three-dimensional environment that includes the portion of one or more hands of the user includes displaying a representation of the first portion of the first virtual content with a first level of transparency, less than full transparency, such as computer system 101 displaying virtual content portion 2120 with a level of transparency less than full transparency in FIG. 21D. In some embodiments, the representation of the first portion of the first virtual content is displayed with a degree of transparency that is greater than or equal to fully opaque (e.g. 0% transparency) but less than completely transparent (e.g., 100% transparency). In some embodiments, a level of transparency refers to a quantitative parameter (e.g., a value in a range from 0 (fully opaque) to 1 or 100% (fully transparent)) that the computer system applies when rendering a representation of the first portion of the first virtual content with other scene layers.

In some embodiments, when the computer system displays the representation of the first portion of the first virtual content with the first level of transparency, a portion of the physical environment that shares a location with the first portion of the first virtual content (e.g., including the portion of one or more hands of the user) is visible through the first portion of the first virtual content. In some embodiments, the first level of transparency is computed, selected, or otherwise generated and applied to the representation of the first portion of the first virtual content in accordance with the determination that the physical environment of the user includes the first lighting condition (e.g., a lighting condition corresponding to low light, such as <100 lux). In some embodiments, the level of transparency is generated based on one or more factors including, but not limited to, lighting condition, hand-to-camera distance, contrast between a region surrounding the one or more hands (or the portion of one or more hands) and the respective virtual content, per-application visibility profiles, display-pixel density, available processing headroom, battery charge level, frame-rate stability, performance modes, and/or device thermal budget). In some embodiments, a second level of transparency, different from the first level of transparency, is selected, computed, updated, or otherwise generated and applied to the representation of the first portion of the first virtual content in accordance with a determination that the physical environment of the user includes a second lighting condition, different from the first lighting condition, as described in greater detail below. In some embodiments, the location of the first portion of the first virtual content is selected (e.g., for display with a first level of transparency, less than full transparency) based on a determined approximation of the location of the hands of the user determined while in the low-lighting condition.

In some embodiments, reducing the visual prominence of the first portion of the first virtual content in the first manner to increase the visibility of the portion of the three-dimensional environment that includes the portion of one or more hands of the user includes, reducing, via the one or more display generation components, the visual prominence of the first portion of the first virtual content according to a feathering treatment defining a visual transition between a first side of a wrist portion of the user that is closer to a hand associated with the wrist portion and a second side of the wrist portion that is closer to a forearm associated with the wrist portion, such as computer system 101 reducing the visual prominence of virtual content portion 2120 according to the feathering treatment defining a transition between hand portion 2106a and forearm portion 2106b separated by wrist portion 2104 in FIG. 21D.

In some embodiments, reducing the visual prominence of the first portion according to the feathering treatment of the first virtual content includes, reducing, via the one or more display generation components, a visual prominence of a portion of the first virtual content corresponding to the first side of the wrist portion without reducing a visual prominence of a portion of the first virtual content corresponding to the second side of the wrist portion, such as computer system 101 reducing the visual prominence of a sub-portion of virtual content portion 2120 that conflicts with hand 2106a (e.g., by occluding said sub-portion of virtual content portion 2120) without reducing the visual prominence of a sub-portion of virtual content portion 2120 that conflicts with forearm portion 2106b (e.g., by displaying said sub-portion with full visual prominence) in FIG. 21D. In some embodiments, the feathering treatment shares one or more characteristics with the feathering treatments described herein. In some embodiments, the computer system applies the first level of transparency within an edge region that lies inside a threshold distance of the wrist portion (e.g., such that pixels farther than the threshold distance are rendered at full opacity while pixels within the threshold distance fade according to a transition curve of the feathering treatment at the first level of transparency).

In some embodiments, in response to detecting the portion of one or more hands of the user at the location in the three-dimensional environment that conflicts with the location associated with the respective portion of the first virtual content from the viewpoint of the user, in accordance with a determination that the physical environment of the user includes a second lighting condition, corresponding to a second light level greater than a first light level of the first lighting condition (e.g., computer system 101 determining three-dimensional environment 2100 includes high lighting level 2132 of FIG. 21B, greater than low lighting level 2134 of FIG. 21D), the computer system reduces, via the one or more display generation components, the visual prominence of the first portion of the first virtual content in a second manner, different from the first manner, to increase the visibility of the portion of the three-dimensional environment that includes the portion of one or more hands of the user, such as computer system 101 displaying virtual content portion 2120 in FIG. 21B in a manner different to the manner of FIG. 21D to increase the visibility of a portion of three-dimensional environment 2100 that includes hand 1902.

In some embodiments, reducing the visual prominence of the first portion of the first virtual content in the second manner includes displaying the representation of the first portion of the first virtual content with a second level of transparency, greater than the first level of transparency, such as computer system 101 displaying virtual content portion 2120 in FIG. 21B with a level of transparency greater than in FIG. 21D (e.g., more transparent and/or fully transparent). In some embodiments, reducing the visual prominence of the first portion of the first virtual content in the second manner shares one or more characteristics with reducing the visual prominence of the first portion of the first virtual content in the first manner. In some embodiments, the computer system maps a measured ambient-light luminance L to a level of transparency T by evaluating a function (e.g., T=f (L)) that yields higher transparency as luminance increases. For example, when the first lighting condition corresponds to higher luminance (e.g., >2000 lux), the computer system optionally sets a greater level of transparency for the first portion of the first virtual content (e.g., the first portion of the first virtual content is more transparent), and when the second lighting condition corresponds to lower luminance (e.g., <100 lux), the computer system optionally sets a lower level of transparency for the first portion of the first virtual content (e.g., the first portion of the first virtual content is more opaque).

In some embodiments, while the visual prominence of the first portion of the first virtual content is reduced in the first manner in accordance with the determination that the physical environment of the user (e.g., a physical environment associated with the computer system) includes the first lighting condition (e.g., computer system 101 reducing the visual prominence of virtual content portion 2120 in the first manner in accordance with high lighting level 2132 of FIG. 21B), the computer system detects, via the one or more input devices (e.g., based on light sensed by one or more cameras, one or more ambient light sensors, and/or one or more optical sensors), a change in the physical environment of the user from including the first lighting condition to including a second lighting condition, different from the first lighting condition, such as computer system 101 detecting a change in lighting level 2130 from high lighting level 2132 in FIG. 21B to low lighting level 2134 in FIG. 21C. In some embodiments, the second lighting condition shares one or more characteristics with the first lighting condition and/or the second lighting conditions described herein. In some embodiments, detecting the change in the physical environment from including the first lighting condition to including the second lighting condition includes sampling one or more lighting-related sensor signals and registering a state-transition event when a difference between the one or more lighting-related sensor signals (e.g., that define the second lighting condition) and the first lighting condition exceeds a respective threshold.

In some embodiments, in response to detecting the change in the physical environment, the computer system changes, via the one or more display generation components, the visual prominence of the first portion of the first virtual content from being reduced in the first manner, to being reduced in a second manner, different from the first manner, to cause a change in an appearance of the portion of one or more hands of the user, such as computer system 101 displaying the visual prominence of virtual content portion 2120 in the second manner in FIG. 21D, different from the manner illustrated in FIG. 21B, to cause a change in an appearance of hand 2102 (e.g., decreasing a level of transparency of virtual content portion 2120). In some embodiments, reducing the visual prominence of the first portion of the first virtual content in the second manner to cause the change in the appearance of the portion of one or more hands of the user shares one or more characteristics with reducing the visual prominence of the first portion of the first virtual content in the first and/or second manners described herein. In some embodiments, the appearance of the portion of one or more hands of the user refers to an aggregate of visual characteristics (e.g., visibility, brightness, transparency or opacity, edge definition, shading detail, and/or other visual characteristics described herein) of the portion of one or more hands of the user within the three-dimensional environment. In some embodiments, causing the change in the appearance of the portion of one or more hands of the user refers to the computer system changing at least one visual characteristic of the portion of one or more hands of the user. As an example, when the user of the computer system moves within the physical environment such that a lighting condition of the physical environment changes from the first lighting condition (e.g., dark room) to the second lighting condition (e.g., a sun-lit room) or the lighting condition within the physical environment otherwise changes without the user moving, the computer system optionally transitions from displaying the first portion of the first virtual content in the first manner to being displayed in a second manner that is different from the first manner, such that the appearance of the portion of one or more hands of the user shifts from a soft, highly transparent silhouette to a sharper, more opaque silhouette.

In some embodiments, the second manner includes displaying a representation of the one or more hands of the user using real-time image data acquired by one or more image sensors that are part of and/or are communicatively coupled to the computer system. In some embodiments, when the change in the physical environment of the user involves the physical environment including a third lighting condition, different from the first and second lighting conditions, rather than including the second lighting condition, the computer system changes the visual prominence of the first portion of the first virtual content from being reduced in the first manner, to being reduced in a third manner, different from the first and second manners. In some embodiments, in response to detecting the change in the physical environment, the computer system does not change the visual prominence of the first portion of the first virtual content from being reduced in the first manner.

In some embodiments, changing the visual prominence of the first portion of the first virtual content from being reduced in the first manner to being reduced in the second manner includes gradually transitioning (e.g., over time, thorough a sequence of intermediate states) the visual prominence of the first portion of the first virtual content from being reduced in the first manner to being reduced in the second manner, such as computer system 101 gradually transitioning the visual prominence of virtual content portion 2120 from being reduced in a first manner in FIG. 21B to being reduced in a second manner in FIG. 21D via one or more intermediate steps, as illustrated in FIG. 21C.

In some embodiments, gradually transitioning the visual prominence of the first portion of the first virtual content from being displayed in the first manner refers to temporally varying at least one rendering parameter that controls visual prominence (e.g., transparency, translucency, and/or opacity) from a first set of values (e.g., the first manner) toward a second, different set of values (e.g., the second manner, a different manner, or not being reduced at all) over an extended interval rather than in a single frame-to-frame step. In some embodiments, the computer system computes the amount of time taken to gradually transition from being reduced in the first manner (e.g., to the second manner, a different manner, or not being reduced at all) to be based on the difference in one or more characteristics between the first lighting condition and the second lighting condition. For example, the computer system optionally interpolates each affected parameter over N consecutive frames, where N is computed such that the total transition time is equal to an amount of time per amount of change in the affected parameter (e.g., 0.25 s per 100 lux change in luminance). In some embodiments, in response to detecting a change in the lighting condition (e.g., from the first lighting condition to the second lighting condition), the computer system visually transitions the first portion of the first virtual content from being reduced in the first manner (e.g., to being reducing in the second manner, a different manner, or not being reduced at all) over time (e.g., 0.1 s, 0.5 s, 1 s, 5 s, or 10 s).

In some embodiments, while the visual prominence of the first portion of the first virtual content is reduced in the first manner, the first portion of the first virtual content has a first relationship to the hand shape of the portion of one or more hands of the user, such as the visual prominence of virtual content portion 2120 having a spatial relationship to the hand shape of hand 2102 in FIG. 21B. In some embodiments, the first relationship is a set of geometric, compositing, and/or spatial alignment rules that govern how the first portion of the first virtual content is configured with respect to the determined hand shape (e.g., the first hand shape or the second hand shape) of the portion of one or more hands of the user while the visual prominence is reduced in the first manner. In some embodiments, the first relationship includes one or more of positional offsets, contour-matching rules, transparency assignments, matting, and/or depth parameters. In some embodiments, the first relationship (e.g., the relationship corresponding to higher luminance) corresponds to one or more of the matting treatments described herein (e.g., the portion shape being determined from the current-image-based hand shape, the feathering treatment applying the first distance and/or the first level of transparency, no blurred-version or skeletal-model fallback being required, and/or the visual prominence being reduced in the first manner).

In some embodiments, changing the visual prominence of the first portion of the first virtual content in response to detecting that the physical environment of the user has changed from including the first lighting condition to including the second lighting condition includes updating the first portion of the first virtual content to have a second relationship, different from the first relationship, to the hand shape of the portion of one or more hands of the user, such as computer system 101 updating virtual content portion 2120 to have a spatial relationship in FIG. 21D, different from the spatial relationship illustrated in FIG. 21B, in response to detecting that three-dimensional environment 2100 has changed from including high lighting level 2132 in FIG. 21B to including low lighting level 2134 in FIG. 21D. In some embodiments, the second relationship shares one or more characteristics with the first relationship. In some embodiments, the second relationship is a reconfigured set of geometric, compositing, and/or spatial alignment rules that govern how the first portion of the first virtual content is configured with respect to the same detected hand shape (e.g., the first hand shape or the second hand shape) in response to the computer system detecting the change in the physical environment including the second lighting condition (e.g., and in accordance with the computer system reducing the visual prominence of the first portion of the first virtual content in the second manner). In some embodiments, the second relationship differs from the first relationship in at least one parameter (e.g., positional offsets, contour-matching rules, transparency assignments, matting, and/or depth parameters). In some embodiments, the second relationship (e.g., the relationship corresponding to lower luminance) corresponds to one or more of the matting treatments described herein (e.g., the portion shape being determined from a blurred version of the hand shape or from the skeletal model, the feathering treatment applying the second distance and/or the second level of transparency, and/or the visual prominence being reduced in the second manner).

In some embodiments, the computer system is able to track a location and shape of the hands in brighter lighting conditions and is able to track a location of hands but not a shape of the hands in lower lighting conditions. In some embodiments, in the brighter lighting conditions (e.g., the second lighting condition), the computer system determines a location of the hand with respect to the virtual content and removes a portion of the virtual content that would otherwise obscure the hand using a machine-learning process or other artificial intelligence processes, when this process is unable to identify the location of the hand in the lower lighting conditions (e.g., the first lighting conditions) the hand shape is used to reveal a region where the hand is determined to be, even if the specific shape of the hand can't be determined accurately, by revealing this location through the virtual content, the user will be able to see at least a portion of their hands and be able to more easily interact with objects using their hands even in lighting conditions where the shape of the hands is not being tracked accurately.

It should be understood that the particular order in which the operations in method 2200 have been described is merely exemplary and is not intended to indicate that the described order is the only order in which the operations could be performed. One of ordinary skill in the art would recognize various ways to reorder the operations described herein . . .

In some embodiments, aspects/operations of methods 800, 1000, 1200, 1400, 1600, 1800, 2000, and/or 2200 may be interchanged, substituted, and/or added between these methods. For example, the characteristics of the computer system, input devices including controllers, and/or display generation components of methods 800, 1000, 1200, 1400, 1600, 1800, 2000, and/or 2200 the characteristics of the input to the computer system of methods 800, 1000, 1200, 1400, 1600, 1800, 2000, and/or 2200 the types of input to the computer system, including the types of input gestures and/or detected motion of the input devices of methods 800, 1000, 1200, 1400, 1600, 1800, 2000, and/or 2200 the virtual objects of methods 800, 1000, 1200, 1400, 1600, 1800, 2000, and/or 2200 the content that is interacted with in methods 800, 1000, 1200, 1400, 1600, 1800, 2000, and/or 2200 and/or the three-dimensional environments of methods 800, 1000, 1200, 1400, 1600, 1800, 2000, and/or 2200 are optionally interchanged, substituted, and/or added between these methods. For brevity, these details are not repeated here.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

As described above, one aspect of the present technology is the gathering and use of data available from various sources to improve XR experiences of users. The present disclosure contemplates that in some instances, this gathered data may include personal information data that uniquely identifies or can be used to contact or locate a specific person. Such personal information data can include demographic data, location-based data, telephone numbers, email addresses, social media IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to improve an XR experience of a user. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of XR experiences, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an XR experience can be generated by inferring preferences based on non-personal information data or a bare minimum amount of personal information, such as the content being requested by the device associated with a user, other non-personal information available to the service, or publicly available information.

1-107. (canceled)

108. A method comprising:
at a computer system in communication with one or more display generation components and one or more input devices:
while displaying, via the one or more display generation components, first virtual content in a three-dimensional environment, detecting a first physical object within a physical environment of a user of the computer system, wherein the first virtual content obscures at least a portion of a representation of the physical environment that includes the first physical object from a current viewpoint of the user of the computer system;
in response to detecting the first physical object within the physical environment:
in accordance with a determination that the first physical object is a first type of object, reducing a visual prominence of a first region of the first virtual content relative to the three-dimensional environment in a first manner so as to increase a visibility of a representation of the first physical object relative to the first virtual content in the three-dimensional environment from the current viewpoint of the user; and
in accordance with a determination that the first physical object is a second type of object, different from the first type of object, reducing a visual prominence of a second region of the first virtual content relative to the three-dimensional environment in a second manner, different from the first manner so as to increase a visibility of a representation of the first physical object relative to the first virtual content in the three-dimensional environment from the current viewpoint of the user.

109. The method of claim 108, wherein:
the first type of object is a controller device; and
the second type of object is a keyboard input device.

110. The method of claim 108, wherein:
the first type of object is a hand of a person holding a controller device; and
the second type of object is the hand of a person that is not holding a controller device.

111. The method of claim 108, wherein:
the first type of object is a person in the physical environment of the user of the computer system; and
the second type of object is a keyboard input device.

112. The method of claim 108, wherein:
the first region has a first shape;
the second region has a second shape; and
the second shape is different from the first shape.

113. The method of claim 112, wherein:
the first shape is asymmetrical;
in accordance with a determination that the first physical object has a first orientation of the object relative to the three-dimensional environment, the first shape has a first orientation of the first shape relative to the three-dimensional environment; and
in accordance with a determination that the first physical object has a second orientation of the object, different from the first orientation of the object, relative to the three-dimensional environment, the first shape has a second orientation of the first shape, different from the first orientation of the first shape, relative to the three-dimensional environment.

114. The method of claim 112, wherein:
the second shape is asymmetrical;
in accordance with a determination that the first physical object has a orientation of the object relative to the three-dimensional environment, the second shape has a first orientation of the second shape relative to the three-dimensional environment; and
in accordance with a determination that the first physical object has a second orientation of the object, different from the first orientation of the object, relative to the three-dimensional environment, the second shape has a second orientation of the second shape, different from the first orientation of the second shape, relative to the three-dimensional environment.

115. The method of claim 108, wherein:
reducing the visual prominence of the first region in the first manner comprises reducing a visual prominence of an edge region of the first region according to a first feather treatment, wherein the first feather treatment defines a transition between the visual prominence of the first region of the first virtual content and a visual prominence of a third region of the first virtual content outside of the first region of the first virtual content that did not have its visual prominence reduced in response to detecting the first physical object within the physical environment; and
reducing the visual prominence of the second region in the second manner comprises reducing a visual prominence of an edge region of the second region according to a second feather treatment, different from the first feather treatment, wherein the second feather treatment defines a transition between the visual prominence of the second region of the first virtual content and a visual prominence of a fourth region of the first virtual content outside of the second region of the first virtual content that did not have its visual prominence reduced in response to detecting the first physical object within the physical environment.

116. The method of claim 115, wherein:
reducing the visual prominence of the edge region of the first region according to the first feather treatment comprises displaying, via the one or more display generation components, a boundary of the first region at a first distance from a boundary of the first physical object; and
reducing the visual prominence of the edge region of the second region according to the second feather treatment comprises displaying, via the one or more display generation components, a boundary of the second region at a second distance, different from the first distance, from a boundary of the first physical object.

117. The method of claim 108, wherein:
reducing the visual prominence of the first region of the first virtual content relative to the three-dimensional environment in the first manner comprises updating, via the one or more display generation components, one or more characteristics of the first region at a first frequency over time; and
reducing the visual prominence of the second region of the first virtual content relative to the three-dimensional environment in the second manner comprises updating one or more characteristics of the second region at a second frequency, different from the first frequency, over time.

118. The method of claim 117, wherein:
the first type of object is a handheld object;
the second type of object is a non-handheld object; and
the first frequency is higher than the second frequency.

119. The method of claim 108, wherein the method further comprises:
while displaying, via the one or more display generation components, the first virtual content in the three-dimensional environment, detecting, via the one or more input devices, a hand of the user of the computer system within the physical environment of the user of the computer system, wherein:
the first virtual content obscures at least a portion of a representation of the physical environment that includes the hand of the user from the current viewpoint of the user; and
a position of the hand of the user is between a position corresponding to the first virtual content and the current viewpoint of the user;
in response to detecting the hand of the user within the physical environment, reducing, via the one or more display generation components, a visual prominence of a third region of the first virtual content in the three-dimensional environment from the current viewpoint of the user so as to increase a visibility of a representation of the hand of the user relative to the first virtual content in the three-dimensional environment from the current viewpoint of the user, wherein a shape of the third region is a first shape that corresponds to a profile of an outer boundary of a portion of the hand of the user that is facing the current viewpoint of the user;
while the third region of the first virtual content with the first shape has the reduced visual prominence, detecting, via the one or more input devices, that the hand of the user is holding a second physical object that is within the physical environment; and
in response to detecting that the hand of the user is holding the second physical object, modifying the shape of the third region from the first shape to a second shape, different from the first shape, wherein:
the third region with the second shape has a reduced visual prominence relative to the first virtual content; and
the second shape does not correspond to a profile of an outer boundary of a portion of the hand of the user that is facing the current viewpoint of the user.

120. The method of claim 108, wherein the method further comprises:
while displaying, via the one or more display generation components, the first virtual content in the three-dimensional environment, detecting, via the one or more input devices, a hand of the user of the computer system within the physical environment of the user of the computer system, wherein:
the first virtual content obscures at least a portion of a representation of the physical environment that includes the hand of the user from the current viewpoint of the user; and
a position of the hand of the user is between a position corresponding to the first virtual content and the current viewpoint of the user;
in response to detecting the hand of the user within the physical environment, reducing, via the one or more display generation components, a visual prominence of a third region of the first virtual content in the three-dimensional environment from the current viewpoint of the user so as to increase a visibility of a representation of the hand of the user relative to the first virtual content in the three-dimensional environment from the current viewpoint of the user, wherein a shape of the third region is a first shape that corresponds to a profile of an outer boundary of a portion of the hand of the user that is facing the current viewpoint of the user;
while the third region of the first virtual content with the first shape has the reduced visual prominence, detecting, via the one or more input devices, that the hand of the user is holding a second physical object that is within the physical environment; and
in response to detecting that the hand of the user is holding the second physical object, and while the third region has the reduced visual prominence:
reducing, via the one or more display generation components, a visual prominence of a fourth region of the first virtual content, different from the third region so as to increase a visibility of a representation of the second physical object relative to the first virtual content in the three-dimensional environment from the current viewpoint of the user, wherein a location of the fourth region in the three-dimensional environment is based on a location of the second physical object in the three-dimensional environment.

121. A computer system that is in communication with one or more display generation components and one or more input devices, the computer system comprising:
one or more processors;
memory; and
one or more programs, wherein the one or more programs are stored in the memory and configured to be executed by the one or more processors, the one or more programs including instructions for:
while displaying, via the one or more display generation components, first virtual content in a three-dimensional environment, detecting a first physical object within a physical environment of a user of the computer system, wherein the first virtual content obscures at least a portion of a representation of the physical environment that includes the first physical object from a current viewpoint of the user of the computer system;
in response to detecting the first physical object within the physical environment:
in accordance with a determination that the first physical object is a first type of object, reducing a visual prominence of a first region of the first virtual content relative to the three-dimensional environment in a first manner so as to increase a visibility of a representation of the first physical object relative to the first virtual content in the three-dimensional environment from the current viewpoint of the user; and
in accordance with a determination that the first physical object is a second type of object, different from the first type of object, reducing a visual prominence of a second region of the first virtual content relative to the three-dimensional environment in a second manner, different from the first manner so as to increase a visibility of a representation of the first physical object relative to the first virtual content in the three-dimensional environment from the current viewpoint of the user.

122. A non-transitory computer readable storage medium storing one or more programs, the one or more programs comprising instructions, which when executed by one or more processors of a computer system that is in communication with a display generation component and one or more input devices, cause the computer system to perform a method comprising:
while displaying, via the one or more display generation components, first virtual content in a three-dimensional environment, detecting a first physical object within a physical environment of a user of the computer system, wherein the first virtual content obscures at least a portion of a representation of the physical environment that includes the first physical object from a current viewpoint of the user of the computer system;
in response to detecting the first physical object within the physical environment:
in accordance with a determination that the first physical object is a first type of object, reducing a visual prominence of a first region of the first virtual content relative to the three-dimensional environment in a first manner so as to increase a visibility of a representation of the first physical object relative to the first virtual content in the three-dimensional environment from the current viewpoint of the user; and
in accordance with a determination that the first physical object is a second type of object, different from the first type of object, reducing a visual prominence of a second region of the first virtual content relative to the three-dimensional environment in a second manner, different from the first manner so as to increase a visibility of a representation of the first physical object relative to the first virtual content in the three-dimensional environment from the current viewpoint of the user.

123-192. (canceled)
